(19) United States
(12) Patent Application Publication
(10) Pub. No.: US 2023/0308516 A1
(43) Pub. Date: Sep. 28, 2023

(54) MULTIUSE COMMUNICATION SYSTEM AND METHOD FOR CONNECTING USERS BASED UPON SHARED NEEDS AND CHALLENGES

(71) Applicant: Pears Inc., Palo Alto, CA (US)

(72) Inventor: Adriana Ferreyr, Palm Beach, FL (US)

(21) Appl. No.: 18/182,969

(22) Filed: Mar. 13, 2023

Related U.S. Application Data
(60) Provisional application No. 63/319,728, filed on Mar. 14, 2022.

(51) Int. Cl. H04L 67/306; H04L 51/216

(52) U.S. Cl. CPC H04L 67/306; H04L 51/216

(57) ABSTRACT

A multiuse communication system for connecting users based upon shared needs and challenges and methods for making and utilizing same. The multiuse communication system enables a system user to select one or more discussion topics and identify another system user to communicate about each selected discussion topic. The system user can be a peer, volunteer or coach for each selected discussion topic. The multiuse communication system can provide a chat box for facilitating communication with the other system users and permit the system user to receive donations and other payments from the other system user and make payments to the other system user. The multiuse communication system optionally can enable the system user to create a personal user profile with a list of discussion topics of interest to the system user. The multiuse communication system advantageously enables the system user to discuss different topics with different other system users.

### CROSS-REFERENCE TO RELATED APPLICATIONS

This application claims the benefit of, and priority to, U.S. Provisional Application Serial No. 63/319,728, filed on Mar. 14, 2022, the disclosure of which is hereby incorporated herein by reference in its entirety and for all purposes.

### FIELD

The disclosed embodiments relate generally to the field of electronic communications and more particularly, but not exclusively, to systems and methods for connecting users based upon shared needs and challenges.

### BACKGROUND

Individuals who are facing a crisis or ongoing issue often struggle to find support. Conventional online systems do not provide an effective mechanism for connecting such individuals with peers and volunteers who have shared similar life experiences or challenges and thus can offer support. Currently-available online volunteer systems, for example, are limited to local networks and resources; whereas, currently-available online coaching systems require payment in exchange for support services.

Despite providing a forum for discussions based upon shared interests, the conventional online systems do not provide chat, video or direct messaging capabilities for facilitating the discussions. Current social media systems have chat, video or direct messaging capabilities but do not provide anonymity that individuals seeking support typically desire. These social media systems also do not provide volunteers who are willing to offer support.

In view of the foregoing, a need exists for an improved system and method for connecting users based upon shared needs and challenges that overcome the aforementioned obstacles and deficiencies of the currently-available online volunteer and coaching systems.

### BRIEF DESCRIPTION OF THE DRAWINGS

FIG. 1A is a top-level block diagram illustrating an exemplary embodiment of a multiuse communication system for connecting system users based upon shared needs and challenges.

FIG. 1B is a top-level block diagram illustrating an alternative exemplary embodiment of the multiuse communication system of FIG. 1A, in which a system user can be connected with a volunteer, a coach or a peer.

FIGS. 2A-F are detail diagrams illustrating exemplary embodiments of a registration page for enabling a new system user to register with the multiuse communication system of FIGS. 1A-B.

FIGS. 3A-K are detail diagrams illustrating exemplary embodiments of a personal profile page for enabling the system user to enter a personal user profile via the multiuse communication system of FIGS. 1A-B.

FIGS. 4A-B are detail diagrams illustrating exemplary embodiments of the personal profile page of FIGS. 3A-K, wherein the personal profile page presents one or more communication threads.

FIG. 5 is a detail diagram illustrating an exemplary embodiment of the personal profile page of FIGS. 3A-K, wherein the personal profile page presents one or more instances of saved content.

FIG. 6 is a detail diagram illustrating an exemplary embodiment of the personal profile page of FIGS. 3A-K, wherein the personal profile page presents one or more user notifications.

FIG. 7 is a detail diagram illustrating an exemplary embodiment of a login page for the personal profile page of FIGS. 3A-K.

FIGS. 8A-D are detail diagrams illustrating exemplary embodiments of a public profile page for enabling the system user to present selected information from the personal user profile to other system users of the multiuse communication system of FIGS. 1A-B.

FIGS. 9A-J are detail diagrams illustrating exemplary embodiments of a homefeed page for enabling the system user to present selected information from the personal user profile to other system users of the multiuse communication system of FIGS. 1A-B.

FIG. 10 is a detail diagram illustrating an exemplary embodiment of a search page for enabling the system user to search the content available via the multiuse communication system of FIGS. 1A-B.

FIG. 11 is a detail diagram illustrating an exemplary embodiment of a suggested support group overview page for enabling the system user to access selected information for a support group suggested by the multiuse communication system of FIGS. 1A-B.

FIGS. 12A-F are detail diagrams illustrating exemplary embodiments of a support group membership page for the multiuse communication system of FIGS. 1A-B.

FIGS. 13A-H are detail diagrams illustrating exemplary embodiments of a live event page associated with the support group membership page of FIGS. 12A-F.

FIGS. 14A-H are detail diagrams illustrating exemplary embodiments of a support group leadership page for the multiuse communication system of FIGS. 1A-B.

FIGS. 15A-C are detail diagrams illustrating exemplary embodiments of a live event page associated with the support group leadership page of FIGS. 14A-H.

FIGS. 16A-C are detail diagrams illustrating exemplary embodiments of a new group creation page for the multiuse communication system of FIGS. 1A-B.

FIGS. 17A-P are detail diagrams illustrating exemplary embodiments of a support network page for the multiuse communication system of FIGS. 1A-B.

FIGS. 18A-B are detail diagrams illustrating exemplary embodiments of an options support network page for the multiuse communication system of FIGS. 1A-B.

FIGS. 19A-D are detail diagrams illustrating exemplary alternative embodiments of a user image data editing page for the personal profile page of FIGS. 3A-K.

FIGS. 20A-X are detail diagrams illustrating additional exemplary alternative embodiments of the personal profile page of FIGS. 3A-K.

FIGS. 21A-E are detail diagrams illustrating further exemplary alternative embodiments of the personal profile page of FIGS. 3A-K.

FIG. 22A-ZB are detail diagrams illustrating exemplary alternative embodiments of the support network page of FIGS. 17A-P.

FIGS. 23A-C are flow charts illustrating an exemplary method for execution by the multiuse communication system of FIGS. 1A-B.

FIG. 24A is a graph illustrating exemplary interactions between a first system user and a second system user based upon selected user roles supported by the multiuse communication system of FIGS. 1A-B.

FIG. 24B is a graph illustrating alternative exemplary interactions between the first system user and the second system user shown in FIG. 24A.

FIGS. 25A-Y are detail diagrams illustrating further exemplary embodiments of the personal profile page of FIGS. 3A-K, wherein the personal profile page includes support network content for a first system user who comprises a peer first user.

FIGS. 26A-Y are detail diagrams illustrating further exemplary embodiments of the personal profile page of FIGS. 3A-K, wherein the personal profile page includes support network content for a first system user who comprises a volunteer first user.

FIGS. 27A-Z are detail diagrams illustrating further exemplary embodiments of the personal profile page of FIGS. 3A-K, wherein the personal profile page includes support network content for a first system user who comprises a professional first user.

FIG. 28A-AA are detail diagrams illustrating further exemplary embodiments of the personal profile page of FIGS. 3A-K, wherein the personal profile page includes support network content for a first system user who comprises a creator first user.

FIG. 29A-AA are detail diagrams illustrating further exemplary embodiments of the personal profile page of FIGS. 3A-K, wherein the personal profile page includes support network content for a first system user who comprises an anonymous first user.

FIGS. 30A-N are detail diagrams illustrating further exemplary embodiments of the personal profile page of FIGS. 3A-K, wherein the personal profile page includes support network content for a first system user who comprises a guest first user.

FIG. 31 shows an example computer system for implementing the multiuse communication system of FIGS. 1A-B.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

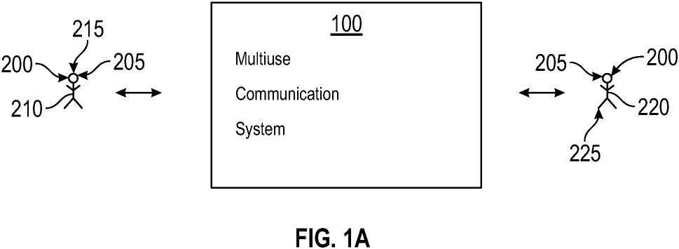

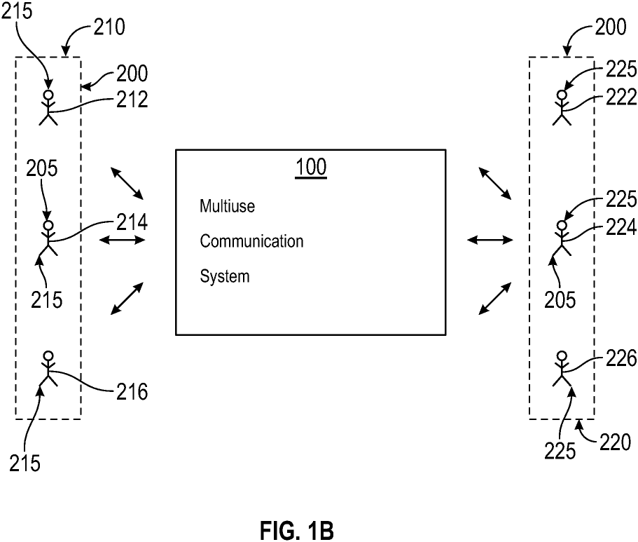

Since currently-available online therapy and other communication systems and methods present confidentiality, privacy, and unreliable technology issues and often cannot convey facial expressions and other body language signals, a multiuse communication system and method for connecting users based upon shared needs and challenges can prove desirable and provide a basis for a wide range of applications, such as connecting users with counsellors. This result can be achieved, according to one embodiment disclosed herein, by a multiuse communication system (or circuit) 100 as illustrated in FIG. 1A.

Turning to FIG. 1A, the multiuse communication system 100 advantageously can enable individuals and other system users 200 to connect and/or communicate with each other. If the system users 200 are associated with respective processing systems (or circuits) 205, for example, the multiuse communication system 100 can enable a first user processing system (or circuit) 215 associated with a first system user 210 to connect and/or communicate with a second user processing system (or circuit) 225 associated with a second system user 220. The first user processing system 215 optionally can connect and/or communicate with any predetermined number of second user processing systems 225 associated with respective second system users 220.

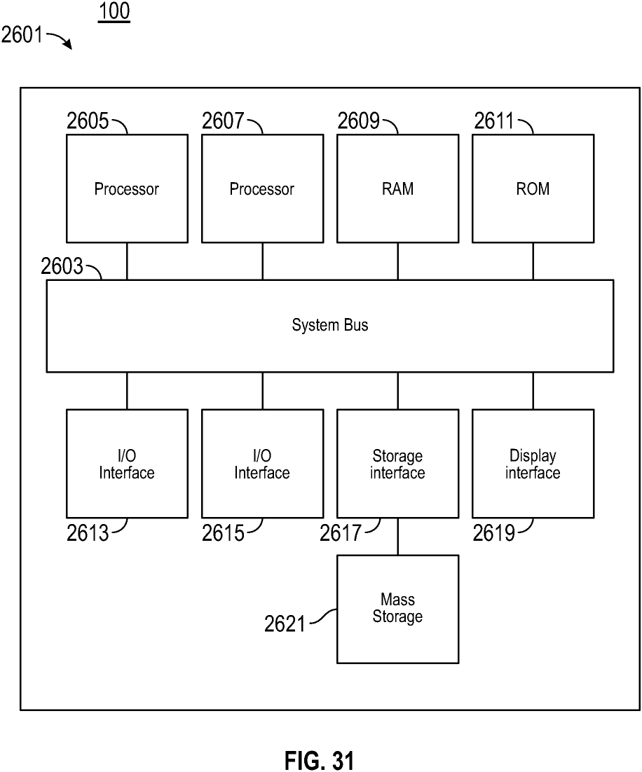

The user processing systems 205 can include one or more desktop computers, one or more laptop computers, one or more palmtop computers and/or one or more smart telephones, without limitation. Additionally and/or alternatively, at least one user processing system 205 can be provided in the manner discussed herein with reference to computer system (or circuit) 2601 (shown in FIG. 31). In selected embodiments, the user processing systems can be close to, and/or remote from, each other. In other words, the first user processing system 215 can be proximal to the second user processing system 225 and/or distal from a third user processing system (or circuit) 205 associated with a third system user 200.

The first system user 210 can utilize the multiuse communication system 100 to identify one or more second system user 220 with whom to connect with regard to a predetermined discussion topic. In selected embodiments, at least one of the system users 200 can be associated with one or more discussion topics. Each system user 200, for example, can establish a user profile via the multiuse communication system 100, and the user profile can include a list of discussion topics relevant or otherwise of interest to the system user 200. A first system user 210 thereby can search among the user profiles established via the multiuse communication system 100 for one or more second system users 220 who have identified the discussion topic as being of interest in their user profiles. The multiuse communication system 100 can enable the first system user 210 to contact the second system users 220 who have identified the discussion topic as being of interest.

In selected embodiments, the multiuse communication system 100 can be provided as a chat box for enabling the first system users 210 to search for, and connect with, one or more of the second system users 220 with regard to the predetermined discussion topic. Additionally and/or alternatively, the first system users 210 can be associated with one or more first user categories or other groups 212, 214, 216, and/or the second system users 220 can be associated with one or more second user categories or other groups 222, 224, 226. The user groups can be based, for example, upon educational, experience employment or other demographic information of the system users 200. The user groups associated with the first system users 210 can be the same as, and/or different from, the user groups associated with the second system users 220. As desired, each of the second system user 220 can list themselves in, or otherwise be associated with, multiple user groups.

As shown in FIG. 1B, for example, the multiuse communication system 100 can enable the first system users 210 to search for, and connect with, one or more of the second system users 220, such as peer users 222, volunteer users 224 and/or coach users 226, to discuss the predetermined discussion topic. The peer users 222 can comprise individuals who are experiencing a particular problem or other issue and who want to connect with other individuals who are experiencing the same particular issue for mutual support. The volunteer users 224 can include individuals who have personal experience with a particular problem or other issue and are willing to donate their time to help people going through something similar. Exemplary volunteer users 224 can include, but are not limited to, a recovering alcoholic helping someone else with a drinking problem, a cancer survivor helping other cancer survivors, and/or a sexual assault survivor helping other sexual assault victims. The coach users 226 can be individuals with expertise or professional training in a specific area who can offer services to those in need. In selected embodiments, the multiuse communication system 100 can designate each system user 200 as being a peer user by default but can permit the system user 200 to select a different user category designation, such as a coach user, a professional user and/or a volunteer user, without limitation.

Advantageously, the multiuse communication system 100 can enable a selected second system user 220 to act more than one role. The selected second system user 220, in other words, can act as a peer user 222, a volunteer user 224 and/or coach user 226. For example, the selected second system user 220 can be a peer user 222 for a first predetermined discussion topic, a volunteer user 224 for a second predetermined discussion topic and/or coach user 226 for a third predetermined discussion topic. In selected embodiments, the multiuse communication system 100 can enable the selected second system user 220 to simultaneously act in more than one role. Stated somewhat differently, the selected second system user 220 can engage in the first, second and/or third predetermined discussion topics at the same time.

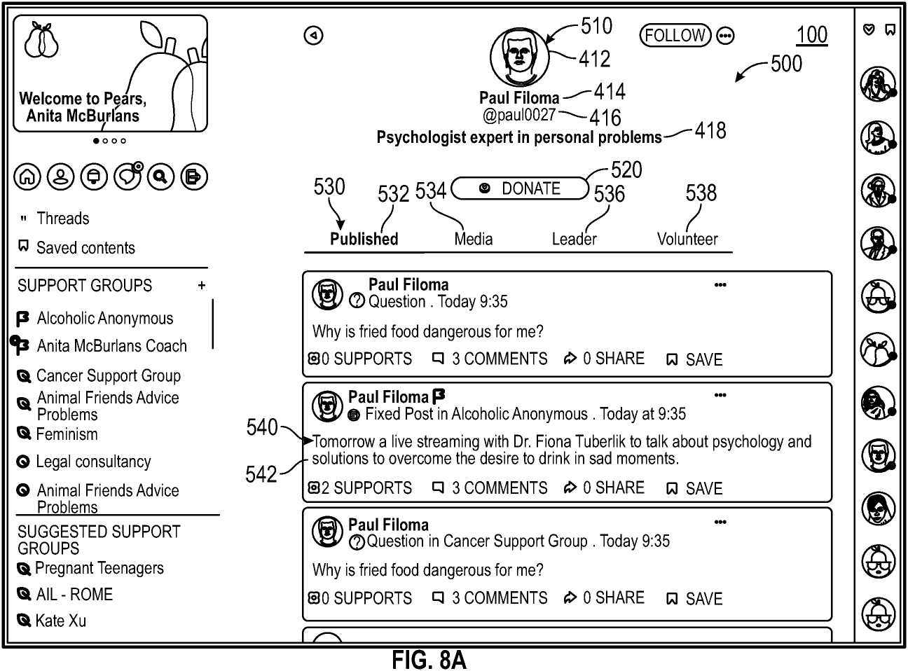

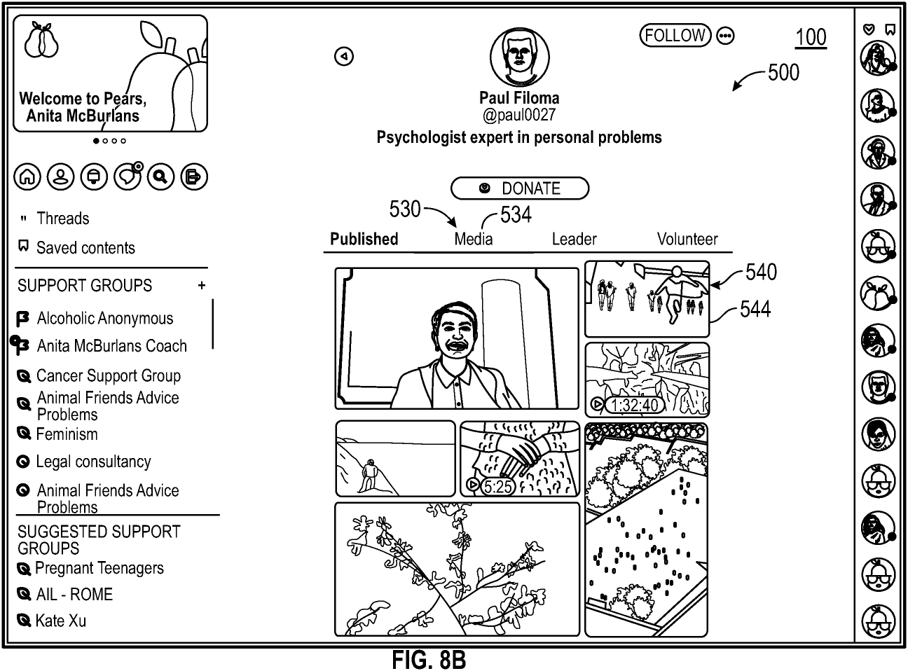

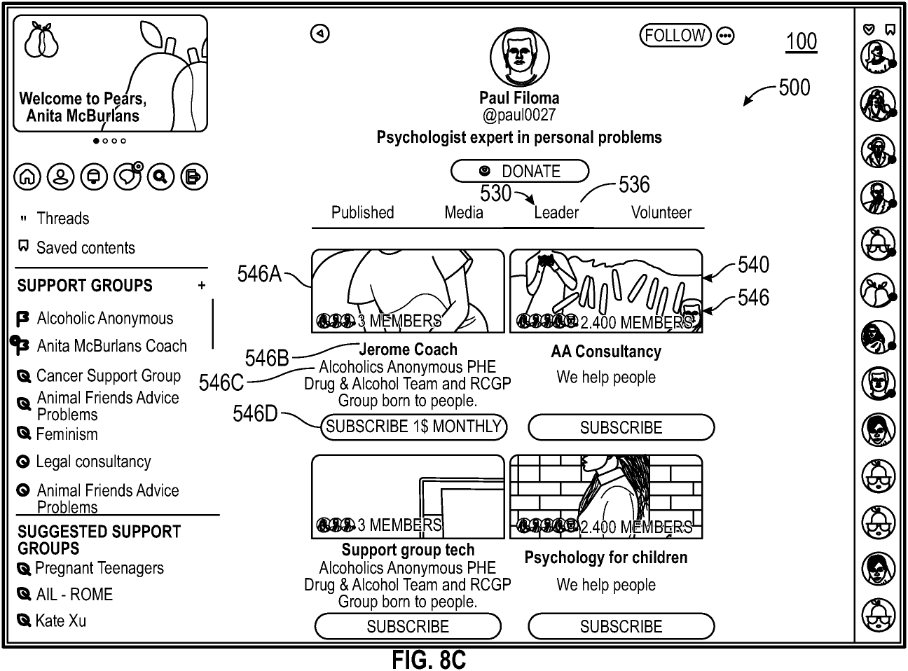

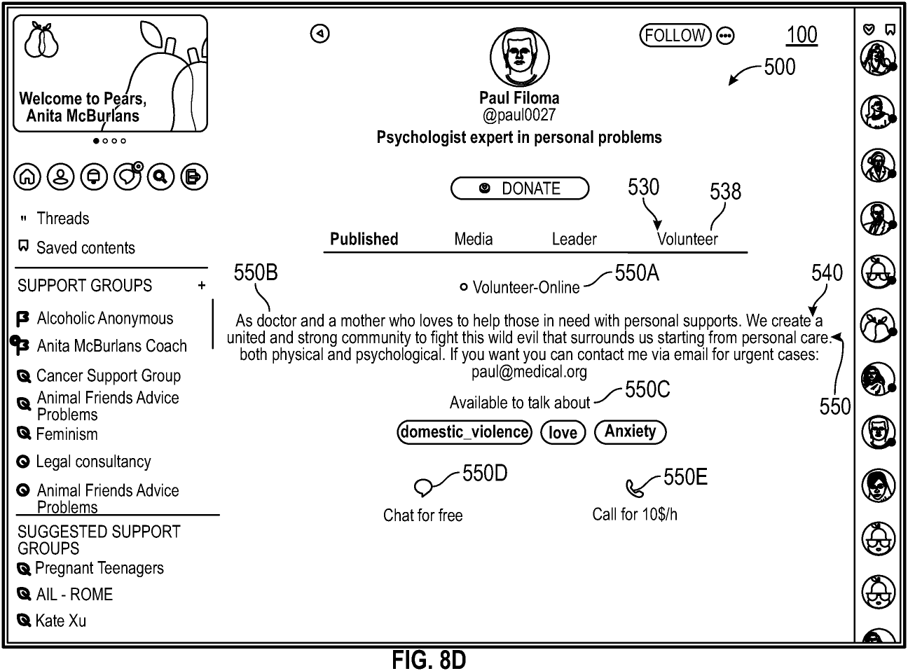

The multiuse communication system 100 optionally can permit or otherwise enable the second system users 220 to donate their time for discussing the discussion topic with the first system users 210 and/or to charge a fee for discussing the discussion topic with the first system users 210. In selected embodiments, each second system user 220 can include a voluntary donation button 520 (shown in FIG. 8A) with the associated user profile; whereas, other second system user 220, such as the coach users 226, optionally can charge a fee for their services and/or can set their own fee rates, such as a fee per hour, minute or other time unit.

Advantageously, the multiuse communication system 100 can provide a way for people facing a crisis or ongoing issue to connect with peers, volunteers and coaches who share similar life experiences or challenges and can offer support. Unlike conventional online systems, the multiuse communication system 100 can connect people with shared challenges from anywhere in the world and need not be limited to local networks and resources. The multiuse communication system 100 thereby can offer a convenient, multiuse communications system that makes it dramatically easier for users to connect with peers, volunteers and coaches.

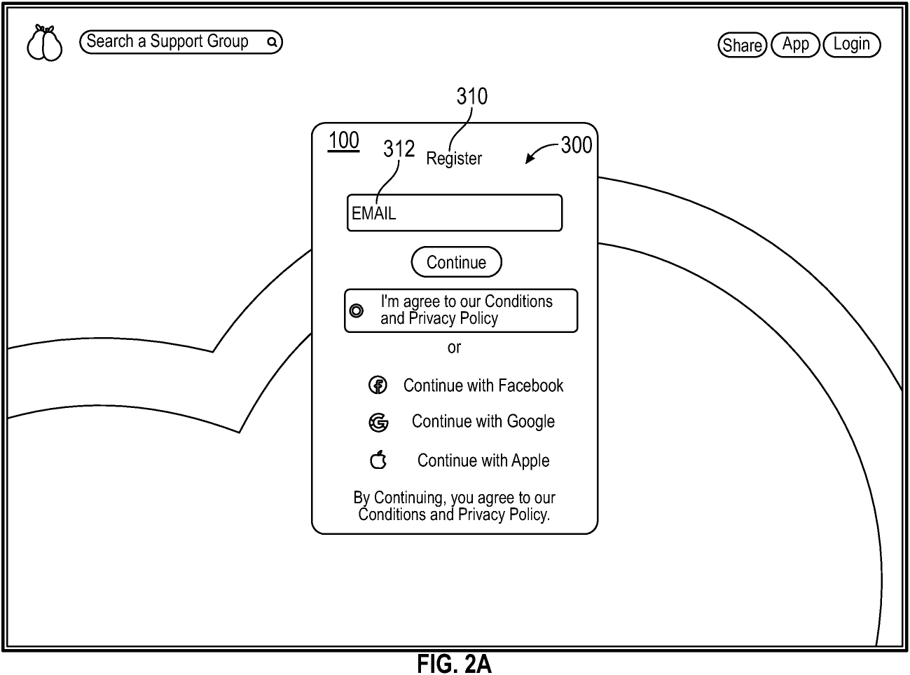

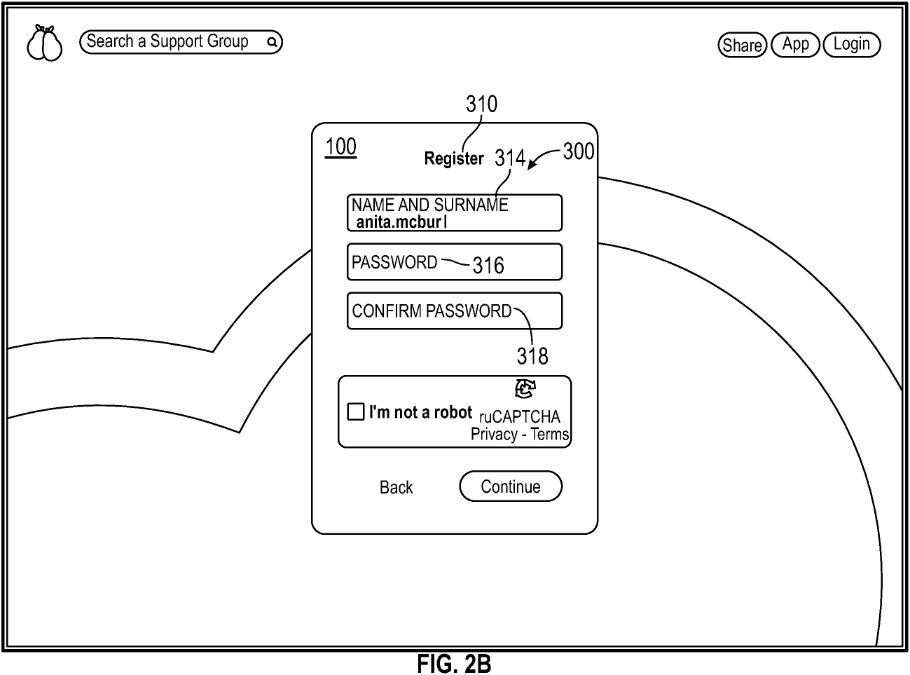

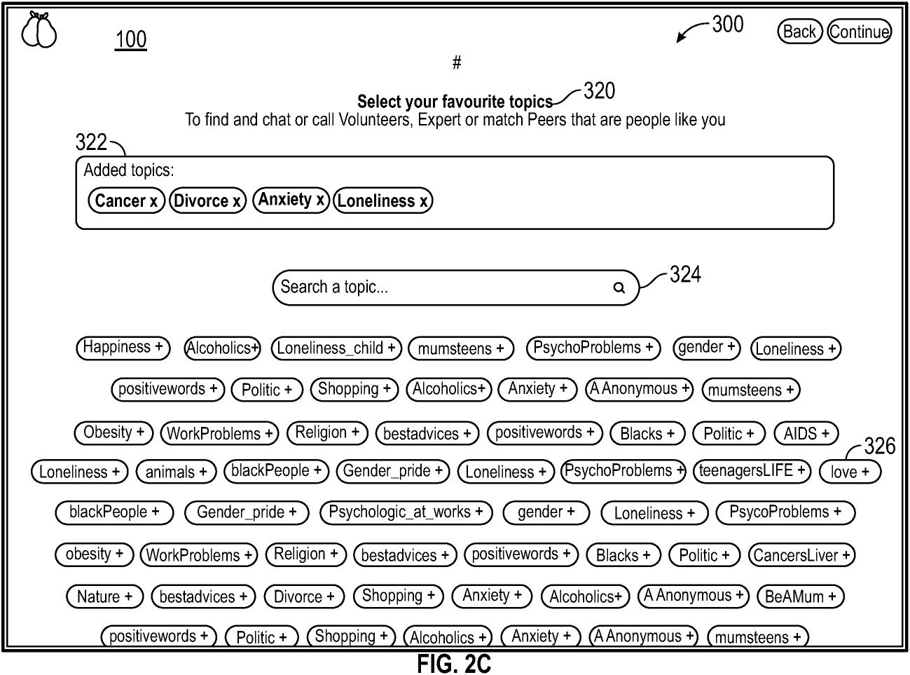

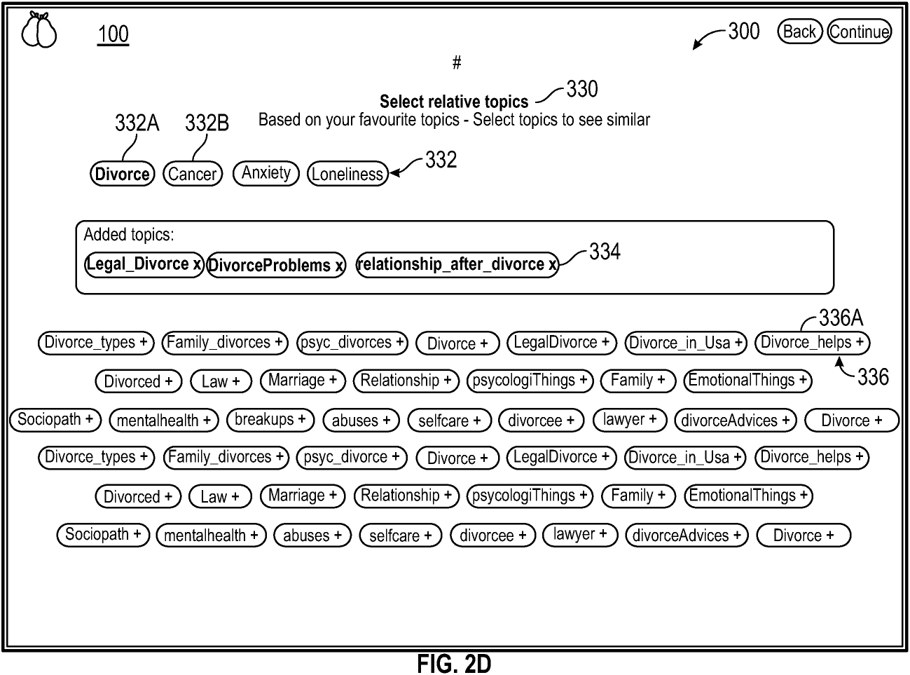

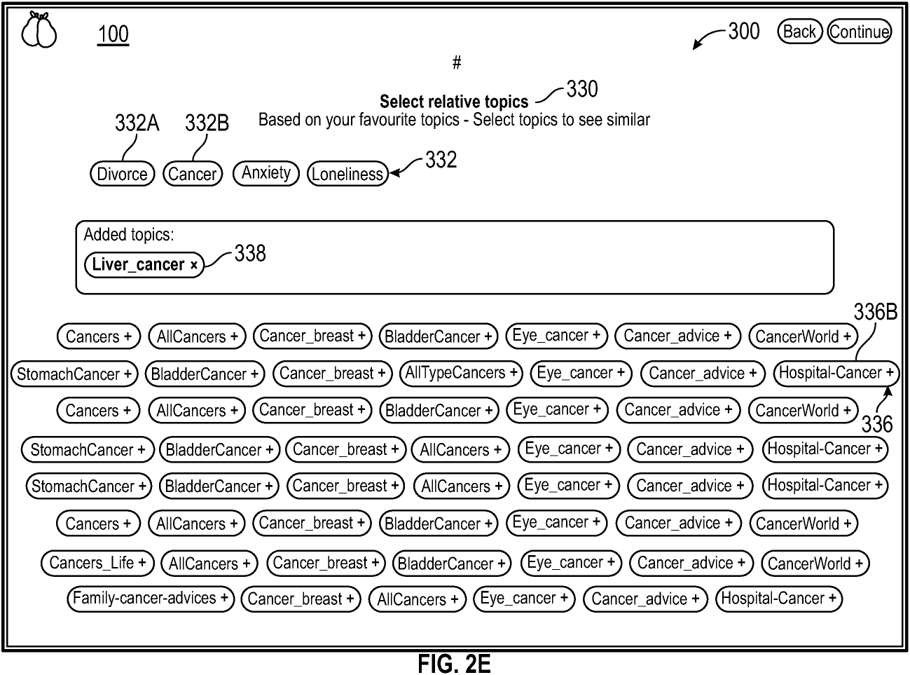

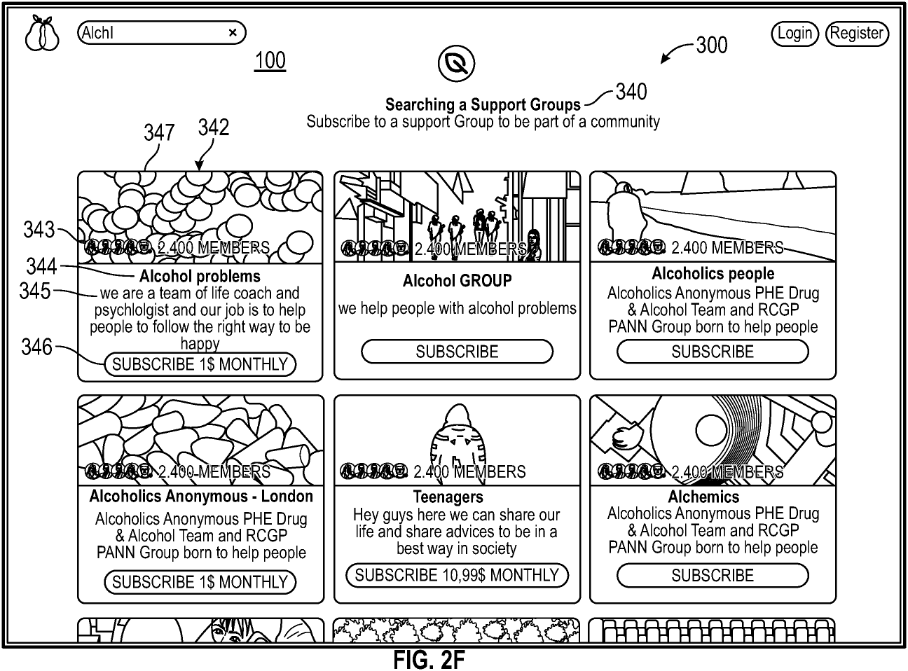

The multiuse communication system 100 optionally can comprise a software application or other computer-implemented system. In selected embodiments, for example, the multiuse communication system 100 can be provided as a website, a mobile telephone application (or app) or other online system available via the Internet. If comprising a software application or other computer-implemented method, the multiuse communication system 100 can present one or more registration pages 300 to a new first system user 210 (shown in FIGS. 1A-B), a new second system user 220 (shown in FIGS. 1A-B) or other new system user 200 (shown in FIGS. 1A-B) as illustrated in FIGS. 2A-F.

Turning to FIGS. 2A-B, an exemplary registration page 310 is shown. The registration page 310 can enable the new system user 200 to enter an electronic mail (or email) address 312, a user name 314, a telephone number and/or any other identification information for registering to utilize the multiuse communication system 100. The new system user 200 can enter a password 316 and optionally confirm the entered password, at 318, on the registration page 310. In selected embodiments, the registration page 310 optionally can enable the new system user 200 to register via one or more third-party applications, such via Facebook, Google and/or Apple. Although shown as comprising two separate registration pages 310 with reference to FIGS. 2A-B for purposes of illustration only, the registration page 310 can comprise any suitable number of registration pages, including a single registration page.

Additionally and/or alternatively, the multiuse communication system 100 can enable the new system user 200 to identify one or more favorite topics. The favorite topics can be identified during registration or afterward, and/or the new system user 200 can update the favorite topics at any time. As shown in FIG. 2C, for example, the multiuse communication system 100 can present a favorite and/or relevant topic (or subtopic) selection page 330. The subtopic selection page 330 can include a topic listing 326 for selection by the new system user 200 and/or can include a search feature 324 by which the new system user 200 can enter topic information for searching among the topic listing 326. The new system user 200 can identify one or more favorite topics as being of interest or otherwise relevant and add the relevant topics to an added topic listing 322 associated with the new system user 200.

In selected embodiments, the subtopic selection page 330 advantageously can present the topic listing 326 in a hierarchical manner. Stated somewhat differently, at least one of the relevant topics in the added topic listing 322 can be associated with one or more subtopics. Turning to FIG. 2D, for example, based upon the added topic listing 322 as selected by the new system user 200, the subtopic selection page 330 can include a subtopic listing 336 for selection by the new system user 200 for each of the added topics. The subtopic selection page 330 optionally can include a search feature by which the new system user 200 can enter subtopic information for searching among the subtopic listing 336.

If the new system user 200 adds divorce 332A to the added topic listing 322, the subtopic selection page 330 can include a subtopic listing 336A of divorce subtopics for selection by the new system user 200 as illustrated in FIG. 2D. FIG. 2E shows a subtopic listing 336B of cancer subtopics for selection by the new system user 200 if the new system user 200 adds cancer 332B to the added topic listing 322. The new system user 200 can identify one or more favorite subtopics as being of interest or otherwise relevant and add the relevant subtopics to an added subtopic listing 328 associated with the new system user 200.

The multiuse communication system 100 optionally can enable the new system user 200 to search for a support group related to the relevant topics and/or subtopics identified the new system user 200. As illustrated in FIG. 2F, for example, the multiuse communication system 100 can present a support group search page 340 for enabling the new system user 200 to view or otherwise access available support groups related to the relevant topics and/or subtopics identified the new system user 200. The support group search page 340 can include a support group listing 342 of one or more support groups 347. The support group listing 342 can provide selected information about the support groups 347, such as a group name 344, membership information 343, a purpose statement 345, cost and/or other subscription information, without limitation.

A support group suggestions page can suggest one or more support groups that may be useful or otherwise relevant to the new system user 200. The support group suggestions page can include a support group listing of one or more support groups. The support group listing can provide selected information about the support groups, such as a group name, membership information, a purpose statement, cost and/or other subscription information (or indicia), without limitation.

The support group suggestions page can include optional search indicia for enabling the new system user 200 to search for a support group related to the relevant topics and/or subtopics identified the new system user 200. The support group suggestions page advantageously can provide an option for the new system user 200 to subscribe to a selected support group via an existing personal user profile or a new personal user profile created specifically for the selected support group. Stated somewhat differently, the new system user 200 can subscribe to the selected support group anonymously or with a user name (or other indicia) set forth in a selected personal user profile of the new system user 200.

Upon activation of the subscription indicia for a selected support group, the support group suggestions page can provide at least one subscription page (or menu) for enabling the new system user 200 to subscribe to the selected support group. For example, the support group suggestions page optionally can provide at least one subscription page (or menu) for enabling the new system user 200 to select one or more personal user profiles of the new system user 200 for interacting with the selected support group.

The support group suggestions page can present at least one payment option page (or menu) for presenting one or more payment options for paying any subscription fee for the selected support group. Exemplary payment options can include, but are not limited to, payment via a credit card, payment via PayPal, payment via Google Pay and/or Pay with Apple Pay. Upon selection of a payment option, the support group suggestions page can help facilitate initiation of the fee payment. The support group suggestions page, in selected embodiments, can present at least one payment field page (or menu). If the payment via the credit card option is selected, for instance, payment field page can include fields for enabling the new system user 200 to enter or otherwise specify a credit card type for the credit card, a card owner name for the credit card, a credit card number for the credit card, an expiry date for the credit card, and/or a Card Verification Value (or CVV) for the credit card, without limitation. Once the subscription process is complete, the support group suggestions page can present a subscription confirmation page.

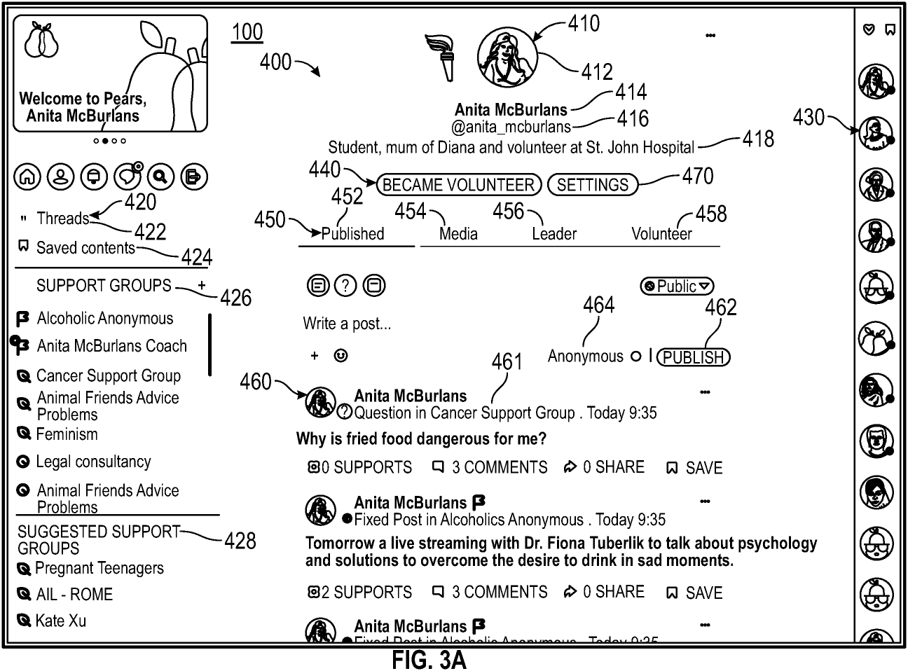

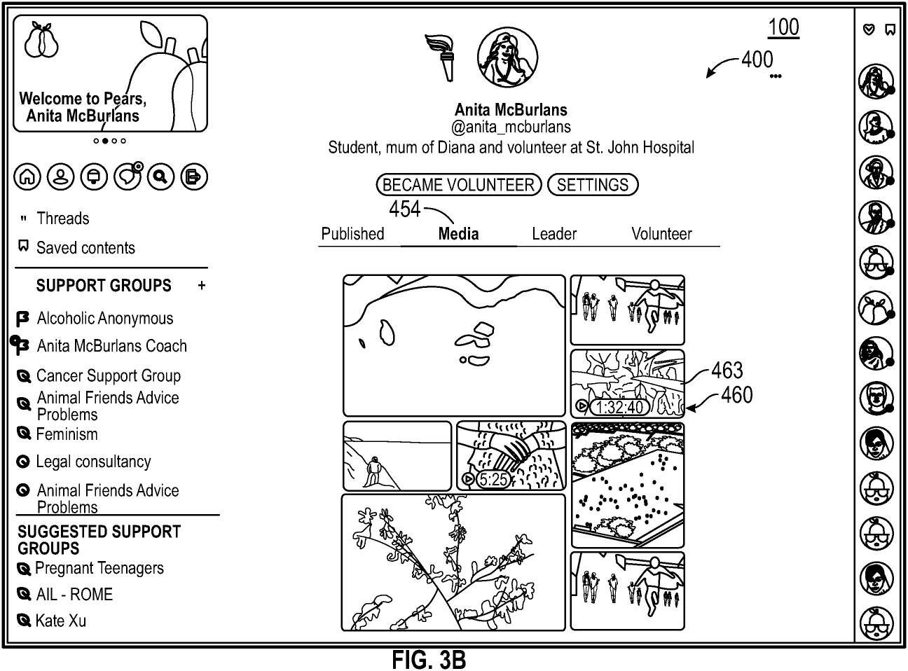

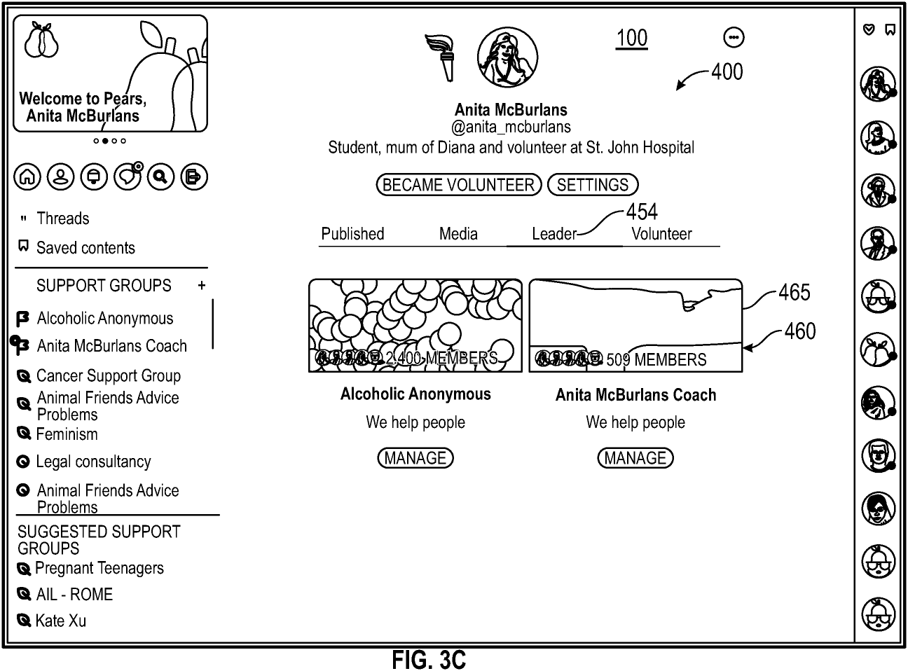

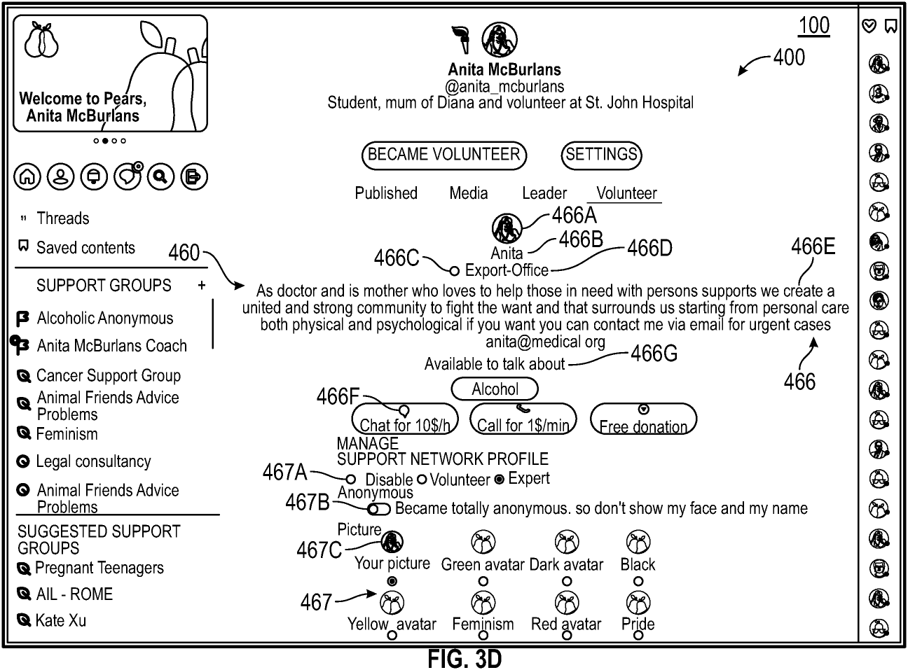

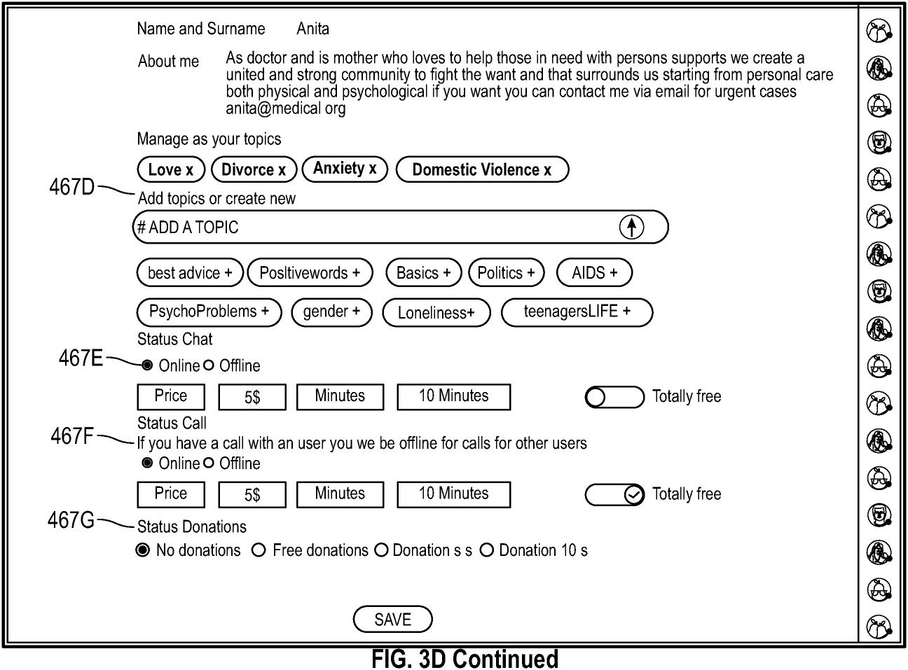

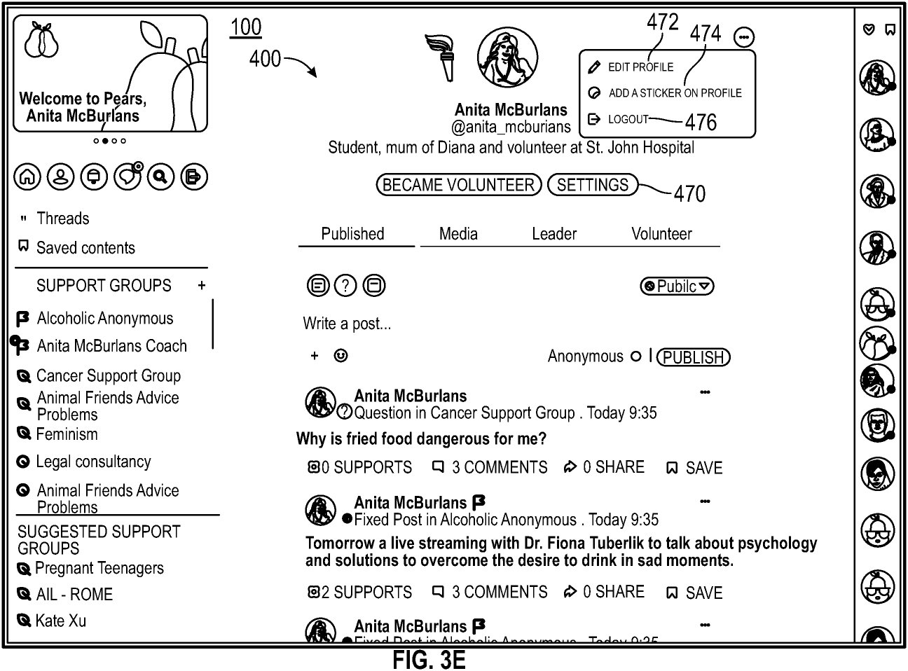

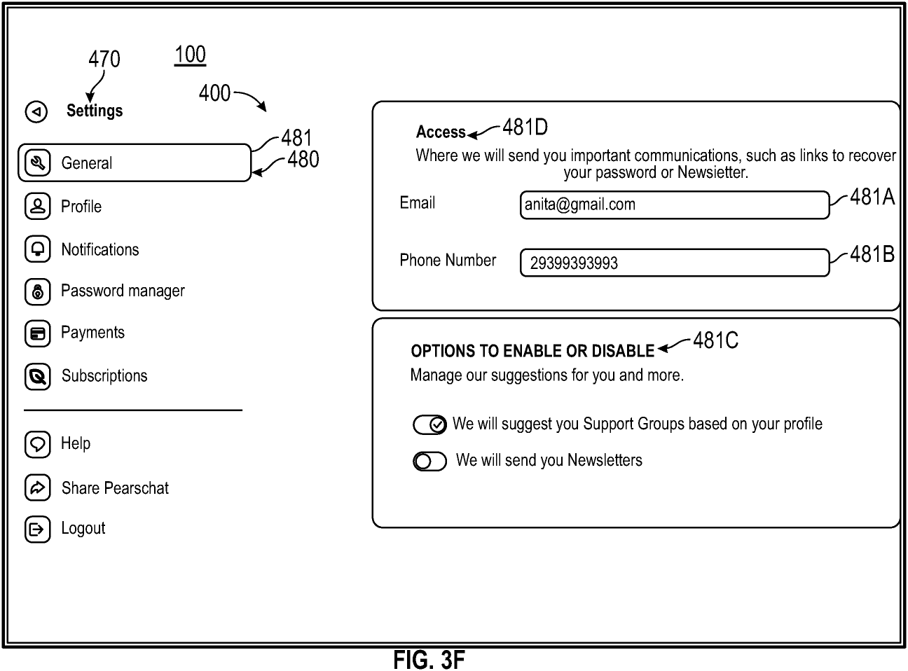

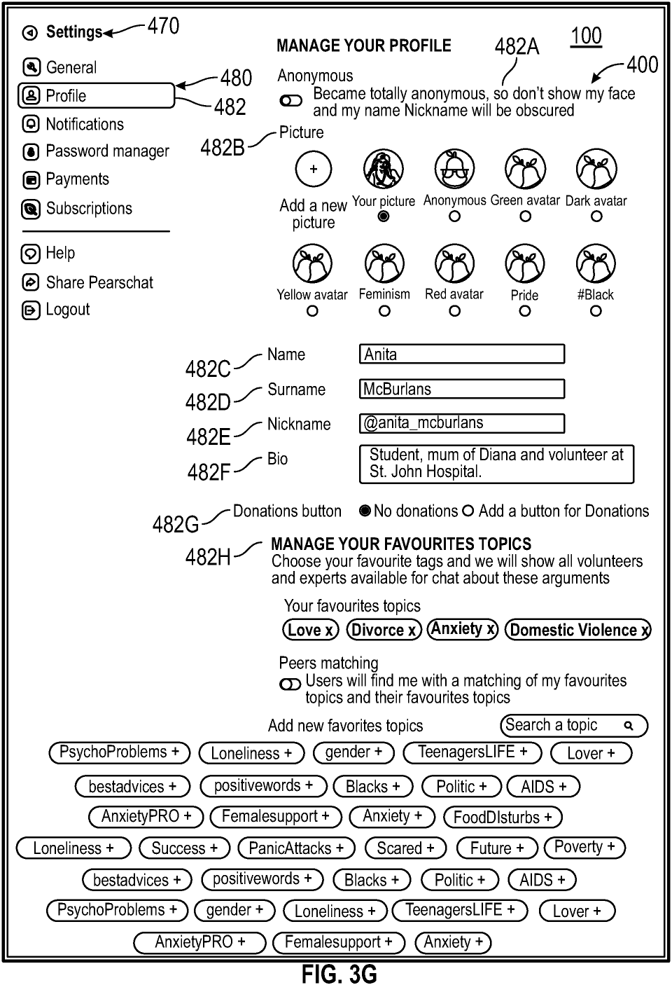

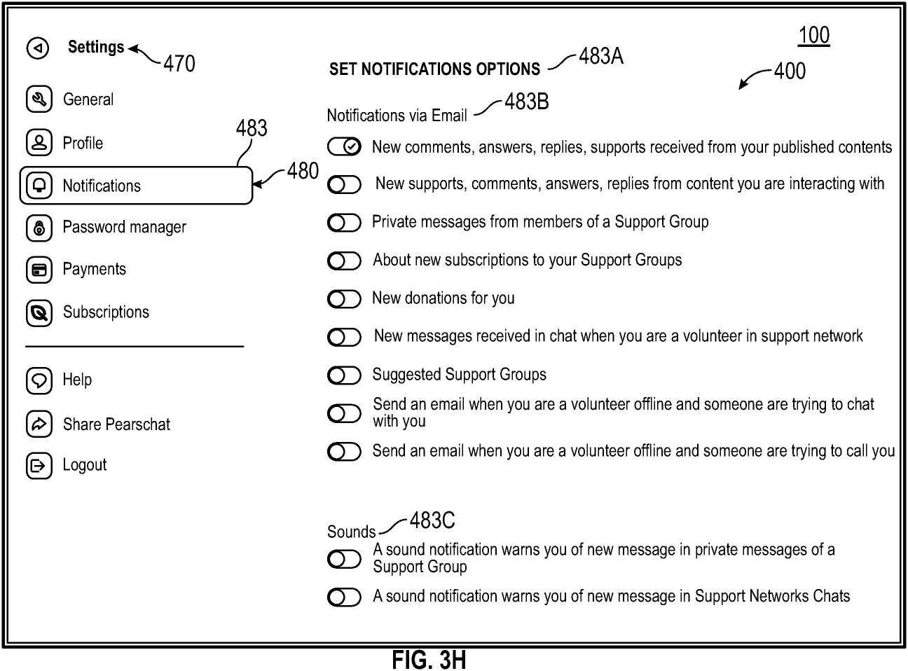

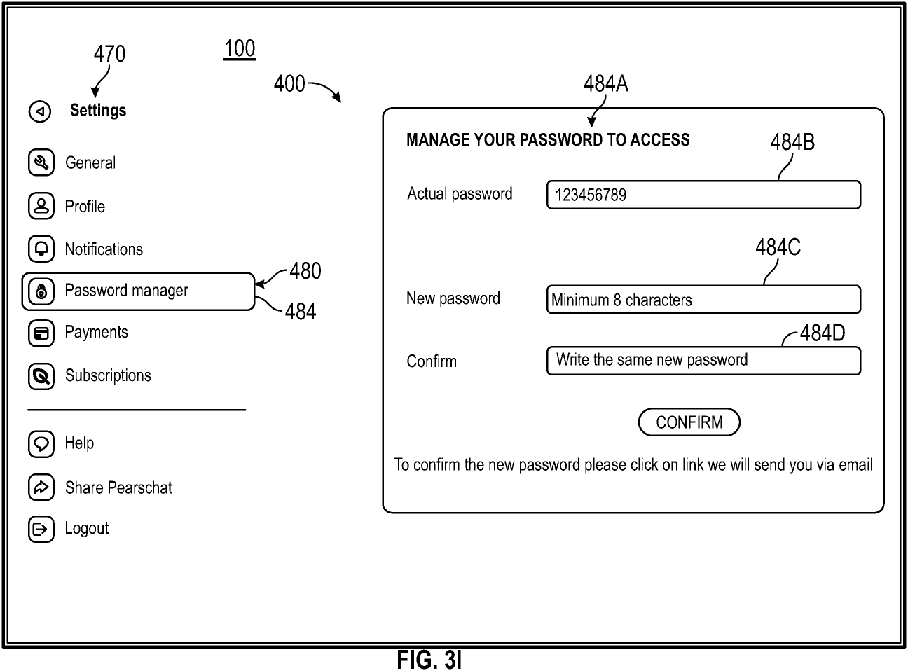

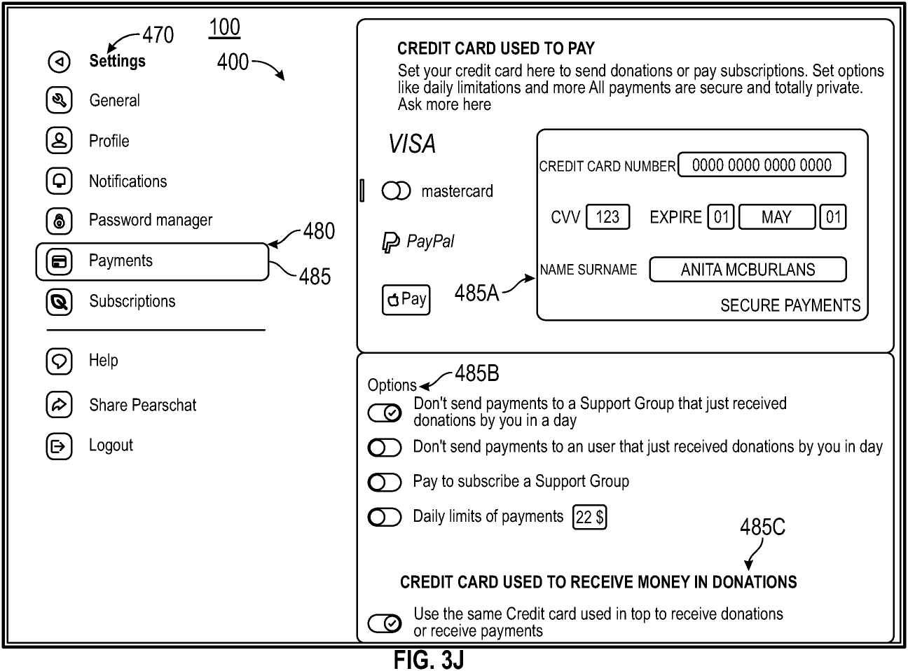

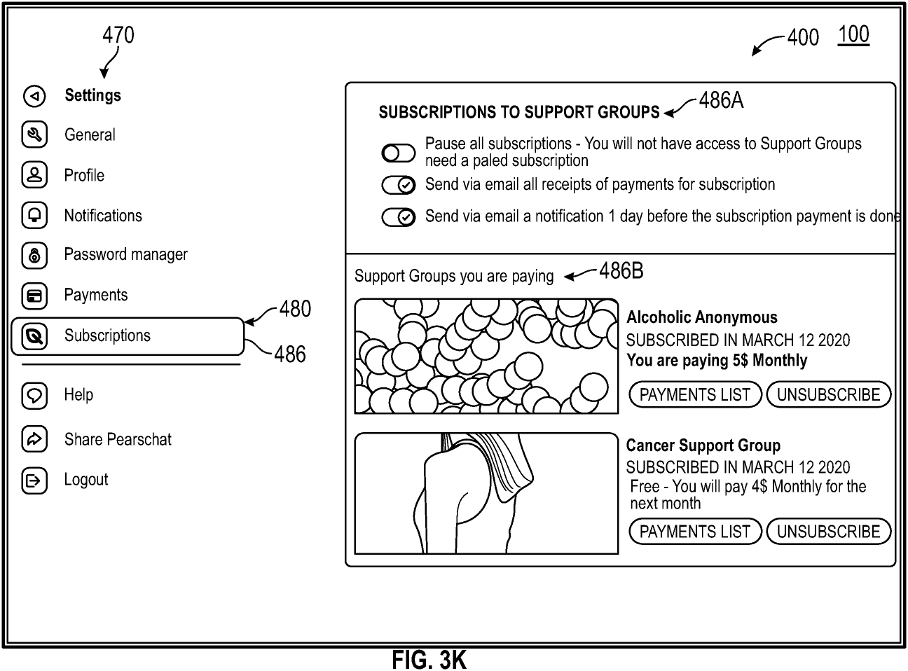

Upon registering to utilize the multiuse communication system 100, the system user 200 can enter a personal user profile. The system user 200, for example, can be presented with a personal profile page 400 as shown in FIGS. 3A-K for enabling the system user 200 to enter the personal user profile via the multiuse communication system 100. Turning to FIG. 3A, for example, the personal profile page 400 permit the system user 200 to enter a user image 412, a user name 414, user contact information 416, user demographic information 418 and/or other personal user profile information of the system user 200.

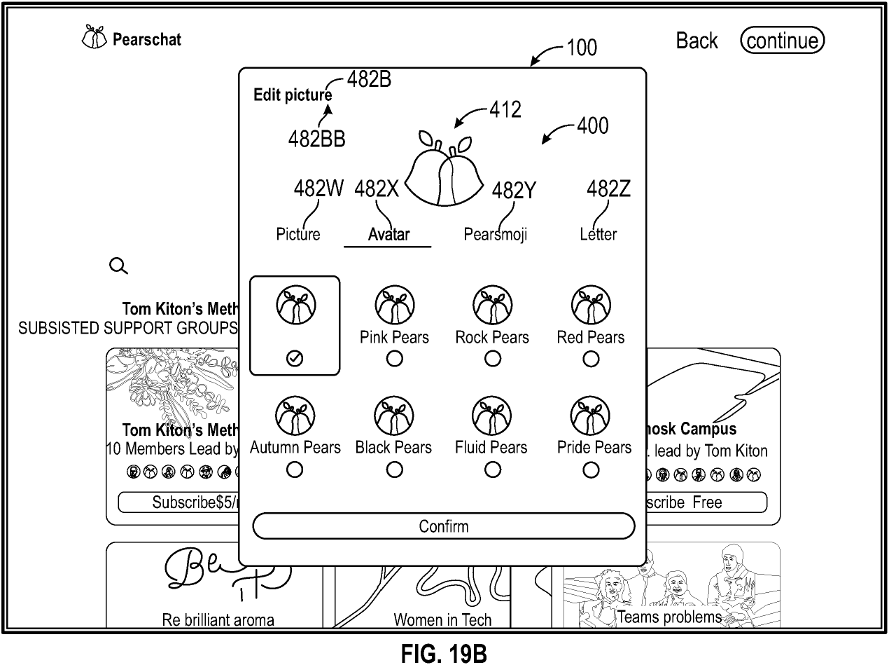

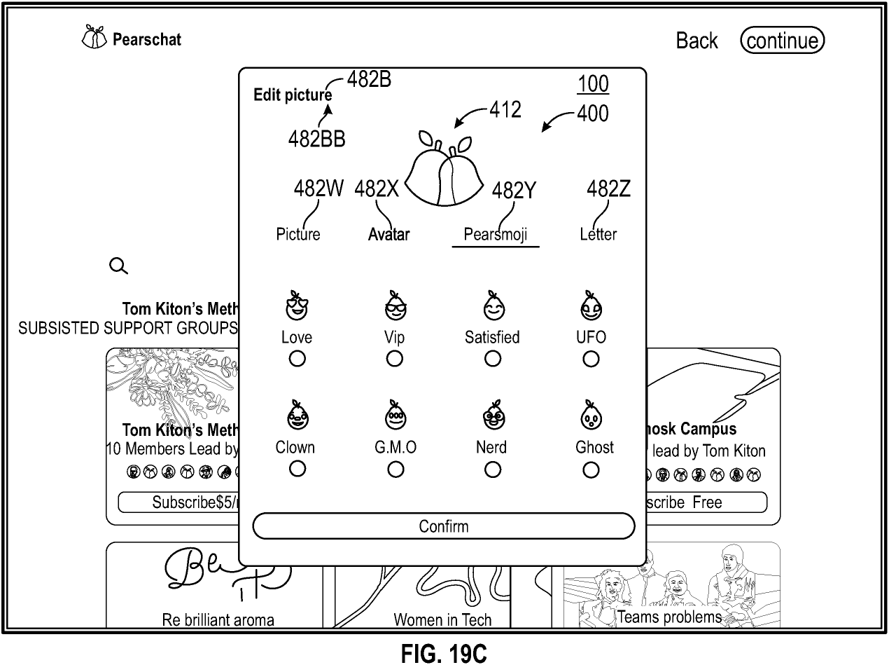

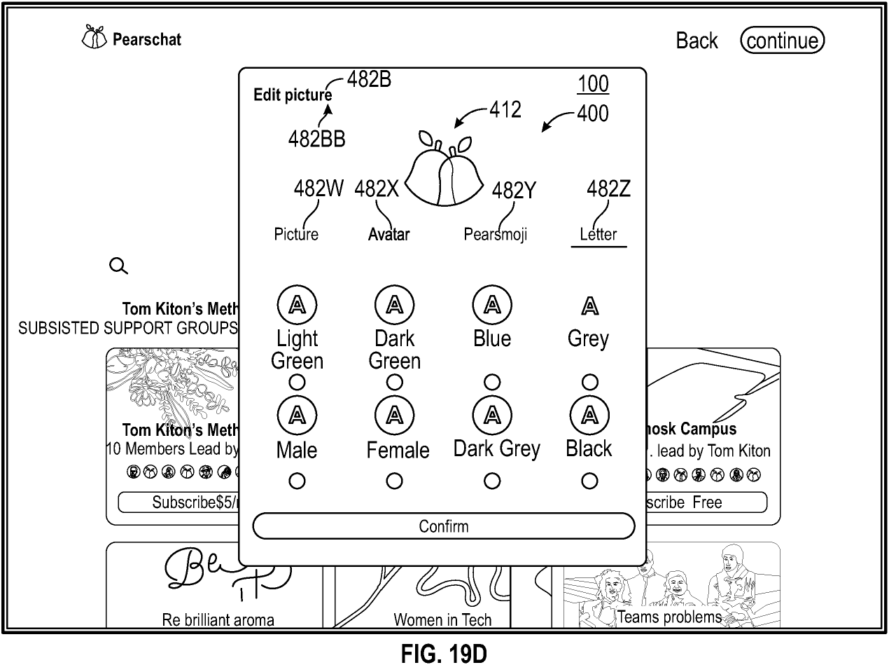

Exemplary images 412 for representing the system user 200 can include one or more photographs or other pictures, one or more avatars, one or more character (such as symbols, letters and/or numbers), and/or emojis, without limitation. In selected embodiments, the character can comprise a character in English or any other language, such as a character in traditional Chinese and/or simplified Chinese. As illustrated in FIGS. 19A-D, the personal profile page 400 permit the system user 200 can include an optional user image data editing page 482BB for enabling the system user 200 to select at least one user image 412 to be associated with the personal profile page 400 and/or to edit the user image 412 previously associated with the personal profile page 400. The user image data editing page 482BB is shown as permitting the system user 200 to edit the user image 412 by selecting a picture 482W, an avatar 482X, an emoji (or a Pearemoji) 482Y and/or a letter (or other character) 482Z in English or any other language.

If the system user 200 elects to edit the user image 412 by selecting a picture 482W as illustrated in FIG. 19A, the user image data editing page 482BB can enable the system user 200 to upload one or more user images 412 and/or to select at least one user image 412 that was previously uploaded by the system user 200. The user image data editing page 482BB optionally can include at least one user image 412 for indicating the system user 200 does not wish to provide any personally-identifiable user image 412 or otherwise wishes to remain anonymous. Once the appropriate user image(s) 412 have been selected, the user image data editing page 482BB can prompt the system user 200 to confirm the user image selection. Additionally and/or alternatively, the user image data editing page 482BB can permit the system user 200 to select one or more avatars if the system user 200 elects to edit the user image 412 by selecting an avatar 482X as illustrated in FIG. 19B, to select one or more emojis if the system user 200 elects to edit the user image 412 by selecting an emoji 482Y as shown in FIG. 19C, and/or to select one or more letters if the system user 200 elects to edit the user image 412 by selecting a letter 482Z as illustrated in FIG. 19D.

Returning to FIG. 3A, the personal profile page 400 is shown as including navigation indicia 420, such as tabs, folders and/or icons, for enabling the system user 200 to navigate the personal profile page 400 and other content available via the multiuse communication system 100. Exemplary navigation indicia 420 can include, but is not limited to, a communication threads link 422, a saved content link 424, a subscribed support group link 426 and/or a suggested support group link 428.

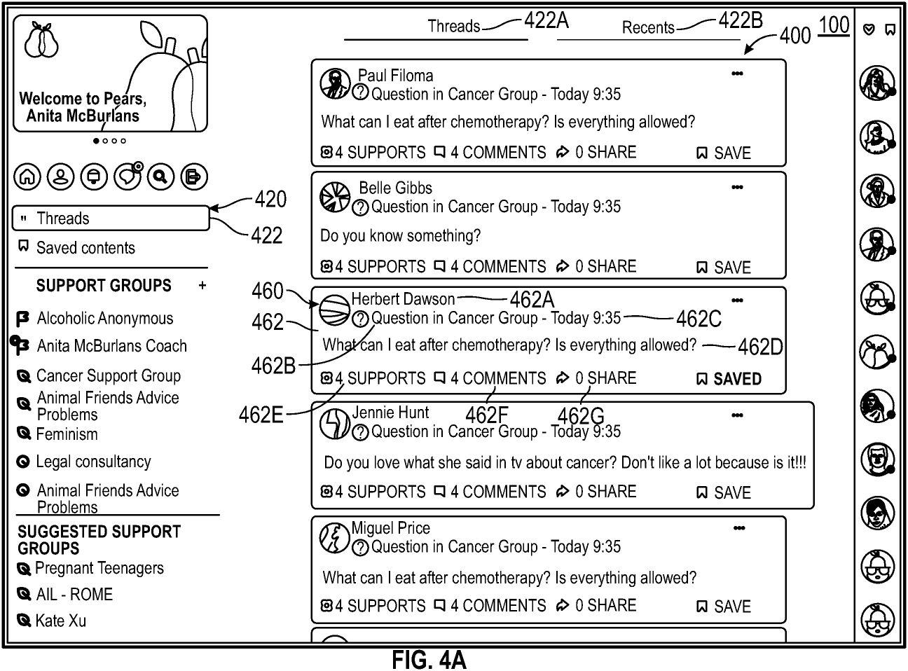

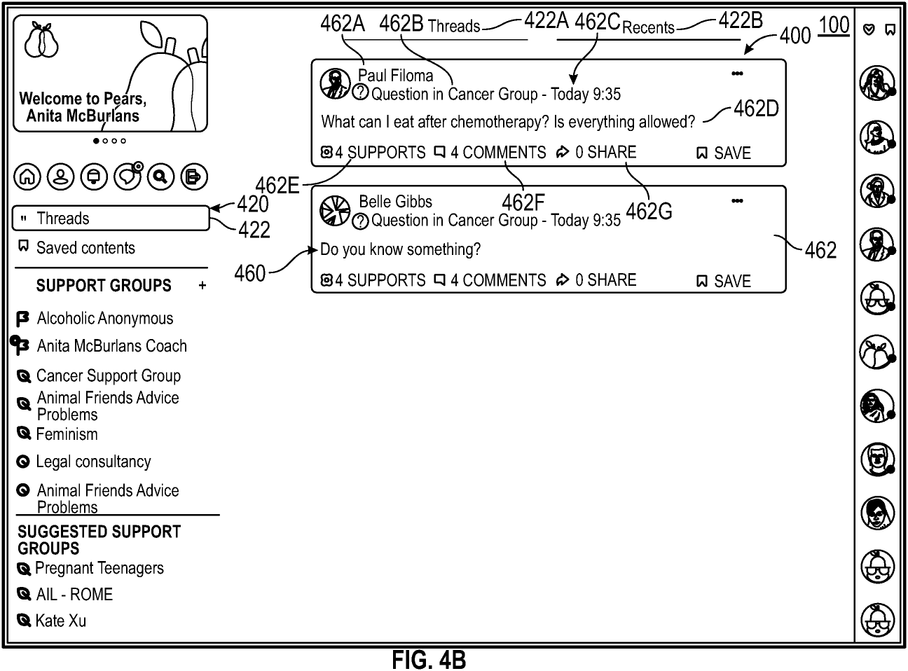

Turning briefly to FIGS. 4A-B, activation of the communication threads link 422 from the personal profile page 400 can enable the system user 200 to view or otherwise access one or more communication threads 462 available via the multiuse communication system 100. The personal profile page 400 can present the available communication threads 462 in any conventional manner. As shown in FIG. 4A, for example, each communication thread 462 can include an author name 462A, a relevant group 462B associated with the communication thread 462, a post date and/or time 462C that the communication thread 462 was posted and/or text or other content 462D of the communication thread 462. Each communication thread 462 optionally can enable system users 200 to support the communication thread 462, at 462E, comment on the communication thread 462, at 462F and/or share the communication thread 462, at 462G.

Additionally and/or alternatively, the personal profile page 400 can sort the available communication threads 462. The personal profile page 400 can sort the available communication threads 462, for example, by the post date and/or time 462C that the communication thread 462 was posted. As shown in FIG. 4A, the personal profile page 400 advantageously can include threads indicia 422A for presenting all of the available communication threads 462.

In selected embodiments, the personal profile page 400 can include recent threads indicia for presenting a subset of the available communication threads 462 that were posted within a predetermined range of post dates and/or times 462C in the manner illustrated in FIG. 4B. The personal profile page 400 advantageously can enable the system user 210 to change the manner in which the system user 210 interacts with the multiuse communication system 100. The personal profile page 400, for example, can permit the system user 210 to select any user profile of the system user 210 should be used to interact the multiuse communication system 100. Additionally and/or alternatively, the personal profile page 400 can indicate which user profile of the system user 210 has been selected. The personal profile page 400 thereby can enable the system user 200 to which user profile is to be used when publishing material, liking published materials or otherwise interacting with the multiuse communication system 100.

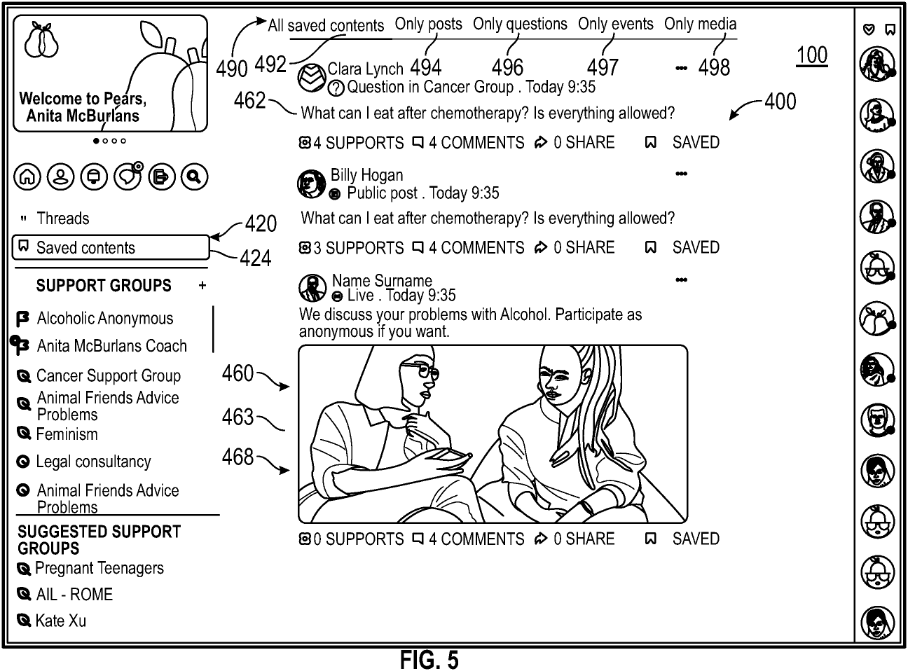

Activation of the saved content link 424 from the personal profile page 400 can enable the system user 200 to view or otherwise access one or more instances of saved content 468 that can be made available via the multiuse communication system 100 as illustrated in FIG. 5. The saved content 468 can include, but is not limited to, textual content, such as communication threads 462 or other messages, and/or image content, such as media items 463. In selected embodiments, saved content 468 can include information related to one or more events. As shown in FIG. 5, the personal profile page 400 can sort the available saved content 468. The personal profile page 400, for example, can present all of the available saved content 468, at 492. In selected embodiments, the personal profile page 400 can present the saved content 468 that is associated with posts 494, questions 496, events 497 and/or media 498.

Returning to FIG. 3A, the subscribed support group link 426 can provide access to one or more support groups available via the multiuse communication system 100 to which the system user 200 has subscribed; whereas, the suggested support group link 428 can provide access to one or more available support groups that the multiuse communication system 100 suggests might interest or otherwise be relevant to the system user 200. In selected embodiments, the multiuse communication system 100 can suggest at least one suggested support group link 428 based upon the personal user profile of the system user 200.

The personal profile page 400 optionally can enable the system user 200 to connect, at 430, with one or more other system users 200. The other system users 200 can include, but are not limited to, the second system users 220, such as peer users 222, volunteer users 224 and/or coach users 226 (collectively shown in FIG. 1B). Additionally and/or alternatively, the personal profile page 400, at 440, can enable the system user 200 to becomes a volunteer user 224 for assisting other system users 200.

In selected embodiments, the personal profile page 400 can permit the system user 200 to access communication threads and other content 460 available via the multiuse communication system 100. The communication threads and other available content 460 advantageously can be sorted into one or more selected content categories 450. As shown in FIG. 3A, exemplary content categories 450 can include a published content category 452, a media content category 454, a leader content category 456 and/or a volunteer content category 458. The personal profile page 400 within the published content category 452, for example, can enable the system user 200 to input personal messages, access communication threads 461 and/or communicate with one or more other system users 200. The personal messages and other content can be entered anonymously, at 464, and/or be designated for publication to other system users 200.

The content 460 available within the media content category 454 can include one or more media items 463 as shown in FIG. 3B. The media items 463 can include any suitable type of media content, such as photographs and/or videos, without limitation. Turning to FIG. 3C, the content 460 available within the leader content category 456 can include indicia 465, such as a group name and/or group purpose statement, related to one or more groups lead by the system user 200. Exemplary groups can include one or more support groups associated with the subscribed support group link 426 and/or the suggested support group link 428 (collectively shown in FIG. 3A). The personal profile page 400 can enable the system user 200 to identify and/or manage each group via the indicia 465.

As shown in FIG. 3D, the content available via the volunteer content category 458 of the personal profile page 400 can include a profile preview 466. The profile preview 466 can include an image 466A, a name 466B, a proficiency status 466C, an availability status 466D, contact information 466G, demographic information 466E, fee information 466F and/or other system user profile information of the system user 200. In selected embodiments, the personal profile page 400 can enable the system user 200 to manage, at 467, the system user profile information. FIG. 3D, for example, shows that the personal profile page 400 can enable the system user 200 to manage support network profile information 467A, anonymity protection 467B, image, name and other demographic information 467C, topical information 467D, chat status information 467E, call status information 467F, fee information 467G, without limitation.

The personal profile page 400 is illustrated in FIG. 3E as including an optional settings indica 470. The optional settings indica 470 can permit the system user 200 to edit, at 472, the personal user profile or other information available on the personal profile page 400. As shown in FIG. 3B, the optional settings indica 470 can enable the system user 200 to add a sticker to the personal user profile, at 474, and/or to log out of the multiuse communication system 100, at 476.

Turning to FIG. 3F, the personal profile page 400 can include a plurality of settings options 480 for enabling the system user 200 view and/or manage selected user profile information. The settings options 480 can include, for example, a general settings options 481 for enabling the system user 200 to set user access information 481D for important communications, such as recovering a user password and/or receiving a system newsletter. The user access information 481D can include an email address 481A, a telephone number 481B, and/or other user access information. Additionally and/or alternatively, the general settings options 481 can include enabling/disabling options 481C for enabling and/or disabling selected system communications. As shown in FIG. 3F, the enabling/disabling options 481C can include options to enable or disable group suggestions and/or to enable or disable the system newsletter. The group suggestions, for example, can be provided by one or more support groups associated with the subscribed support group link 426 and/or the suggested support group link 428 (collectively shown in FIG. 3A).

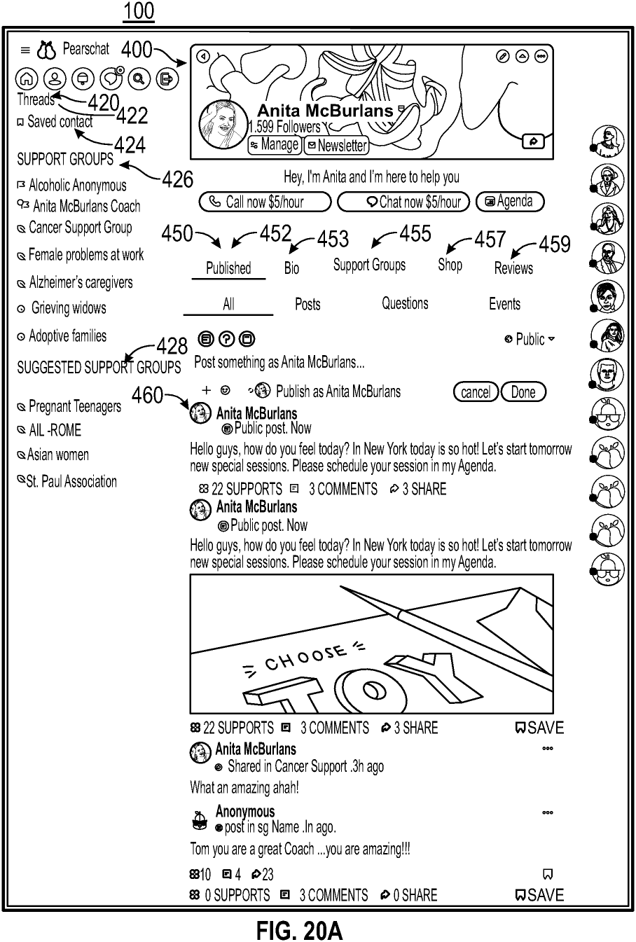

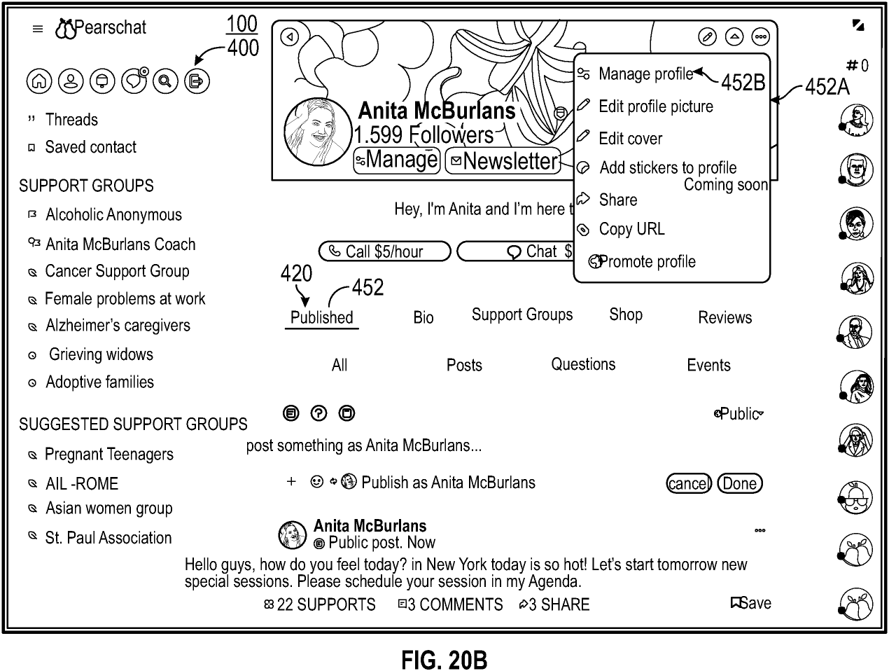

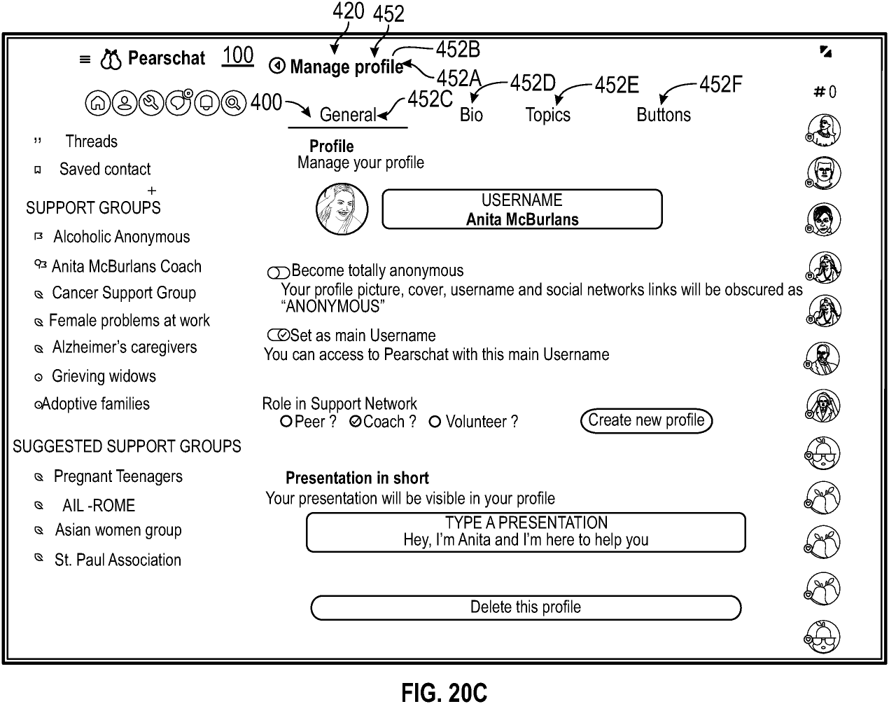

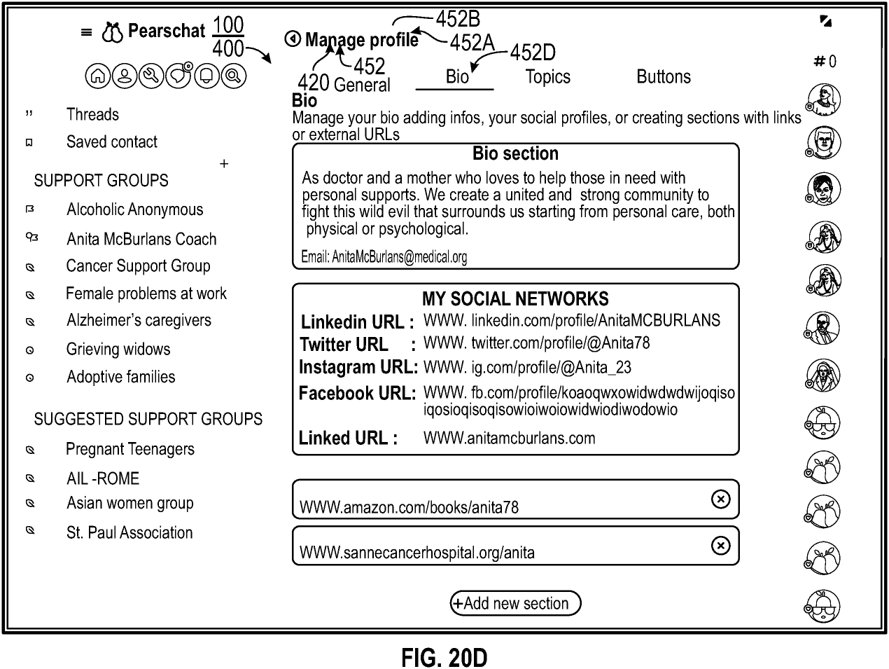

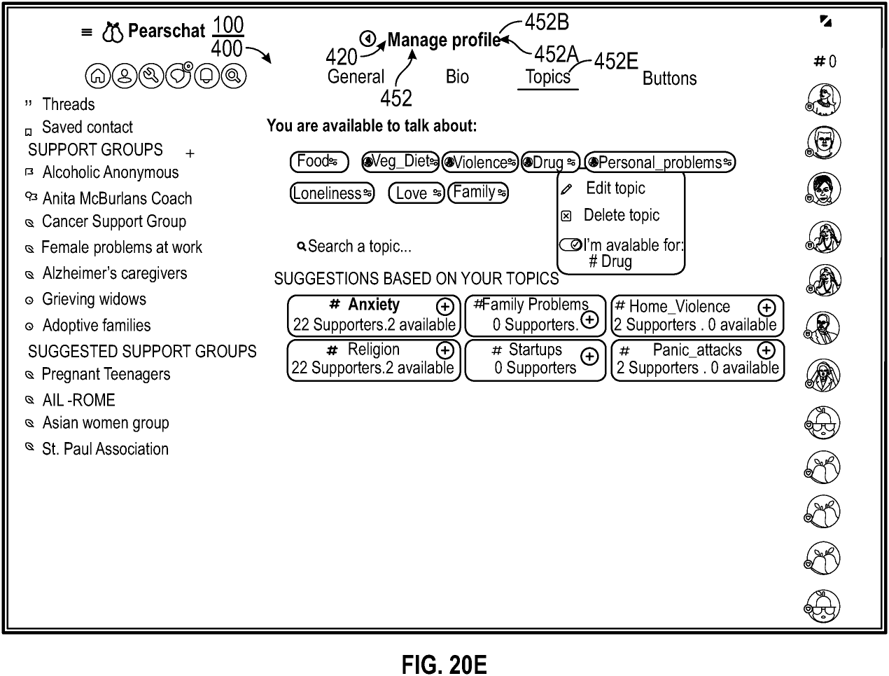

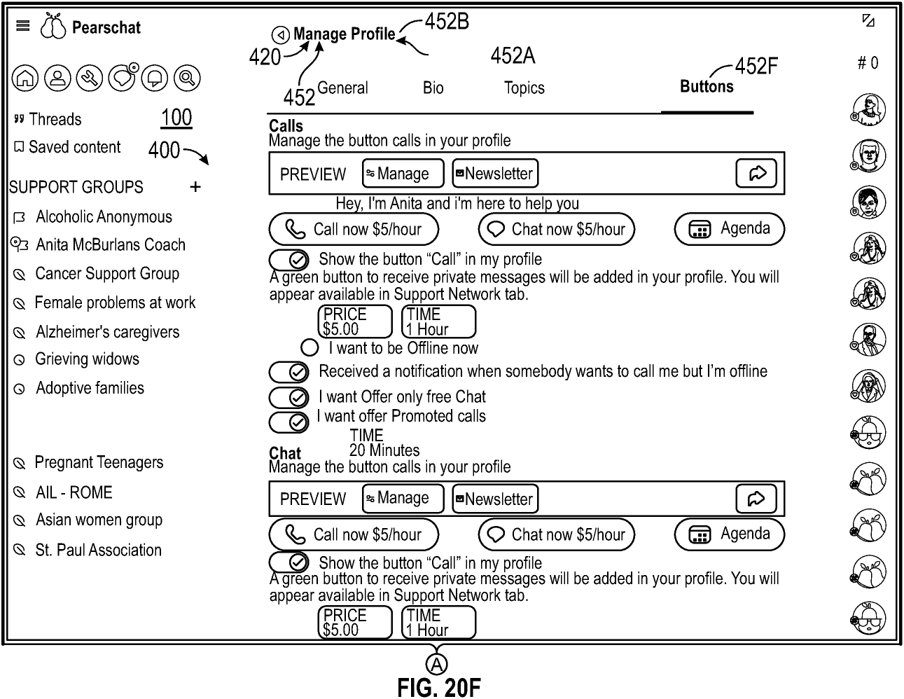

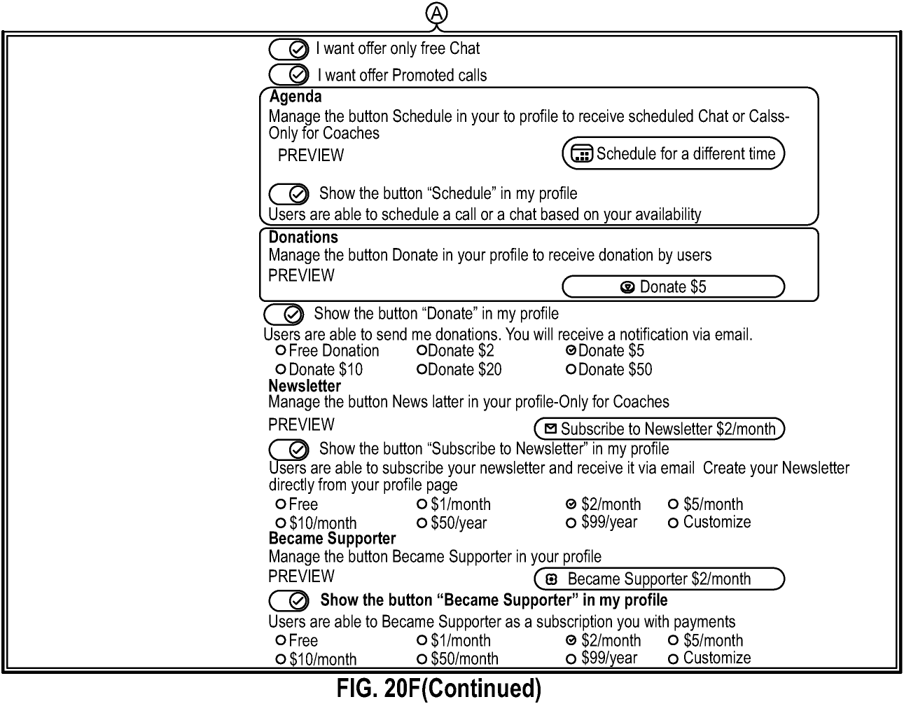

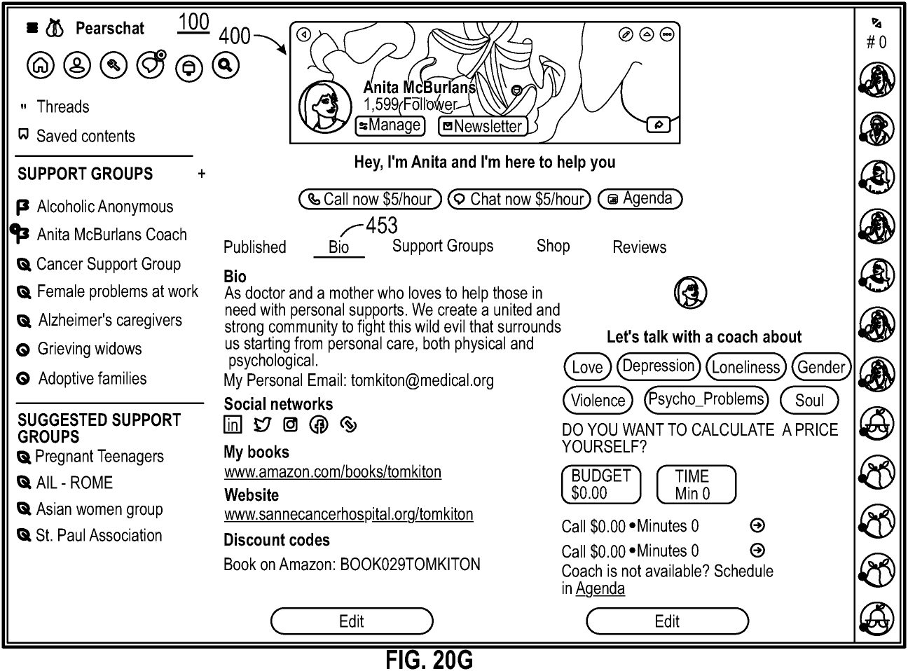

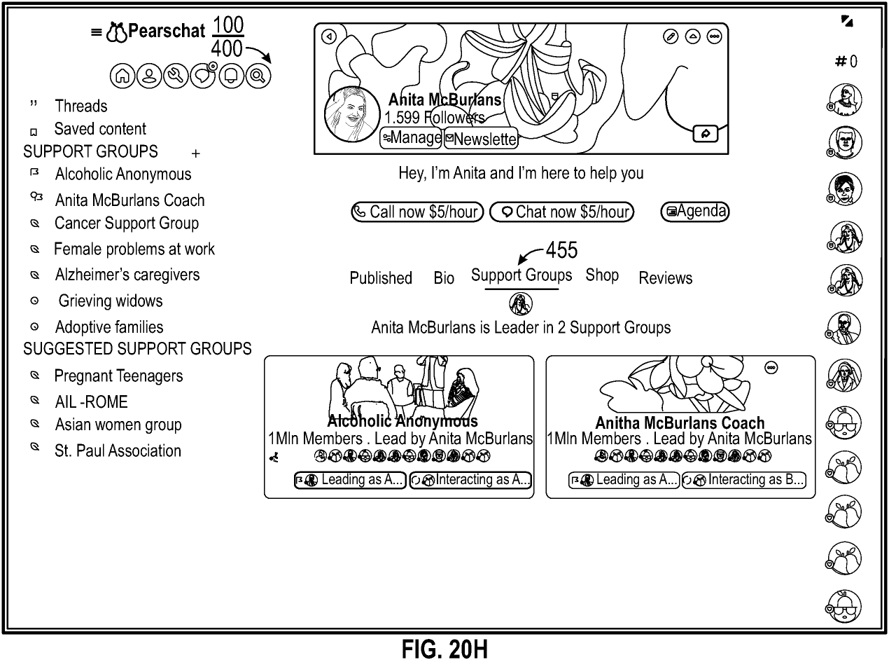

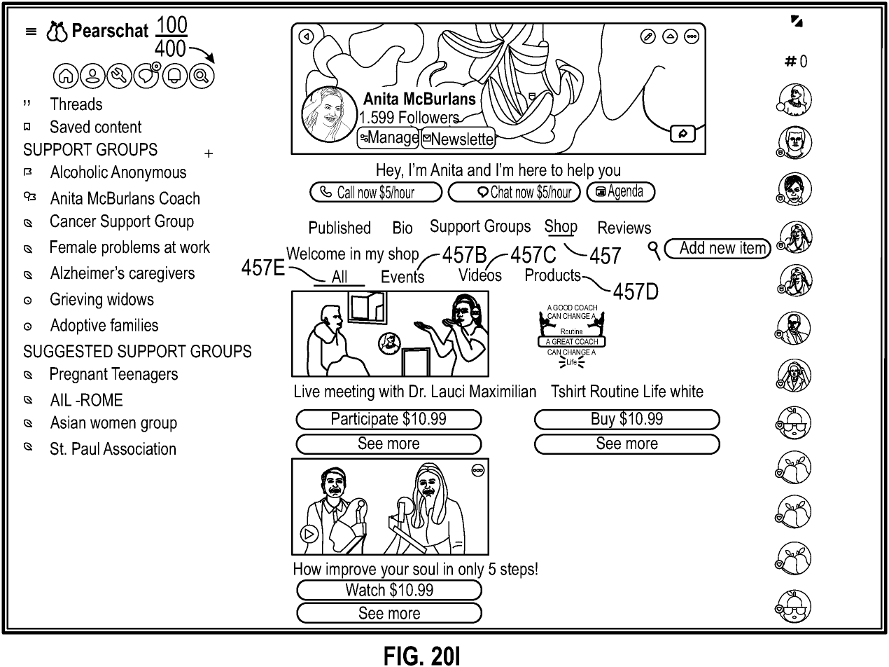

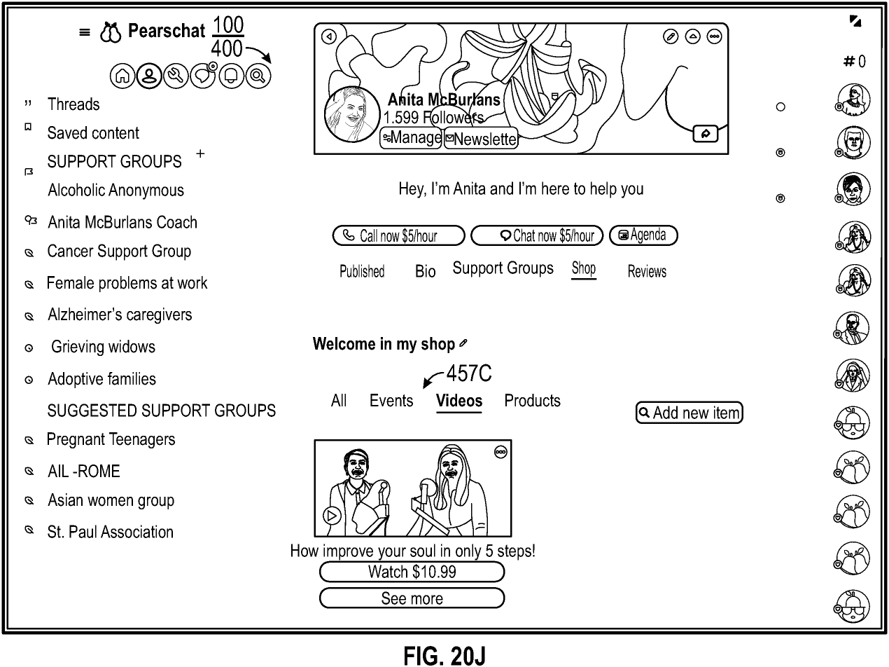

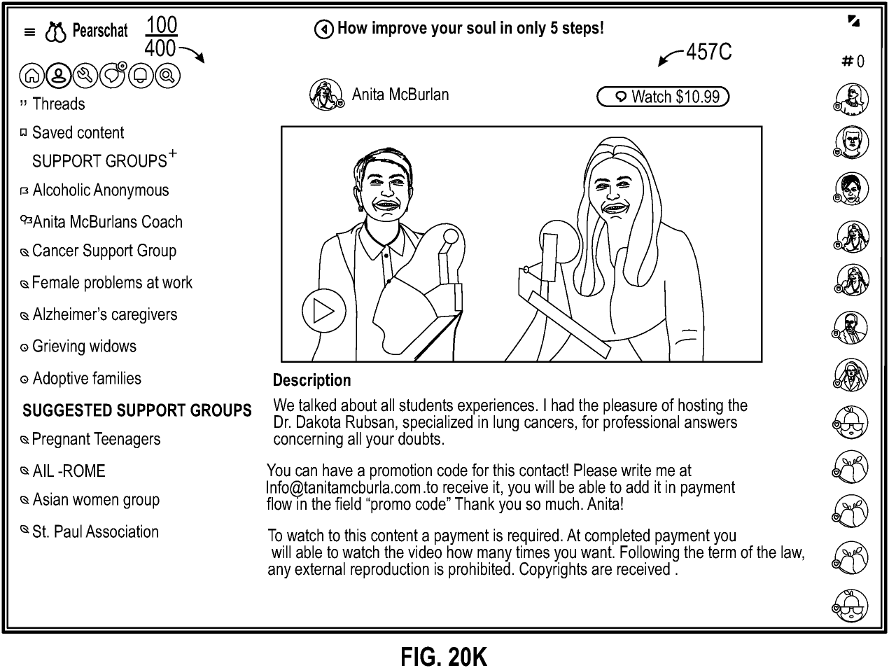

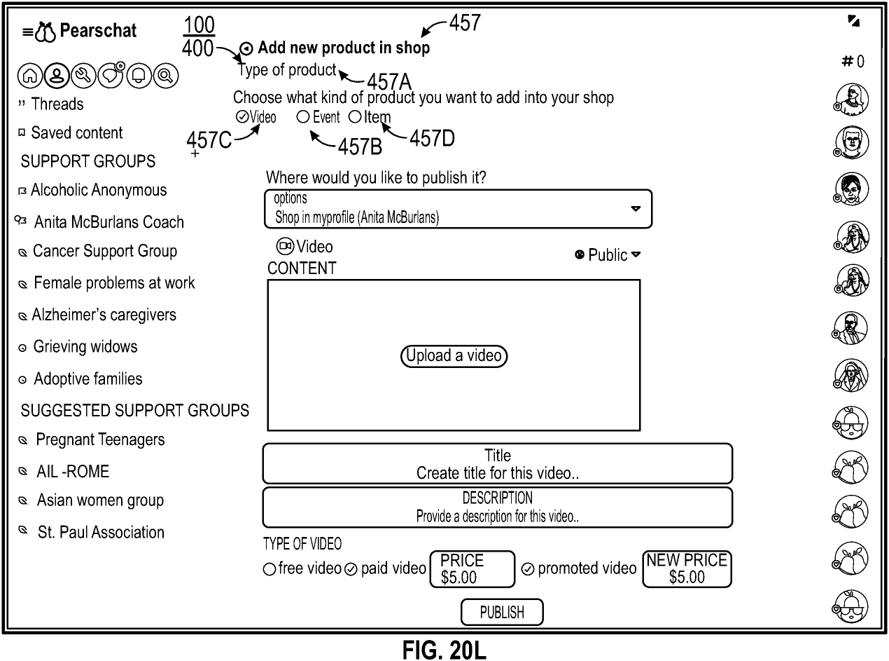

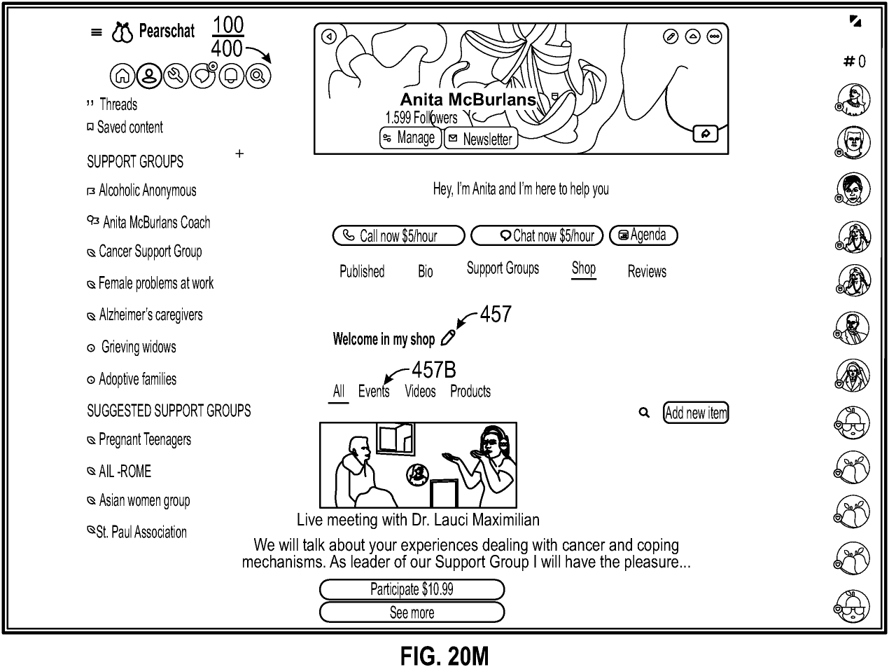

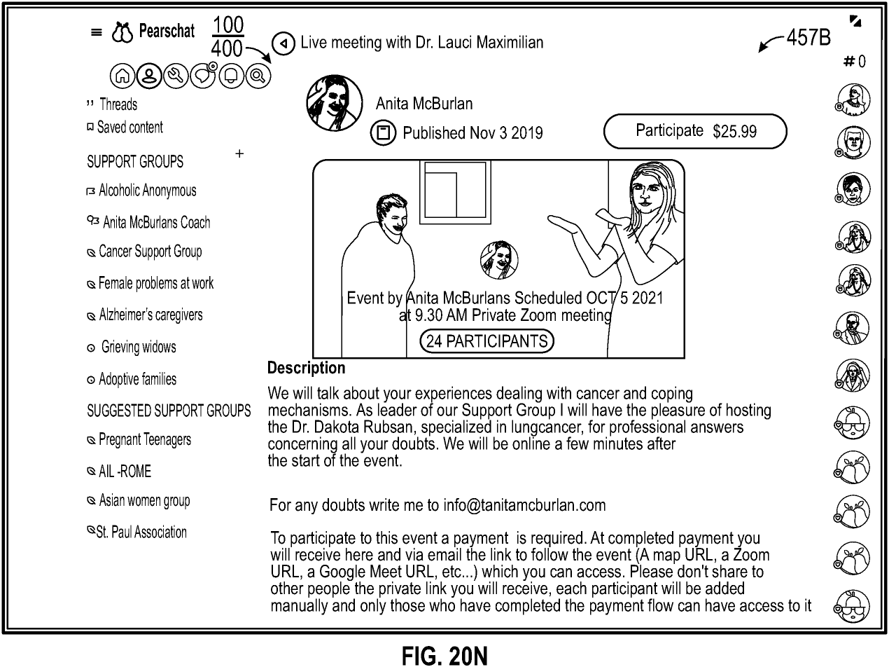

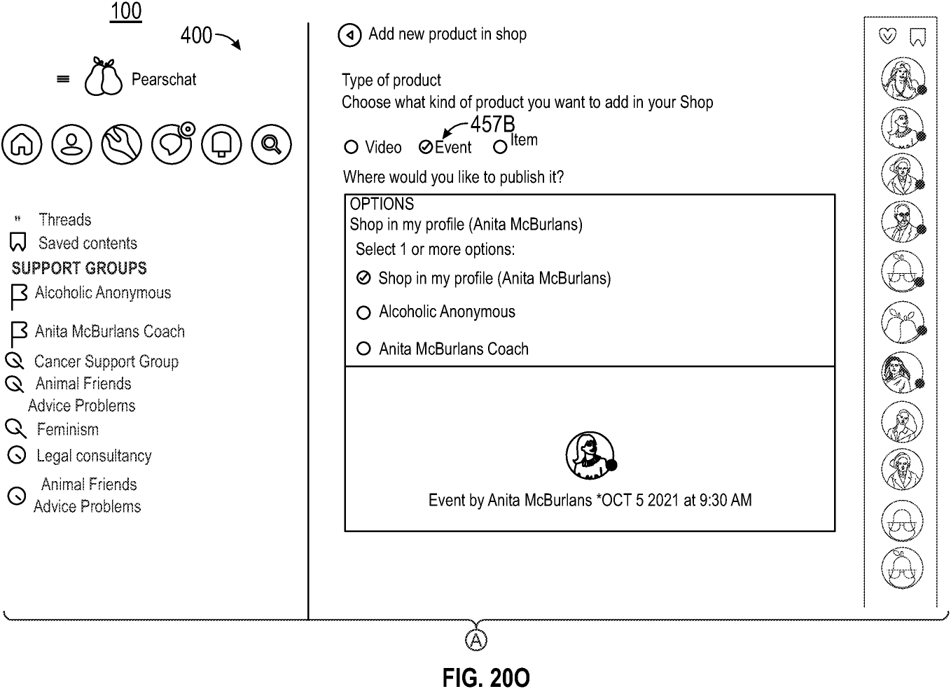

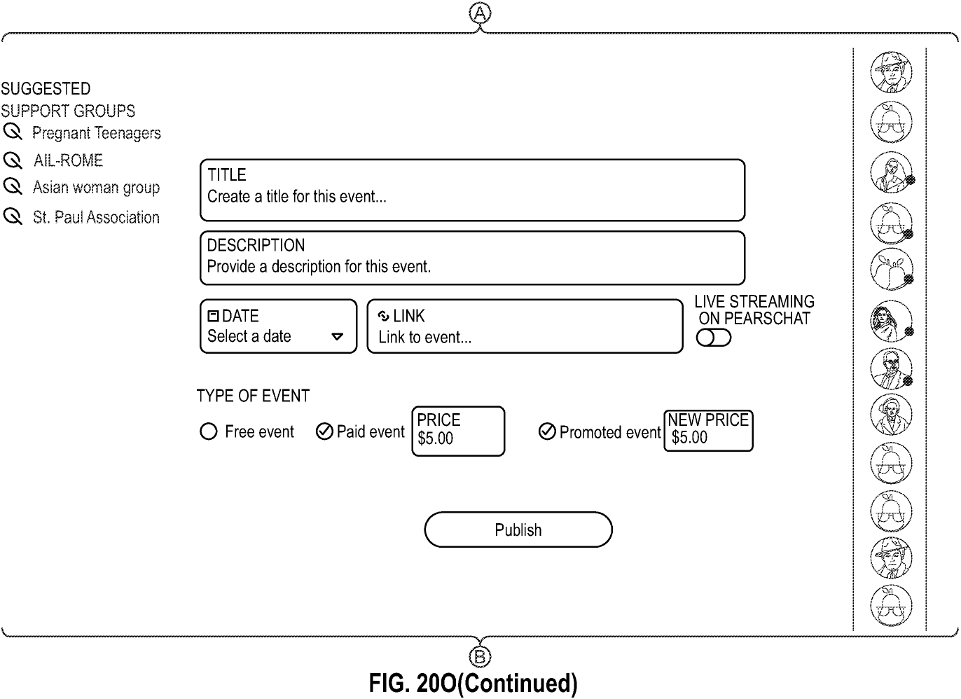

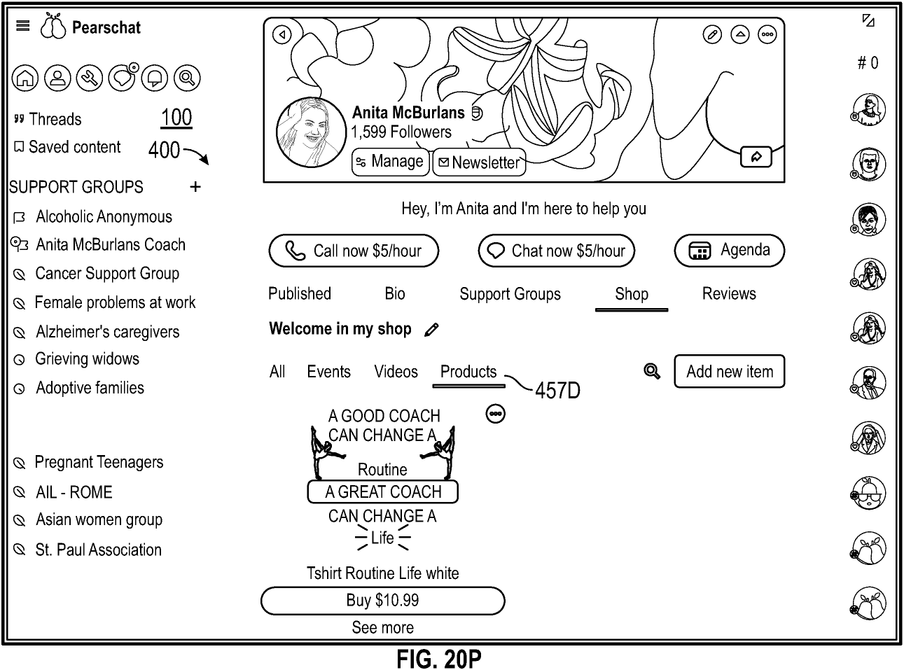

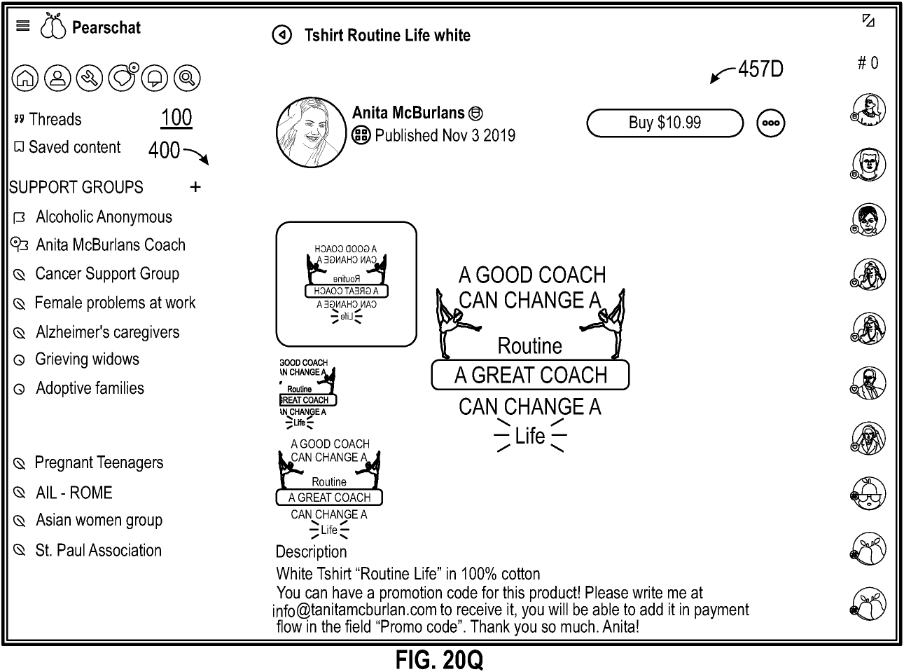

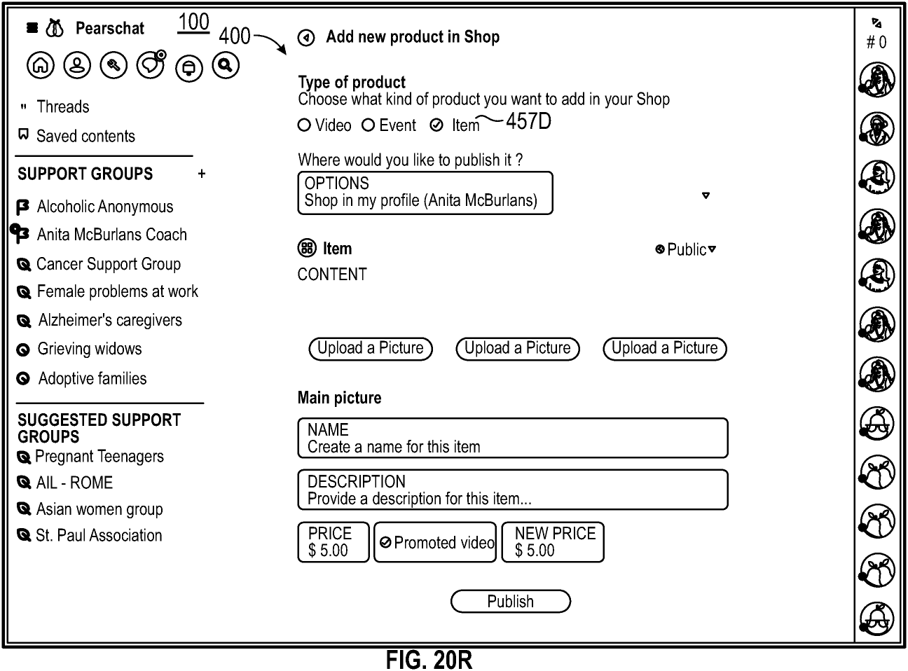

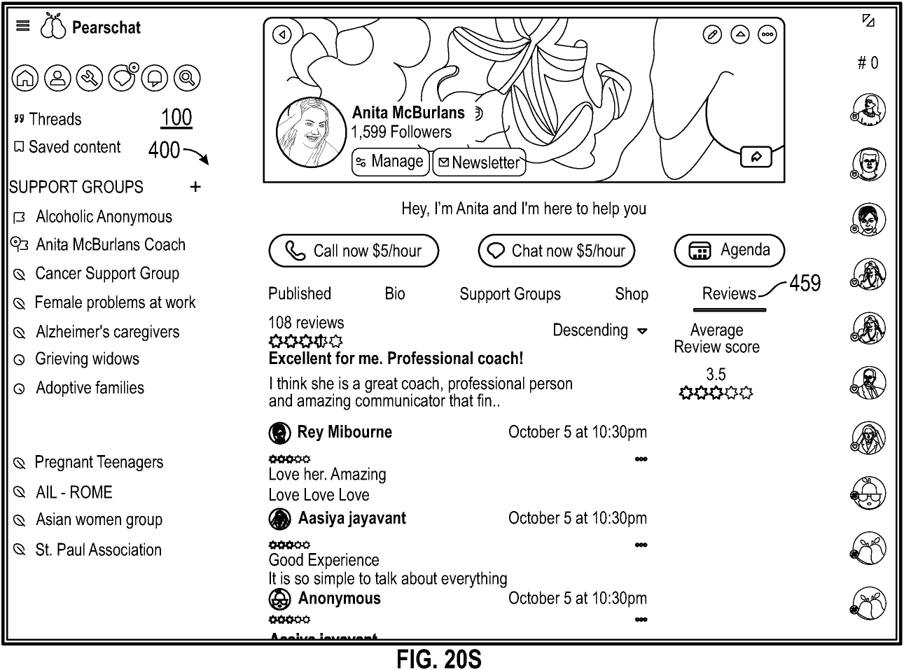

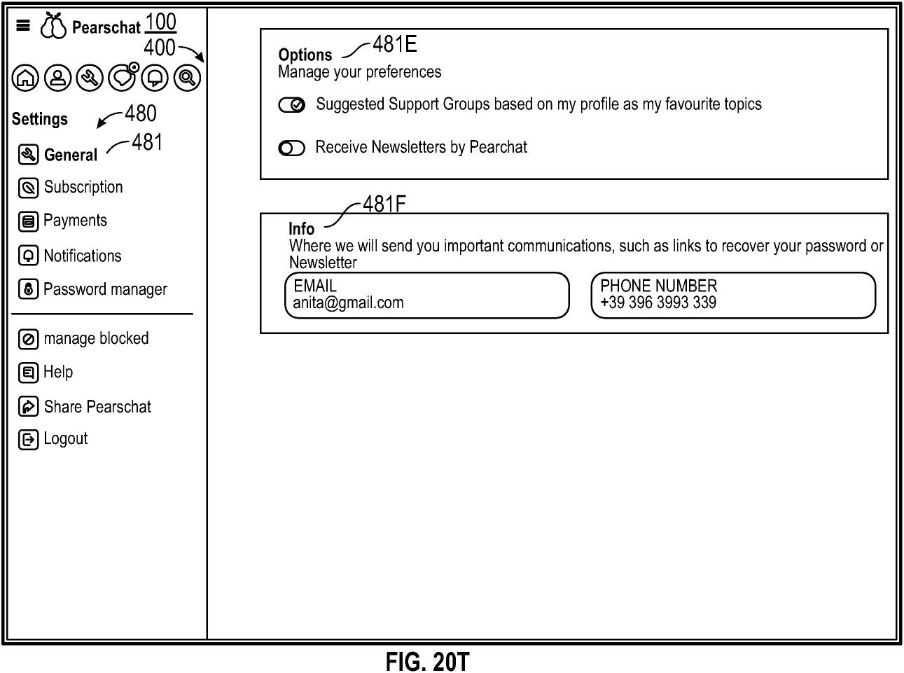

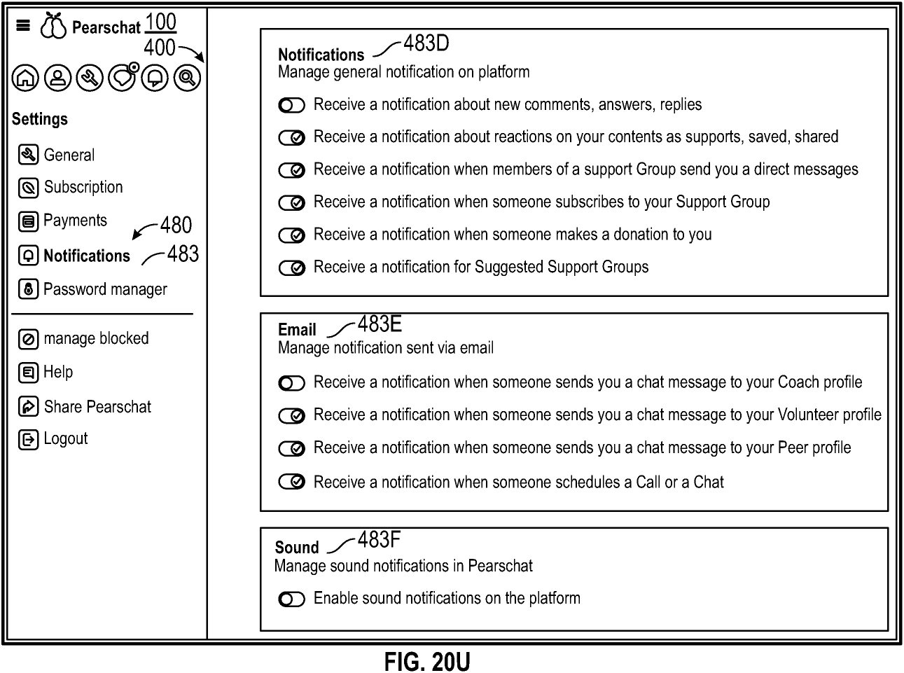

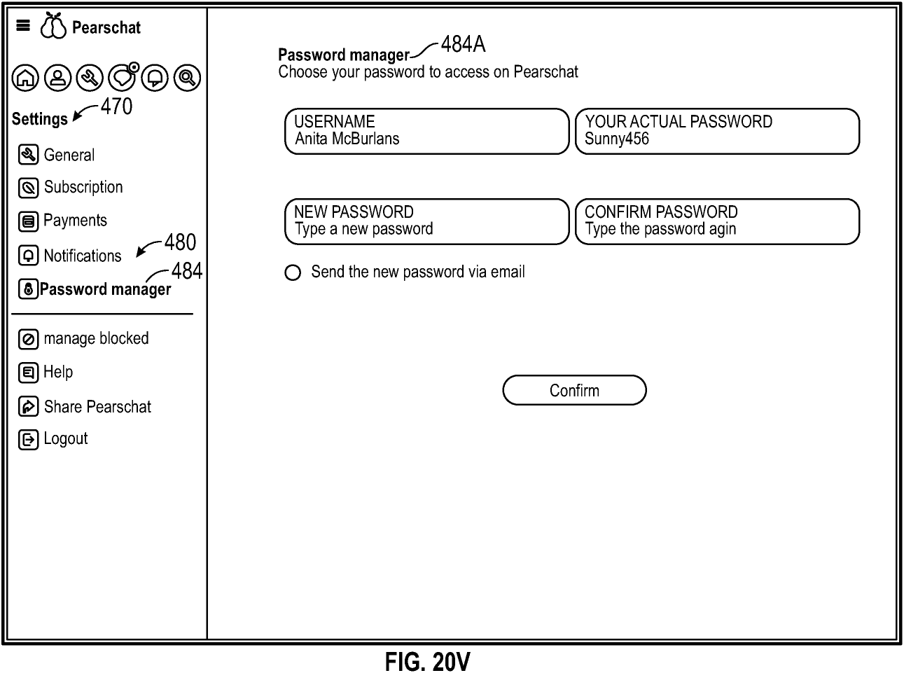

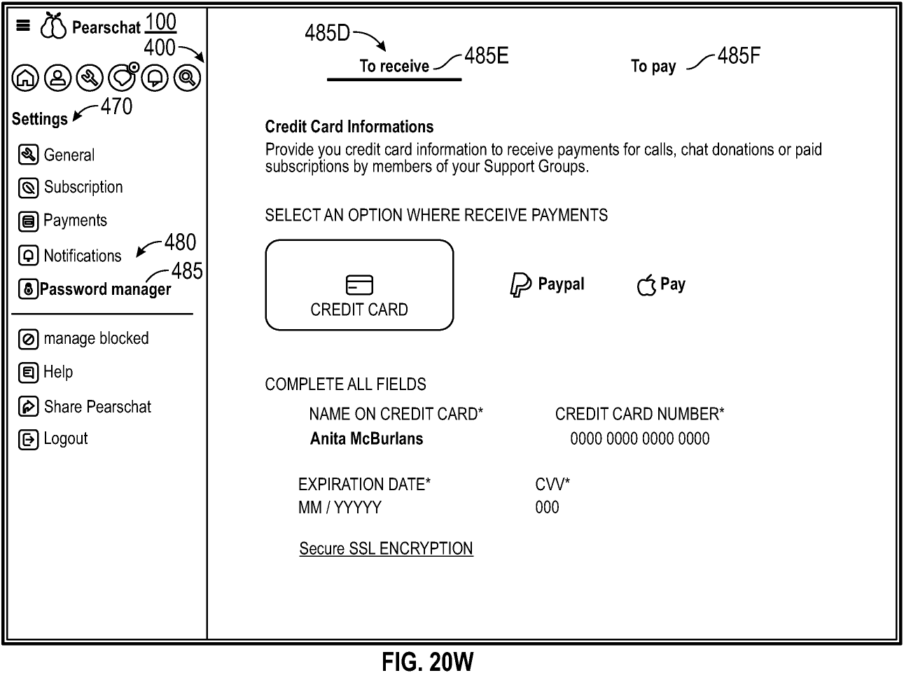

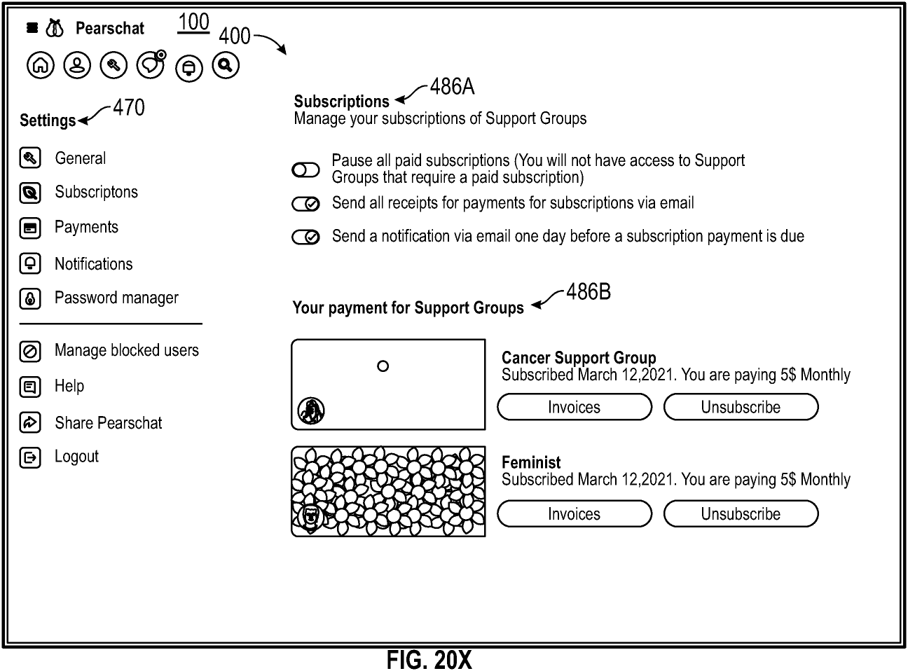

An alternative embodiment of the general settings options 481 is illustrated in FIG. 20T. Turning to FIG. 20T, the general settings options 481 are shown as including managing one or more options 481E for managing one or more preferences of the system user 200. Exemplary preference options 481E can include, but are not limited to, suggested support groups and/or receiving newsletters. The general settings options 481 of FIG. 20T is shown as including an optional option to managing contact information 481F to which communications can be sent to the system user 200. The contact information 481F, for example, can include an email address and/or a telephone number, without limitation.

The personal profile page 400 can enable the system user 200 to manage the user profile, at 482, as shown in FIG. 3G. FIG. 3G shows that the personal profile page 400 can enable the system user 200 to manage selected user profile information. The selected user profile information can include, but is not limited to, anonymity protection 482A, user image data 482B, a user first name 482C, a user last name 482D, a user nickname 482E, biographical, narrative and/or other demographic information 482F and/or donation information 482G. Depending upon a setting of the anonymity protection 482A, selected user profile information, such as the user image data 482B, the user first name 482C, the user last name 482D, the user nickname 482E and/or the biographical or other demographic information 482F can be made available to other system users 200. The personal profile page 400 optionally can enable the system user 200 to manage favorite user topics of the system user 200 and/or to permit the multiuse communication system 100 to match the favorite user topics of the system user 200 with the favorite user topics of one or more other system users 200.

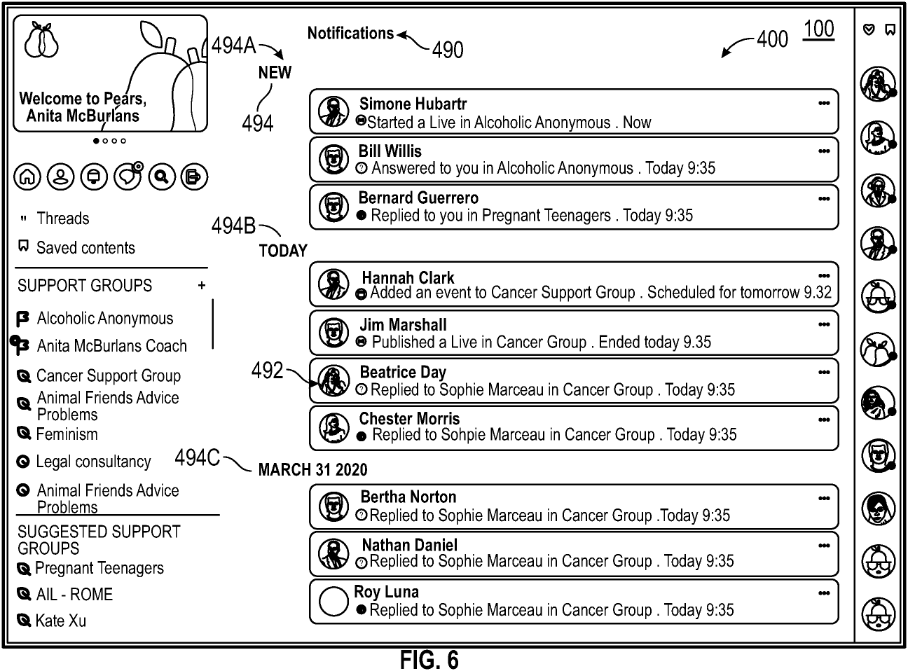

Turning to FIG. 3H, the settings options 480 optionally can include notification settings options 483 for enabling the system user 200 to select a type, format and other features of user notifications 492 (shown in FIG. 6) that should be presented to the system user 200. The notification settings options 483 present the system user 200 with a predetermined number of set notification options 483A. Exemplary notification settings options 483 can include one or more types of notifications to be sent to the system user 200 via email, at 483B, and/or one or more sound notifications 483C for warning the system 200 about new messages and other preselected events, without limitation.

An alternative embodiment of the notification settings options 483 is illustrated in FIG. 20U. Turning to FIG. 20U, the notification settings options 483 are shown as including one or more options 483D for managing one or more preferences of the system user 200 for general notifications provided via the multiuse communication system 100. The general notifications options can include, but are not limited to an option for receiving a notification about new comments, answers and/or replies, an option for receiving a notification about reactions of other system users 200 to contact provided by the system user 200, an option for receiving a notification when a direct message is sent by another member of a selected support group, an option for receiving a notification when another system user 200 subscribes to a support group lead by the system user 200, an option for receiving a notification when another system user 200 makes a donation to the system user 200 and/or an option for receiving a notification when a support group is suggested for the system user 200.

The notification settings options 483 of FIG. 20U are shown as including one or more options 483E for managing electronic mail (or email) notifications sent to the system user 200 via the multiuse communication system 100. The email notification options can include an option to receive a notification when another system user 200 sends a chat message to a coach profile of the system user 200, an option to receive a notification when another system user 200 sends a chat message to a volunteer profile of the system user 200, an option to receive a notification when another system user 200 sends a chat message to a peer profile of the system user 200 and/or an option to receive a notification with another system user 200 schedules a telephone call and/or a chat with the system user 200, without limitation. Optionally, the notification settings options 483 of FIG. 20U are shown as including an option 483F for managing sound notifications by the multiuse communication system 100.

In selected embodiments, the personal profile page 400 can include a notifications page 490 for presenting one or more of the user notifications 492 to the system user 200 as illustrated in FIG. 6. The notifications page 490, for example, can present user notifications 492 associated with new (or updated) events, saved content 468 (shown in FIG. 5), media items 463 (shown in FIG. 5) and/or user notifications 492 (shown in FIGS. 4A-B), without limitation. The notifications page 490 optionally can sort the user notifications 492. For example, the personal profile page 400 can sort the available user notifications 492 by date and/or time 494. As shown in FIG. 6, the notifications page 490 advantageously can present the user notifications 492 as being new user notifications 494A, user notifications 494B for a current day and/or new user notifications 494C that were posted or otherwise became available on a certain date 494C.

An exemplary personal profile page 400 is shown in FIG. 3I with settings options 480 for permitting the system user 200 to manage accesses (or security) to the system user profile, at 484. As illustrated in FIG. 3I, the personal profile page 400 can enable the system user 200 to manage a password, at 484A, for accessing the multiuse communication system 100. The system user 200 can view actual (or current) password information 484B and/or can enter a new password 484C. In selected embodiments, the system user 200 may be asked to confirm the new password, at 484D. The system user 200 profile optionally can be deleted. Once completed, the edits to the system user 200 profile access can be saved. An alternative embodiment of the personal profile page 400 of FIG. 3I is shown in FIG. 20V.

Additionally and/or alternatively, the settings options 480 can include payment options 485 as illustrated in FIG. 3J. The payment options 485 can enable the system user 200 to enter payment information 485A, such as a card number and other information associated with a credit card, a debit card or other financial account. In selected embodiments, the payment options 485 can include one or more payment limitation and other control options 485B. Exemplary payment limitation and other control options 485B can include, but are not limited to, a prohibition against sending a payment to a group that recently received a payment from the system user 200, a prohibition against sending a payment to another system user 200 who recently received a payment from the system user 200, a payment for subscribing to a selected group and/or payment amount limitations. Optionally, the payment information 485A can be enabled to receive donations and other payments sent to the system user 200 from other system users 200, at 485C.

An alternative embodiment of the payment options 485 is illustrated in FIG. 20W. The payment options 485D of FIG. 20W are shown to include an option 485E for the system user 200 to receive a payment from another system user 200 and/or an option 485F for the system user 200 to send a payment to another system user 200. As shown in FIG. 20W, the received payment can be applied to a selected payment device, such as a credit card, Paypal, Apple Pay, that is associated with the system user 200, without limitation. Additionally and/or alternatively, the payment sent by the system user 200 can be debited from the selected payment device that is associated with the system user 200.

Turning to FIG. 3K, the settings options 480 optionally can include one or more subscription management options 486. The subscription management options 486 can permit the system user 200 to managing user subscriptions to at least one group, at 486A. Exemplary groups can include one or more support groups associated with the subscribed support group link 426 and/or the suggested support group link 428 (collectively shown in FIG. 3A). The system user 200, for example, can be enabled to pause one or more group subscription, to view or otherwise access subscription payment information and/or to receive subscription payment deadline reminders. Group information about each of the groups to which the system user 200 has subscribed also can be presented, at 486B. The group information can include a group icon, a group name, a subscription date, subscription fee information and a payment history for each group, without limitation. An alternative embodiment of the subscription management options 486 is illustrated in FIG. 20X.

Alternative exemplary embodiments of the personal profile page 400 are illustrated in FIGS. 20A-S. In the manner set forth in additional detail herein, the personal profile page 400 can permit the system user 200 to access communication threads and other content 460 available via the multiuse communication system 100. The communication threads and other available content 460 advantageously can be sorted into one or more selected content categories 450 in the manner set forth in more detail above with the content categories 450 of FIG. 3A. As shown in FIG. 20A, for example, the content categories 450 can include a published content category 452, a biography content category 453, a support groups content category 455, a shop contents category 457 and/or a reviews content category 459.

The published content category 452 can comprise information associated with at least one personal user profile of the system user 200. Upon selection of the published content category 452, the personal profile page 400 can enable the system user 200 to edit or otherwise manage the personal user profile information of the system user 200. As illustrated in FIG. 20B, for example, the multiuse communication system 100 can present a profile management page 452A for managing the personal user profile information of the system user 200. The profile management page 452A is shown in FIG. 20B as being configured to enable the system user 200 to manage, at 452B, the personal user profile information of the system user 200, edit a user image associated with the personal user profile information of the system user 200, edit a cover associated with the personal user profile information of the system user 200, add at least one sticker to the personal user profile information of the system user 200, share the personal user profile information of the system user 200, copy a Uniform Resource Locator (or URL) associated with the personal user profile information of the system user 200 and/or promote the personal user profile information of the system user 200, without limitation.

An exemplary profile management page 452A is illustrated in FIG. 20C. The profile management page 452A can enable the system user 200 to edit or otherwise manage the personal user profile information of the system user 200. As shown in FIG. 20C, the profile management page 452A can provide one or more personal user profile management options. The profile management page 452A, for example, can enable the system user 200 to edit or otherwise manage general information 452C, biographic information 452D, topical information 452E and/or button information 452F within the personal user profile of the system user 200.

Exemplary general information 452C within the personal user profile of the system user 200 that can be managed via the profile management page 452A is shown in FIG. 20C. FIG. 20D shows exemplary biographic information 452D within the personal user profile of the system user 200 that can be managed via the profile management page 452A. Examples of the selected topical information 452E within the personal user profile of the system user 200 that can be managed via the profile management page 452A is shown in FIG. 20E; whereas, exemplary button information 452F within the personal user profile of the system user 200 that can be managed via the profile management page 452A is shown in FIG. 20F.

The biography content category 453 can comprise biographical information associated with at least one personal user profile of the system user 200. Upon selection of the biography content category 453, the personal profile page 400 can enable the system user 200 to edit or otherwise manage the biographical information of the system user 200. As illustrated in FIG. 20G, for example, the biographical information can include a biographical summary, one or more email addresses, one or more social network links, one or more books, one or more websites and/or one or more discount codes, without limitation.

Additionally and/or alternatively, the support groups content category 455 can comprise support group information associated with at least one personal user profile of the system user 200. Upon selection of the support groups content category 455, the personal profile page 400 can enable the system user 200 to edit or otherwise manage the support group information of the system user 200. As illustrated in FIG. 20H, for example, the support group information can include a listing of each support group that is associated with the system user 200.

Turning to FIGS. 20I-R, selection of the shop contents category 457 can enable the system user 200 to shop for selected products and/or services, including, but not limited to, events, videos, products (or items). Stated somewhat differently, the shop contents category 457 can permit system users 200, such as coach users 226 (shown in FIG. 1B), to post content for sale to other system users 200 who follow the coach users 226, belong to support groups managed by the coach users 226, and/or are otherwise associated with the coach users 226. As shown in FIG. 20I, for example, the shop contents category 457 of the personal profile page 400 can include navigation indicia 457B-E for enabling the system user 200 to navigate shopping content available via the multiuse communication system 100.

The personal profile page 400 of a coach user 226 (shown in FIG. 1B), for example, can permit the coach user 226 to manage the content available for sale via the personal profile page 400. New products and other content for sale can be added to the personal profile page 400 as illustrated in FIG. 20O. The navigation indicia 457B-E, for example, can include, but is not limited to, an all shopping content link 457E, an events shopping content link 457B, a videos shopping content link 457C and/or an products (or other items) shopping content link 457D in the manner described in more detail above with reference to FIGS. 3-5. The all shopping content link 457E enables the personal profile page 400 to present all products, services and other shopping content available via the multiuse communication system 100.

When the videos shopping content link 457C is activated, the personal profile page 400 can present video shopping content available via the multiuse communication system 100 as shown in FIGS. 20J-K. The video shopping content can include one or more videos that can be viewed by the system user 200. The personal profile page 400 optionally can present a description for one or more of the available videos, a price for viewing or otherwise accessing the videos and/or a promotion for at least one of the available videos, without limitation. In selected embodiments, the multiuse communication system 100 can enable the system user 220 to upload or otherwise add a new video to the multiuse communication system 100 as illustrated in FIG. 20L.

Activation of the events shopping content link 457B can permit the personal profile page 400 to present event shopping content available via the multiuse communication system 100 as shown in FIGS. 20M-O. The event shopping content can include one or more events in which the system user 200 can participate. The personal profile page 400 optionally can present a description for one or more of the available events, a price for viewing or otherwise accessing the events and/or a promotion for at least one of the available events, without limitation. In selected embodiments, the multiuse communication system 100 can enable the system user 220 to upload or otherwise add information about a new event to the multiuse communication system 100 as shown in FIG. 20O.

Upon activation of the products shopping content link 457D, the personal profile page 400 can present product shopping content available via the multiuse communication system 100 as shown in FIGS. 20P-R. The product shopping content can include one or more products that can be viewed and/or purchased by the system user 200. The personal profile page 400 optionally can present a description for one or more of the available products, a price for viewing or otherwise accessing the products and/or a promotion for at least one of the available products, without limitation. In selected embodiments, the multiuse communication system 100 can enable the system user 220 to upload or otherwise add information about a new product to the multiuse communication system 100 as illustrated in FIG. 20R.

The reviews content category 459 can comprise information associated with at least one personal user profile of the system user 200. Turning to FIG. 20S, for example, the personal profile page 400 can sort and view review information for the system user 200. In selected embodiments, the review information can be entered by one or more other system users 200 and/or can include textual comments and/or rating information for the system user 200.

In selected embodiments, the multiuse communication system 100 can enable the system user 200 to publish selected information from the personal user profile to other system users 200. An exemplary public user profile 500 is illustrated in FIGS. 8A-D. Turning to FIG. 8A, the system user 200 can select to publish any information 510 from the personal user profile, including the user image 412, the user name 414, the user contact information 416, user demographic information 418 and/or any other personal user profile information of the system user 200. The public user profile 500 optionally can include a donation button 520 by which the other system users 200 can provide financial support for the system user 200. The donation button 520 can enable the other system users 200 to provide the system user 200, for example, with a voluntary donation and/or a fee payment for services provided by the system user 200. In selected embodiments, the multiuse communication system 100 can enable the other system users 200 to follow and/or unfollow the system user 200 and/or the public user profile 500 of the system user 200.

For example, the public user profile 500 can include pricing information, agenda information and/or topic information for the system user 200. The public user profile 500 thereby can enable the system user 200 to sell products, promote events, post content and/or provide information about the system user 200. In selected embodiments, the public user profile 500 can include information about the system user 200 based upon reviews submitted by other system users 200.

The public user profile 500 can include a “following as” link and/or an “interacting as” link. The public user profile 500 can include an optional call link and/or a chat link. The call link can be associated with free or fee-based telephone calls; whereas, the chat link can be associated with free or fee-based chats. Additionally and/or alternatively, the public user profile 500 can include a “schedule” link, a “become supporter” link, a “subscribe to newsletter” link and/or a “promotion” link. The “schedule” link can facilitate scheduling a telephone call or a chat with another system user 200, such as a coach user 226 (shown in FIG. 1B), by enabling the system user 200 to view the agenda information for the other system user 200 and to schedule the telephone call or chat for a mutually-convenient time. The features associated with the “schedule” link, the “become supporter” link, the “subscribe to newsletter” link and the “promotion” link each can be free or fee-based. The donation button 520 of the public user profile 500 can be provided in the manner set forth above with reference to the donation button 520 of FIG. 8A. Preferably including user profile information about a coach user 226, the public user profile 500 can include user profile information about any type of system user 200, including a peer user 222 or a volunteer user 224 (collectively shown in FIG. 1B).

Returning to FIG. 8A, the public user profile 500 can present public profile content 540 associated with the personal user profile of the system user 200. As shown in FIG. 8A, the public profile content 540 can include one or more categories 530 of content. Exemplary public profile content categories 530 can include, but are not limited to, published content 532, media content 534, leader content 536 and/or volunteer content 538. The public profile content 540 associated with the published content 532 can include, for example, one or more posts 542, messages, communication threads and other materials. Additionally and/or alternatively, the media content 534 available from the public user profile 500 can include one or more media content items 544 as shown in FIG. 8B. The media content items 544 can include any suitable type of media content, such as photographs and/or videos, without limitation.

Turning to FIGS. 8C-D, the public user profile 500 can present the system user 200 as being a leader and/or a volunteer. The system user 200, for example, can be a leader of one or more groups associated with the multiuse communication system 100. Exemplary groups can include one or more support groups related to the relevant topics and/or subtopics identified the system user 200. If the system user 200 is presented as being a leader, the public user profile 500 can include leader content 536 with group overview information 546 about each of the groups for which the system user 200 is a leader as shown in FIG. 8C. Turning to FIG. 8C, the group overview information 546 available among the leader content 536 can include indicia, such as an image 546A, a group name 546B, and/or group purpose statement 546C, related to the one or more groups lead by the system user 200. The group overview information 546 optionally can include subscription information 546C for enabling other system users 200 to subscribe to the group and/or for providing cost information for subscribing to the group.

The system user 200, additionally and/or alternatively, can be a volunteer for one or more groups associated with the multiuse communication system 100. Exemplary groups can include one or more support groups related to the relevant topics and/or subtopics identified the system user 200. If the system user 200 is presented as being a volunteer, the public user profile 500 can include volunteer content 538 with volunteer overview information 550 as illustrated in FIG. 8D. The volunteer overview information 550 can provide a current volunteer status information 550A, demographic information 550B and/or a list of discussion topics 550C relevant or otherwise of interest to the system user 200. In selected embodiments, the public user profile 500 can enable the other system users 200 to contact or otherwise communicate with the system user 200 with regard to one or more of the discussion topics 550C. The public user profile 500, for example, can permit the other system users 200 to chat, at 550D, with the system user 200 and/or to call, at 550E, the system user 200. The multiuse communication system 100 can permit the other system users to communicate with the system user for free and/or for a fee.

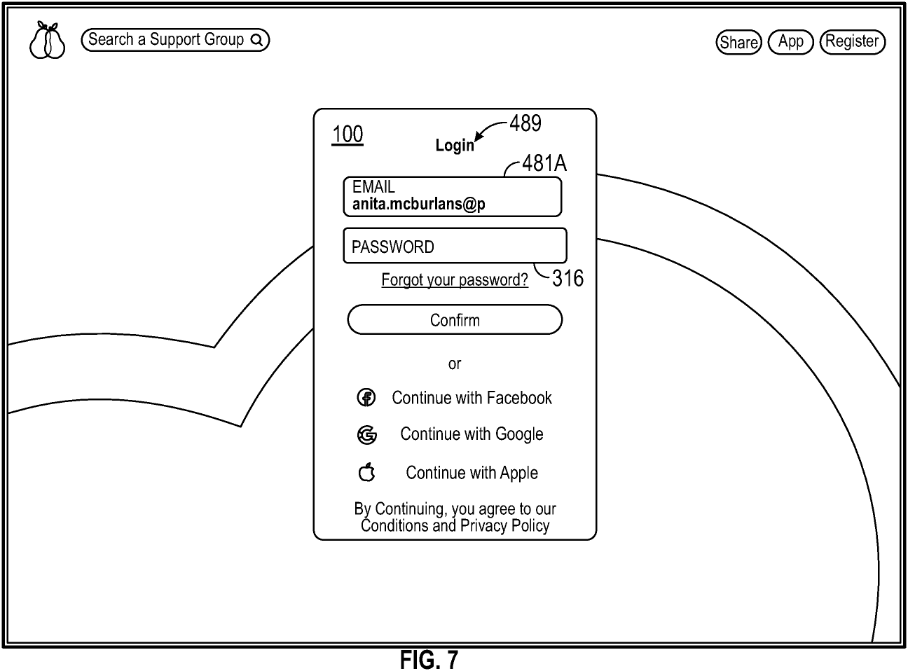

An exemplary login page 489 is shown in FIG. 7. Turning to FIG. 7, the login page 489 can comprise a welcome (or sign-in) page that can enable the system user 200 to utilize the multiuse communication system 100 and/or to visit a website associated with the multiuse communication system 100. The login page 489 can permit the system user 200 to enter the user name 314 (shown in FIGS. 2A-B), the telephone number 481B (shown in FIG. 3F), the email address 481A, the password 316 and/or other user access information entered by the system user 200 when registering to utilize the multiuse communication system 100. Although shown and described with reference to FIG. 7 as comprising a single login page 489 for purposes of illustration only, the login page 489 can comprise any suitable number of login (or welcome) pages.

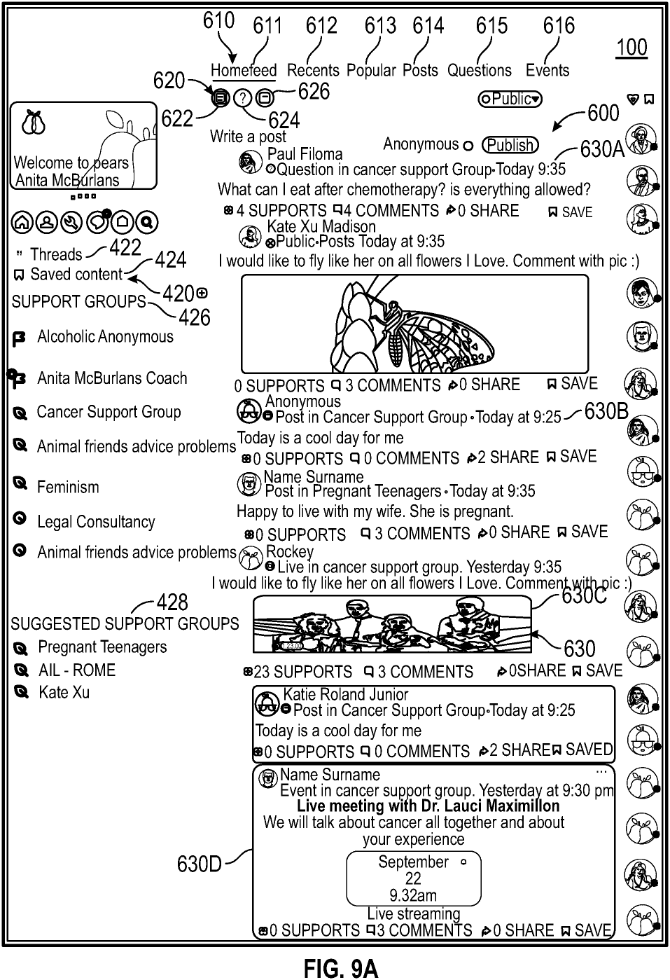

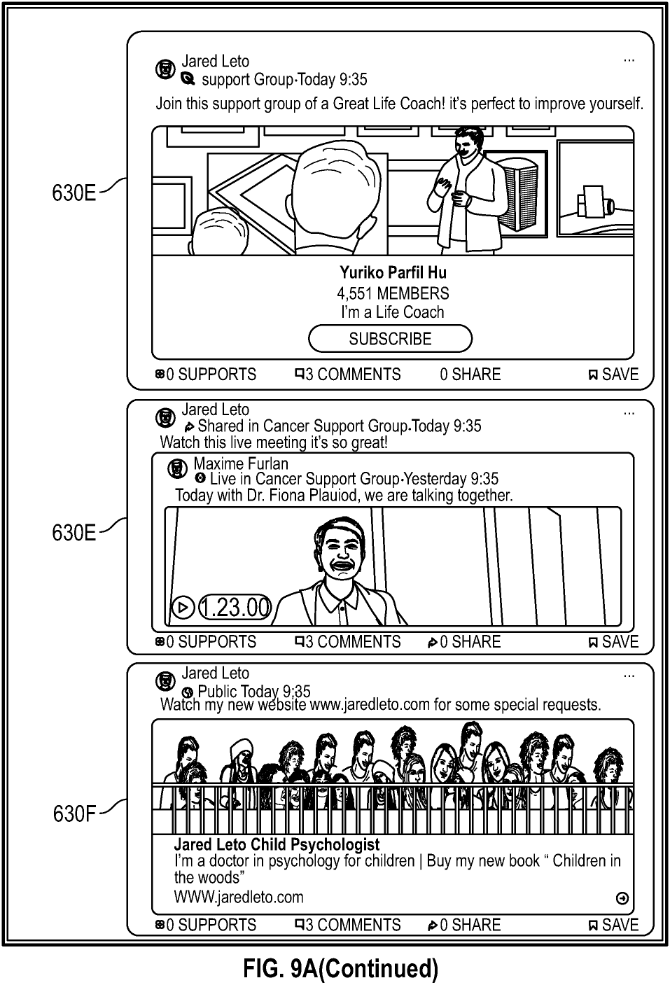

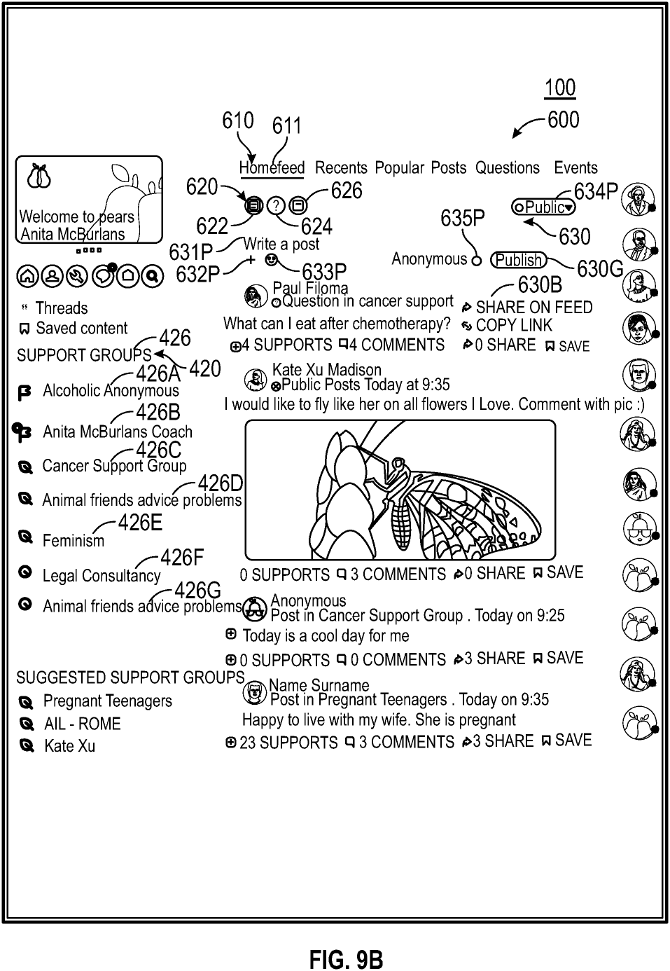

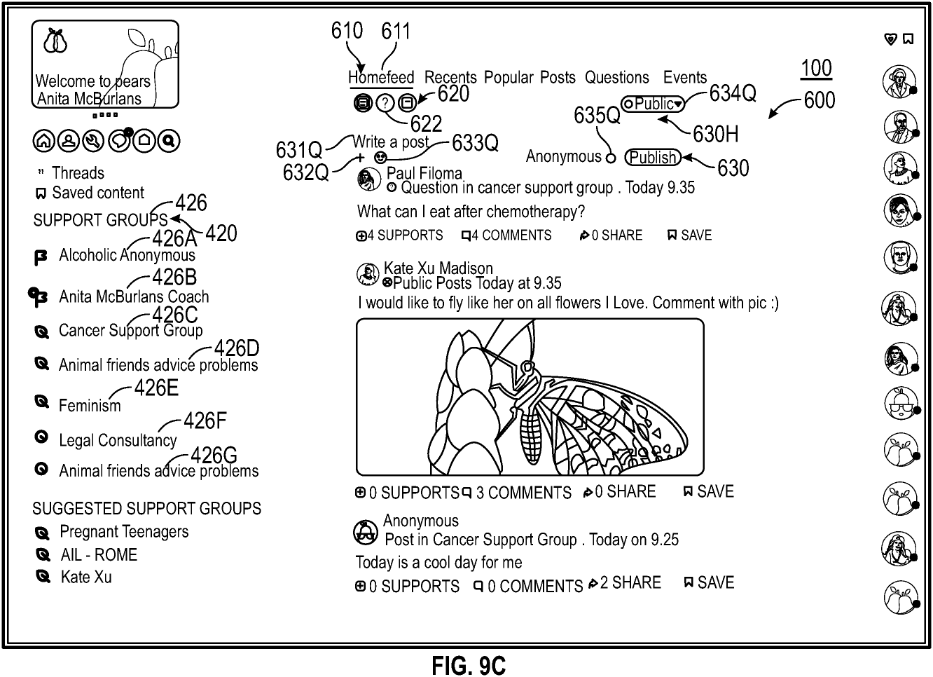

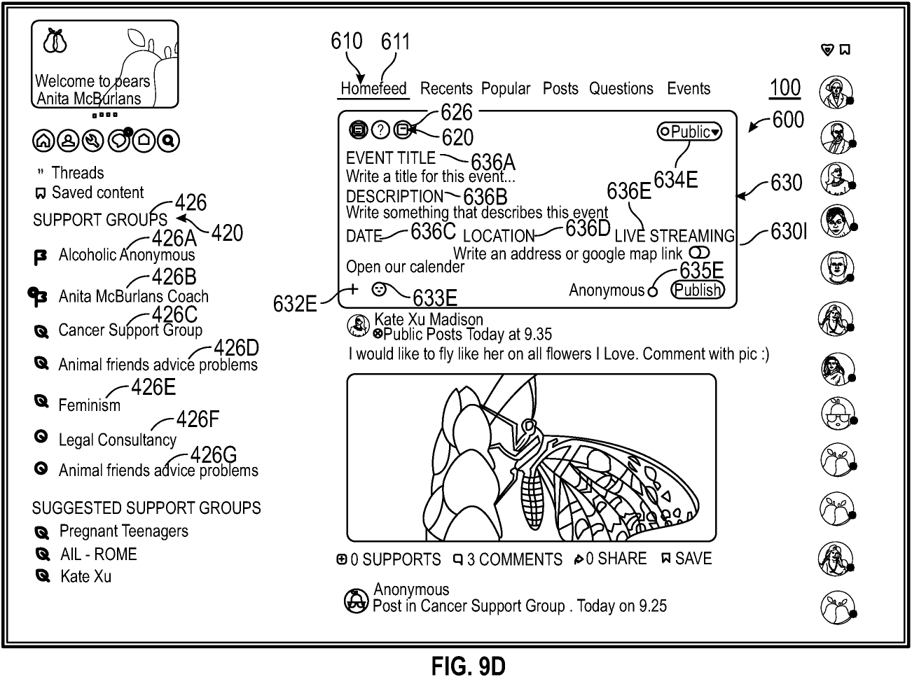

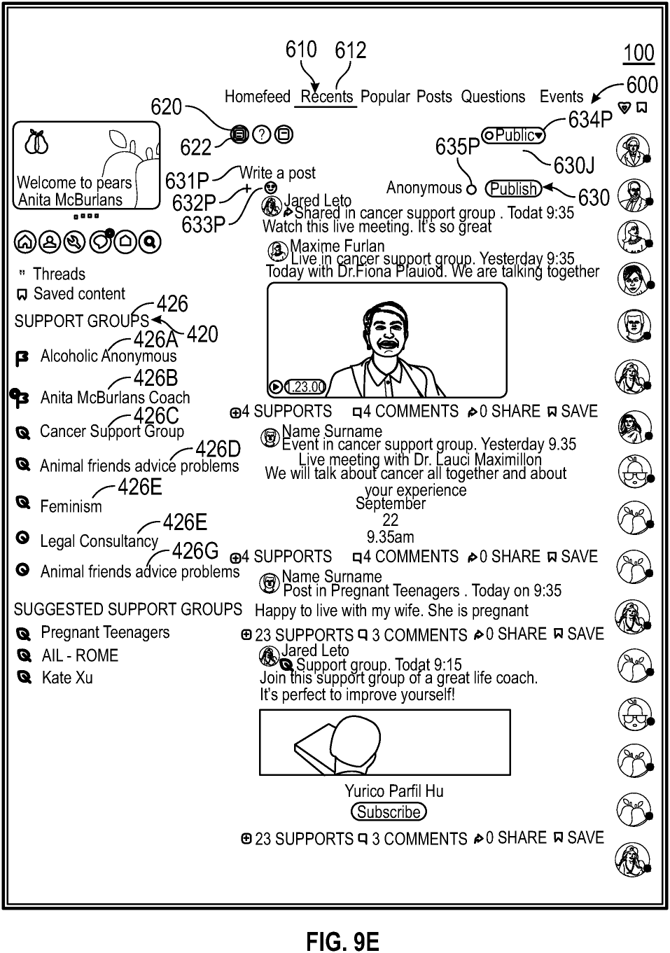

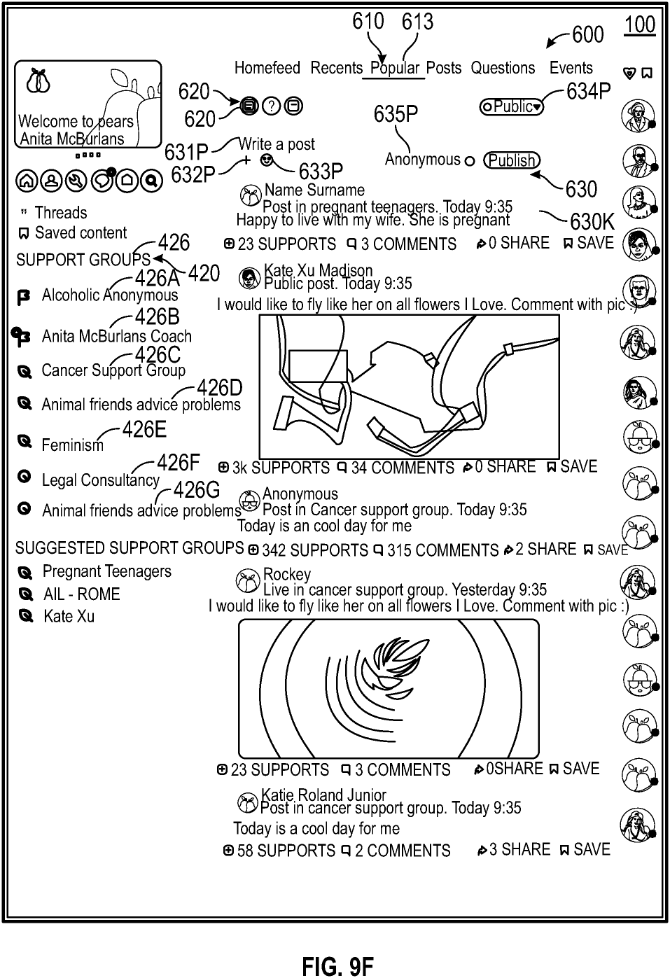

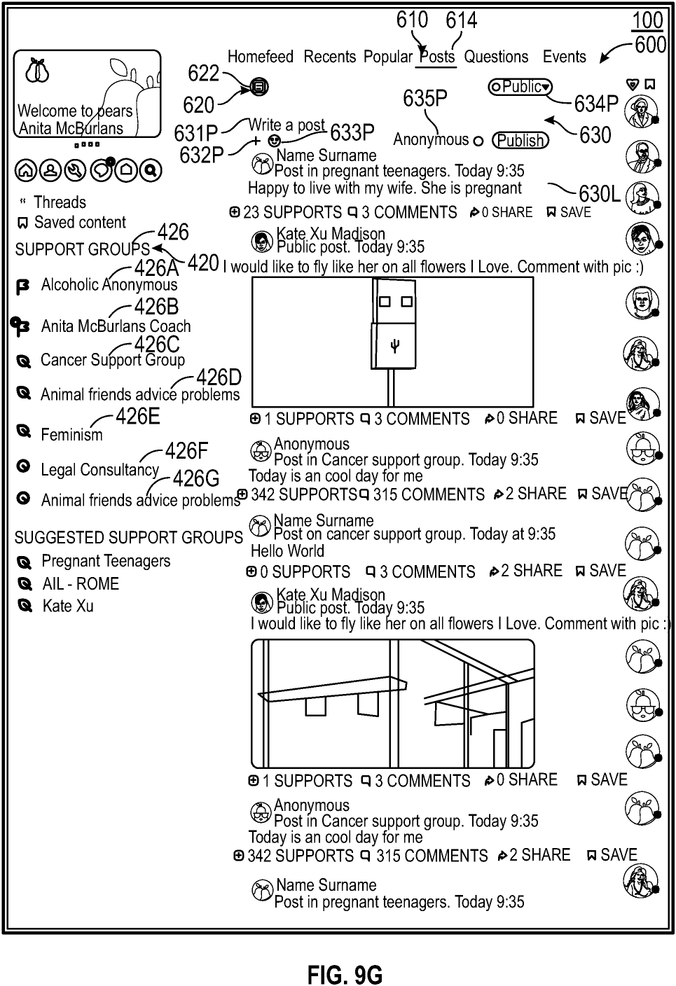

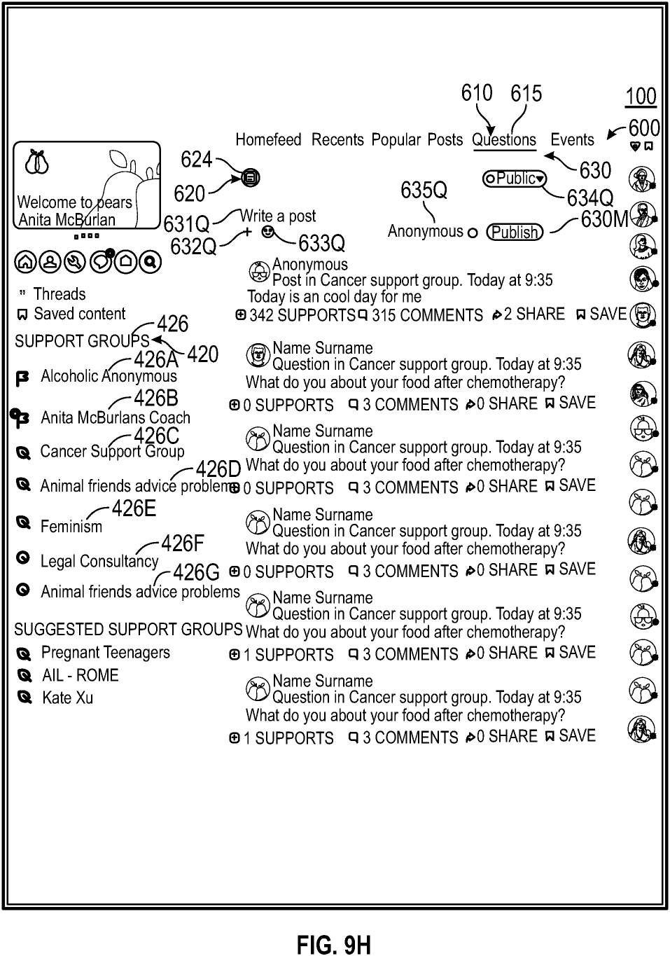

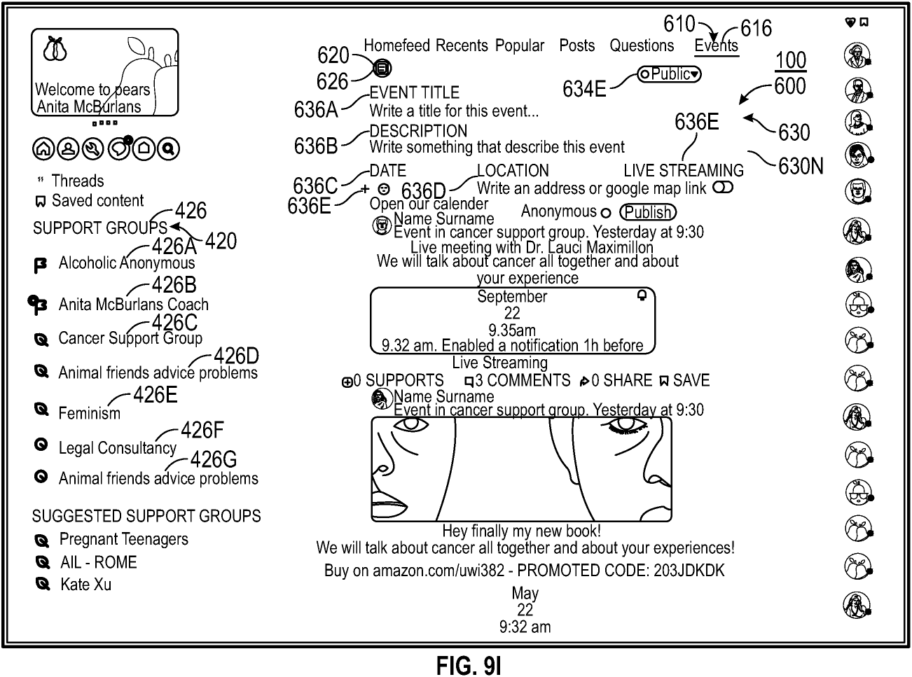

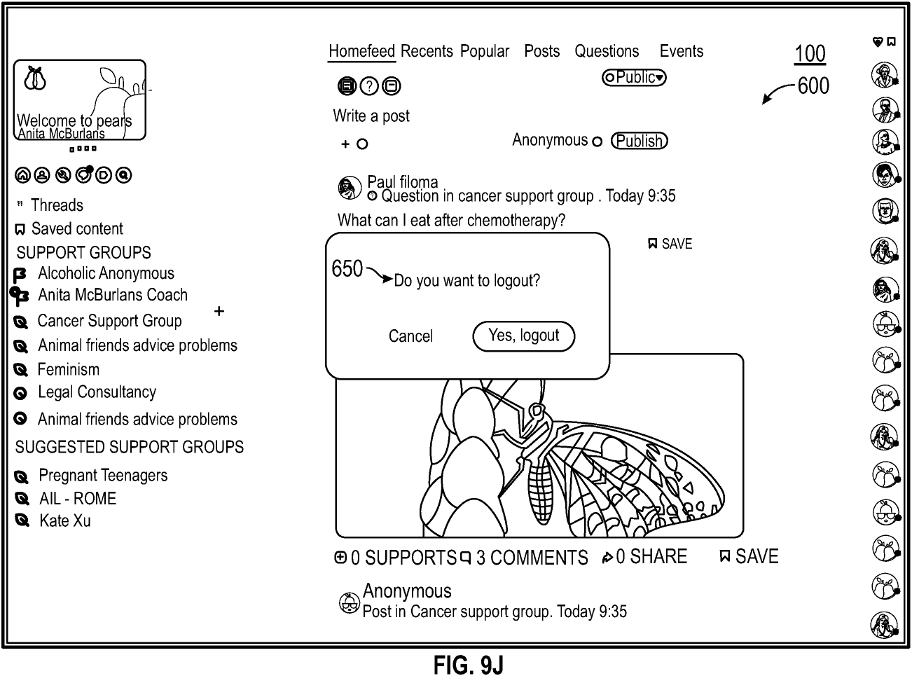

Once the system user 200 logs in, the multiuse communication system 100 can present a home (or homefeed ) page 600 to the system user 200 in selected embodiments as illustrated in FIG. 9A. The homefeed page 600 can comprise a primary page for navigating the multiuse communication system 100. As shown in FIG. 9A, the homefeed page 600 can include navigation indicia 420 for enabling the system user 200 to navigate the multiuse communication system 100 and other content available via the multiuse communication system 100. The navigation indicia 420, for example, can include, but is not limited to, a communication threads link 422, a saved content link 424, a subscribed support group link 426 and/or a suggested support group link 428 in the manner described in more detail above with reference to FIGS. 3-5.

As shown in FIG. 9A, the homefeed page 600 can include supplemental navigation indicia 610. The supplemental navigation indicia 610 can help enable the system user 200 with navigating, viewing and otherwise accessing homefeed content 630 available via the homefeed page 600. In selected embodiments, the homefeed page 600 can sort the available homefeed content 630 to facilitate content access. The homefeed page 600, for example, can present all of the available homefeed content 630, at 611. The available homefeed content 630 can include one or more questions 630A, one or more posts 630B, one or more media items 630C, one or more events 630D, one or more group invitations (or subscription requests) 630E and/or one or more advertisements 630F, without limitation. In selected embodiments, the homefeed page 600 can present recent homefeed content 630, at 612, popular homefeed content 630, at 613, homefeed content 630 related to posts, at 614, homefeed content 630 related to questions, at 615 and/or homefeed content 630 related to events, at 616, without limitation. An alternative embodiment of the homefeed page 600 of FIG. 9A is illustrated in FIG. 9K.

In selected embodiments, the homefeed page 600 advantageously can include hierarchical supplemental navigation indicia, such as first and second supplemental navigation indicia 610, 620, for facilitating navigation and access of the homefeed content 630 available via the homefeed page 600. When presenting all of the available homefeed content 630, at 611, for example, the homefeed page 600 can provide the second navigation indicia 620 for navigating within the available homefeed content 630. As shown in FIG. 9B, for example, the second navigation indicia 620 can include post creation indicia 622, question creation indicia 624 and/or event post creation indicia 626, without limitation. The homefeed page 600 optionally can enable the system user 200 to copy a link and/or share a feed for a selected post, question or event.

Upon selection of the post creation indicia 622, the homefeed page 600 can permit the system user 200 to search, review and otherwise access the available posts and/or to create a new post 630G. The accessed posts and/or the new post can be related to a discussion topic relevant or otherwise of interest to the system user 200. The homefeed page 600, as shown in FIG. 9B, can permit the system user 200 to enter post text 631P and/or to insert one or more post attachments 632P, such as a photograph, a video or other media item 463 (shown in FIG. 5), for the new post 630G. Additionally and/or alternatively, the homefeed page 600 can enable the system user 200 to include at least one post emoticon 633P to the new post 630G. The system user 200 optionally elect to publish the new post 630G anonymously, at 635P, and/or can control distribution 634P for the new post 630G via the homefeed page 600. For example, the new post 630G can be designated as being public, private, distributable to one or more selected system users 200 and/or distributable to one or more selected subscribed support groups 426A-G.

For example, the homefeed page 600 can support the system user 200 adding discussion topics as tags to a prior question. The prior question thereby can be presented when other system users 200 search for content to view and/or questions to answer.

Additionally and/or alternatively, the homefeed page 600 can permit the system user 200 to search, review and otherwise access the available questions (and any related answers or other responses) and/or to create a new question upon selection of the question creation indicia 624. In selected embodiments, the system user 200 can attach a chat topic to the new question so that other system users 200 can later find the new question and/or provide an answer to the new question based on the chat topic. The accessed questions and/or the new question can be related to a discussion topic relevant or otherwise of interest to the system user 200.

The homefeed page 600, as shown in FIG. 9C, can permit the system user 200 to enter question text 631Q and/or to insert one or more question attachments 632Q, such as a photograph, a video or other media item 463 (shown in FIG. 5), for the new question 630H. Additionally and/or alternatively, the homefeed page 600 can enable the system user 200 to include at least one question emoticon 633Q to the new question 630H. The system user 200 optionally elect to publish the new question 630H anonymously, at 635Q, and/or can control distribution 634Q for the new question 630H via the homefeed page 600. For example, the new question 630H can be designated as being public, private, distributable to one or more selected system users 200 and/or distributable to one or more selected subscribed support groups 426A-G.

The homefeed page 600 is illustrated in FIG. 9D as being configured to permit the system user 200 to search, review and otherwise access the available events and/or create a new event 630I upon selection of the event creation indicia 626. The accessed events and/or the new event can be related to a discussion topic relevant or otherwise of interest to the system user 200. Turning to FIG. 9D, the homefeed page 600 can permit the system user 200 to enter an event title 636A, an event description 636B, an event time and date 636C, an event location 636D and/or other event scheduling information. The event location 636D, for example, can comprise a physical (or geographic) location and/or a virtual location. If the new event 630I is associated with a virtual location, the homefeed page 600 can enable the system user 200 to enter streaming or other virtual access indicia 636E.

Additionally and/or alternatively, the homefeed page 600 can enable the system user 200 to insert one or more event attachments 632E, such as a photograph, a video or other media item 463 (shown in FIG. 5), for the new event 630I and/or to include at least one event emoticon 633E to the new event 630I. The system user 200 optionally elect to publish the new event 630I anonymously, at 635E, and/or can control distribution 634E for the new event 630I via the homefeed page 600. For example, the new event 630I can be designated as being public, private, distributable to one or more selected system users 200 and/or distributable to one or more selected subscribed support groups 426A-G.

Turning to FIG. 9E, the homefeed page 600 for presenting recent homefeed content 630, at 612, is shown. The available recent homefeed content 630 can include one or more questions 630A, one or more posts 630B, one or more media items 630C, one or more events 630D, one or more group invitations (or subscription requests) 630E and/or one or more advertisements 630F (collectively shown in FIG. 9A), without limitation. Upon selection of the post creation indicia 622, the homefeed page 600 can permit the system user 200 to search, review and otherwise access the available posts and/or to create a new post 630J. The accessed posts and/or the new post can be related to a discussion topic relevant or otherwise of interest to the system user 200.

The homefeed page 600, as shown in FIG. 9E, can permit the system user 200 to enter post text 631P and/or to insert one or more post attachments 632P, such as a photograph, a video or other media item 463 (shown in FIG. 5), for the new post 630J. Additionally and/or alternatively, the homefeed page 600 can enable the system user 200 to include at least one post emoticon 633P to the new post 630J. The system user 200 optionally elect to publish the new post 630J anonymously, at 635P, and/or can control distribution 634P for the new post 630J via the homefeed page 600. For example, the new post 630J can be designated as being public, private, distributable to one or more selected system users 200 and/or distributable to one or more selected subscribed support groups 426A-G.

The homefeed page 600 of FIG. 9F is illustrated as being configured to present popular homefeed content 630, at 613. The available popular homefeed content 630 can include one or more questions 630A, one or more posts 630B, one or more media items 630C, one or more events 630D, one or more group invitations (or subscription requests) 630E and/or one or more advertisements 630F (collectively shown in FIG. 9A), without limitation. Upon selection of the post creation indicia 622, the homefeed page 600 can permit the system user 200 to search, review and otherwise access the available posts and/or to create a new post 630K. The accessed posts and/or the new post can be related to a discussion topic relevant or otherwise of interest to the system user 200.

The homefeed page 600, as shown in FIG. 9F, can permit the system user 200 to enter post text 631P and/or to insert one or more post attachments 632P, such as a photograph, a video or other media item 463 (shown in FIG. 5), for the new post 630K. Additionally and/or alternatively, the homefeed page 600 can enable the system user 200 to include at least one post emoticon 633P to the new post 630K. The system user 200 optionally elect to publish the new post 630K anonymously, at 635P, and/or can control distribution 634P for the new post 630K via the homefeed page 600. For example, the new post 630K can be designated as being public, private, distributable to one or more selected system users 200 and/or distributable to one or more selected subscribed support groups 426A-G.

Turning to FIG. 9G, the homefeed page 600 for presenting homefeed content 630 related to posts, at 614, is shown. The available homefeed content 630 related to posts can include one or more questions 630A, one or more posts 630B, one or more media items 630C, one or more events 630D, one or more group invitations (or subscription requests) 630E and/or one or more advertisements 630F (collectively shown in FIG. 9A), without limitation. Upon selection of the post creation indicia 622, the homefeed page 600 can permit the system user 200 to search, review and otherwise access the available posts and/or to create a new post 630L. The accessed posts and/or the new post can be related to a discussion topic relevant or otherwise of interest to the system user 200.

The homefeed page 600, as shown in FIG. 9G, advantageously can permit the system user 200 to enter post text 631P and/or to insert one or more post attachments 632P, such as a photograph, a video or other media item 463 (shown in FIG. 5), for the new post 630L. Additionally and/or alternatively, the homefeed page 600 can enable the system user 200 to include at least one post emoticon 633P to the new post 630L. The system user 200 optionally elect to publish the new post 630L anonymously, at 635P, and/or can control distribution 634P for the new post 630L via the homefeed page 600. For example, the new post 630L can be designated as being public, private, distributable to one or more selected system users 200 and/or distributable to one or more selected subscribed support groups 426A-G.

Additionally and/or alternatively, the homefeed page 600 of FIG. 9H can present homefeed content 630 related to questions, at 615. The available homefeed content 630 related to questions can include one or more questions 630A, one or more posts 630B, one or more media items 630C, one or more events 630D, one or more group invitations (or subscription requests) 630E and/or one or more advertisements 630F (collectively shown in FIG. 9A), without limitation. In selected embodiments, the homefeed page 600 can permit the system user 200 to search, review and otherwise access the available questions (and any related answers or other responses) and/or to create a new question 630M upon selection of the question creation indicia 624. The accessed questions and/or the new question can be related to a discussion topic relevant or otherwise of interest to the system user 200.

The homefeed page 600, as shown in FIG. 9H, can permit the system user 200 to enter question text 631Q and/or to insert one or more question attachments 632Q, such as a photograph, a video or other media item 463 (shown in FIG. 5), for the new question 630M. Additionally and/or alternatively, the homefeed page 600 can enable the system user 200 to include at least one question emoticon 633Q to the new question 630M. The system user 200 optionally elect to publish the new question 630M anonymously, at 635Q, and/or can control distribution 634Q for the new question 630M via the homefeed page 600. For example, the new question 630M can be designated as being public, private, distributable to one or more selected system users 200 and/or distributable to one or more selected subscribed support groups 426A-G.

The homefeed page 600 optionally can present homefeed content 630 related to events, at 616, as illustrated in FIG. 9J. The available homefeed content 630 related to events can include one or more questions 630A, one or more posts 630B, one or more media items 630C, one or more events 630D, one or more group invitations (or subscription requests) 630E and/or one or more advertisements 630F (collectively shown in FIG. 9A), without limitation. Turning to FIG. 9J, the homefeed page 600 is illustrated as being configured to permit the system user 200 to search, review and otherwise access the available events and/or to create a new event 630N upon selection of the event creation indicia 626. The accessed events and/or the new event can be related to a discussion topic relevant or otherwise of interest to the system user 200. Turning to FIG. 9J, the homefeed page 600 can permit the system user 200 to enter an event title 636A, an event description 636B, an event time and date 636C, an event location 636D and/or other event scheduling information. The event location 636D, for example, can comprise a physical (or geographic) location and/or a virtual location.

If the new event 630N is associated with a virtual location, the homefeed page 600 can enable the system user 200 to enter streaming or other virtual access indicia 636E. Additionally and/or alternatively, the homefeed page 600 can enable the system user 200 to insert one or more event attachments 632E, such as a photograph, a video or other media item 463 (shown in FIG. 5), for the new event 630N and/or to include at least one event emoticon 633E to the new event 630N. The system user 200 optionally elect to publish the new event 630N anonymously, at 635E, and/or can control distribution 634E for the new event 630N via the homefeed page 600. For example, the new event 630N can be designated as being public, private, distributable to one or more selected system users 200 and/or distributable to one or more selected subscribed support groups 426A-G.

An exemplary logout page 650 for the multiuse communication system 100 is shown in FIG. 9J. The logout page 650 can comprise an exit (or sign-out) page that can enable the system user 200 to discontinue a current session for utilizing the multiuse communication system 100. The logout page 650 can permit the system user 200 to confirm an intent to discontinue the current session before ending the current session.

For example, the homefeed page 600 advantageously can enable the selected system user 210 to change the manner in which the selected system user 210 interacts with the multiuse communication system 100. The homefeed page 600, in selected embodiments, can enable the selected system user 210 to create more than one user profile and to select which of the created user profiles of the selected system user 210 should be used to interact the multiuse communication system 100. In selected embodiments, the homefeed page 600 can permit the selected system user 210 to enter a post, ask a question and/or to create an event under the selected user profile of the selected system user 210.

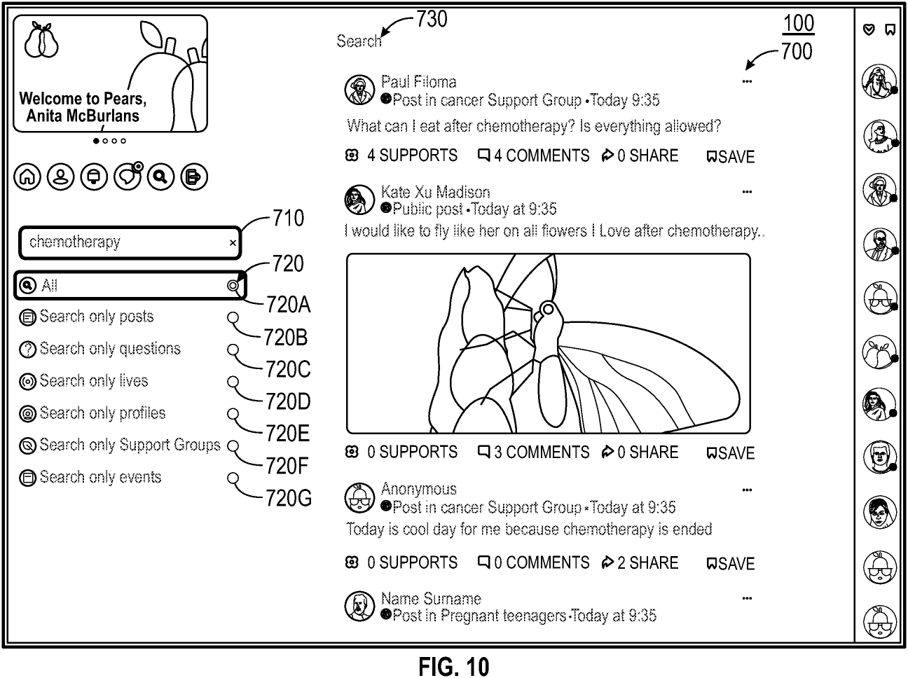

In the manner set forth herein, the multiuse communication system 100 advantageously can provide access to multiple groups, such as support groups, for a variety of discussion topics. The multiuse communication system 100, for example, can present a search page 700 for enabling the selected system user 210 to search the content available via the multiuse communication system 100 as shown in FIG. 10. Turning to FIG. 10, the search page 700 can permit the selected system user 210 to provide a discussion topic, one or more key words or other search term(s) via a search box 710.

The search page 700 optionally can provide search control indicia 720 for controlling the scope of the content search. The search indicia 720, for example, can permit the selected system user 210 to search all or a predetermined portion of the content available via the multiuse communication system 100. As shown in FIG. 10, the search indicia 720 can include search all indicia 720A, search posts indicia 720B, search questions indicia 720C, search lives indicia 720D, search user profiles indicia 720E, search support groups indicia 720F and/or search events indicia 720G, without limitation. The search term(s) can be compared with the selected content available via the multiuse communication system 100. The search page 700 can present the search results 730 of the content search. The search results 730 can include, but are not limited to, one or more questions 630A, one or more posts 630B, one or more media items 630C, one or more events 630D, one or more group invitations (or subscription requests) 630E and/or one or more advertisements 630F (collectively shown in FIG. 9A).

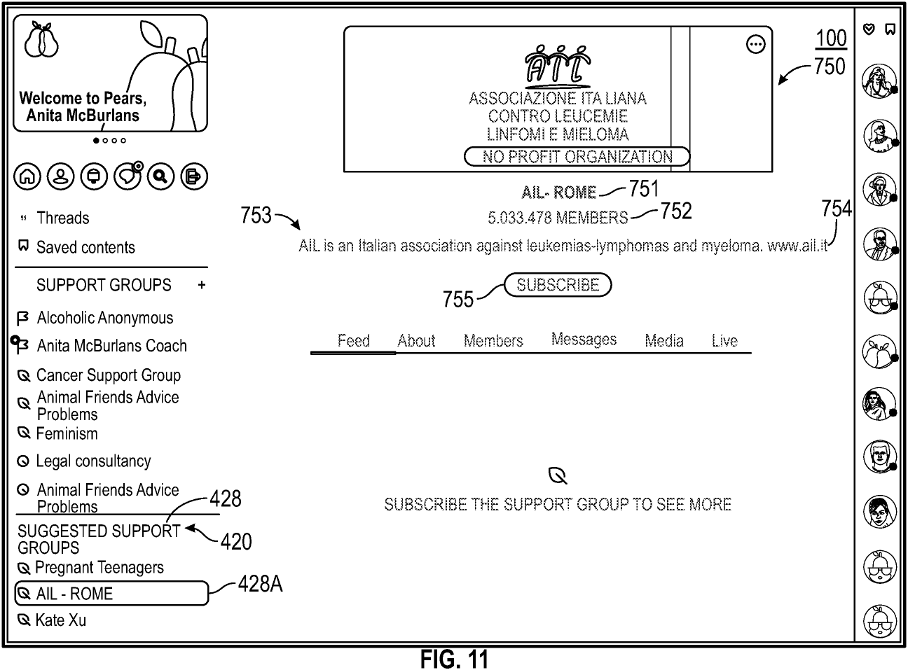

The multiuse communication system 100 can suggest one or more groups to the selected system user 210 based upon the discussion topics listed in the user profile of the system user 210 in the manner discussed above with reference to FIG. 3A. In selected embodiments, the multiuse communication system 100 can present a suggested support group overview page 750 for enabling the selected system user 210 to access selected information for one or more of the support groups 428 suggested by the multiuse communication system 100 as shown in FIG. 11. Turning to FIG. 11, the suggested support group overview page 750 can provide overview information for a selected support group 428A. The overview information can include, but is not limited to, a name 751 of the selected support group 428A, a membership 752 of the selected support group 428A, a description 753 of the selected support group 428A and/or contact information 754 for the selected support groups 428A. The suggested support group overview page 750 optionally can permit the selected system user 210 to subscribe to the selected support group 428A, at 755.

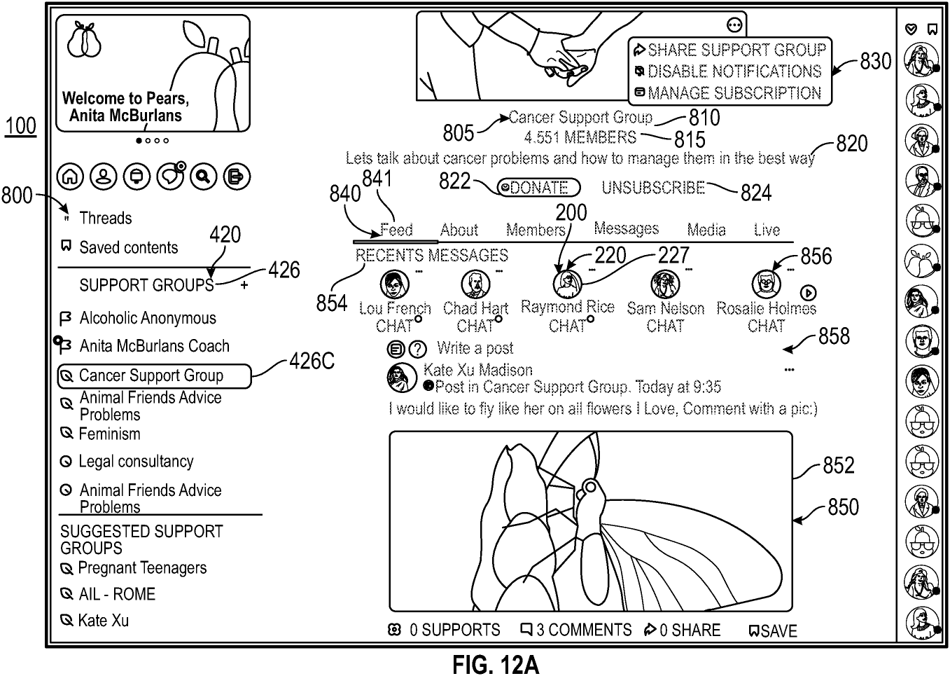

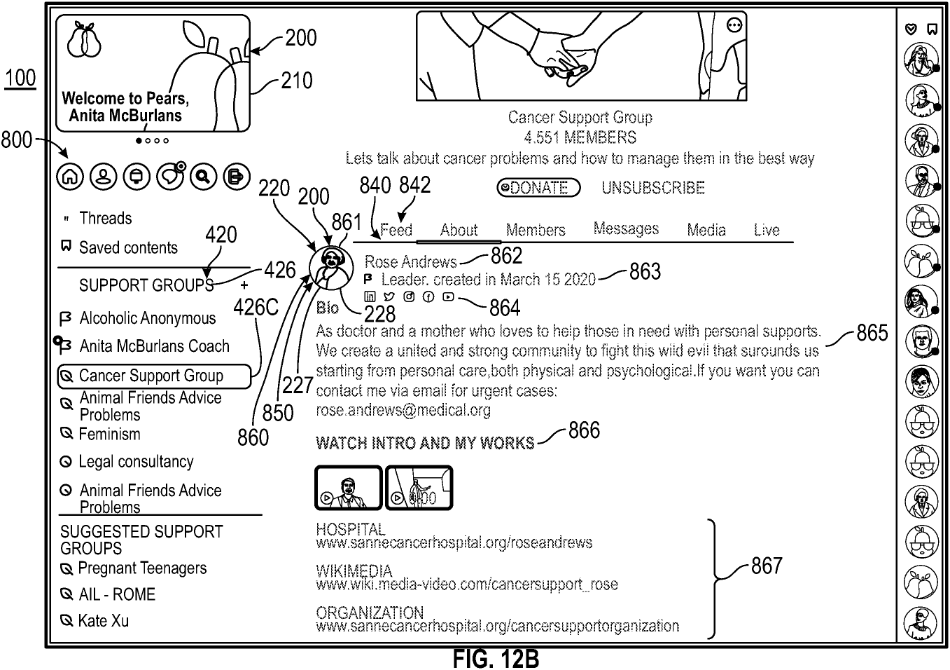

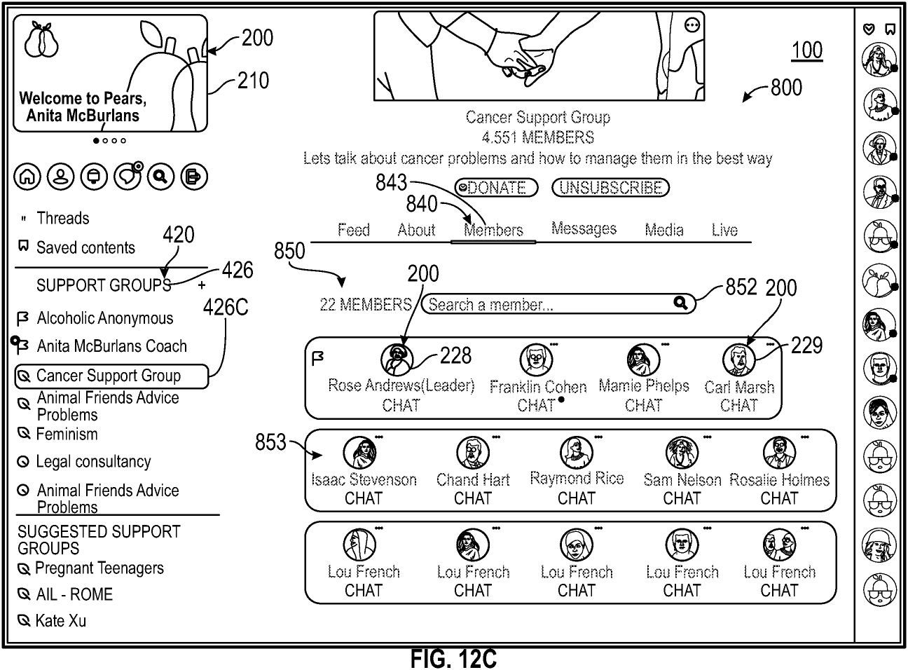

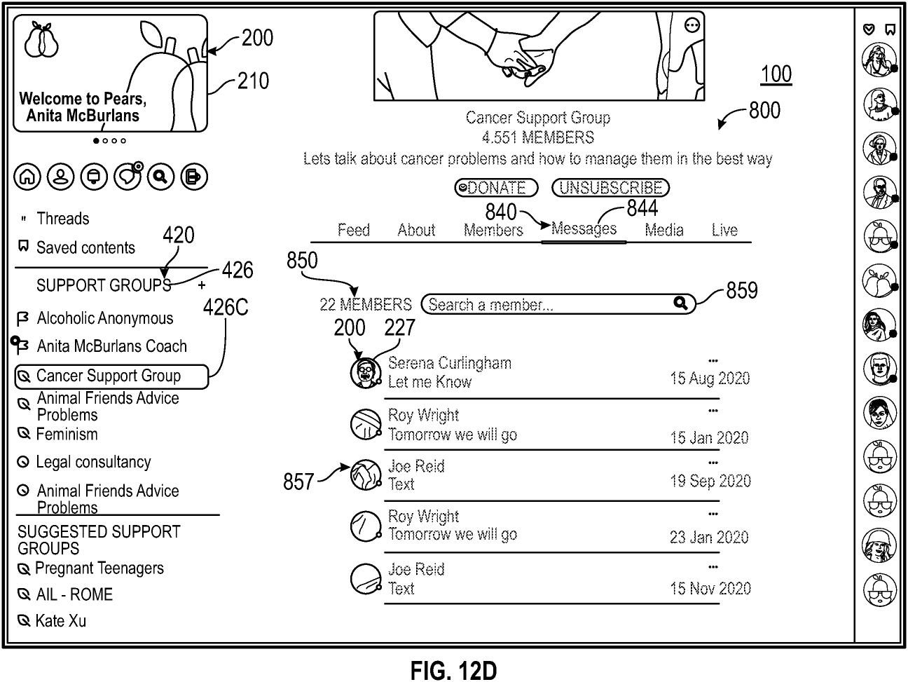

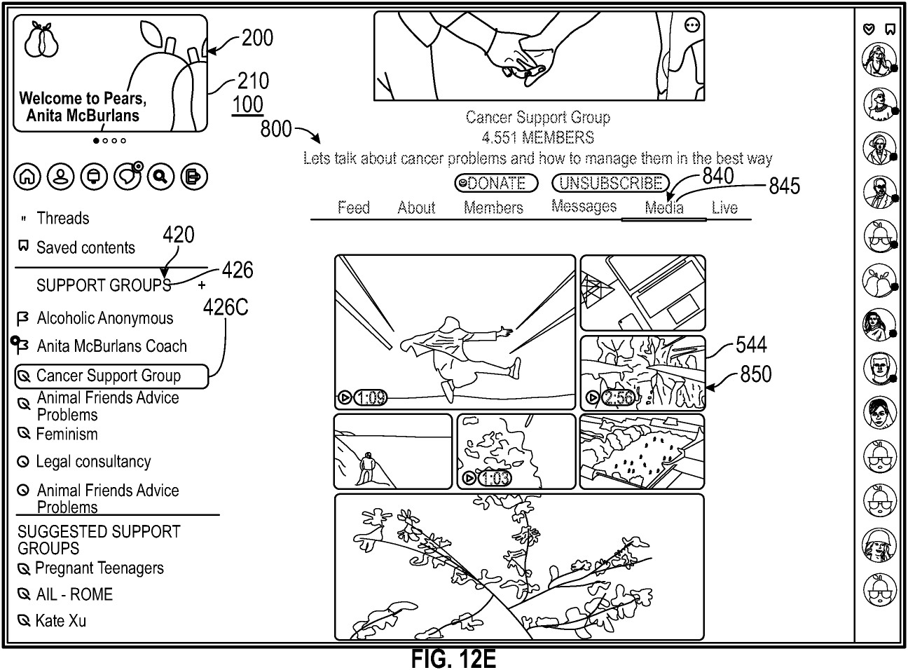

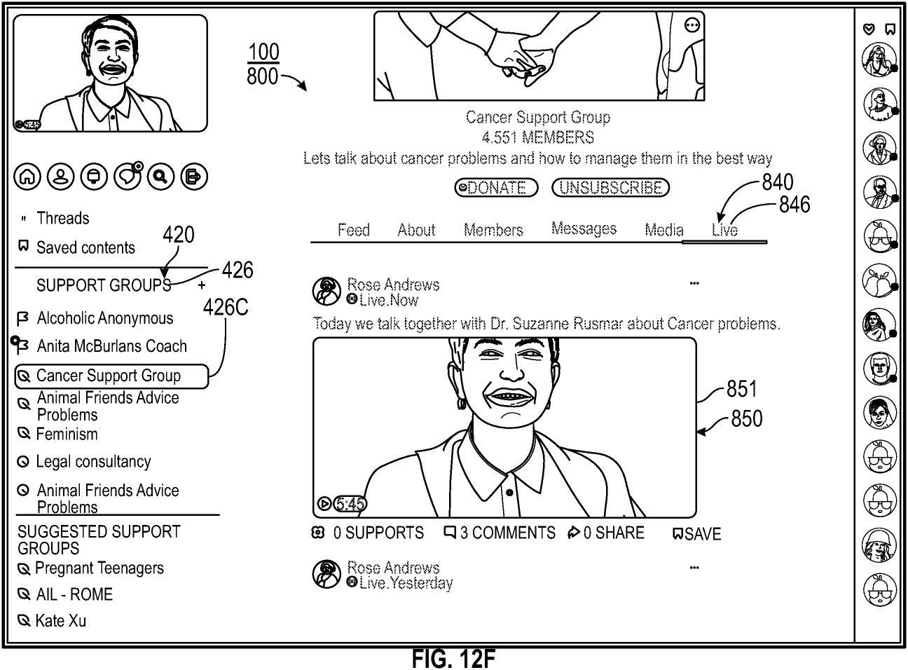

If the selected system user 210 elects to subscribe to a selected group, such as a selected support group 805, of the multiuse communication system 100 can present a support group membership page 800 as illustrated in FIG. 12A. The support group membership page 800 can provide selected information about the selected support group 805, such as a group name 810, membership information 815, a purpose statement 820, cost and/or other subscription information, without limitation. In selected embodiments, the support group membership page 800 can include a donate option 822 for providing financial support to the selected support group 805 and/or one or more other system users 220 who are members 227 of the selected support group 805. The support group membership page 800 optionally can include an unsubscribe option 824 for enabling the selected system user 210 to end the subscription to the selected support group 805. As shown in FIG. 12A, the group name 810 can be included among the subscribed support group links 426.

The support group membership page 800 optionally can provide support group management indicia 830 for managing the subscription and/or membership of the selected system user 210 in the selected support group 805. As illustrated in FIG. 12A, the support group management indicia 830 can enable the selected system user 210 to share the selected support group 805 with other system users 200, disable notifications from the selected support group 805 and/or to otherwise manage the subscription of the selected system user 210 in the selected support group 805.

Additionally and/or alternatively, the support group membership page 800 can provide support group membership control indicia 840 for navigating the support group membership page 800 and/or accessing support group content 850 available via the support group membership page 800. The support group membership control indicia 840, for example, can permit the selected system user 210 to view and otherwise access feed materials 841 associated with the selected support group 805, overview information 842 about the selected support group 805, membership information 843 for the selected support group 805, messages 844 associated with the selected support group 805, media 845 associated with the selected support group 805 and/or live materials 846 for the selected support group 805, without limitation.

The feed materials 841 can include, but are not limited to, one or more questions 630A, one or more posts 630B, one or more media items 630C, one or more events 630D, one or more group invitations (or subscription requests) 630E and/or one or more advertisements 630F (collectively shown in FIG. 9A). As shown in FIG. 12A, for example, the feed materials 841 can include one or more recent messages 854, a listing 856 of at least one other member 227 of the selected support group 805 and/or enable the selected system user 210 to view an available post 852 and/or to write a new post 858. The listing 856 optionally can enable the selected system user 210 to chat or otherwise communicate with one or more other members 227 of the selected support group 805.

Turning to FIG. 12B, the support group membership page 800 can permit the selected system user 210 to view and otherwise access overview information 842 about the selected support group 805. The overview information 842, for example, can provide leadership information about one or more leader 228 of the selected support group 805. The leaders 228 of the selected support group 805 can include one or more peer users 222, one or more volunteer users 224 and/or one or more coach users 226 (collectively shown in FIG. 1B). As shown in FIG. 12B, for example, the leadership information can comprise, but is not limited to, an image 861, a name 862, leadership information 863, contact information 864, demographic information 865, introductory and/or reference materials 866, external reference materials 867 and/or other member information about the leaders 228.

The support group membership page 800 of FIG. 12C can permit the selected system user 210 to view and otherwise access membership information 843 for the selected support group 805. The members 227 of the selected support group 805 can include one or more peer users 222, one or more volunteer users 224 and/or one or more coach users 226 (collectively shown in FIG. 1B). As shown in FIG. 12C, for example, the membership information 851 can comprise member information about a leader 228 and/or non-leader members 229 of the selected support group 805. The support group membership page 800 can include, but is not limited to, an image, a name, contact information, demographic information and/or other member information about the members 227. The support group membership page 800 optionally can enable the selected system user 210 to search, at 852, within the membership information 851 and/or to chat or otherwise communicate with one or more other members 227 of the selected support group 805.

Message information 844 related to one or more messages 857 among the members 227 of the selected support group 805 can be viewed, exchanged and/or otherwise accessed via the support group membership page 800 shown in FIG. 12D. Each message 857 can include information about the participating members 227 and the message text of the message 857. In selected embodiments, the support group membership page 800 can enable the selected system user 210 to search, at 859, among the messages 857. FIG. 12E illustrates that one or more media content items 544 optionally can be accessed via a media page 845 associated with the selected support group 805. The media content items 544 can include any suitable type of media content, such as photographs and/or videos, without limitation. Additionally and/or alternatively, live materials 846, such as a streamed (or live) live event 851, for the selected support group 805 can be viewed or otherwise accessed via the support group membership page 800 shown in FIG. 12F.

The support group membership control indicia 840 of the support group membership page 800 can be provided in the manner set forth above with reference to the support group membership control indicia 840 of FIGS. 12A-F. The support group membership control indicia 840 can include shop materials 847 associated with the selected support group 805 (shown in FIG. 12A). Selection of the shop materials 847 can enable the system user 200 to shop for selected products and/or services, including, but not limited to, events, videos, products (or items) in the manner set forth in more detail above with reference to the shop contents category 457 of FIGS. 20I-R. Media associated with the selected support group 805 thereby can be accessed via the access feed materials 841, the live materials 846 and/or the shop materials 847 for the selected support group 805.

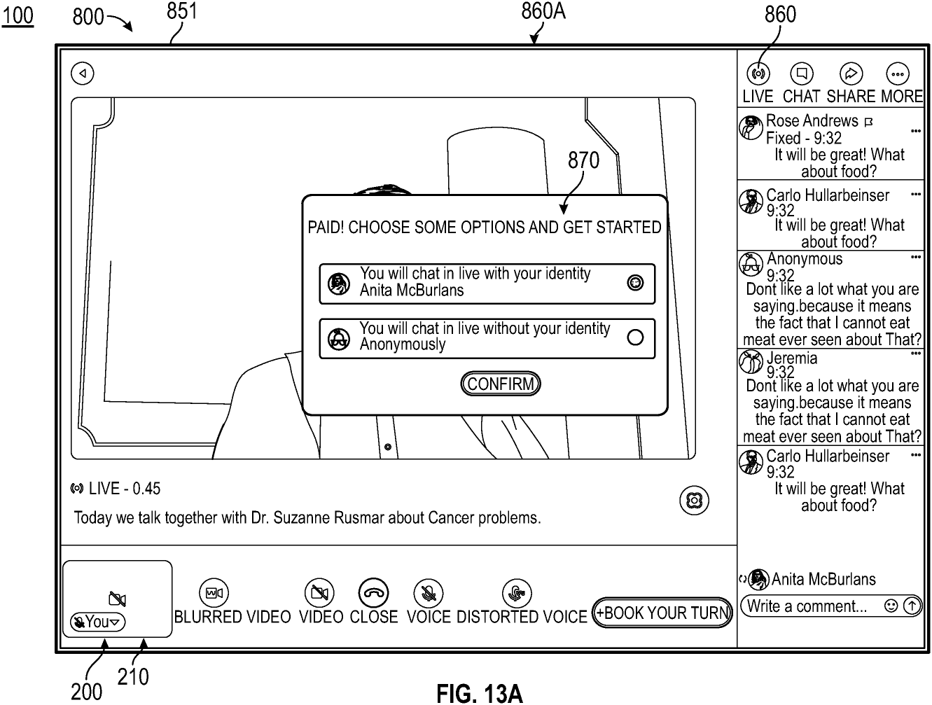

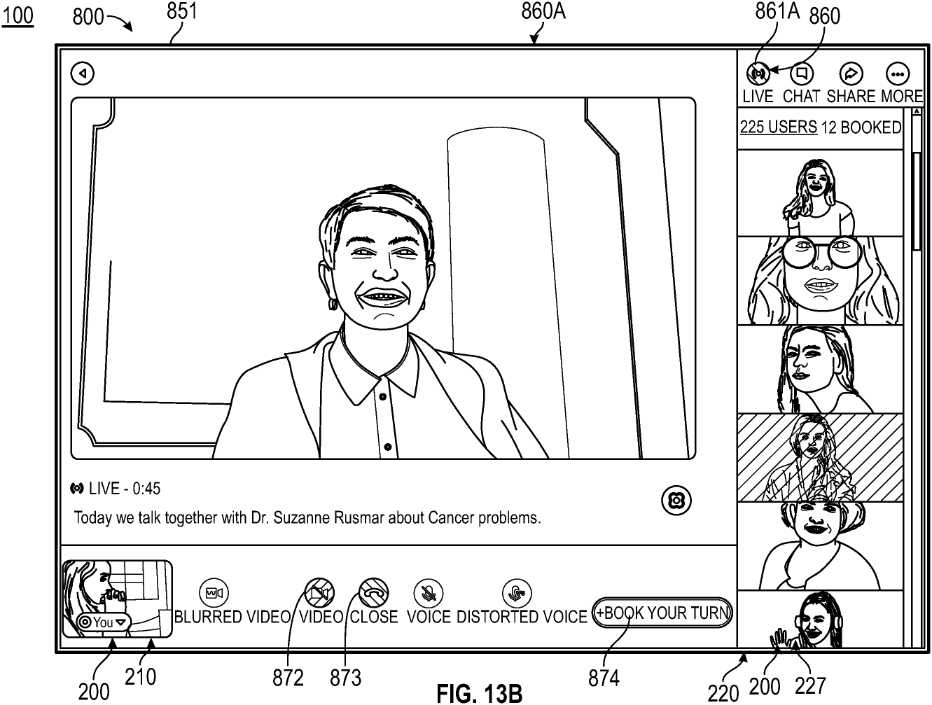

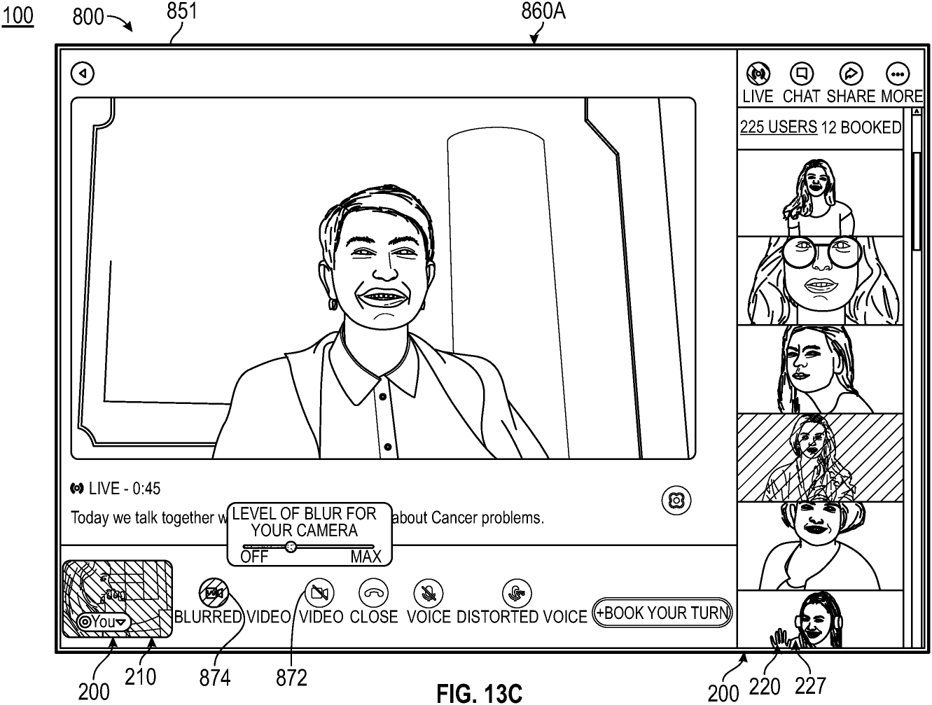

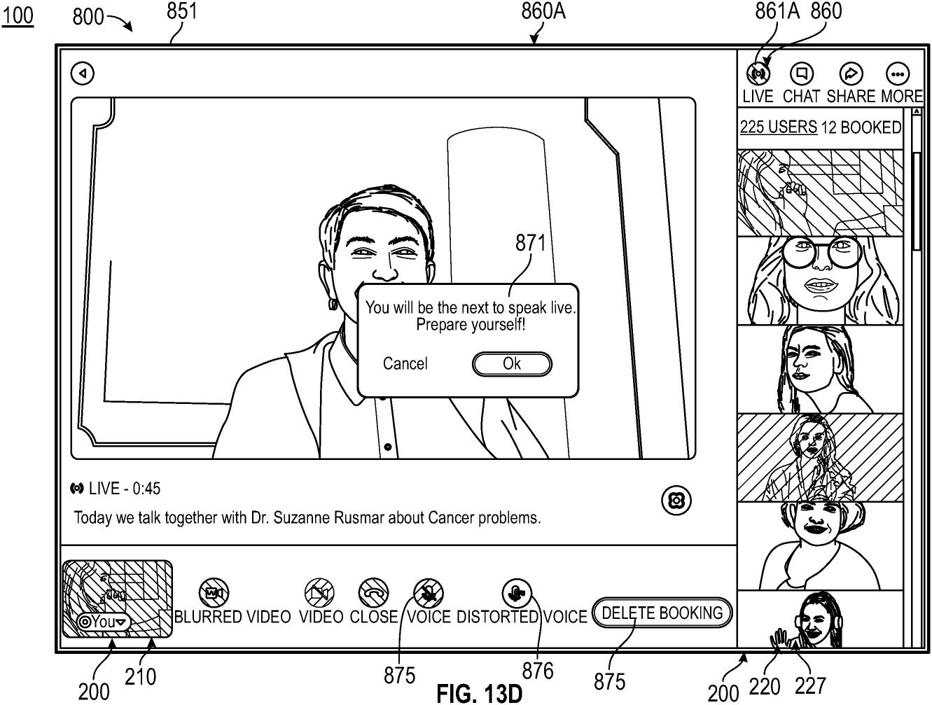

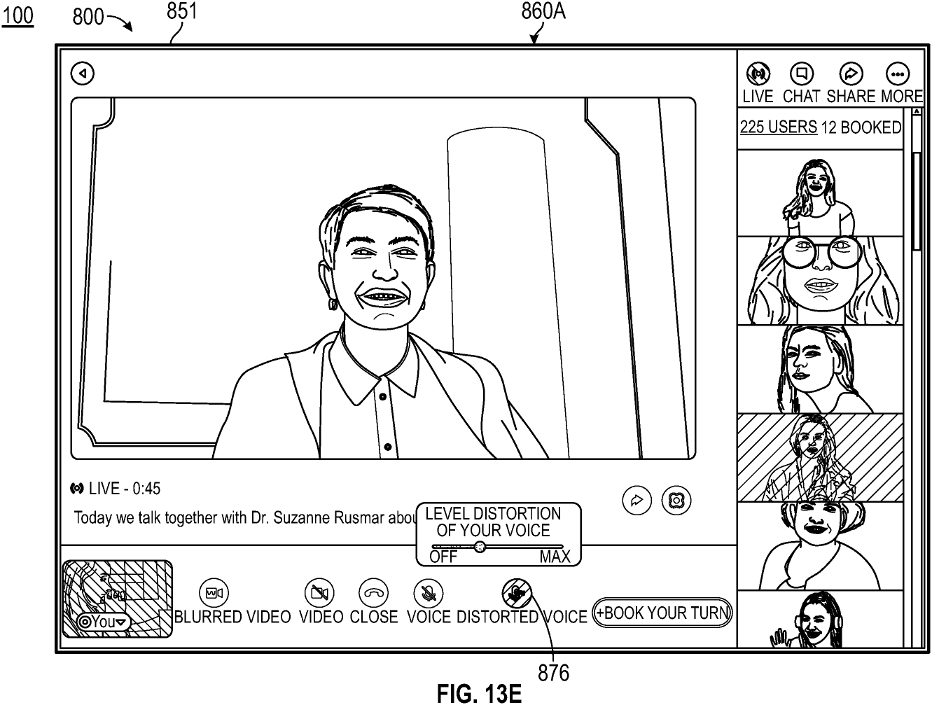

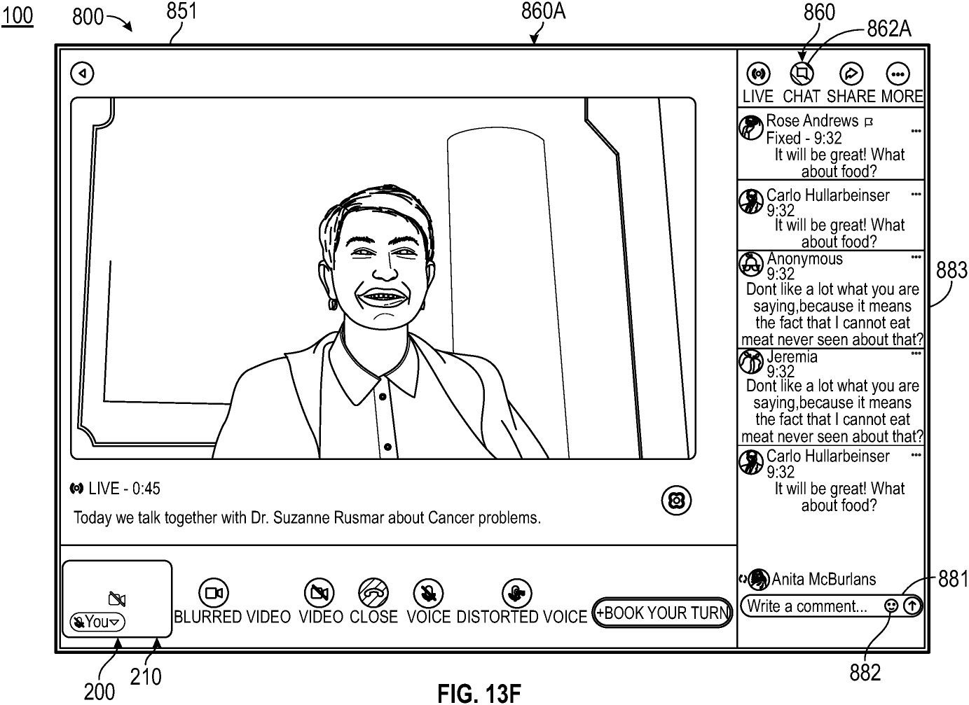

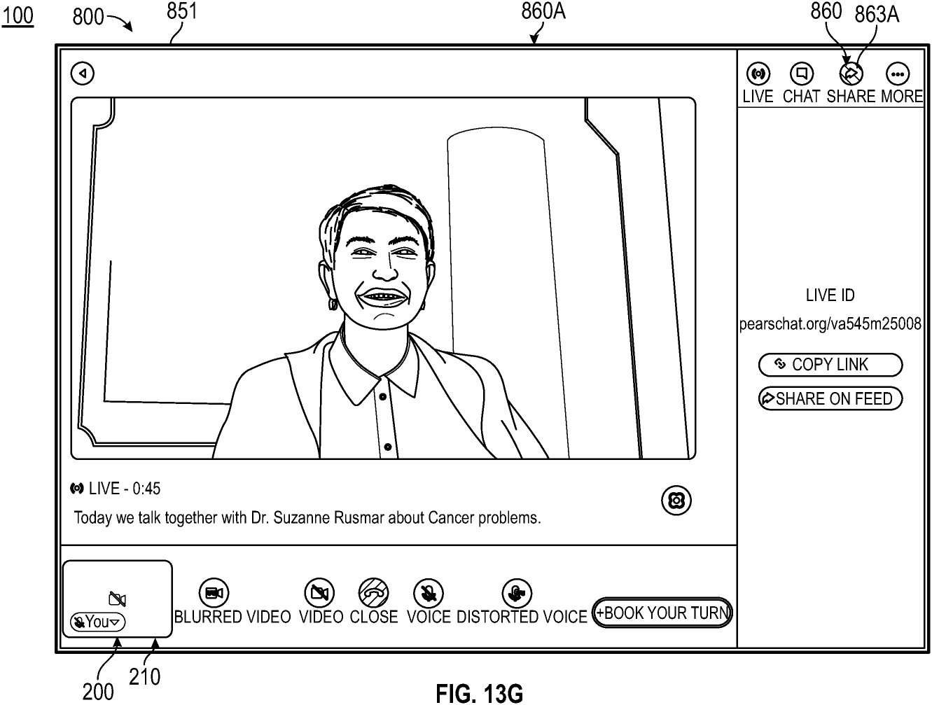

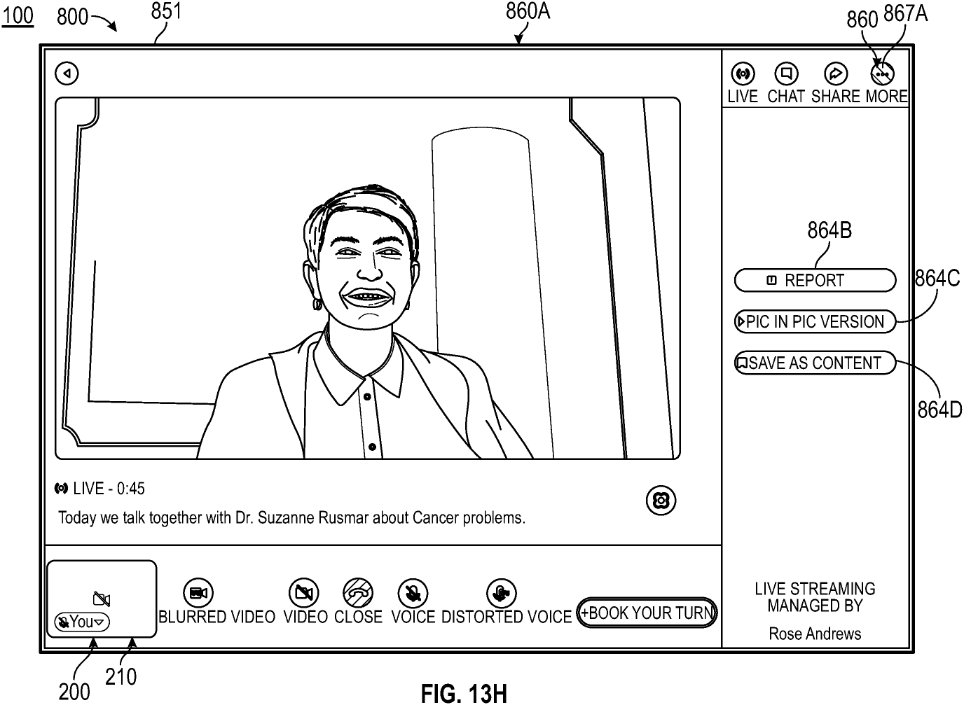

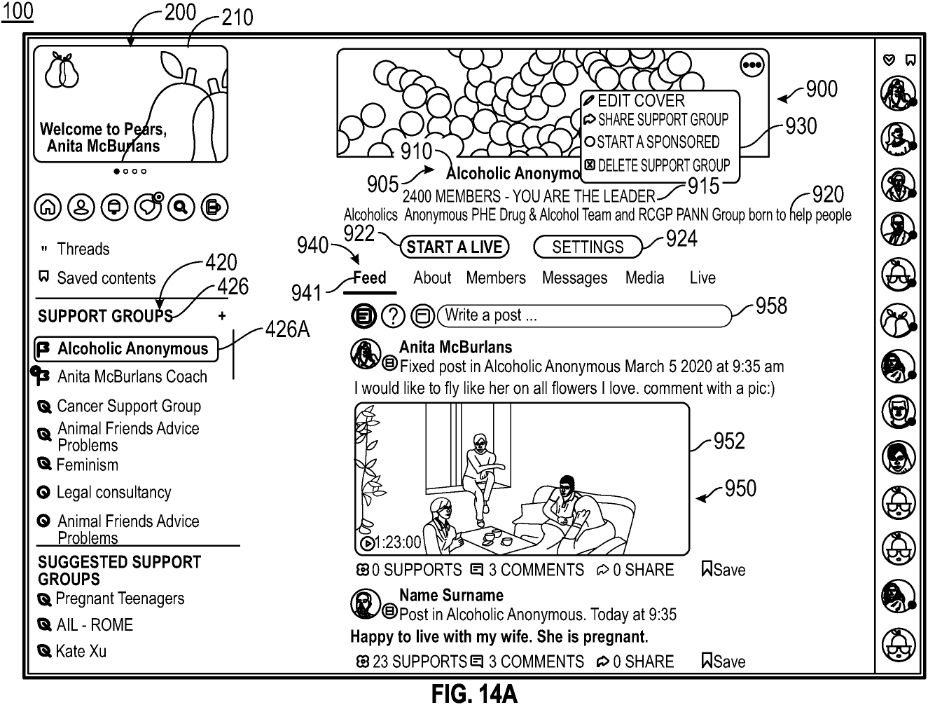

An exemplary live event page 860A for presenting the live event 851 to the selected support group 805 is shown in FIGS. 13A-H. Turning to FIG. 13A, for example, the multiuse communication system 100 can have a payment or other registration requirement 870 in advance of permitting access to the live event 851. Additionally and/or alternatively, the selected system user 210 can be presented with an option to attend the live event 851 anonymously or to provide a name or other identifying information.

The live event 851 can include video content, audio content and/or slides, reports or other written documents, without limitation. As shown in FIG. 13B, the live event page 860A can visually present one or more images of at least one speaker and audibly present a presentation by the speaker. The live event page 860A can enable the selected system user 210 to activate and/or deactivate a video camera 872, such as a computer web camera, for capturing an image of the selected system user 210 and presenting the captured image on the live event page 860A. The video camera 872 can be deactivated, for example, if the selected system user 210 does not wish to be seen or otherwise chooses to remain anonymous.

If the video camera 872 of the selected system user 210 is activated, the live event page 860A can present blurred video indicia 874. The blurred video indicia 874 can permit the selected system user 210 to blur the image of the selected system user 210 as shown in FIG. 13C. In selected embodiments, the blurred video indicia 874 can enable the selected system user 210 to control a level of blur for the video camera 872. Other attending members 227 also can be afforded an option to be seen on the live event page 860A, to provide a blurred image and/or to remain anonymous. The live event page 860A can include optional close event indicia 873 for enabling the selected system user 210 to terminate participation in the live event 851.

As illustrated in FIG. 13B, the live event page 860A can include navigation indicia 860. The navigation indicia 860 can help enable the system user 200 with navigating, viewing and otherwise accessing video content, audio content, documents and other event content associated with the live event 851. In selected embodiments, the live event page 860A can sort the available event content to facilitate content access. The live event page 860A, for example, can present the video content and/or audio content associated with the live event 851, at 861A.

Additionally and/or alternatively, the selected system user 210 can utilize book your turn indicia 874 if the selected system user 210 wishes to actively participate in the live event 851. The selected system user 210 can actively participate in the live event 851 by, for example, presenting a question to the speaker during the presentation. As a time for the selected system user 210 to speak approaches, the live event page 860A can present a preparation warning 871 as illustrated in FIG. 13D. The live event page 860A can enable the selected system user 210 to activate and/or deactivate a microphone 875, such as a computer microphone, for capturing the voice of the selected system user 210 for presentation during the live event 851. The microphone 875 can be activated when the selected system user 210 is ready to speak.

If the microphone 875 of the selected system user 210 is activated, the live event page 860A can present distorted voice indicia 876. The distorted voice indicia 876 can permit the selected system user 210 to distort the voice of the selected system user 210 as shown in FIGS. 13D and 13E. In selected embodiments, the distorted voice indicia 876 can enable the selected system user 210 to control a level of distortion for the microphone 875. Other attending members 227 also can be afforded an option to be heard during the live event 851, to distort their voices and/or to remain silent. The live event page 860A can include optional delete booking indicia 875 if the selected system user 210 decides against speaking or otherwise actively participating in the live event 851.

Turning to FIG. 13F, the live event page 860A can support a chat feature 862A associated with the live event 851, at 862A. The chat feature 862A can enable two or more of the attending members 227 to exchange chat messages 880 during the live event 851. The live event page 860A can permit the selected system user 210 to enter chat text 881, to insert one or more post attachments, such as a photograph, a video or other media item 463 (shown in FIG. 5), and/or to include at least one post emoticon 882 for a new chat message 880.

The live event page 860A optionally can enable the selected system user 210 to share the content associated with the live event 851, at 863A, as illustrated in FIG. 13G. Additionally and/or alternatively, the live event page 860A can support other event functions, at 864A, such as enabling the selected system user 210 to submit a report 864B, present the video content of the live event 851 in a picture-in-picture format 864C, and/or to save the content associated with the live event 851, at 864D, without limitation.

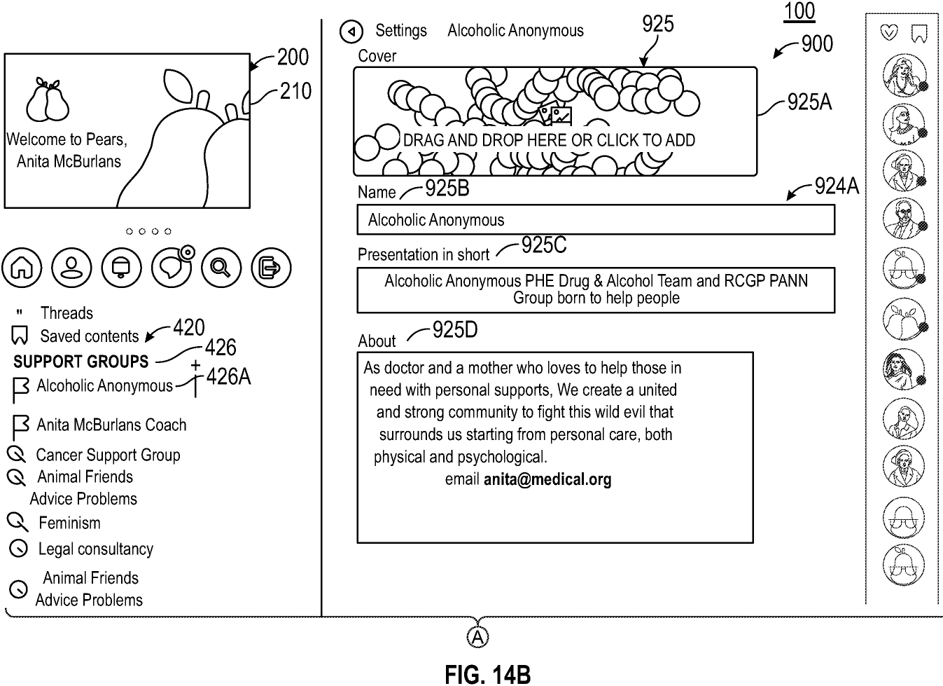

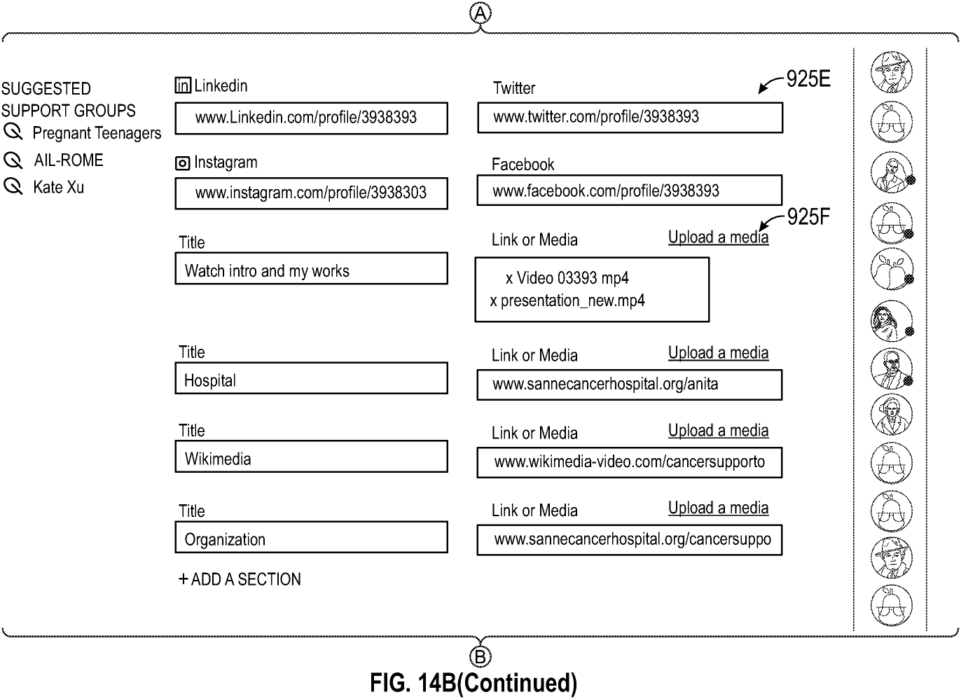

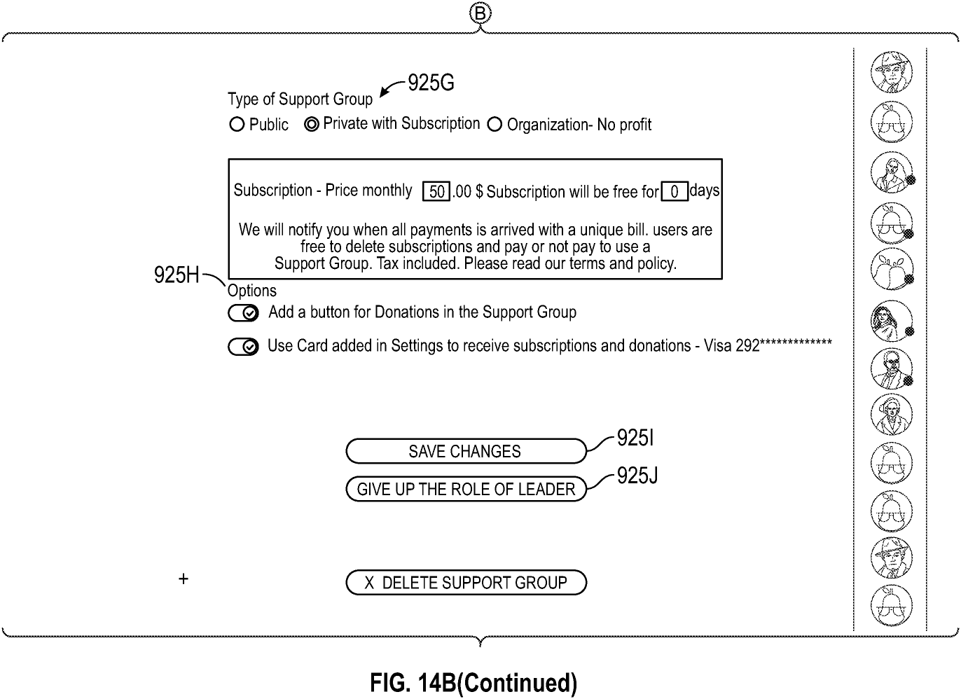

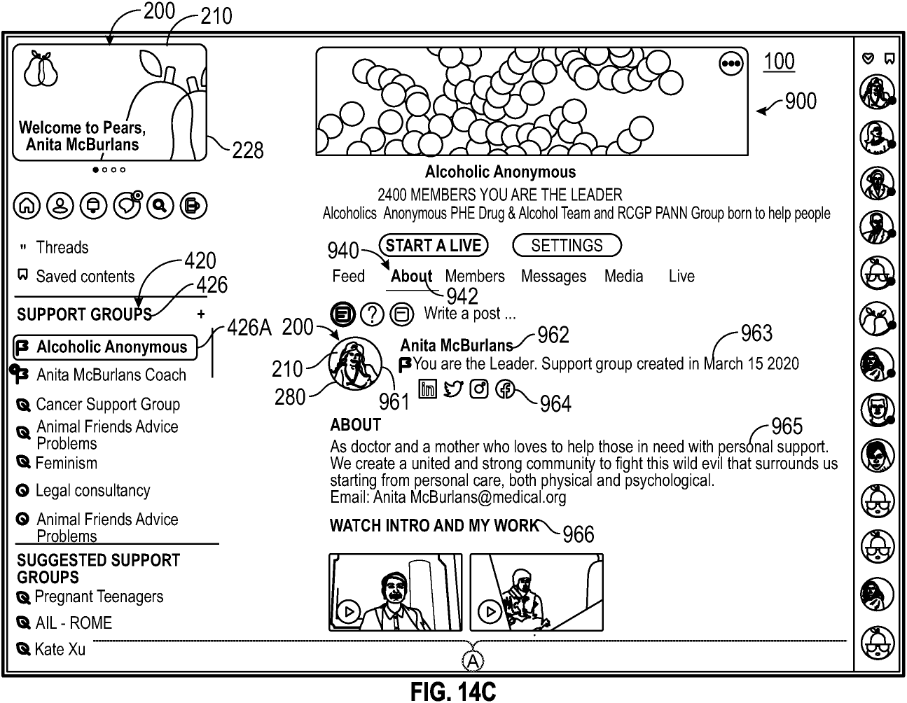

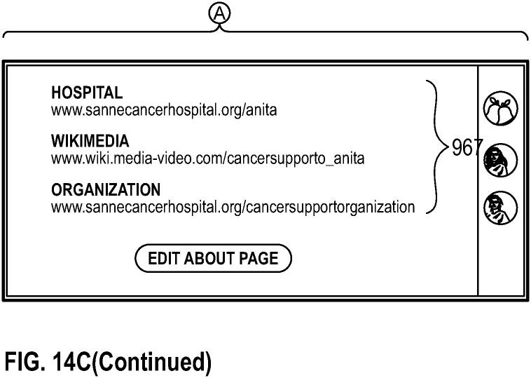

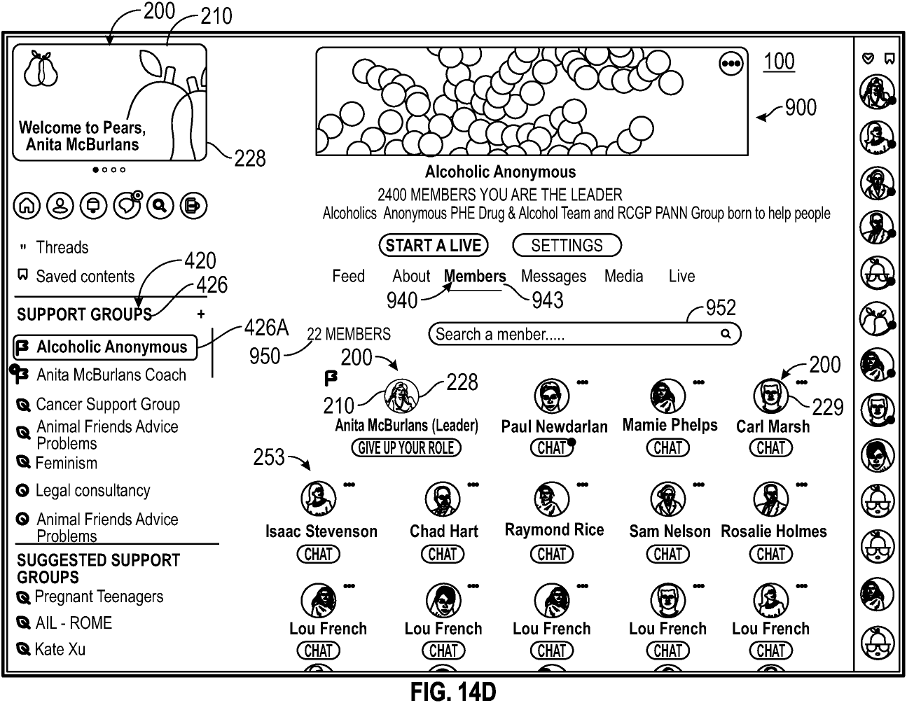

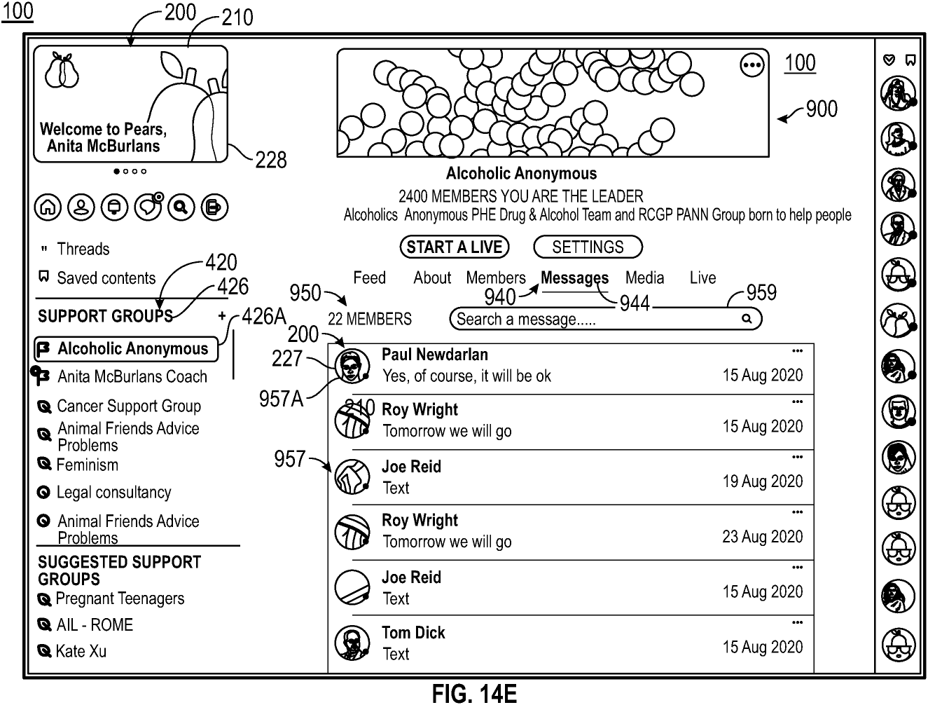

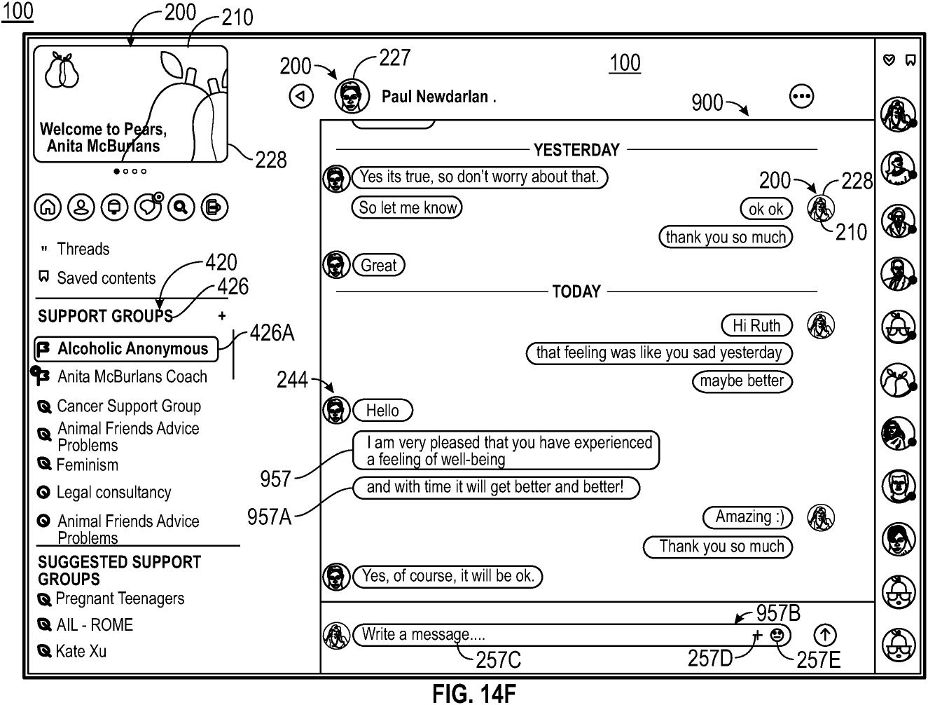

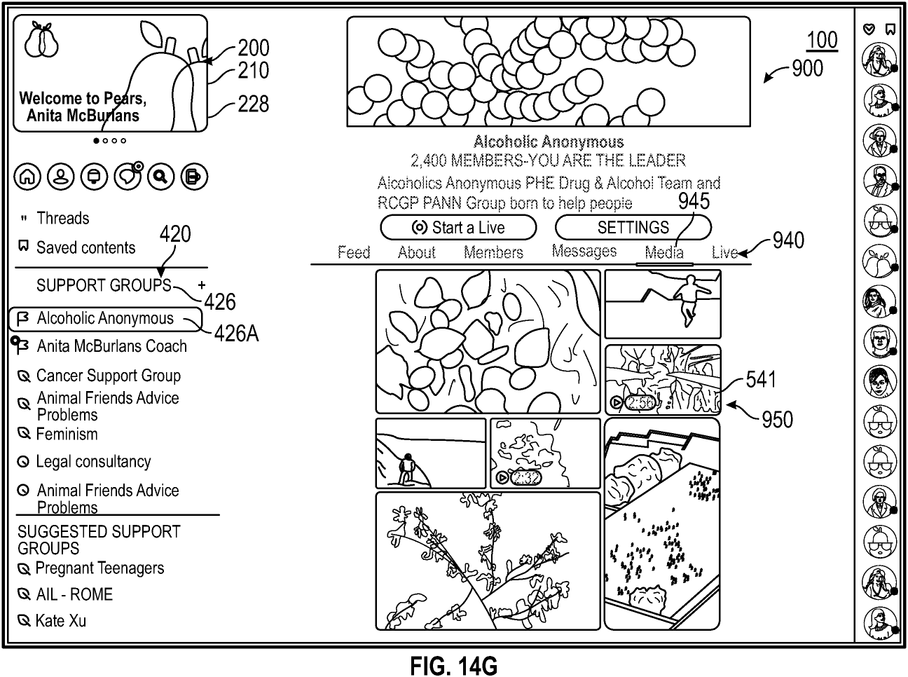

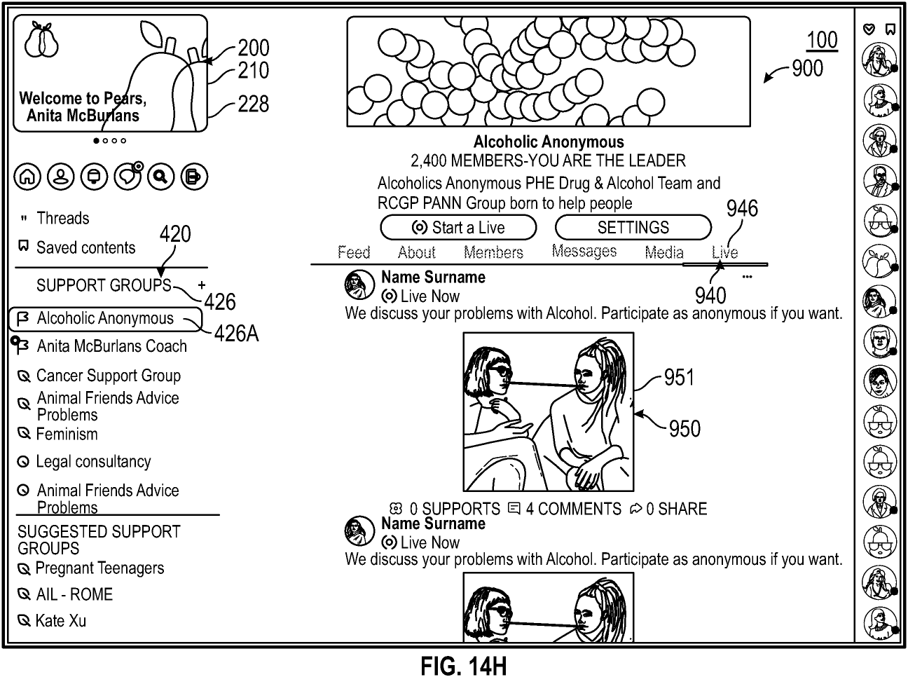

The membership of each group associated with the multiuse communication system 100 can include one or more leaders 228. In selected embodiments, the selected system user 210 can elect to become a leader 228 of a selected group, such as the selected support group 905, of the multiuse communication system 100. The multiuse communication system 100 can present a support group leadership page 900 as illustrated in FIG. 14A. The support group leadership page 900 can provide selected information about the selected support group 905, such as a group name 910, membership information 915, a purpose statement 920, cost and/or other group information, without limitation.

In selected embodiments, the support group leadership page 900 can include a share live event content option 922 for sharing live event content to the selected support group 905 and/or one or more other system users 220 who are members 227 of the selected support group 905. The support group leadership page 900 optionally can include a settings option 924 for enabling the selected system user 210, as a leader 228 of the selected support group 905, to prepare, update and/or maintain a group profile 924A (shown in FIG. 14B) for the selected support group 905. As illustrated in FIG. 14A, the group name 910 can be included among the subscribed support group links 426.

The support group leadership page 900 optionally can provide support group management indicia 930 for managing the selected support group 905. As illustrated in FIG. 14A, for example, the support group management indicia 930 can enable the selected system user 210 to edit a cover for the selected support group 905, to share the selected support group 905 with other system users 200, to start a sponsorship for the selected support group 905, to delete the selected support group 905 and/or to otherwise manage the selected support group 905.

Additionally and/or alternatively, the support group leadership page 900 can provide support group membership control indicia 940 for navigating the support group leadership page 900 and/or accessing support group content 950 available via the support group leadership page 900. The support group membership control indicia 940, for example, can permit the selected system user 210 to view and otherwise access feed materials 941 associated with the selected support group 905, overview information 942 about the selected support group 905, membership information 943 for the selected support group 905, messages 944 associated with the selected support group 905, media 945 associated with the selected support group 905 and/or live materials 946 for the selected support group 905, without limitation.

The feed materials 941 can include, but are not limited to, one or more questions 630A, one or more posts 630B, one or more media items 630C, one or more events 630D, one or more group invitations (or subscription requests) 630E and/or one or more advertisements 630F (collectively shown in FIG. 9A). As shown in FIG. 14A, for example, the feed materials 941 can enable the selected system user 210 to view an available post 952 and/or to write a new post 958. In selected embodiments, the selected system user 210 to chat or otherwise communicate with one or more other members 227 of the selected support group 905 via the support group leadership page 900.

An exemplary group profile page 925 for preparing, updating and/or maintaining the group profile 924A is illustrated in FIG. 14B. Turning to FIG. 14B, the group profile page 925 can enable the selected system user 210, as a leader 228 of the selected support group 905, to prepare, update and/or maintain the group profile 924A. The group profile page 925 can enable the selected system user 210 to add, modify and/or delete a group name 925B of the selected support group 905, a group abstract 925C for the selected support group 905, a group mission statement 925D for the selected support group 905, and/or other demographic information associated with the selected support group 905.

In selected embodiments, the group profile page 925 can enable the selected system user 210 to add, modify and/or delete contact information 925E for the selected support group 905, a catalogue of reference materials 925F relevant to the selected support group 905, a group type 925G of the selected support group 905 and/or other group profile page options 925H. For example, the group type 925G can comprise a public group type, a private group and/or a nonprofit organization group and/or a group that is free or requires payment of a subscription fee. Other group profile page options 925H can include, but are not limited to, adding a donations button to the group profile 924A of the selected support group 905 and/or subscription fee payment processing procedure. Any changes to the group profile 924A can be saved, at 925I, and/or the selected system user 210 can withdraw from being a leader 228 of the selected support group 905, at 925J.

Turning to FIG. 14C, the support group leadership page 900 can permit the selected system user 210, as a leader 228 of the selected support group 905, to view and otherwise access overview information 942 about the selected support group 905. The overview information 942, for example, can provide leadership information about the selected system user 210 and any other leader 228 of the selected support group 905. The other leaders 228 of the selected support group 905 can include one or more peer users 222, one or more volunteer users 224 and/or one or more coach users 226 (collectively shown in FIG. 1B). As shown in FIG. 14C, for example, the leadership information can comprise, but is not limited to, an image 961, a name 962, leadership information 963, contact information 964, demographic information 965, introductory and/or reference materials 966, external reference materials 967 and/or other member information about the leaders 228.

The support group leadership page 900 of FIG. 14D can permit the selected system user 210 to view and otherwise access membership information 943 for the selected support group 905. The members 227 of the selected support group 905 can include one or more peer users 222, one or more volunteer users 224 and/or one or more coach users 226 (collectively shown in FIG. 1B). As shown in FIG. 14D, for example, the membership information 951 can comprise member information about a leader 228 and/or non-leader members 229 of the selected support group 905. The support group leadership page 900 can include, but is not limited to, an image, a name, contact information, demographic information and/or other member information about the members 227. The support group leadership page 900 optionally can enable the selected system user 210 to search, at 952, within the membership information 951 and/or to chat or otherwise communicate with one or more other members 227 of the selected support group 905.

Message information 944 related to one or more messages 957 among the members 227 of the selected support group 905 can be viewed, exchanged and/or otherwise accessed via the support group leadership page 900 shown in FIG. 14E. Each message 957 can include information about the participating members 227 and the message text of the message 957. In selected embodiments, the support group leadership page 900 can enable the selected system user 210 to select a particular message 957A for further review. Turning to FIG. 14F, for example, the support group leadership page 900 is shown as presenting message exchanges between the selected system user 210 and a selected member 227 as associated with the selected message 957A. The support group leadership page 900 optionally can enable the selected system user 210 to create a new message 957B. The new message 957B can include message text 957C, one or more message attachments 957D, such as a photograph, a video or other media item 463 (shown in FIG. 5), and/or at least one message emoticon 957E, without limitation. FIG. 14E illustrates that the support group leadership page 900 can enable the selected system user 210 to search, at 959, among the messages 957.

FIG. 14G illustrates that one or more media content items 544 optionally can be accessed via a media page 945 associated with the selected support group 905. The media content items 544 can include any suitable type of media content, such as photographs and/or videos, without limitation. Additionally and/or alternatively, live materials 946, such as a streamed (or live) live event 951, for the selected support group 905 can be viewed or otherwise accessed via the support group leadership page 900 shown in FIG. 14H.

The support group membership control indicia 940 of the support group leadership page 900 can be provided in the manner set forth above with reference to the support group membership control indicia 940 of FIGS. 14A-F. The support group membership control indicia 940 can include shop materials associated with the selected support group 805 (shown in FIG. 12A). Selection of the shop materials can enable the system user 200 to shop for selected products and/or services, including, but not limited to, events, videos, products (or items) in the manner set forth in more detail above with reference to the shop contents category 457 of FIGS. 20I-R. Media associated with the selected support group 805 thereby can be accessed via the access feed materials 941, the live materials 946 and/or the shop materials for the selected support group 805.

The multiuse communication system 100 can enable the system user 210 to communicate with other members 227 of a support group 805. For example, the system user 200 optionally can communicate with one or more of the other members 227 in real time via a chatroom. In selected embodiments, the multiuse communication system 100 can present a chatroom page for facilitating communication between the system user 200 and the other members 227.

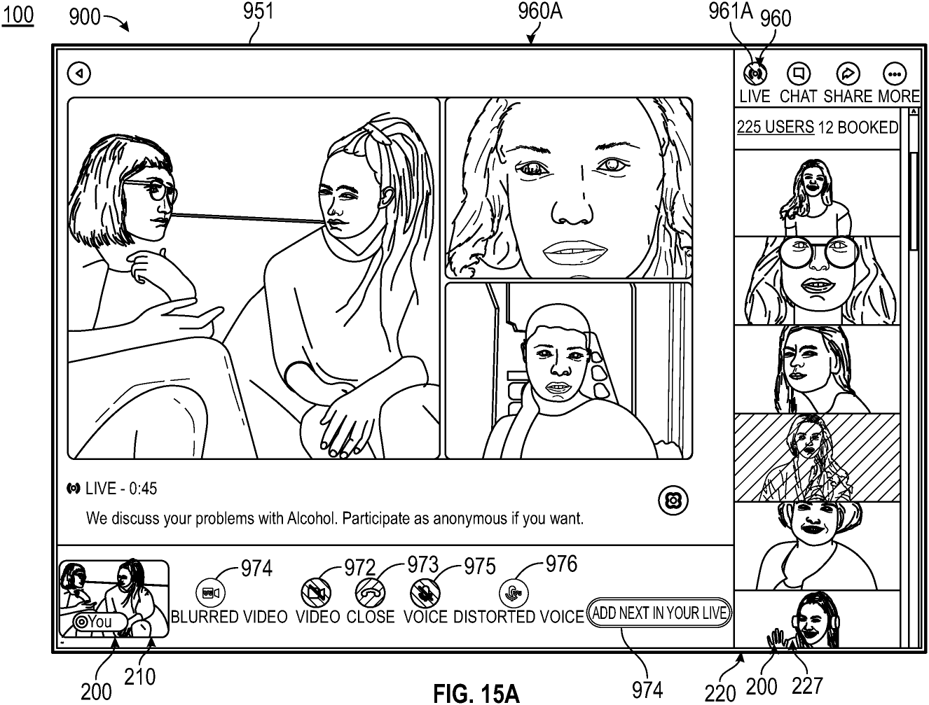

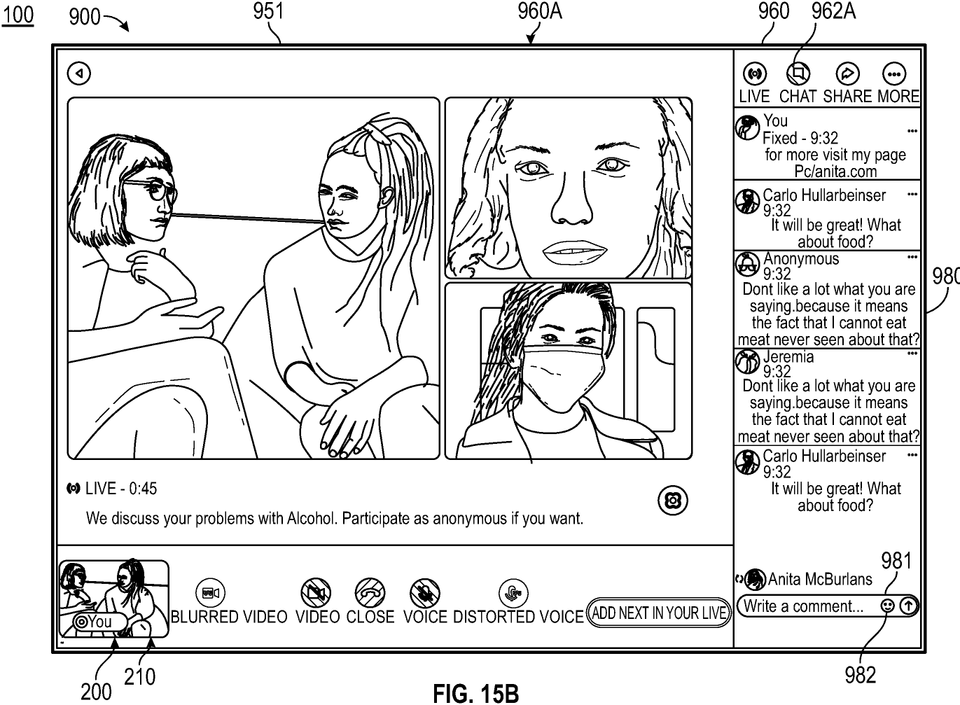

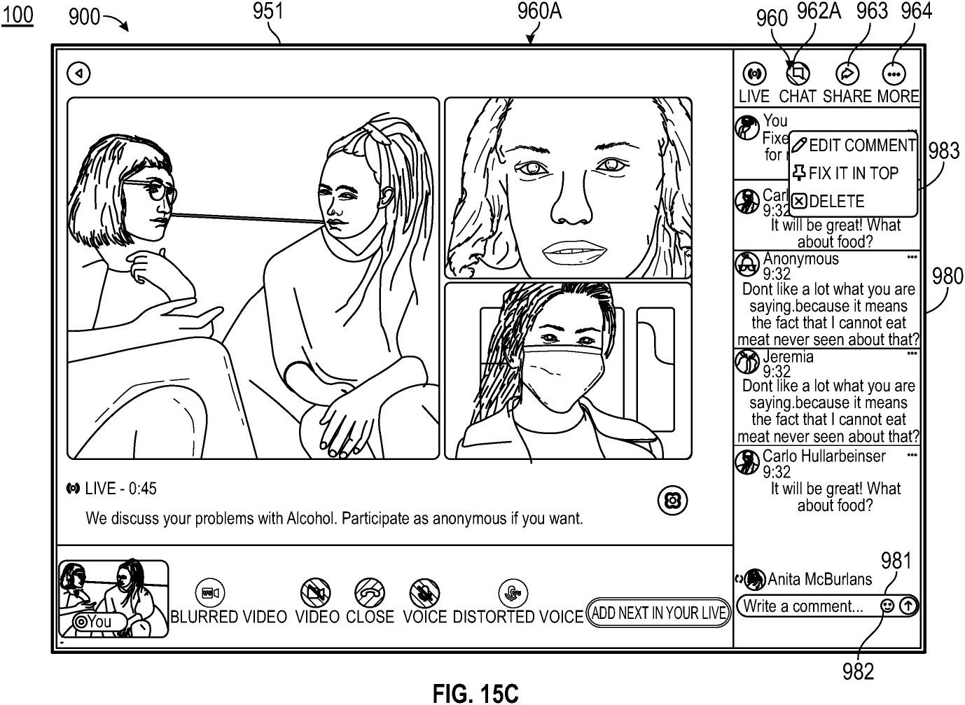

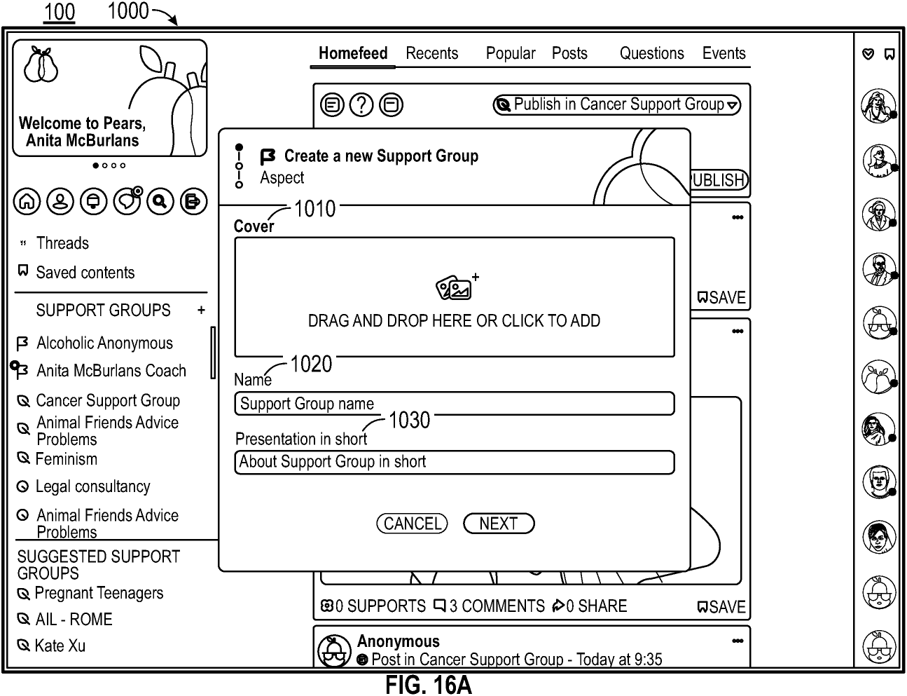

An exemplary live event page 960A for presenting the live event 951 to the selected support group 905 is shown in FIGS. 15A-C. In selected embodiments, the live event page 960A can support identical functionality as is supported by the live event page 860A discussed in more detail above with reference to FIGS. 13A-H. The live event 951 can include video content, audio content and/or slides, reports or other written documents, without limitation. As shown in FIG. 15A, for example, the live event page 960A can visually present one or more images of at least one speaker and audibly present a presentation by the speaker. Additionally and/or alternatively, the live event page 960A can enable the selected system user 210 to activate and/or deactivate a video camera 972, such as a computer web camera, for capturing an image of the selected system user 210 and presenting the captured image on the live event page 960A. The video camera 972 can be deactivated, for example, if the selected system user 210 does not wish to be seen or otherwise chooses to remain anonymous.

If the video camera 972 of the selected system user 210 is activated, the live event page 960A can present blurred video indicia 974. The blurred video indicia 974 can permit the selected system user 210 to blur the image of the selected system user 210 in the manner shown and described above with reference to FIG. 13C. In selected embodiments, the blurred video indicia 974 can enable the selected system user 210 to control a level of blur for the video camera 972. Other attending members 227 also can be afforded an option to be seen on the live event page 960A, to provide a blurred image and/or to remain anonymous. The live event page 960A can include optional close event indicia 973 for enabling the selected system user 210 to terminate participation in the live event 951.

As illustrated in FIG. 15A, the live event page 960A can include navigation indicia 960. The navigation indicia 960 can help enable the system user 200 with navigating, viewing and otherwise accessing video content, audio content, documents and other event content associated with the live event 951. In selected embodiments, the live event page 960A can sort the available event content to facilitate content access. The live event page 960A, for example, can present the video content and/or audio content associated with the live event 951, at 961A. Additionally and/or alternatively, the selected system user 210 can utilize add next indicia 974 if the selected system user 210 wishes to add a new live event to the live event page 960A.

The live event page 960A optionally can enable the selected system user 210 to activate and/or deactivate a microphone 975, such as a computer microphone, for capturing the voice of the selected system user 210 for presentation during the live event 951. The microphone 975 can be activated, for example, when the selected system user 210 is ready to speak. If the microphone 975 of the selected system user 210 is activated, the live event page 960A can present distorted voice indicia 976. The distorted voice indicia 976 can permit the selected system user 210 to distort the voice of the selected system user 210 in the manner shown and described above with reference to FIGS. 13D and 13E. In selected embodiments, the distorted voice indicia 976 can enable the selected system user 210 to control a level of distortion for the microphone 975. Other attending members 227 also can be afforded an option to be heard during the live event 951, to distort their voices and/or to remain silent.

Turning to FIG. 15B, the live event page 960A can support a chat feature 962A associated with the live event 951, at 962A. The chat feature 962A can enable two or more of the attending members 227 to exchange chat messages 980 during the live event 951. The live event page 960A can permit the selected system user 210 to enter chat text 981, to insert one or more post attachments, such as a photograph, a video or other media item 463 (shown in FIG. 5), and/or to include at least one post emoticon 982 for a new chat message 980. The live event page 960A optionally can enable the selected system user 210 to moderate or otherwise control the chat messages 980 exchanged among the attending members 227. As shown in FIG. 15C, for example, the live event page 960A can permit the attending members 227 to edit a chat message 980, to delete a chat message 980 and/or to fix a chat message 980, at 983.

The live event page 960A optionally can enable the selected system user 210 to share the content associated with the live event 951, at 963A, in the manner shown and described above with reference to FIG. 13G. Additionally and/or alternatively, the live event page 960A can support other event functions, at 964A, such as enabling the selected system user 210 to submit a report, present the video content of the live event 951 in a picture-in-picture format, and/or to save the content associated with the live event 951 in the manner shown and described above with reference to FIG. 13H.

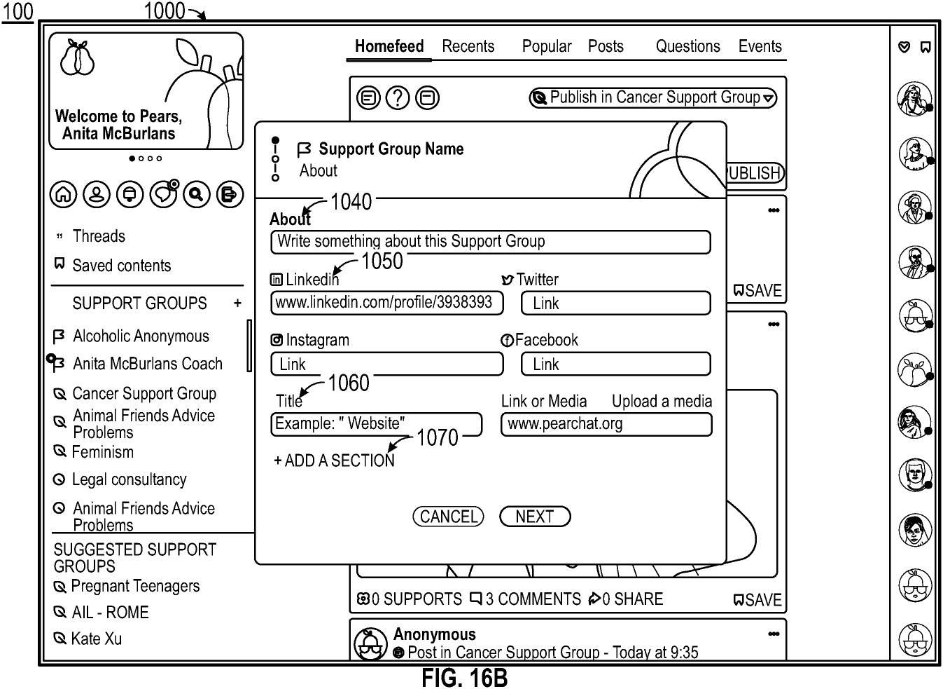

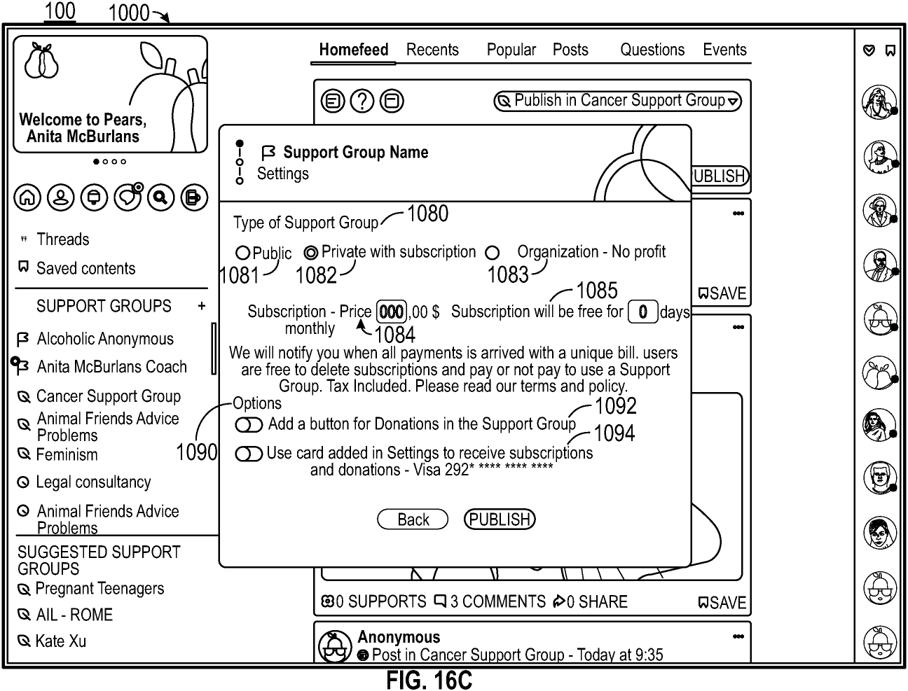

In selected embodiments, the multiuse communication system 100 can permit the selected system user 210 to create one or more new support groups. Turning to FIGS. 16A-C, an exemplary new group creation page 1000 for creating a profile for the new support group is shown. The new group creation page 1000 can enable the selected system user 210 to enter information for creating the new support group. As shown in FIG. 16A, for example, the new group creation page 1000 can permit entry of overview information, such as cover information 1010, a name 1020 and/or a presentation in short 1030, without limitation, for the new support group. The new group creation page 1000 optionally can enable entry of a group abstract 1040, contact information 1050 and/or media and other reference materials 1060 relevant to the new support group as illustrated in FIG. 16B. In selected embodiments, one or more new sections 1070 can be included in the new group profile.

Additionally and/or alternatively, the new group profile can include a support group type 1080 as illustrated in FIG. 16C. Exemplary support group types can include a public support group 1081, a private support group 1082 and/or a non-profit organization support group 1083. If the new support group is a private support group 1082 or otherwise requires a subscription fee, the new group profile can include a subscription fee amount 1084. The subscription fee amount 1084 can include an initiation fee amount, a one-time fee amount and/or a periodic fee amount, such as annually or monthly. The subscription fee can include one or more optional promotions, such as a free trial period 1085.

In selected embodiments, the new group creation page 1000 can present one or more optional new group profile features 1090. The optional new group profile features 1090 can include, but are not limited to, a donations option 1092 for making a voluntary donation to the new support group and/or subscription fee payment option 1094 for processing any subscription fee payment, without limitation.

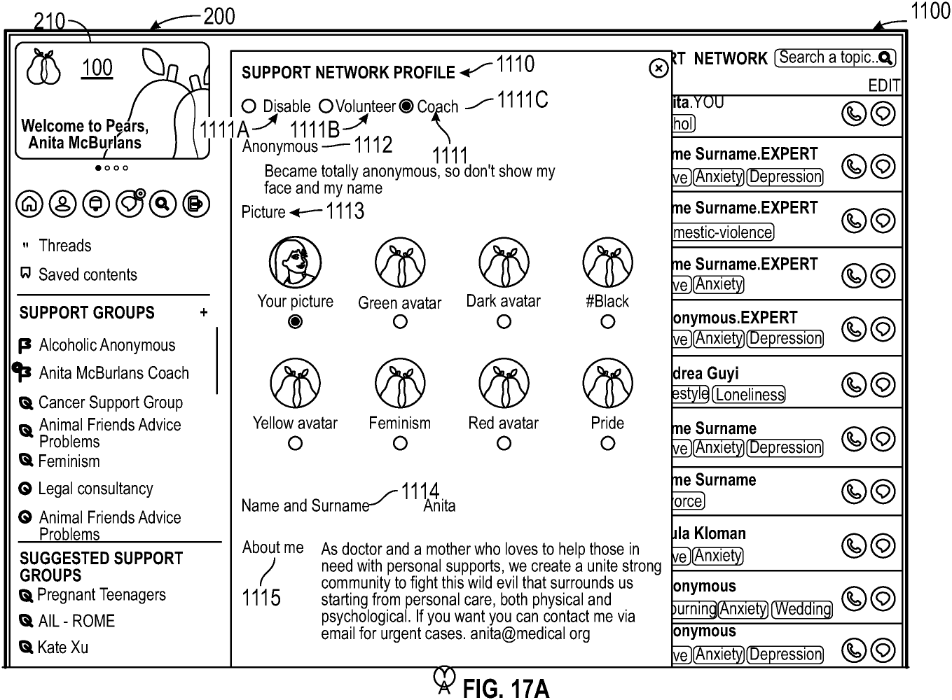

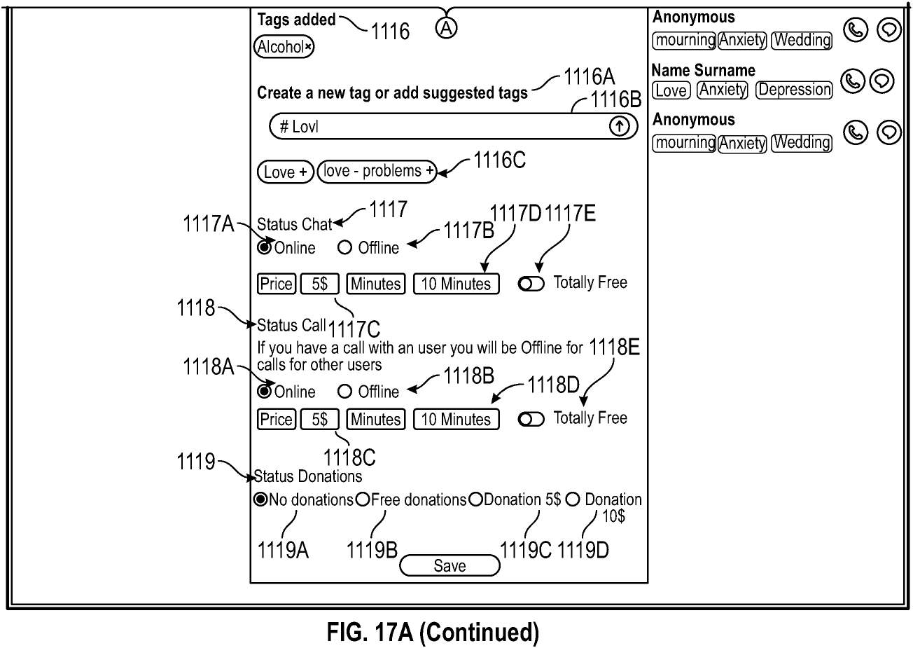

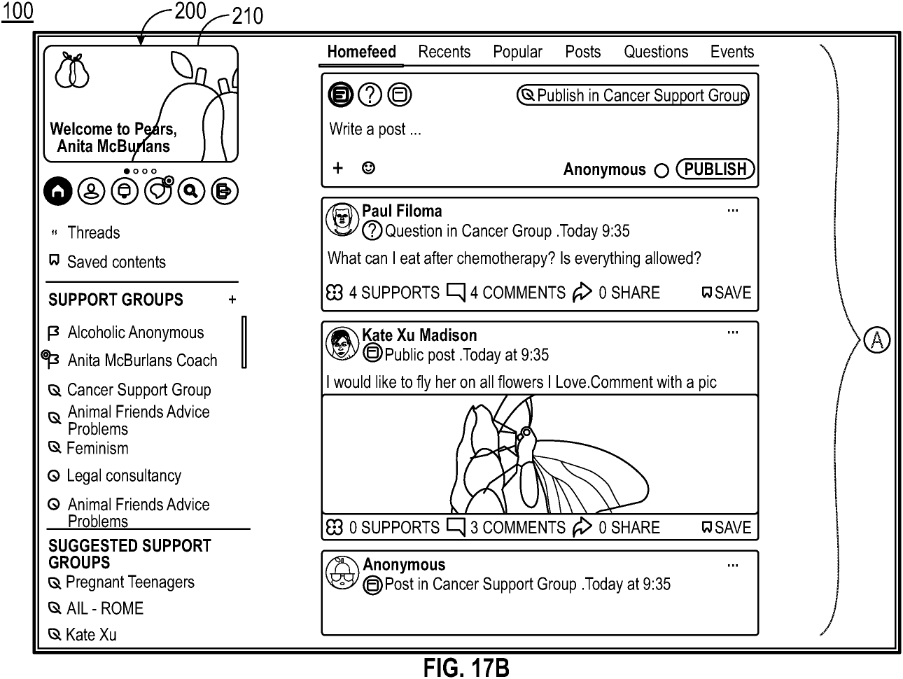

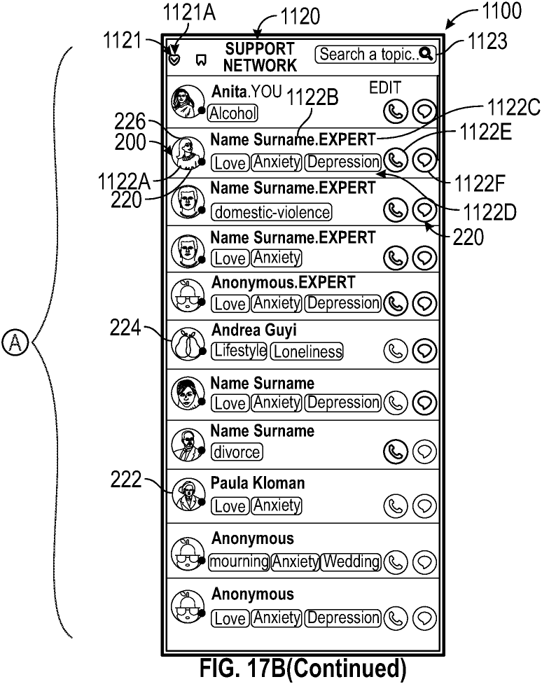

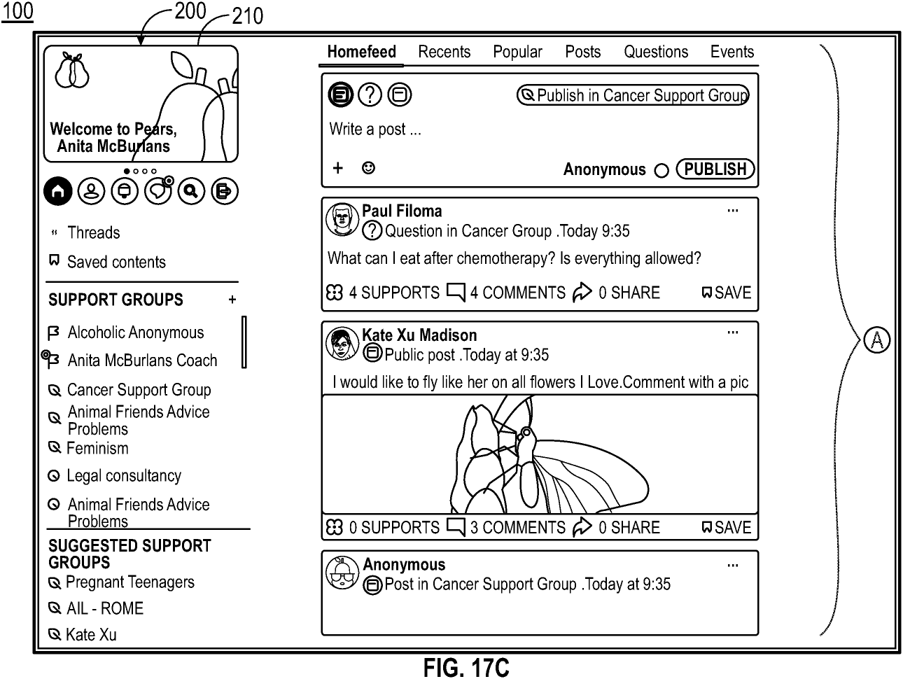

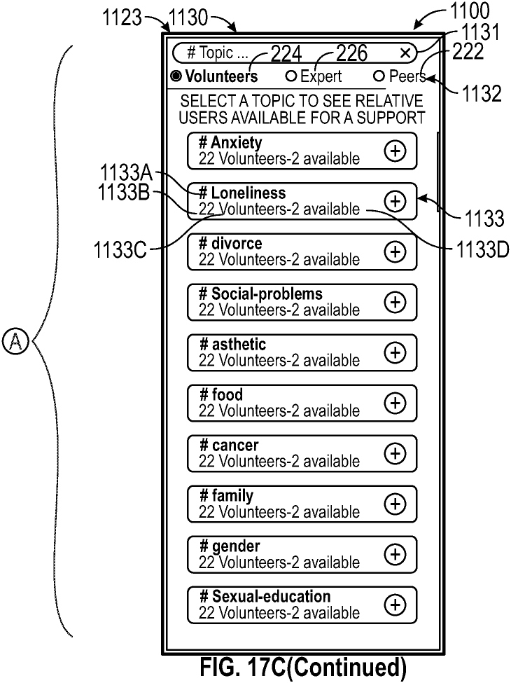

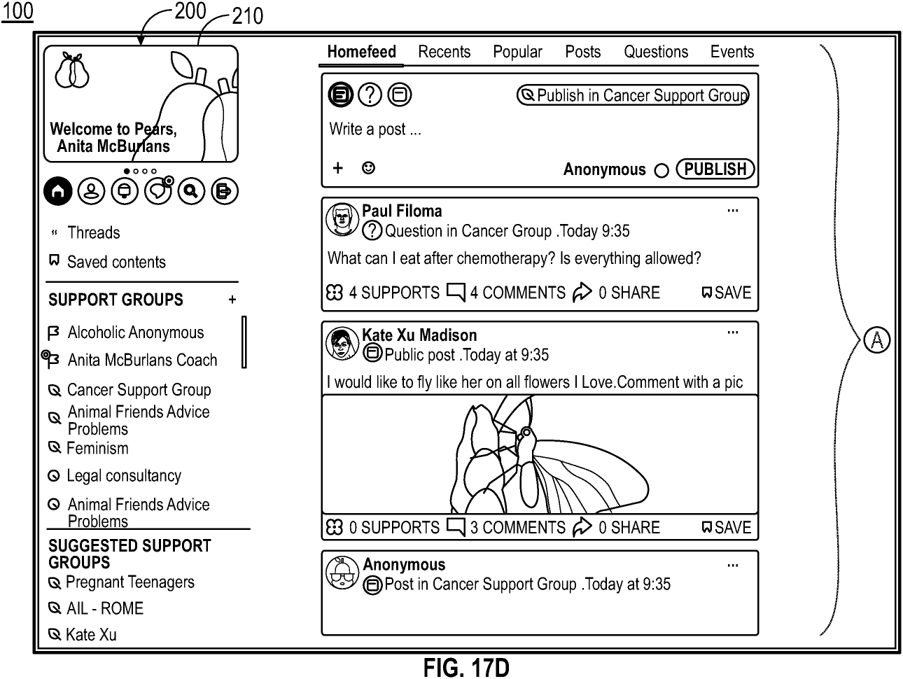

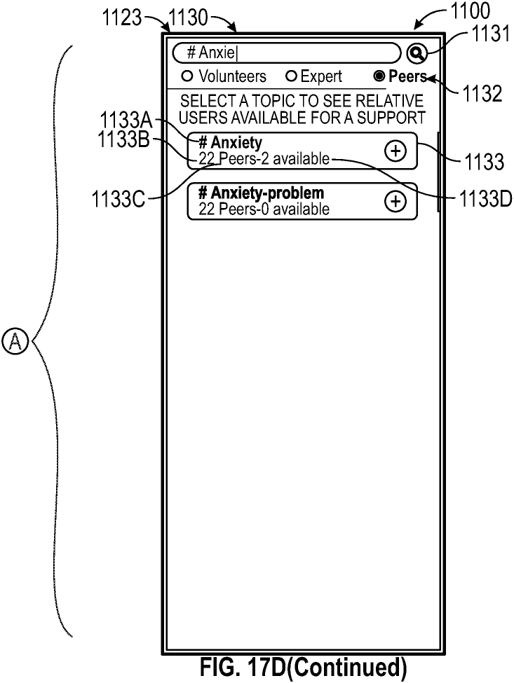

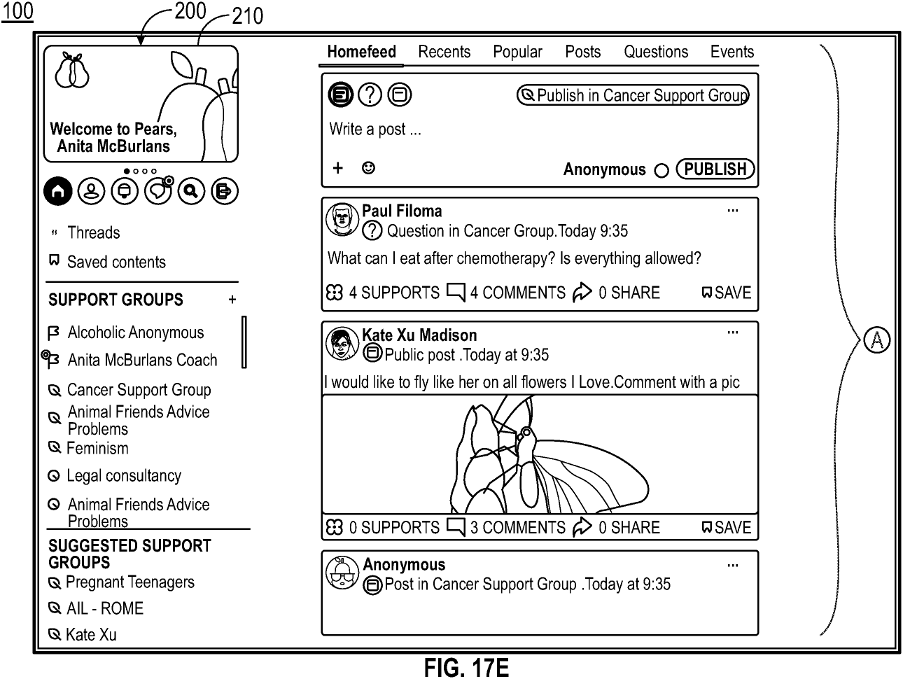

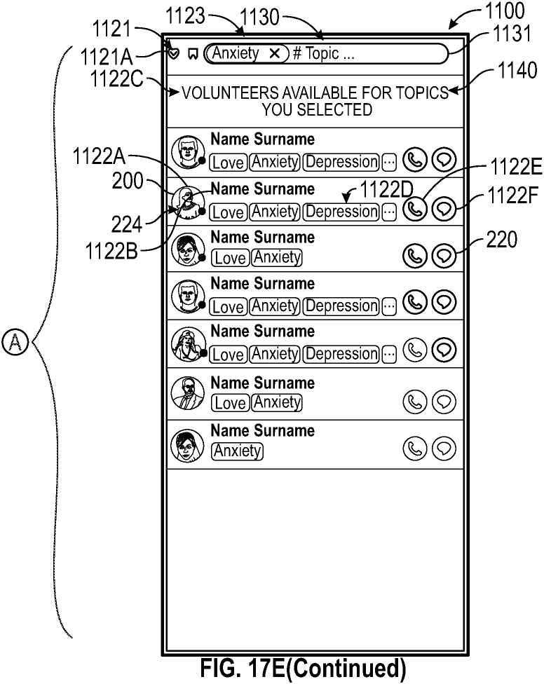

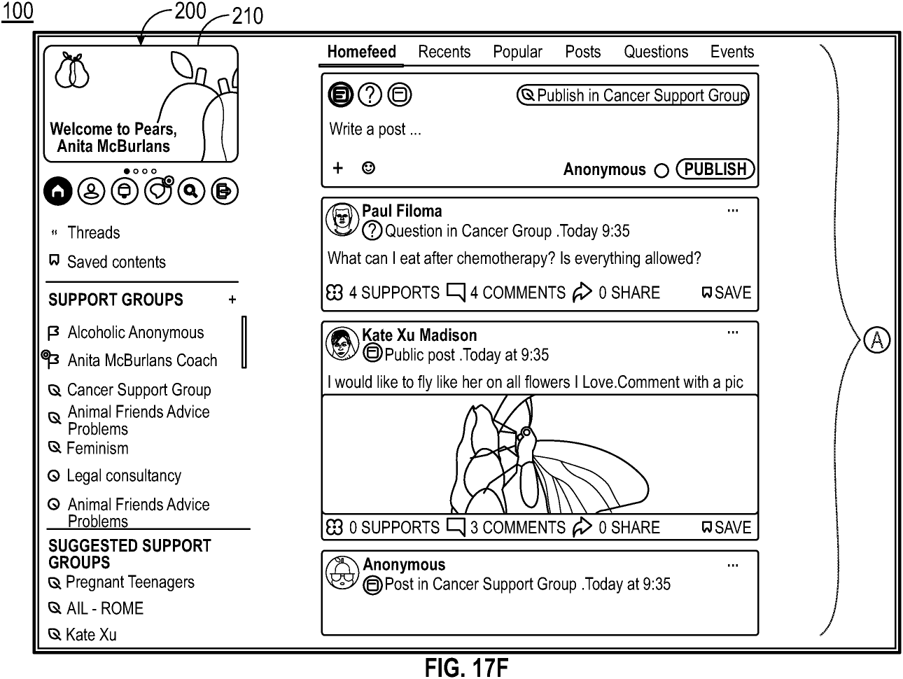

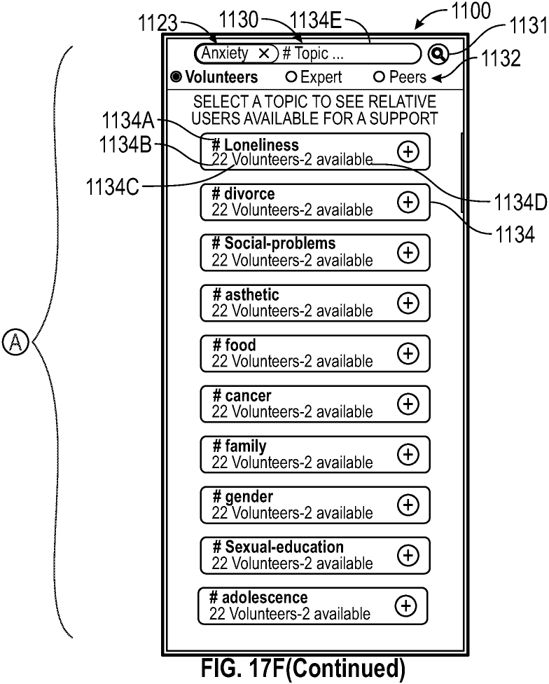

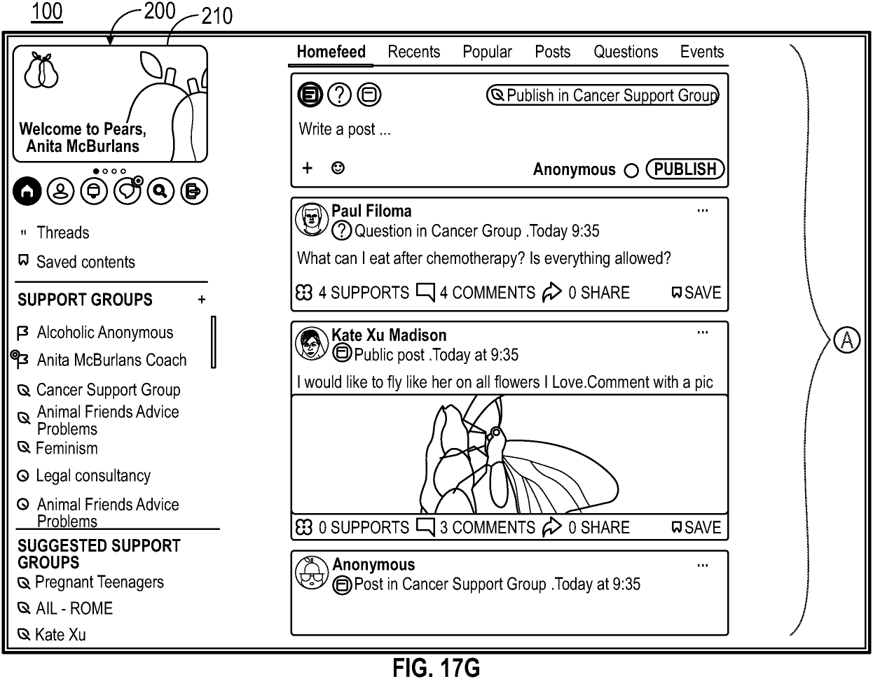

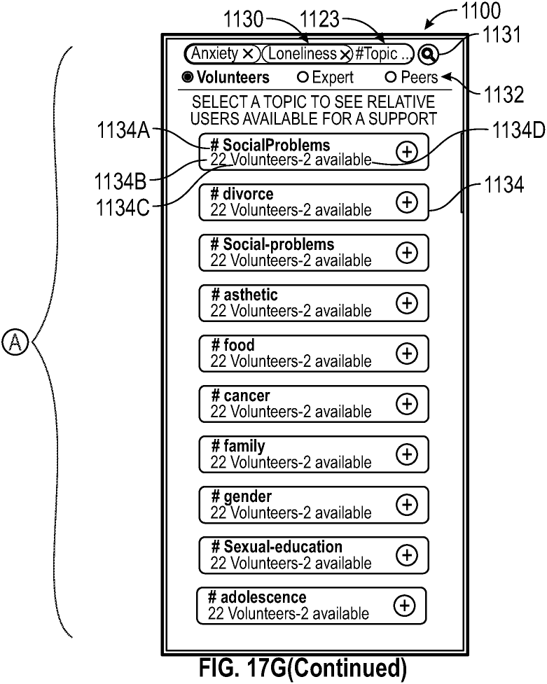

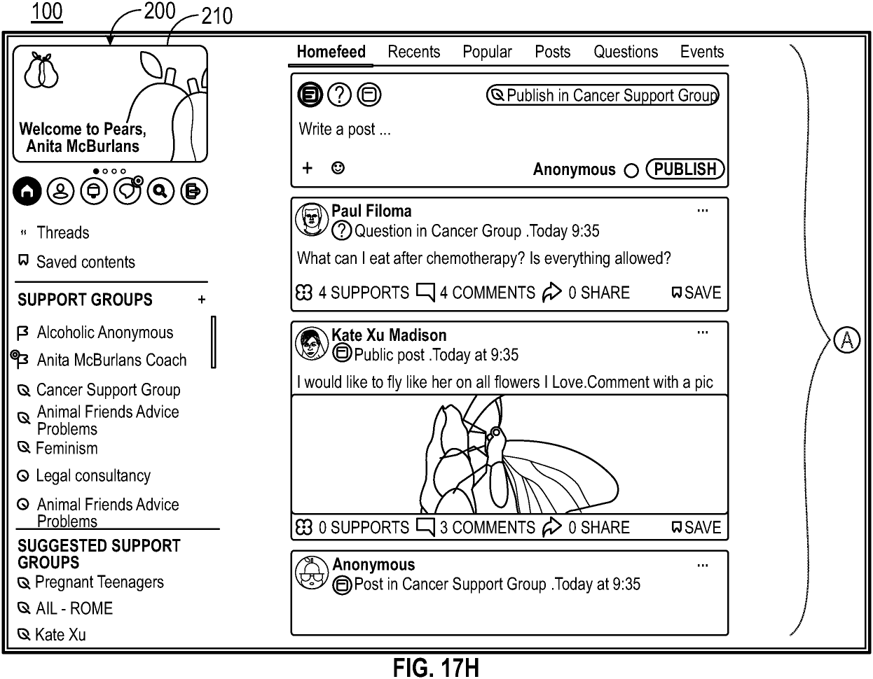

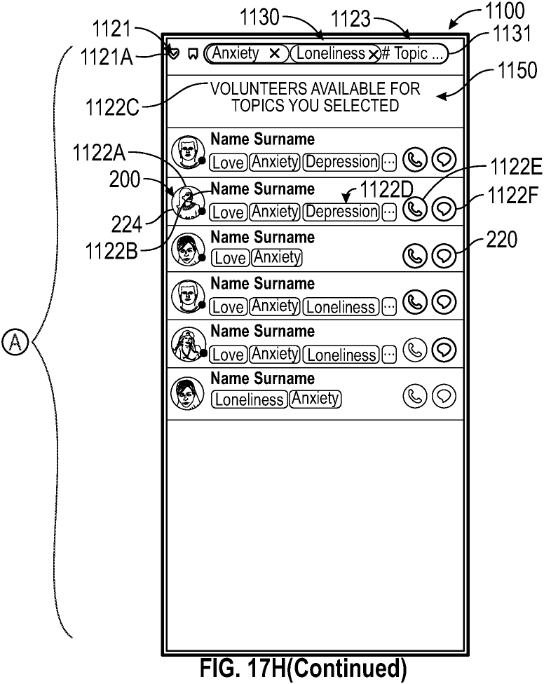

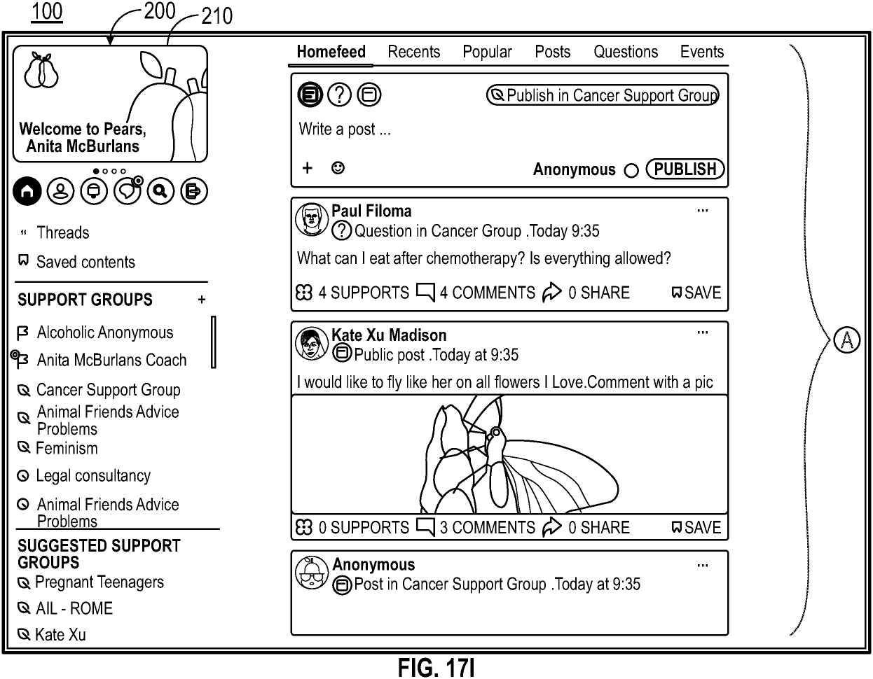

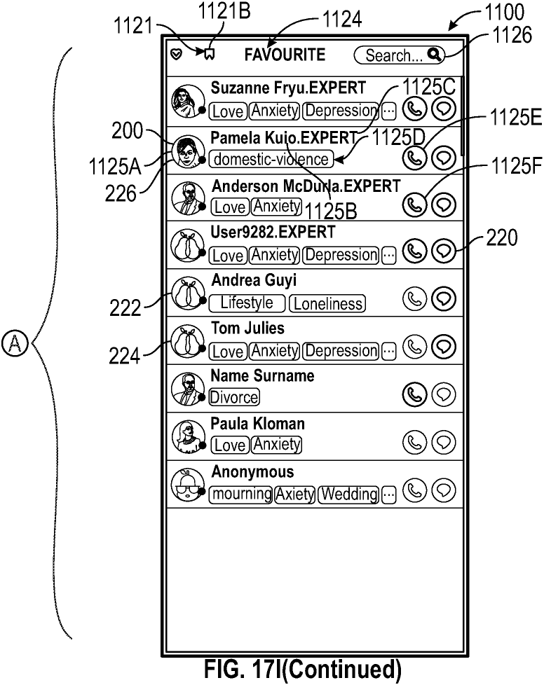

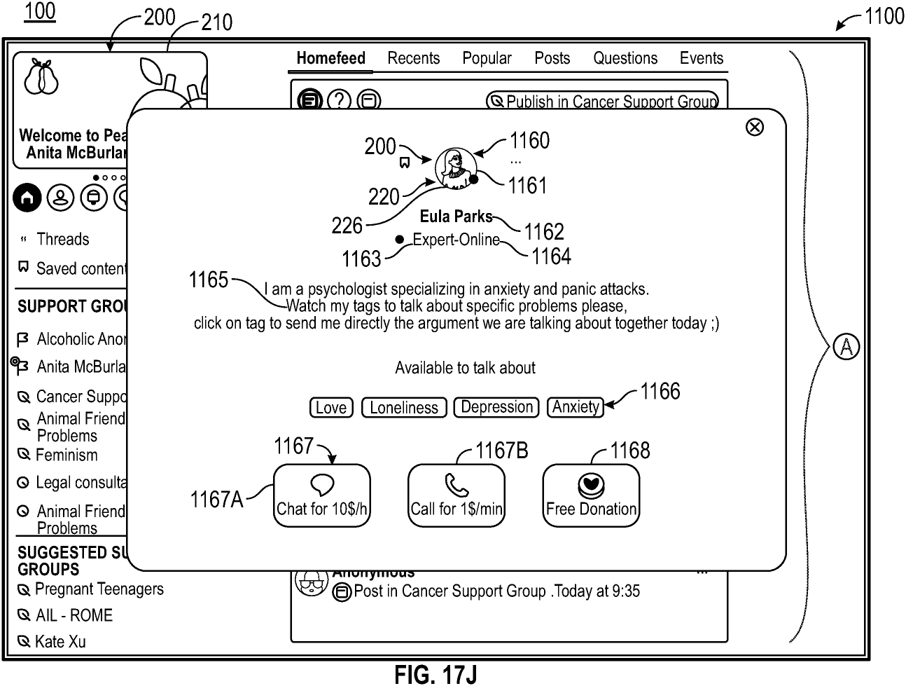

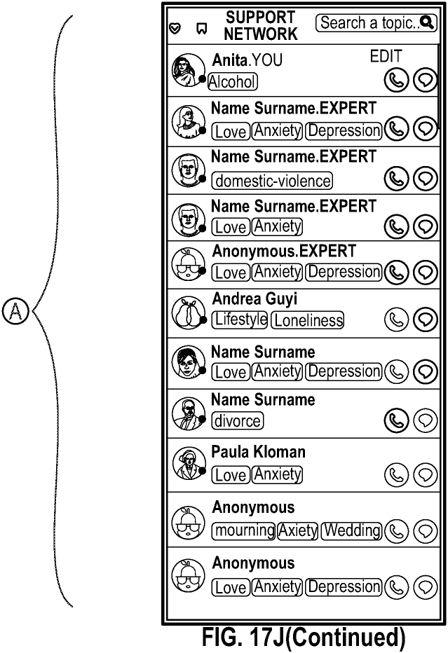

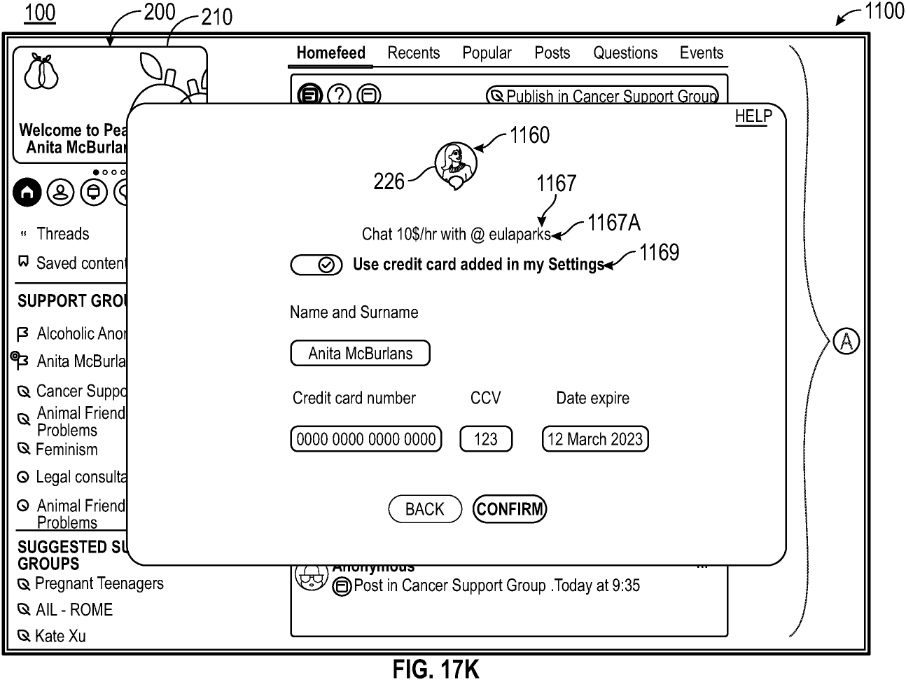

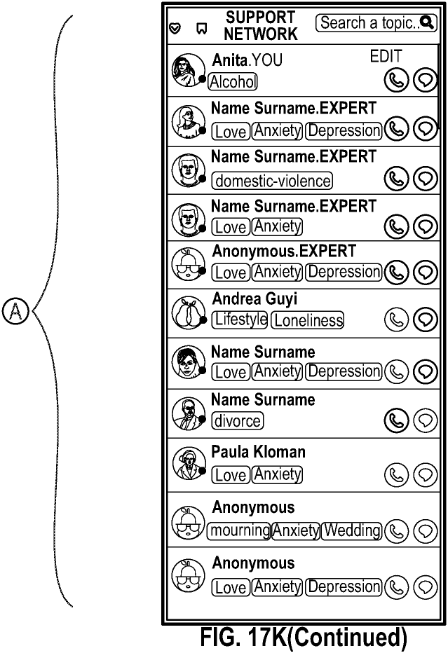

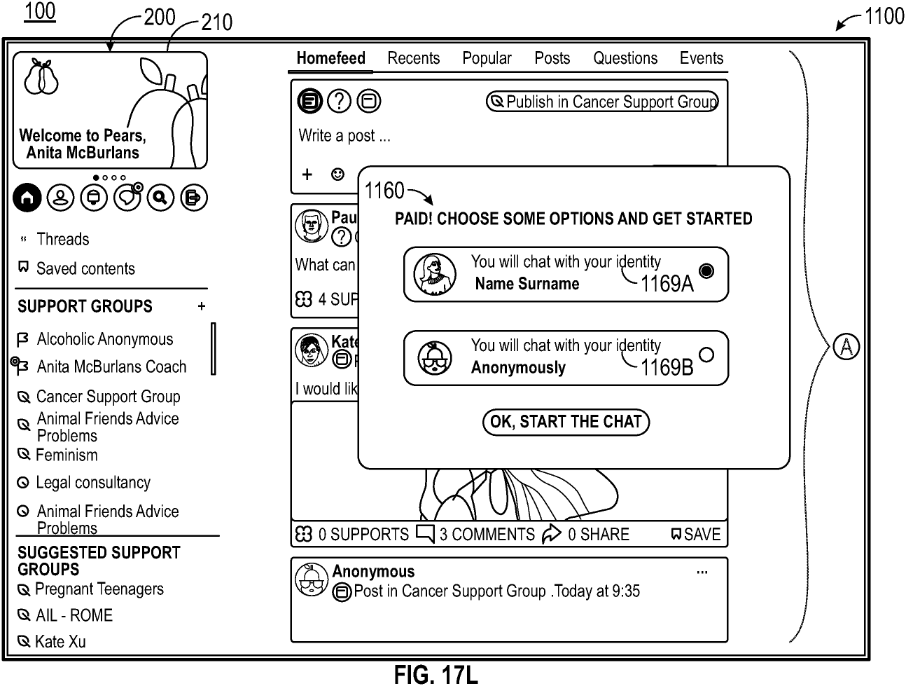

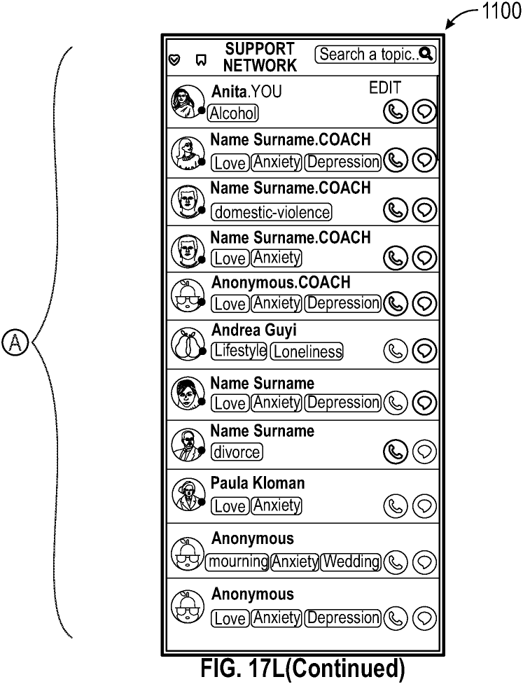

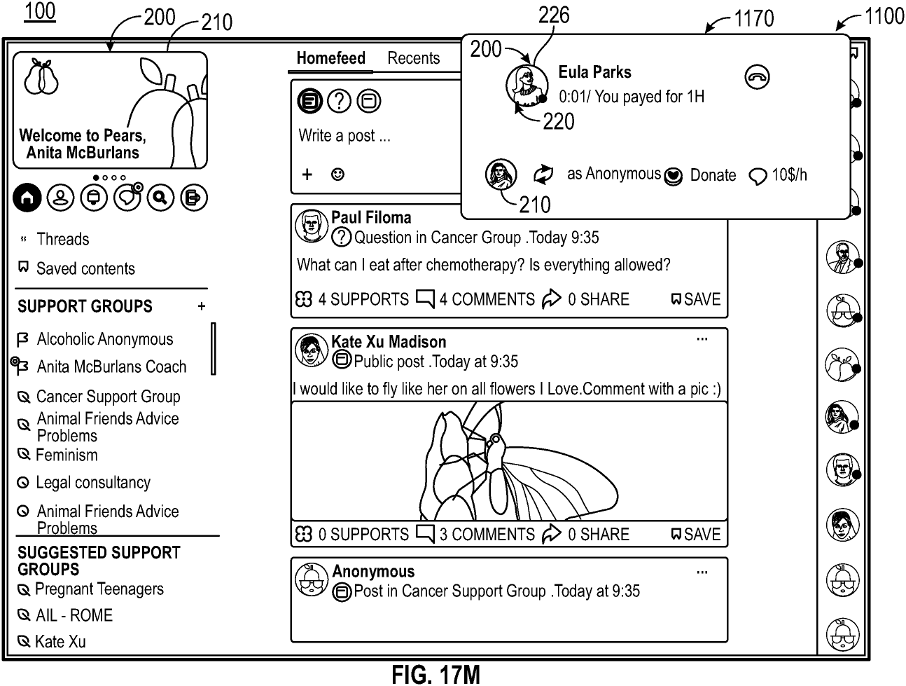

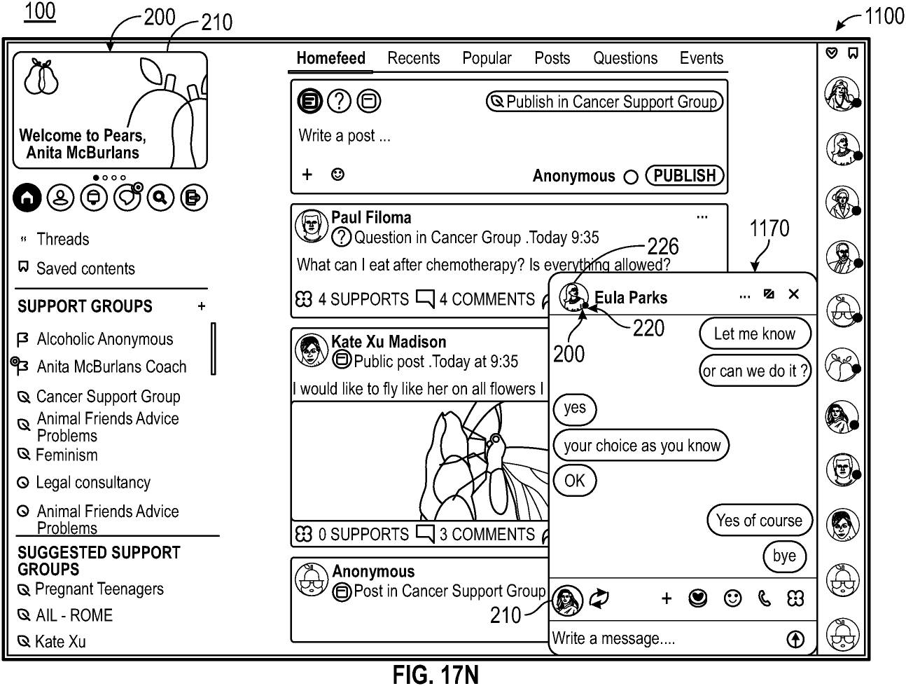

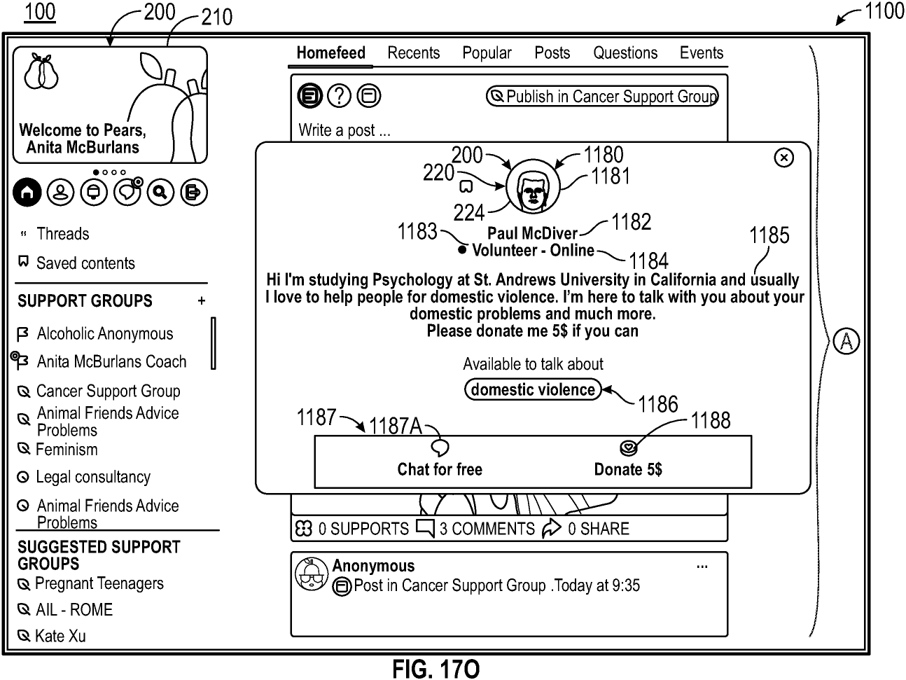

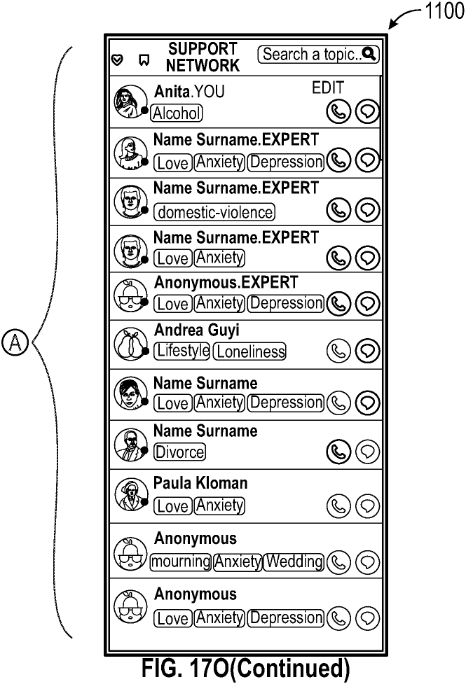

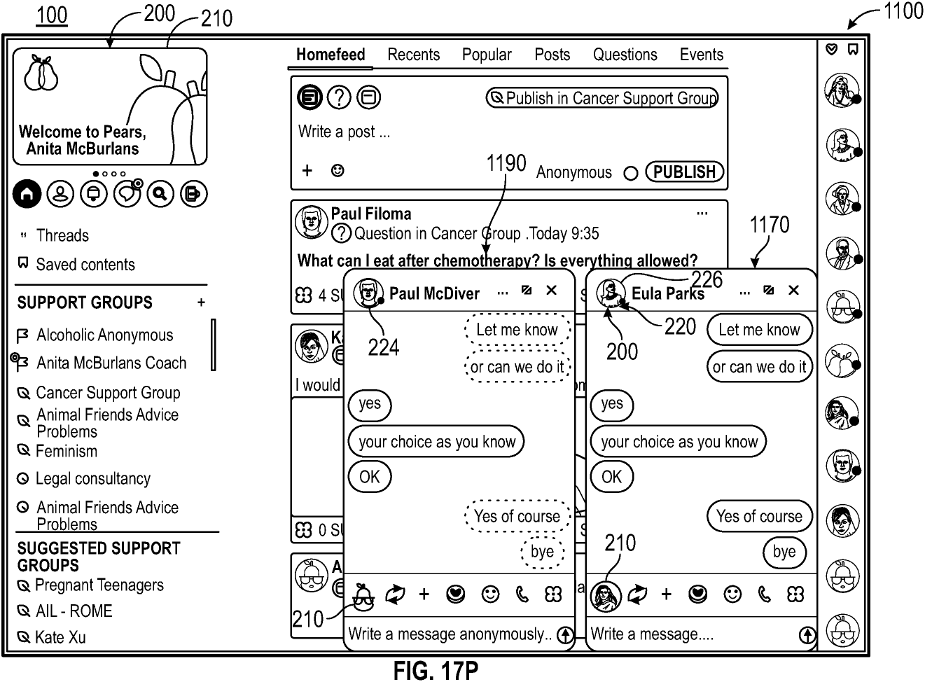

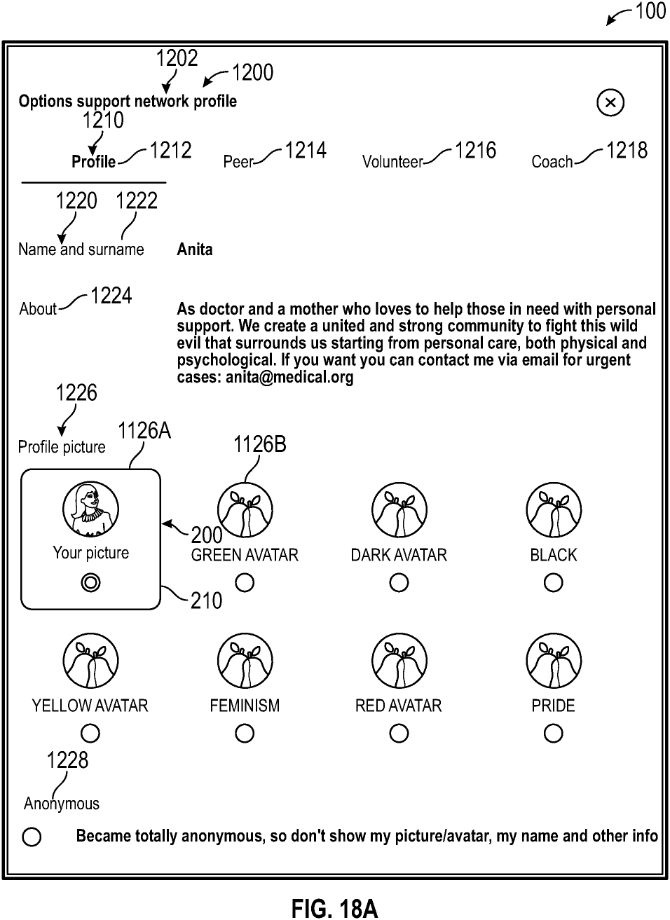

The multiuse communication system 100 advantageously can enable the selected system user 210 to establish a support network profile for becoming available to provide support to other system users 200. The support network profile can be at least partially integrated with, and/or separate from, the personal user profile discussed in more detail above with reference to FIGS. 3A-K. The multiuse communication system 100 can permit the selected system user 210 to update the support network profile with new and/or different profile information at any time. As shown in FIG. 17A, for example, the multiuse communication system 100 can provide a support network page 1100 for establishing the support network profile 1110.

Turning to FIG. 17A, the support network profile 1110 is illustrated as including a user availability status 1111. The user availability status 1111 can indicate whether the selected system user 210 is available to provide support to the other system users 200 and/or a capacity in which the selected system user 210 can provide the support. The support network page 1100 can enable the selected system user 210 to decline (or disable), at 1111A, providing support to the other system users 200. The selected system user 210 alternatively can indicate an availability to provide support to the other system users 200 in the capacity of a volunteer user 224 (shown in FIG. 1B), at 1111B, as a peer user 222 (shown in FIG. 1B) and/or as a coach user 226 (shown in FIG. 1B), at 1111C.

In selected embodiments, the support network page 1100 can permit the selected system user 210 to enter an image 1113, a name 1114, contact information, biographical or other demographic information 1115 and/or other personal support network profile information for the selected system user 210. At least a portion of the personal support network profile information can be made available to the other system users 200 via the multiuse communication system 100. Additionally and/or alternatively, the selected system user 210 can elect to withhold the personal support network profile information or otherwise remain anonymous, at 1112.

The support network page 1100 advantageously can permit the selected system user 210 to associate one or more discussion tags 1116 with the support network profile 1110. The discussion tags 1116 can help to identify the discussion topics that the selected system user 210 is available to discuss and otherwise provide support for the other system users 200. As shown in FIG. 17A, for example, the support network page 1100 can permit the selected system user 210 to add discussion tags 1116 to the support network profile 1110, at 1116A, by entering one or more discussion topic search terms 1116B. The multiuse communication system 100 can compare the entered discussion topic search terms with a set of discussion topic stored in a discussion topic database system (or circuit) (not shown) of the multiuse communication system 100. Results of the comparison can be presented, at 1116C, to the selected system user 210 for selection and addition to the support network profile 1110.

In selected embodiments, the support network page 1100 can permit the selected system user 210 to select a unique capacity for providing support to the other system users 200 for each discussion topic and/or discussion tag 1116. The selected system user 210, for example, can select, at 1111, to provide support for a first discussion topic in a capacity of a volunteer user 224, for a second discussion topic in a capacity of a peer user 222 and/or for a third discussion topic in a capacity of a coach user 226. Stated somewhat differently, the selected system user 210 can select, at 1111, to provide support as a volunteer user 224 for a first set of one or more discussion topics, as a peer user 222 for a second set of one or more discussion topics and/or as a coach user 226 for a third set of one or more discussion topics.

As shown in FIG. 17A, the support network page 1100 can enable the selected system user 210 to set a chat status 1117 for providing support to the other system users 200 via a chat session. The chat status 1117, for example, can include an indication whether the selected system user 210 is online 1117A or otherwise available for a chat session and/or is offline 1117B or otherwise unavailable for a chat session. Additionally and/or alternatively, the chat status 1117 can include chat cost information for the chat session. The chat cost information can include a chat price 1117C that can comprise a fixed price and/or a price rate for a predetermined time interval 1117D, such as for ten minutes. The selected system user 210 optionally can indicate that the chat session is available at no charge, at 111E, to the other system users 200.

The support network page 1100 of FIG. 17A is shown as enabling the selected system user 210 to set a call status 1118 for providing support to the other system users 200 via a telephone call session. The call status 1118, for example, can include an indication whether the selected system user 210 is online 1118A or otherwise available for a call session and/or is offline 1118B or otherwise unavailable for a call session. Additionally and/or alternatively, the call status 1118 can include call cost information for the call session. The call cost information can include a call price 1118C that can comprise a fixed price and/or a price rate for a predetermined time interval 1118D, such as for ten minutes. The selected system user 210 optionally can indicate that the call session is available at no charge, at 111E, to the other system users 200.

In selected embodiments, the support network profile 1110 can include a donation option for receiving donations 1119 from the other system users 200. The donations 1119, for example, can include voluntary donations from the other system users 200 who receive support from the selected system user 210 and wish to provide a donation to the selected system user 210 in appreciation of the provided support. Exemplary donation options 1119 can include, but are not limited to, no donations accepted 1119A, free donations 1119B and/or donations in a predetermined amount, such as a five dollar donation 1119C and/or a ten dollar donation 1119D.

The multiuse communication system 100 advantageously can assist the selected system user 210 with identifying one or more other system users 220, such as peer users 222, volunteer users 224 and/or coach users 226 (collectively shown in FIG. 1B), for discussing one or more predetermined discussion topics. Turning to FIG. 17B, the support network page 1100 can present a listing 1121 of at least one other system user 220 within the support network 1120 available via the multiuse communication system 100. The listing 1121, for example, can comprise a complete listing 1121A of each of the other system users 220 associated with the multiuse communication system 100 as illustrated in FIG. 17B. The listing 1121 can include a user image 1122A, a user name 1122A, a user proficiency status 1122C, at least one associated discussion topic 1122D, user contact information, user availability information and/or other profile information for each other system user 220. The user availability information can include, but is not limited to, availability via telephone 1122E and/or availability via chat 1122F.

The support network page 1100 can include enabling the selected system user 210 to search among the listed other system users 220. As shown in FIG. 17C, the selected system user 210 search among the listed other system users 220 via one or more support network criteria such as discussion topic 1131 and/or user proficiency status 1132. Exemplary types of user proficiency status 1132 can include peer users 222, volunteer users 224 and/or coach users 226. The selected system user 210 can enter, at 1130, a discussion topic 1131 and/or can select a discussion topic from a listing 1133 of discussion topics. As the selected system user 210 proceeds with entering the discussion topic 1131, the listing 1133 of discussion topics can narrow to available discussion topics associated with the entered discussion topic 1131 as illustrated in FIG. 17D. The listing 1133 of discussion topics can include a name 1133A of each discussion topic and/or summary information, such as a number 1133B, user proficiency 1133C and/or a user availability 1133D of other system users 220 associated with the discussion topic.

Upon selection of the discussion topic 1131 and/or the user proficiency status 1132, the support network page 1100 can present a listing 1140 of the other system users 220 who satisfy the support network criteria as shown in FIG. 17E. The listing 1140 can include the user image 1122A, the user name 1122A, the user proficiency status 1122C, the associated discussion topic 1122D, the user contact information, the user availability information and/or availability via telephone 1122E and/or availability via chat 1122F. The selected system user 210 can select at least one of the other system users 220 included in the listing 1140.

Additionally and/or alternatively, the selected system user 210 can enter further support network criteria, such as second discussion topic information, as shown in FIGS. 17F and 17G. The selected system user 210 can conduct additional searching among other system user 220 within the support network 1120 available via the multiuse communication system 100 via the further support network criteria. In the manner set forth above with reference to FIG. 17C, the selected system user 210 can enter, at 1130, a second discussion topic information 1134E and/or can select a discussion topic from a listing 1134 of discussion topics. As the selected system user 210 proceeds with entering the second discussion topic information 1134E, the listing 1134 of discussion topics can narrow to available discussion topics associated with the entered second discussion topic information 1134E. The listing 1134 of discussion topics can include a name 1134A of each discussion topic and/or summary information, such as a number 1134B, user proficiency 1134C and/or a user availability 1134D of other system users 220 associated with the second discussion topic. In selected embodiments, the further support network criteria can include information about three or more discussion topics.

Based upon the entered support network criteria, the support network page 1100 can present a listing 1150 of the other system users 220 who satisfy the entered support network criteria as illustrated in FIG. 17H. Turning to FIG. 17H, the listing 1150 can include the user image 1122A, the user name 1122A, the user proficiency status 1122C, the associated discussion topic 1122D, the user contact information, the user availability information and/or availability via telephone 1122E and/or availability via chat 1122F. The selected system user 210 can select at least one of the other system users 220 included in the listing 1150.

In selected embodiments, the support network page 1100 can enable the selected system user 210 to add one or more of the identified other system users 220 for discussing one or more predetermined discussion topics to a favorites listing 1121B as illustrated in FIG. 17I. The favorites listing 1121B can include the other system users 220, such as peer users 222, volunteer users 224 and/or coach users 226, who satisfy the support network criteria provided by the selected system user 210. The listing 1121 can include a user image 1125A, a user name 1125A, a user proficiency status 1125C, at least one associated discussion topic 1125D, user contact information, user availability information and/or other profile information for each other system user 220. The user availability information can include, but is not limited to, availability via telephone 1125E and/or availability via chat 1125F.

If the selected system user 210 elects to contact one of the identified other system users 220, such as a selected coach user 226, the support network page 1100 can present overview information 1160 for the selected coach user 226 as illustrated in FIG. 17J. The overview information 1160 can include, but is not limited to, a coach image 1161, a coach name 1162, a coach proficiency status 1163, a coach availability 1164, coach biographical or other demographic information 1165 and/or a listing 1166 of available coach discussion topics.

As shown in FIG. 17J, the support network page 1100 can present contact and/or fee information for the selected coach user 226. The selected coach user 226, for example, can be available to chat 1167A for free or at a first predetermined fee rate and/or can be available for a telephone call 1167B for free or at a second predetermined fee rate. The selected coach user 226 optionally may be willing to accept a voluntary donation 1168. The support network page 1100 can provide payment options 1169 for submitting a fee payment and/or a voluntary donation to the selected coach user 226 as shown in FIG. 17K.

The multiuse communication system 100 can enable the selected system user 210 and the selected coach user 226 to communicate. Turning to FIG. 17L, the selected system user 210 optionally can elect to provide a user name 1169A for communicating with the selected coach user 226 and/or can elect to communicate anonymously, at 1169B, with the selected coach user 226. In selected embodiments, the multiuse communication system 100 can present a chatroom page for facilitating communication between the selected system user 210 and the selected coach user 226. An exemplary chat 1170 between the selected system user 210 and the selected coach user 226 is illustrated in FIGS. 17M and 17N.

The chatroom page can enable the selected system user 210 to see all of the members 227 and other system users 200 for the selected support group 805 who are online and/or to chat with the members 227 in real-time. For example, the chatroom page optionally can permit the selected system user 210 to see all of the members 227 and other system users 200 for the selected support group 805 who are online chatting at the moment versus if the selected system user 210 were to access the members page of the selected support group 805 that will show all the members 227 of the selected support group 805 in total both online and offline.

Additionally and/or alternatively, the selected system user 210 can elect to contact a selected volunteer user 224, the support network page 1100 can present overview information 1180 for the selected volunteer user 224 as illustrated in FIG. 17O. The overview information 1180 can include, but is not limited to, a volunteer image 1181, a volunteer name 1182, a volunteer proficiency status 1183, a volunteer availability 1184, volunteer biographical or other demographic information 1185 and/or a listing 1186 of available volunteer discussion topics. As shown in FIG. 17O, the support network page 1100 can present contact and/or optional fee information for the selected volunteer user 224. The selected volunteer user 224, for example, can be available to chat 1187A for free or at a first predetermined fee rate and/or can be available for a telephone call 1187B for free or at a second predetermined fee rate. The selected volunteer user 224 optionally may be willing to accept a voluntary donation 1188.

The multiuse communication system 100 can enable the selected system user 210 and the selected volunteer user 224 to communicate. The selected system user 210 can elect to provide a user name for communicating with the selected volunteer user 224 and/or can elect to communicate anonymously with the selected volunteer user 224 in the manner discussed above with reference to FIG. 17L. In selected embodiments, the multiuse communication system 100 can present a chatroom page for facilitating communication between the selected system user 210 and the selected volunteer user 224.

An exemplary chat 1190 between the selected system user 210 and the selected volunteer user 224 is illustrated in FIG. 17P. The chatroom page for facilitating communication between the selected system user 210 and the selected volunteer user 224 can be separate from, or at least partially integrated with, the chatroom page shown in FIG. 17L for facilitating communication between the selected system user 210 and the selected coach user 226. Advantageously, the chatroom page can support multiple, simultaneous interactions between system users 200, such as between the selected system user 210 and the selected volunteer user 224 and between the selected system user 210 and the selected coach user 226. Stated somewhat differently, the multiuse communication system 100 can enable the selected system user 210 to communicate and otherwise interact simultaneously with two or more selected system users 220, such as by anonymously chatting with the selected volunteer user 224 while chatting with the selected coach user 226 as shown in FIG. 17P.

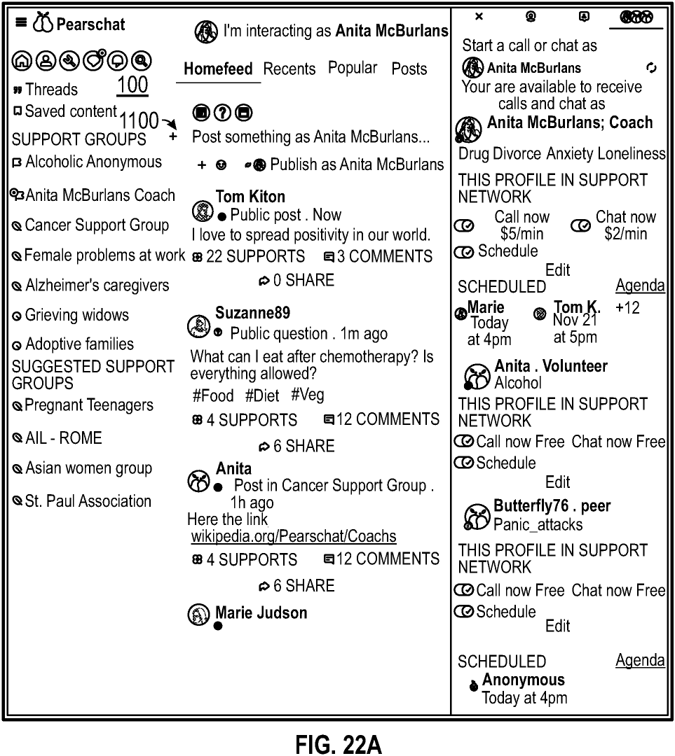

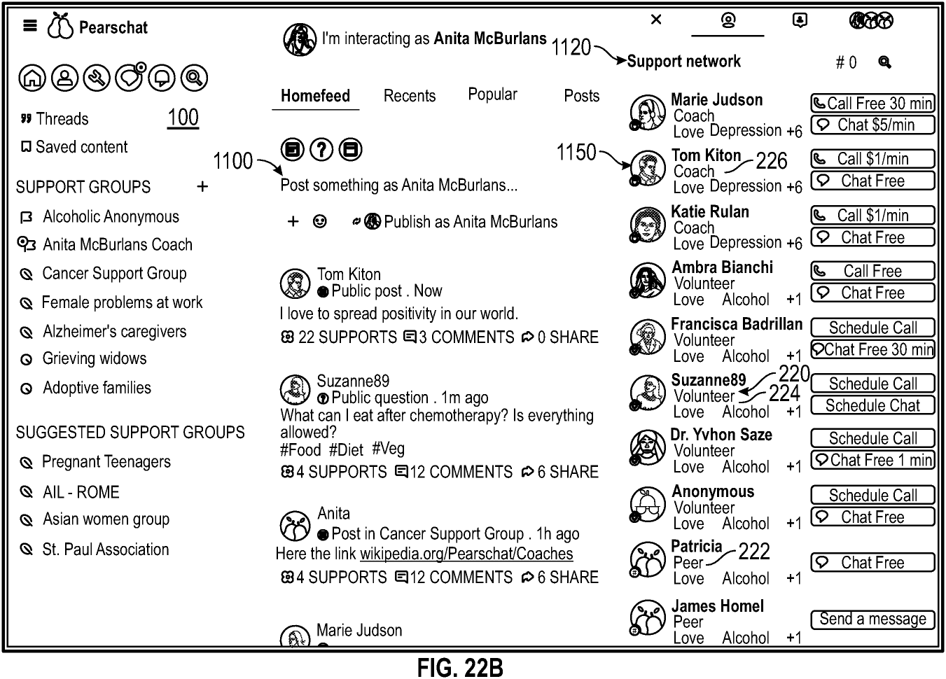

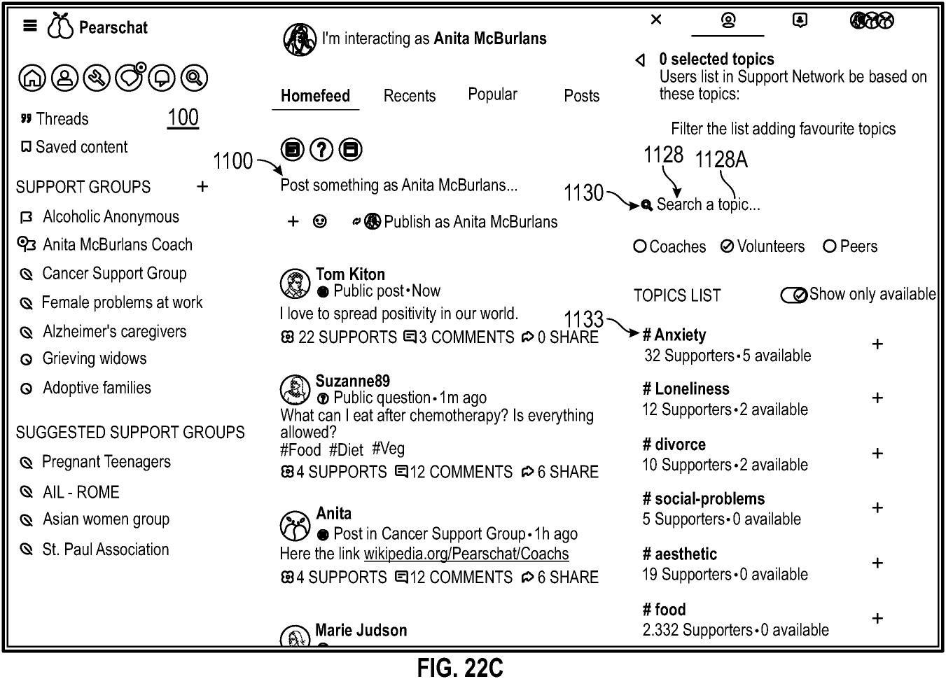

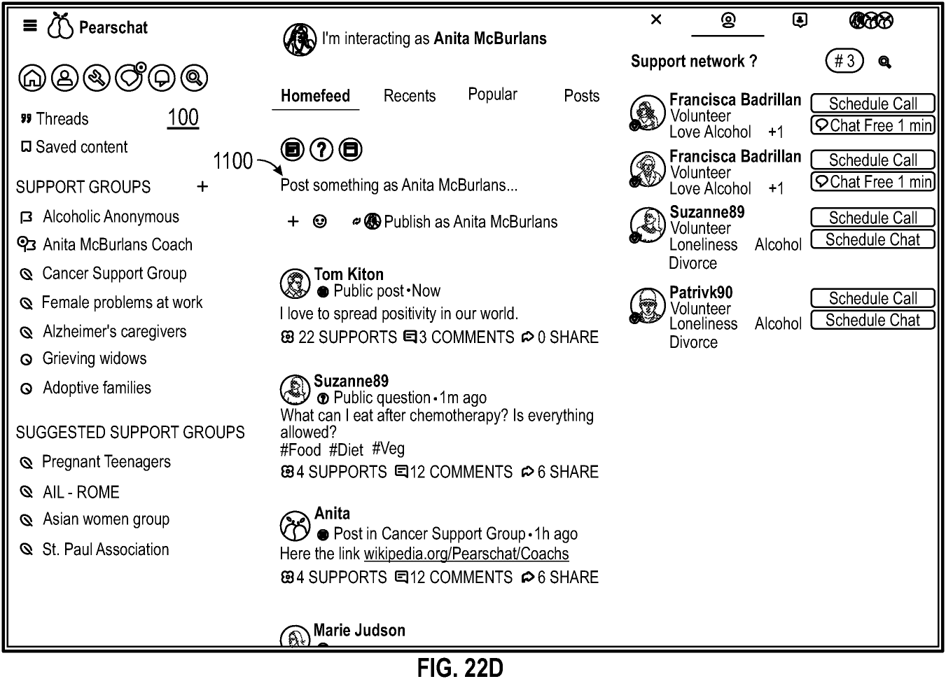

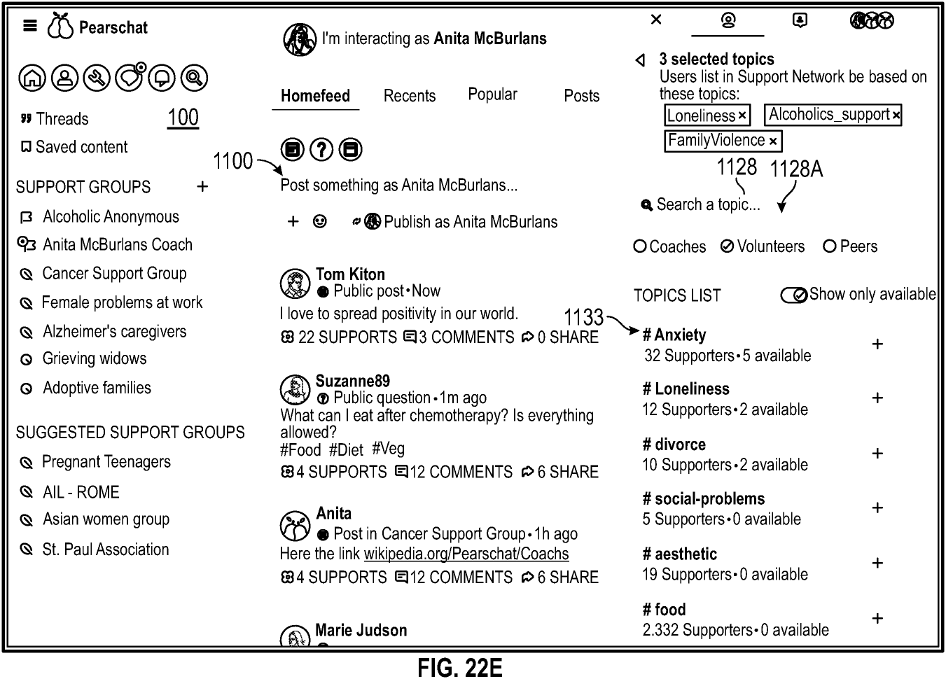

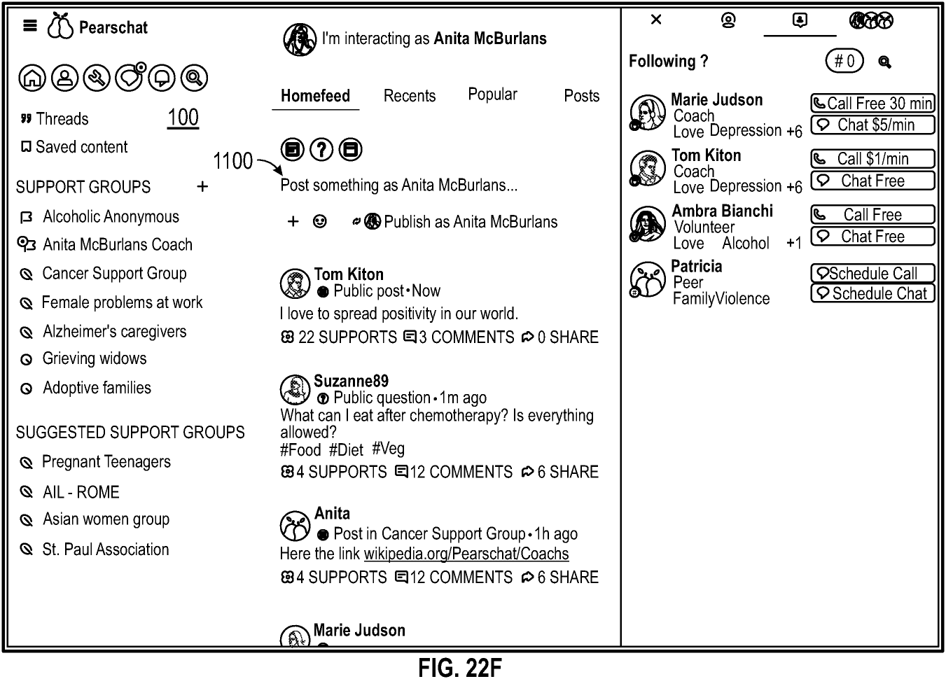

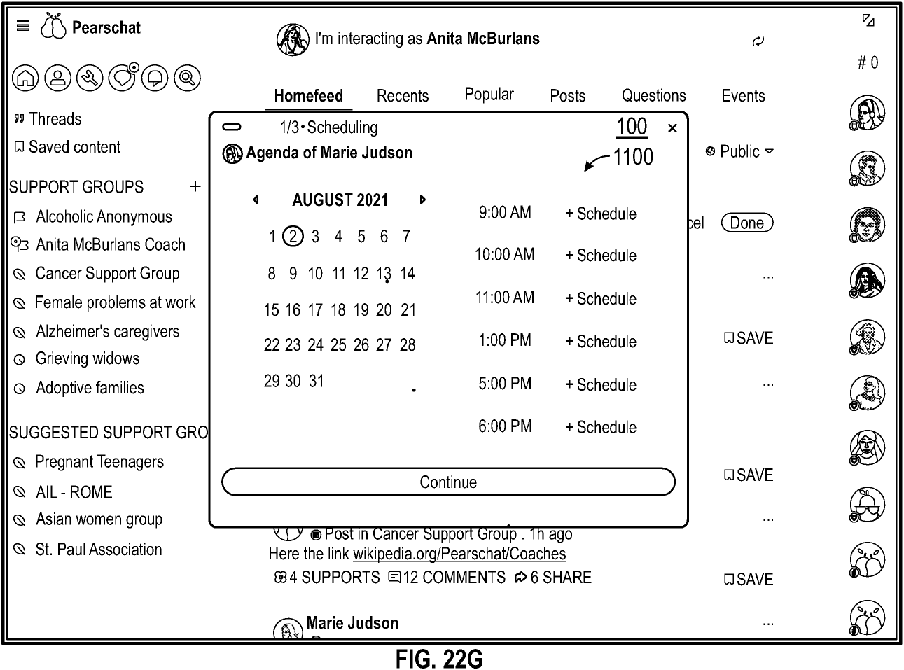

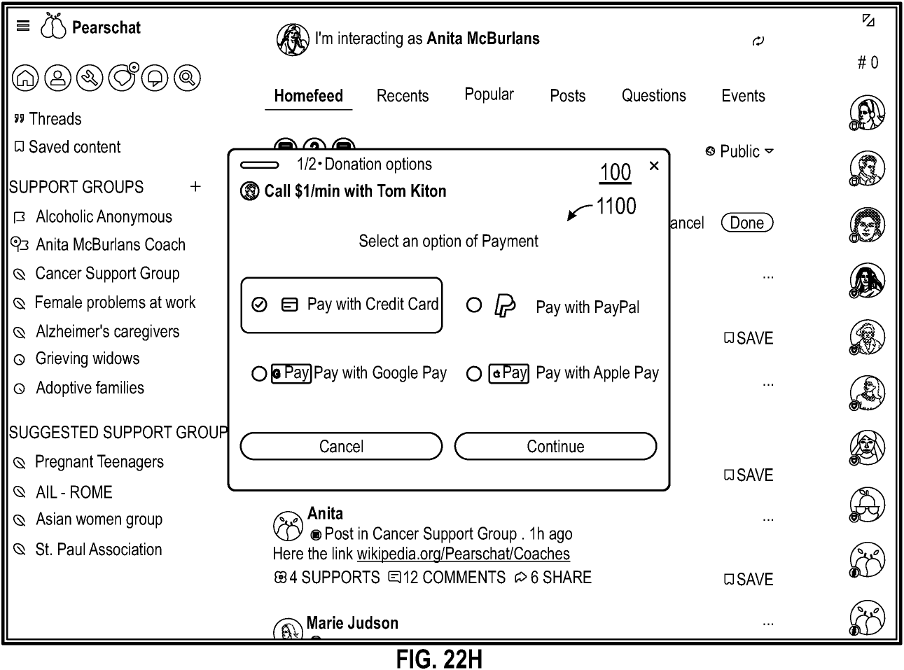

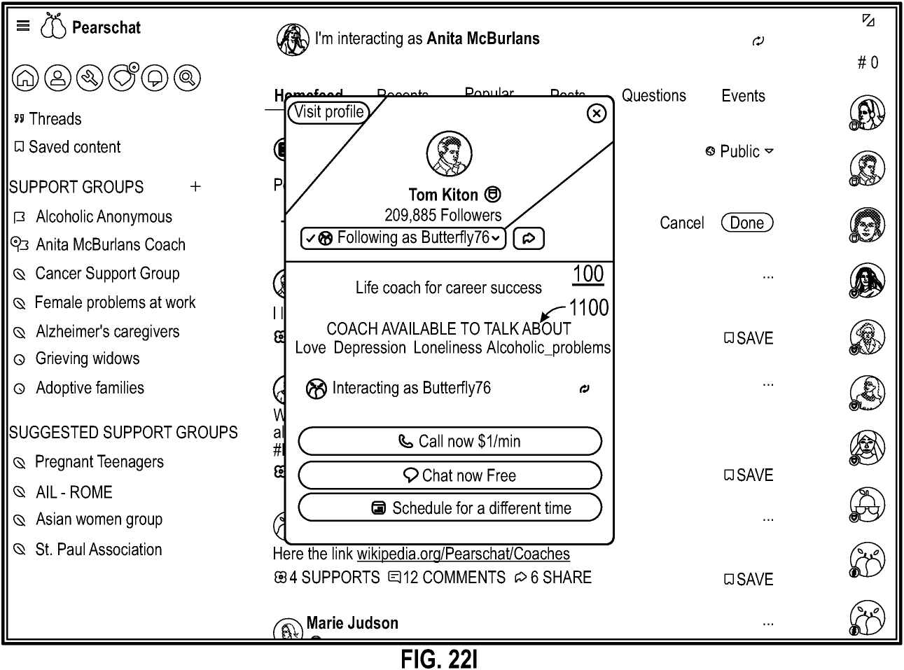

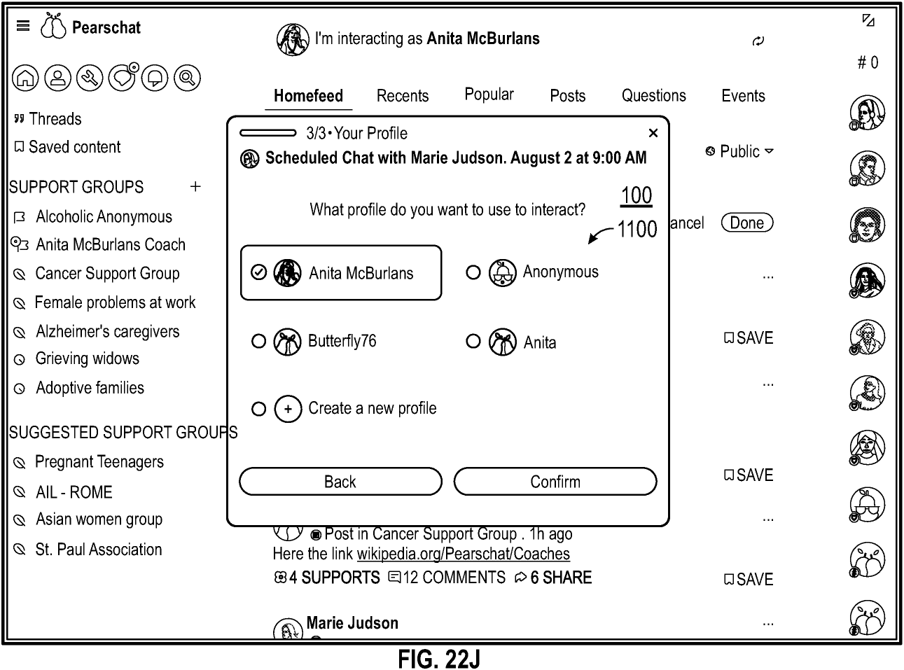

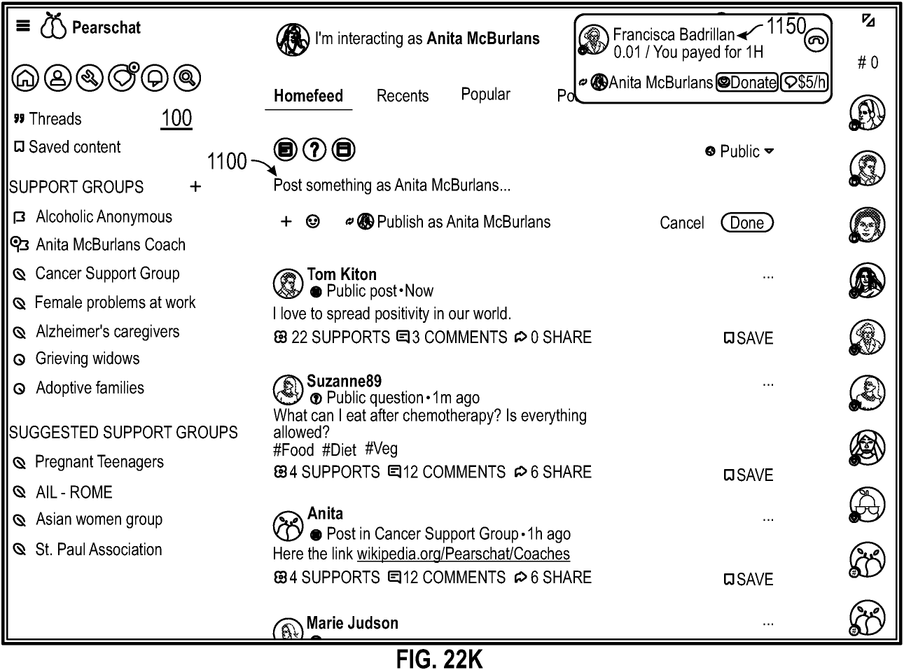

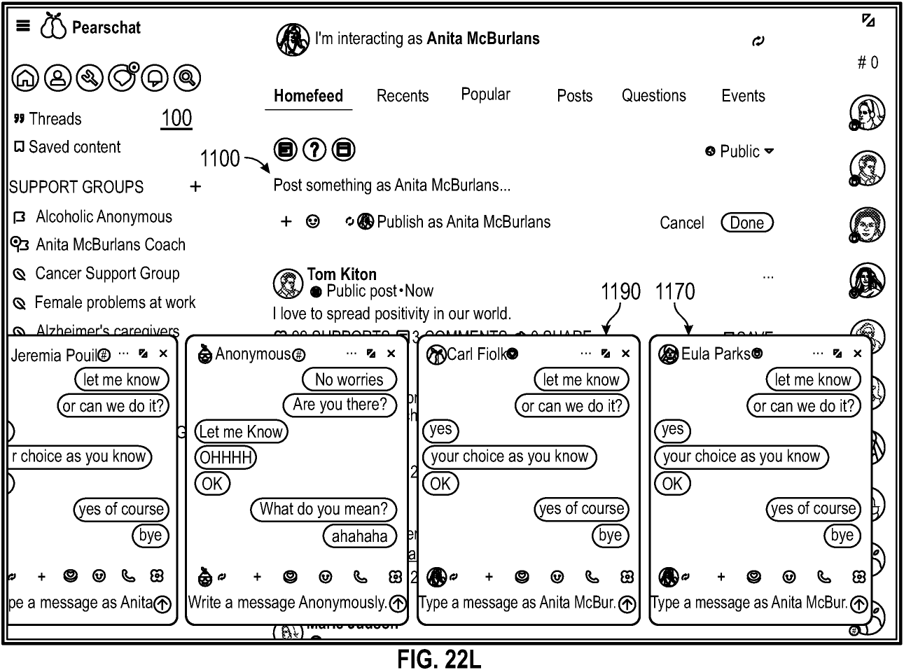

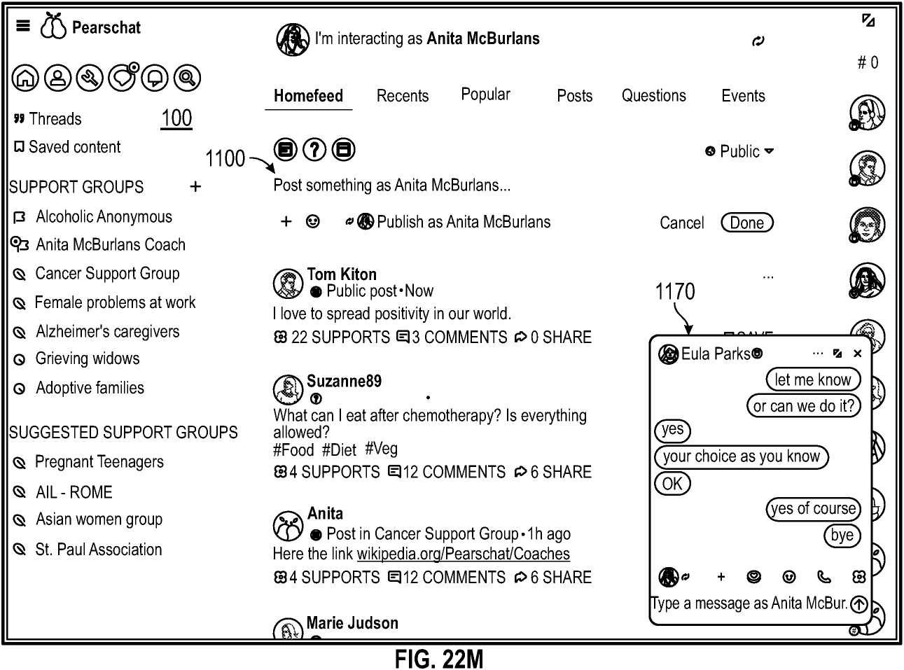

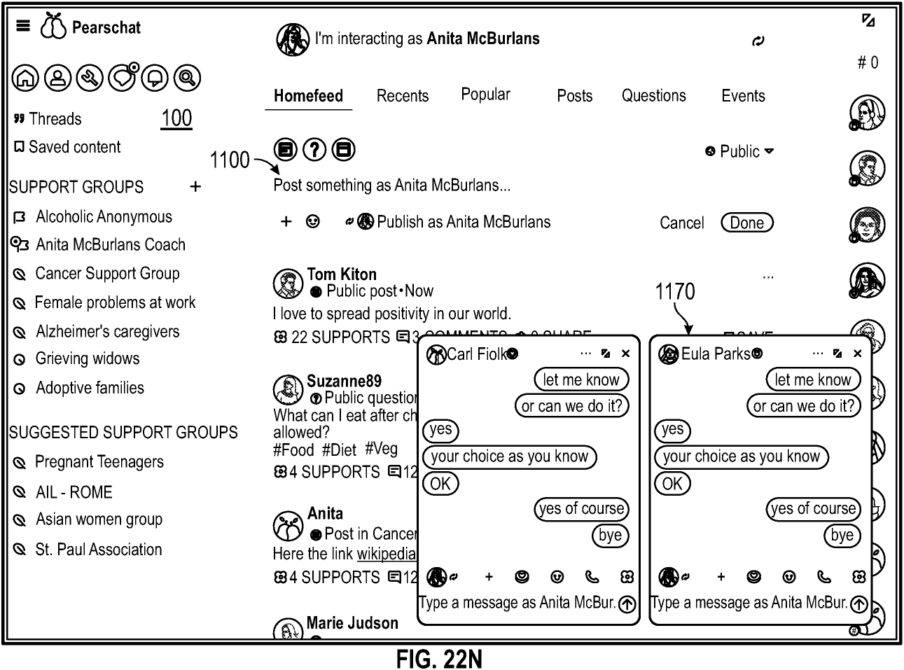

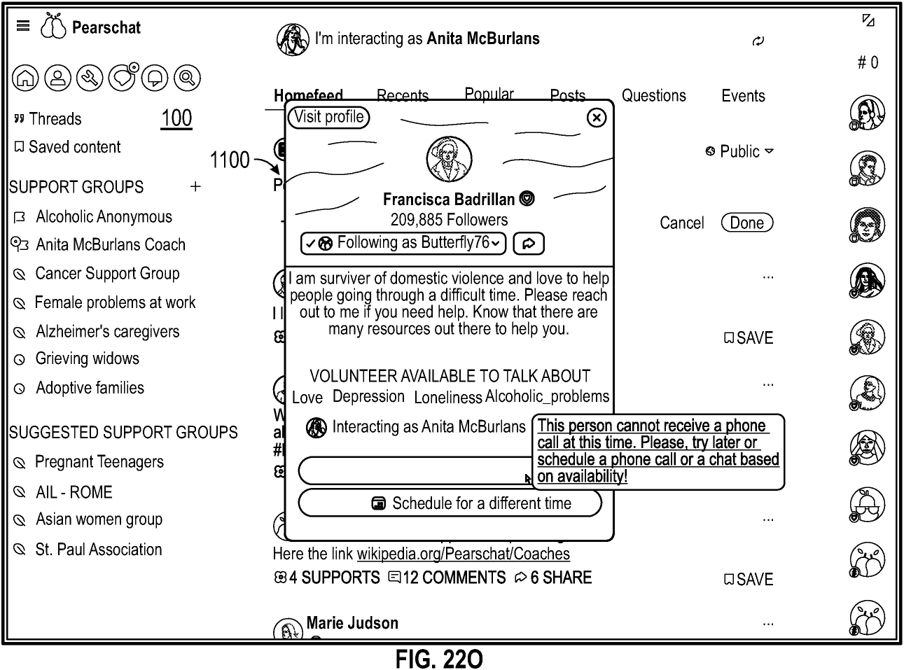

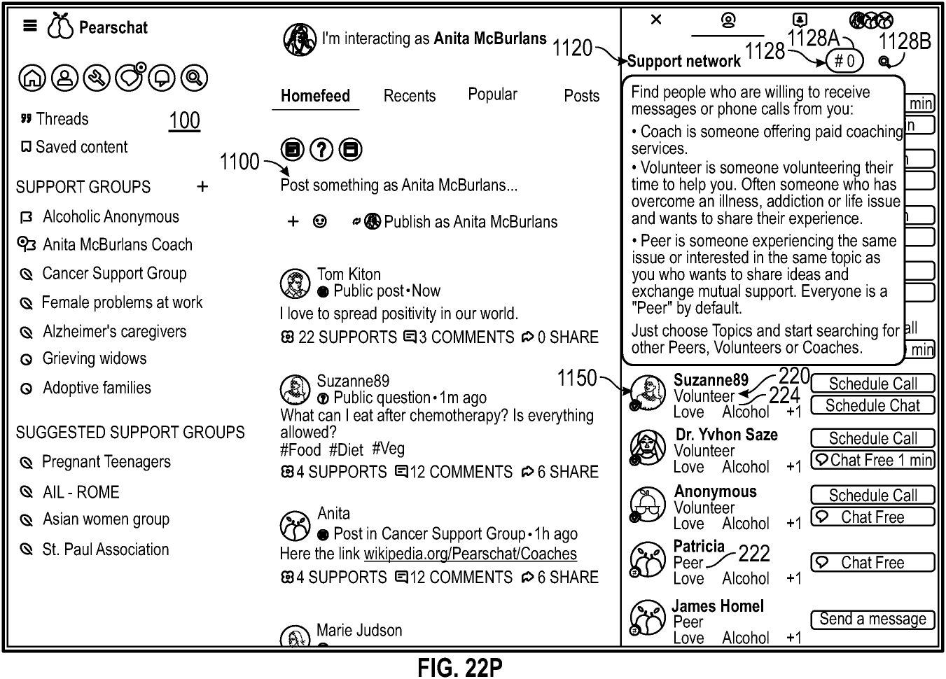

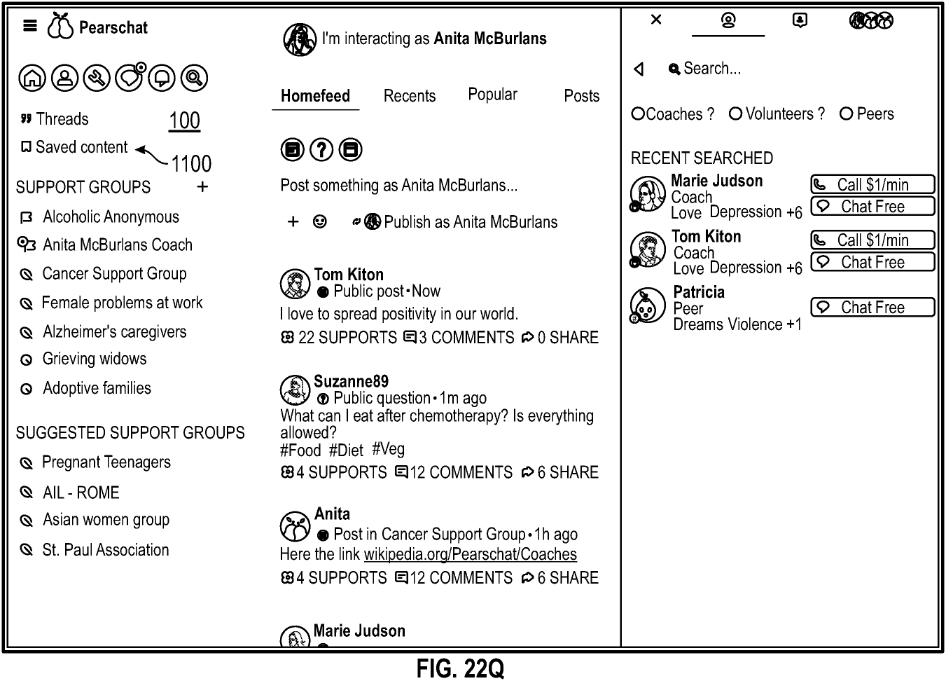

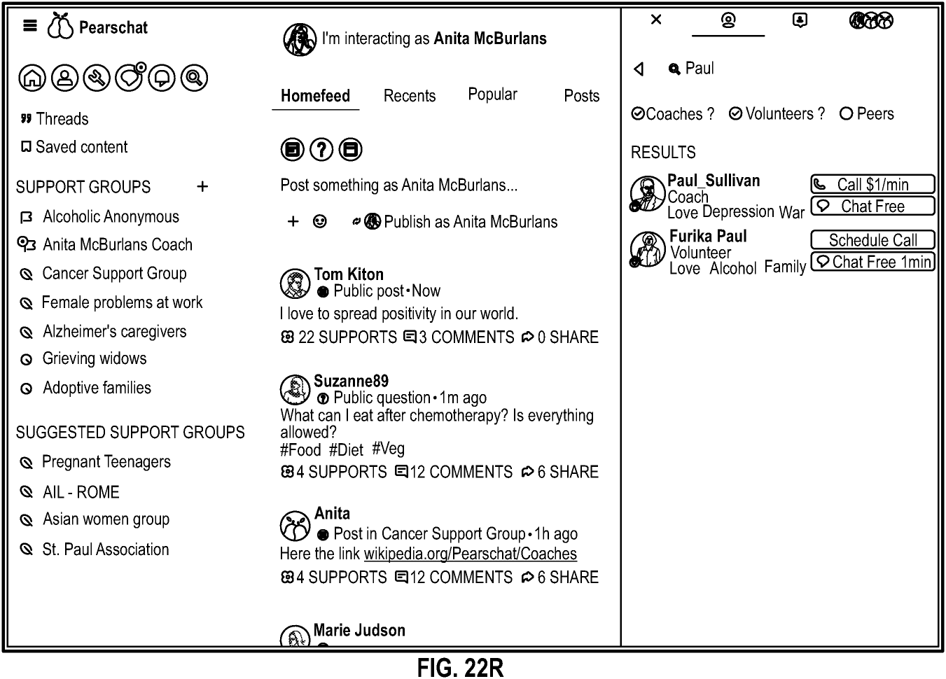

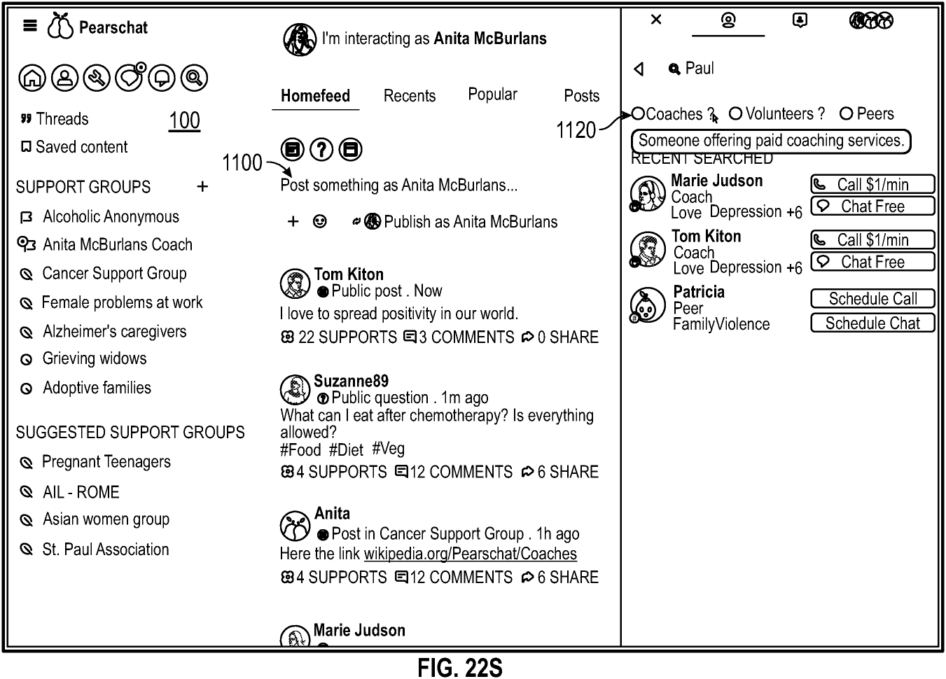

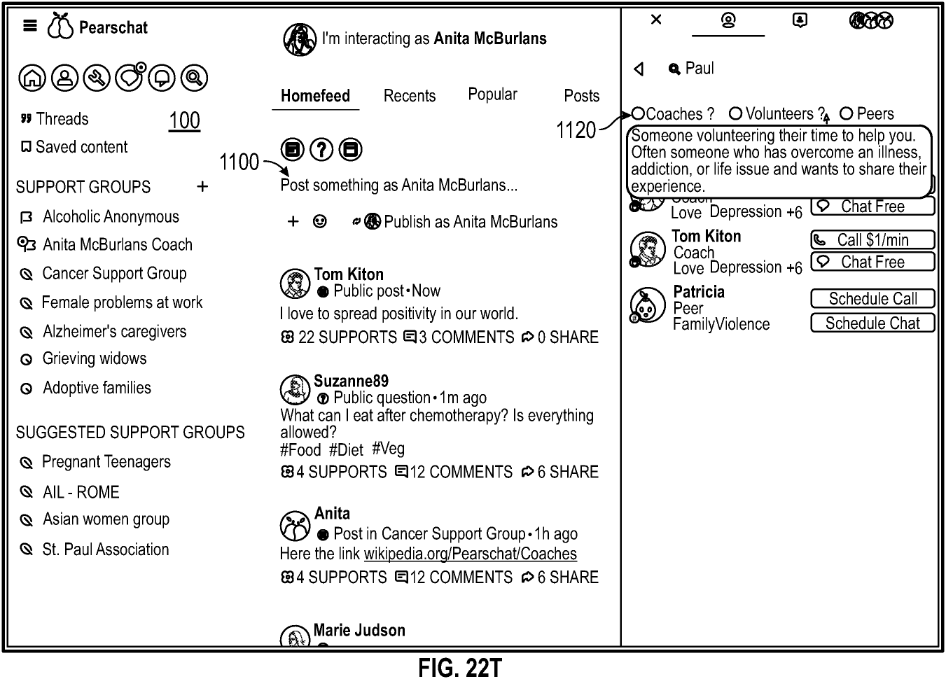

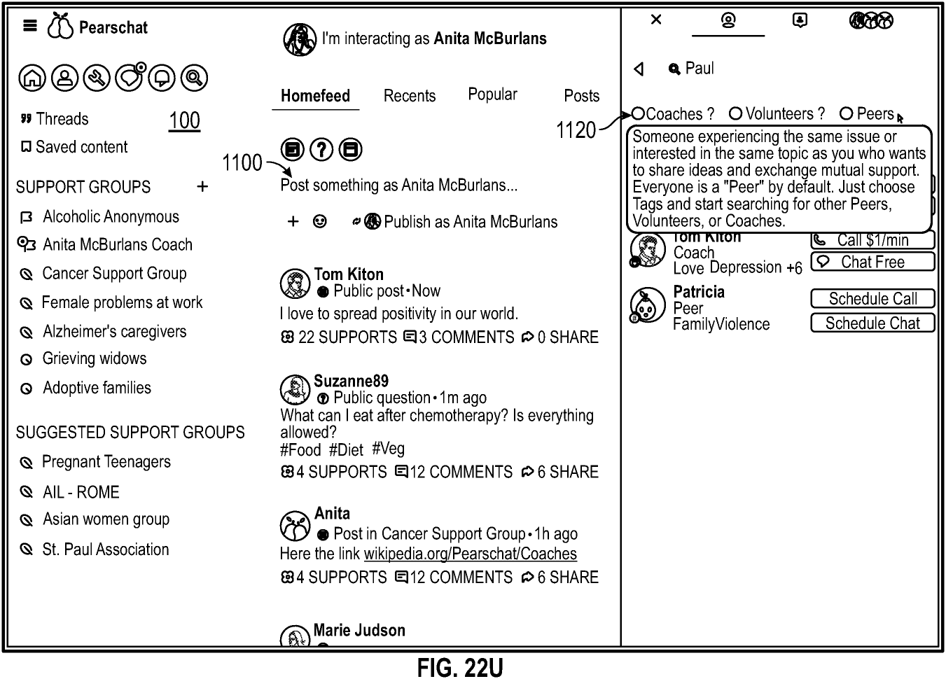

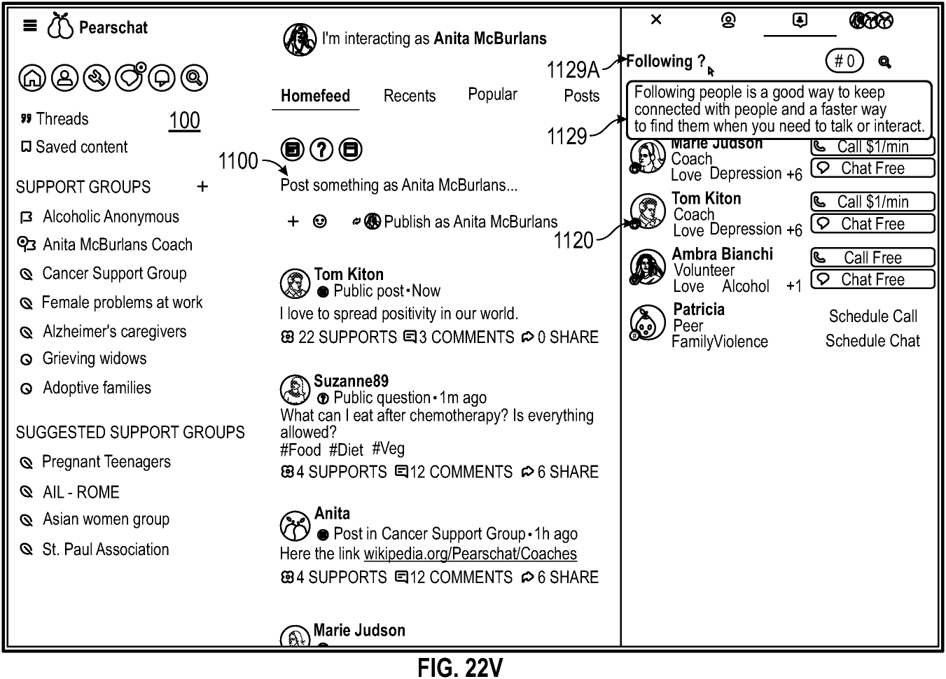

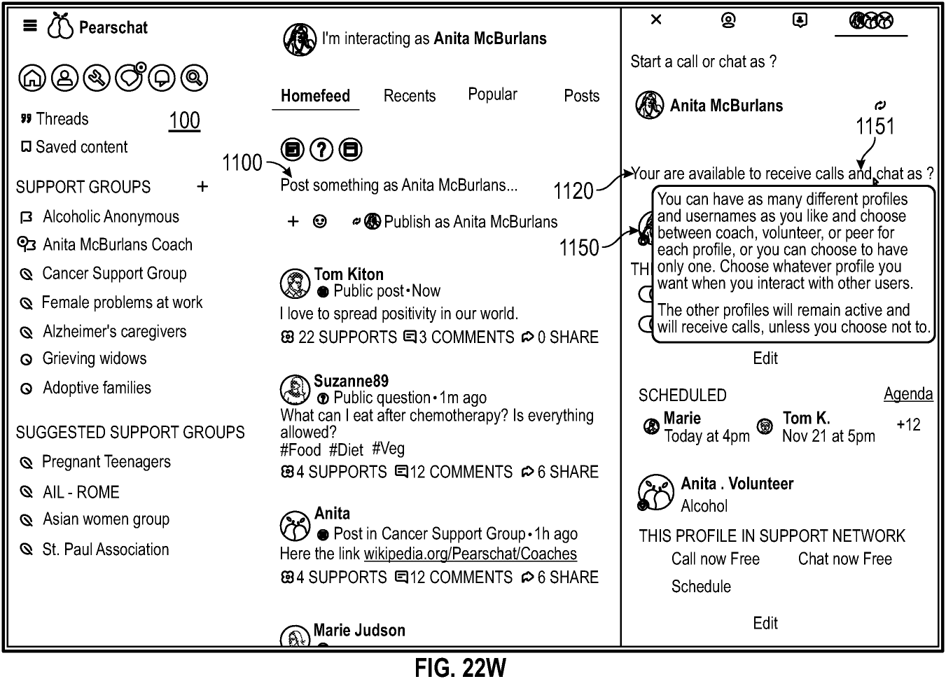

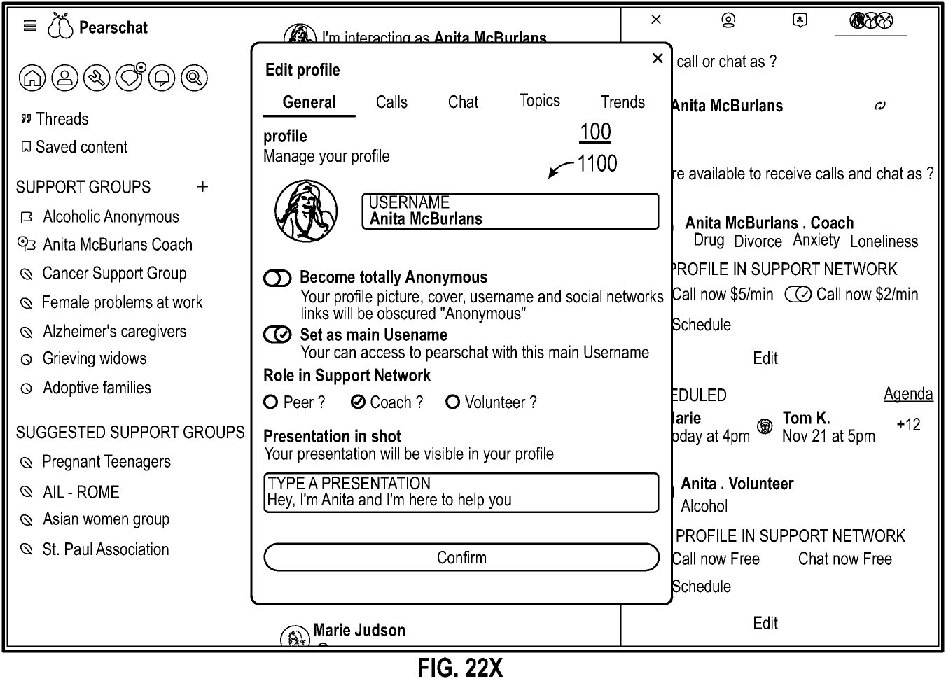

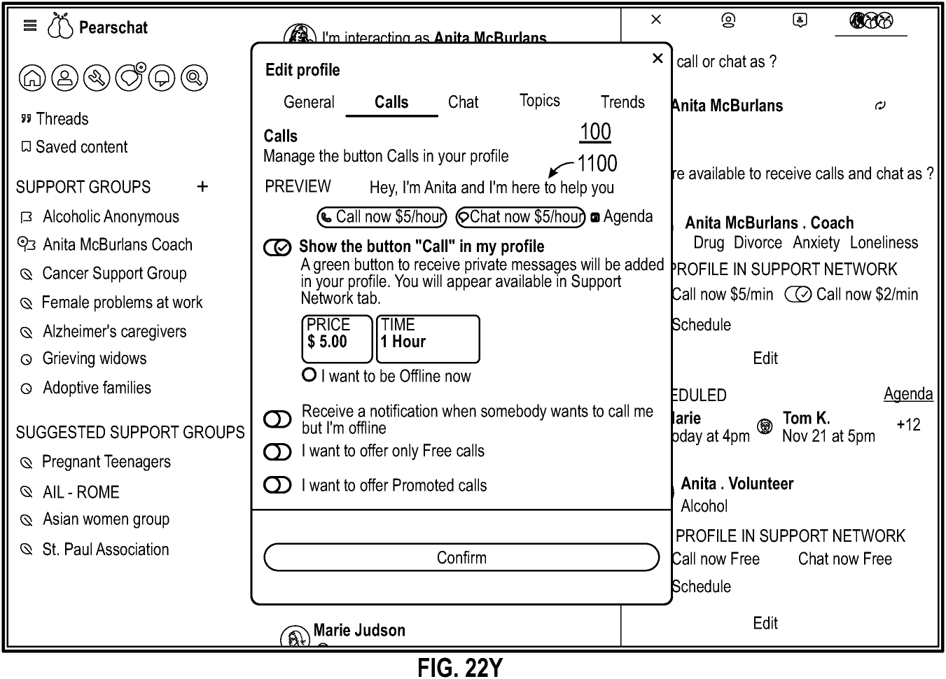

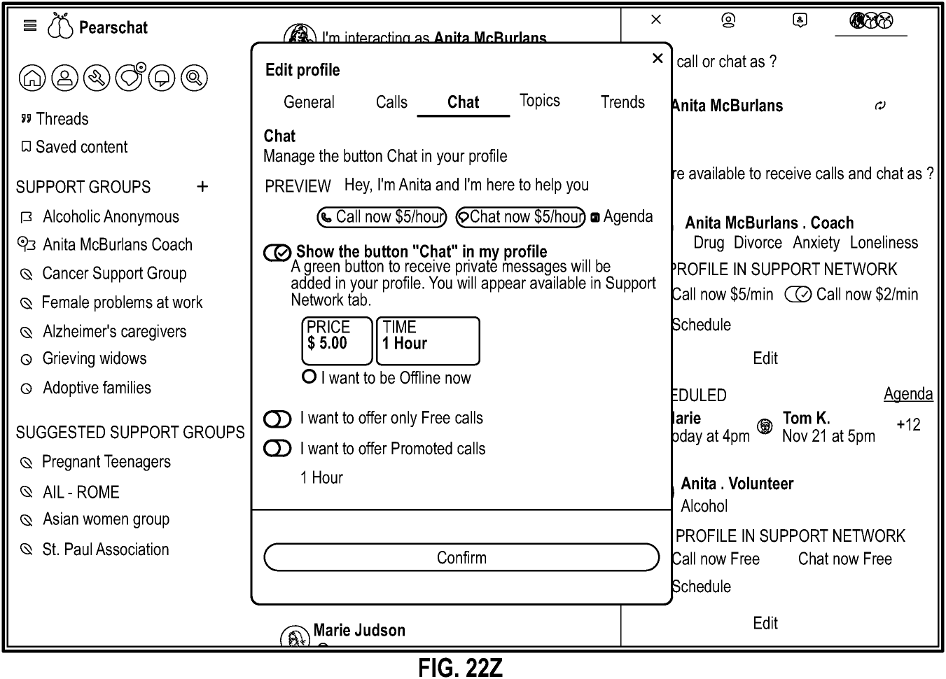

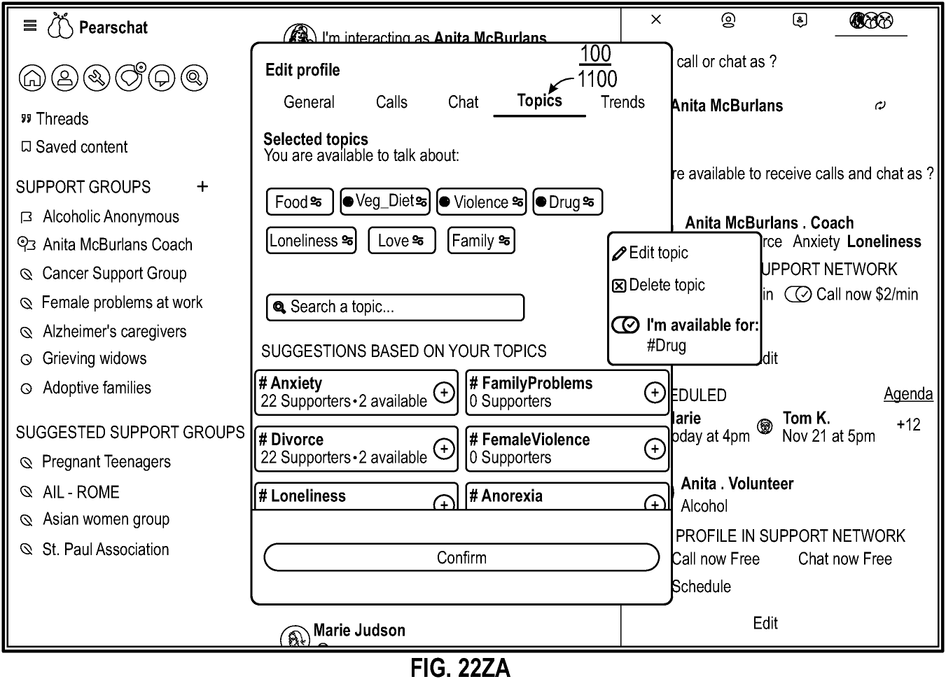

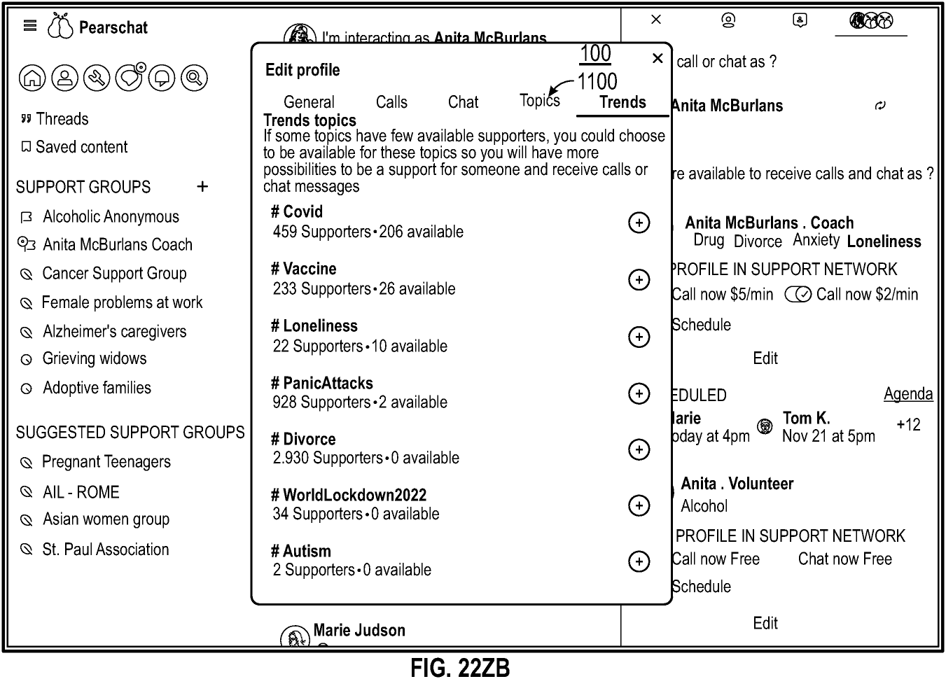

An alternative embodiment of the support network page 1100 of FIGS. 17A-P is illustrated in FIG. 22A-ZB. As shown in FIG. 22B, for example, the support network page 1100 can present the support network 1120 available to the selected system user 210 via the multiuse communication system 100. The support network 1120 advantageously can include a listing 1150 of one or more other system users 220, such as peer user(s) 222, volunteer user(s) 224 and/or coach user(s) 226, within the support network 1120. As illustrated in FIGS. 22S-U, the support network page 1100 can provide an explanation or other description of each category of other system user 220. A peer user 222, for example, can comprise another system user 220 who is experiencing the same issue or interests in the same topic as the selected system user 210 and who wants to share ideas and exchange mutual support. A volunteer user 224 can comprise another system user 220 who volunteers time to help system users, such as the selected system user 210. Additionally and/or alternatively, a coach user 226 can comprise another system user 220 who offers paid coaching services.

In selected embodiments, the multiuse communication system 100 can present helpful explanations, navigation guidance and/or other usage tips for assisting the selected system user 210. The multiuse communication system 100 of FIG. 22V, for example, can include usage tips 1129 for the support network page 1100. As shown in FIG. 22V, for example, the usage tips 1129 can explain how the selected system user 210 can utilize a “following” feature 1129A of the support network page 1100 in a more effective manner.

As shown in FIG. 22B, pricing and agenda/topic information can be presented for each of the other system users 220. The support network page 1100 optionally can enable the selected system user 210 to schedule a day and/or time to call, chat or otherwise communicate with the other system users 220. Advantageously, the support network page 1100 of FIG. 22W is illustrated as enabling the selected system user 210 to select a predetermined user profile, at 1151, for initiating the call, chat or other communication with another system user 220. Stated somewhat differently, the selected system user 210 change to a different user profile or create a new user profile for initiating the call, chat or other communication with the other system user 220. Additionally and/or alternatively, the support network page 1100 can enable the selected system user 210 to select and/or edit one or more discussion topics that the selected system user 210 is available to discuss at a current time and/or at a future time. An exemplary manner for changing or otherwise editing a user profile of the selected system user 210 is illustrated in FIG. 22X-ZB.

In selected embodiments, the support network page 1100 can enable searches 1128 within the support network 1120. The support network page 1100, for example, can permit topical searches 1128A within the support network 1120 and/or name searches 1128B for other system users 220 within the support network 1120. The searches 1128 within the support network 1120 optionally can include specifying the type of other system users 220, such as peer user(s) 222, volunteer user(s) 224 and/or coach user(s) 226 as shown in FIG. 22C. Exemplary search pages for performing a topical search 1128A within the support network 1120 are shown in FIGS. 22C and 22E. An exemplary topical search result that has been filtered for volunteer users 224 who are available to discuss alcohol-related topics is shown in FIG. 22D. Results from a search of the chat box is shown in FIG. 22Q.

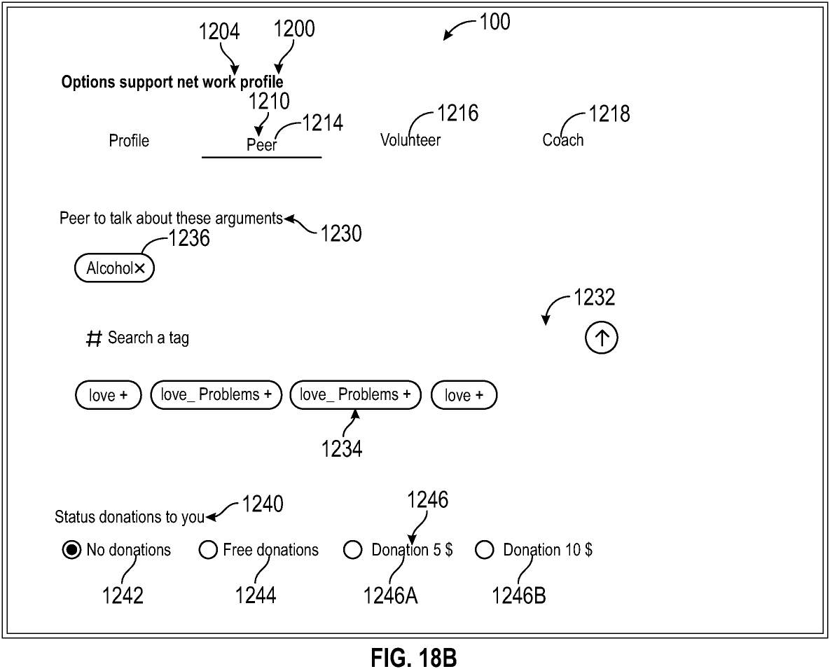

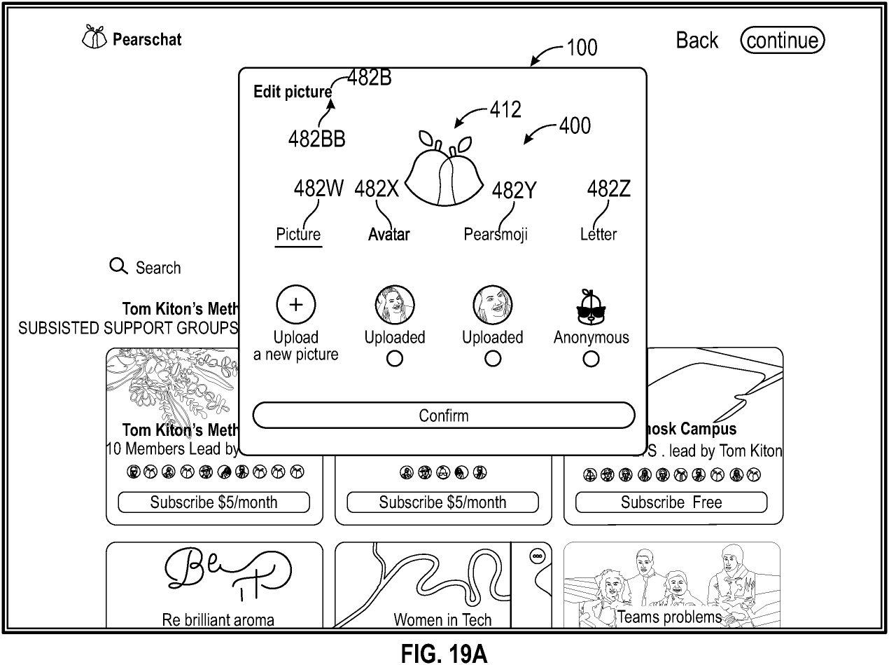

Turning to FIG. 18A, an options support network profile page 1200 of the multiuse communication system 100 is shown. The options support network profile page 1200 can include navigation indicia 1210 for visiting one or more subpages or otherwise navigating the options support network profile page 1200. As illustrated in FIG. 18A, the navigation indicia 1210 can include profile subpage navigation indicia 1212, peer user subpage navigation indicia 1214, volunteer user subpage navigation indicia 1216 and/or coach user subpage navigation indicia 1218. Activation of the profile subpage navigation indicia 1212, for example, can enable the multiuse communication system 100 to present a profile subpage 1202 of the options support network profile page 1200.

The profile subpage 1202 can enable the selected system user 210 to enter a chat profile 1220 on the multiuse communication system 100. The chat profile 1220 can be separate from, or at least partially integrated with, the personal user profile discussed herein with reference to FIGS. 3A-K. As shown in FIG. 18A, for example, the profile subpage 1202 permit the selected system user 210 to enter chat profile information such as a user name 1222, user biographic and/or demographic information 1224, an image 1226, contact information, and/or other user chat profile information of the selected system user 210. The image 1226 can include a photograph 1226A of (or otherwise associated with) the selected system user 210, an avatar image 1226B, a drawing or other visual media associated with the selected system user 210. The profile subpage 1202 optionally can enable the selected system user 210, at 1228, to inhibit other system users 200 from accessing or otherwise viewing the user name 1222, the user biographic and/or demographic information 1224, the image 1226 and/or other user chat profile information of the chat profile 1220.

Activation of the peer user subpage navigation indicia 1214 can enable the multiuse communication system 100 to present a peer user subpage 1204 of the options support network profile page 1200 as illustrated in FIG. 18B. The peer user subpage 1204 advantageously can permit the selected system user 210 (shown in FIG. 18A) to identify one or more discussion (or chat) topics for discussion with one or more other system users 200 (shown in FIGS. 1A-B). In selected embodiments, the multiuse communication system 100 identify the chat topics in the manner discussed above with reference to the favorite topics and favor subtopics of FIGS. 2C-E. The peer user subpage 1204 can include a chat topic listing 1234 for selection by the selected system user 210 and/or can include a search feature 1232 by which the selected system user 210 can enter chat topic information for searching among the chat topic listing 1234.

Turning to FIG. 18B, the peer user subpage 1204 can present a search feature 1232 for entering a chat topic. The multiuse communication system 100 can search among chat topics supported by the multiuse communication system 100 that relate to the entered chat topic. The multiuse communication system 100 can present one or more supported chat topics 1234 that relate to the entered chat topic. The selected system user 210 can identify one or more of the presented chat topics 1234 as being of interest or otherwise relevant and add the relevant chat topics 1234 to an added chat topic listing 1236 associated with the selected system user 210.

Based upon the chat topic listing 1236, the multiuse communication system 100 can search for one or more other system users 200 for discussing at least one selected chat topic of the chat topic listing 1236. The multiuse communication system 100, for example, can search for other system users 200 who have identified the selected chat topic as being of interest in their chat profiles 1220 (shown in FIG. 18A). In selected embodiments, the multiuse communication system 100 can provide a chat box for enabling the selected system user 210 to communicate with, and otherwise interact with, at least one other system user 200 who have identified the selected chat topic as being of interest. The chat box, in other words, can facilitate communication between the selected system user 210 and the other system user 200.

The peer user subpage 1204 can include an optional donation or other payment status information 1240. Via the donation or other payment status information 1240 of the peer user subpage 1204, the selected system user 210 can designate whether payments will be accepted and, if so, exemplary payment amounts for engaging in a chat as a peer user with regard to the selected chat topic. The selected system user 210, for example, can designate that no donations will be accepted 1242, free donations will be accepted 1244 or donations of a predetermined monetary amount will be accepted 1246. Exemplary monetary amounts can include five dollars 1246A and/or ten dollars 1246B.

The multiuse communication system 100 can support a volunteer user subpage and/or a coach user subpage for the options support network profile page 1200. Activation of the volunteer user subpage navigation indicia 1216 can enable the multiuse communication system 100 to present the volunteer user subpage of the options support network profile page 1200; whereas, activation of the coach user subpage navigation indicia 1218 can enable the multiuse communication system 100 to present the coach user subpage. The volunteer user subpage and/or coach user subpage can be provided in the manner of the peer user subpage 1204 shown in FIG. 18B.

Advantageously, the peer user subpage 1204, the volunteer user subpage and/or the coach user subpage can enable the selected system user 210 to designate different or otherwise independent chat topics and/or different or otherwise independent donation or other payment status information for when the selected system user 210 chats or otherwise interacts in a capacity as a peer user 222, volunteer user 224 and/or coach user 226 (collectively shown in FIG. 1B) with another system user 200. For example, the selected system user 210 can be a peer user 222 for the chat topic of depression while simultaneously being coach user 226 for the chat topic of career success and volunteer user 224 for the chat topic of sexual assault.

The selected system user 210, when acting in a selected capacity, may elect to chat or otherwise interact only with other system users 200 acting in the same capacity. For example, the selected system user 210 acting as a peer user 222 may wish only to interact with other system users 200 who also are acting as a peer user 222. Additionally and/or alternatively, the selected system user 210, when acting in a selected capacity, may elect to interact with other system users 200 acting in a different capacity from the selected capacity of the selected system user 210. The selected system user 210 acting as a peer user 222 thereby can interact with other system users 200 who are acting as a volunteer user 224 and/or coach user.

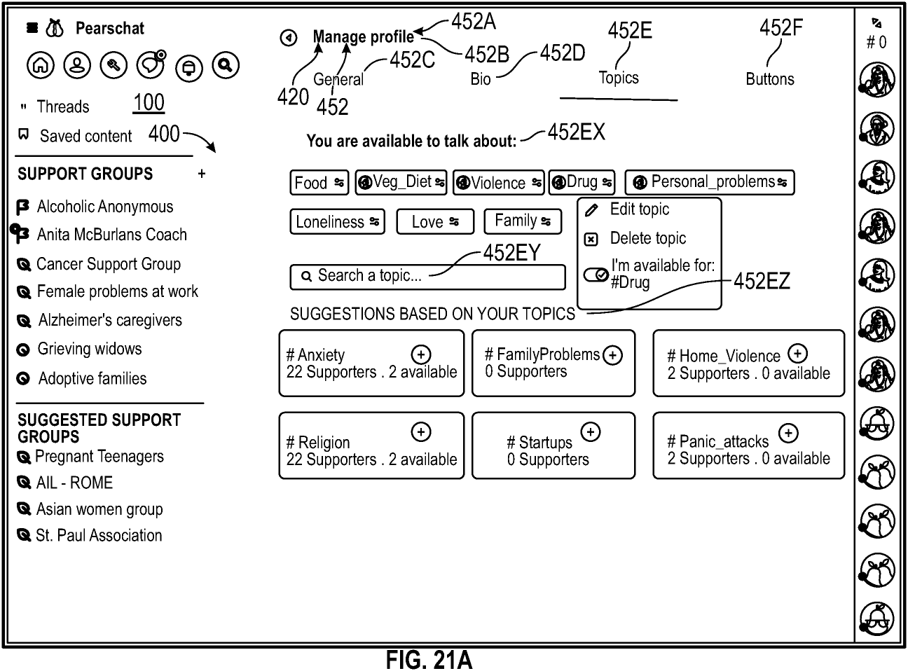

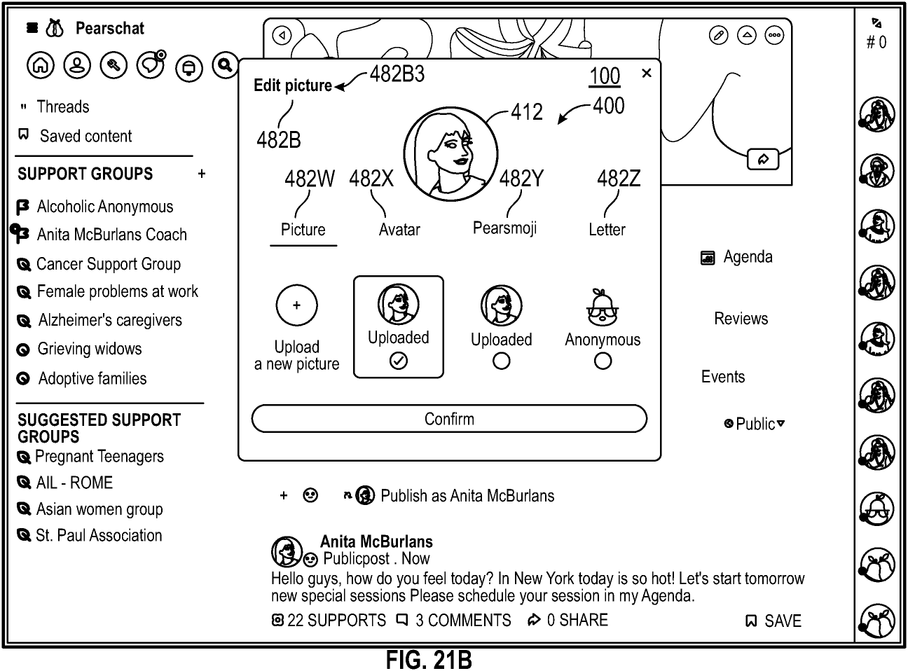

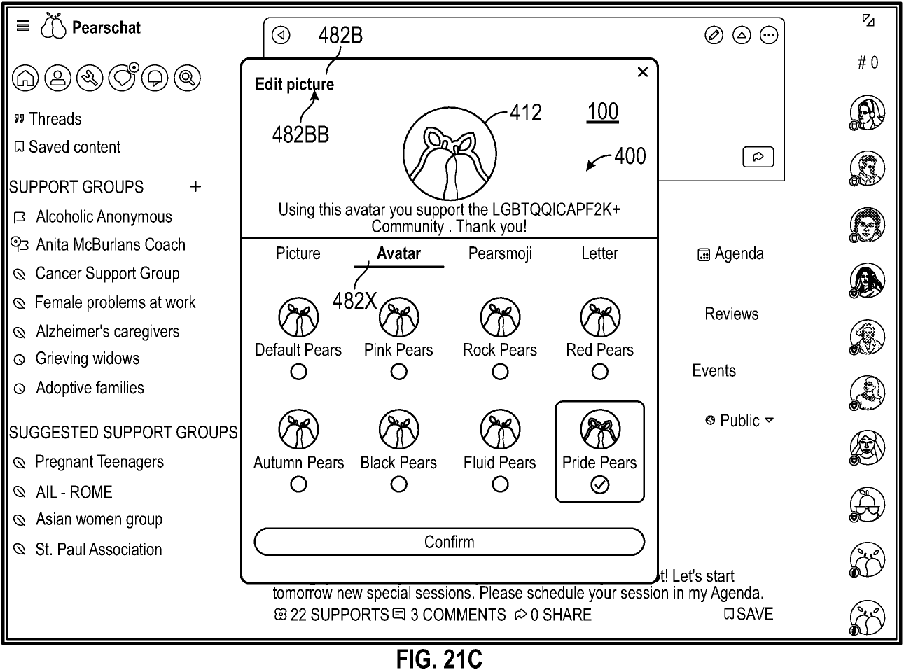

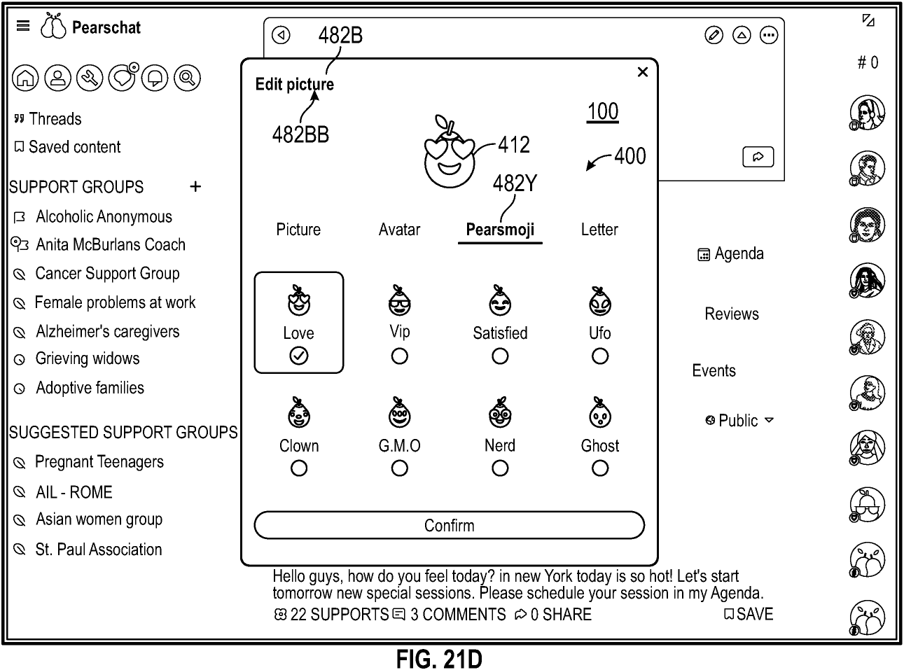

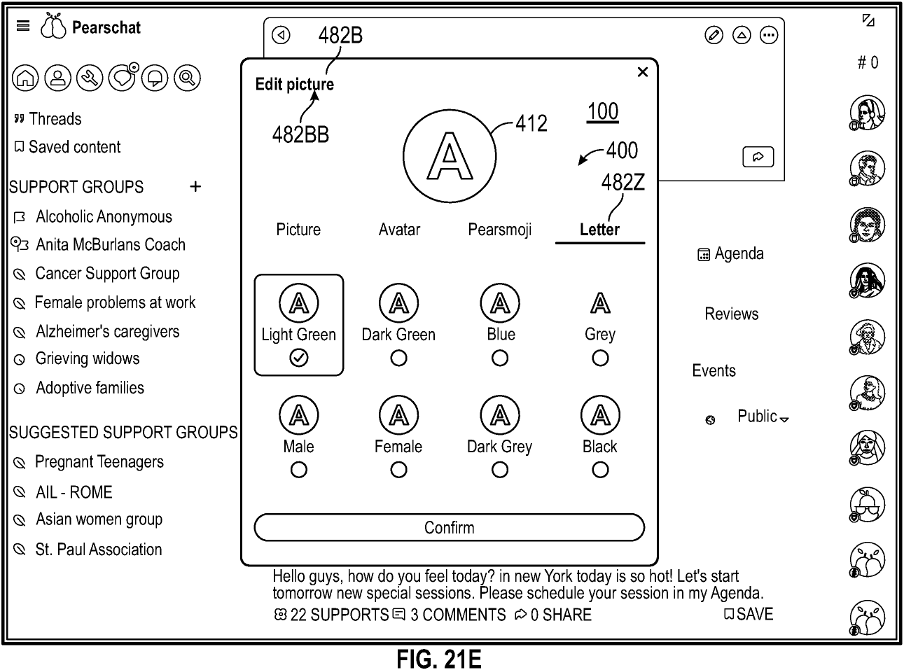

Further exemplary alternative embodiments of the profile management page 452A associated with the personal profile page 400 of the multiuse communication system 100 are shown in FIGS. 21A-E. In the manner set forth above, the profile management page 452A can enable the system user 200 to edit or otherwise manage the personal user profile information of the system user 200. As shown in FIG. 21A, the profile management page 452A can provide one or more personal user profile management options in the manner discussed in more detail above with reference to the profile management page 452A shown in FIG. 20C. The profile management page 452A, for example, can enable the system user 200 to edit or otherwise manage general information 452C, biographic information 452D, topical information 452E and/or button information 452F within the personal user profile of the system user 200. FIG. 21A shows that, when managing the topical information 452E, the profile management page 452A can enable the system user 200 to edit a current topic listing 452EX, permit the system user 200 to search for a topic 452EY and/or suggest one or more additional topics 452EZ to the system user 200.

In the manner discussed in more detail above with reference to FIGS. 19A-D, exemplary images 412 for representing the system user 200 can include one or more photographs or other pictures, one or more avatars, one or more character (such as symbols, letters and/or numbers), and/or emojis, without limitation. In selected embodiments, the character can comprise a character in English or any other language, such as a character in traditional Chinese and/or simplified Chinese. As illustrated in FIGS. 21A-D, the personal profile page 400 permit the system user 200 can include an optional user image data editing page 482BB for enabling the system user 200 to select at least one user image 412 to be associated with the personal profile page 400 and/or to edit the user image 412 previously associated with the personal profile page 400. The user image data editing page 482BB is shown as permitting the system user 200 to edit the user image 412 by selecting a picture 482W, an avatar 482X, an emoji (or a Pearemoji) 482Y and/or a letter (or other character) 482Z in English or any other language.

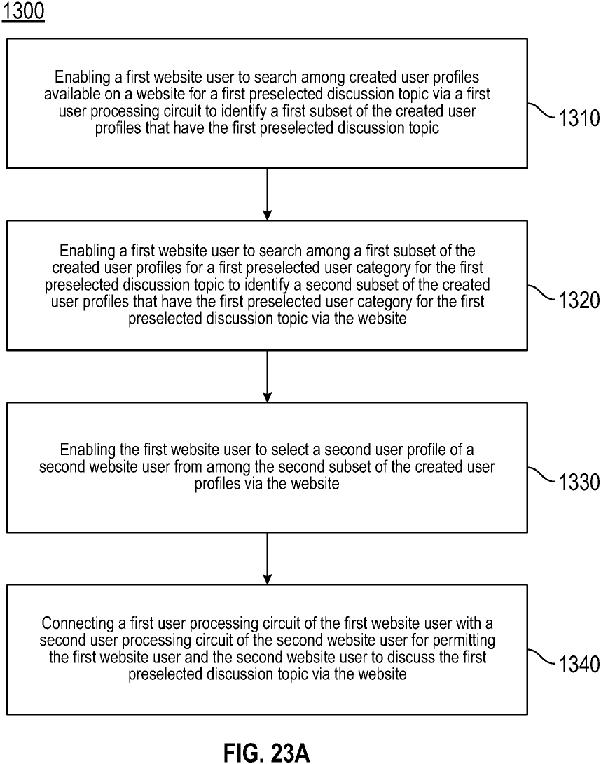

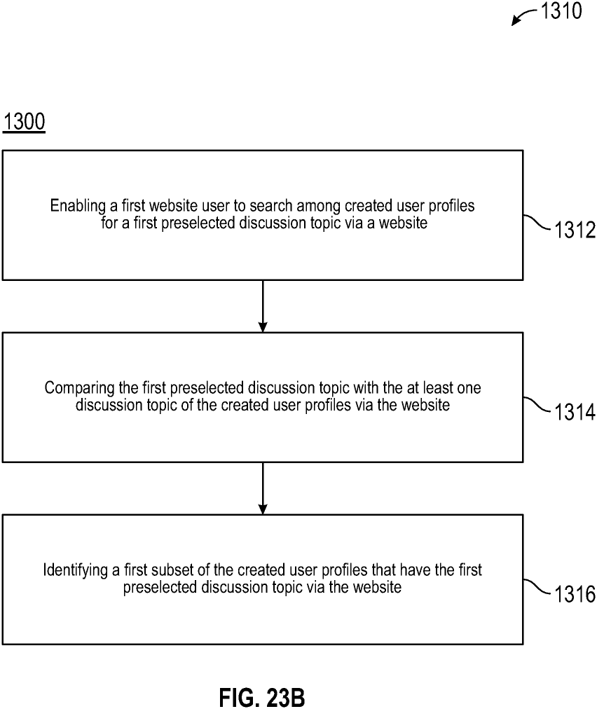

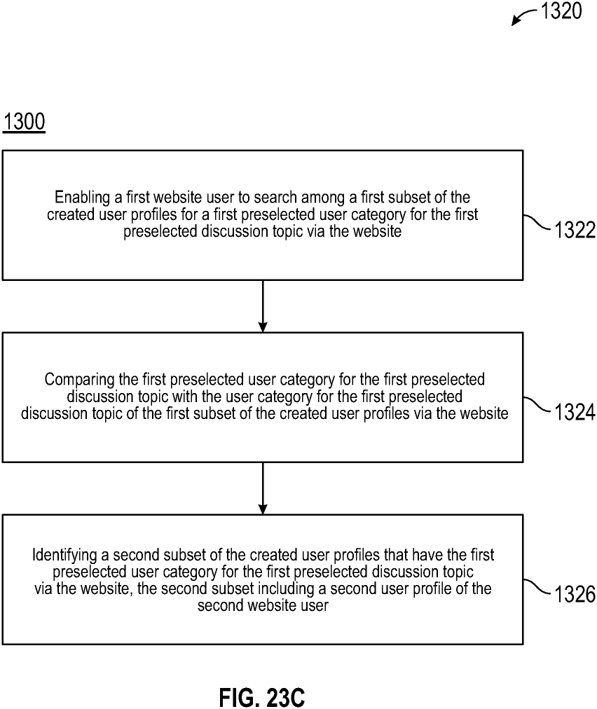

An exemplary method 1300 that can be performed via the multiuse communication system 100 is shown in FIGS. 23A-C. The exemplary method 1300, in selected embodiments, can comprise a computer-implemented method. If the multiuse communication system 100 comprises a website, for example, the exemplary method 1300 can connect a first user processing system 215 (shown in FIG. 1A) of a first system user 210 (shown in FIG. 1A) with a second user processing system 225 (shown in FIG. 1A) of a second system user 220 (shown in FIG. 1A) based upon shared needs and challenges of the first and second system users 210, 220 via the website. The website can enable system users 200 (shown in FIG. 1A) to create user profiles via respective user processing systems 205 (shown in FIG. 1A), each of the created user profiles having at least one discussion topic and a user category of the relevant system user 200 with respect to each discussion topic in the manner discussed in more detail above.

Turning to FIG. 23A, the method 1300 is shown as including, at 1310, enabling the first system user 210 to utilize the first user processing system 215 to search among the created user profiles available on the website for a first preselected discussion topic to identify a first subset of the created user profiles that have the first preselected discussion topic. The method 1300 also includes enabling the first system user 210 to the first user processing system 215 for searching among a first subset of the created user profiles for a first preselected user category for the first preselected discussion topic to identify a second subset of the created user profiles that have the first preselected user category for the first preselected discussion topic via the website, at 1320. The first system user 210, at 1330, can be enabled to select a second user profile of a second system user 220 from among the second subset of the created user profiles via the website.

The first user processing system 215 of the first system user 210 thereby can be connected, at 1340, with the second user processing system 225 of the second system user 220 for permitting the first system user 210 and the second system user 220 to discuss the first preselected discussion topic via the website. In selected embodiments, the connection between the first user processing system 215 and the second user processing system 225 can comprise a chat box in the manner discussed in more detail herein. The chat box, for example, can enable the first system user 210 to communicate with, and otherwise interact with, the second system user 220 who has been identified the first preselected discussion topic as being of interest. The chat box, in other words, can facilitate communication between the first system user 210 and the second system user 220.

An exemplary embodiment of enabling the first system user 210 to utilize the first user processing system 215 to search among the created user profiles available on the website, at 1310, is shown in FIG. 23B. Turning to FIG. 23B, the method 1300 can include, at 1312, enabling the first system user 210 to search among the created user profiles for a first preselected discussion topic via the website. At 1314, the first preselected discussion topic can be compared with the at least one discussion topic of the created user profiles via the website. The first subset of the created user profiles that have the first preselected discussion topic thereby can be identified via the website, at 1316.

FIG. 23C illustrates an exemplary embodiment of enabling the first system user 210 to the first user processing system 215 for searching among a first subset of the created user profiles for a first preselected user category for the first preselected discussion topic to identify a second subset of the created user profiles that have the first preselected user category for the first preselected discussion topic via the website, at 1320. Turning to FIG. 23C, the method 1300 is shown as including, at 1322, enabling the first system user 210 to search among the first subset of the created user profiles for a first preselected user category for the first preselected discussion topic via the website. At 1324, the first preselected user category for the first preselected discussion topic can be compared with the user category for the first preselected discussion topic of the first subset of the created user profiles via the website. A second subset of the created user profiles that have the first preselected user category for the first preselected discussion topic can be identified, at 1326, via the website. The second subset can include a second user profile of the second system user 220.

In selected embodiments, a selected system user 200 can have more than one profile. When a first system user 210 searches a topic and/or specifies the type of a second system user 220 with whom the first system user 210 wants to communicate, the multiuse communication system 100 can respond by presenting a message, such as a pop-up message. The message, for example, can include question such as “Would you like to continue with this profile, switch to a different profile or create a new one?” Additionally and/or alternatively, if the first system user 210 receives a call from, or is otherwise contacted by, the second system user 220, the multiuse communication system 100 can present a brief description of the user profile of the second system user 220, a preview of any reviews of the second system user 220, and/or the discussion topic that the second system user 220 is willing to discuss can appear. The first system user 210 thereby can accept or reject the call. If the first system user 210 accepts the call from the second system user 220, an availability of the second system user 220 can be shown in the calendar of the first system user 210.

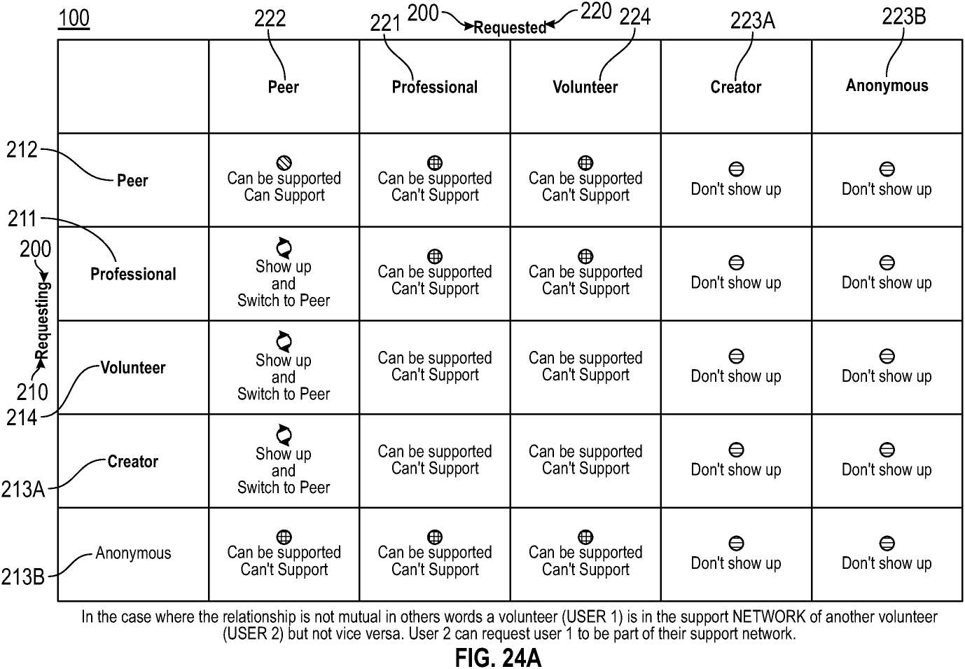

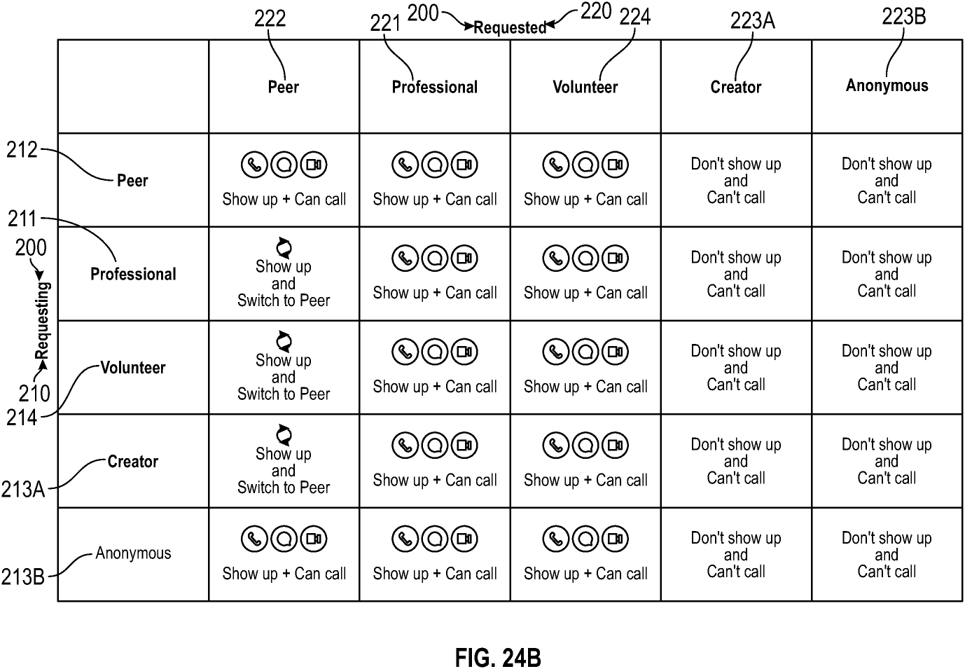

In the manner discussed herein, each first system user 210 can be associated with one or more first user categories or other groups, and/or each second system user 220 can be associated with one or more second user categories. FIG. 24A illustrates selected exemplary first user categories for the first system user 210 can include a peer first user 212, a professional first user 211, a volunteer first user 214, a coach first user 216, a creator first user 213A and/or an anonymous first user 213B, without limitation. Additionally and/or alternatively, the second user categories for the second system user 220 can include, but are not limited to, a peer second user 222, a professional second user 221, a volunteer second user 224, a coach second user 226, a creator second user 223A and/or an anonymous second user 223B as shown in FIG. 24A.

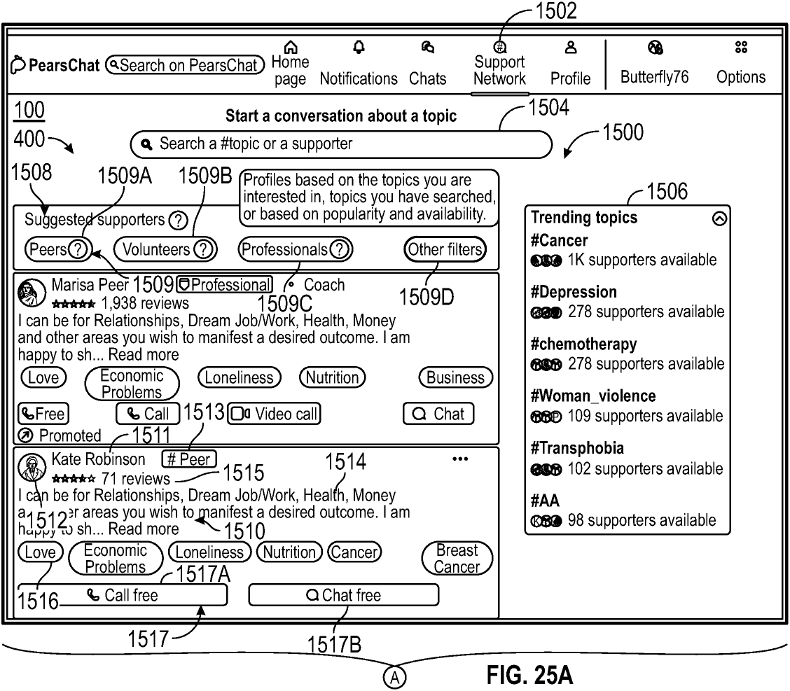

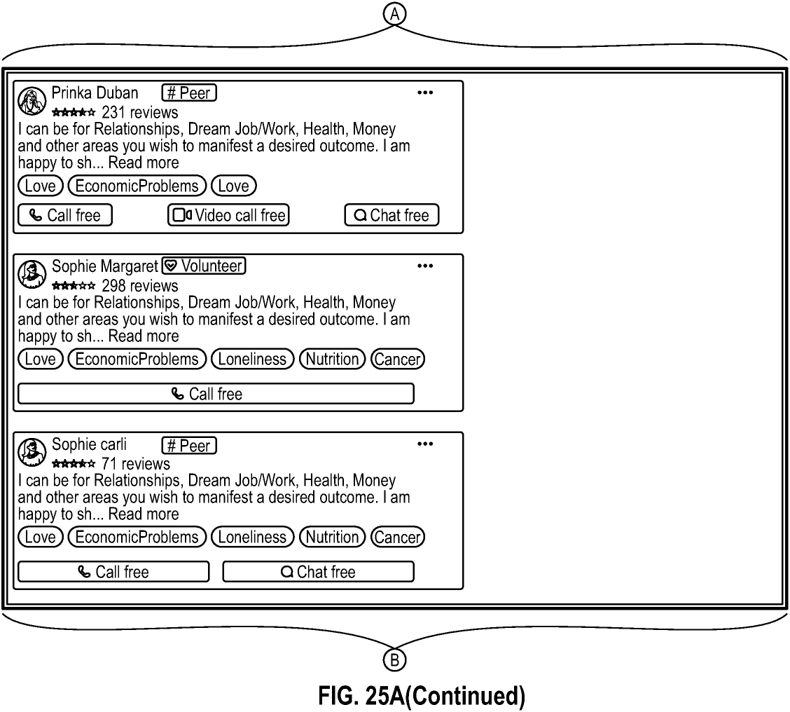

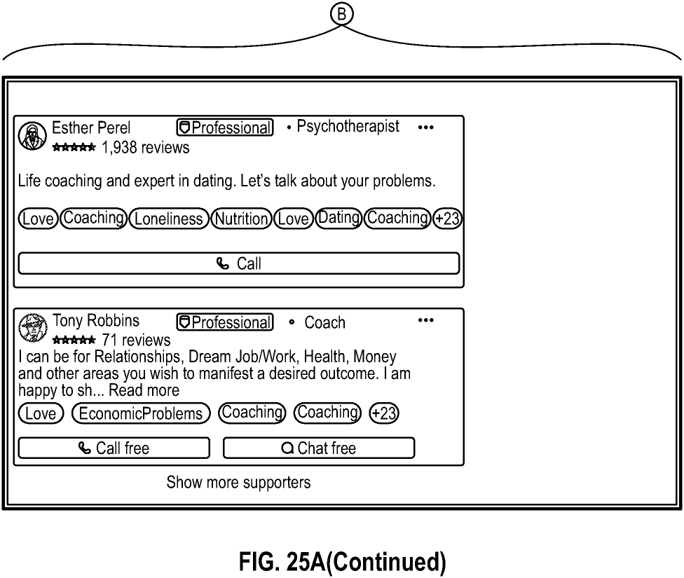

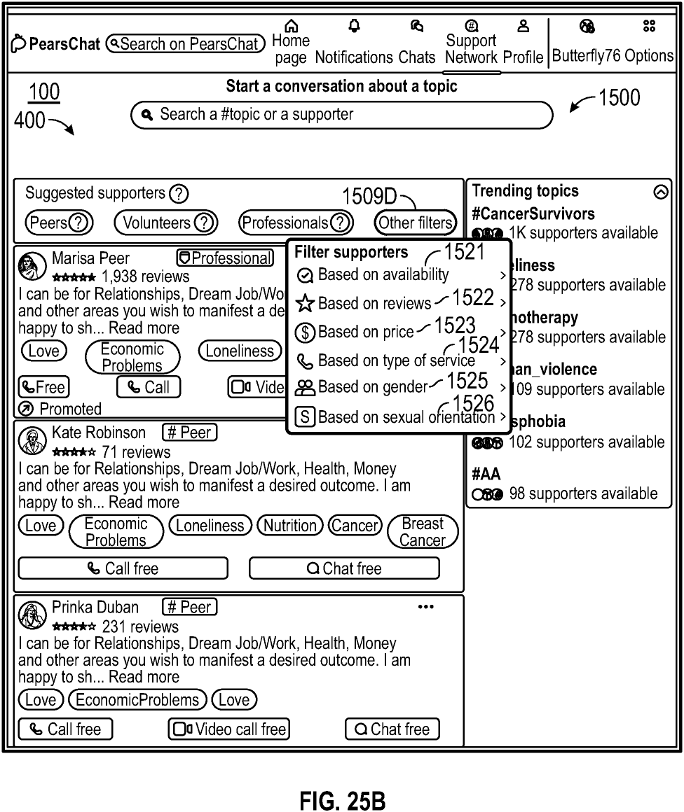

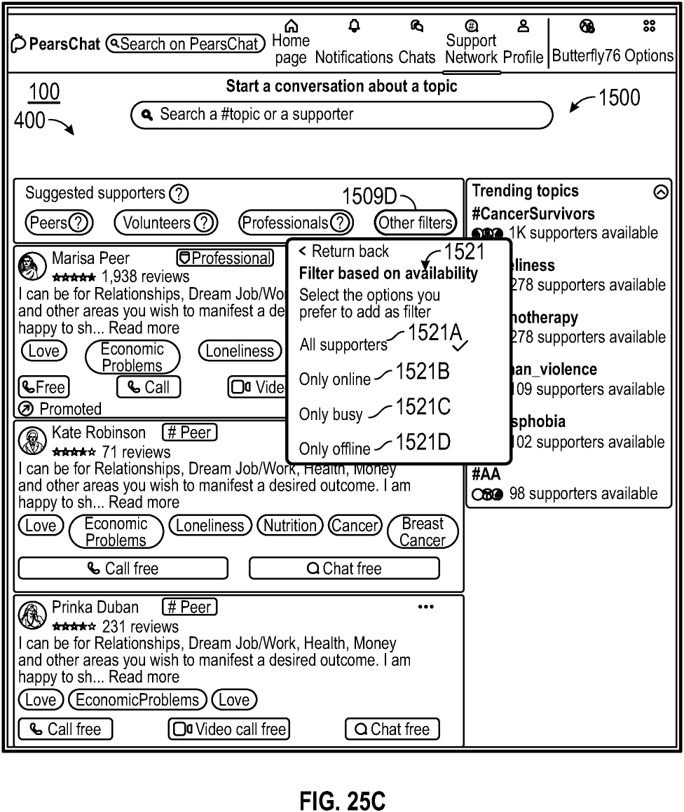

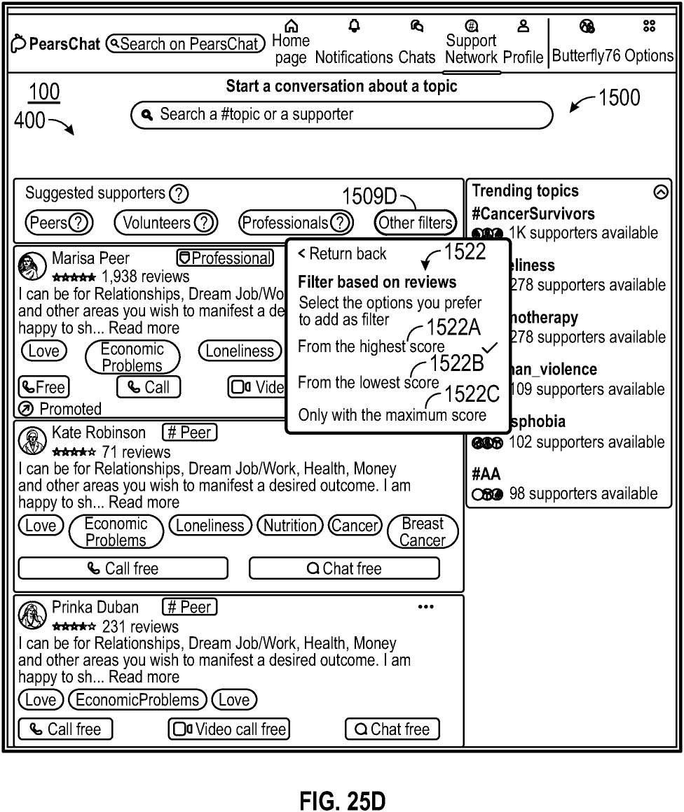

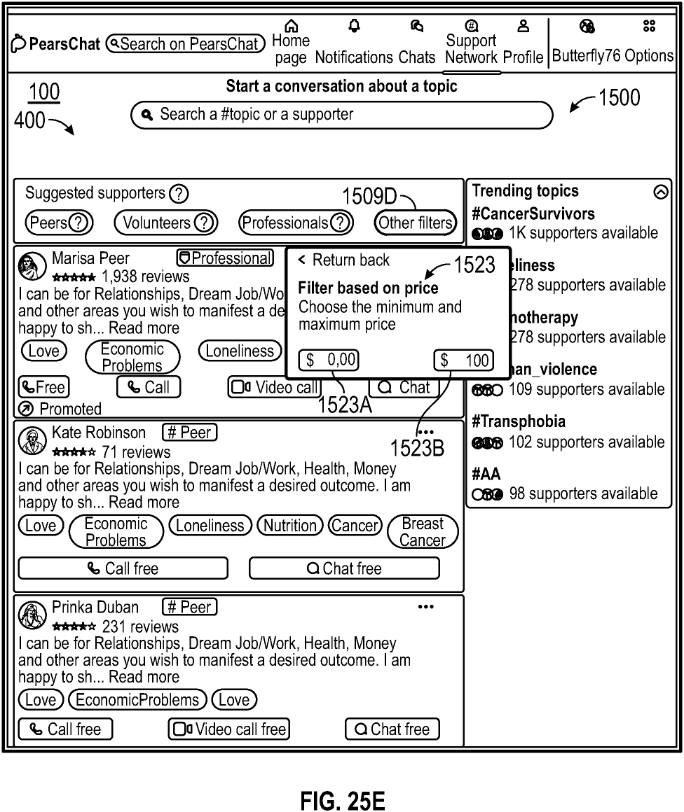

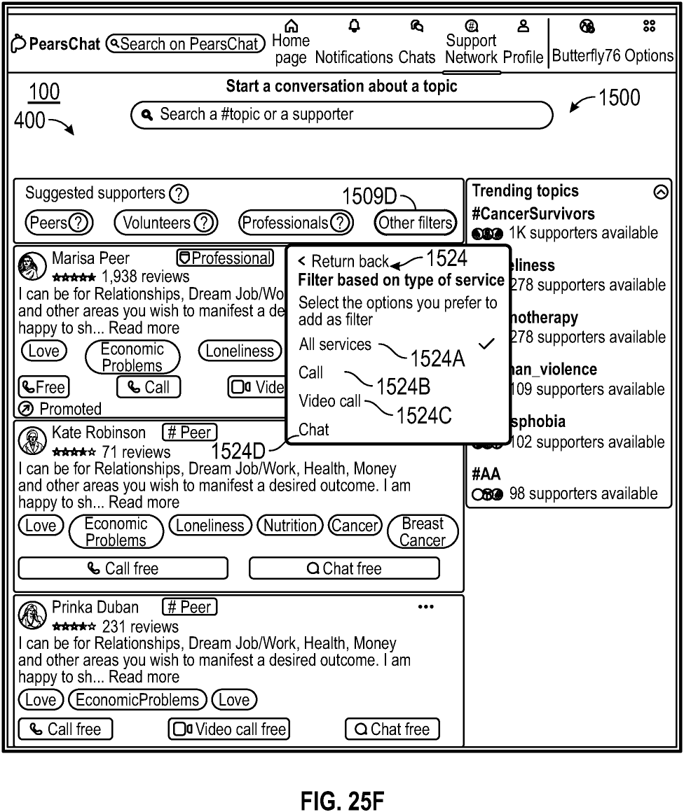

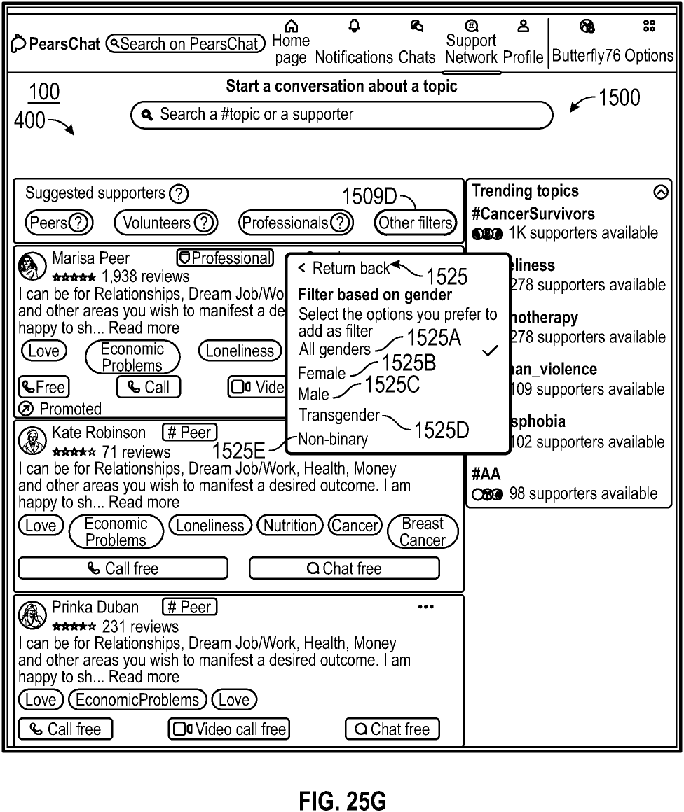

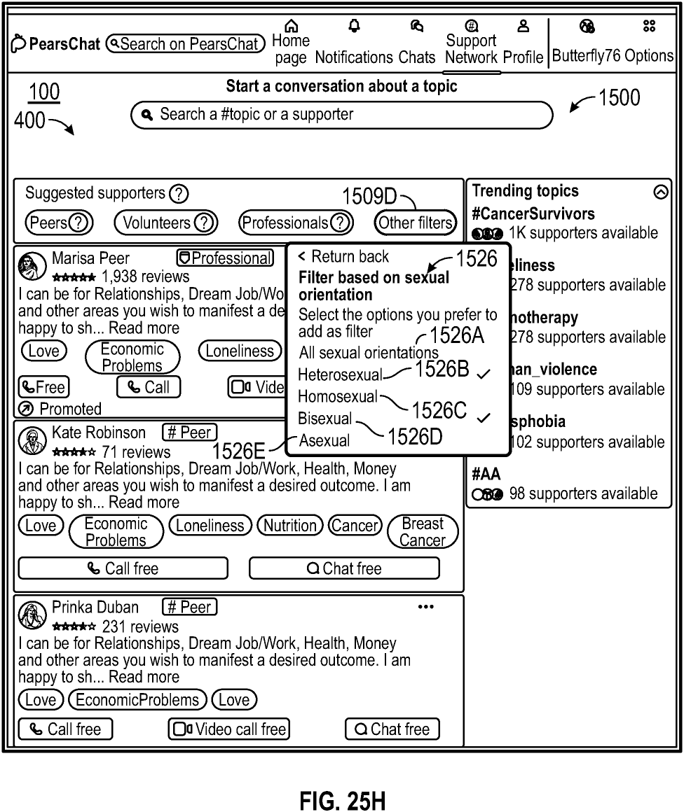

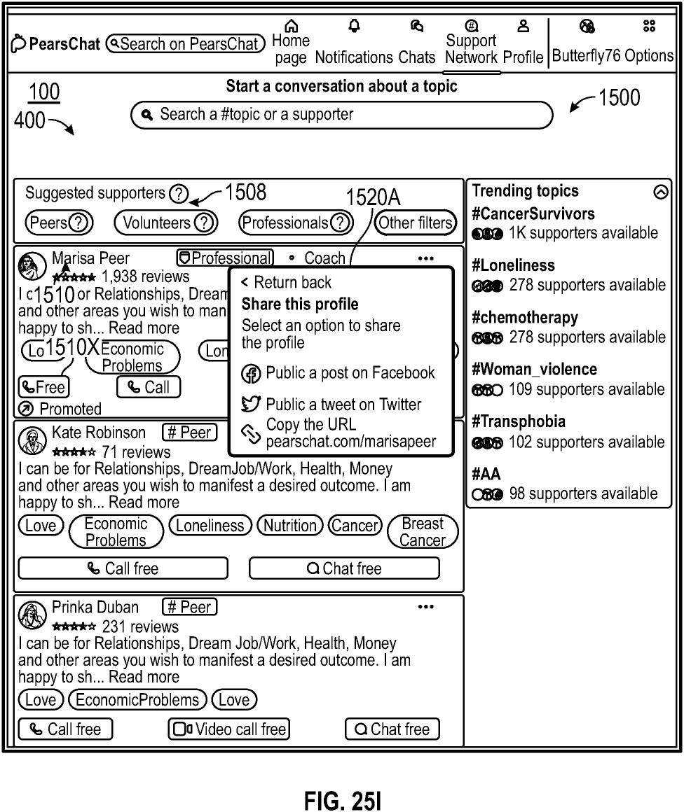

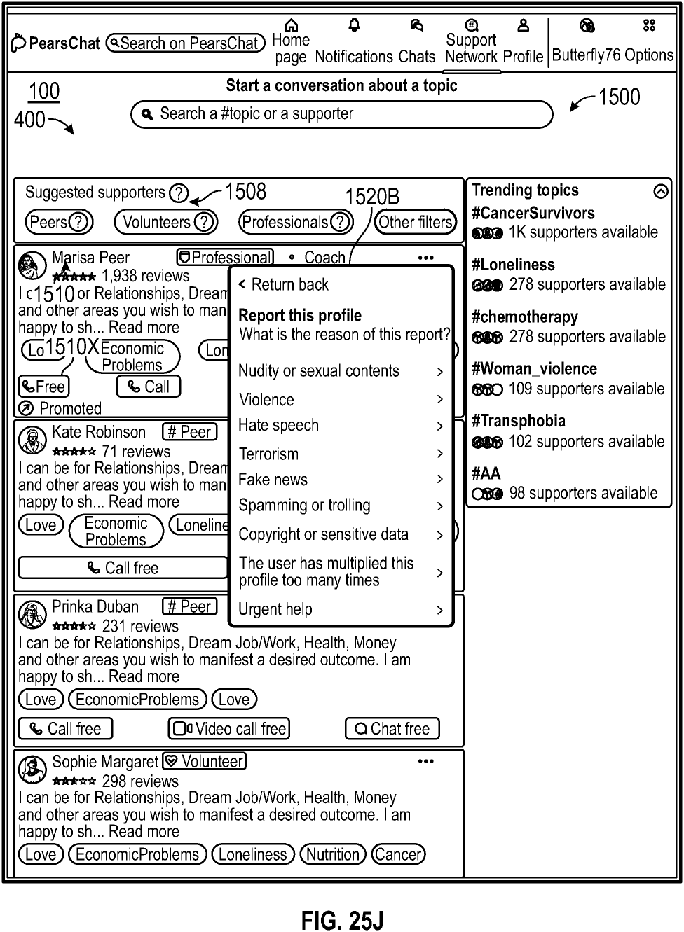

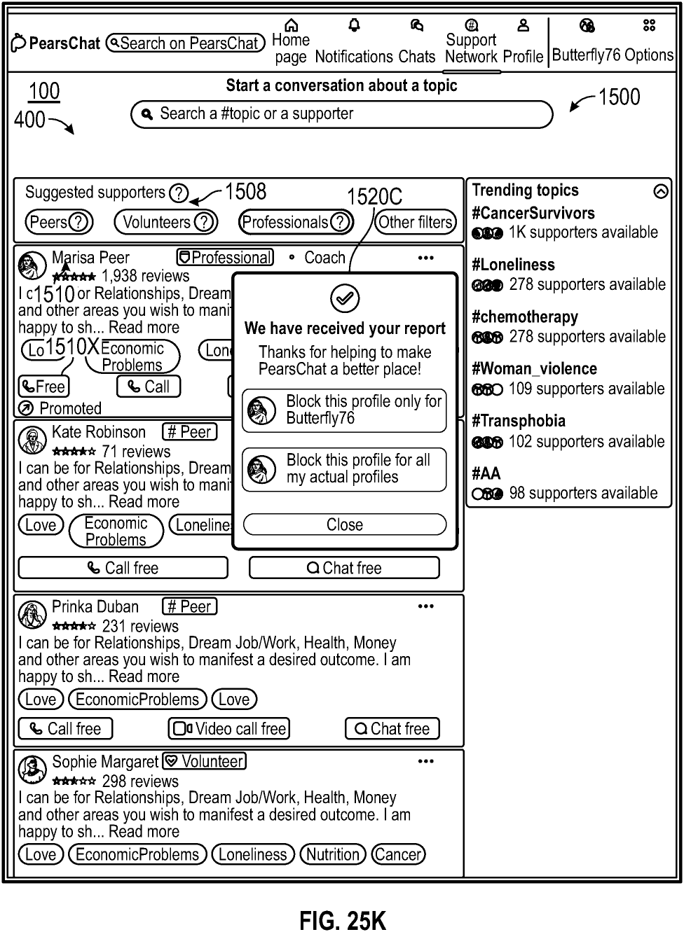

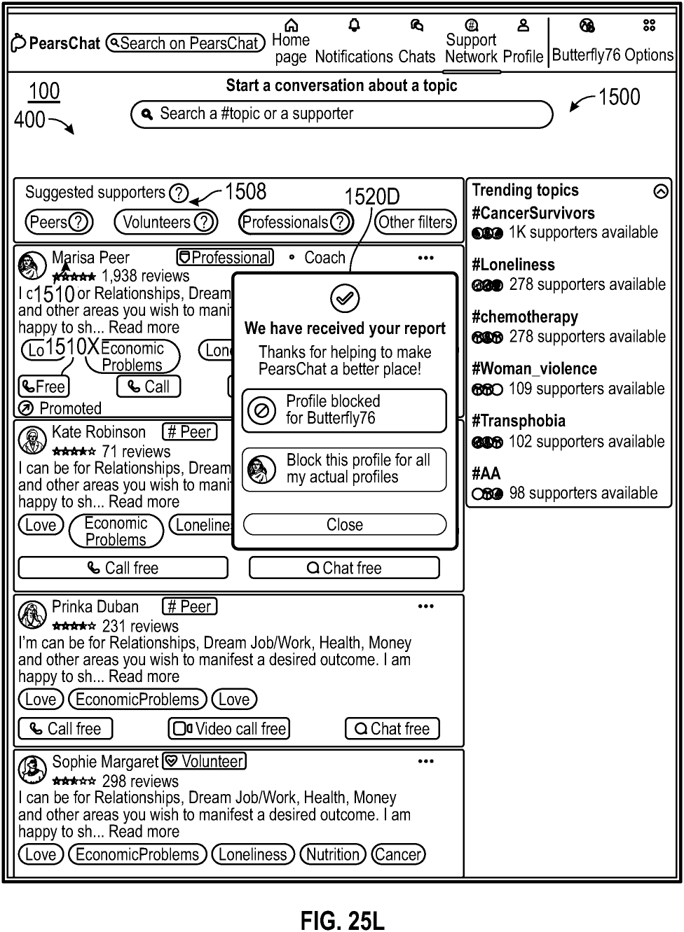

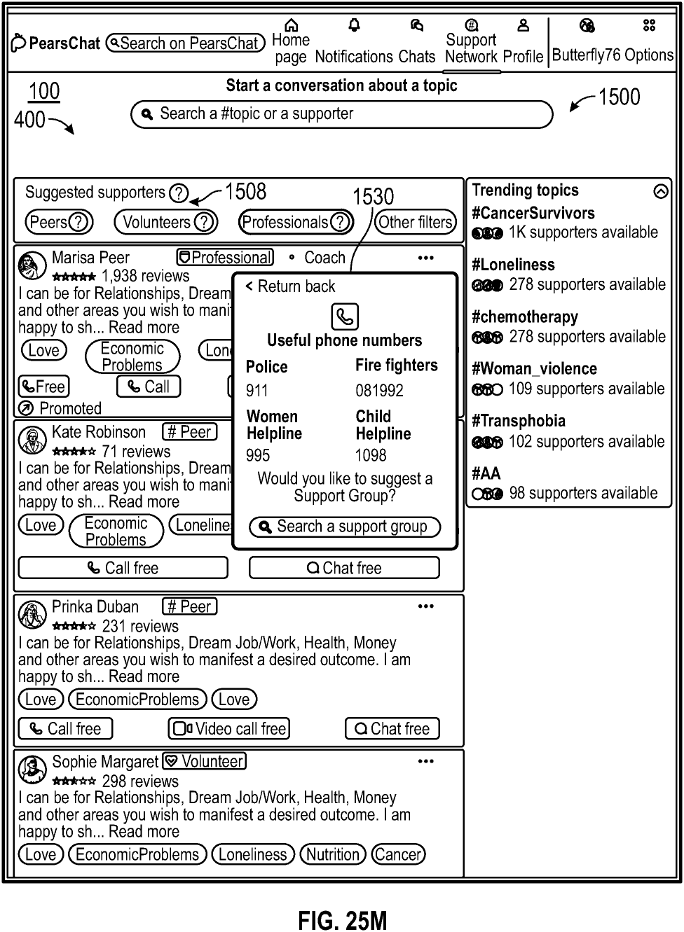

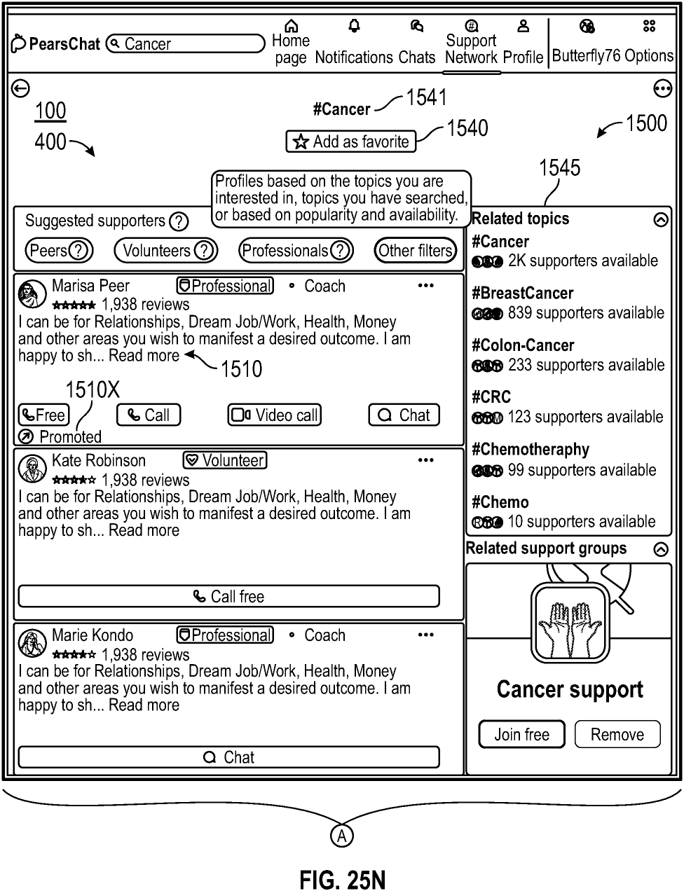

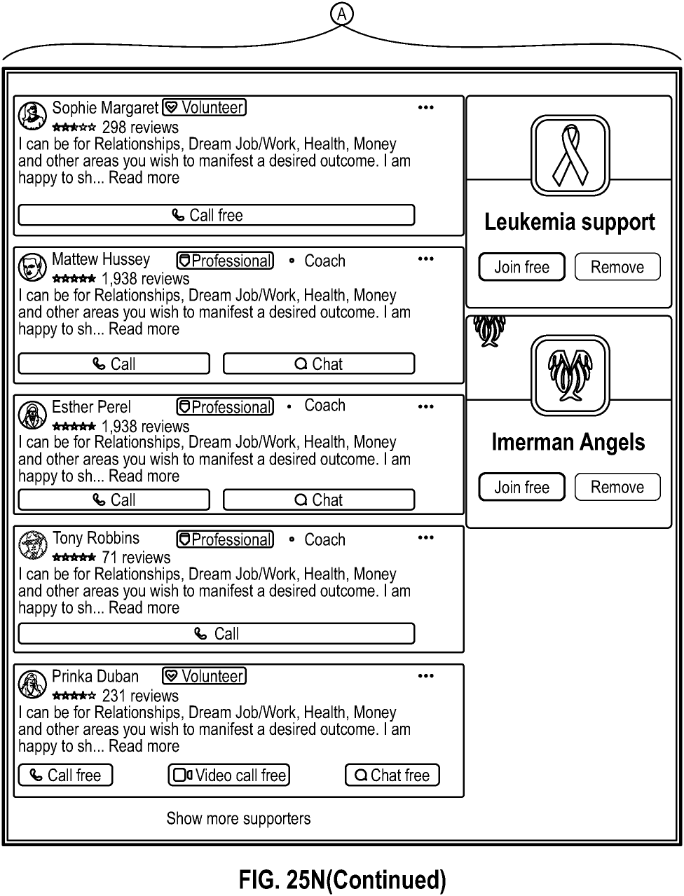

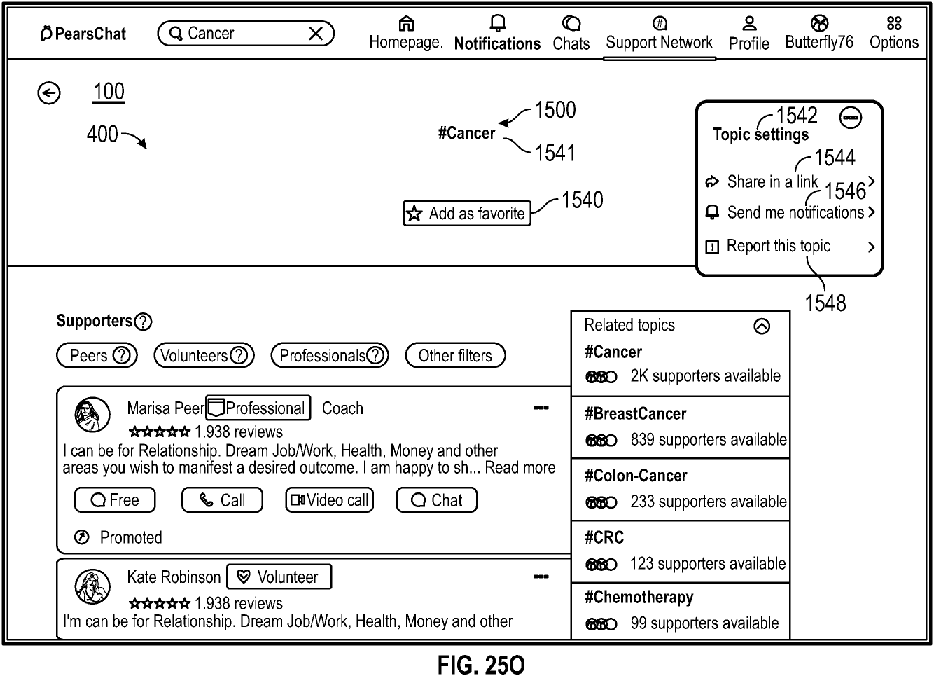

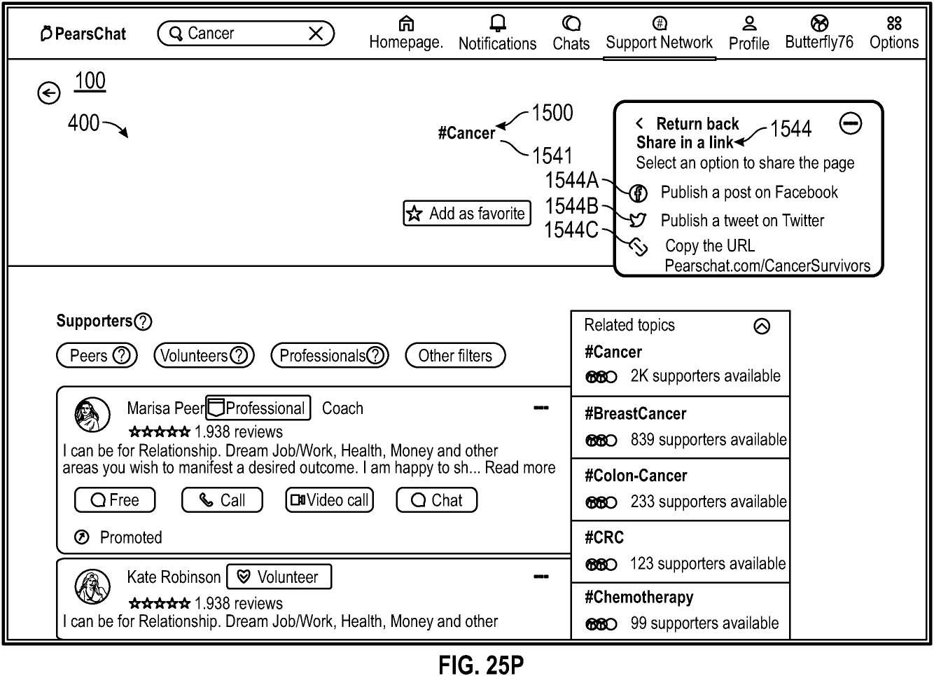

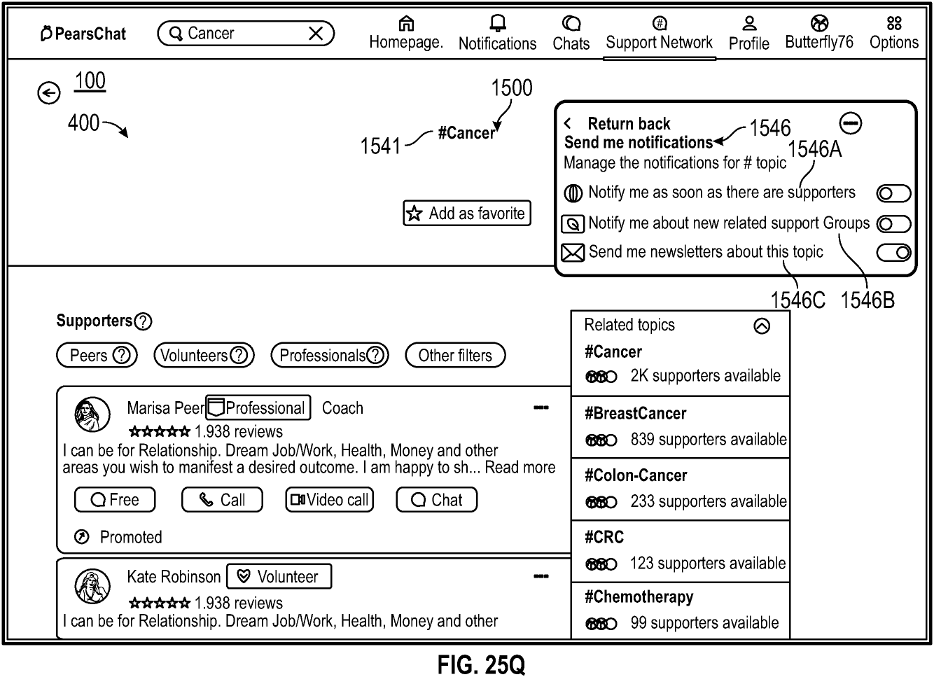

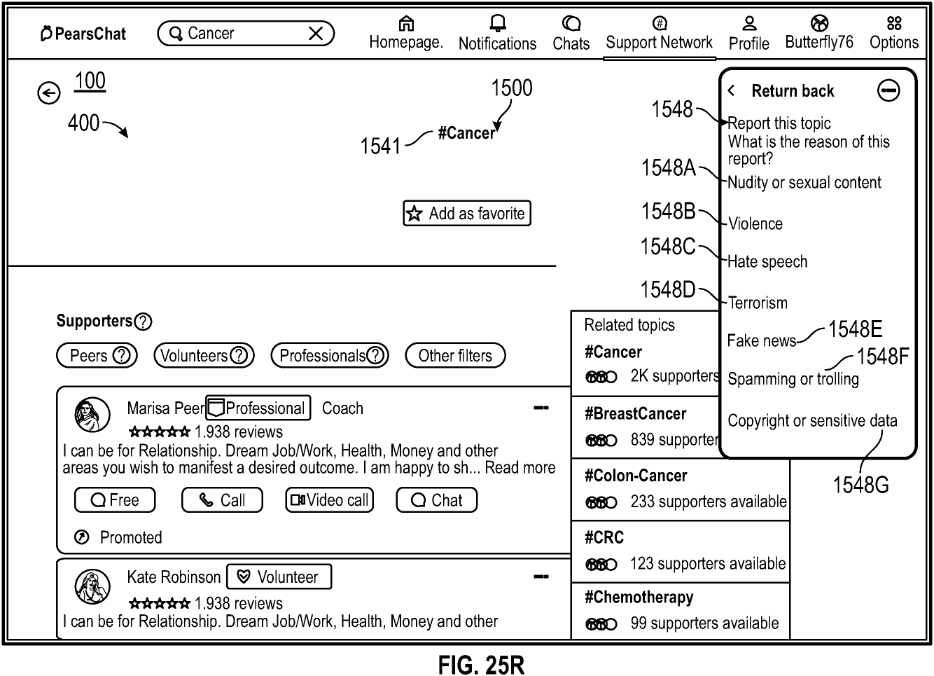

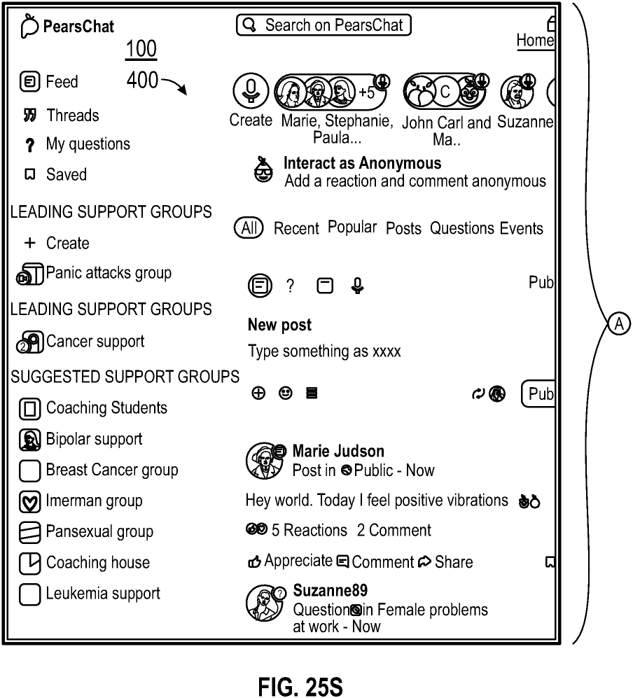

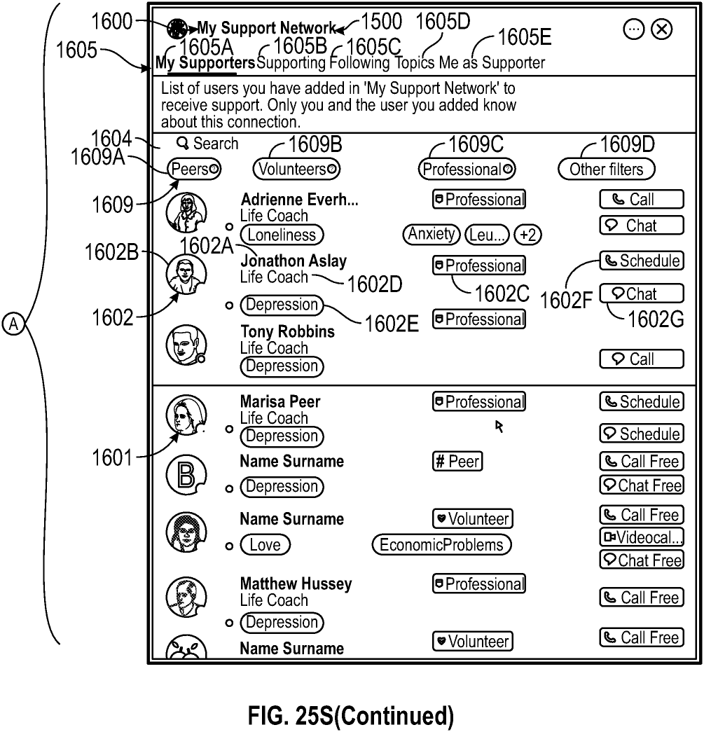

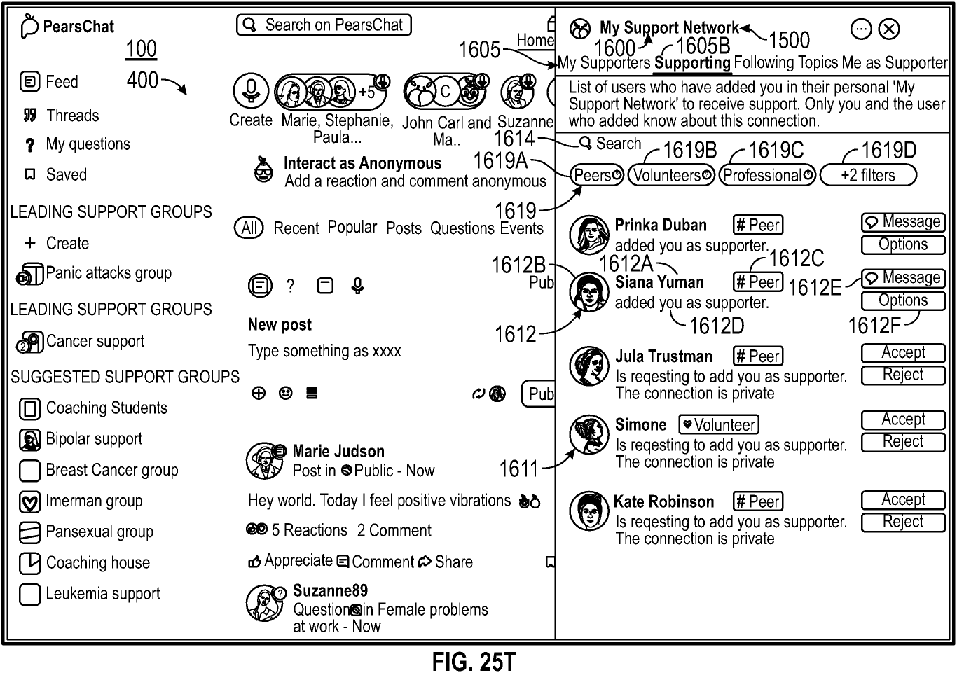

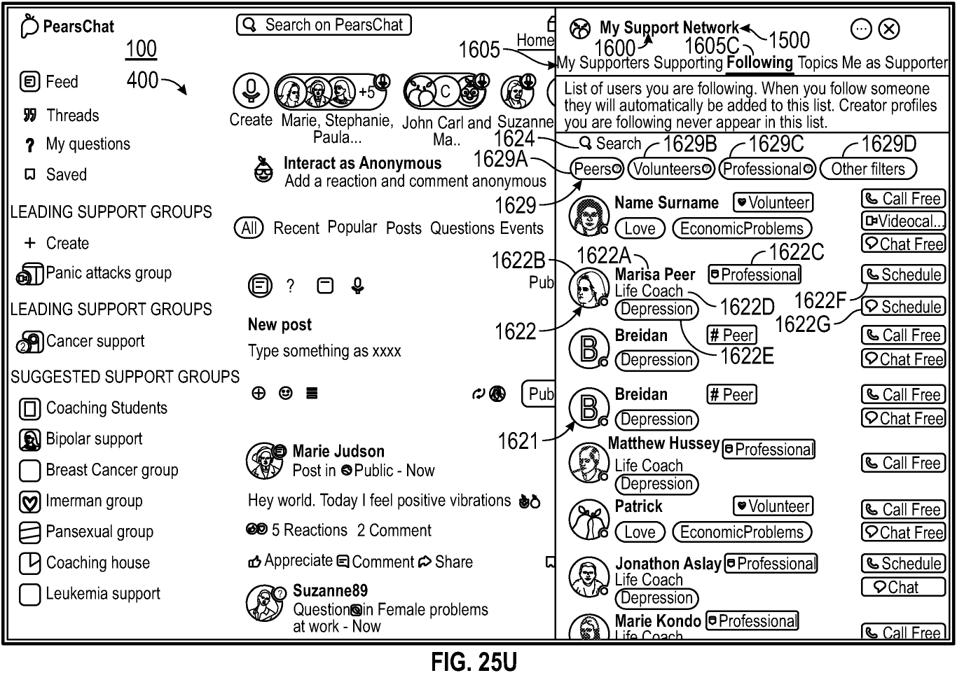

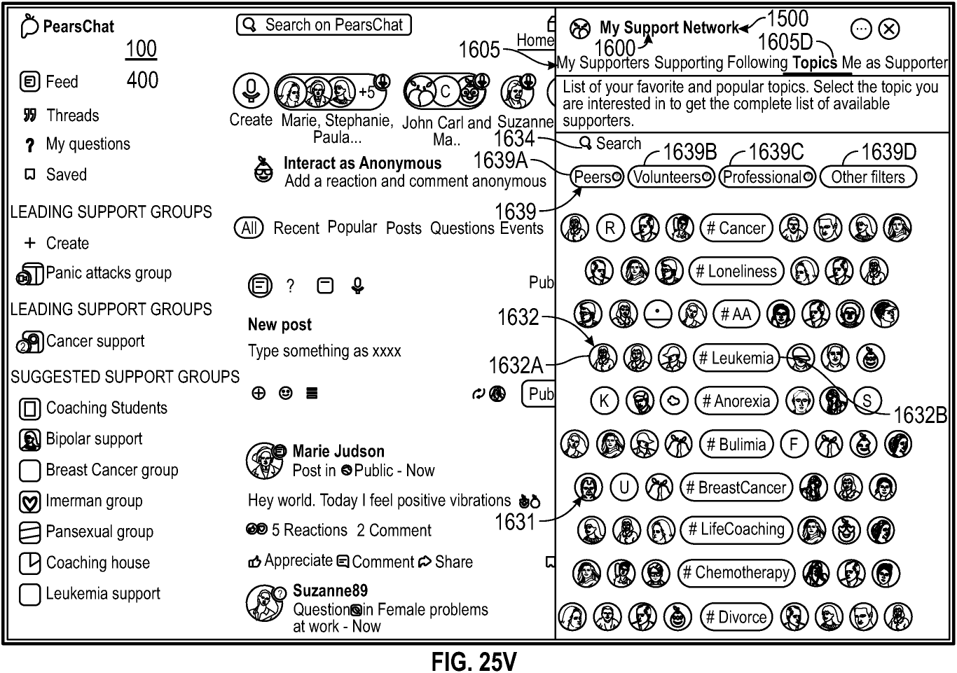

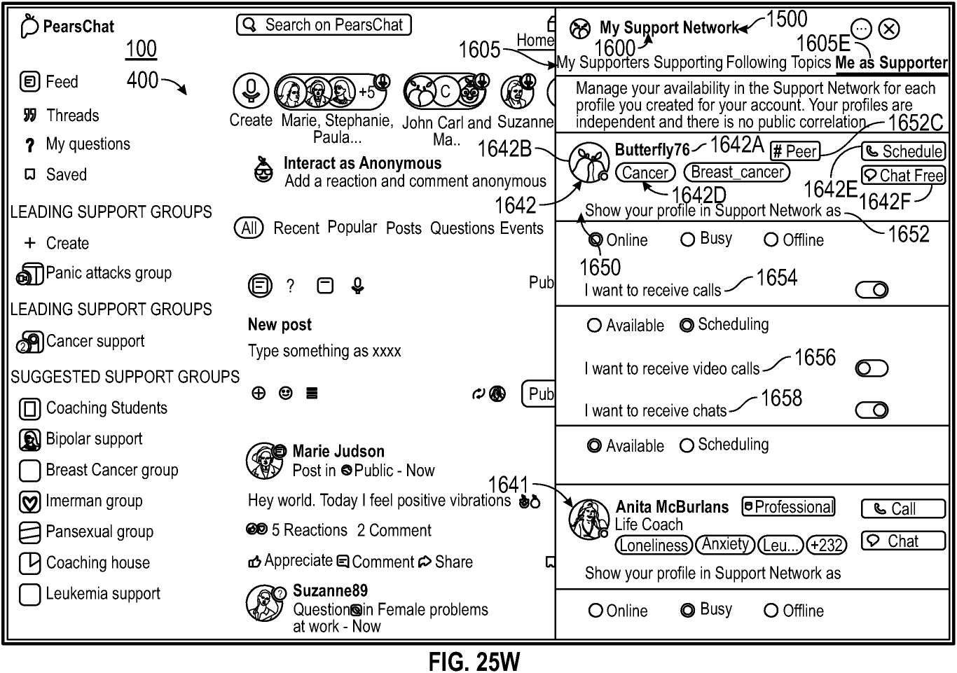

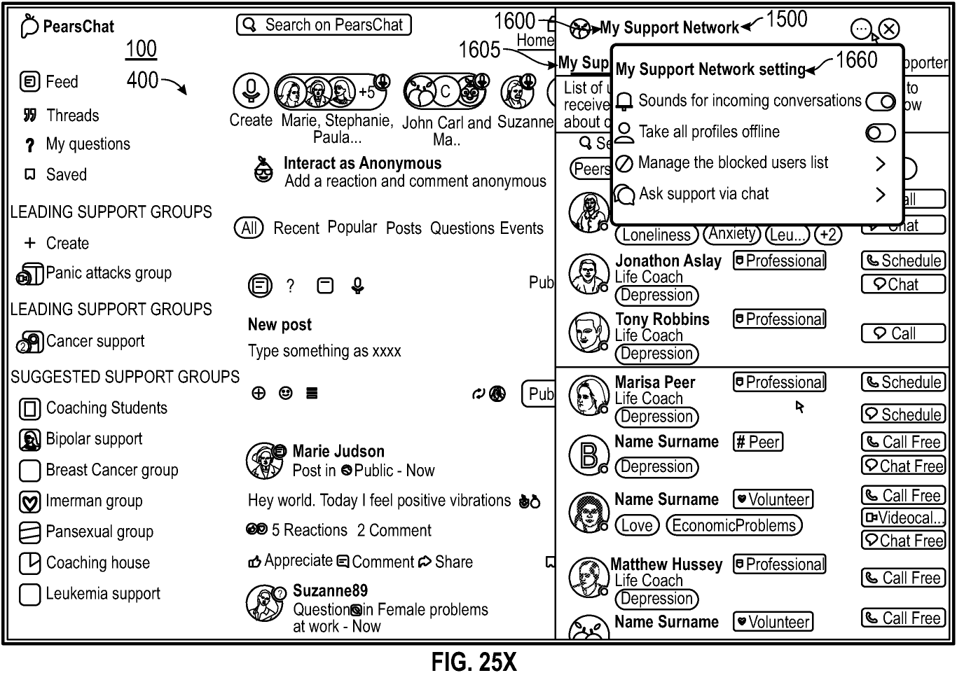

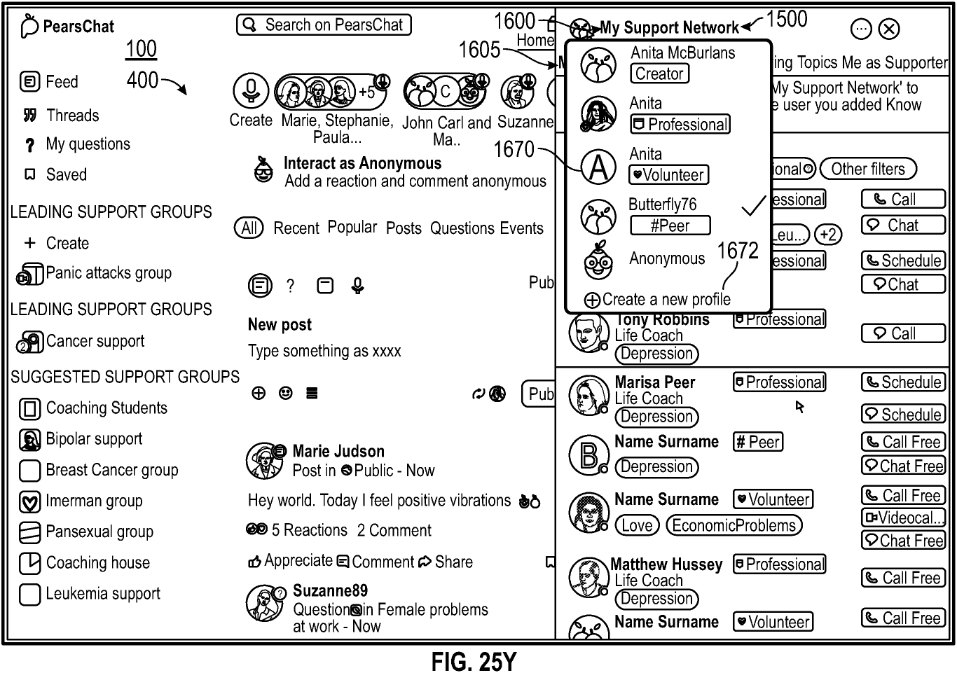

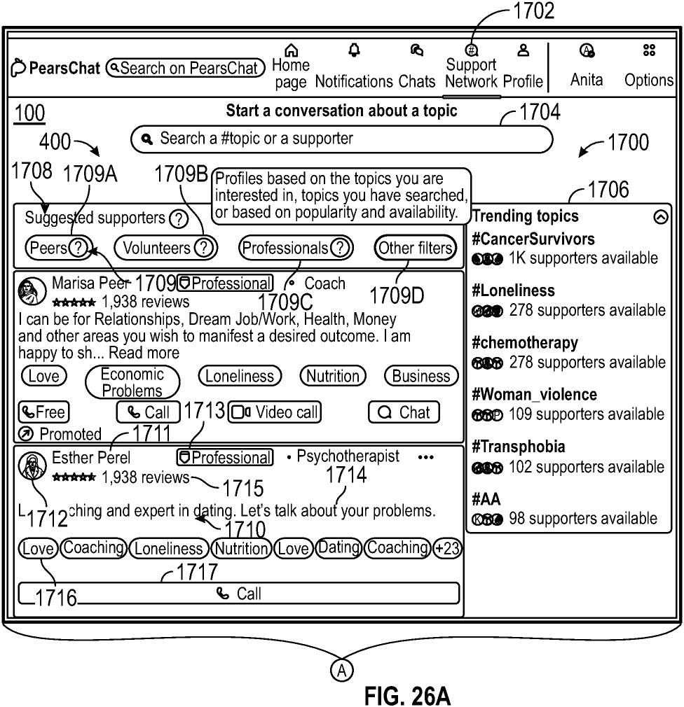

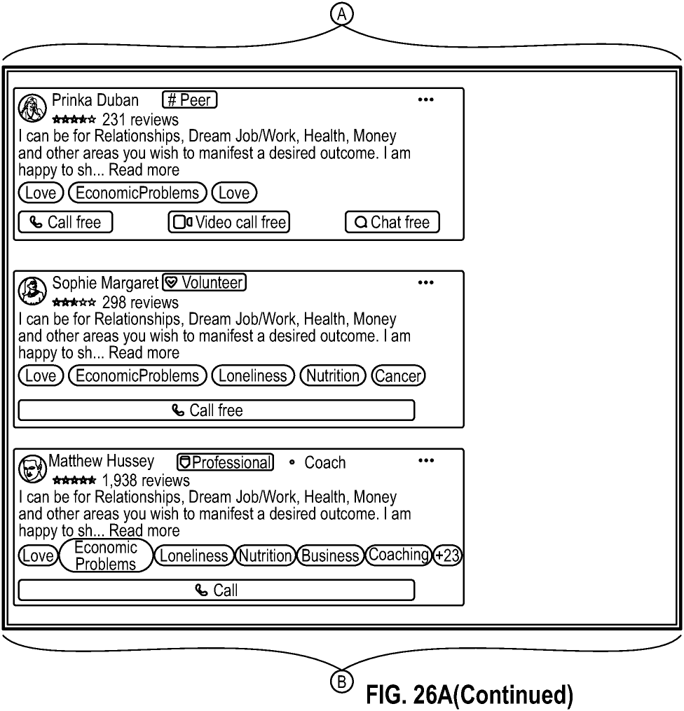

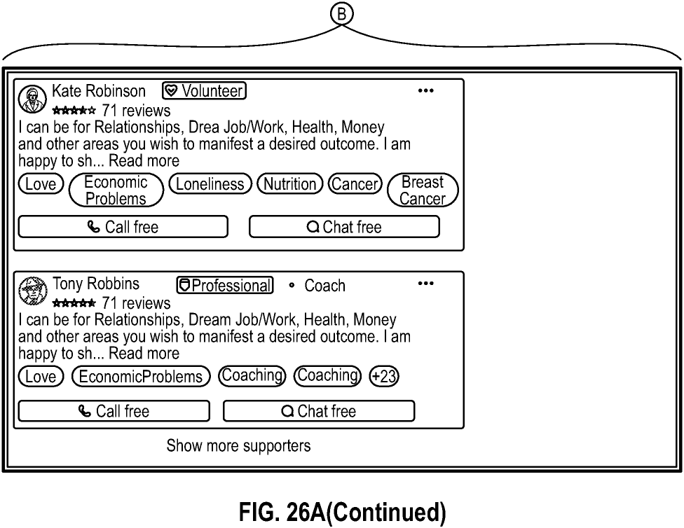

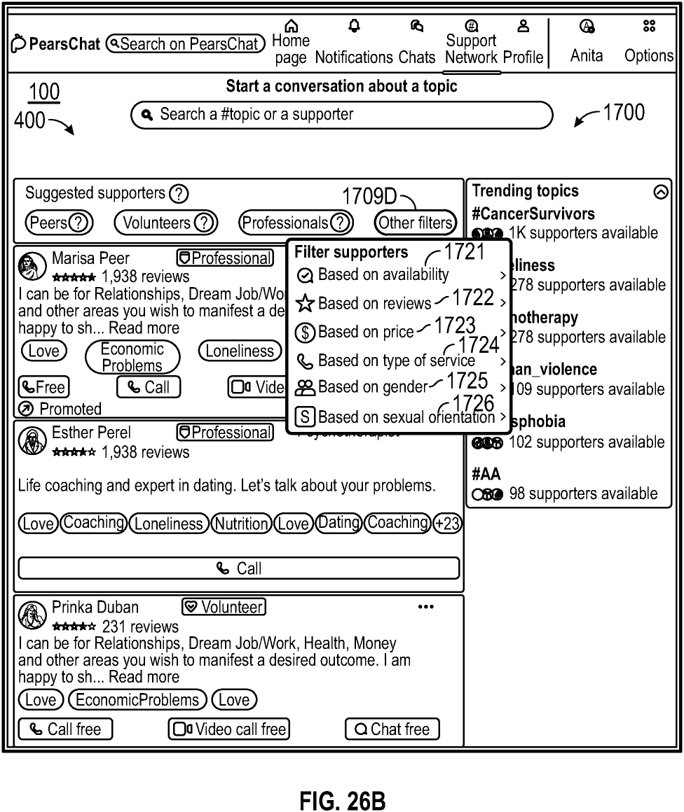

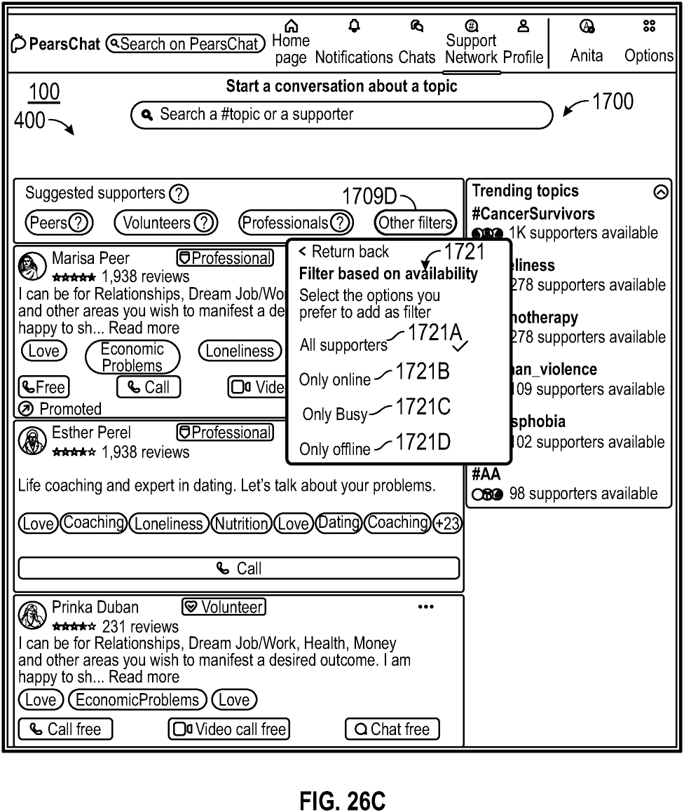

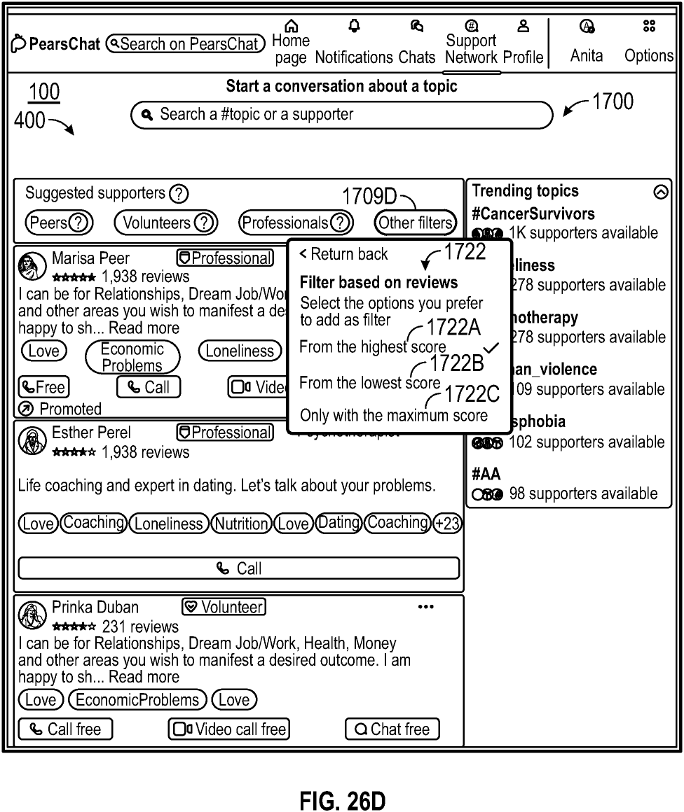

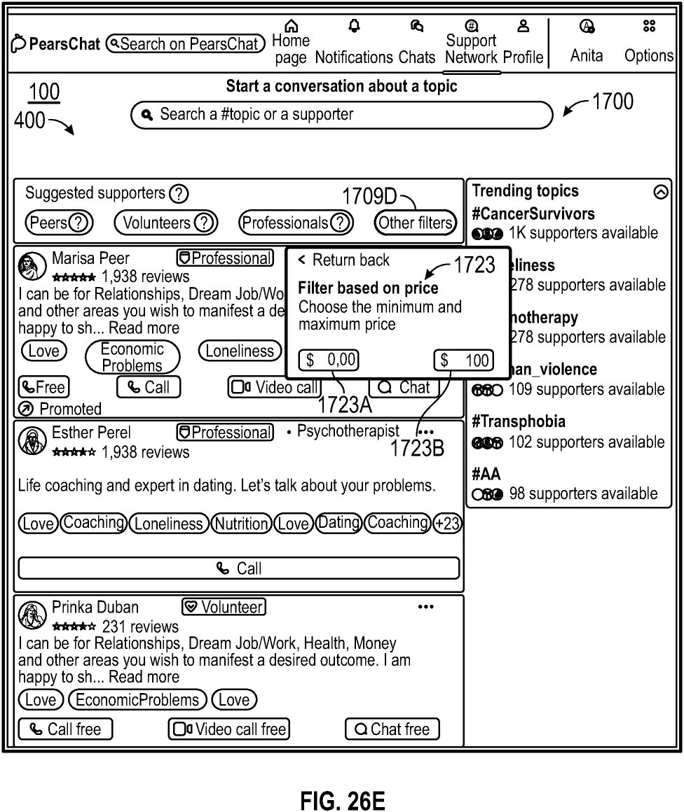

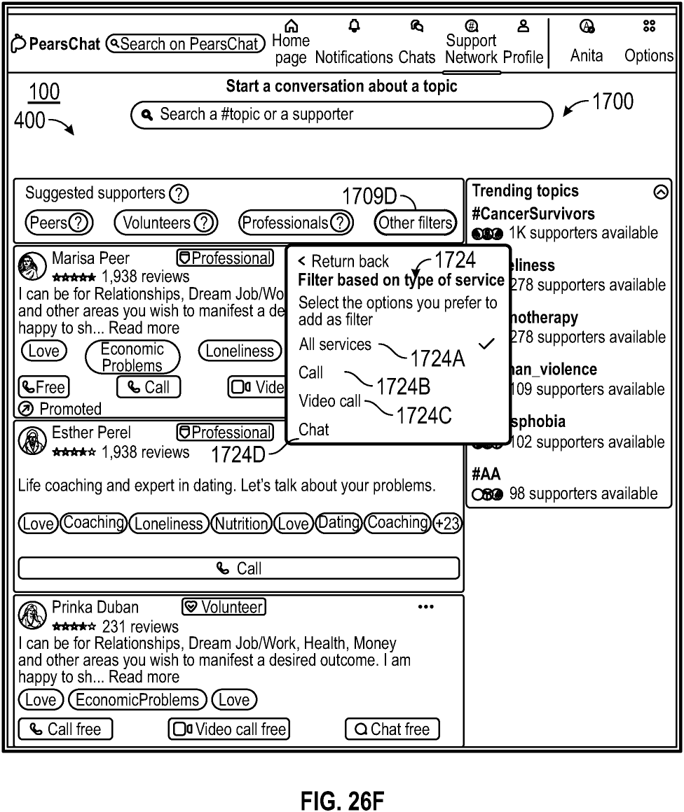

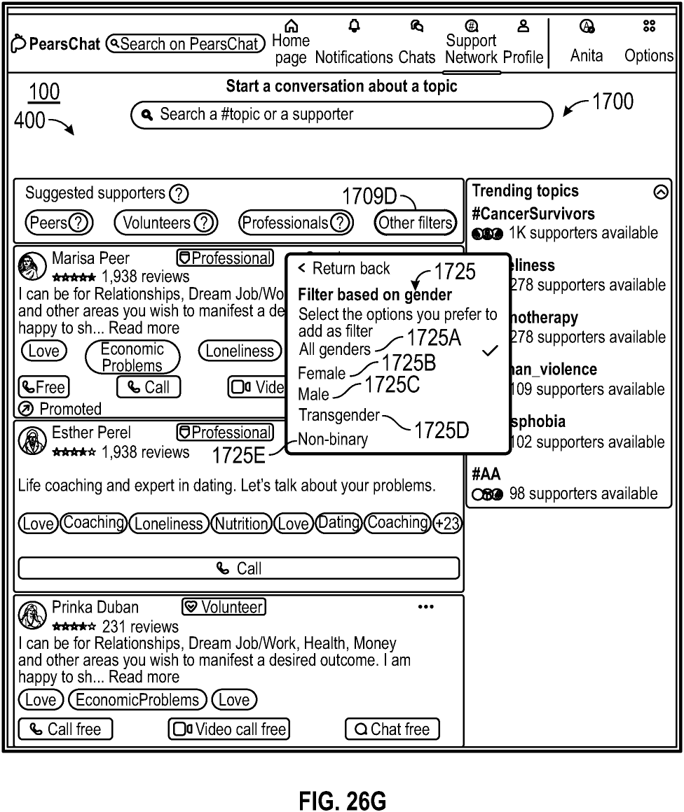

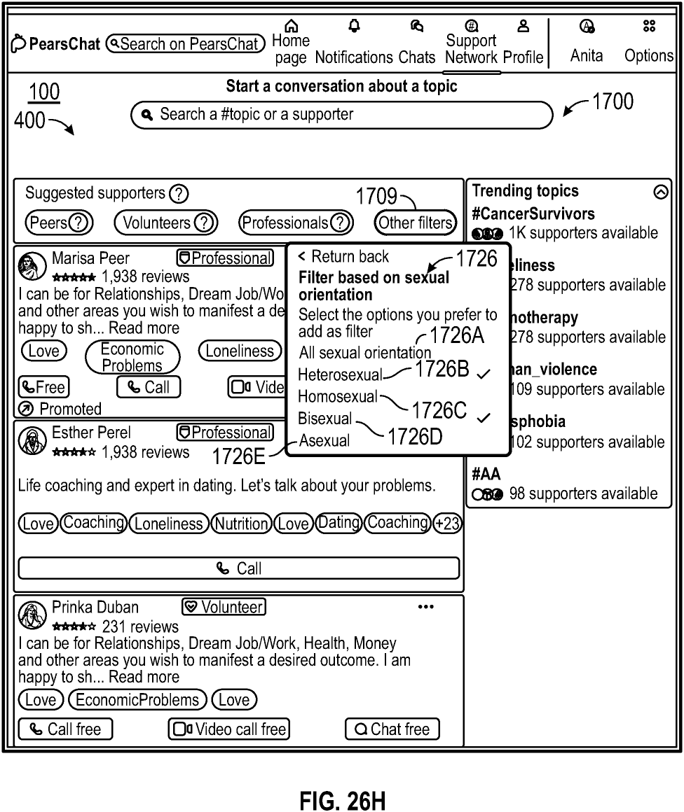

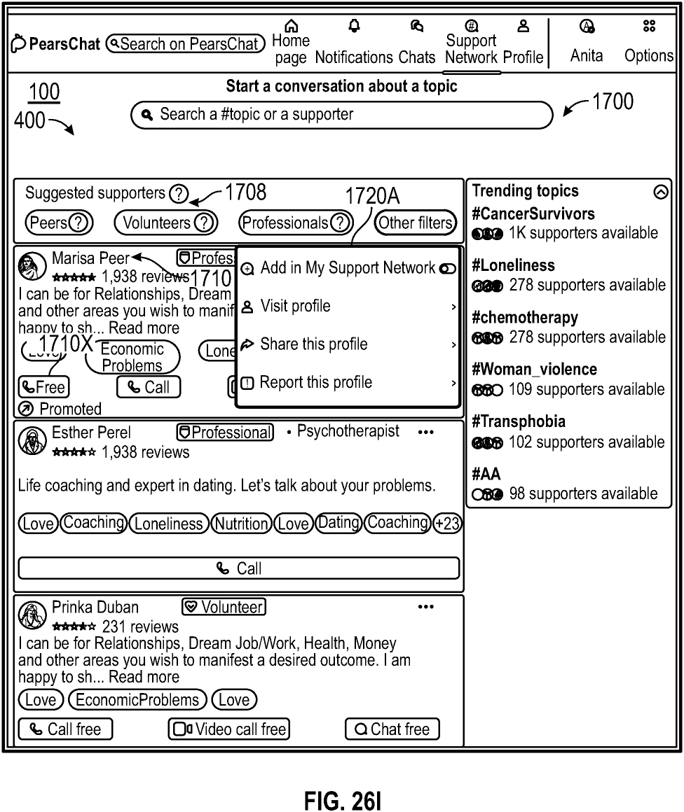

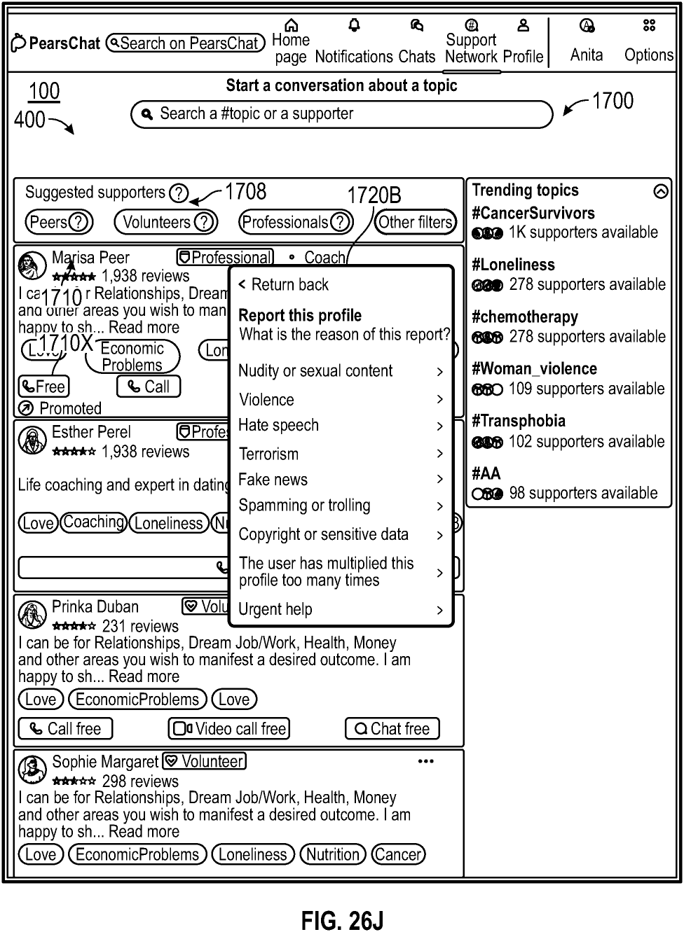

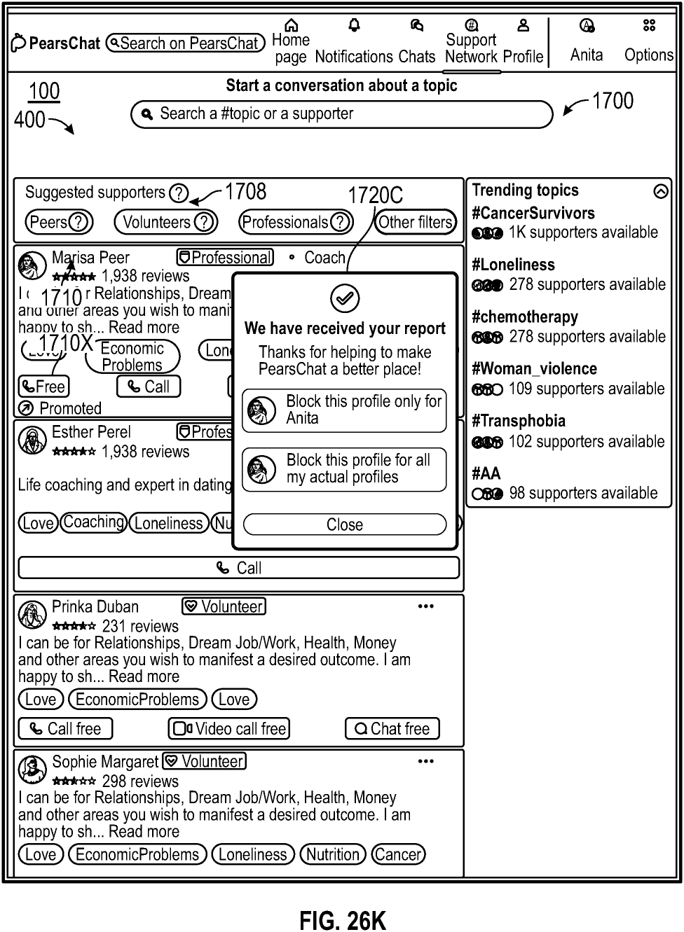

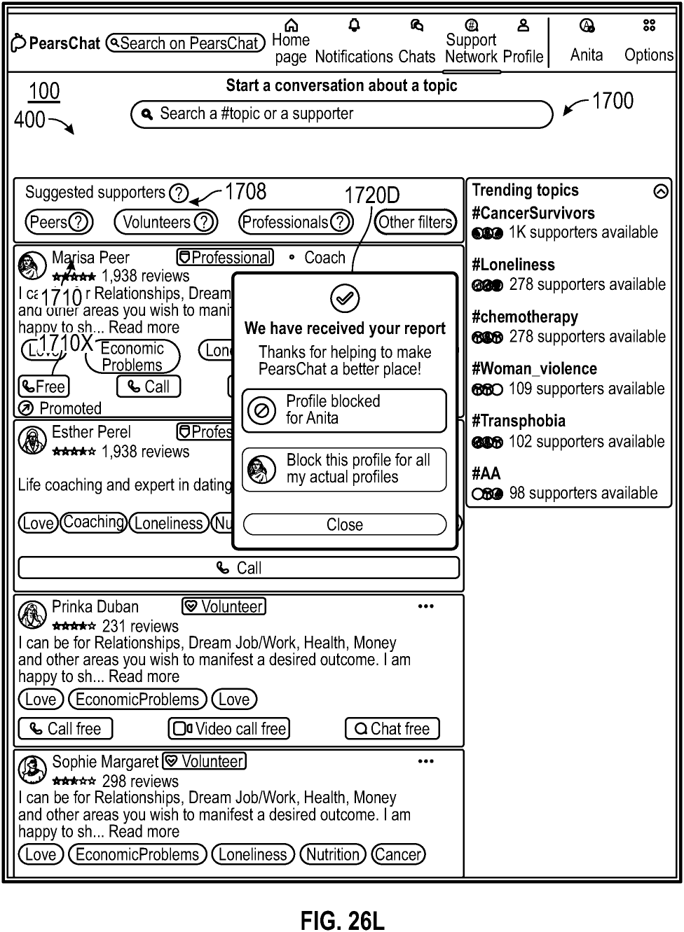

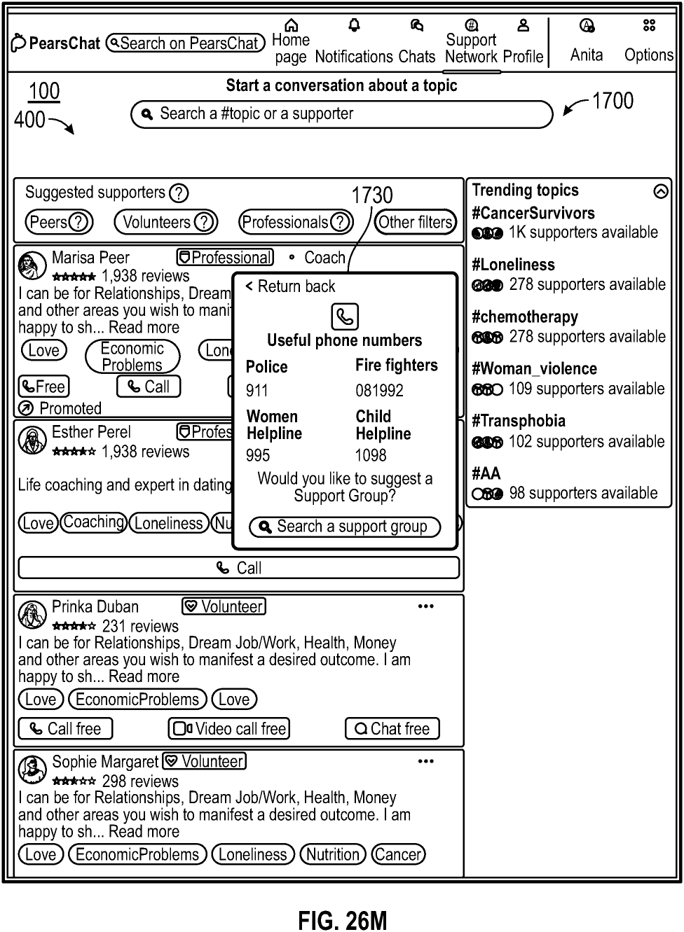

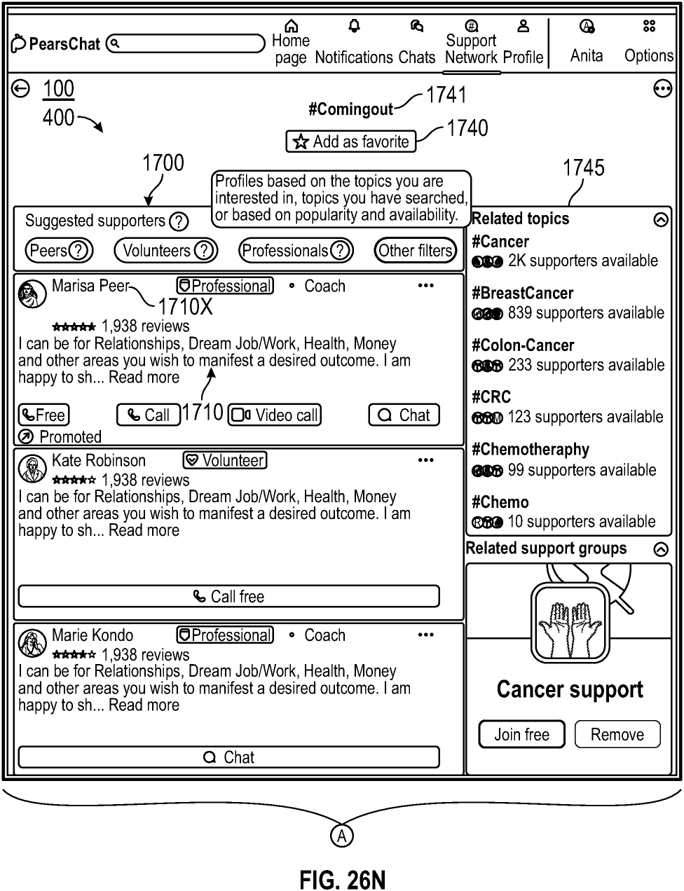

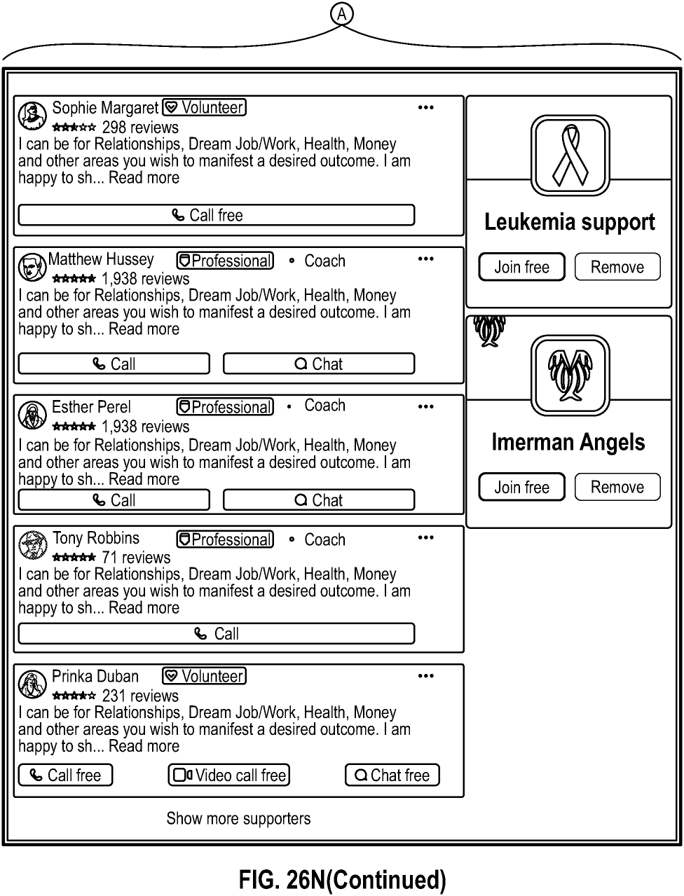

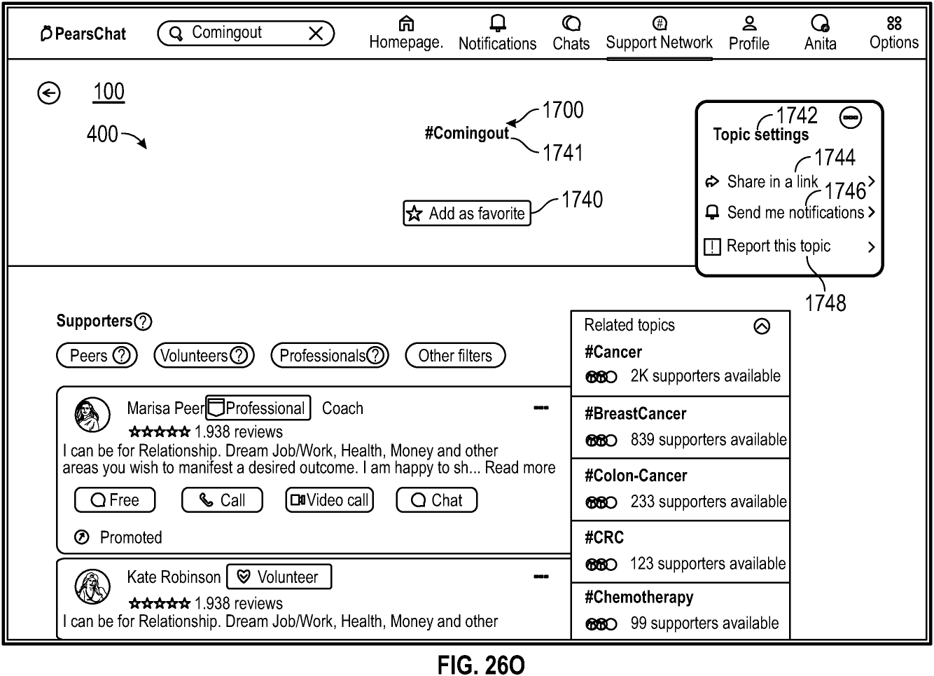

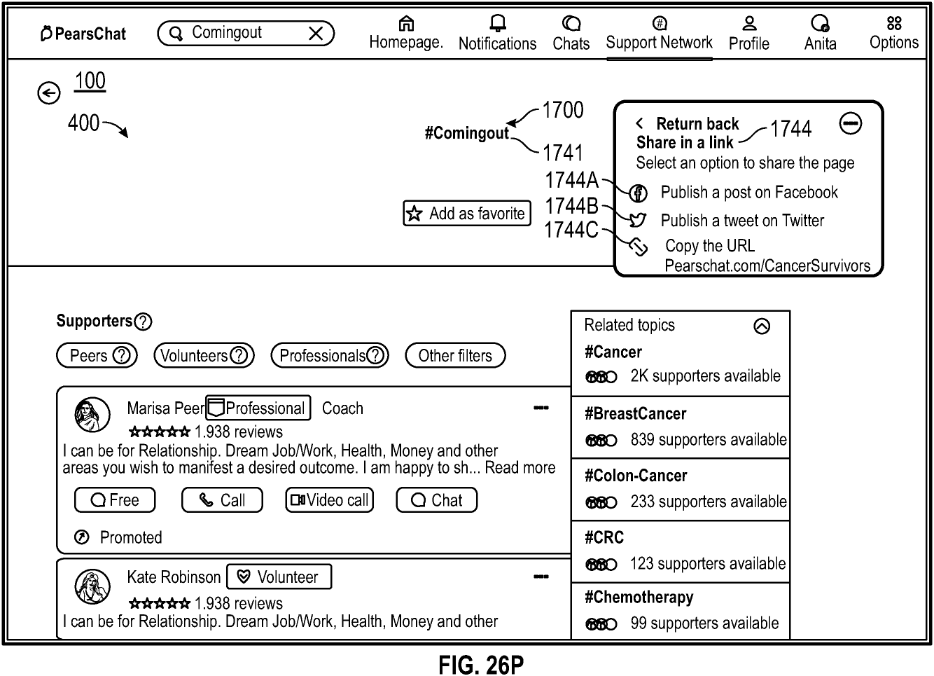

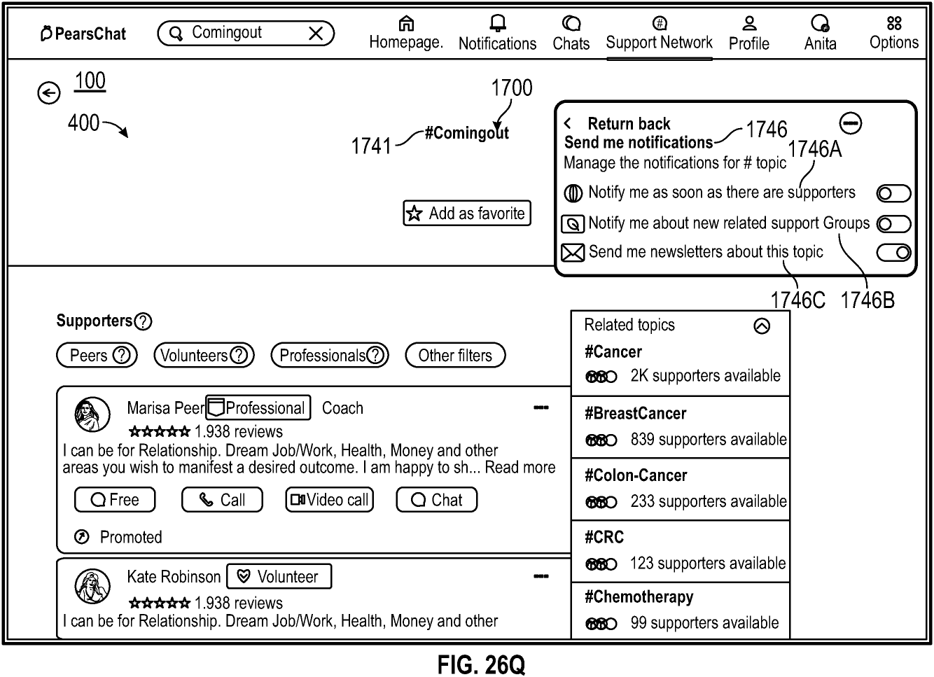

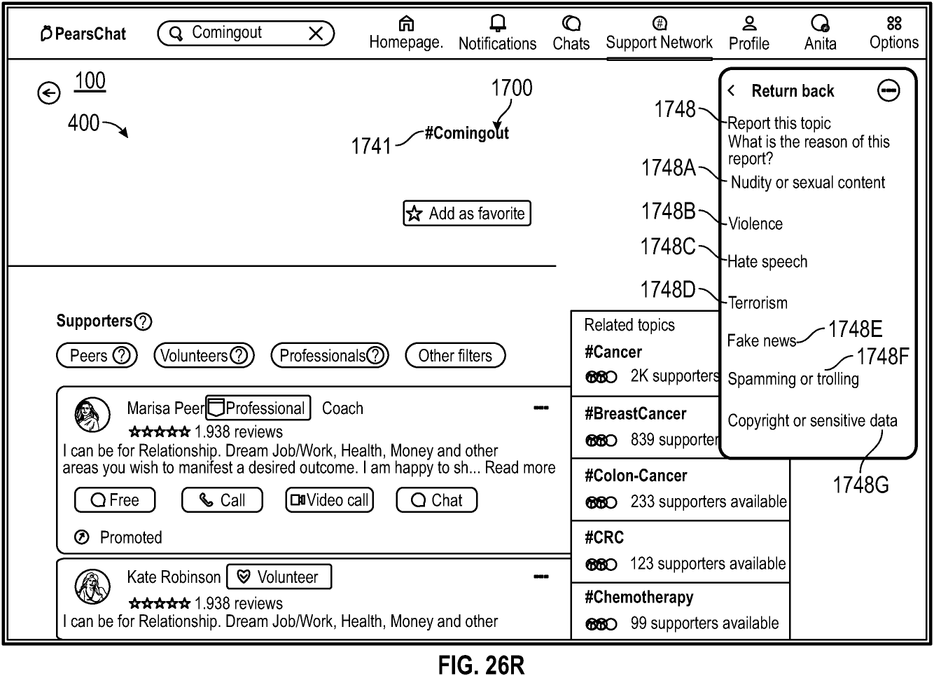

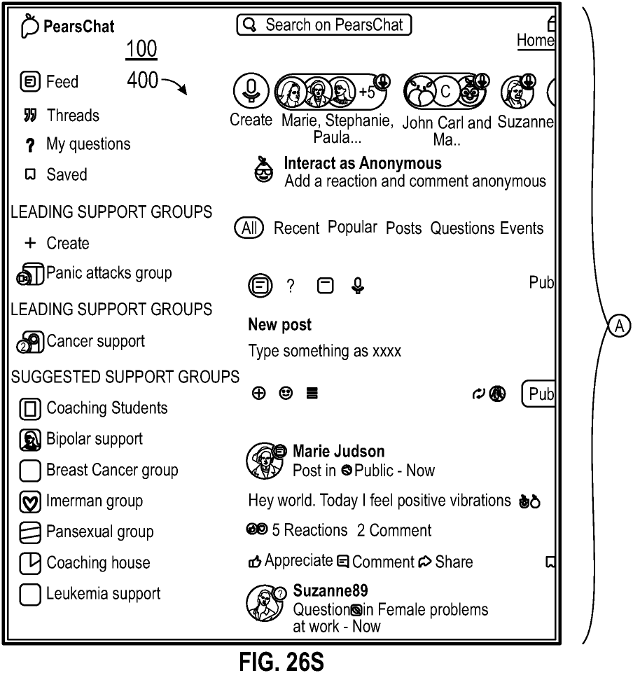

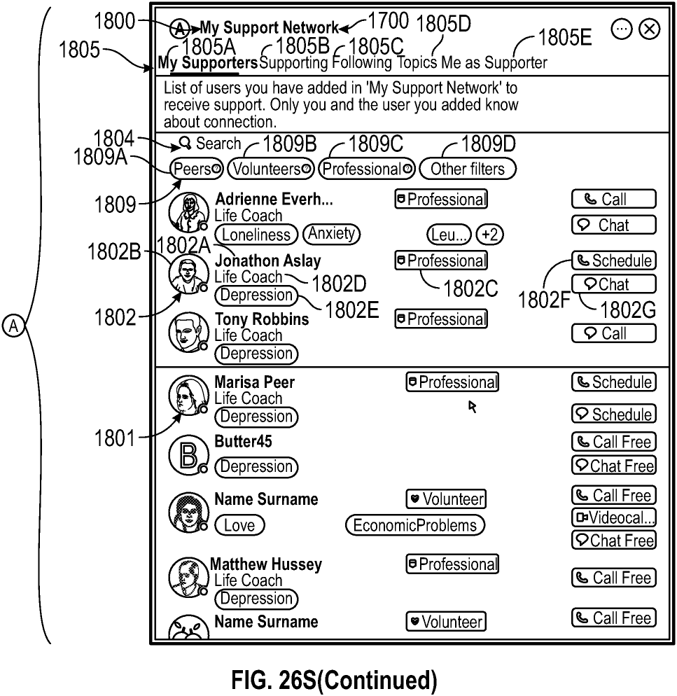

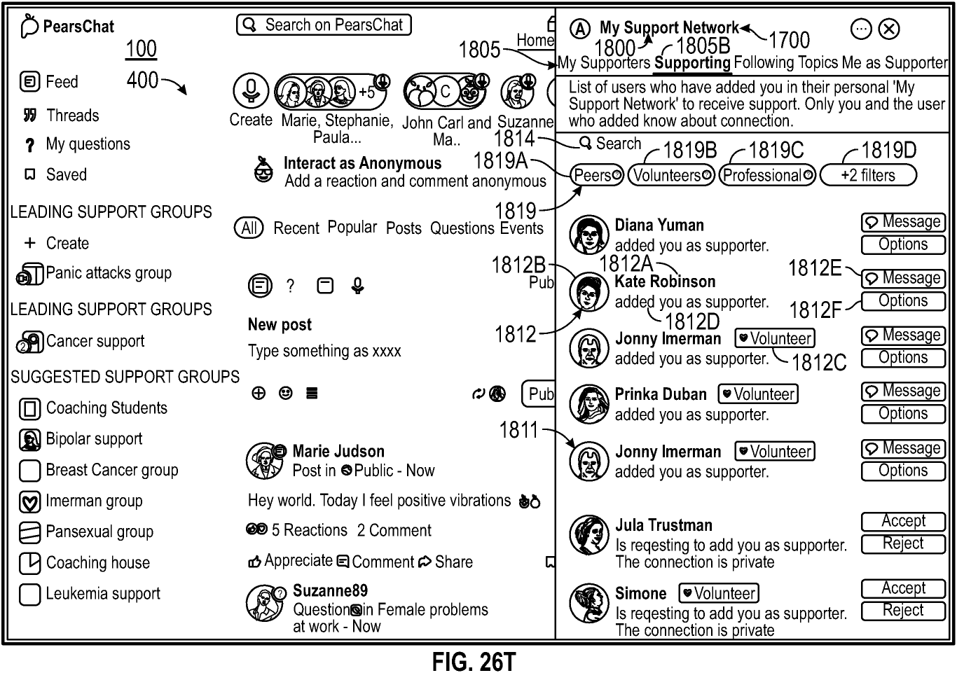

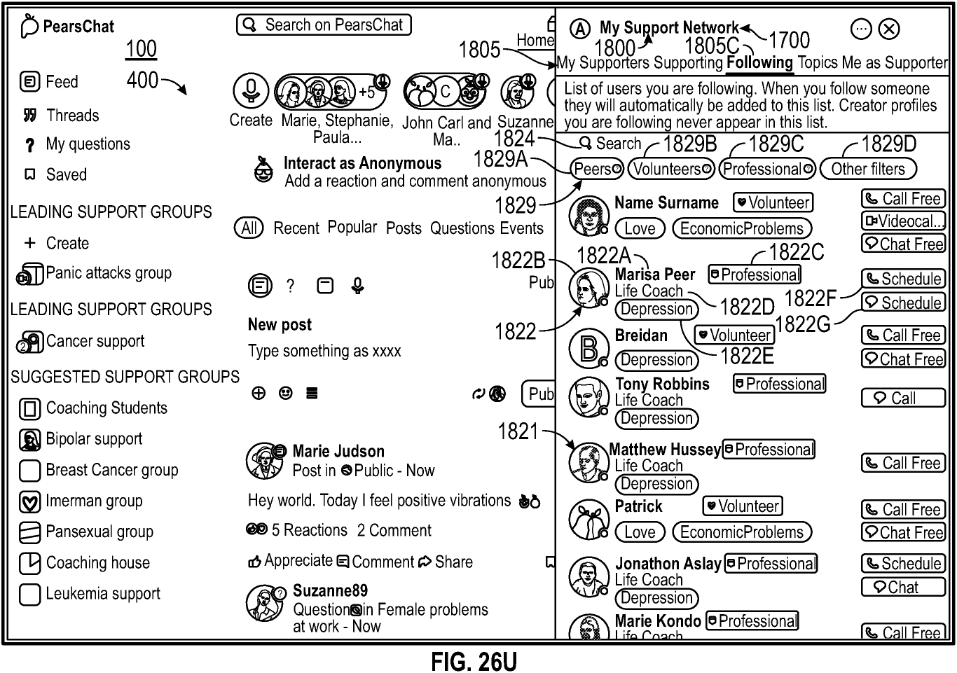

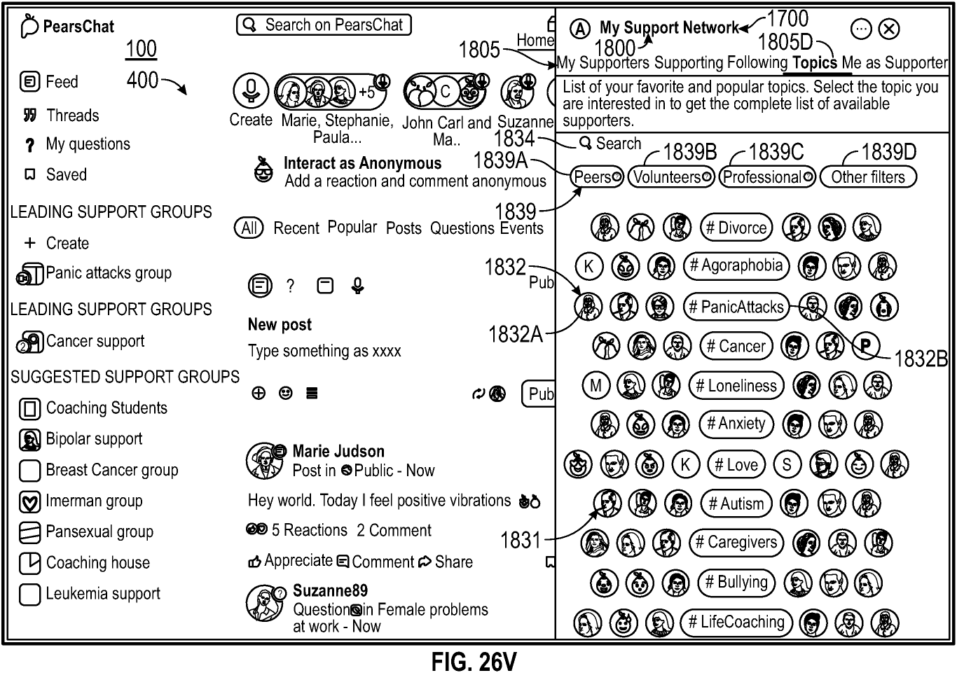

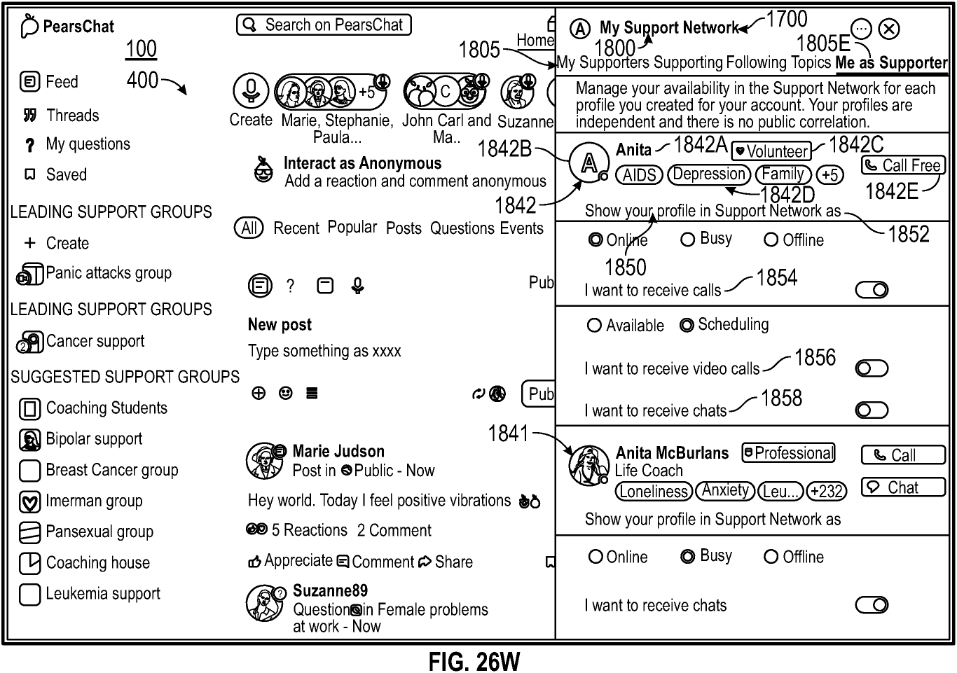

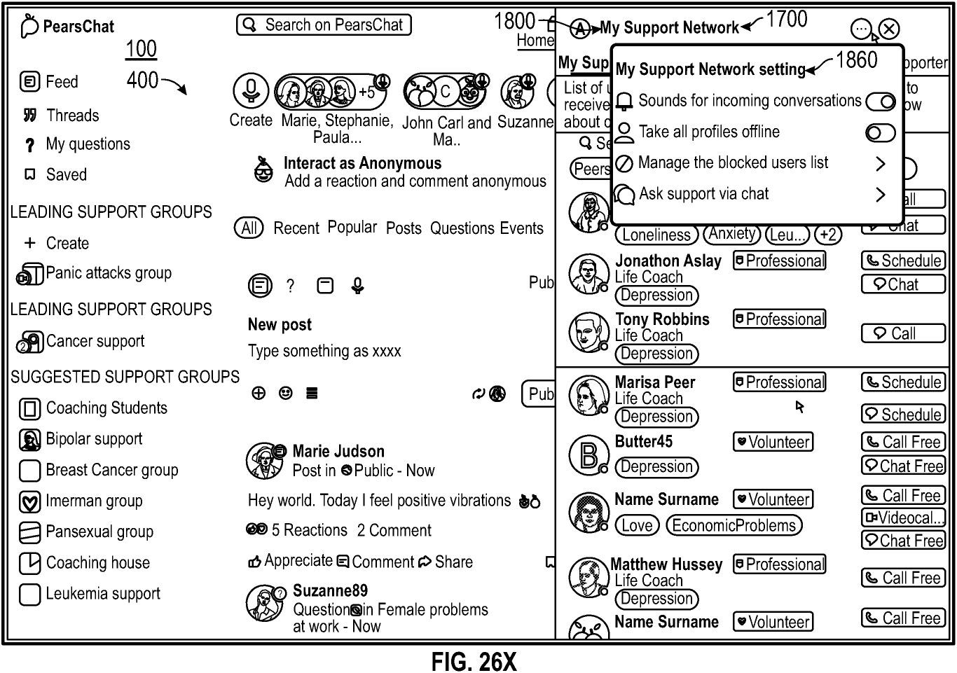

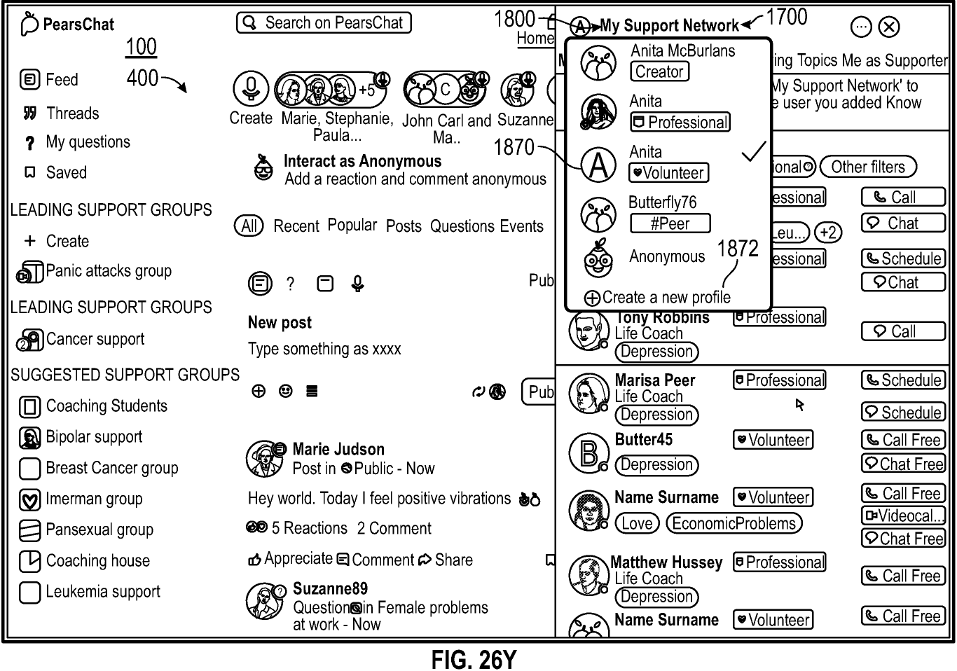

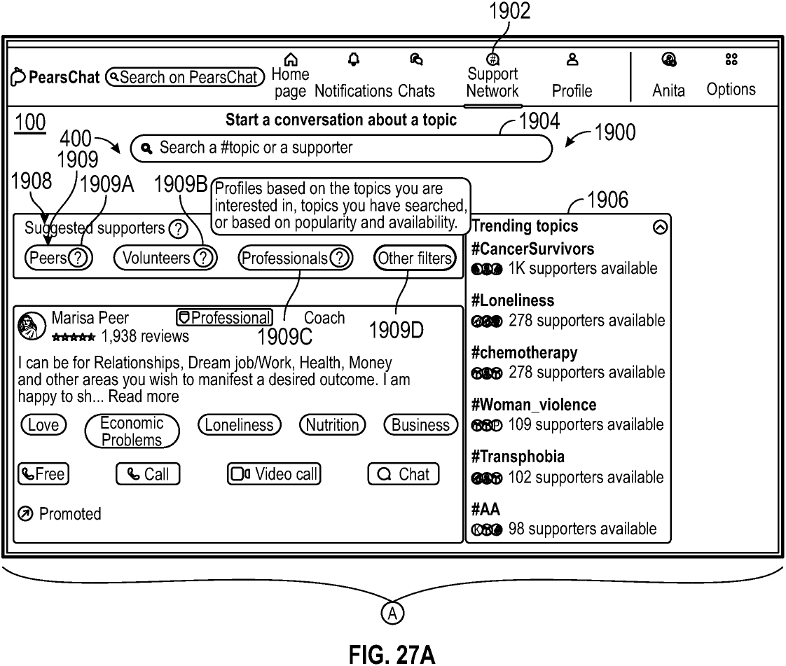

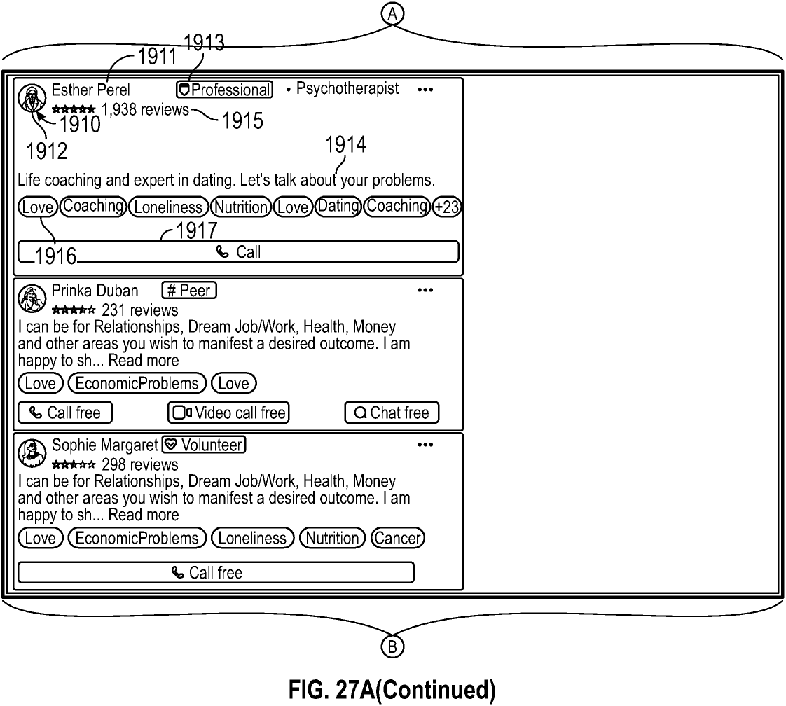

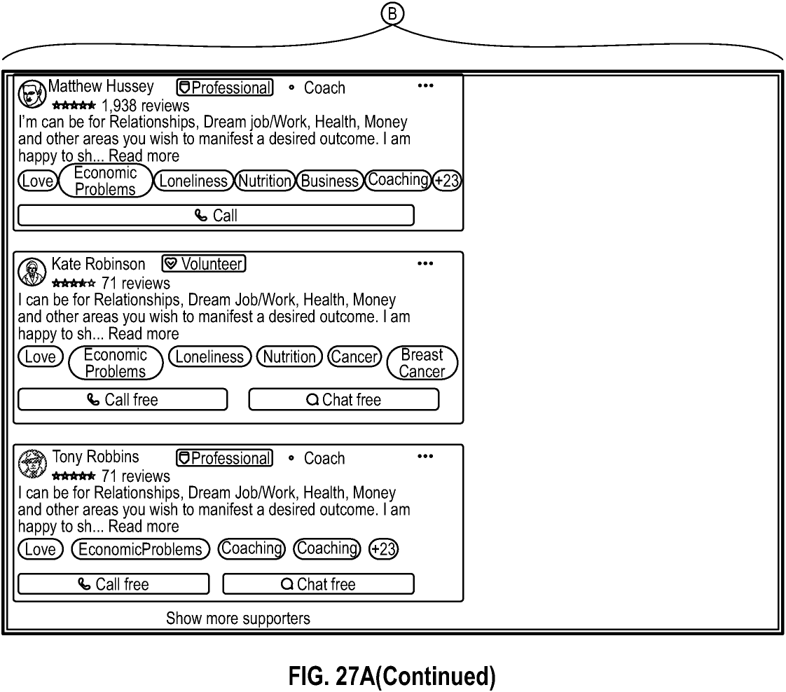

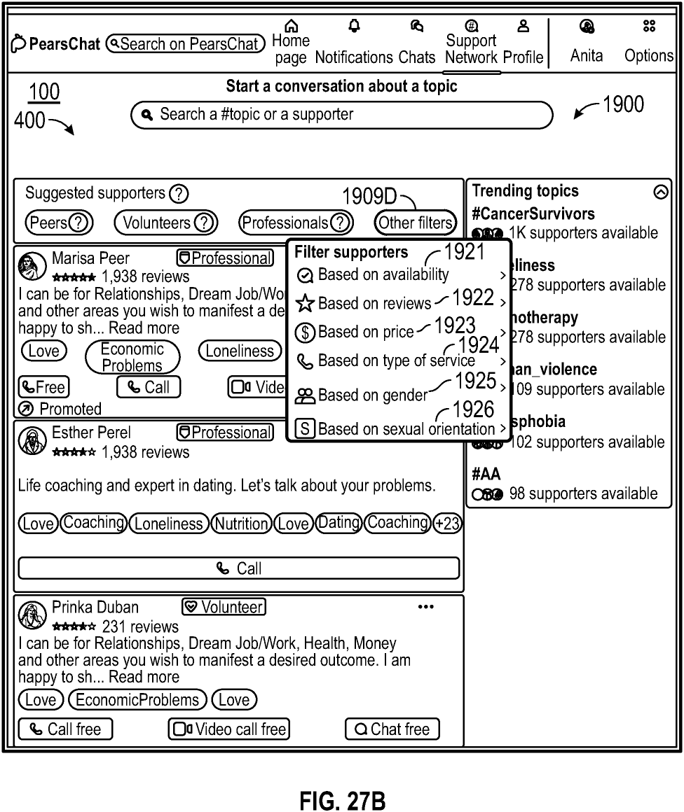

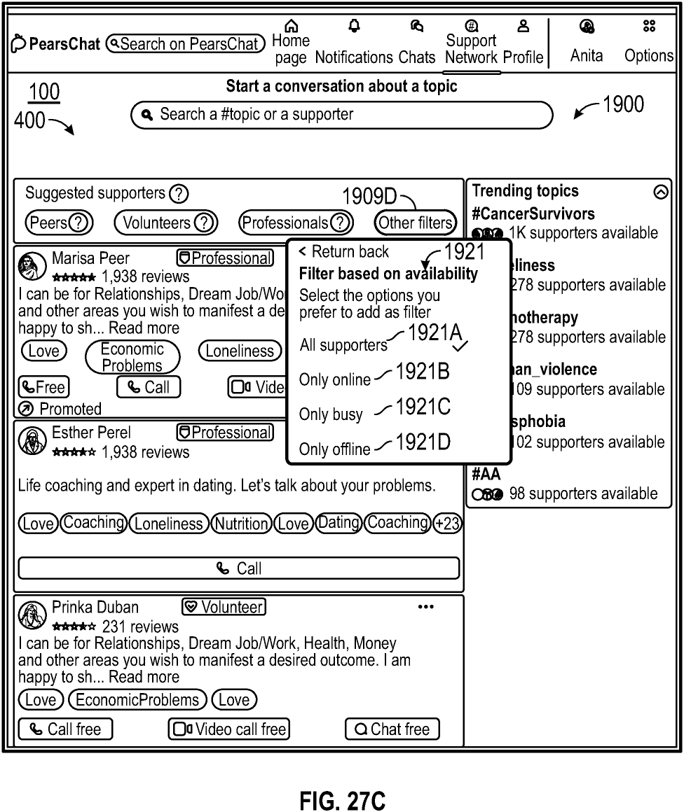

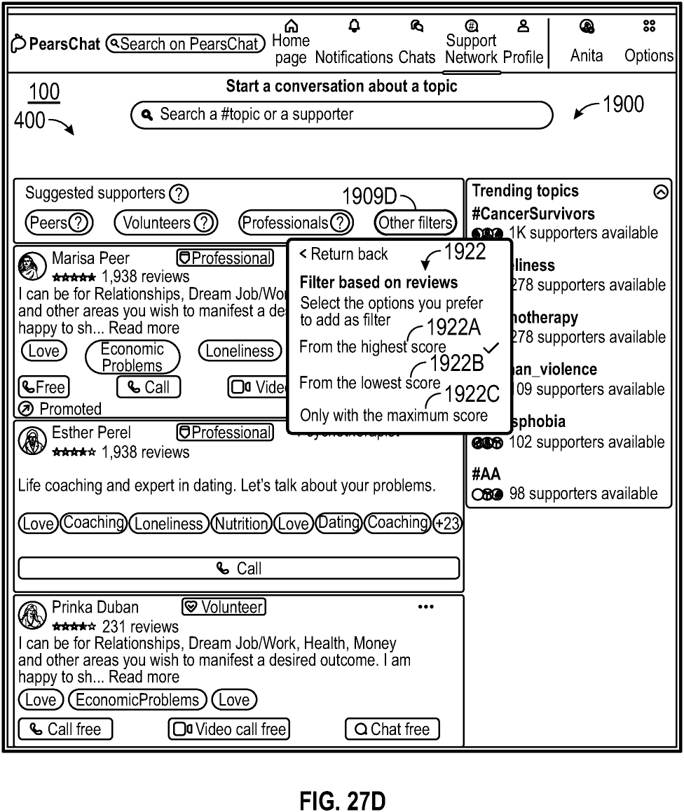

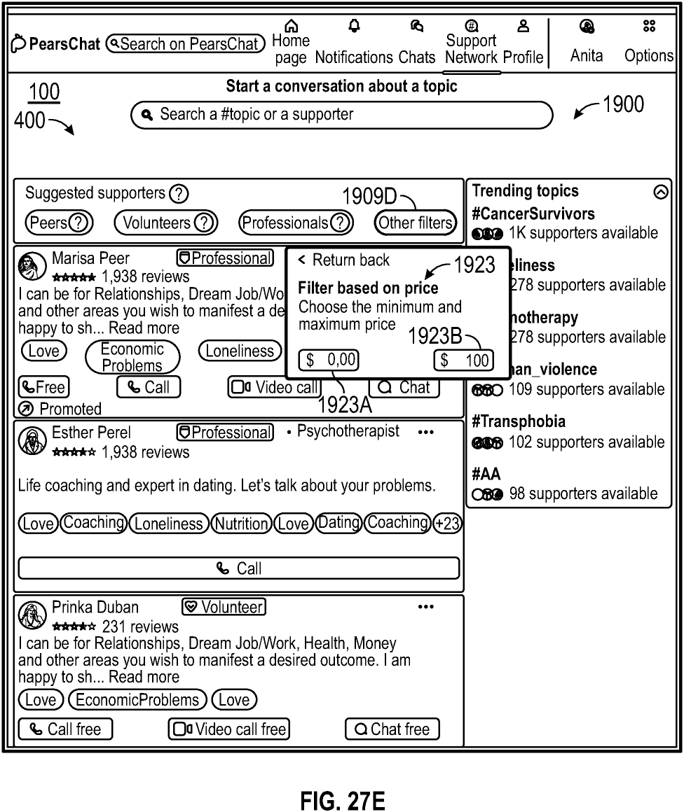

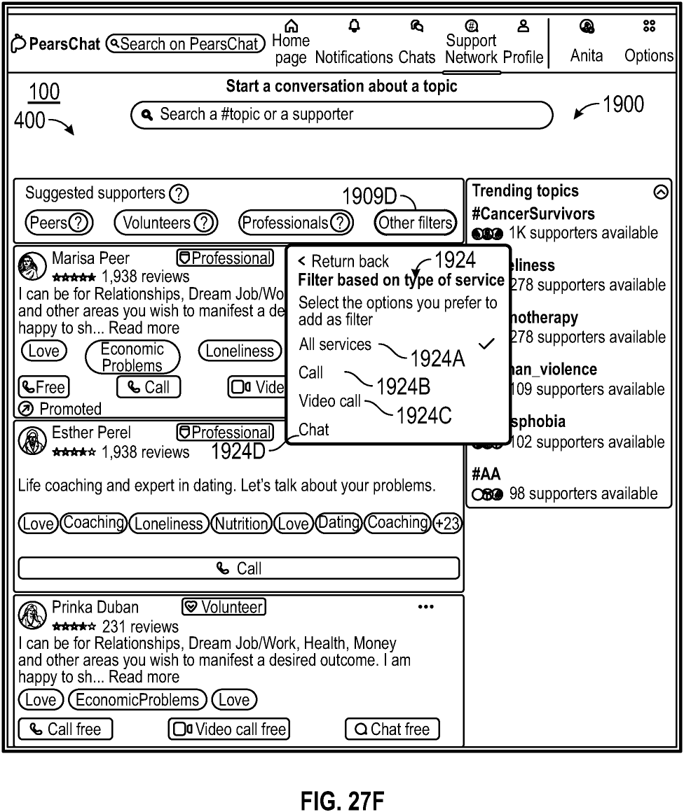

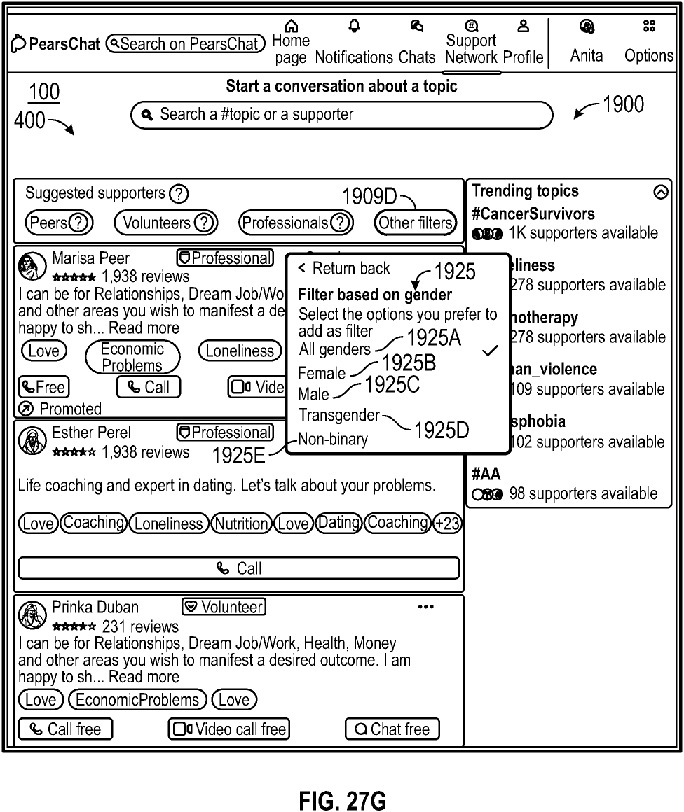

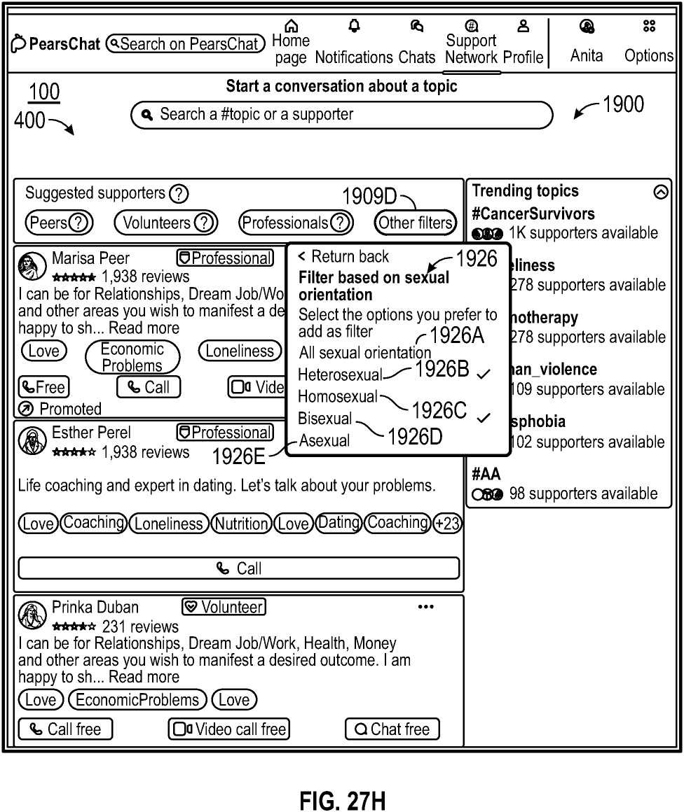

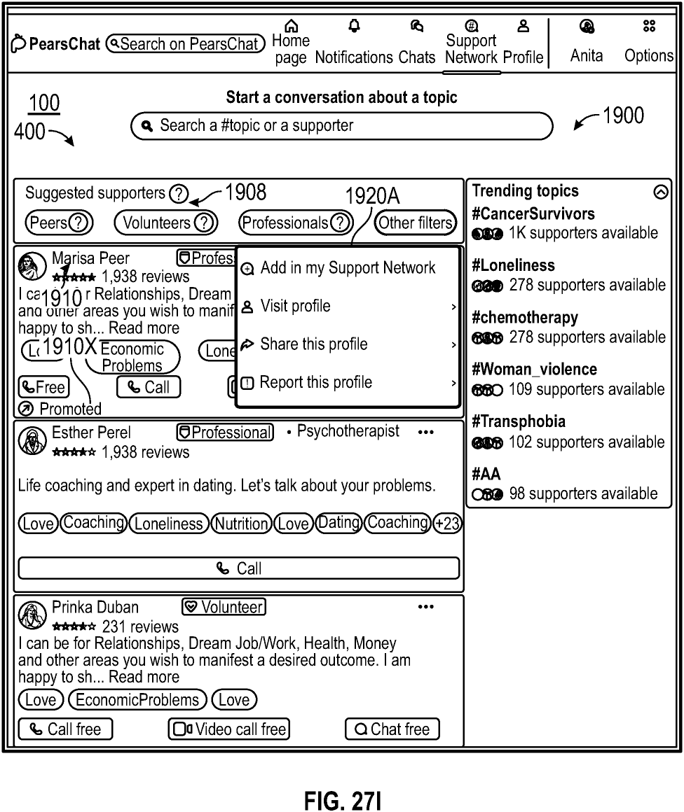

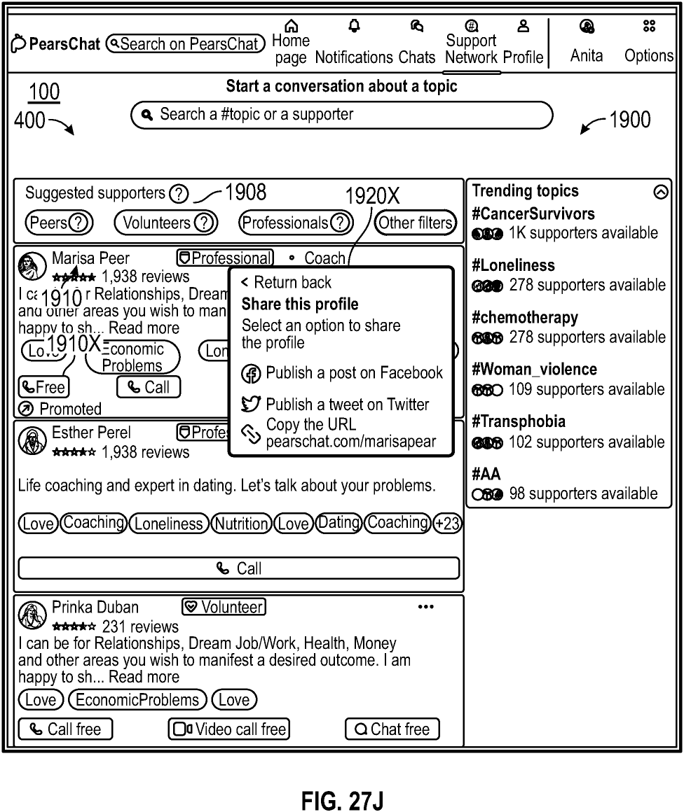

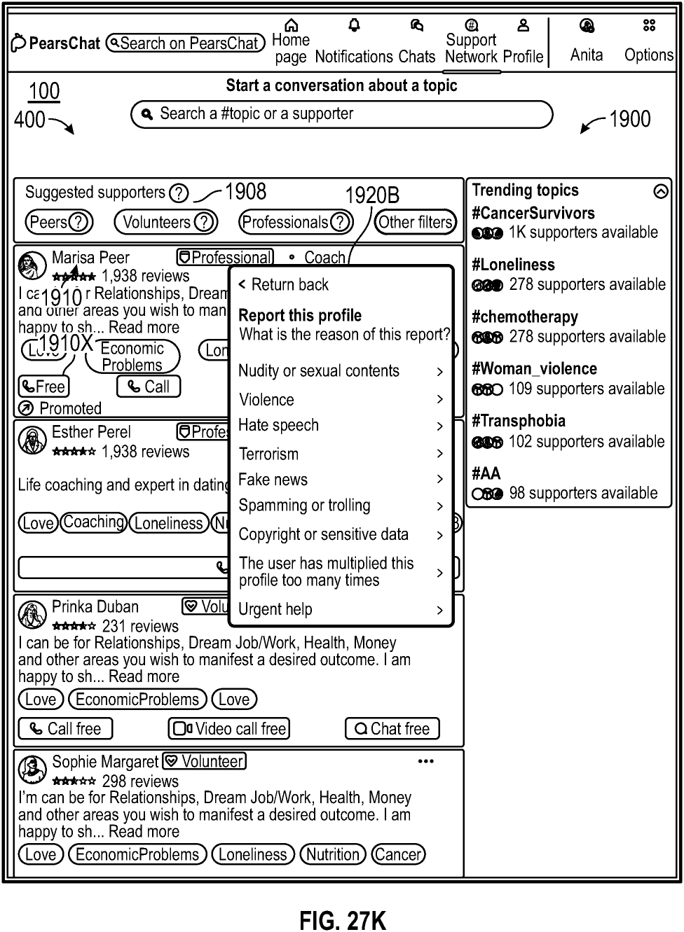

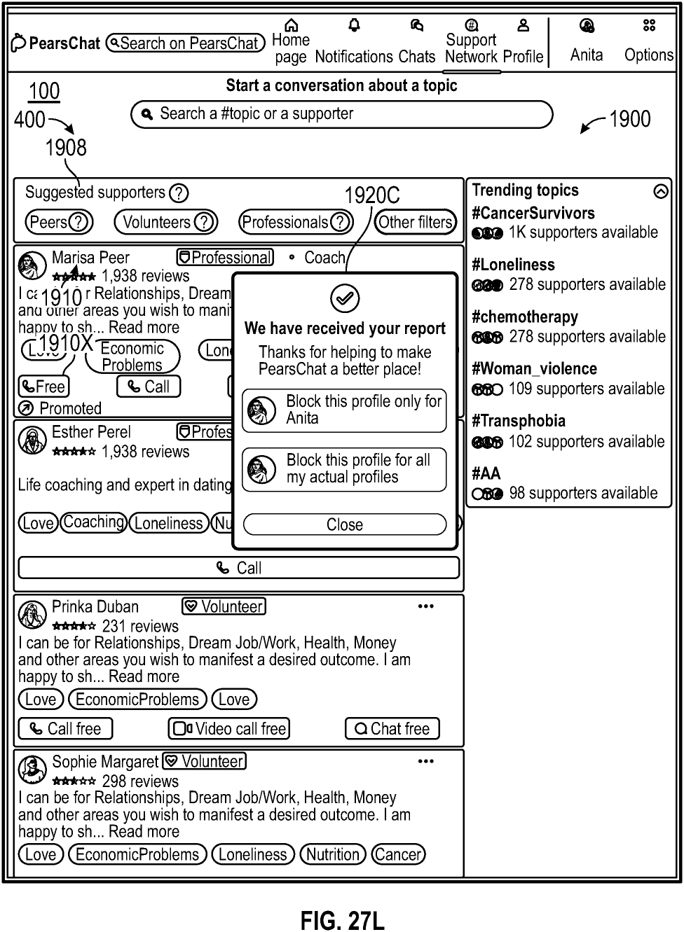

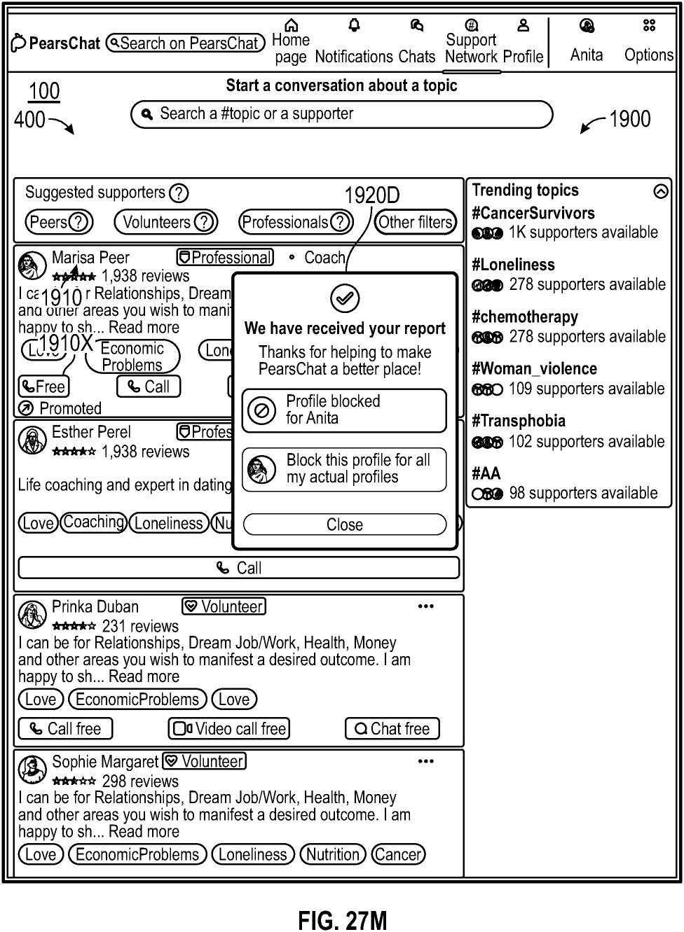

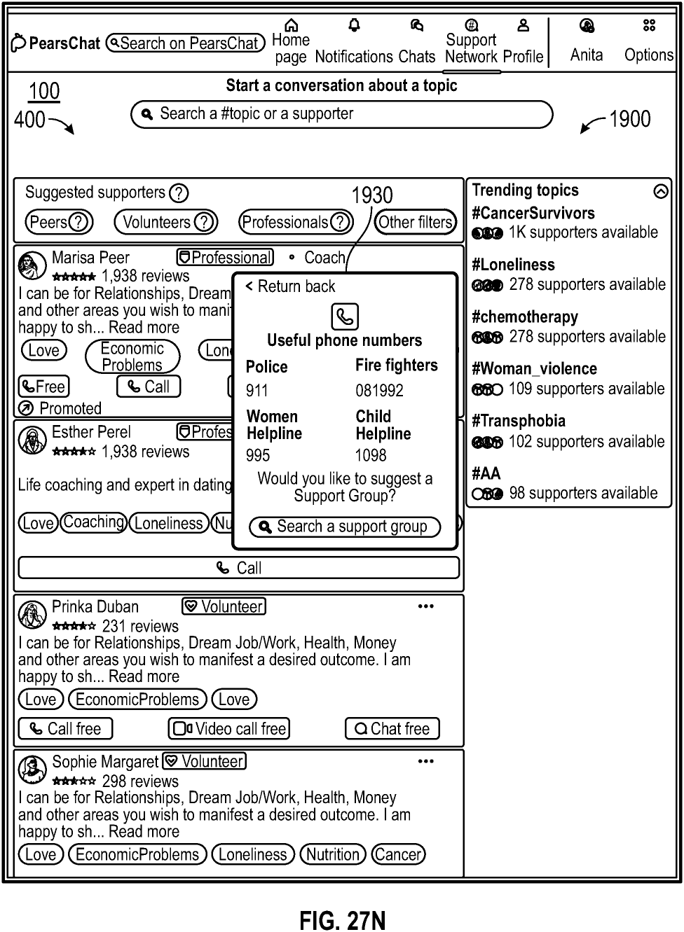

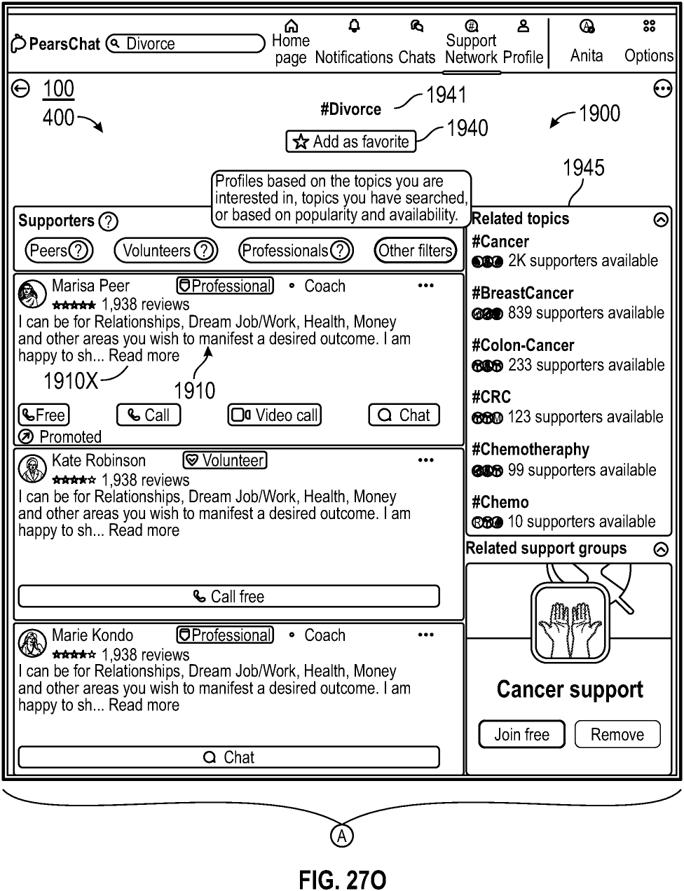

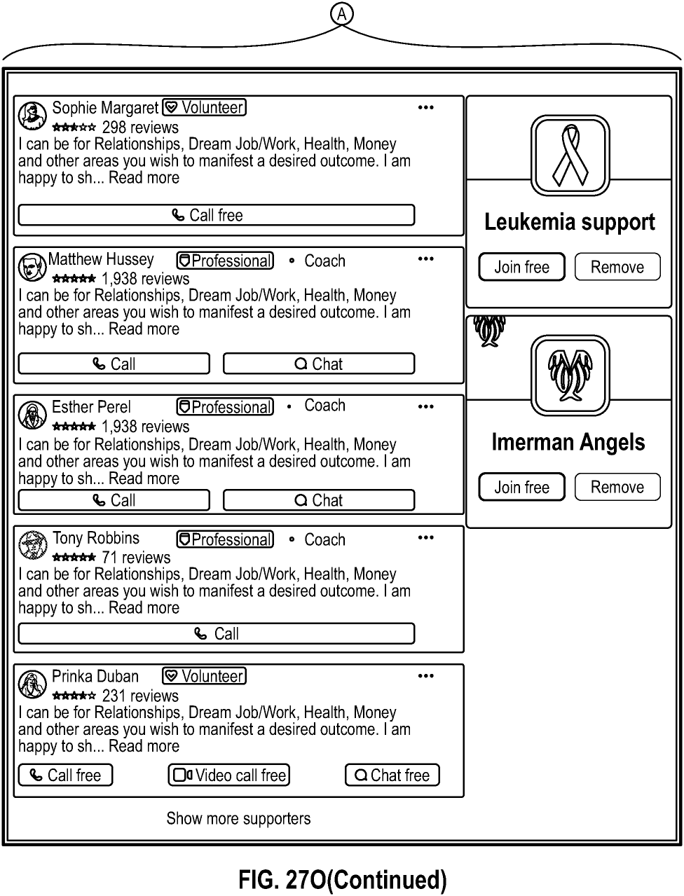

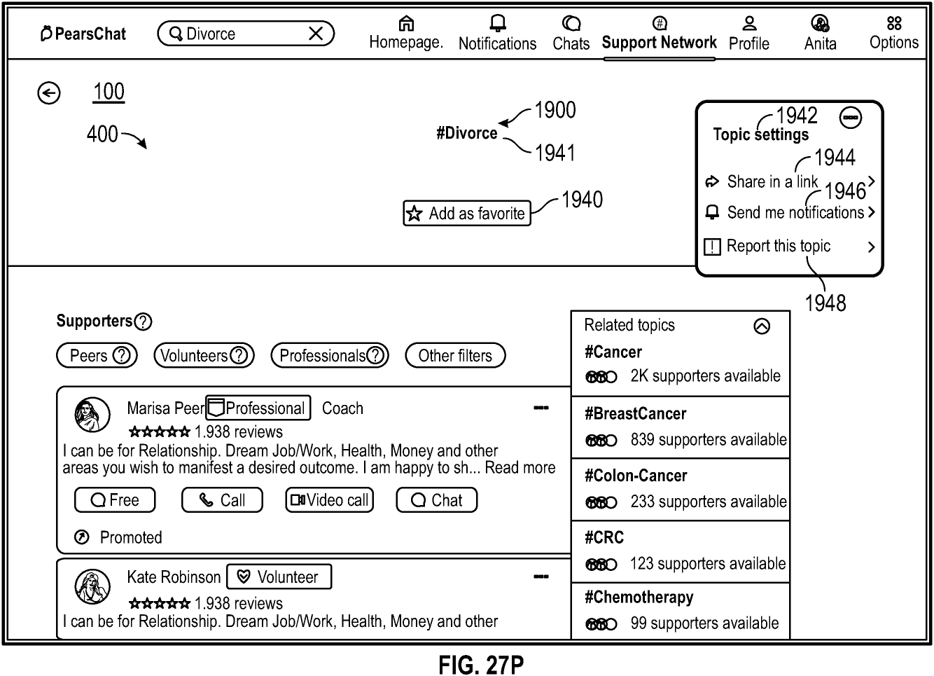

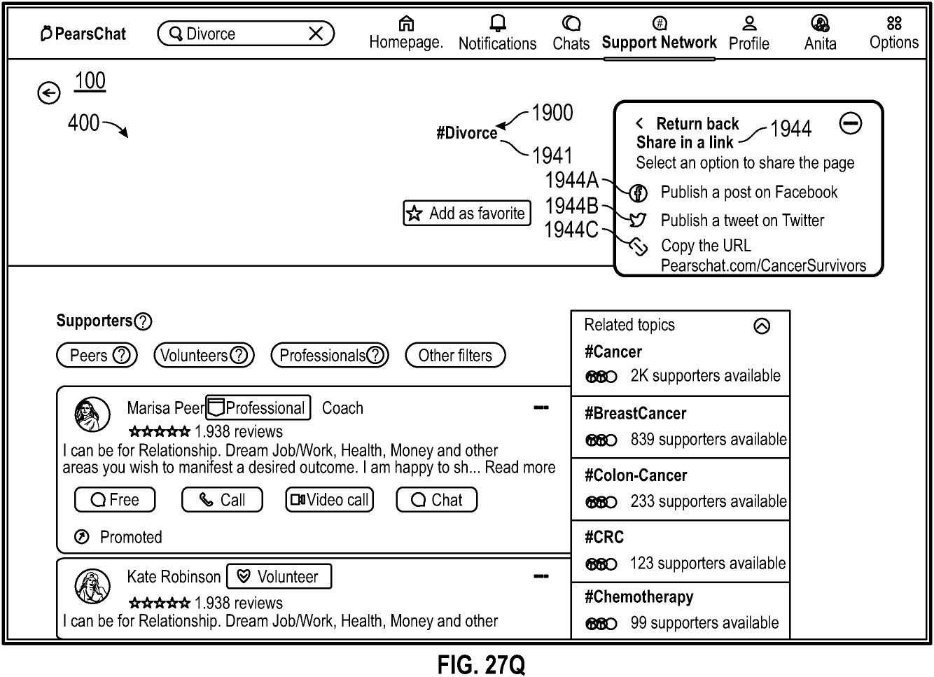

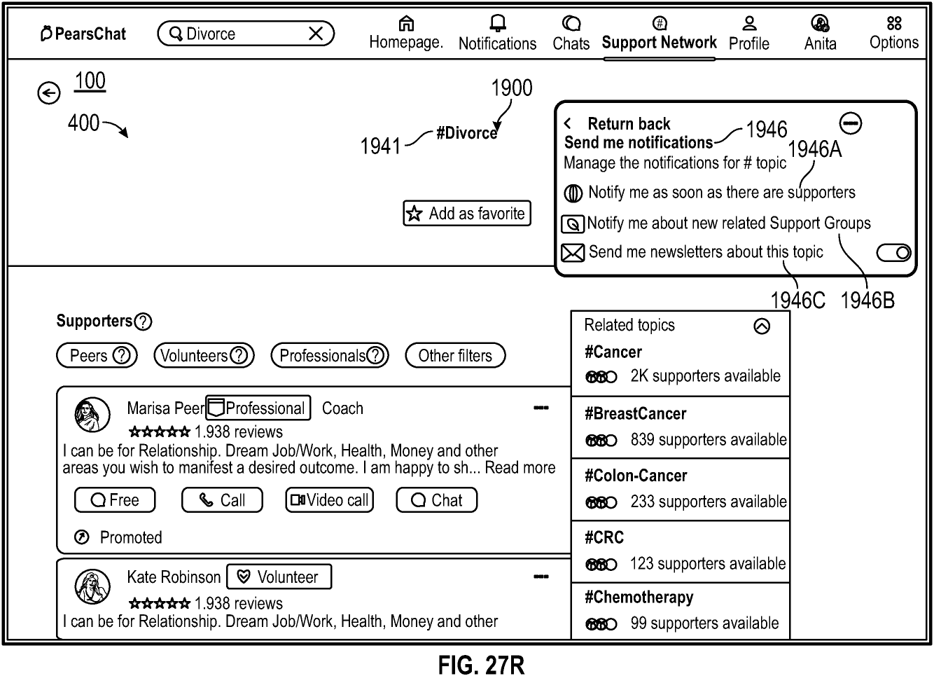

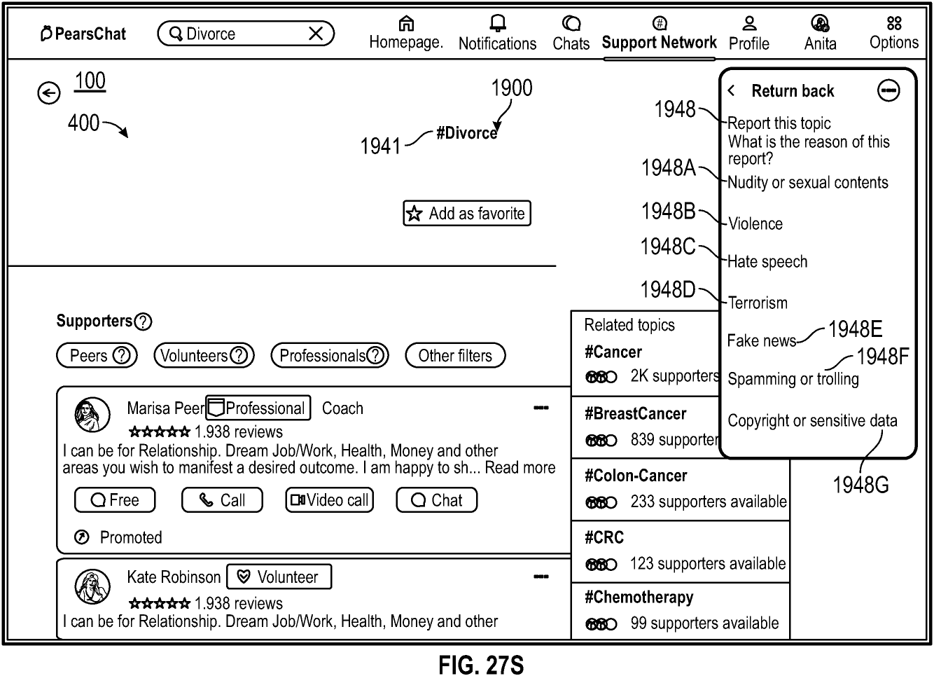

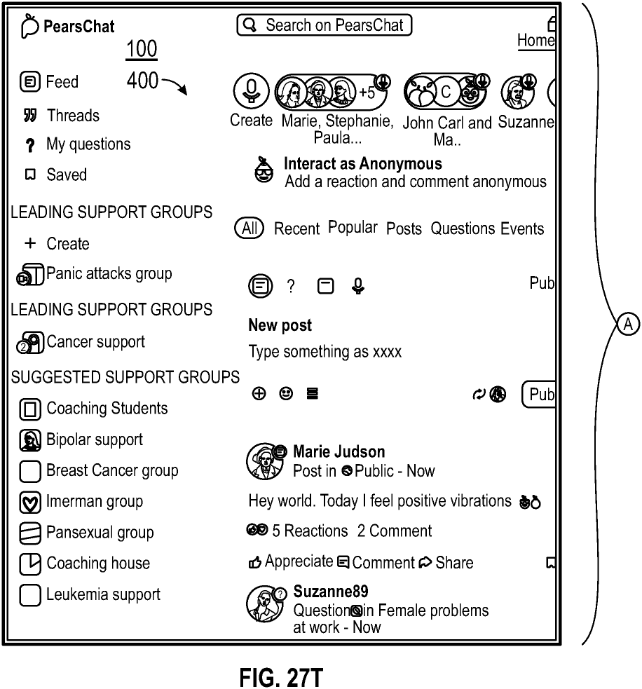

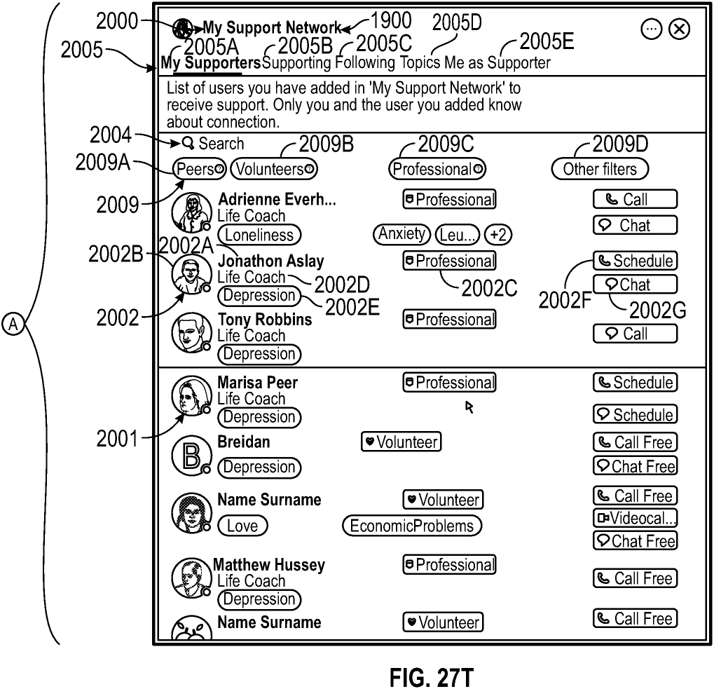

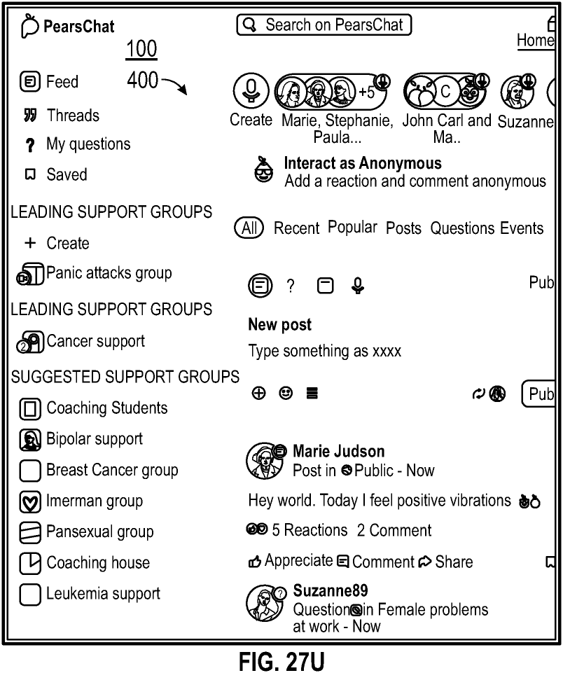

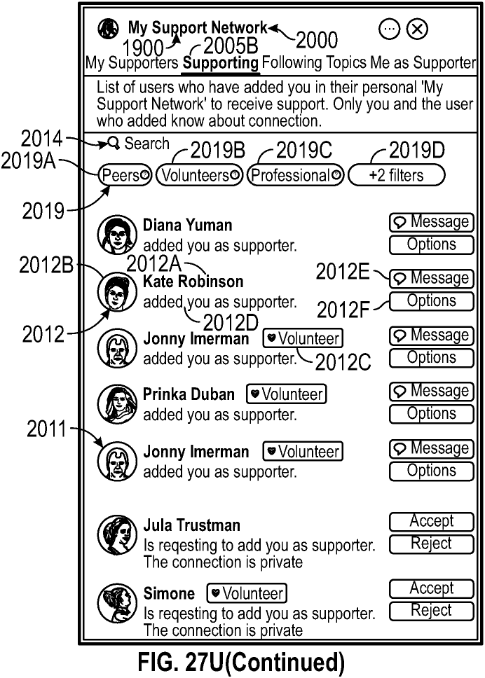

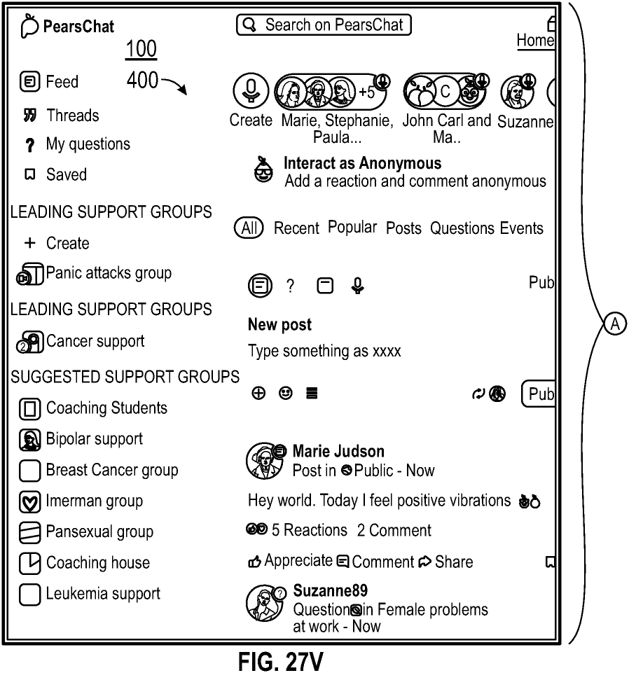

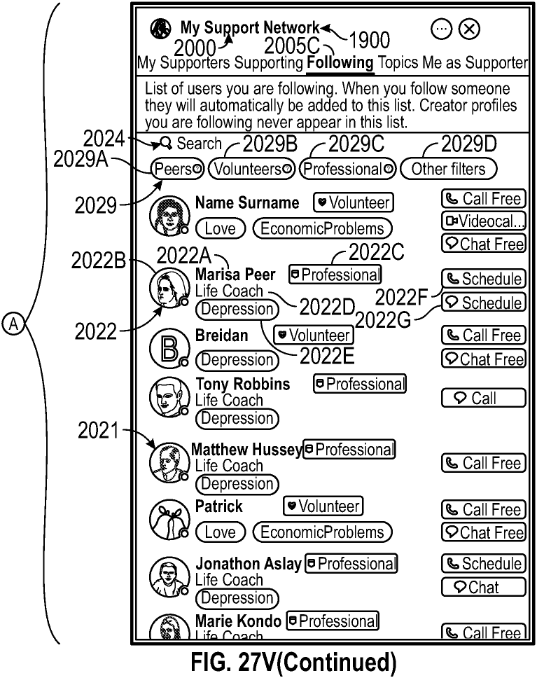

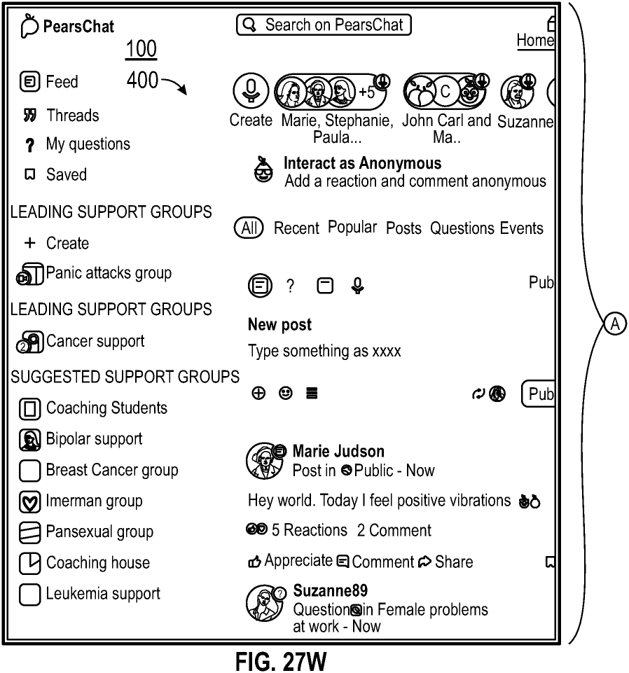

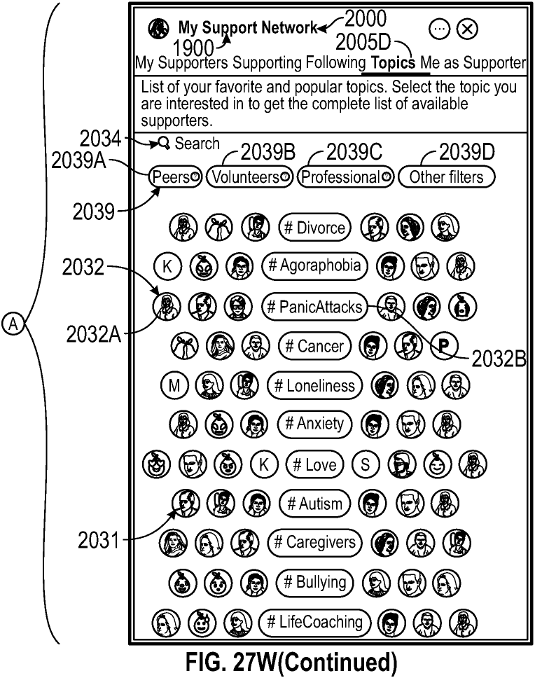

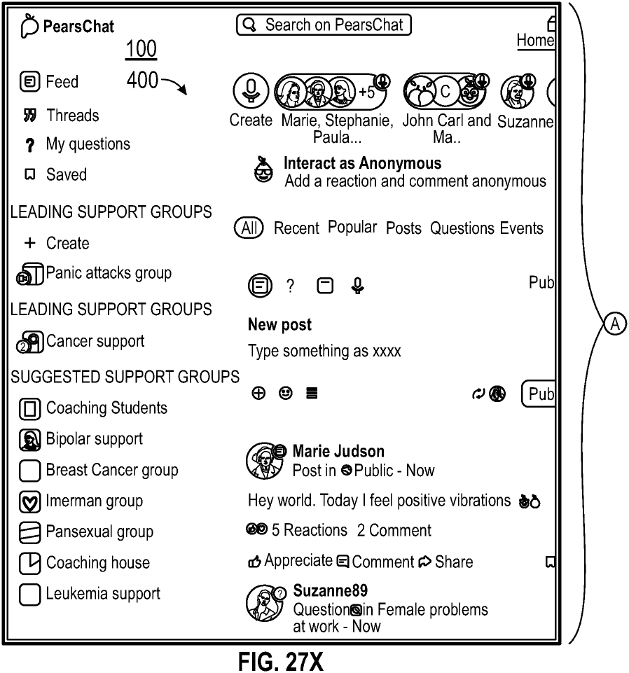

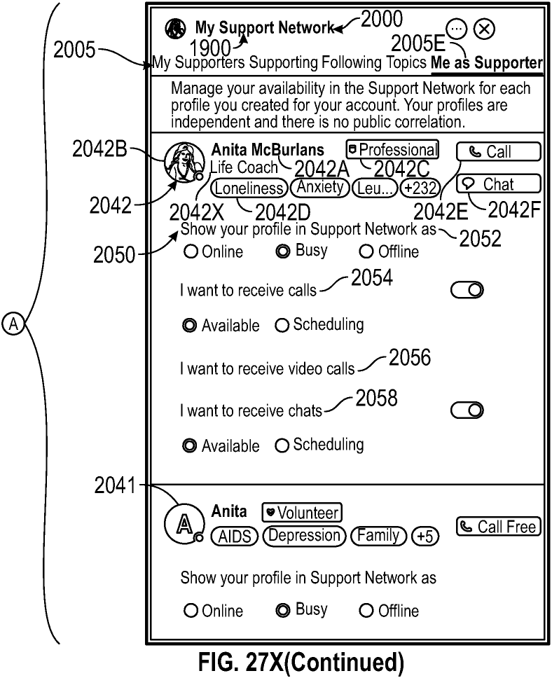

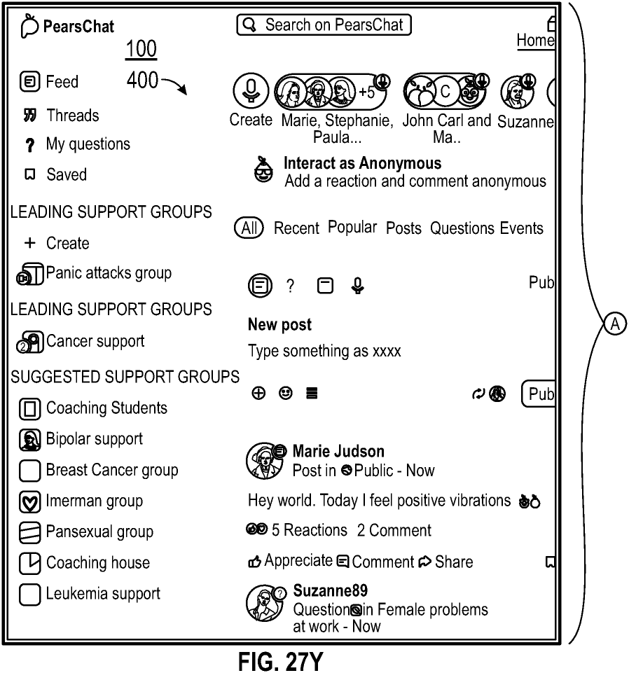

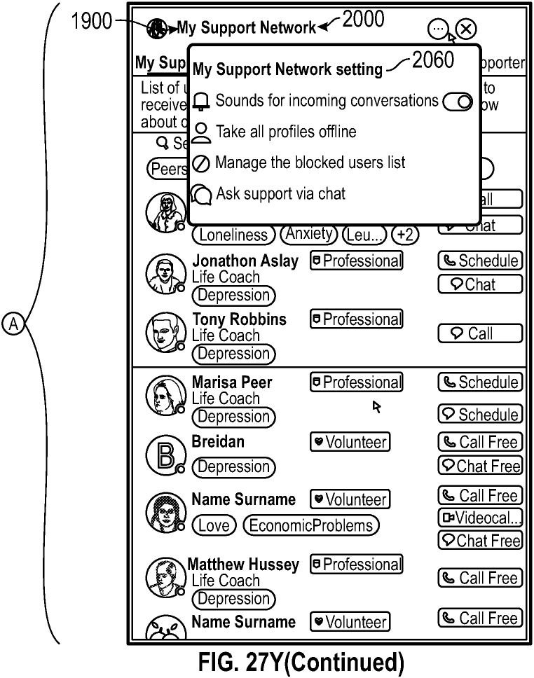

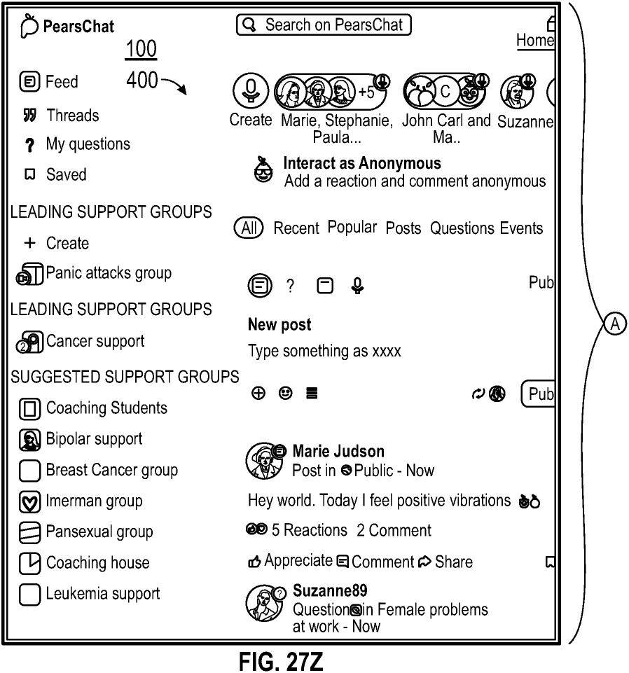

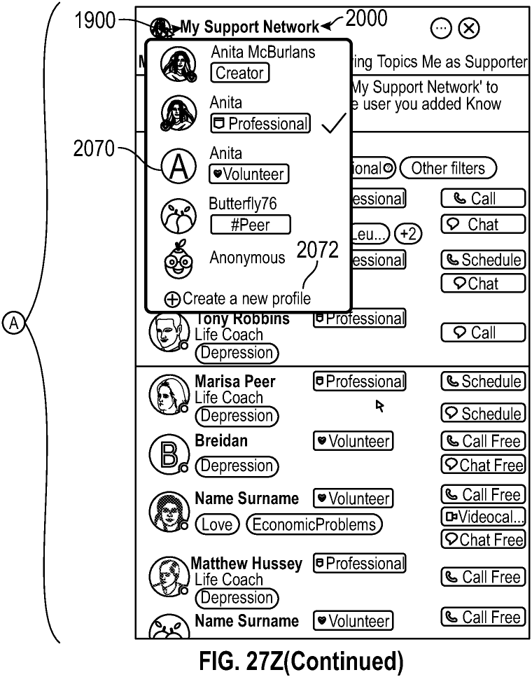

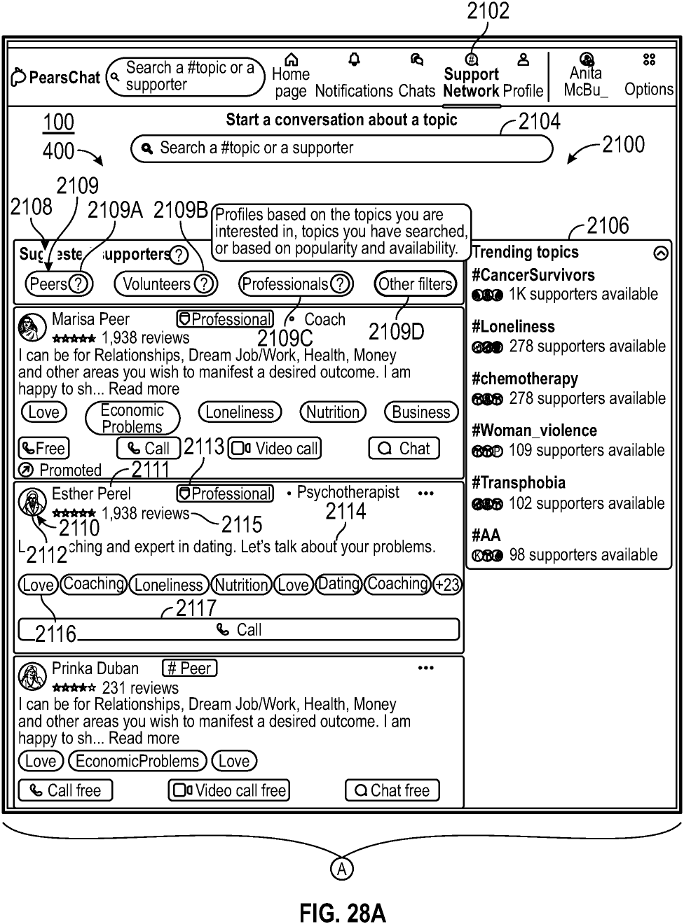

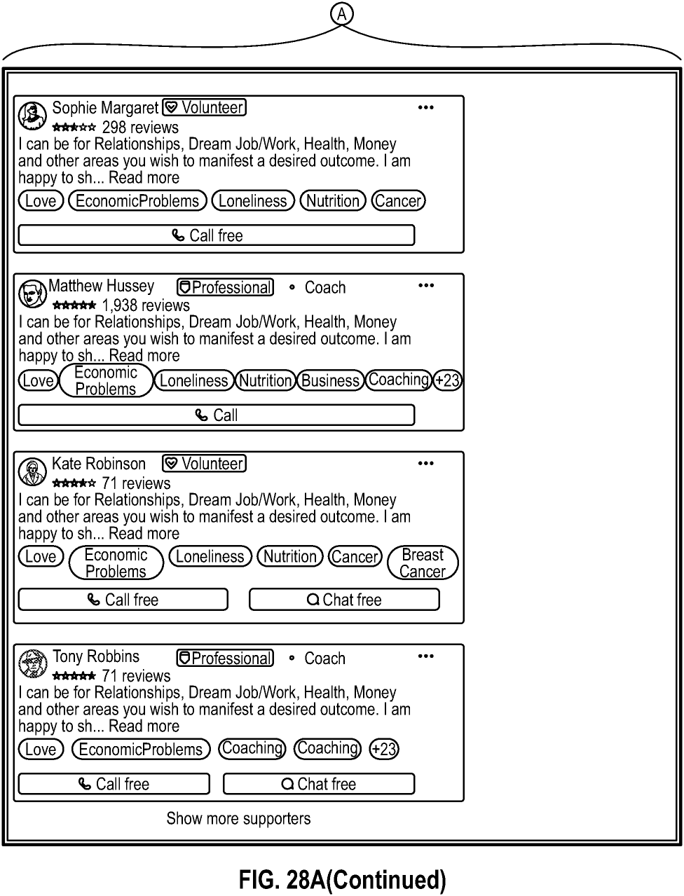

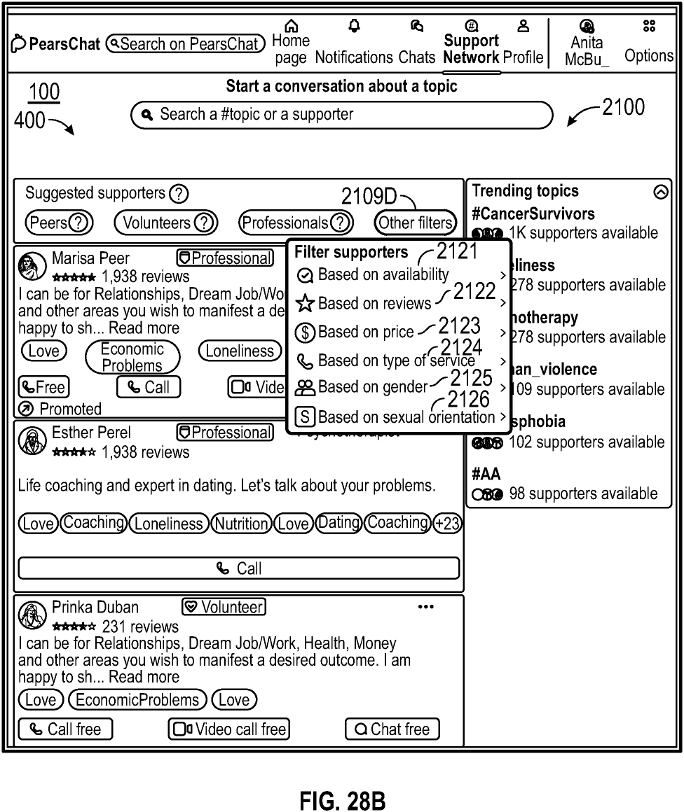

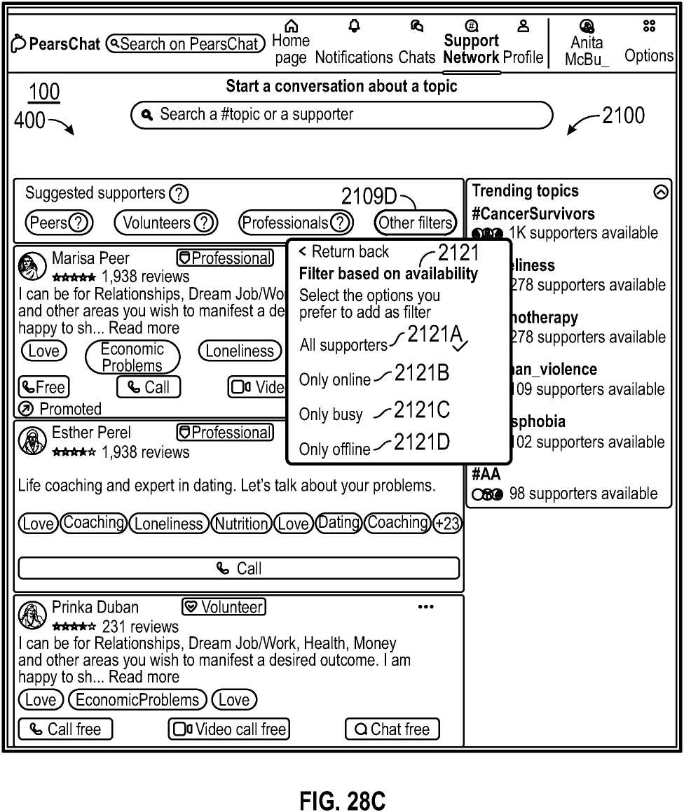

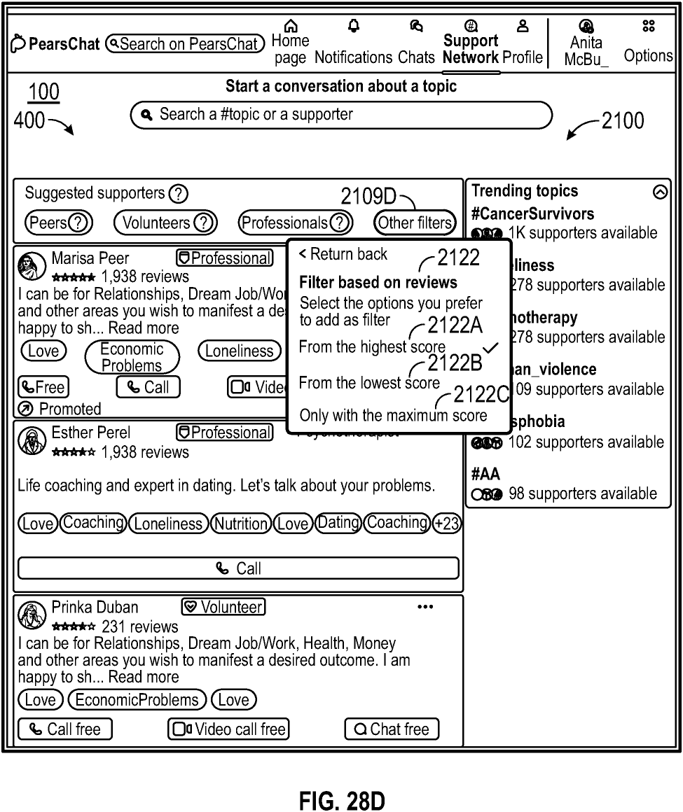

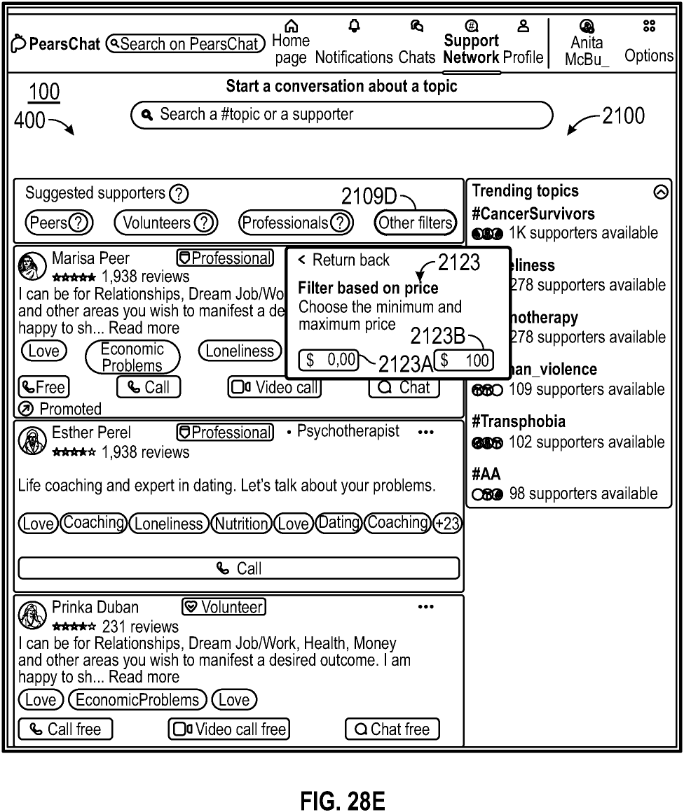

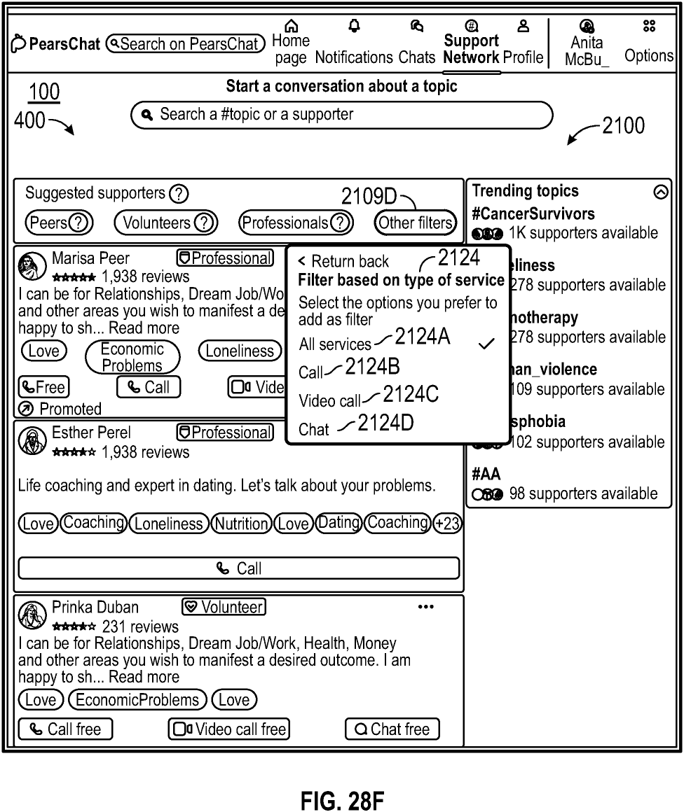

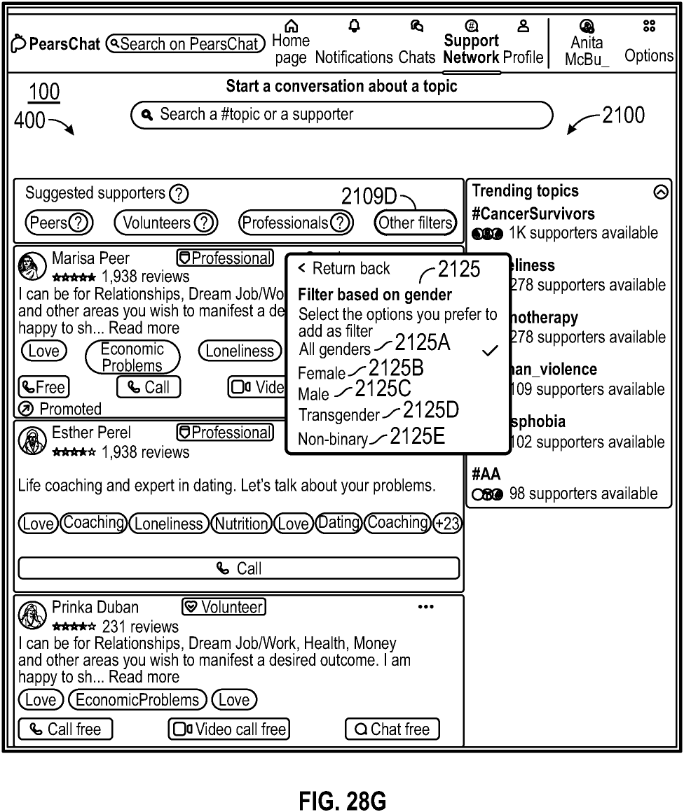

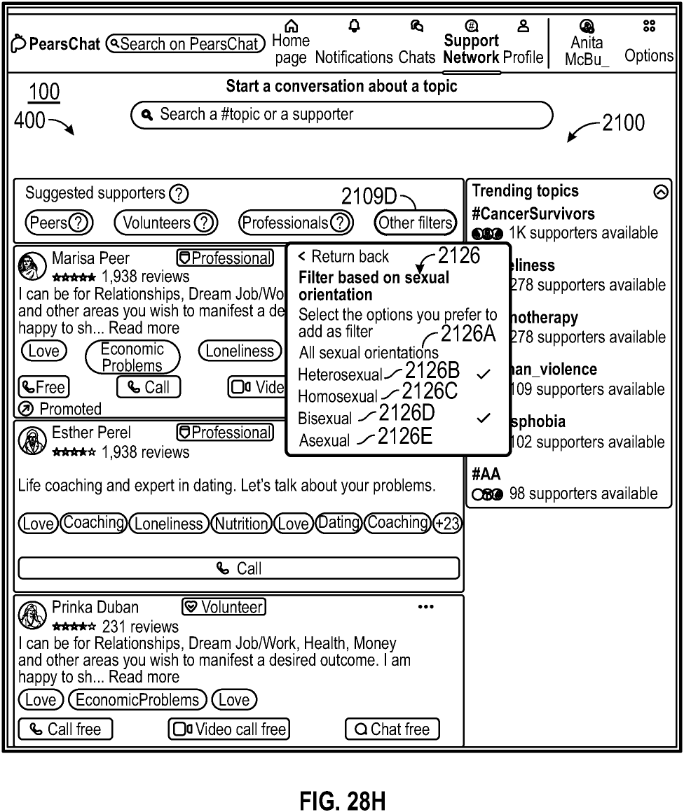

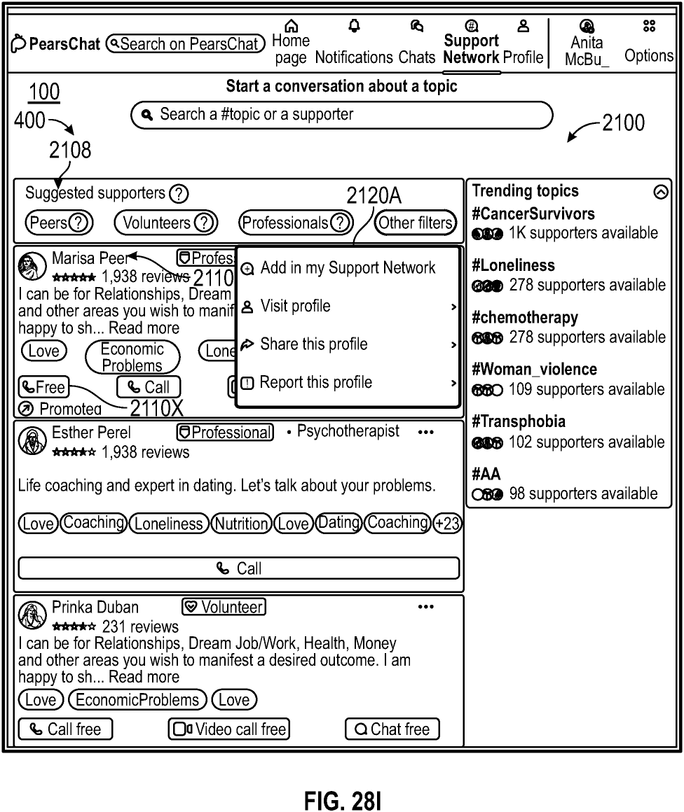

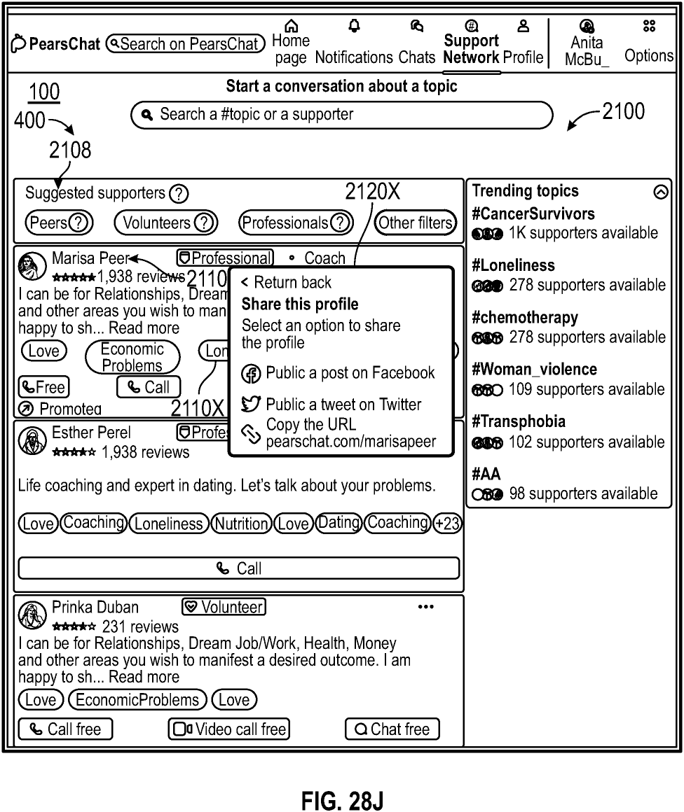

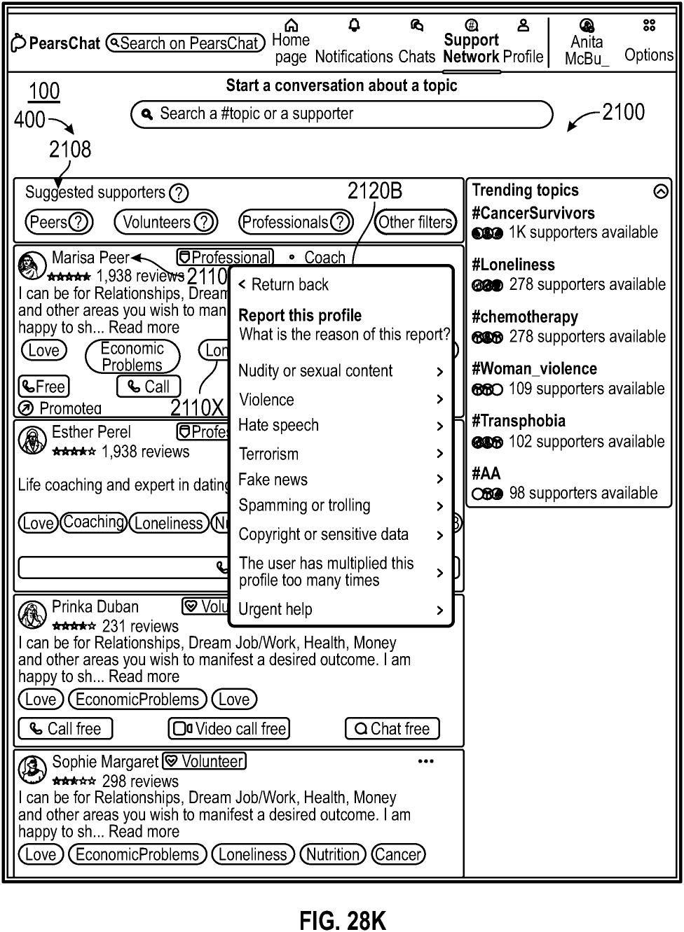

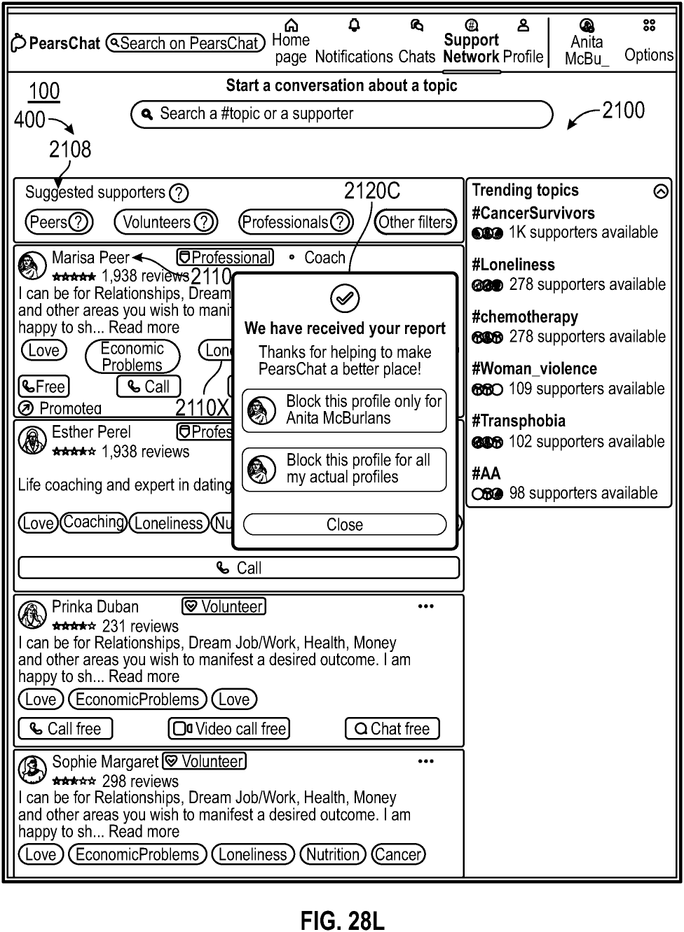

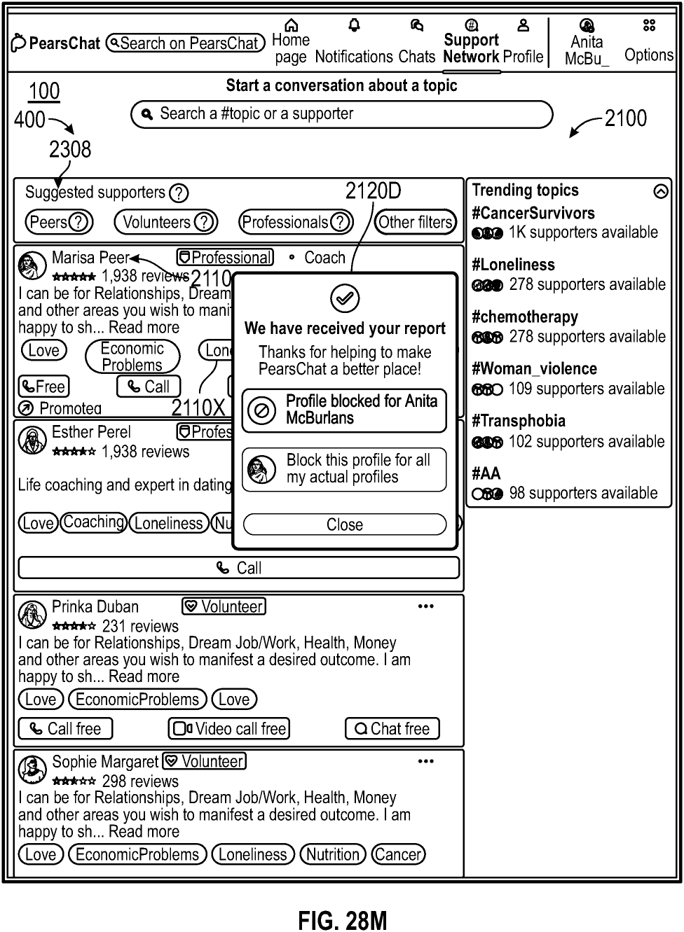

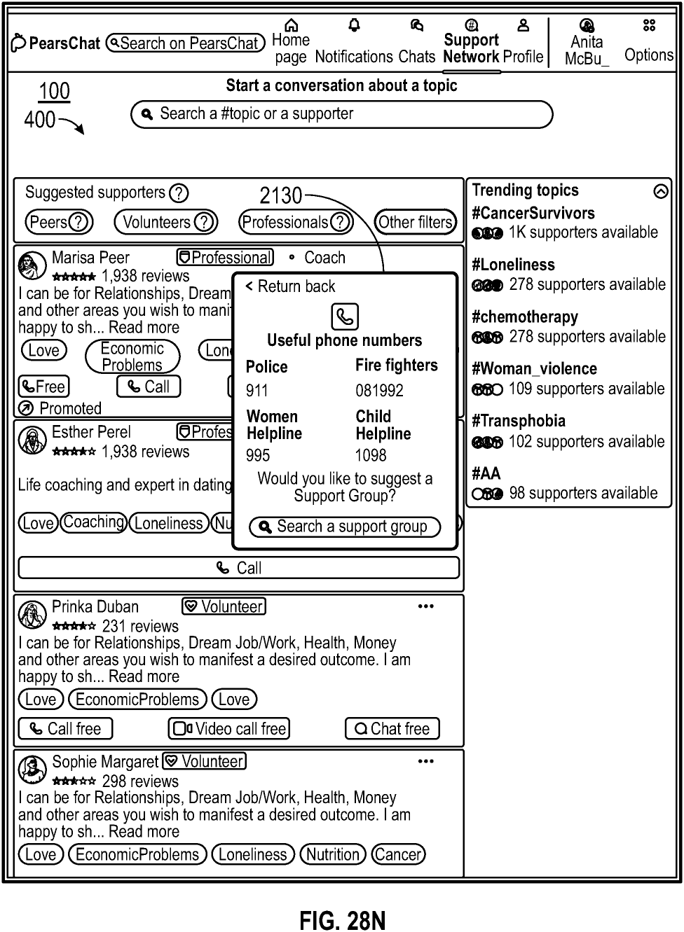

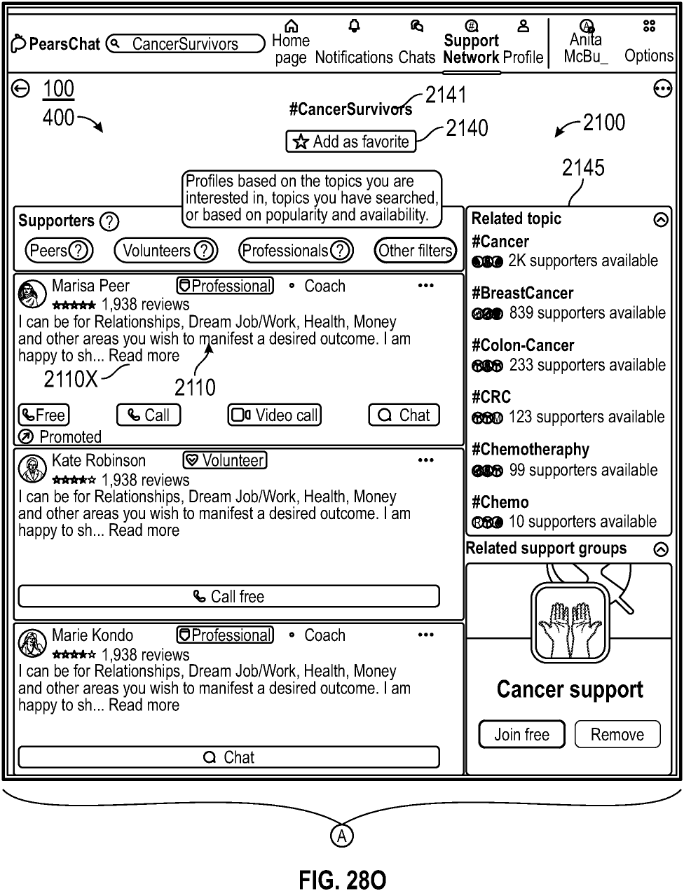

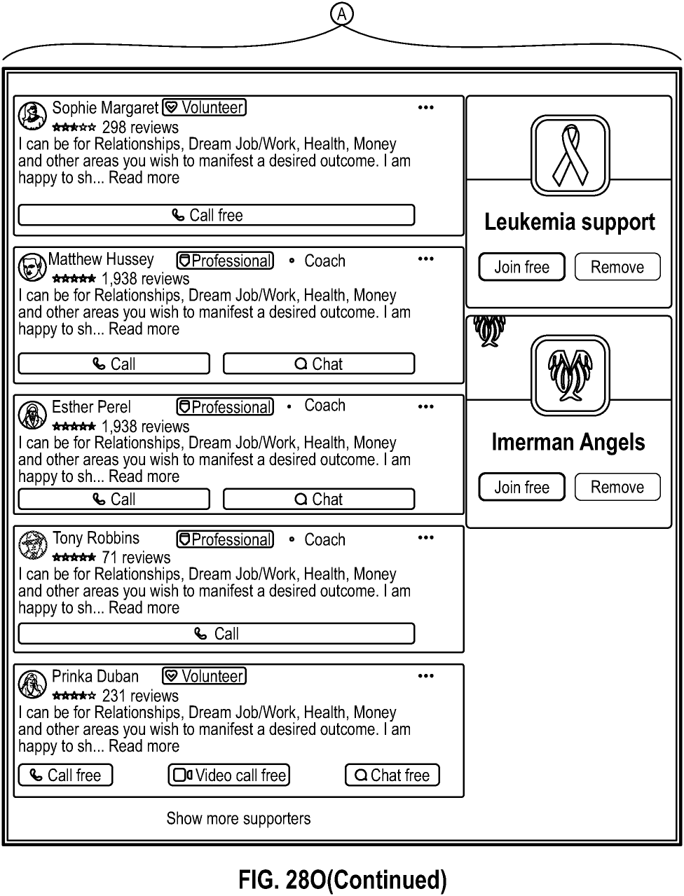

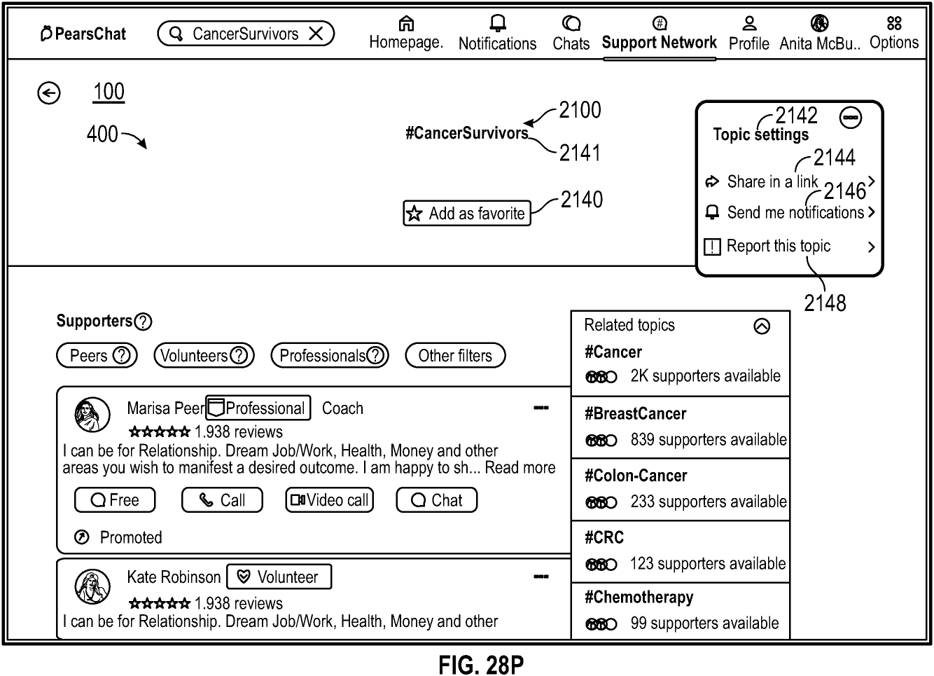

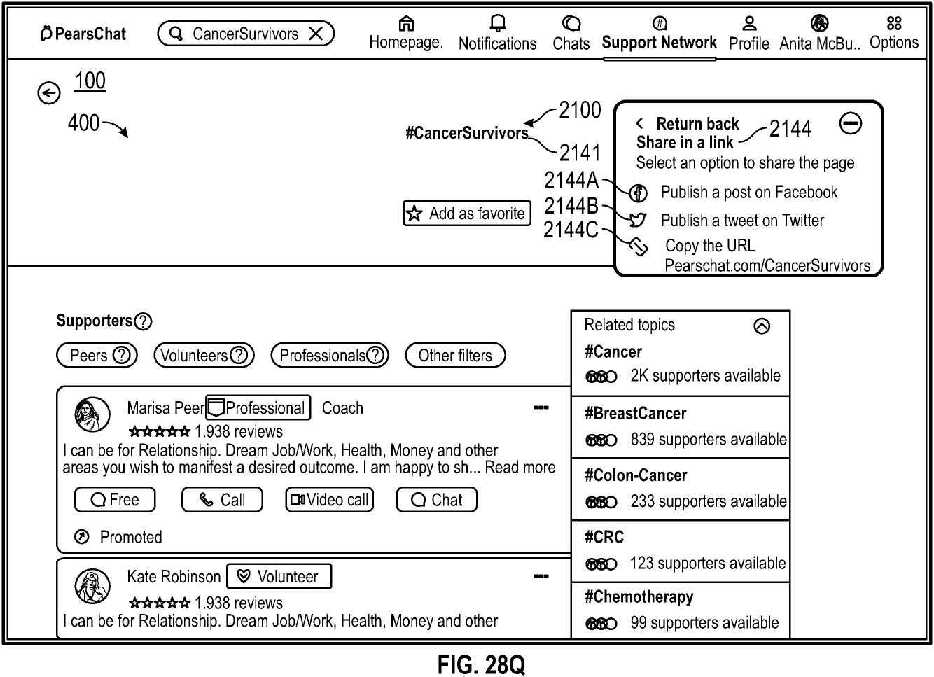

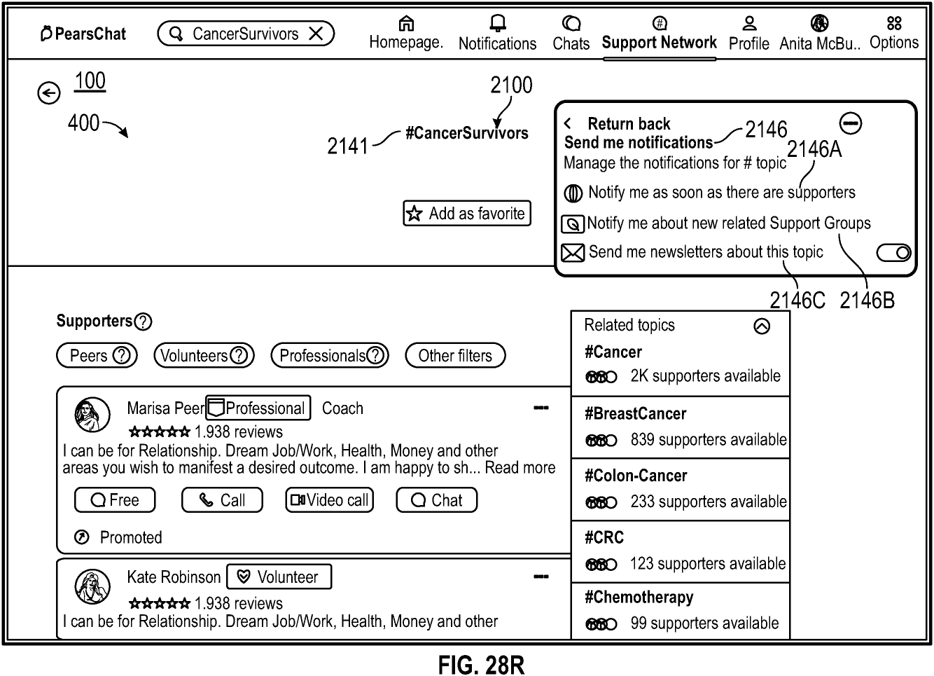

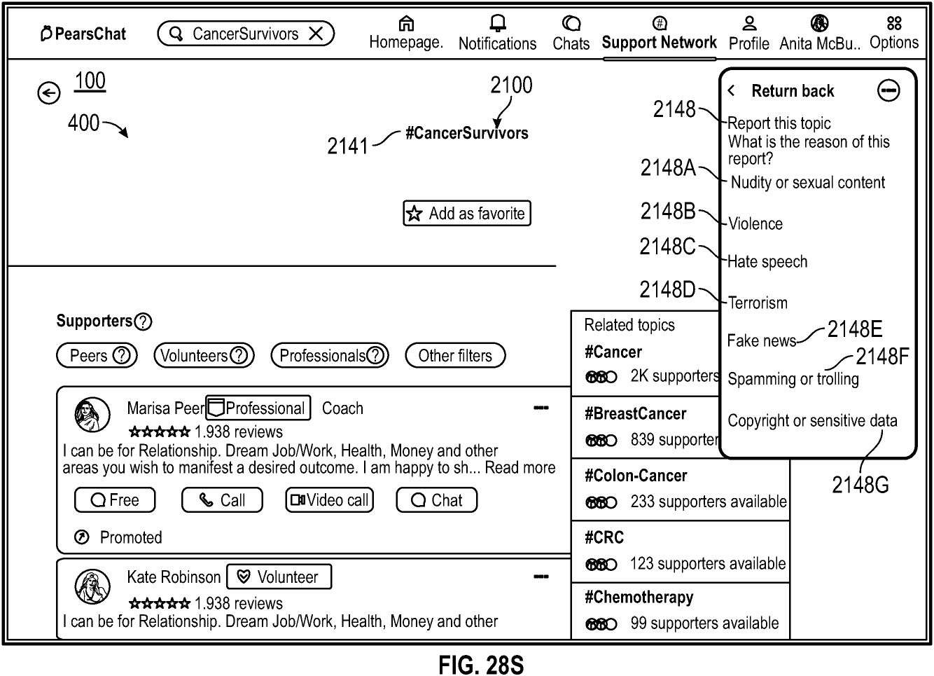

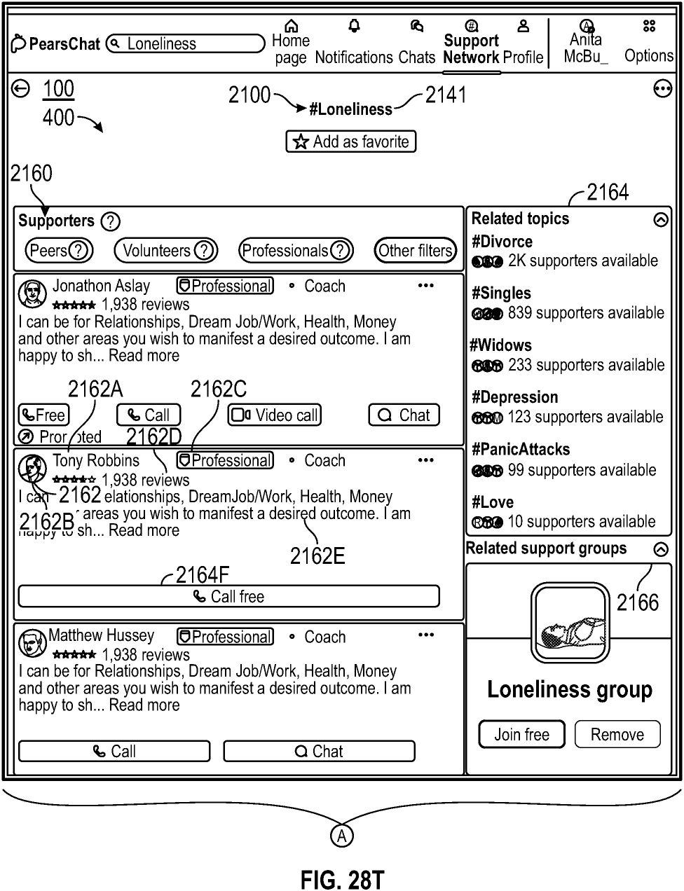

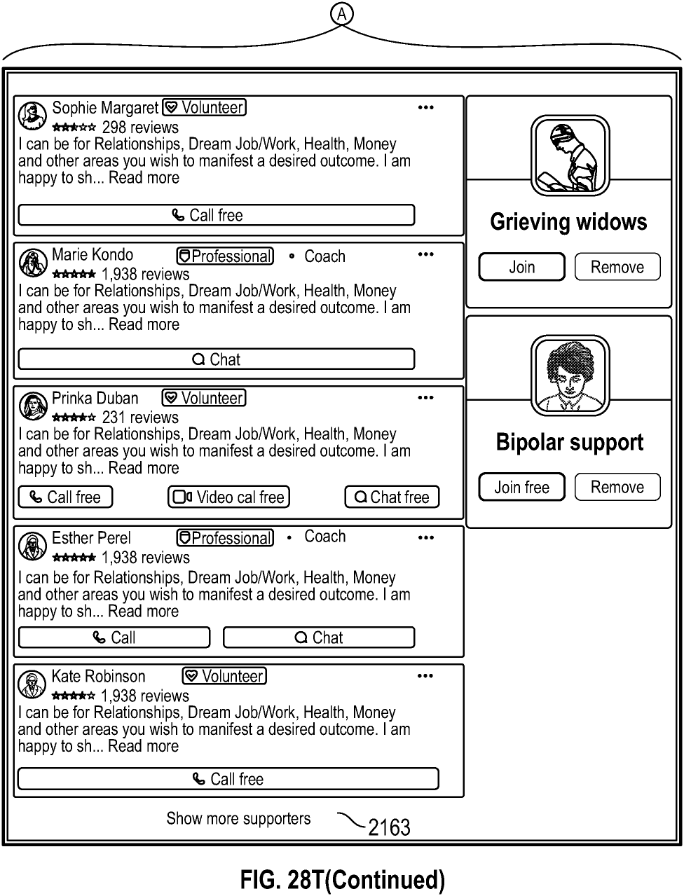

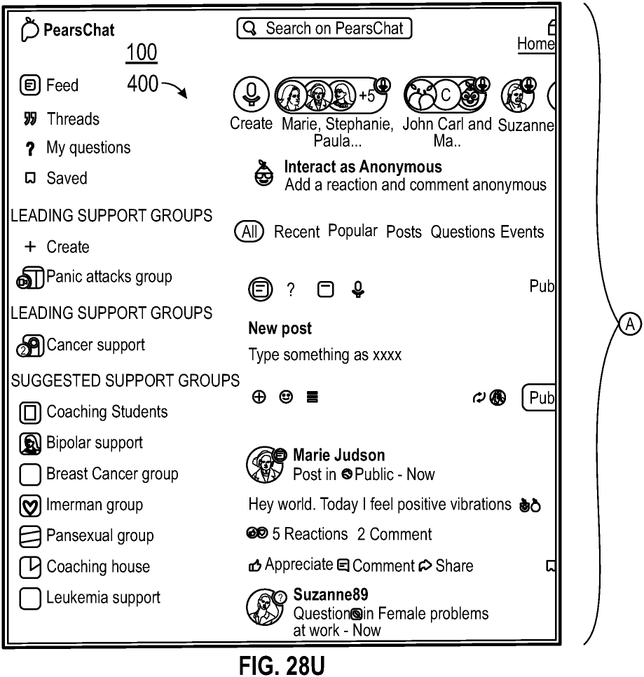

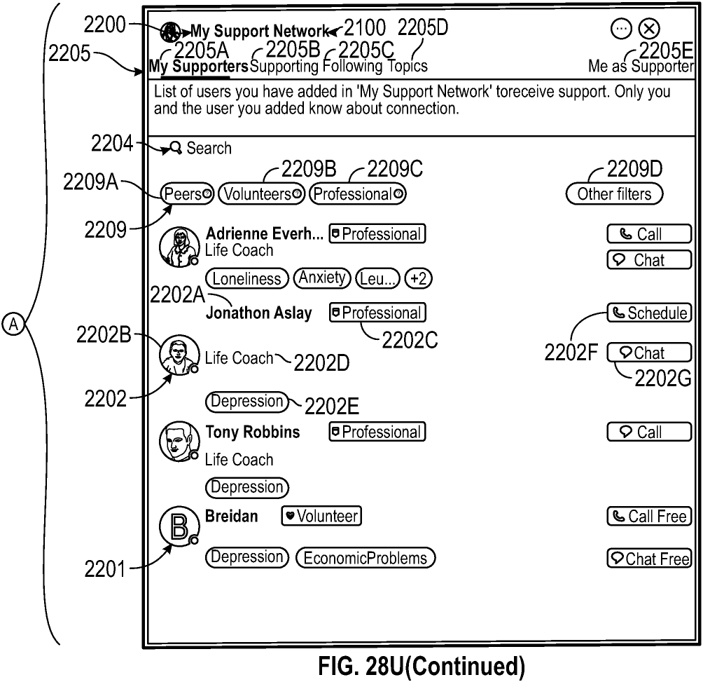

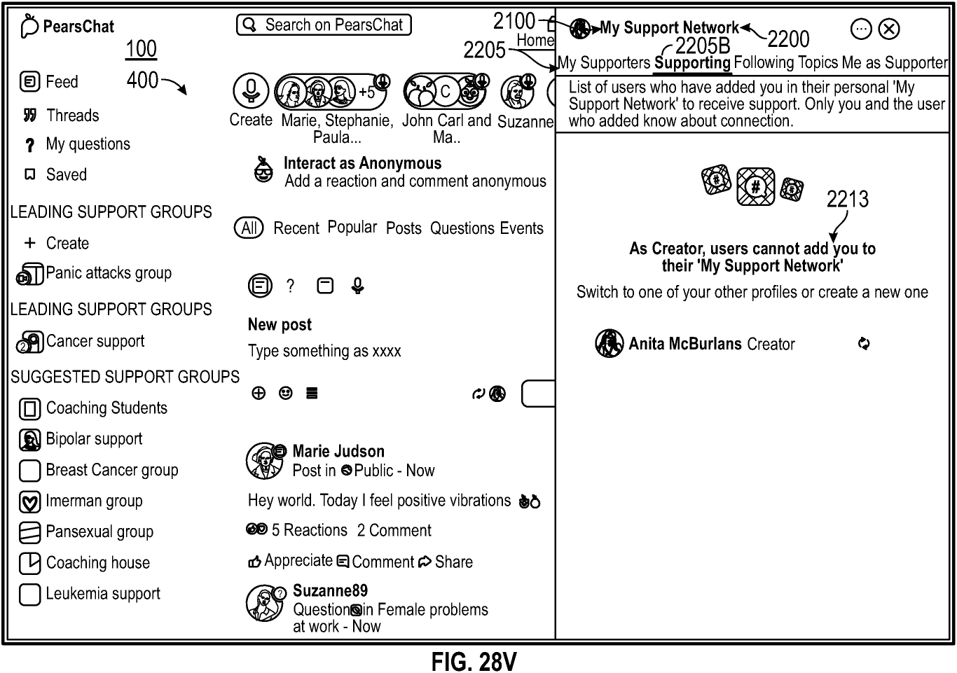

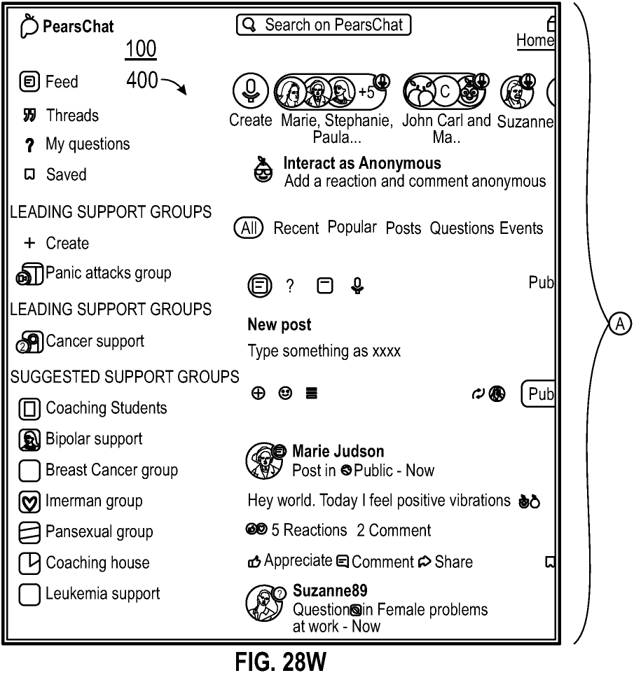

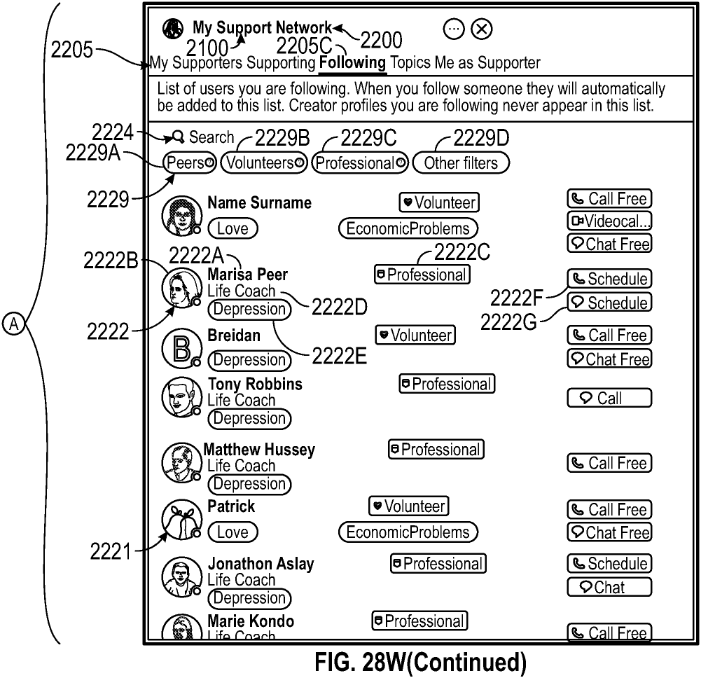

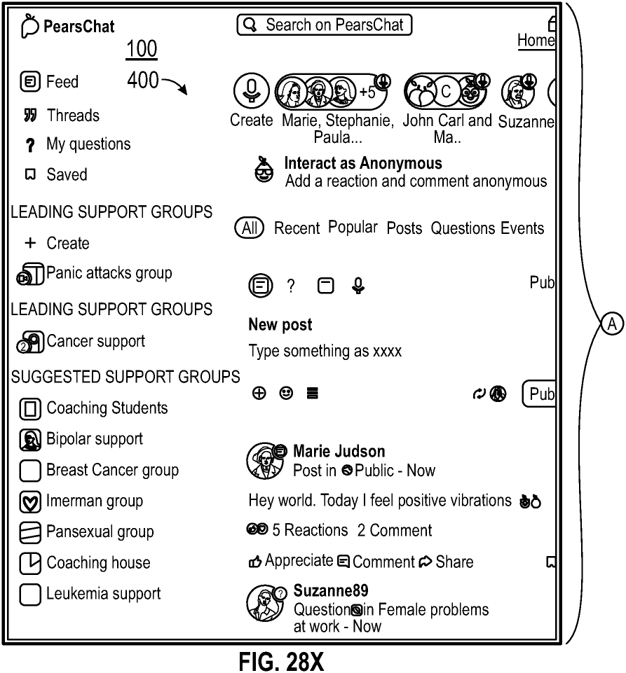

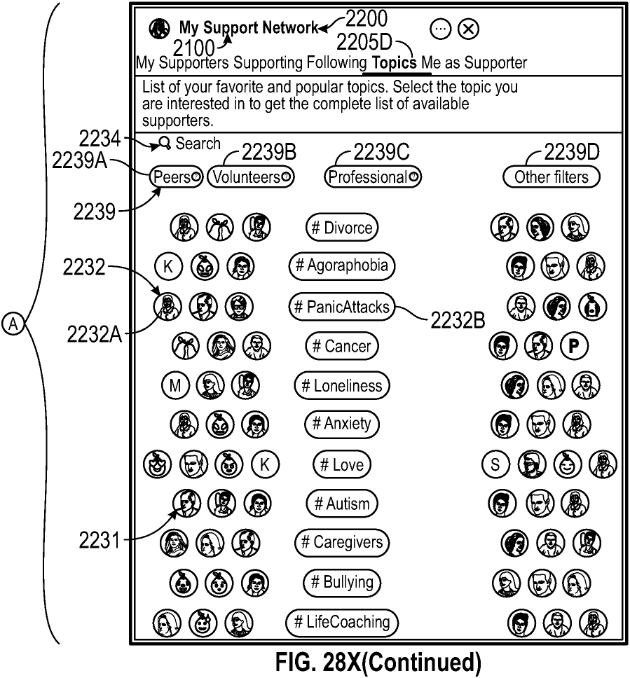

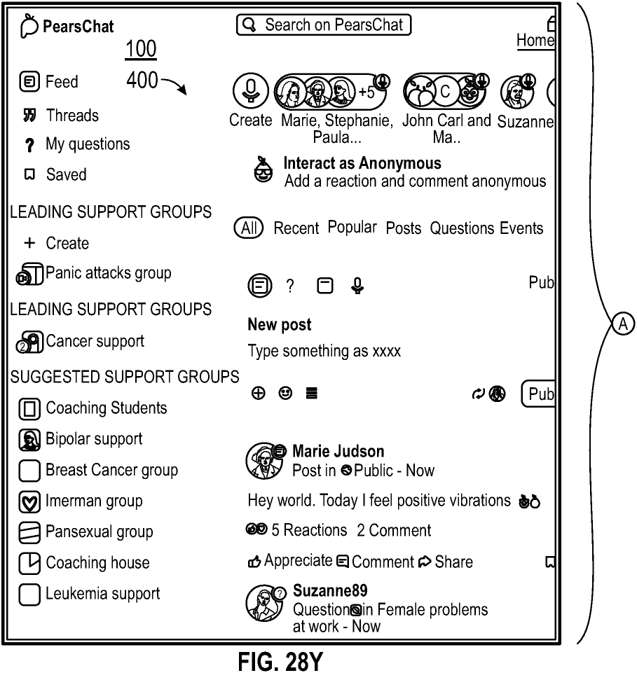

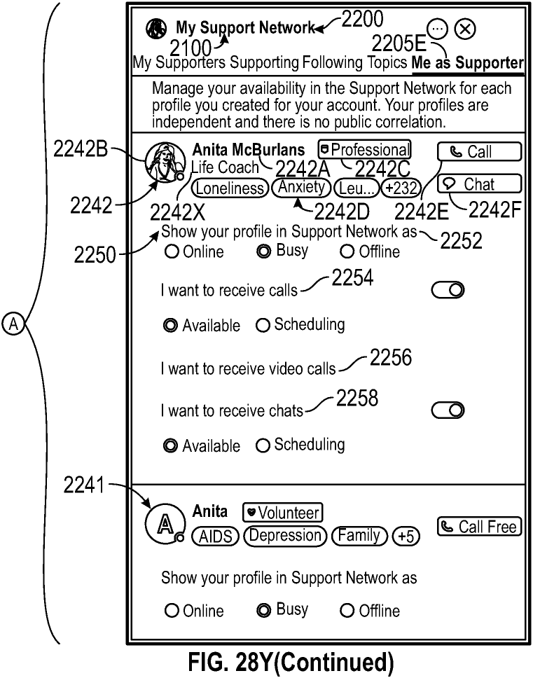

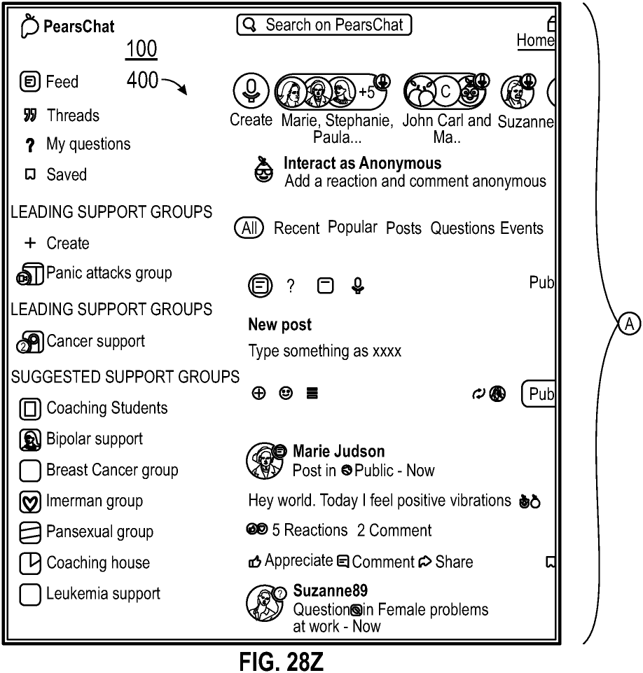

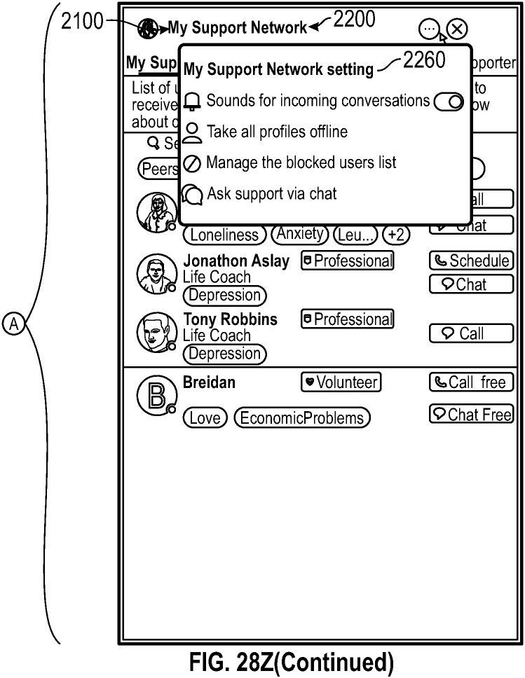

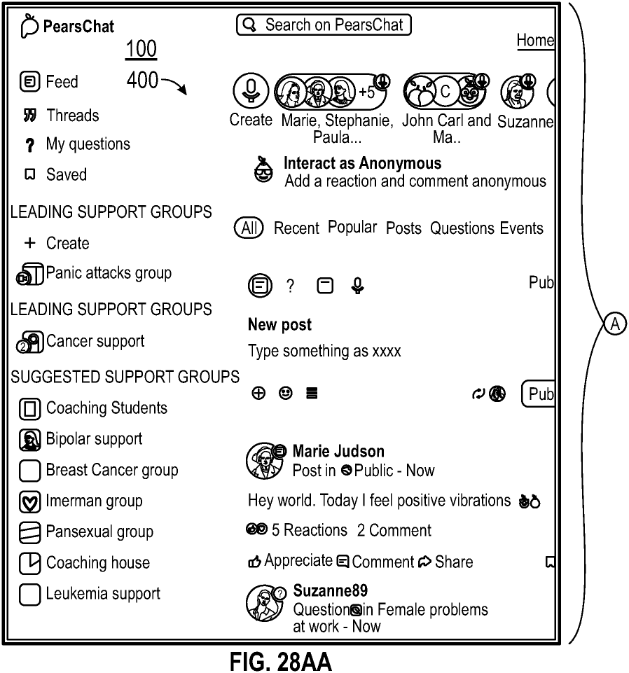

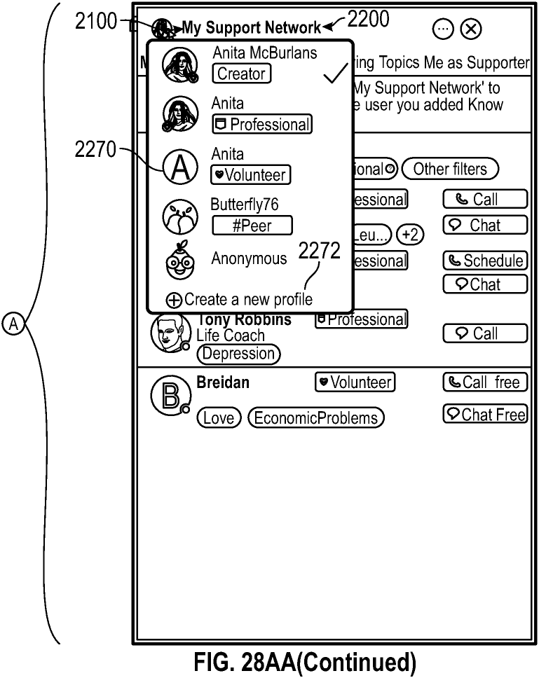

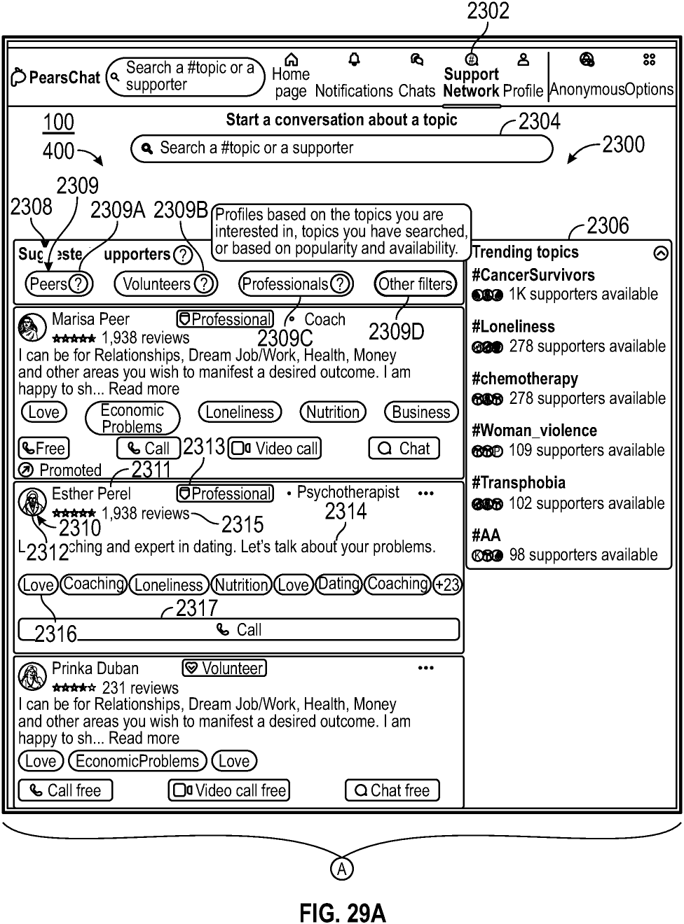

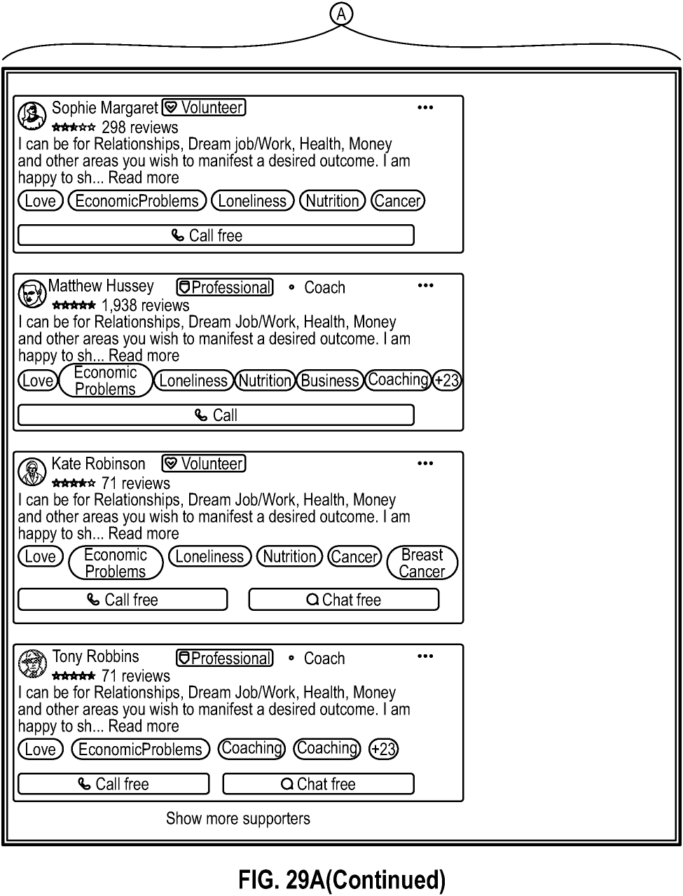

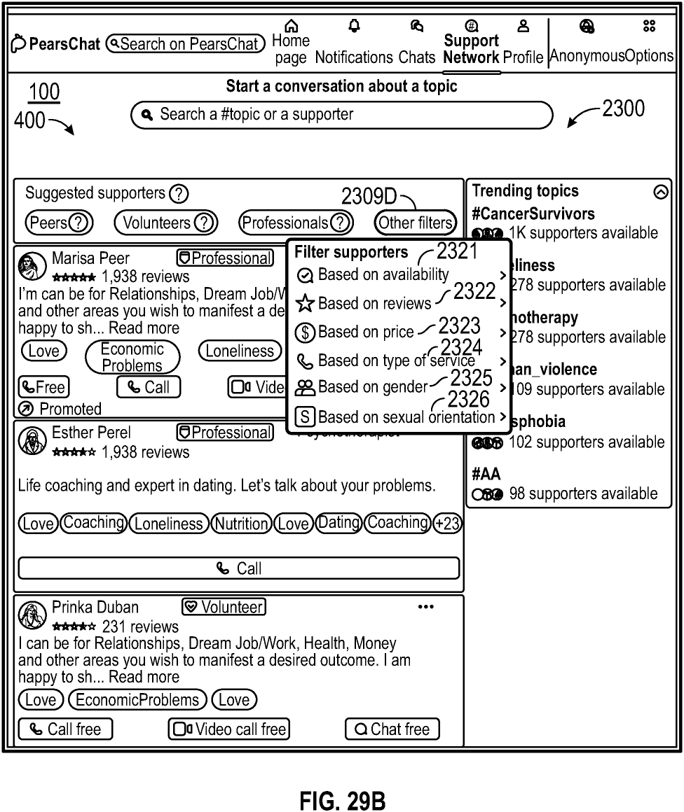

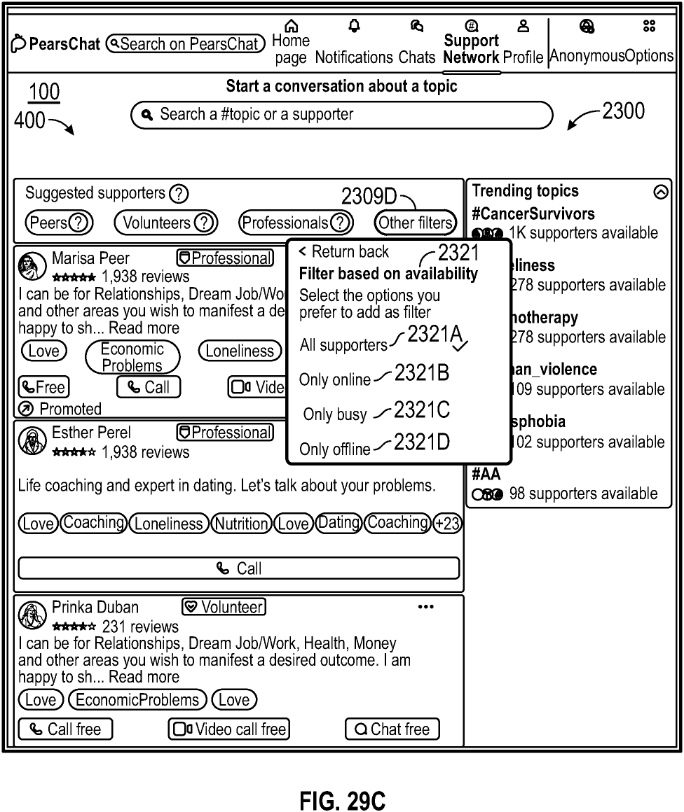

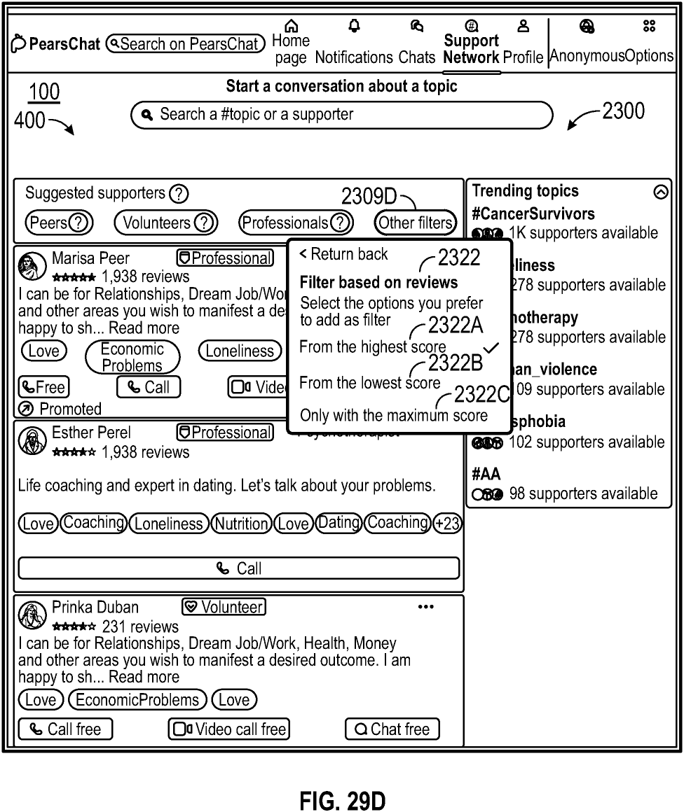

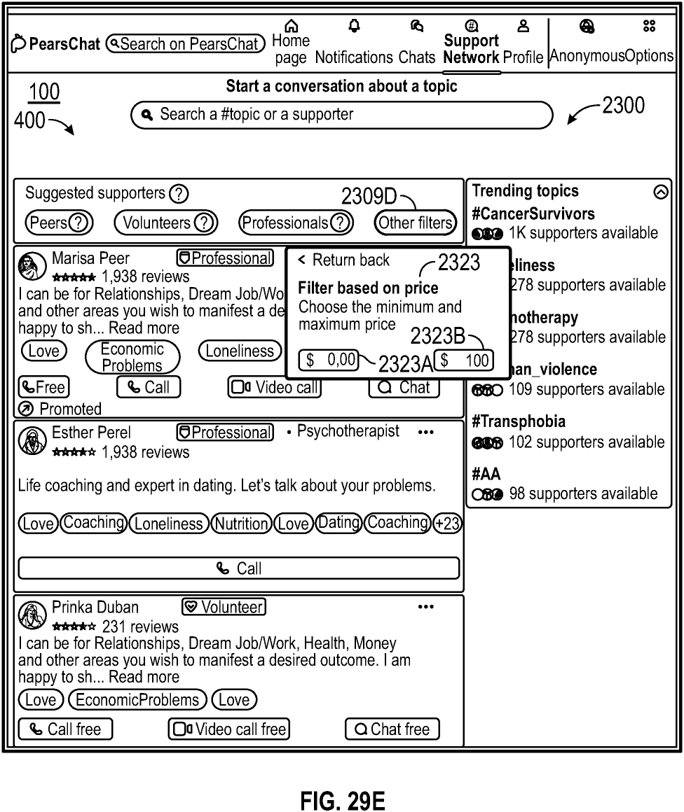

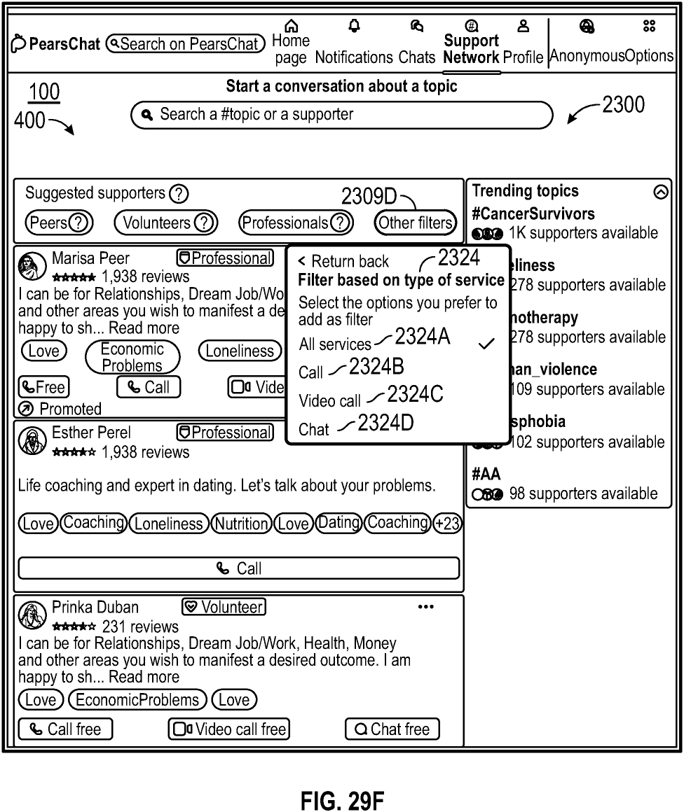

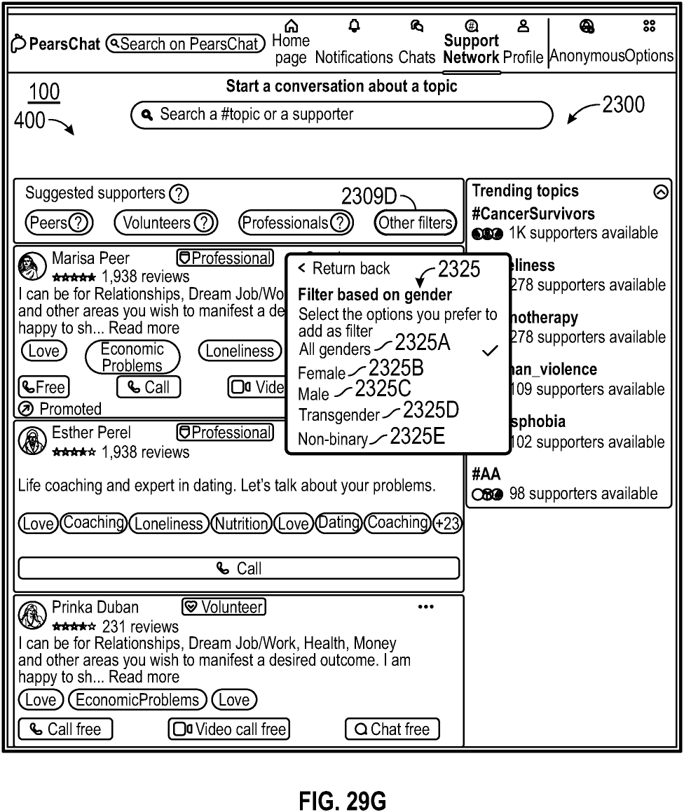

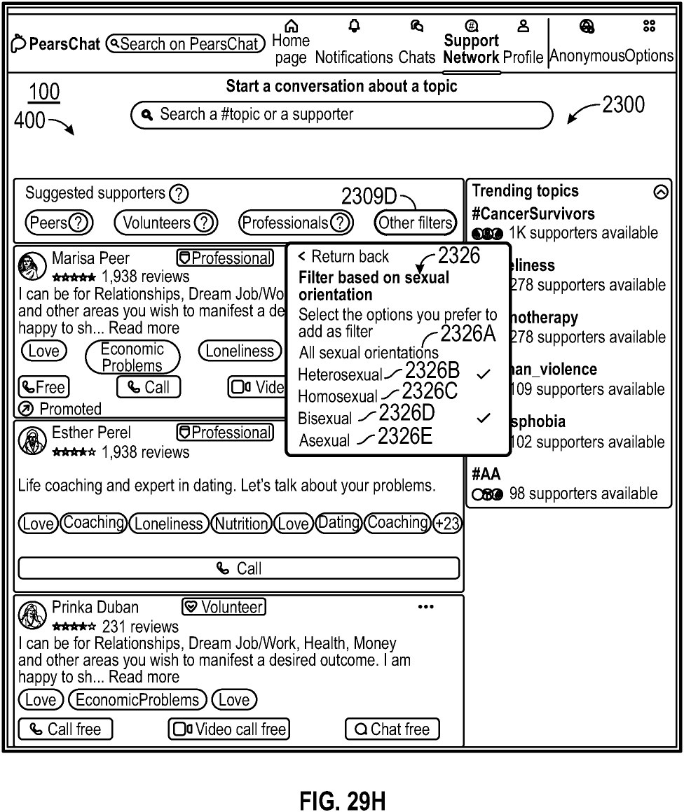

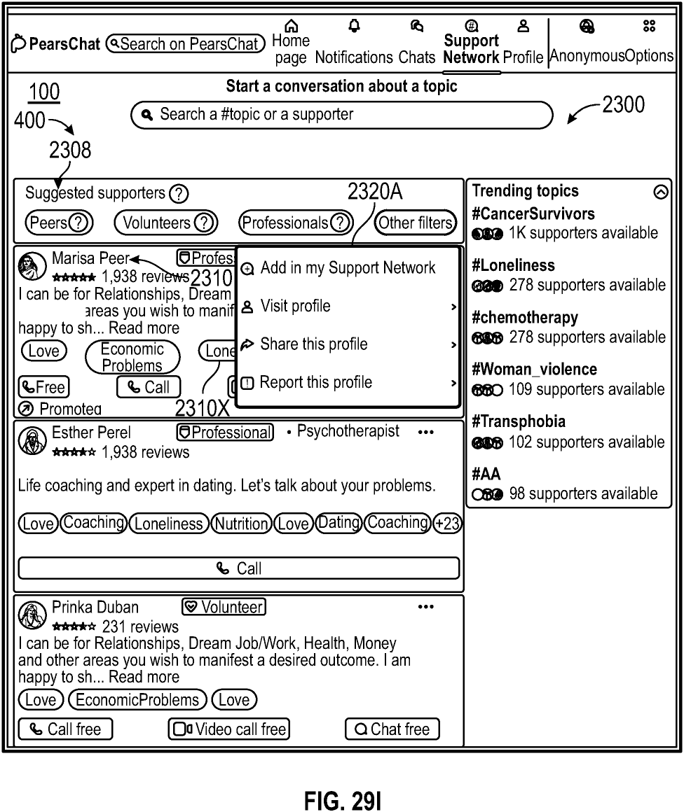

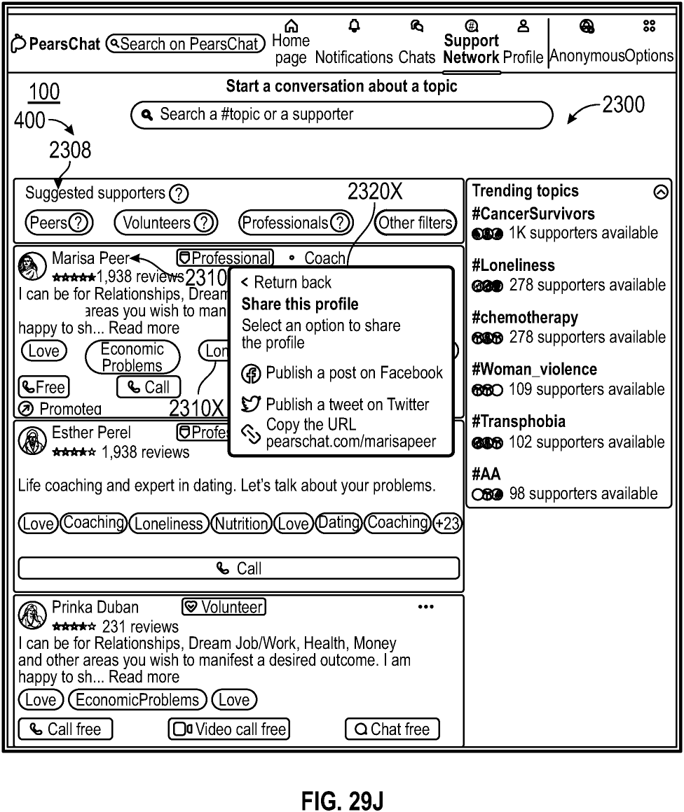

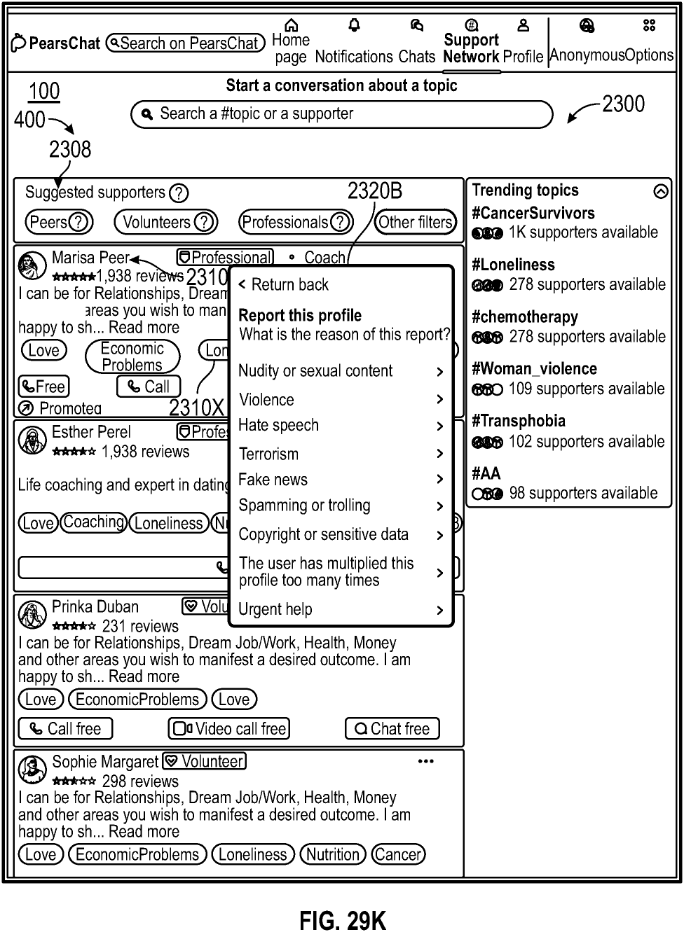

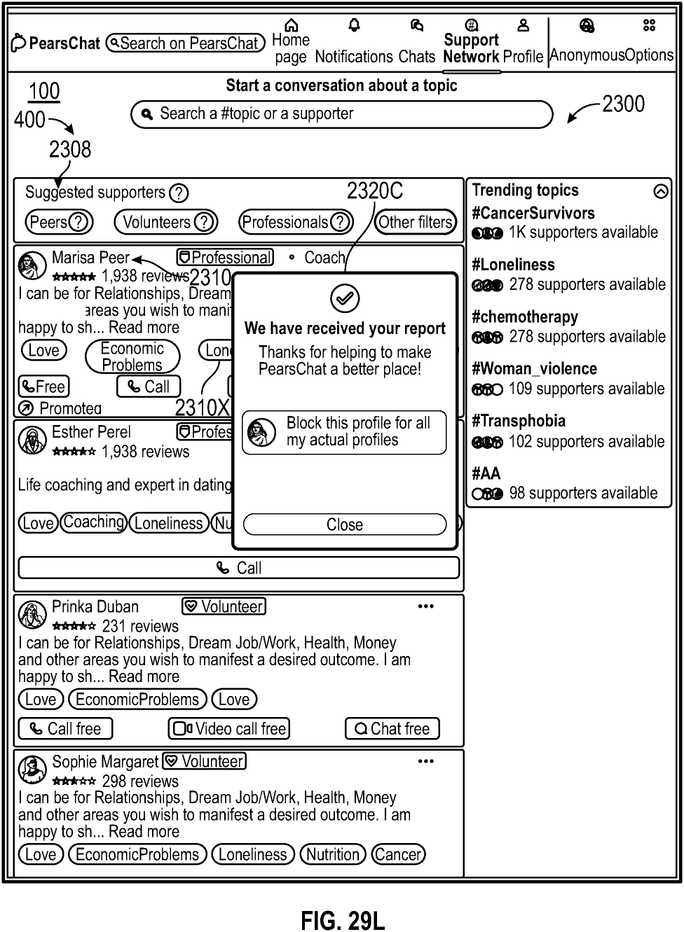

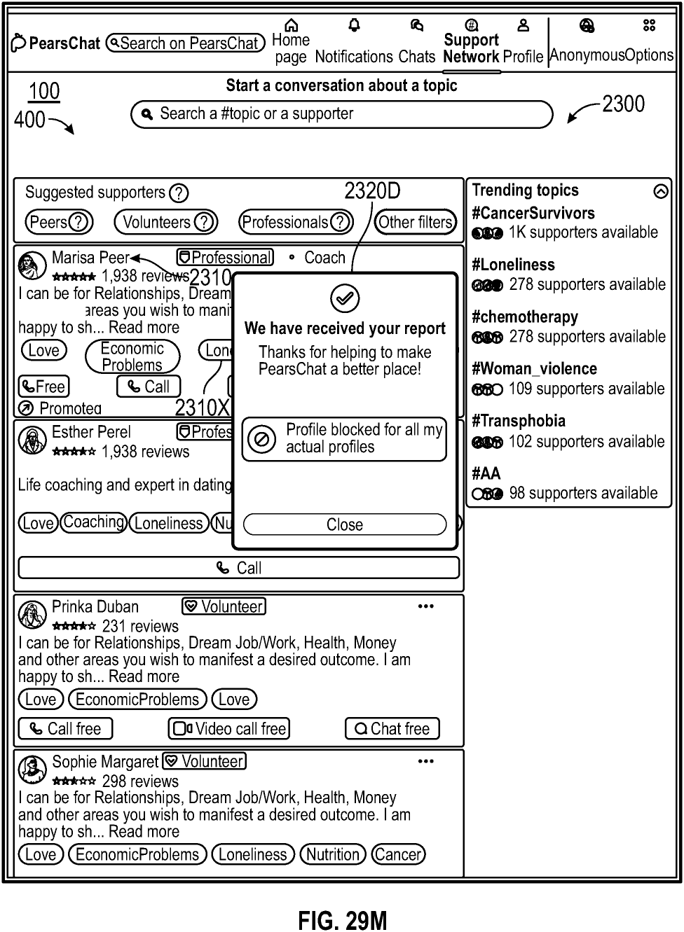

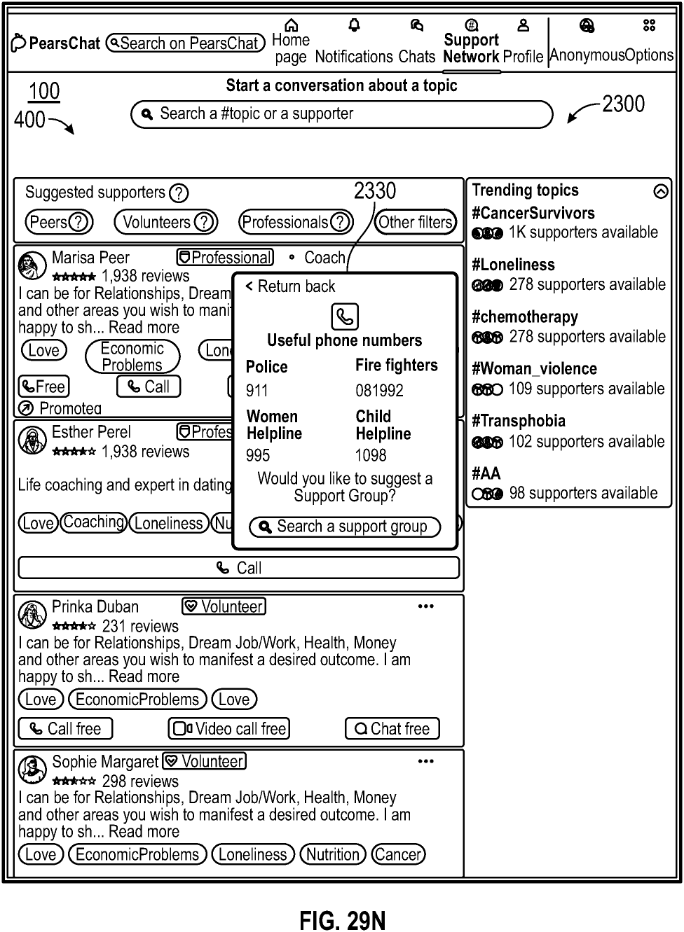

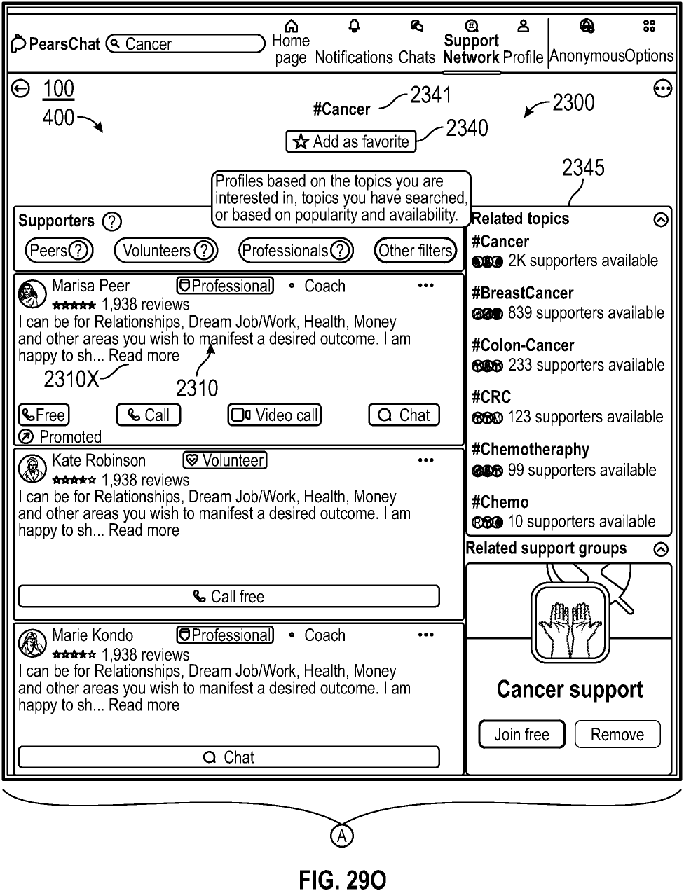

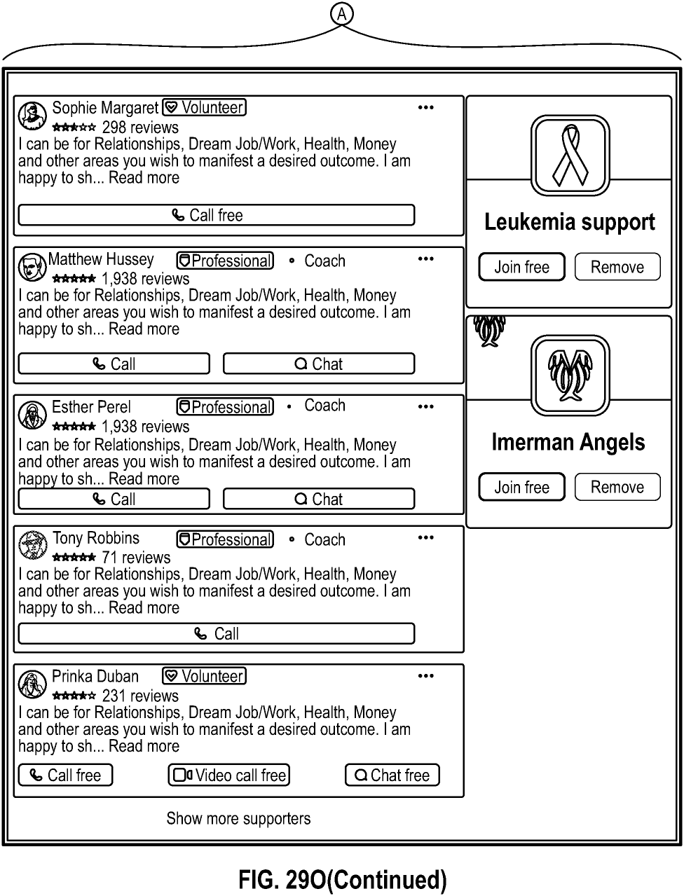

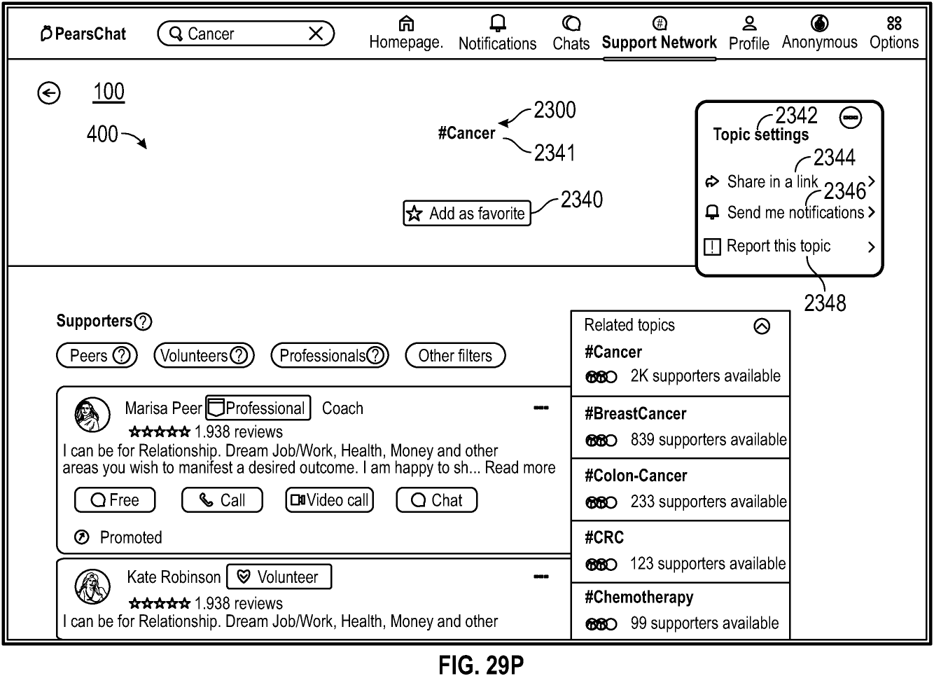

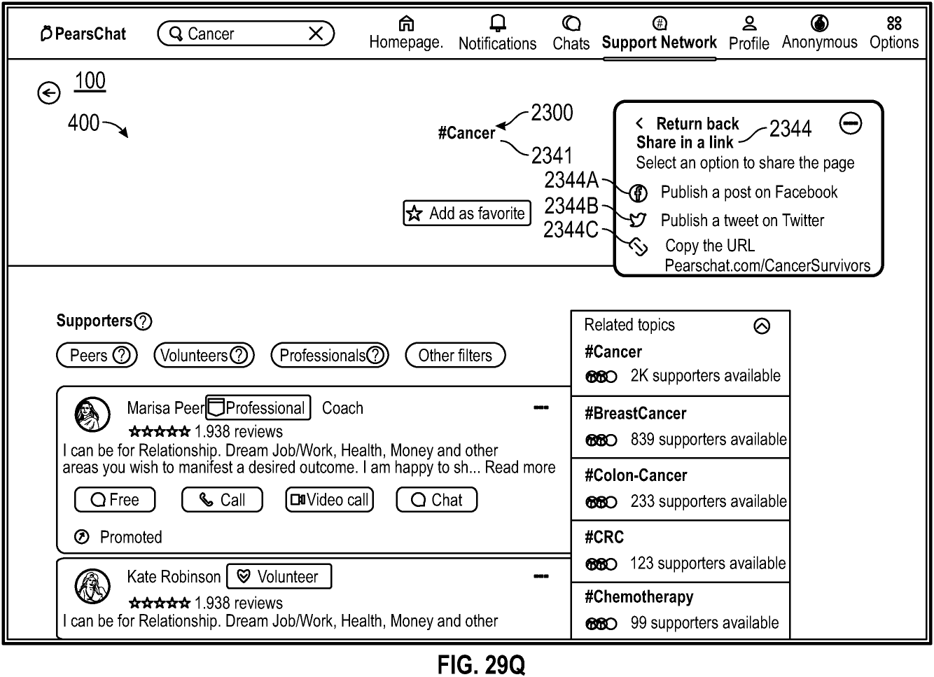

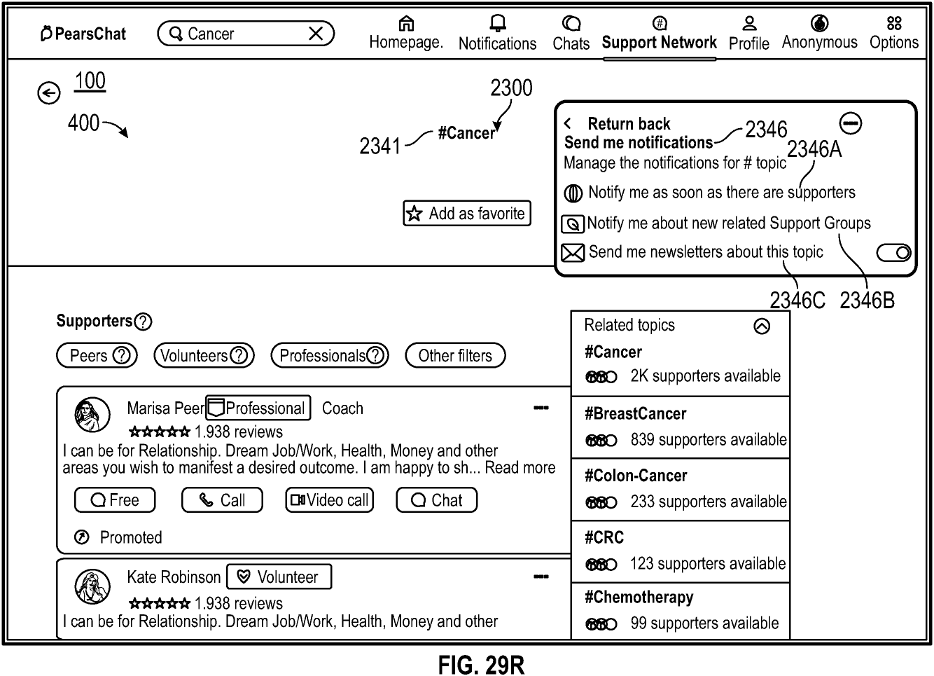

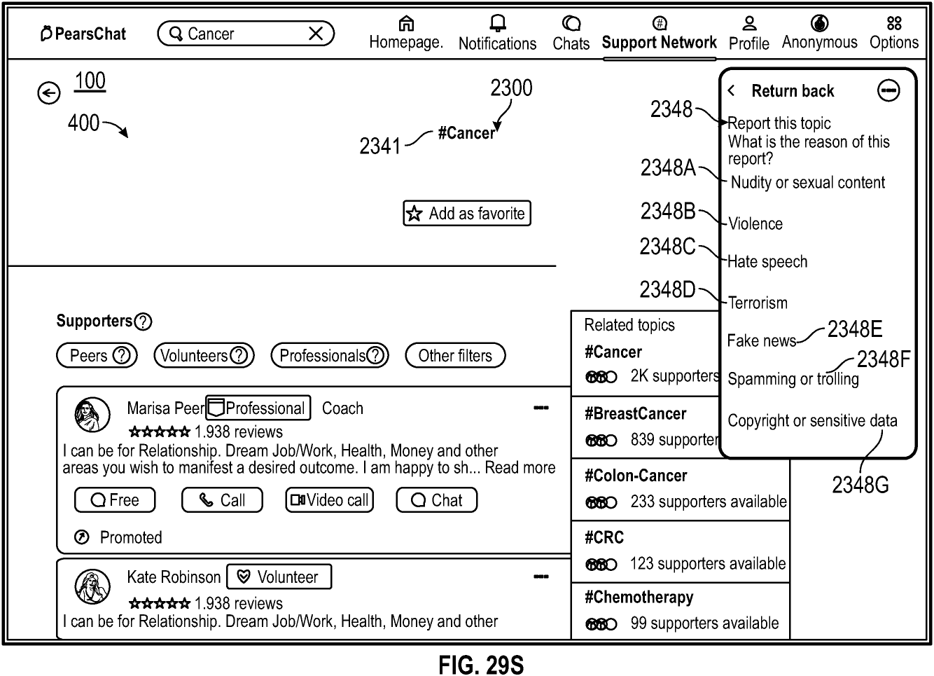

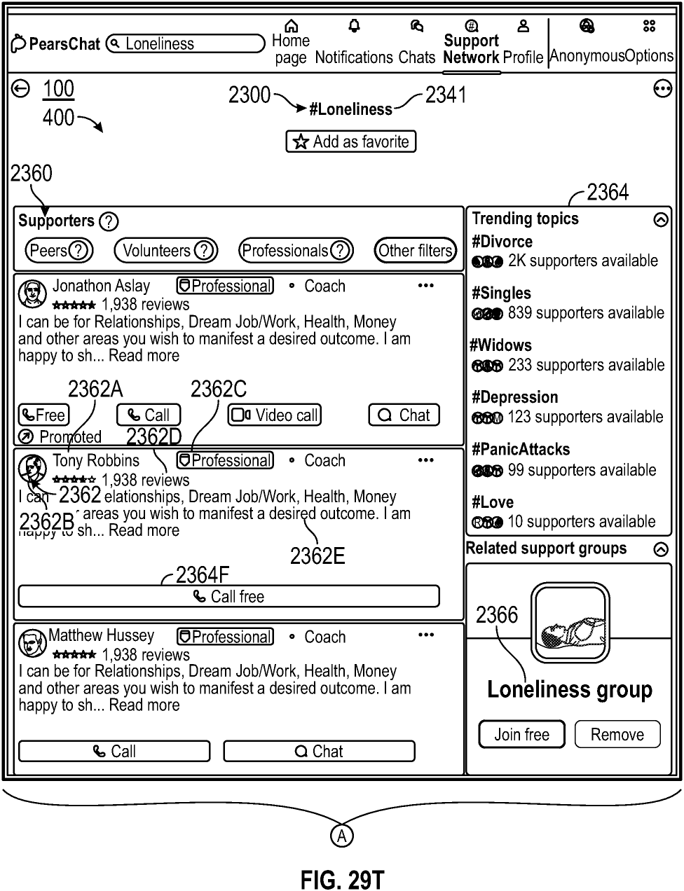

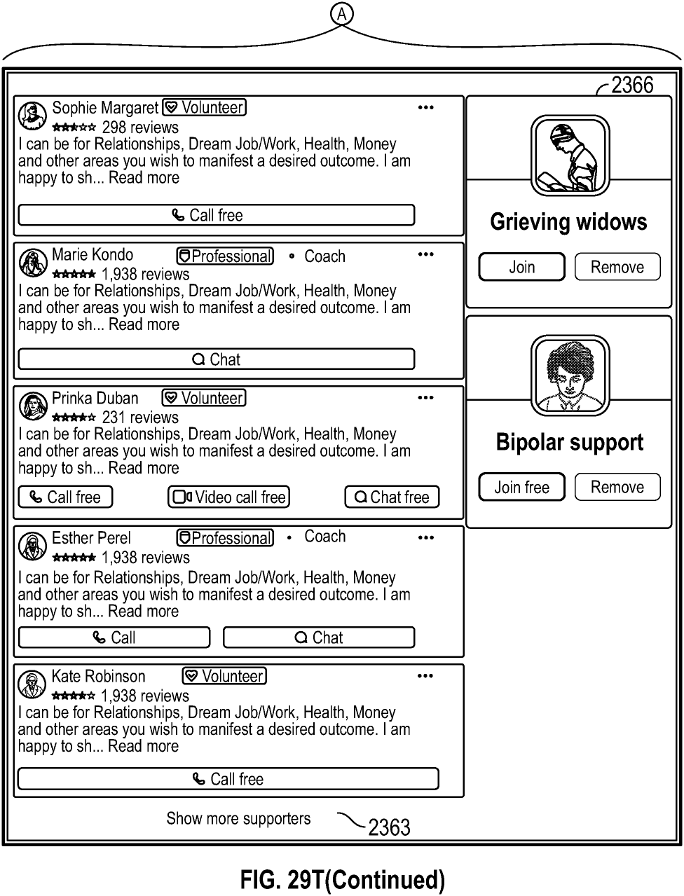

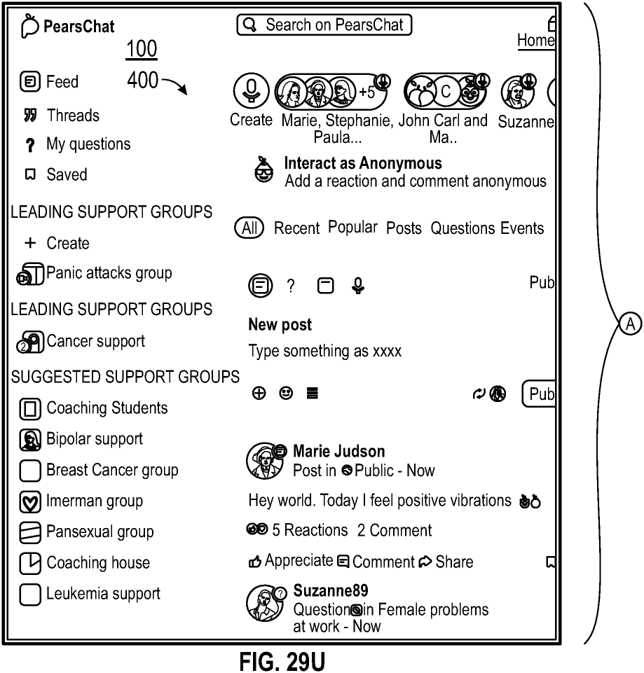

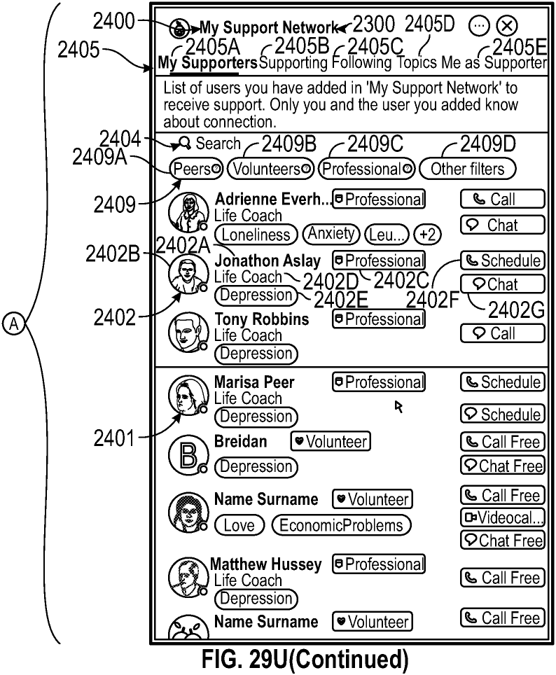

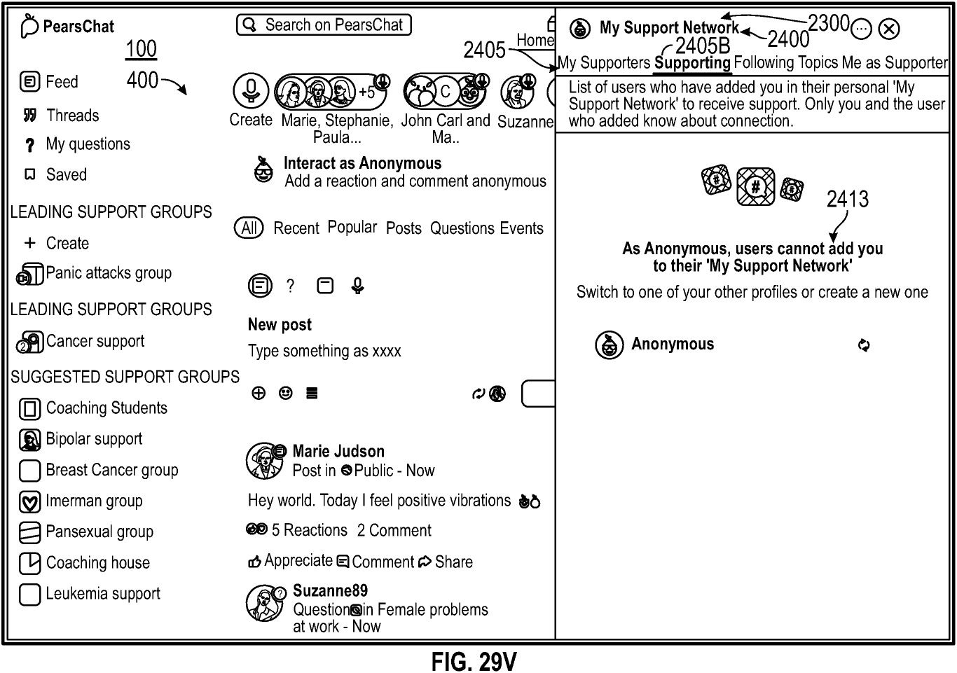

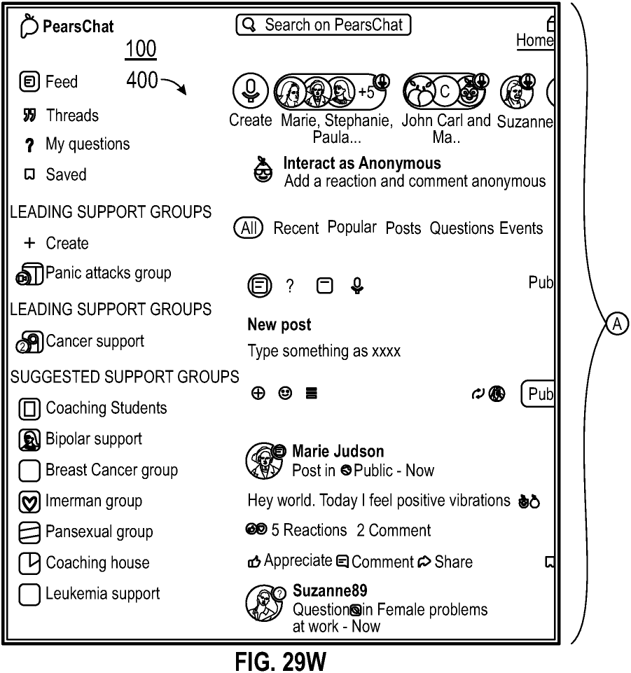

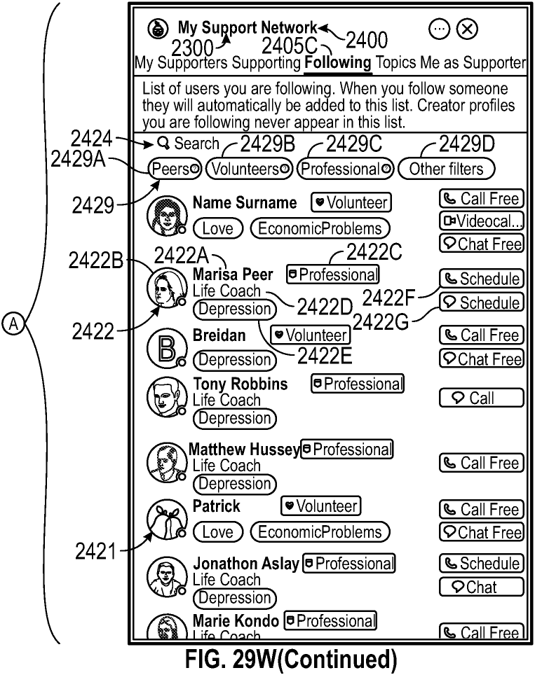

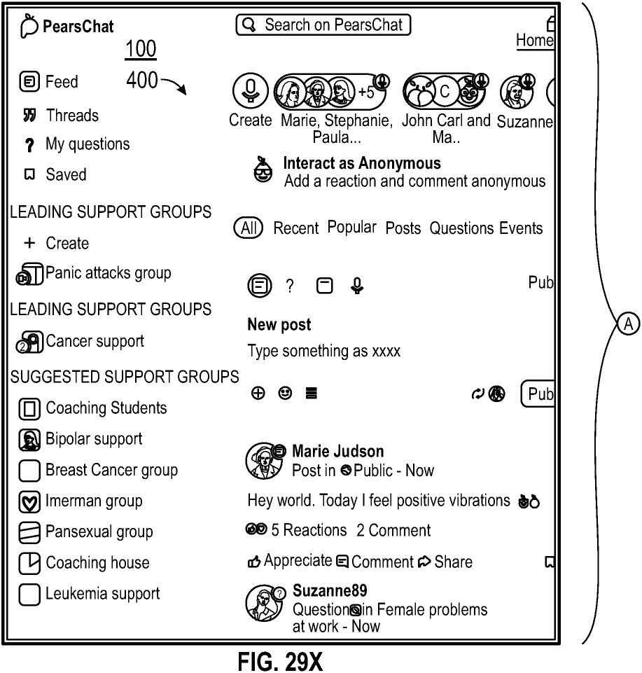

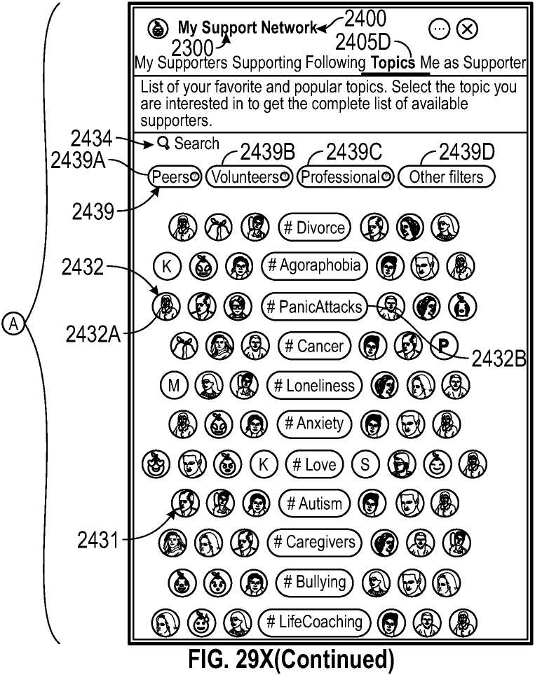

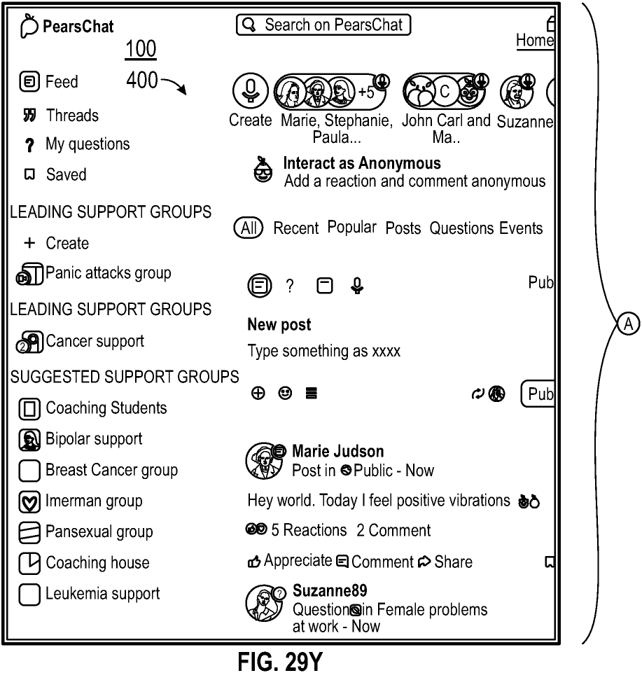

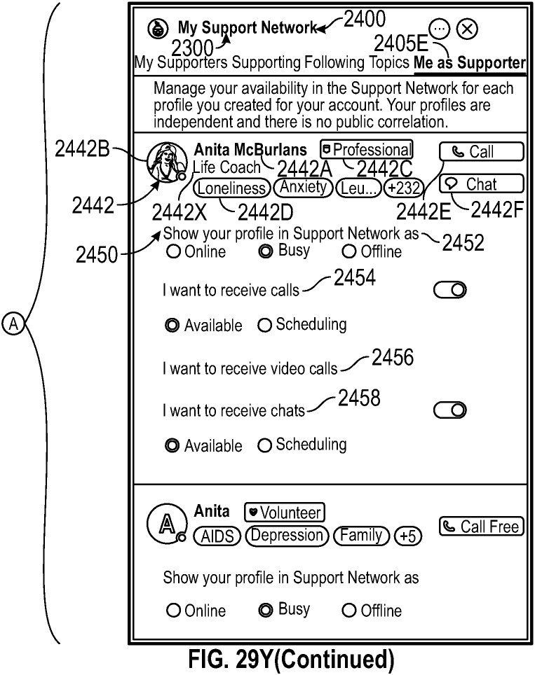

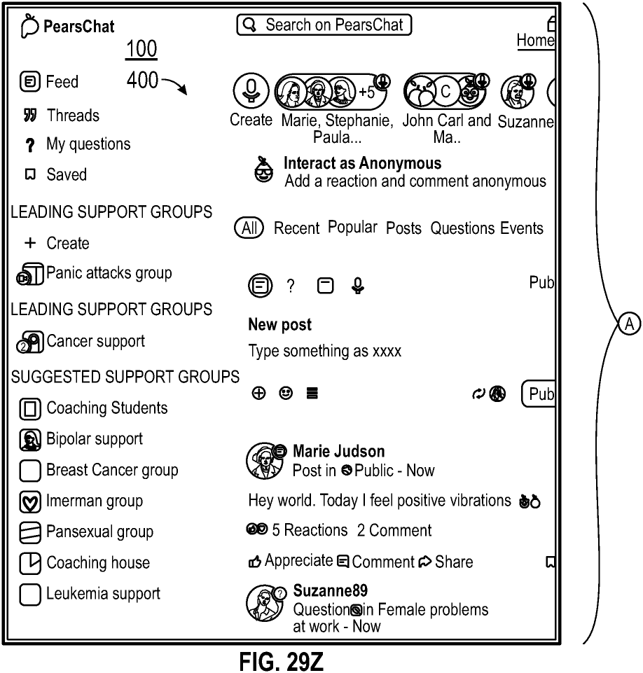

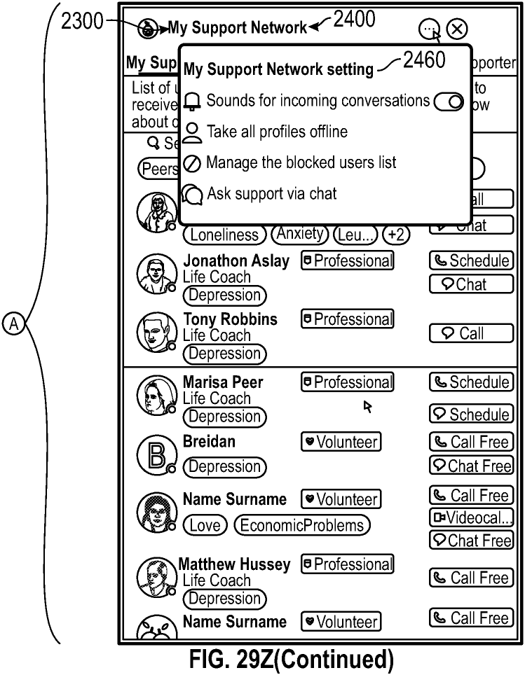

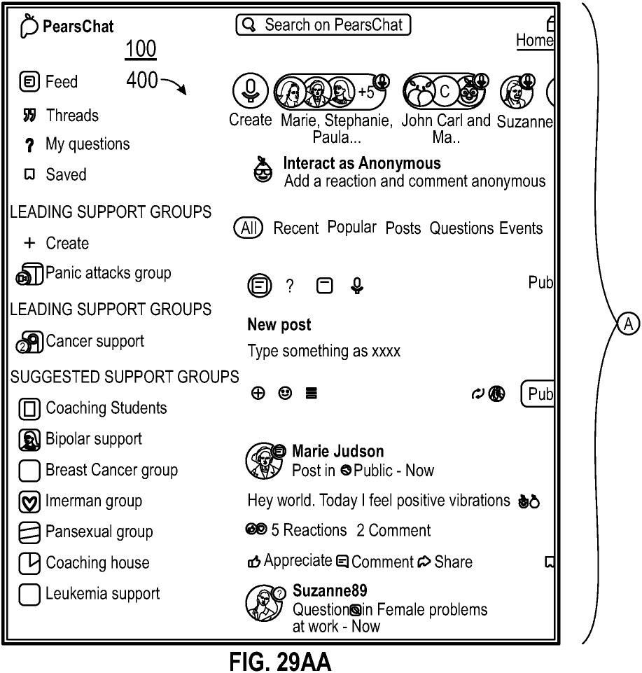

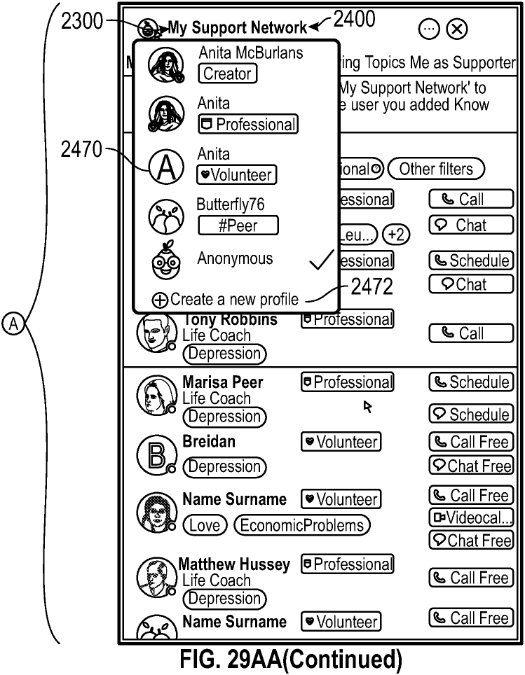

The graph of FIG. 24A illustrates an embodiment of how the multiuse communication system 100 can respond when a my support page, such as a my support network page 1600 (shown FIGS. 25S-Y), a my support network page 1800 (shown in FIGS. 26S-Y), a my support network page 2000 (shown in FIGS. 27T-Z), a my support network page 2200 (shown in FIG. 28U-AA) and/or a my support network page 2400 (shown in FIG. 29U-AA), is accessed. The response of the multiuse communication system 100 can depend, for example, upon a first user category associated with the first system user 210. The connection formed between the first system user 210 and the second system user 220 via the multiuse communication system 100 can be mutual or not mutual based upon the first user category associated with the first system user 210 and the second user category associated with the second system user 220. Since the creators and anonymous user categories are not supported by the my support page, profiles associated with second system user 220 with the creators and anonymous user categories are not presented via the my support page.

The multiuse communication system 100 of FIG. 24A shows that the first system user 210, in selected embodiments, can be a peer first user 212 and can present a user profile for one or more second system users 220. As set forth above, the second system users 220 can comprise a peer second user 222, a professional second user 221, a volunteer second user 224, a coach second user 226, a creator second user 223A and/or an anonymous second user 223B. The multiuse communication system 100, for example, can present a second system user 220 who comprises a peer second user 222 in response to a search for a selected discussion topic performed by the first system user 210 who is a peer first user 212 and/or can enable the second system user 220, if selected, to call or otherwise contact the first system user 210. In other words, if the first system user 210 comprises a peer first user 212 and the second system user 220 comprises a peer second user 222, the system users 210, 220 can be supported and support. The first system user 210 thereby can be added to the my support page of the second system user 220, and the supporting page of the second system user 220 can include the added first system user 210 among the supported users of the second system user 220 as shown via the my support page. Additionally and/or alternatively, the second system user 220 thereby can be added to the my support page of the first system user 210, and the supporting page of the first system user 210 can include the added second system user 220 among the supporting users of the first system user 210 as shown via the my support page.

If the first system user 210 comprises a peer first user 212 and the second system user 220 comprises a professional second user 221 or a volunteer second user 224, the system users 210, 220 can be supported but cannot support. The first system user 210 thereby can be added to the my support page of the second system user 220, and the supporting page of the second system user 220 can include the added first system user 210 among the supported users of the second system user 210 as shown via the my support page. The my support page of the first system user 210, however, cannot include the added second system user 220 among the my supporters of the first system user 210 as shown via the my support page. The multiuse communication system 100 optionally may not present a second system user 220 who comprises a creator second user 223A or an anonymous second user 223B in response to the search performed by the first system user 210 and/or can inhibit the second system user 220 from calling or otherwise contacting the first system user 210 with regard to the selected discussion topic. For example, the multiuse communication system 100 can inhibit the second system user 220 who comprises a creator second user 223A or an anonymous second user 223B from being presented among the search results of the first system user 210.

The multiuse communication system 100 of FIG. 24B alternatively can enable the first system user 210 to be logged into the multiuse communication system 100 as a peer first user 212 using a peer user profile and search for the selected discussion topic. The graph of FIG. 24B shows another exemplary embodiment of how the multiuse communication system 100 and illustrates which system users 200 can connect via the my support page, such as a my support network page 1600 (shown FIGS. 25S-Y), a my support network page 1800 (shown in FIGS. 26S-Y), a my support network page 2000 (shown in FIGS. 27T-Z), a my support network page 2200 (shown in FIG. 28U-AA) and/or a my support network page 2400 (shown in FIG. 29U-AA). The connections among the system users 200 can based, at least in part, upon the user profiles and/or the user categories of the system users 200. In some cases, a connection between the system users 200 is permitted; the connection is not permitted in other cases. The first system user 210 optionally may be required to switch to being a peer first user 212 to achieve a connection with another system user 200. Since the creators and anonymous user categories are not supported by the my support page, profiles associated with second system user 220 with the creators and anonymous user categories are not presented via the my support page, but such second system user 220 can engage in a telephone call, a videoconference, an internet chat or otherwise interact with other system users 200.

If the first system user 210 wishes to interact with second system users 220 who comprise peer second users 222, the multiuse communication system 100 can present search results with a listing of peer second users 222 and enable the first system user 210 to call or otherwise interact with one or more of the listed peer second users 222. If the first system user 210 is logged in as a peer first user 212, searches for the selected discussion topic and wishes to interact with second system users 220 who comprise a professional second user 221 and/or a volunteer second user 224, the multiuse communication system 100 can present search results with a listing of professional second users 221 and/or volunteer second users 224 and enable the first system user 210 to call or otherwise interact with one or more of the listed professional second users 221 and/or one or more of the listed volunteer second users 224.

Stated somewhat differently, if the first system user 210 comprises a peer first user 212 and the second system user 220 comprises a peer second user 222, a professional second user 221 or a volunteer second user 224, the system users 210, 220 can show up and call. The supporting page of the second system user 220 thereby can be updated to include the first system user 210 among the supported users of the second system user 220, and the supported page of the first system user 210 can be updated to include the second system user 220 among the supporting users of the first system user 210. In other words, the multiuse communication system 100 may impose no restriction on connecting a peer first user 212 with peer second users 222, professional second users 221 and/or volunteer second users 224.

The multiuse communication system 100 is illustrated in FIG. 24B as not including a creator second user 223A or an anonymous second user 223B in the listing of second system users 220 that results from searches performed by peer first users 212. For example, the multiuse communication system 100 can inhibit the second system user 220 who comprises a creator second user 223A or an anonymous second user 223B from being presented among the search results of the first system user 210 and prevent telephone calls or other interactions between the system users 210, 220.

Returning to FIG. 24A, if the first system user 210 identifies as a professional first user 211, a volunteer first user 214 or a creator first user 213A, the multiuse communication system 100 can present a listing of one or more second system users 220 in response to a search for a selected discussion topic. The listed second system users 220 can include one or more second system users 220 who comprise peer second users 222. The multiuse communication system 100 can connect the first system user 210 with at least one of the peer second users 222 but, in selected embodiment, may condition the connection on the first system user 210 changing to a peer first user 212 before connecting the first system user 210 with the peer second users 222. In other words, the peer second users 222 can show up among the search results, but the first system user 210 may be required to switch to being a peer first user 212.

If the second system user 220 comprises a professional second user 221 or a volunteer second user 224, the system users 210, 220 can be supported but cannot support. The first system user 210 thereby can be added to the my support page of the second system user 220, and the supporting page of the second system user 220 can include the added first system user 210 among the supported users of the second system user 210 as shown via the my support page. The my support page of the first system user 210, however, cannot include the added second system user 220 among the my supporters of the first system user 210 as shown via the my support page.

The multiuse communication system 100 optionally may not present a second system user 220 who comprises a creator second user 223A or an anonymous second user 223B in response to the search performed by the first system user 210 and/or can inhibit the second system user 220 from interacting or otherwise contacting the first system user 210 with regard to the selected discussion topic. For example, the multiuse communication system 100 can inhibit the second system user 220 who comprises a creator second user 223A or an anonymous second user 223B from being presented among the search results of the first system user 210 and prevent telephone calls or other interactions between the system users 210, 220.

Alternatively, the first system user 210 can log into the multiuse communication system 100 of FIG. 24B as a professional first user 211 using a professional user profile, a volunteer first user 214 or a creator first user 213A and search for the selected discussion topic. If the first system user 210 wishes to interact with second system users 220 who comprise peer second users 222, the multiuse communication system 100 can present search results with a listing of peer second users 222. If the first system user 210 attempts to call or otherwise connect with one of the peer second users 222, the multiuse communication system 100 can inhibit the connection and instruct the first system user 210 to switch to an existing peer first user 212 (or to create a new peer profile) of the first system user 210 before a connection with the peer second users 222 will be permitted. In other words, the first system user 210 can be required to switch to being a peer first user 212 to achieve a connection with the peer second users 222. The multiuse communication system 100 can prevent the first system user 210 from connecting with the peer second users 222 when the first system user 210 acts in the capacity of the professional first user 211 with a professional profile, the volunteer first user 214 or the creator first user 213A.

If the first system user 210 is logged into the multiuse communication system 100 of FIG. 24B as a professional first user 211, a volunteer first user 214 or a creator first user 213A, searches for the selected discussion topic and wishes to interact with second system users 220 who comprise a professional second user 221 and/or a volunteer second user 224, the multiuse communication system 100 can present search results with a listing of professional second users 221 and/or volunteer second users 224 and enable the first system user 210 to call or otherwise interact with one or more of the listed professional second users 221 and/or one or more of the listed volunteer second users 224.

Stated somewhat differently, if the first system user 210 comprises a professional first user 211, a volunteer first user 214 or a creator first user 213A and the second system user 220 comprises a professional second user 221 or a volunteer second user 224, the system users 210, 220 can show up and call. The supporting page of the second system user 220 thereby can be updated to include the first system user 210 among the supported users of the second system user 220, and the supported page of the first system user 210 can be updated to include the second system user 220 among the supporting users of the first system user 210. The multiuse communication system 100, in other words, may impose no restriction on connecting a professional second user 221 with peer second users 222, professional second users 221 and/or volunteer second users 224. Stated somewhat differently, the multiuse communication system 100 can permit the first system user 210 to connect with a professional second user 221 and/or a volunteer second user 224 when the first system user 210 acts in the capacity of the professional second user 221, the volunteer second user 224 or the creator second user 223A.

The multiuse communication system 100 is illustrated in FIG. 24B as not including a creator second user 223A or an anonymous second user 223B in the listing of second system users 220 that results from searches performed by peer first users 212. For example, the multiuse communication system 100 can inhibit the second system user 220 who comprises a creator second user 223A or an anonymous second user 223B from being presented among the search results of the first system user 210 and prevent telephone calls or other interactions between the system users 210, 220.

Returning again to FIG. 24A, the first system user 210 optionally can identify as an anonymous second user 223B. The anonymous second user 223B, for example, can comprise a first system user 210 who is not logged into the multiuse communication system 100 and/or who is not associated with any other first user category. The anonymous second user 223B can initiate a search for a selected discussion topic via the multiuse communication system 100, which can present a listing of one or more second system users 220 in response to the search.

If the listed second system users 220 comprise peer second users 222, professional second users 221 and/or volunteer second users 224, the system users 210, 220 can be supported but cannot support. The first system user 210 thereby can be added to the my support page of a selected second system user 220, and the supporting page of the selected second system user 220 can include the added first system user 210 among the supported users of the selected second system user 210 as shown via the my support page. The my support page of the first system user 210, however, cannot include the selected second system user 220 among the my supporters of the first system user 210 as shown via the my support page. The multiuse communication system 100 can inhibit the second system user 220 who comprises a creator second user 223A or an anonymous second user 223B from being presented among the search results of the first system user 210.

The multiuse communication system 100 can connect the first system user 210 with at least one of the listed second system users 220 but, in selected embodiment, may condition the connection on the first system user 210 registering with, and/or logging into, the multiuse communication system 100 before connecting the first system user 210 with the listed second system users 220. The multiuse communication system 100 optionally may not present a second system user 220 who comprises a creator second user 223A or an anonymous second user 223B in response to the search performed by the first system user 210 and/or can inhibit the second system user 220 from interacting or otherwise contacting the first system user 210 with regard to the selected discussion topic.

The multiuse communication system 100 optionally can enable the first system user 210 to access the multiuse communication system 100 as a guest second user. The first system user 210 can search the multiuse communication system 100 for the selected discussion topic, and, in response to the search, the multiuse communication system 100 can present a listing of one or more second system users 220 who comprise peer second users 222, professional second users 221 and/or volunteer second users 224. If the first system user 210 wishes to interact with second system users 220, the multiuse communication system 100 can require the first system user 210 to register with the multiuse communication system 100 and/or log into the multiuse communication system 100 before permitting the first system user 210 to call or otherwise interact with one or more of the listed second system users 220. The multiuse communication system 100 may not include a creator second user 223A and/or an anonymous second user 223B among the listed second system users 220.

In selected embodiments, the multiuse communication system 100 advantageously can support a support network for each first system user 210. The support network can allow the first system user 210 to add other system users 200 to the support network of the first system user 210. The multiuse communication system 100 optionally can require each other system user 200 to accept an invitation to the support network of the first system user 210.

Turning to FIG. 25A, for example, the personal profile page 400 is shown as supporting a support network page 1500. The exemplary support network page 1500 of FIG. 25A can include support network content for a first system user 210 who comprises a peer first user 212. The personal profile page 400, for instance, can include navigation indicia 1502, such as one or more tabs, one or more folders and/or one or more icons, for enabling the first system user 210 to access the support network page 1500 and associated support network content available via the multiuse communication system 100. The support network page 1500 is shown in FIG. 25A as including a search feature 1504 by which the first system user 210 can enter discussion topic information and/or name or other information about another system user 200 who might be a potential supporter of the first system user 210. In selected embodiments, the support network page 1500 can present a trending topic listing 1506 with one or more trending discussion topics and/or a suggested supporter listing 1508 of one or more suggested system users 1510 who might support the first system user 210.

The suggested supporter listing 1508 can include selected information about each of the suggested system users 1510. The selected information can include, but is not limited to, a user name 1511 of the suggested supporting user 1510, a user image 1512 of the suggested supporting user 1510 and/or a user category 1513 of the suggested supporting user 1510. In selected embodiments, the user category 1513 of the suggested supporting user 1510 can comprise a user category associated with a preselected discussion topic in the manner discussed in more detail herein. The selected information about the suggested supporting user 1510 optionally can include biographical, narrative and/or other demographic information 1514 of the suggested supporting user 1510, user review information 1515 for the suggested supporting user 1510, relevant discussion topic information 1516 for the suggested supporting user 1510 and/or contact information 1517 for the suggested supporting user 1510, without limitation. Exemplary contact information 1517 can include cost information for interacting with the suggested supporting user 1510 and/or available interaction media, such as a telephone call 1517A, a chat 1517B and/or a videoconference.

The suggested supporter listing 1508 can be based upon a discussion topic that might be of interest to the first system user 210 and/or a discussion topic searched via the search feature 1504. The suggested supporting users 1510 associated with the suggested supporter listing 1508 can be arranged in any suitable order or other configuration. In selected embodiments, the suggested supporting users 1510 can be sorted based upon a popularity, a review rating or availability of the suggested supporting users 1510, without limitation. As shown in FIG. 25A, the suggested supporter listing 1508 can include filtering indicia 1509 by which the first system user 210 can focus or otherwise narrow the suggested supporter listing 1508. The filtering indicia 1509, for example, can comprise one or more user category filters 1509A-C and/or other suggested supporter filters 1509D. Peer user category filter 1509A can be utilized to narrow the suggested supporter listing 1508 to include only suggested supporting users 1510 who identify as peer system users 222 that are experiencing the same issue as the first system user 210 and/or have an interest in the discussion topic provided by the first system user 210 and wants to share ideas and exchange mutual support.

Volunteer user category filter 1509B can be utilized to narrow the suggested supporter listing 1508 to include only suggested supporting users 1510 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1509C can be utilized to narrow the suggested supporter listing 1508 to include only suggested supporting users 1510 who comprise professional system users who are experts in the discussion topic, offer paid listing services and/or are available for professional consultations. Although FIG. 25A shows selected user category filters 1509A-C as including a peer user category filter 1509A, a volunteer user category filter 1509B and a professional user category filter 1509C for purposes of illustration only, the support network page 1500 can include user category filters 1509A-C for any of the user categories discussed herein.

The suggested supporter filters 1509D can comprise any suitable filters for focusing or otherwise narrowing the suggested supporter listing 1508. Turning to FIG. 25B, for example, the suggested supporter filters 1509D can include, but are not limited to, a first supporter filter 1521 based upon an availability of the suggested supporting users 1510, a second supporter filter 1522 based upon reviews of the suggested supporting users 1510, a third supporter filter 1523 based upon a price the suggested supporting users 1510, a fourth supporter filter 1524 based upon type of service provided by the suggested supporting users 1510, a fifth supporter filter 1525 based upon a gender of the suggested supporting users 1510 and/or a sixth supporter filter 1526 based upon a sexual orientation of the suggested supporting users 1510.

FIG. 25C shows that exemplary first supporter filters 1521 can be utilized, at 1521A, to present all of the suggested supporting users 1510 included in the suggested supporter listing 1508. The first supporter filters 1521 alternatively can be utilized to narrow the suggested supporter listing 1508 to include only suggested supporting users 1510 who are available to online, at 1521B, to include only suggested supporting users 1510 who are busy, at 1521C, and/or to include only suggested supporting users 1510 who are available to offline, at 1521D. Turning to FIG. 25D, the second supporter filter 1522 is shown as being configured to narrow the suggested supporter listing 1508 to include only suggested supporting users 1510 who have the highest review score, at 1522A, to include only suggested supporting users 1510 who have the lowest review score, at 1522B, and/or to include only suggested supporting users 1510 who have a maximum review score, at 1522C.

Additionally and/or alternatively, the third supporter filter 1523 illustrated in FIG. 25E enables the suggested supporter listing 1508 to be narrowed to include only suggested supporting users 1510 who have a price between a minimum price amount 1523A and a maximum price amount 1523B. The price can comprise a price rate, a total price for a selected interaction, or any other conventional pricing system or manner. Turning to FIG. 25F, the fourth supporter filter 1524 can narrow the suggested supporter listing 1508 to include only suggested supporting users 1510 who support all communication media 1524A, who support only telephonic communication media 1524B, who support only videoconference communication media 1524C and/or who support only internet chat communication media 1524D, without limitation.

As set forth above, the fifth supporter filter 1525 can narrow the suggested supporter listing 1508 based upon a gender of the suggested supporting users 1510. The fifth supporter filter 1525, for example, can enable the suggested supporter listing 1508 include suggested supporting users 1510 of all genders, at 1525A, as illustrated in FIG. 25G. Alternatively, the fifth supporter filter 1525 can narrow the suggested supporter listing 1508 to include only suggested supporting users 1510 who are female, at 1525B, to include only suggested supporting users 1510 who are male, at 1525C, to include only suggested supporting users 1510 who are transgender, at 1525C, and/or to include only suggested supporting users 1510 who are non-binary, at 1525D, without limitation.

The sixth supporter filter 1526 can narrow the suggested supporter listing 1508 based upon a sexual orientation of the suggested supporting users 1510. As shown in FIG. 25H, the sixth supporter filter 1526, for example, can enable the suggested supporter listing 1508 include suggested supporting users 1510 of all sexual orientations, at 1526A. In selected embodiments, the sixth supporter filter 1526 alternatively can narrow the suggested supporter listing 1508 to include only suggested supporting users 1510 who are heterosexual, at 1526B, to include only suggested supporting users 1510 who are homosexual, at 1526C, to include only suggested supporting users 1510 who are bisexual, at 1526C, and/or to include only suggested supporting users 1510 who are asexual, at 1526D, without limitation.

As illustrated in FIG. 25I, the support network page 1500 can enable the first system user 210 to select at least one of the suggested supporting users 1510 included in the suggested supporter listing 1508. The first system user 210, at 1520A, can share a supporter profile 1510X of the selected suggested supporting user 1510. Additionally and/or alternatively, the first system user 210, at 1520B, can report the supporter profile 1510X of the selected suggested supporting user 1510 as shown in FIGS. 25J-L.

Turning to FIG. 25J, the support network page 1500 can enable the first system user 210 to report the supporter profile 1510X, for example, for including nudity or sexual content, violent content, hate speech content, terrorism content, fake news content, spamming or trolling content and/or copyright or sensitive data content, without limitation. The first system user 210 optionally can report the supporter profile 1510X if the selected suggested supporting user 1510 has multiplied the supporter profile 1510X too many times and/or if urgent help is needed. The support network page 1500 can receive the report from the first system user 210, at 1520C, and permit the first system user 210 to block the supporter profile 1510 from one or more user profiles associated with the first system user 210 as shown in FIG. 25K. Blocking confirmation can be provided, at 1520D, as illustrated in FIG. 25L.

In selected embodiments, the support network page 1500 can present one or more useful telephone numbers, at 1530, as shown in FIG. 25M. Exemplary useful telephone numbers can include, but are not limited to, a telephone number for police assistance, a telephone number for fire fighters, a telephone number for a women helpline and/or a telephone number for a child helpline The support network page 1500 optionally can enable the first system user 210 to search among available support groups and/or to suggest a support group, without limitation.

Turning to FIG. 25N, the support network page 1500 can enable the first system user 210 to narrow the suggested supporter listing 1508 to include only suggested supporting users 1510 for a selected discussion topic 1541. The first system user 210 optionally can add the supporter profile 1510X of the selected suggested supporting user 1510 to a group of favorites, at 1540. In selected embodiments, the support network page 1500 can present one or more related discussion topics 1545 that are related to the selected discussion topic 1541.

The support network page 1500 of FIG. 25O is shown as enabling the first system user 210 to submit one or more topic settings 1542 via the support network page 1500. The support network page 1500, for example, can permit the first system user 210 to share the supporter profile 1510X in a link, at 1544, to send request notifications, at 1546, and/or to report the selected discussion topic 1541, at 1548, without limitation. The support network page 1500 can permit the first system user 210 to share the supporter profile 1510X in a link, at 1544, in any suitable manner as illustrated in FIG. 25P. The support network page 1500, for example, can permit the first system user 210 to share the supporter profile 1510X via a post on Facebook, at 1544A, via a tweet on Twitter, at 1544B, and/or by copying a Uniform Resource Locator (or URL) for the supporter profile 1510X, at 1544C, without limitation.

Additionally and/or alternatively, the support network page 1500 can be configured to send request notifications, at 1546, in any suitable manner. Turning to FIG. 25Q, for instance, the support network page 1500 is illustrated as being configured to send request notifications, at 1546, by notifying the first system user 210 as soon as a suggested supporting user 1510 becomes available, at 1546A, by notifying the first system user 210 as soon as a new support group becomes available, at 1546B, and/or by sending a newsletter relevant to the selected discussion topic 1541 to the first system user 210, at 1546C, without limitation. The support network page 1500 likewise can be configured to enable the first system user 210 to report the selected discussion topic 1541, at 1548, in any suitable manner. As shown in FIG. 25R, the support network page 1500 can enable the first system user 210 to report the selected discussion topic 1541, at 1548, for including nudity or sexual content 1548A, violent content 1548B, hate speech content 1548C, terrorism content 1548D, fake news content 1548E, spamming or trolling content 1548F and/or copyright or sensitive data content 1548, without limitation.

The support network page 1500 advantageously can present a my support network page 1600 for the first system user 210. Whereas the support network page 1500 can comprise a public page that can be made available for viewing by other system users 200, the my support network page 1600 preferably is a private page that is accessible only by the first system user 210 and can be developed for each user category (or role) assumed by the first system user 210. An exemplary my support network page 1600 is shown in FIGS. 25S-Y. Turning to FIG. 25S, the my support network page 1600 can include navigation indicia 1605 for accessing one or more subpages of the my support network page 1600. The subpages can include, but are not limited to, a supporters subpage 1605A, a supporting subpage 1605B, a following subpage 1605C, a topics subpage 1605D and/or a supporter subpage 1605E.

The supporters subpage 1605A can comprise a supporter listing 1601 of one or more supporting system users 1602 who support the first system user 210. The supporter listing 1601 can include selected information about each of the supporting system users 1602. The selected information can include, but is not limited to, a user name 1602A of the supporting system user 1602, a user image 1602B of the supporting system user 1602 and/or a user category 1602C of the supporting system user 1602. In selected embodiments, the user category 1602C of the supporting system user 1602 can comprise a user category associated with a preselected discussion topic in the manner discussed in more detail herein. The selected information about the supporting system user 1602 optionally can include biographical, narrative and/or other demographic information 1602D of the supporting system user 1602, user review information for the supporting system user 1602, relevant discussion topic information for the supporting system user 1602 and/or contact information for the supporting system user 1602, without limitation. Exemplary contact information can include cost information for interacting with the supporting system user 1602, an availability 1602F of the supporting system user 1602 and/or available interaction media, such as a telephone call, a chat 1602G and/or a videoconference.

As shown in FIG. 25S, the supporters subpage 1605A can include a search feature 1604 by which the first system user 210 can enter discussion topic information and/or name or other information about a supporting system user 1602 of the first system user 210. The supporter listing 1601 can be based upon a discussion topic that might be of interest to the first system user 210 and/or a discussion topic searched via the search feature 1604. The supporting system users 1602 associated with the supporter listing 1601 can be arranged in any suitable order or other configuration. In selected embodiments, the supporting system users 1602 can be sorted based upon a popularity, a review rating or availability of the supporting system users 1602, without limitation.

As shown in FIG. 25S, the supporter listing 1601 can include filtering indicia 1609 by which the first system user 210 can focus or otherwise narrow the supporter listing 1601. The filtering indicia 1609, for example, can comprise one or more user category filters 1609A-C and/or other supporter filters 1609D. Peer user category filter 1609A can be utilized to narrow the supporter listing 1601 to include only supporting system users 1602 who identify as peer system users 222 that are experiencing the same issue as the first system user 210 and/or have an interest in the discussion topic provided by the first system user 210 and wants to share ideas and exchange mutual support.

Volunteer user category filter 1609B can be utilized to narrow the supporter listing 1601 to include only supporting system users 1602 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1609C can be utilized to narrow the supporter listing 1601 to include only supporting system users 1602 who comprise professional system users who are experts in the discussion topic, offer paid listing services and/or are available for professional consultations. Although FIG. 25S shows selected user category filters 1609A-C as including a peer user category filter 1609A, a volunteer user category filter 1609B and a professional user category filter 1609C for purposes of illustration only, the support network page 1600 can include user category filters 1609A-C for any of the user categories discussed herein.

The supporter filters 1609D can comprise any suitable filters for focusing or otherwise narrowing the supporter listing 1601. Exemplary supporter filters 1609D can include, but are not limited to, a first supporter filter based upon an availability of the supporting system users 1602, a second supporter filter based upon reviews of the supporting system users 1602, a third supporter filter based upon a price the supporting system users 1602, a fourth supporter filter based upon type of service provided by the supporting system users 1602, a fifth supporter filter based upon a gender of the supporting system users 1602 and/or a sixth supporter filter based upon a sexual orientation of the supporting system users 1602.

Turning to FIG. 25T, the supporting subpage 1605B can comprise a supported listing 1611 of one or more supported system users 1612 who are supported by the first system user 210. The supported listing 1611 can include selected information about each of the supported system users 1612. The selected information can include, but is not limited to, a user name 1612A of the supported system user 1612, a user image 1612B of the supported system user 1612 and/or a user category 1612C of the supported system user 1612. In selected embodiments, the user category 1612C of the supported system user 1612 can comprise a user category associated with a preselected discussion topic in the manner discussed in more detail herein.

The selected information about the supported system user 1612 optionally can include biographical, narrative and/or other demographic information 1612D of the supported system user 1612, user review information for the supported system user 1612, relevant discussion topic information for the supported system user 1612, contact information 1612E for the supported system user 1612 and/or other information or options 1612F for the supported system user 1612, without limitation. Exemplary contact information 1612E can include an availability of the supported system user 1612 and/or available interaction media, such as a telephone call, a chat and/or a videoconference. In selected embodiments, the first system user 210 can elect to accept and/or reject one or more of the supported system users 1612.

As shown in FIG. 25T, the supporting subpage 1605B can include a search feature 1614 by which the first system user 210 can enter discussion topic information and/or name or other information about a supported system user 1612 of the first system user 210. The supported listing 1611 can be based upon a discussion topic that might be of interest to the first system user 210 and/or a discussion topic searched via the search feature 1614. The supported system users 1612 associated with the supported listing 1611 can be arranged in any suitable order or other configuration. In selected embodiments, the supported system users 1612 can be sorted based upon a popularity, a review rating or availability of the supported system users 1612, without limitation.

As shown in FIG. 25T, the supported listing 1611 can include filtering indicia 1619 by which the first system user 210 can focus or otherwise narrow the supported listing 1611. The filtering indicia 1619, for example, can comprise one or more user category filters 1619A-C and/or other supporter filters 1619D. Peer user category filter 1619A can be utilized to narrow the supported listing 1611 to include only supported system users 1612 who identify as peer system users 222 that are experiencing the same issue as the first system user 210 and/or have an interest in the discussion topic provided by the first system user 210 and wants to share ideas and exchange mutual support.

Volunteer user category filter 1619B can be utilized to narrow the supported listing 1611 to include only supported system users 1612 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1619C can be utilized to narrow the supported listing 1611 to include only supported system users 1612 who comprise professional system users who are experts in the discussion topic, offer paid listing services and/or are available for professional consultations. Although FIG. 25T shows selected user category filters 1619A-C as including a peer user category filter 1619A, a volunteer user category filter 1619B and a professional user category filter 1619C for purposes of illustration only, the support network page 1600 can include user category filters 1619A-C for any of the user categories discussed herein.

The supporter filters 1619D can comprise any suitable filters for focusing or otherwise narrowing the supported listing 1611. Exemplary supporter filters 1619D can include, but are not limited to, a first supporter filter based upon an availability of the supported system users 1612, a second supporter filter based upon reviews of the supported system users 1612, a third supporter filter based upon a gender of the supported system users 1612 and/or a fourth supporter filter based upon a sexual orientation of the supported system users 1612.

The following subpage 1605C of FIG. 25U can comprise a followed user listing 1621 of one or more followed system users 1622 who are followed by the first system user 210. The followed user listing 1621 can include selected information about each of the followed system users 1622. The selected information can include, but is not limited to, a user name 1622A of the followed system user 1622, a user image 1622B of the followed system user 1622 and/or a user category 1622C of the followed system user 1622.

In selected embodiments, the user category 1622C of the followed system user 1622 can comprise a user category associated with a preselected discussion topic in the manner discussed in more detail herein. The selected information about the followed system user 1622 optionally can include biographical, narrative and/or other demographic information 1622D of the followed system user 1622, user review information for the followed system user 1622, relevant discussion topic information for the followed system user 1622 and/or contact information for the followed system user 1622, without limitation. Exemplary contact information can include an availability of the followed system user 1622 and/or available interaction media, such as a telephone call 1622F, a chat 1622G and/or a videoconference.

As shown in FIG. 25U, the following subpage 1605C can include a search feature 1624 by which the first system user 210 can enter discussion topic information and/or name or other information about a followed system user 1622 of the first system user 210. The followed user listing 1621 can be based upon a discussion topic that might be of interest to the first system user 210 and/or a discussion topic searched via the search feature 1624. The followed system users 1622 associated with the followed user listing 1621 can be arranged in any suitable order or other configuration. In selected embodiments, the followed system users 1622 can be sorted based upon a popularity, a review rating or availability of the followed system users 1622, without limitation.

As shown in FIG. 25U, the followed user listing 1621 can include filtering indicia 1629 by which the first system user 210 can focus or otherwise narrow the followed user listing 1621. The filtering indicia 1629, for example, can comprise one or more user category filters 1629A-C and/or other supporter filters 1629D. Peer user category filter 1629A can be utilized to narrow the followed user listing 1621 to include only followed system users 1622 who identify as peer system users 222 that are experiencing the same issue as the first system user 210 and/or have an interest in the discussion topic provided by the first system user 210 and wants to share ideas and exchange mutual support.

Volunteer user category filter 1629B can be utilized to narrow the followed user listing 1621 to include only followed system users 1622 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1629C can be utilized to narrow the followed user listing 1621 to include only followed system users 1622 who comprise professional system users who are experts in the discussion topic, offer paid listing services and/or are available for professional consultations. Although FIG. 25U shows selected user category filters 1629A-C as including a peer user category filter 1629A, a volunteer user category filter 1629B and a professional user category filter 1629C for purposes of illustration only, the support network page 1600 can include user category filters 1629A-C for any of the user categories discussed herein.

The supporter filters 1629D can comprise any suitable filters for focusing or otherwise narrowing the followed user listing 1621. Exemplary supporter filters 1629D can include, but are not limited to, a first supporter filter based upon an availability of the followed system users 1622, a second supporter filter based upon reviews of the followed system users 1622, a third supporter filter based upon a price the followed system users 1622, a fourth supporter filter based upon type of service provided by the followed system users 1622, a fifth supporter filter based upon a gender of the followed system users 1622 and/or a sixth supporter filter based upon a sexual orientation of the followed system users 1622.

Turning to FIG. 25V, the topics subpage 1605D can comprise a topical listing 1631 of one or more system users 1632 who have indicated an interest in selected discussion topics 1632B. The topical listing 1631 can include selected information about each of the system users 1632. The selected information can include, but is not limited to, a user name, a user image 1632A and/or a user category of the supporting system user 1632. As shown in FIG. 25V, the topics subpage 1605D can include a search feature 1634 by which the first system user 210 can enter discussion topic information and/or name or other information about a supporting system user 1632 of the first system user 210. The topical listing 1631 can be based upon a discussion topic that might be of interest to the first system user 210 and/or a discussion topic searched via the search feature 1634. The system users 1632 associated with the topical listing 1631 can be arranged by discussion topic 1632B.

As shown in FIG. 25V, the topical listing 1631 can include filtering indicia 1639 by which the first system user 210 can focus or otherwise narrow the topical listing 1631. The filtering indicia 1639, for example, can comprise one or more user category filters 1639A-C and/or other supporter filters 1639D. Peer user category filter 1639A can be utilized to narrow the topical listing 1631 to include only system users 1632 who identify as peer system users 222 that are experiencing the same issue as the first system user 210 and/or have an interest in the discussion topic provided by the first system user 210 and wants to share ideas and exchange mutual support.

Volunteer user category filter 1639B can be utilized to narrow the topical listing 1631 to include only system users 1632 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1639C can be utilized to narrow the topical listing 1631 to include only system users 1632 who comprise professional system users who are experts in the discussion topic, offer paid listing services and/or are available for professional consultations. Although FIG. 25V shows selected user category filters 1639A-C as including a peer user category filter 1639A, a volunteer user category filter 1639B and a professional user category filter 1639C for purposes of illustration only, the support network page 1600 can include user category filters 1639A-C for any of the user categories discussed herein.

The supporter filters 1639D can comprise any suitable filters for focusing or otherwise narrowing the topical listing 1631. Exemplary supporter filters 1639D can include, but are not limited to, a first supporter filter based upon an availability of the system users 1632, a second supporter filter based upon reviews of the system users 1632, a third supporter filter based upon a price the system users 1632, a fourth supporter filter based upon type of service provided by the system users 1632, a fifth supporter filter based upon a gender of the system users 1632 and/or a sixth supporter filter based upon a sexual orientation of the system users 1632.

The my support network page 1600 advantageously can enable the first system user 210 to select at least one of the discussion topic 1632B included in the topical listing 1631. Upon selection of the discussion topic 1632B, the my support network page 1600 can present the selected information about each of the system users 1632 associated with the selected discussion topic 1632B. The first system user 210 thereby can be permitted to contact one or more of the system users 1632 to discuss the selected discussion topic 1632B.

The supporter subpage 1605E is shown in FIG. 25W as comprising a user profile listing 1641 of each user profile 1642 associated with the first system user 210 when supporting other system users 200. Turning to FIG. 25W, the user profile listing 1641 can include selected information about each of the user profiles 1642. The selected information can include, but is not limited to, a user name 1642A of the user profile 1642, a user image 1642B of the user profile 1642 and/or a user category 1642C of the user profile 1642. In selected embodiments, the user category 1642C of the user profile 1642 can comprise a user category associated with a preselected discussion topic in the manner discussed in more detail herein.

The selected information about the user profile 1642 optionally can include biographical, narrative and/or other demographic information, user review information, relevant discussion topic information 1642D and/or contact information for the user profile 1642, without limitation. Exemplary contact information can include cost information, an availability 1642E of the first system user 210 and/or available interaction media, such as a telephone call, a chat 1642F and/or a videoconference. The supporter subpage 1605E optionally can enable the first system user 210 to control, at 1650, selected aspects of each user profile 1642. The first system user 210, for example, can be permitted to control, at 1652, a manner in which the user profile 1642 is presented in the support network page 1500 of other system users 200. Additionally and/or alternatively, the supporter subpage 1605E can enable the first system user 210 to control whether the first system user 210 is willing to participate in telephone calls 1654, videoconferences 1656 and/or internet chats 1658, without limitation.

As illustrated in FIG. 25X, the support network page 1500 optionally can enable the first system user 210 to adjust one or more support network settings 1660. The first system user 210 likewise can be permitted to view all user profiles 1670 associated with the first system user 210 and/or to create a new user profile 1672 as shown in FIG. 25Y.

The personal profile page 400 of FIG. 26A is shown as supporting a support network page 1700. The exemplary support network page 1700 of FIG. 26A can include support network content for a first system user 210 who comprises a volunteer first user 214. The personal profile page 400, for instance, can include navigation indicia 1702, such as one or more tabs, one or more folders and/or one or more icons, for enabling the first system user 210 to access the support network page 1700 and associated support network content available via the multiuse communication system 100. The support network page 1700 is shown in FIG. 26A as including a search feature 1704 by which the first system user 210 can enter discussion topic information and/or name or other information about another system user 200 who might be a potential supporter of the first system user 210. The multiuse communication system 100 can prevent the first system user 210 who comprises a volunteer first user 214 from connecting with other system users 200 who comprise peer second users 222 in the manner discussed in more detail herein with reference to FIGS. 24A-B. In selected embodiments, the support network page 1700 can present a trending topic listing 1706 with one or more trending discussion topics and/or a suggested supporter listing 1708 of one or more suggested system users 1710 who might support the first system user 210.

The suggested supporter listing 1708 can include selected information about each of the suggested system users 1710. The selected information can include, but is not limited to, a user name 1711 of the suggested supporting user 1710, a user image 1712 of the suggested supporting user 1710 and/or a user category 1713 of the suggested supporting user 1710. In selected embodiments, the user category 1713 of the suggested supporting user 1710 can comprise a user category associated with a preselected discussion topic in the manner discussed in more detail herein. The selected information about the suggested supporting user 1710 optionally can include biographical, narrative and/or other demographic information 1714 of the suggested supporting user 1710, user review information 1715 for the suggested supporting user 1710, relevant discussion topic information 1716 for the suggested supporting user 1710 and/or contact information 1717 for the suggested supporting user 1710, without limitation. Exemplary contact information 1717 can include cost information for interacting with the suggested supporting user 1710 and/or available interaction media, such as a telephone call, a chat and/or a videoconference.

The suggested supporter listing 1708 can be based upon a discussion topic that might be of interest to the first system user 210 and/or a discussion topic searched via the search feature 1704. The suggested supporting users 1710 associated with the suggested supporter listing 1708 can be arranged in any suitable order or other configuration. In selected embodiments, the suggested supporting users 1710 can be sorted based upon a popularity, a review rating or availability of the suggested supporting users 1710, without limitation. As shown in FIG. 26A, the suggested supporter listing 1708 can include filtering indicia 1709 by which the first system user 210 can focus or otherwise narrow the suggested supporter listing 1708. The filtering indicia 1709, for example, can comprise one or more user category filters 1709A-C and/or other suggested supporter filters 1709D. Peer user category filter 1709A can be utilized to narrow the suggested supporter listing 1708 to include only suggested supporting users 1710 who identify as peer system users 222 that are experiencing the same issue as the first system user 210 and/or have an interest in the discussion topic provided by the first system user 210 and wants to share ideas and exchange mutual support.

Volunteer user category filter 1709B can be utilized to narrow the suggested supporter listing 1708 to include only suggested supporting users 1710 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1709C can be utilized to narrow the suggested supporter listing 1708 to include only suggested supporting users 1710 who comprise professional system users who are experts in the discussion topic, offer paid listing services and/or are available for professional consultations. Although FIG. 26A shows selected user category filters 1709A-C as including a peer user category filter 1709A, a volunteer user category filter 1709B and a professional user category filter 1709C for purposes of illustration only, the support network page 1700 can include user category filters 1709A-C for any of the user categories discussed herein.

The suggested supporter filters 1709D can comprise any suitable filters for focusing or otherwise narrowing the suggested supporter listing 1708. Turning to FIG. 26B, for example, the suggested supporter filters 1709D can include, but are not limited to, a first supporter filter 1721 based upon an availability of the suggested supporting users 1710, a second supporter filter 1722 based upon reviews of the suggested supporting users 1710, a third supporter filter 1723 based upon a price the suggested supporting users 1710, a fourth supporter filter 1724 based upon type of service provided by the suggested supporting users 1710, a fifth supporter filter 1725 based upon a gender of the suggested supporting users 1710 and/or a sixth supporter filter 1726 based upon a sexual orientation of the suggested supporting users 1710.

FIG. 26C shows that exemplary first supporter filters 1721 can be utilized, at 1721A, to present all of the suggested supporting users 1710 included in the suggested supporter listing 1708. The first supporter filters 1721 alternatively can be utilized to narrow the suggested supporter listing 1708 to include only suggested supporting users 1710 who are available to online, at 1721B, to include only suggested supporting users 1710 who are busy, at 1721C, and/or to include only suggested supporting users 1710 who are available to offline, at 1721D. Turning to FIG. 26D, the second supporter filter 1722 is shown as being configured to narrow the suggested supporter listing 1708 to include only suggested supporting users 1710 who have the highest review score, at 1722A, to include only suggested supporting users 1710 who have the lowest review score, at 1722B, and/or to include only suggested supporting users 1710 who have a maximum review score, at 1722C.

Additionally and/or alternatively, the third supporter filter 1723 illustrated in FIG. 26E enables the suggested supporter listing 1708 to be narrowed to include only suggested supporting users 1710 who have a price between a minimum price amount 1723A and a maximum price amount 1723B. The price can comprise a price rate, a total price for a selected interaction, or any other conventional pricing system or manner. Turning to FIG. 26F, the fourth supporter filter 1724 can narrow the suggested supporter listing 1708 to include only suggested supporting users 1710 who support all communication media 1724A, who support only telephonic communication media 1724B, who support only videoconference communication media 1724C and/or who support only internet chat communication media 1724D, without limitation.

As set forth above, the fifth supporter filter 1725 can narrow the suggested supporter listing 1708 based upon a gender of the suggested supporting users 1710. The fifth supporter filter 1725, for example, can enable the suggested supporter listing 1708 include suggested supporting users 1710 of all genders, at 1725A, as illustrated in FIG. 26G. Alternatively, the fifth supporter filter 1725 can narrow the suggested supporter listing 1708 to include only suggested supporting users 1710 who are female, at 1725B, to include only suggested supporting users 1710 who are male, at 1725C, to include only suggested supporting users 1710 who are transgender, at 1725C, and/or to include only suggested supporting users 1710 who are non-binary, at 1725D, without limitation.

The sixth supporter filter 1726 can narrow the suggested supporter listing 1708 based upon a sexual orientation of the suggested supporting users 1710. As shown in FIG. 26H, the sixth supporter filter 1726, for example, can enable the suggested supporter listing 1708 include suggested supporting users 1710 of all sexual orientations, at 1726A. In selected embodiments, the sixth supporter filter 1726 alternatively can narrow the suggested supporter listing 1708 to include only suggested supporting users 1710 who are heterosexual, at 1726B, to include only suggested supporting users 1710 who are homosexual, at 1726C, to include only suggested supporting users 1710 who are bisexual, at 1726C, and/or to include only suggested supporting users 1710 who are asexual, at 1726D, without limitation.

As illustrated in FIG. 26I, the support network page 1700 can enable the first system user 210 to select at least one of the suggested supporting users 1710 included in the suggested supporter listing 1708. The first system user 210, at 1720A, can visit a supporter profile 1710X of the selected suggested supporting user 1710, can add the selected suggested supporting user 1710 to the user profile of the first system user 210 and/or can share the supporter profile 1710X of the selected suggested supporting user 1710. The first system user 210 optionally can report the supporter profile 1710X.

For example, the first system user 210, at 1720B, can report the supporter profile 1710X of the selected suggested supporting user 1710 as shown in FIGS. 26J-L. Turning to FIG. 26J, the support network page 1700 can enable the first system user 210 to report the supporter profile 1710X, for example, for including nudity or sexual content, violent content, hate speech content, terrorism content, fake news content, spamming or trolling content and/or copyright or sensitive data content, without limitation. The first system user 210 optionally can report the supporter profile 1710X if the selected suggested supporting user 1710 has multiplied the supporter profile 1710X too many times and/or if urgent help is needed. The support network page 1700 can receive the report from the first system user 210, at 1720C, and permit the first system user 210 to block the supporter profile 1710 from one or more user profiles associated with the first system user 210 as shown in FIG. 26K. Blocking confirmation can be provided, at 1720D, as illustrated in FIG. 26L.

In selected embodiments, the support network page 1700 can present one or more useful telephone numbers, at 1730, as shown in FIG. 26M. Exemplary useful telephone numbers can include, but are not limited to, a telephone number for police assistance, a telephone number for fire fighters, a telephone number for a women helpline and/or a telephone number for a child helpline The support network page 1700 optionally can enable the first system user 210 to search among available support groups and/or to suggest a support group, without limitation.

Turning to FIG. 26N, the support network page 1700 can enable the first system user 210 to narrow the suggested supporter listing 1708 to include only suggested supporting users 1710 for a selected discussion topic 1741. The first system user 210 optionally can add the supporter profile 1710X of the selected suggested supporting user 1710 to a group of favorites, at 1740. In selected embodiments, the support network page 1700 can present one or more related discussion topics 1745 that are related to the selected discussion topic 1741.

The support network page 1700 of FIG. 25O is shown as enabling the first system user 210 to submit one or more topic settings 1742 via the support network page 1700. The support network page 1700, for example, can permit the first system user 210 to share the supporter profile 1710X in a link, at 1744, to send request notifications, at 1746, and/or to report the selected discussion topic 1741, at 1748, without limitation. The support network page 1700 can permit the first system user 210 to share the supporter profile 1710X in a link, at 1744, in any suitable manner as illustrated in FIG. 26P. The support network page 1700, for example, can permit the first system user 210 to share the supporter profile 1710X via a post on Facebook, at 1744A, via a tweet on Twitter, at 1744B, and/or by copying a Uniform Resource Locator (or URL) for the supporter profile 1710X, at 1744C, without limitation.

Additionally and/or alternatively, the support network page 1700 can be configured to send request notifications, at 1746, in any suitable manner. Turning to FIG. 26Q, for instance, the support network page 1700 is illustrated as being configured to send request notifications, at 1746, by notifying the first system user 210 as soon as a suggested supporting user 1710 becomes available, at 1746A, by notifying the first system user 210 as soon as a new support group becomes available, at 1746B, and/or by sending a newsletter relevant to the selected discussion topic 1741 to the first system user 210, at 1746C, without limitation. The support network page 1700 likewise can be configured to enable the first system user 210 to report the selected discussion topic 1741, at 1748, in any suitable manner. As shown in FIG. 26R, the support network page 1700 can enable the first system user 210 to report the selected discussion topic 1741, at 1748, for including nudity or sexual content 1748A, violent content 1748B, hate speech content 1748C, terrorism content 1748D, fake news content 1748E, spamming or trolling content 1748F and/or copyright or sensitive data content 1748, without limitation.

The support network page 1700 advantageously can present a my support network page 1800 for the first system user 210. Whereas the support network page 1700 can comprise a public page that can be made available for viewing by other system users 200, the my support network page 1800 preferably is a private page that is accessible only by the first system user 210 and can be developed for each user category (or role) assumed by the first system user 210. An exemplary my support network page 1800 is shown in FIGS. 26S-Y. Turning to FIG. 26S, the my support network page 1800 can include navigation indicia 1805 for accessing one or more subpages of the my support network page 1800. The subpages can include, but are not limited to, a supporters subpage 1805A, a supporting subpage 1805B, a following subpage 1805C, a topics subpage 1805D and/or a supporter subpage 1805E.

The supporters subpage 1805A can comprise a supporter listing 1801 of one or more supporting system users 1802 who support the first system user 210. The supporter listing 1801 can include selected information about each of the supporting system users 1802. The selected information can include, but is not limited to, a user name 1802A of the supporting system user 1802, a user image 1802B of the supporting system user 1802 and/or a user category 1802C of the supporting system user 1802. In selected embodiments, the user category 1802C of the supporting system user 1802 can comprise a user category associated with a preselected discussion topic in the manner discussed in more detail herein. The selected information about the supporting system user 1802 optionally can include biographical, narrative and/or other demographic information 1802D of the supporting system user 1802, user review information for the supporting system user 1802, relevant discussion topic information for the supporting system user 1802 and/or contact information for the supporting system user 1802, without limitation. Exemplary contact information can include cost information for interacting with the supporting system user 1802, an availability 1802F of the supporting system user 1802 and/or available interaction media, such as a telephone call, a chat 1802G and/or a videoconference.

As shown in FIG. 26S, the supporters subpage 1805A can include a search feature 1804 by which the first system user 210 can enter discussion topic information and/or name or other information about a supporting system user 1802 of the first system user 210. The supporter listing 1801 can be based upon a discussion topic that might be of interest to the first system user 210 and/or a discussion topic searched via the search feature 1804. The supporting system users 1802 associated with the supporter listing 1801 can be arranged in any suitable order or other configuration. In selected embodiments, the supporting system users 1802 can be sorted based upon a popularity, a review rating or availability of the supporting system users 1802, without limitation.

As shown in FIG. 26S, the supporter listing 1801 can include filtering indicia 1809 by which the first system user 210 can focus or otherwise narrow the supporter listing 1801. The filtering indicia 1809, for example, can comprise one or more user category filters 1809A-C and/or other supporter filters 1809D. Peer user category filter 1809A can be utilized to narrow the supporter listing 1801 to include only supporting system users 1802 who identify as peer system users 222 that are experiencing the same issue as the first system user 210 and/or have an interest in the discussion topic provided by the first system user 210 and wants to share ideas and exchange mutual support.

Volunteer user category filter 1809B can be utilized to narrow the supporter listing 1801 to include only supporting system users 1802 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1809C can be utilized to narrow the supporter listing 1801 to include only supporting system users 1802 who comprise professional system users who are experts in the discussion topic, offer paid listing services and/or are available for professional consultations. Although FIG. 26S shows selected user category filters 1809A-C as including a peer user category filter 1809A, a volunteer user category filter 1809B and a professional user category filter 1809C for purposes of illustration only, the support network page 1800 can include user category filters 1809A-C for any of the user categories discussed herein.

The supporter filters 1809D can comprise any suitable filters for focusing or otherwise narrowing the supporter listing 1801. Exemplary supporter filters 1809D can include, but are not limited to, a first supporter filter based upon an availability of the supporting system users 1802, a second supporter filter based upon reviews of the supporting system users 1802, a third supporter filter based upon a price the supporting system users 1802, a fourth supporter filter based upon type of service provided by the supporting system users 1802, a fifth supporter filter based upon a gender of the supporting system users 1802 and/or a sixth supporter filter based upon a sexual orientation of the supporting system users 1802.

Turning to FIG. 26T, the supporting subpage 1805B can comprise a supported listing 1811 of one or more supported system users 1812 who are supported by the first system user 210. The supported listing 1811 can include selected information about each of the supported system users 1812. The selected information can include, but is not limited to, a user name 1812A of the supported system user 1812, a user image 1812B of the supported system user 1812 and/or a user category 1812C of the supported system user 1812. In selected embodiments, the user category 1812C of the supported system user 1812 can comprise a user category associated with a preselected discussion topic in the manner discussed in more detail herein.

The selected information about the supported system user 1812 optionally can include biographical, narrative and/or other demographic information 1812D of the supported system user 1812, user review information for the supported system user 1812, relevant discussion topic information for the supported system user 1812, contact information 1812E for the supported system user 1812 and/or other information or options 1812F for the supported system user 1812, without limitation. Exemplary contact information 1812E can include an availability of the supported system user 1812 and/or available interaction media, such as a telephone call, a chat and/or a videoconference. In selected embodiments, the first system user 210 can elect to accept and/or reject one or more of the supported system users 1812.

As shown in FIG. 26T, the supporting subpage 1805B can include a search feature 1814 by which the first system user 210 can enter discussion topic information and/or name or other information about a supported system user 1812 of the first system user 210. The supported listing 1811 can be based upon a discussion topic that might be of interest to the first system user 210 and/or a discussion topic searched via the search feature 1814. The supported system users 1812 associated with the supported listing 1811 can be arranged in any suitable order or other configuration. In selected embodiments, the supported system users 1812 can be sorted based upon a popularity, a review rating or availability of the supported system users 1812, without limitation.

As shown in FIG. 26T, the supported listing 1811 can include filtering indicia 1819 by which the first system user 210 can focus or otherwise narrow the supported listing 1811. The filtering indicia 1819, for example, can comprise one or more user category filters 1819A-C and/or other supporter filters 1819D. Peer user category filter 1819A can be utilized to narrow the supported listing 1811 to include only supported system users 1812 who identify as peer system users 222 that are experiencing the same issue as the first system user 210 and/or have an interest in the discussion topic provided by the first system user 210 and wants to share ideas and exchange mutual support.

Volunteer user category filter 1819B can be utilized to narrow the supported listing 1811 to include only supported system users 1812 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1819C can be utilized to narrow the supported listing 1811 to include only supported system users 1812 who comprise professional system users who are experts in the discussion topic, offer paid listing services and/or are available for professional consultations. Although FIG. 26T shows selected user category filters 1819A-C as including a peer user category filter 1819A, a volunteer user category filter 1819B and a professional user category filter 1819C for purposes of illustration only, the support network page 1800 can include user category filters 1819A-C for any of the user categories discussed herein.

The supporter filters 1819D can comprise any suitable filters for focusing or otherwise narrowing the supported listing 1811. Exemplary supporter filters 1819D can include, but are not limited to, a first supporter filter based upon an availability of the supported system users 1812, a second supporter filter based upon reviews of the supported system users 1812, a third supporter filter based upon a gender of the supported system users 1812 and/or a fourth supporter filter based upon a sexual orientation of the supported system users 1812.

The following subpage 1805C of FIG. 26U can comprise a followed user listing 1821 of one or more followed system users 1822 who are followed by the first system user 210. The followed user listing 1821 can include selected information about each of the followed system users 1822. The selected information can include, but is not limited to, a user name 1822A of the followed system user 1822, a user image 1822B of the followed system user 1822 and/or a user category 1822C of the followed system user 1822.

In selected embodiments, the user category 1822C of the followed system user 1822 can comprise a user category associated with a preselected discussion topic in the manner discussed in more detail herein. The selected information about the followed system user 1822 optionally can include biographical, narrative and/or other demographic information 1822D of the followed system user 1822, user review information for the followed system user 1822, relevant discussion topic information for the followed system user 1822 and/or contact information for the followed system user 1822, without limitation. Exemplary contact information can include an availability of the followed system user 1822 and/or available interaction media, such as a telephone call 1822F, a chat 1822G and/or a videoconference.

As shown in FIG. 26U, the following subpage 1805C can include a search feature 1824 by which the first system user 210 can enter discussion topic information and/or name or other information about a followed system user 1822 of the first system user 210. The followed user listing 1821 can be based upon a discussion topic that might be of interest to the first system user 210 and/or a discussion topic searched via the search feature 1824. The followed system users 1822 associated with the followed user listing 1821 can be arranged in any suitable order or other configuration. In selected embodiments, the followed system users 1822 can be sorted based upon a popularity, a review rating or availability of the followed system users 1822, without limitation.

As shown in FIG. 26U, the followed user listing 1821 can include filtering indicia 1829 by which the first system user 210 can focus or otherwise narrow the followed user listing 1821. The filtering indicia 1829, for example, can comprise one or more user category filters 1829A-C and/or other supporter filters 1829D. Peer user category filter 1829A can be utilized to narrow the followed user listing 1821 to include only followed system users 1822 who identify as peer system users 222 that are experiencing the same issue as the first system user 210 and/or have an interest in the discussion topic provided by the first system user 210 and wants to share ideas and exchange mutual support.

Volunteer user category filter 1829B can be utilized to narrow the followed user listing 1821 to include only followed system users 1822 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1829C can be utilized to narrow the followed user listing 1821 to include only followed system users 1822 who comprise professional system users who are experts in the discussion topic, offer paid listing services and/or are available for professional consultations. Although FIG. 26U shows selected user category filters 1829A-C as including a peer user category filter 1829A, a volunteer user category filter 1829B and a professional user category filter 1829C for purposes of illustration only, the support network page 1800 can include user category filters 1829A-C for any of the user categories discussed herein.

The supporter filters 1829D can comprise any suitable filters for focusing or otherwise narrowing the followed user listing 1821. Exemplary supporter filters 1829D can include, but are not limited to, a first supporter filter based upon an availability of the followed system users 1822, a second supporter filter based upon reviews of the followed system users 1822, a third supporter filter based upon a price the followed system users 1822, a fourth supporter filter based upon type of service provided by the followed system users 1822, a fifth supporter filter based upon a gender of the followed system users 1822 and/or a sixth supporter filter based upon a sexual orientation of the followed system users 1822.

Turning to FIG. 26V, the topics subpage 1805D can comprise a topical listing 1831 of one or more system users 1832 who have indicated an interest in selected discussion topics 1832B. The topical listing 1831 can include selected information about each of the system users 1832. The selected information can include, but is not limited to, a user name, a user image 1832A and/or a user category of the supporting system user 1832. As shown in FIG. 26V, the topics subpage 1805D can include a search feature 1834 by which the first system user 210 can enter discussion topic information and/or name or other information about a supporting system user 1832 of the first system user 210. The topical listing 1831 can be based upon a discussion topic that might be of interest to the first system user 210 and/or a discussion topic searched via the search feature 1834. The system users 1832 associated with the topical listing 1831 can be arranged by discussion topic 1832B.

As shown in FIG. 26V, the topical listing 1831 can include filtering indicia 1839 by which the first system user 210 can focus or otherwise narrow the topical listing 1831. The filtering indicia 1839, for example, can comprise one or more user category filters 1839A-C and/or other supporter filters 1839D. Peer user category filter 1839A can be utilized to narrow the topical listing 1831 to include only system users 1832 who identify as peer system users 222 that are experiencing the same issue as the first system user 210 and/or have an interest in the discussion topic provided by the first system user 210 and wants to share ideas and exchange mutual support.

Volunteer user category filter 1839B can be utilized to narrow the topical listing 1831 to include only system users 1832 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1839C can be utilized to narrow the topical listing 1831 to include only system users 1832 who comprise professional system users who are experts in the discussion topic, offer paid listing services and/or are available for professional consultations. Although FIG. 26V shows selected user category filters 1839A-C as including a peer user category filter 1839A, a volunteer user category filter 1839B and a professional user category filter 1839C for purposes of illustration only, the support network page 1800 can include user category filters 1839A-C for any of the user categories discussed herein.

The supporter filters 1839D can comprise any suitable filters for focusing or otherwise narrowing the topical listing 1831. Exemplary supporter filters 1839D can include, but are not limited to, a first supporter filter based upon an availability of the system users 1832, a second supporter filter based upon reviews of the system users 1832, a third supporter filter based upon a price the system users 1832, a fourth supporter filter based upon type of service provided by the system users 1832, a fifth supporter filter based upon a gender of the system users 1832 and/or a sixth supporter filter based upon a sexual orientation of the system users 1832.

The my support network page 1800 advantageously can enable the first system user 210 to select at least one of the discussion topic 1832B included in the topical listing 1831. Upon selection of the discussion topic 1832B, the my support network page 1800 can present the selected information about each of the system users 1832 associated with the selected discussion topic 1832B. The first system user 210 thereby can be permitted to contact one or more of the system users 1832 to discuss the selected discussion topic 1832B.

The supporter subpage 1805E is shown in FIG. 26W as comprising a user profile listing 1841 of each user profile 1842 associated with the first system user 210 when supporting other system users 200. Turning to FIG. 26W, the user profile listing 1841 can include selected information about each of the user profiles 1842. The selected information can include, but is not limited to, a user name 1842A of the user profile 1842, a user image 1842B of the user profile 1842 and/or a user category 1842C of the user profile 1842. In selected embodiments, the user category 1842C of the user profile 1842 can comprise a user category associated with a preselected discussion topic in the manner discussed in more detail herein.

The selected information about the user profile 1842 optionally can include biographical, narrative and/or other demographic information, user review information, relevant discussion topic information 1842D and/or contact information for the user profile 1842, without limitation. Exemplary contact information can include cost information, an availability of the first system user 210 and/or available interaction media, such as a telephone call 1842E, a chat and/or a videoconference. The supporter subpage 1805E optionally can enable the first system user 210 to control, at 1850, selected aspects of each user profile 1842. The first system user 210, for example, can be permitted to control, at 1852, a manner in which the user profile 1842 is presented in the support network page 1700 of other system users 200. Additionally and/or alternatively, the supporter subpage 1805E can enable the first system user 210 to control whether the first system user 210 is willing to participate in telephone calls 1854, videoconferences 1856 and/or internet chats 1858, without limitation.

As illustrated in FIG. 26X, the support network page 1700 optionally can enable the first system user 210 to adjust one or more support network settings 1860. The first system user 210 likewise can be permitted to view all user profiles 1870 associated with the first system user 210 and/or to create a new user profile 1872 as shown in FIG. 26Y.

The personal profile page 400 of FIG. 27A is shown as supporting a support network page 1900. The exemplary support network page 1900 of FIG. 27A can include support network content for a first system user 210 who comprises a professional first user 211. The personal profile page 400, for instance, can include navigation indicia 1902, such as one or more tabs, one or more folders and/or one or more icons, for enabling the first system user 210 to access the support network page 1900 and associated support network content available via the multiuse communication system 100. The support network page 1900 is shown in FIG. 27A as including a search feature 1904 by which the first system user 210 can enter discussion topic information and/or name or other information about another system user 200 who might be a potential supporter of the first system user 210. The multiuse communication system 100 can prevent the first system user 210 who comprises a professional first user 211 from connecting with other system users 200 who comprise peer second users 222 in the manner discussed in more detail herein with reference to FIGS. 24A-B. In selected embodiments, the support network page 1900 can present a trending topic listing 1906 with one or more trending discussion topics and/or a suggested supporter listing 1908 of one or more suggested system users 1910 who might support the first system user 210.

The suggested supporter listing 1908 can include selected information about each of the suggested system users 1910. The selected information can include, but is not limited to, a user name 1911 of the suggested supporting user 1910, a user image 1912 of the suggested supporting user 1910 and/or a user category 1913 of the suggested supporting user 1910. In selected embodiments, the user category 1913 of the suggested supporting user 1910 can comprise a user category associated with a preselected discussion topic in the manner discussed in more detail herein. The selected information about the suggested supporting user 1910 optionally can include biographical, narrative and/or other demographic information 1914 of the suggested supporting user 1910, user review information 1915 for the suggested supporting user 1910, relevant discussion topic information 1916 for the suggested supporting user 1910 and/or contact information 1917 for the suggested supporting user 1910, without limitation. Exemplary contact information 1917 can include cost information for interacting with the suggested supporting user 1910 and/or available interaction media, such as a telephone call, a chat and/or a videoconference.

The suggested supporter listing 1908 can be based upon a discussion topic that might be of interest to the first system user 210 and/or a discussion topic searched via the search feature 1904. The suggested supporting users 1910 associated with the suggested supporter listing 1908 can be arranged in any suitable order or other configuration. In selected embodiments, the suggested supporting users 1910 can be sorted based upon a popularity, a review rating or availability of the suggested supporting users 1910, without limitation. As shown in FIG. 27A, the suggested supporter listing 1908 can include filtering indicia 1909 by which the first system user 210 can focus or otherwise narrow the suggested supporter listing 1908. The filtering indicia 1909, for example, can comprise one or more user category filters 1909A-C and/or other suggested supporter filters 1909D. Peer user category filter 1909A can be utilized to narrow the suggested supporter listing 1908 to include only suggested supporting users 1910 who identify as peer system users 222 that are experiencing the same issue as the first system user 210 and/or have an interest in the discussion topic provided by the first system user 210 and wants to share ideas and exchange mutual support.

Volunteer user category filter 1909B can be utilized to narrow the suggested supporter listing 1908 to include only suggested supporting users 1910 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 1909C can be utilized to narrow the suggested supporter listing 1908 to include only suggested supporting users 1910 who comprise professional system users who are experts in the discussion topic, offer paid listing services and/or are available for professional consultations. Although FIG. 27A shows selected user category filters 1909A-C as including a peer user category filter 1909A, a volunteer user category filter 1909B and a professional user category filter 1909C for purposes of illustration only, the support network page 1900 can include user category filters 1909A-C for any of the user categories discussed herein.

The suggested supporter filters 1909D can comprise any suitable filters for focusing or otherwise narrowing the suggested supporter listing 1908. Turning to FIG. 27B, for example, the suggested supporter filters 1909D can include, but are not limited to, a first supporter filter 1921 based upon an availability of the suggested supporting users 1910, a second supporter filter 1922 based upon reviews of the suggested supporting users 1910, a third supporter filter 1923 based upon a price the suggested supporting users 1910, a fourth supporter filter 1924 based upon type of service provided by the suggested supporting users 1910, a fifth supporter filter 1925 based upon a gender of the suggested supporting users 1910 and/or a sixth supporter filter 1926 based upon a sexual orientation of the suggested supporting users 1910.

FIG. 27C shows that exemplary first supporter filters 1921 can be utilized, at 1921A, to present all of the suggested supporting users 1910 included in the suggested supporter listing 1908. The first supporter filters 1921 alternatively can be utilized to narrow the suggested supporter listing 1908 to include only suggested supporting users 1910 who are available to online, at 1921B, to include only suggested supporting users 1910 who are busy, at 1921C, and/or to include only suggested supporting users 1910 who are available to offline, at 1921D. Turning to FIG. 27D, the second supporter filter 1922 is shown as being configured to narrow the suggested supporter listing 1908 to include only suggested supporting users 1910 who have the highest review score, at 1922A, to include only suggested supporting users 1910 who have the lowest review score, at 1922B, and/or to include only suggested supporting users 1910 who have a maximum review score, at 1922C.

Additionally and/or alternatively, the third supporter filter 1923 illustrated in FIG. 27E enables the suggested supporter listing 1908 to be narrowed to include only suggested supporting users 1910 who have a price between a minimum price amount 1923A and a maximum price amount 1923B. The price can comprise a price rate, a total price for a selected interaction, or any other conventional pricing system or manner. Turning to FIG. 27F, the fourth supporter filter 1924 can narrow the suggested supporter listing 1908 to include only suggested supporting users 1910 who support all communication media 1924A, who support only telephonic communication media 1924B, who support only videoconference communication media 1924C and/or who support only internet chat communication media 1924D, without limitation.

As set forth above, the fifth supporter filter 1925 can narrow the suggested supporter listing 1908 based upon a gender of the suggested supporting users 1910. The fifth supporter filter 1925, for example, can enable the suggested supporter listing 1908 include suggested supporting users 1910 of all genders, at 1925A, as illustrated in FIG. 27G. Alternatively, the fifth supporter filter 1925 can narrow the suggested supporter listing 1908 to include only suggested supporting users 1910 who are female, at 1925B, to include only suggested supporting users 1910 who are male, at 1925C, to include only suggested supporting users 1910 who are transgender, at 1925C, and/or to include only suggested supporting users 1910 who are non-binary, at 1925D, without limitation.

The sixth supporter filter 1926 can narrow the suggested supporter listing 1908 based upon a sexual orientation of the suggested supporting users 1910. As shown in FIG. 27H, the sixth supporter filter 1926, for example, can enable the suggested supporter listing 1908 include suggested supporting users 1910 of all sexual orientations, at 1926A. In selected embodiments, the sixth supporter filter 1926 alternatively can narrow the suggested supporter listing 1908 to include only suggested supporting users 1910 who are heterosexual, at 1926B, to include only suggested supporting users 1910 who are homosexual, at 1926C, to include only suggested supporting users 1910 who are bisexual, at 1926C, and/or to include only suggested supporting users 1910 who are asexual, at 1926D, without limitation.

The support network page 1900 of FIG. 27I is shown as enabling the first system user 210 to select at least one of the suggested supporting users 1910 included in the suggested supporter listing 1908. The first system user 210, at 1920A, can visit a supporter profile 1910X of the selected suggested supporting user 1910, can add the selected suggested supporting user 1910 to the user profile of the first system user 210 and/or can share the supporter profile 1910X of the selected suggested supporting user 1910.

As illustrated in FIG. 27J, the support network page 1900 can enable the first system user 210 to select at least one of the suggested supporting users 1910 included in the suggested supporter listing 1908. The first system user 210, at 1920X, can share the supporter profile 1910X of the selected suggested supporting user 1910.

The first system user 210 optionally can report the supporter profile 1910X. For example, the first system user 210, at 1920B, can report the supporter profile 1910X of the selected suggested supporting user 1910 as shown in FIGS. 27K-M. Turning to FIG. 27K, the support network page 1900 can enable the first system user 210 to report the supporter profile 1910X, for example, for including nudity or sexual content, violent content, hate speech content, terrorism content, fake news content, spamming or trolling content and/or copyright or sensitive data content, without limitation. The first system user 210 optionally can report the supporter profile 1910X if the selected suggested supporting user 1910 has multiplied the supporter profile 1910X too many times and/or if urgent help is needed. The support network page 1900 can receive the report from the first system user 210, at 1920C, and permit the first system user 210 to block the supporter profile 1910 from one or more user profiles associated with the first system user 210 as shown in FIG. 27L. Blocking confirmation can be provided, at 1920D, as illustrated in FIG. 27M.

In selected embodiments, the support network page 1900 can present one or more useful telephone numbers, at 1930, as shown in FIG. 27N. Exemplary useful telephone numbers can include, but are not limited to, a telephone number for police assistance, a telephone number for fire fighters, a telephone number for a women helpline and/or a telephone number for a child helpline The support network page 1900 optionally can enable the first system user 210 to search among available support groups and/or to suggest a support group, without limitation.

Turning to FIG. 27O, the support network page 1900 can enable the first system user 210 to narrow the suggested supporter listing 1908 to include only suggested supporting users 1910 for a selected discussion topic 1941. The first system user 210 optionally can add the supporter profile 1910X of the selected suggested supporting user 1910 to a group of favorites, at 1940. In selected embodiments, the support network page 1900 can present one or more related discussion topics 1945 that are related to the selected discussion topic 1941.

The support network page 1900 of FIG. 25P is shown as enabling the first system user 210 to submit one or more topic settings 1942 via the support network page 1900. The support network page 1900, for example, can permit the first system user 210 to share the supporter profile 1910X in a link, at 1944, to send request notifications, at 1946, and/or to report the selected discussion topic 1941, at 1948, without limitation. The support network page 1900 can permit the first system user 210 to share the supporter profile 1910X in a link, at 1944, in any suitable manner as illustrated in FIG. 27Q. The support network page 1900, for example, can permit the first system user 210 to share the supporter profile 1910X via a post on Facebook, at 1944A, via a tweet on Twitter, at 1944B, and/or by copying a Uniform Resource Locator (or URL) for the supporter profile 1910X, at 1944C, without limitation.

Additionally and/or alternatively, the support network page 1900 can be configured to send request notifications, at 1946, in any suitable manner. Turning to FIG. 27R, for instance, the support network page 1900 is illustrated as being configured to send request notifications, at 1946, by notifying the first system user 210 as soon as a suggested supporting user 1910 becomes available, at 1946A, by notifying the first system user 210 as soon as a new support group becomes available, at 1946B, and/or by sending a newsletter relevant to the selected discussion topic 1941 to the first system user 210, at 1946C, without limitation. The support network page 1900 likewise can be configured to enable the first system user 210 to report the selected discussion topic 1941, at 1948, in any suitable manner. As shown in FIG. 27S, the support network page 1900 can enable the first system user 210 to report the selected discussion topic 1941, at 1948, for including nudity or sexual content 1948A, violent content 1948B, hate speech content 1948C, terrorism content 1948D, fake news content 1948E, spamming or trolling content 1948F and/or copyright or sensitive data content 1948, without limitation.

The support network page 1900 advantageously can present a my support network page 2000 for the first system user 210. Whereas the support network page 1900 can comprise a public page that can be made available for viewing by other system users 200, the my support network page 2000 preferably is a private page that is accessible only by the first system user 210 and can be developed for each user category (or role) assumed by the first system user 210. An exemplary my support network page 2000 is shown in FIGS. 27T-Z. Turning to FIG. 27T, the my support network page 2000 can include navigation indicia 2005 for accessing one or more subpages of the my support network page 2000. The subpages can include, but are not limited to, a supporters subpage 2005A, a supporting subpage 2005B, a following subpage 2005C, a topics subpage 2005D and/or a supporter subpage 2005E.

The supporters subpage 2005A can comprise a supporter listing 2001 of one or more supporting system users 2002 who support the first system user 210. The supporter listing 2001 can include selected information about each of the supporting system users 2002. The selected information can include, but is not limited to, a user name 2002A of the supporting system user 2002, a user image 2002B of the supporting system user 2002 and/or a user category 2002C of the supporting system user 2002. In selected embodiments, the user category 2002C of the supporting system user 2002 can comprise a user category associated with a preselected discussion topic in the manner discussed in more detail herein. The selected information about the supporting system user 2002 optionally can include biographical, narrative and/or other demographic information 2002D of the supporting system user 2002, user review information for the supporting system user 2002, relevant discussion topic information for the supporting system user 2002 and/or contact information for the supporting system user 2002, without limitation. Exemplary contact information can include cost information for interacting with the supporting system user 2002, an availability 2002F of the supporting system user 2002 and/or available interaction media, such as a telephone call, a chat 2002G and/or a videoconference.

As shown in FIG. 27T, the supporters subpage 2005A can include a search feature 2004 by which the first system user 210 can enter discussion topic information and/or name or other information about a supporting system user 2002 of the first system user 210. The supporter listing 2001 can be based upon a discussion topic that might be of interest to the first system user 210 and/or a discussion topic searched via the search feature 2004. The supporting system users 2002 associated with the supporter listing 2001 can be arranged in any suitable order or other configuration. In selected embodiments, the supporting system users 2002 can be sorted based upon a popularity, a review rating or availability of the supporting system users 2002, without limitation.

As shown in FIG. 27T, the supporter listing 2001 can include filtering indicia 2009 by which the first system user 210 can focus or otherwise narrow the supporter listing 2001. The filtering indicia 2009, for example, can comprise one or more user category filters 2009A-C and/or other supporter filters 2009D. Peer user category filter 2009A can be utilized to narrow the supporter listing 2001 to include only supporting system users 2002 who identify as peer system users 222 that are experiencing the same issue as the first system user 210 and/or have an interest in the discussion topic provided by the first system user 210 and wants to share ideas and exchange mutual support.

Volunteer user category filter 2009B can be utilized to narrow the supporter listing 2001 to include only supporting system users 2002 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 2009C can be utilized to narrow the supporter listing 2001 to include only supporting system users 2002 who comprise professional system users who are experts in the discussion topic, offer paid listing services and/or are available for professional consultations. Although FIG. 27T shows selected user category filters 2009A-C as including a peer user category filter 2009A, a volunteer user category filter 2009B and a professional user category filter 2009C for purposes of illustration only, the support network page 2000 can include user category filters 2009A-C for any of the user categories discussed herein.

The supporter filters 2009D can comprise any suitable filters for focusing or otherwise narrowing the supporter listing 2001. Exemplary supporter filters 2009D can include, but are not limited to, a first supporter filter based upon an availability of the supporting system users 2002, a second supporter filter based upon reviews of the supporting system users 2002, a third supporter filter based upon a price the supporting system users 2002, a fourth supporter filter based upon type of service provided by the supporting system users 2002, a fifth supporter filter based upon a gender of the supporting system users 2002 and/or a sixth supporter filter based upon a sexual orientation of the supporting system users 2002.

Turning to FIG. 27U, the supporting subpage 2005B can comprise a supported listing 2011 of one or more supported system users 2012 who are supported by the first system user 210. The supported listing 2011 can include selected information about each of the supported system users 2012. The selected information can include, but is not limited to, a user name 2012A of the supported system user 2012, a user image 2012B of the supported system user 2012 and/or a user category 2012C of the supported system user 2012. In selected embodiments, the user category 2012C of the supported system user 2012 can comprise a user category associated with a preselected discussion topic in the manner discussed in more detail herein.

The selected information about the supported system user 2012 optionally can include biographical, narrative and/or other demographic information 2012D of the supported system user 2012, user review information for the supported system user 2012, relevant discussion topic information for the supported system user 2012, contact information 2012E for the supported system user 2012 and/or other information or options 2012F for the supported system user 2012, without limitation. Exemplary contact information 2012E can include an availability of the supported system user 2012 and/or available interaction media, such as a telephone call, a chat and/or a videoconference. In selected embodiments, the first system user 210 can elect to accept and/or reject one or more of the supported system users 2012.

As shown in FIG. 27U, the supporting subpage 2005B can include a search feature 2014 by which the first system user 210 can enter discussion topic information and/or name or other information about a supported system user 2012 of the first system user 210. The supported listing 2011 can be based upon a discussion topic that might be of interest to the first system user 210 and/or a discussion topic searched via the search feature 2014. The supported system users 2012 associated with the supported listing 2011 can be arranged in any suitable order or other configuration. In selected embodiments, the supported system users 2012 can be sorted based upon a popularity, a review rating or availability of the supported system users 2012, without limitation.

As shown in FIG. 27U, the supported listing 2011 can include filtering indicia 2019 by which the first system user 210 can focus or otherwise narrow the supported listing 2011. The filtering indicia 2019, for example, can comprise one or more user category filters 2019A-C and/or other supporter filters 2019D. Peer user category filter 2019A can be utilized to narrow the supported listing 2011 to include only supported system users 2012 who identify as peer system users 222 that are experiencing the same issue as the first system user 210 and/or have an interest in the discussion topic provided by the first system user 210 and wants to share ideas and exchange mutual support.

Volunteer user category filter 2019B can be utilized to narrow the supported listing 2011 to include only supported system users 2012 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 2019C can be utilized to narrow the supported listing 2011 to include only supported system users 2012 who comprise professional system users who are experts in the discussion topic, offer paid listing services and/or are available for professional consultations. Although FIG. 27U shows selected user category filters 2019A-C as including a peer user category filter 2019A, a volunteer user category filter 2019B and a professional user category filter 2019C for purposes of illustration only, the support network page 2000 can include user category filters 2019A-C for any of the user categories discussed herein.

The supporter filters 2019D can comprise any suitable filters for focusing or otherwise narrowing the supported listing 2011. Exemplary supporter filters 2019D can include, but are not limited to, a first supporter filter based upon an availability of the supported system users 2012, a second supporter filter based upon reviews of the supported system users 2012, a third supporter filter based upon a gender of the supported system users 2012 and/or a fourth supporter filter based upon a sexual orientation of the supported system users 2012.

The following subpage 2005C of FIG. 27V can comprise a followed user listing 2021 of one or more followed system users 2022 who are followed by the first system user 210. The followed user listing 2021 can include selected information about each of the followed system users 2022. The selected information can include, but is not limited to, a user name 2022A of the followed system user 2022, a user image 2022B of the followed system user 2022 and/or a user category 2022C of the followed system user 2022.

In selected embodiments, the user category 2022C of the followed system user 2022 can comprise a user category associated with a preselected discussion topic in the manner discussed in more detail herein. The selected information about the followed system user 2022 optionally can include biographical, narrative and/or other demographic information 2022D of the followed system user 2022, user review information for the followed system user 2022, relevant discussion topic information for the followed system user 2022 and/or contact information for the followed system user 2022, without limitation. Exemplary contact information can include an availability of the followed system user 2022 and/or available interaction media, such as a telephone call 2022F, a chat 2022G and/or a videoconference.

As shown in FIG. 27V, the following subpage 2005C can include a search feature 2024 by which the first system user 210 can enter discussion topic information and/or name or other information about a followed system user 2022 of the first system user 210. The followed user listing 2021 can be based upon a discussion topic that might be of interest to the first system user 210 and/or a discussion topic searched via the search feature 2024. The followed system users 2022 associated with the followed user listing 2021 can be arranged in any suitable order or other configuration. In selected embodiments, the followed system users 2022 can be sorted based upon a popularity, a review rating or availability of the followed system users 2022, without limitation.

As shown in FIG. 27V, the followed user listing 2021 can include filtering indicia 2029 by which the first system user 210 can focus or otherwise narrow the followed user listing 2021. The filtering indicia 2029, for example, can comprise one or more user category filters 2029A-C and/or other supporter filters 2029D. Peer user category filter 2029A can be utilized to narrow the followed user listing 2021 to include only followed system users 2022 who identify as peer system users 222 that are experiencing the same issue as the first system user 210 and/or have an interest in the discussion topic provided by the first system user 210 and wants to share ideas and exchange mutual support.

Volunteer user category filter 2029B can be utilized to narrow the followed user listing 2021 to include only followed system users 2022 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 2029C can be utilized to narrow the followed user listing 2021 to include only followed system users 2022 who comprise professional system users who are experts in the discussion topic, offer paid listing services and/or are available for professional consultations. Although FIG. 27V shows selected user category filters 2029A-C as including a peer user category filter 2029A, a volunteer user category filter 2029B and a professional user category filter 2029C for purposes of illustration only, the support network page 2000 can include user category filters 2029A-C for any of the user categories discussed herein.

The supporter filters 2029D can comprise any suitable filters for focusing or otherwise narrowing the followed user listing 2021. Exemplary supporter filters 2029D can include, but are not limited to, a first supporter filter based upon an availability of the followed system users 2022, a second supporter filter based upon reviews of the followed system users 2022, a third supporter filter based upon a price the followed system users 2022, a fourth supporter filter based upon type of service provided by the followed system users 2022, a fifth supporter filter based upon a gender of the followed system users 2022 and/or a sixth supporter filter based upon a sexual orientation of the followed system users 2022.

Turning to FIG. 27W, the topics subpage 2005D can comprise a topical listing 2031 of one or more system users 2032 who have indicated an interest in selected discussion topics 2032B. The topical listing 2031 can include selected information about each of the system users 2032. The selected information can include, but is not limited to, a user name, a user image 2032A and/or a user category of the supporting system user 2032. As shown in FIG. 27W, the topics subpage 2005D can include a search feature 2034 by which the first system user 210 can enter discussion topic information and/or name or other information about a supporting system user 2032 of the first system user 210. The topical listing 2031 can be based upon a discussion topic that might be of interest to the first system user 210 and/or a discussion topic searched via the search feature 2034. The system users 2032 associated with the topical listing 2031 can be arranged by discussion topic 2032B.

As shown in FIG. 27W, the topical listing 2031 can include filtering indicia 2039 by which the first system user 210 can focus or otherwise narrow the topical listing 2031. The filtering indicia 2039, for example, can comprise one or more user category filters 2039A-C and/or other supporter filters 2039D. Peer user category filter 2039A can be utilized to narrow the topical listing 2031 to include only system users 2032 who identify as peer system users 222 that are experiencing the same issue as the first system user 210 and/or have an interest in the discussion topic provided by the first system user 210 and wants to share ideas and exchange mutual support.

Volunteer user category filter 2039B can be utilized to narrow the topical listing 2031 to include only system users 2032 who comprise volunteer system users 224. Volunteer system users 224 volunteer their time to help others system users 200. For example, volunteer system users 224 can be system users 200 who have overcome an illness, an addiction or another life issues and who want to share their experiences with other system users 200. Similarly, professional user category filter 2039C can be utilized to narrow the topical listing 2031 to include only system users 2032 who comprise professional system users who are experts in the discussion topic, offer paid listing services and/or are available for professional consultations. Although FIG. 27W shows selected user category filters 2039A-C as including a peer user category filter 2039A, a volunteer user category filter 2039B and a professional user category filter 2039C for purposes of illustration only, the support network page 2000 can include user category filters 2039A-C for any of the user categories discussed herein.

The supporter filters 2039D can comprise any suitable filters for focusing or otherwise narrowing the topical listing 2031. Exemplary supporter filters 2039D can include, but are not limited to, a first supporter filter based upon an availability of the system users 2032, a second supporter filter based upon reviews of the system users 2032, a third supporter filter based upon a price the system users 2032, a fourth supporter filter based upon type of service provided by the system users 2032, a fifth supporter filter based upon a gender of the system users 2032 and/or a sixth supporter filter based upon a sexual orientation of the system users 2032.

The my support network page 2000 advantageously can enable the first system user 210 to select at least one of the discussion topic 2032B included in the topical listing 2031. Upon selection of the discussion topic 2032B, the my support network page 2000 can present the selected information about each of the system users 2032 associated with the selected discussion topic 2032B. The first system user 210 thereby can be permitted to contact one or more of the system users 2032 to discuss the selected discussion topic 2032B.

The supporter subpage 2005E is shown in FIG. 27X as comprising a user profile listing 2041 of each user profile 2042 associated with the first system user 210 when supporting other system users 200. Turning to FIG. 27X, the user profile listing 2041 can include selected information about each of the user profiles 2042. The selected information can include, but is not limited to, a user name 2042A of the user profile 2042, a user image 2042B of the user profile 2042 and/or a user category 2042C of the user profile 2042. In selected embodiments, the user category 2042C of the user profile 2042 can comprise a user category associated with a preselected discussion topic in the manner discussed in more detail herein.

The selected information about the user profile 2042 optionally can include biographical, narrative and/or other demographic information 2042X, user review information, relevant discussion topic information 2042D and/or contact information for the user profile 2042, without limitation. Exemplary contact information can include cost information, an availability of the first system user 210 and/or available interaction media, such as a telephone call 2042E, a chat 2042F and/or a videoconference. The supporter subpage 2005E optionally can enable the first system user 210 to control, at 2050, selected aspects of each user profile 2042. The first system user 210, for example, can be permitted to control, at 2052, a manner in which the user profile 2042 is presented in the support network page 1900 of other system users 200. Additionally and/or alternatively, the supporter subpage 2005E can enable the first system user 210 to control whether the first system user 210 is willing to participate in telephone calls 2054, videoconferences 2056 and/or internet chats 2058, without limitation.

As illustrated in FIG. 27Y, the support network page 1900 optionally can enable the first system user 210 to adjust one or more support network settings 2060. The first system user 210 likewise can be permitted to view all user profiles 2070 associated with the first system user 210 and/or to create a new user profile 2072 as shown in FIG. 27Z.

The personal profile page 400 of FIG. 28A is shown as supporting a support network page 2100. The exemplary support network page 2100 of FIG. 28A can include support network content for a first system user 210 who comprises a creator first user 213A. The personal profile page 400, for instance, can include navigation indicia 2102, such as one or more tabs, one or more folders and/or one or more icons, for enabling the first system user 210 to access the support network page 2100 and associated support network content available via the multiuse communication system 100. The support network page 2100 is shown in FIG. 28A as including a search feature 2104 by which the first system user 210 can enter discussion topic information and/or name or other information about another system user 220 who might be a potential supporter of the first system user 210. The multiuse communication system 100 can prevent the first system user 210 who comprises a creator first user 213A from connecting with other system users 220 who comprise peer second users 222 in the manner discussed in more detail herein with reference to FIGS. 24A-B. In selected embodiments, the support network page 2100 can present a trending topic listing 2106 with one or more trending discussion topics and/or a suggested supporter listing 2108 of one or more suggested system users 2110 who might support the first system user 210.

The suggested supporter listing 2108 can include selected information about each of the suggested system users 2110. The selected information can include, but is not limited to, a user name 2111 of the suggested supporting user 2110, a user image 2112 of the suggested supporting user 2110 and/or a user category 2113 of the suggested supporting user 2110. In selected embodiments, the user category 2113 of the suggested supporting user 2110 can comprise a user category associated with a preselected discussion topic in the manner discussed in more detail herein. The selected information about the suggested supporting user 2110 optionally can include biographical, narrative and/or other demographic information 2114 of the suggested supporting user 2110, user review information 2115 for the suggested supporting user 2110, relevant discussion topic information 2116 for the suggested supporting user 2110 and/or contact information 2117 for the suggested supporting user 2110, without limitation. Exemplary contact information 2117 can include cost information for interacting with the suggested supporting user 2110 and/or available interaction media, such as a telephone call, a chat and/or a videoconference.

The suggested supporter listing 2108 can be based upon a discussion topic that might be of interest to the first system user 210 and/or a discussion topic searched via the search feature 2104. The suggested supporting users 2110 associated with the suggested supporter listing 2108 can be arranged in any suitable order or other configuration. In selected embodiments, the suggested supporting users 2110 can be sorted based upon a popularity, a review rating or availability of the suggested supporting users 2110, without limitation. As shown in FIG. 28A, the suggested supporter listing 2108 can include filtering indicia 2109 by which the first system user 210 can focus or otherwise narrow the suggested supporter listing 2108. The filtering indicia 2109, for example, can comprise one or more user category filters 2109A-C and/or other suggested supporter filters 2109D. Peer user category filter 2109A can be utilized to narrow the suggested supporter listing 2108 to include only suggested supporting users 2110 who identify as peer system users 222 that are experiencing the same issue as the first system user 210 and/or have an interest in the discussion topic provided by the first system user 210 and wants to share ideas and exchange mutual support.

Volunteer user category filter 2109B can be utilized to narrow the suggested supporter listing 2108 to include only suggested supporting users 2110 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2109C can be utilized to narrow the suggested supporter listing 2108 to include only suggested supporting users 2110 who comprise professional system users who are experts in the discussion topic, offer paid listing services and/or are available for professional consultations. Although FIG. 28A shows selected user category filters 2109A-C as including a peer user category filter 2109A, a volunteer user category filter 2109B and a professional user category filter 2109C for purposes of illustration only, the support network page 2100 can include user category filters 2109A-C for any of the user categories discussed herein.

The suggested supporter filters 2109D can comprise any suitable filters for focusing or otherwise narrowing the suggested supporter listing 2108. Turning to FIG. 28B, for example, the suggested supporter filters 2109D can include, but are not limited to, a first supporter filter 2121 based upon an availability of the suggested supporting users 2110, a second supporter filter 2122 based upon reviews of the suggested supporting users 2110, a third supporter filter 2123 based upon a price the suggested supporting users 2110, a fourth supporter filter 2124 based upon type of service provided by the suggested supporting users 2110, a fifth supporter filter 2125 based upon a gender of the suggested supporting users 2110 and/or a sixth supporter filter 2126 based upon a sexual orientation of the suggested supporting users 2110.

FIG. 28C shows that exemplary first supporter filters 2121 can be utilized, at 2121A, to present all of the suggested supporting users 2110 included in the suggested supporter listing 2108. The first supporter filters 2121 alternatively can be utilized to narrow the suggested supporter listing 2108 to include only suggested supporting users 2110 who are available to online, at 2121B, to include only suggested supporting users 2110 who are busy, at 2121C, and/or to include only suggested supporting users 2110 who are available to offline, at 2121D. Turning to FIG. 28D, the second supporter filter 2122 is shown as being configured to narrow the suggested supporter listing 2108 to include only suggested supporting users 2110 who have the highest review score, at 2122A, to include only suggested supporting users 2110 who have the lowest review score, at 2122B, and/or to include only suggested supporting users 2110 who have a maximum review score, at 2122C.

Additionally and/or alternatively, the third supporter filter 2123 illustrated in FIG. 28E enables the suggested supporter listing 2108 to be narrowed to include only suggested supporting users 2110 who have a price between a minimum price amount 2123A and a maximum price amount 2123B. The price can comprise a price rate, a total price for a selected interaction, or any other conventional pricing system or manner. Turning to FIG. 28F, the fourth supporter filter 2124 can narrow the suggested supporter listing 2108 to include only suggested supporting users 2110 who support all communication media 2124A, who support only telephonic communication media 2124B, who support only videoconference communication media 2124C and/or who support only internet chat communication media 2124D, without limitation.

As set forth above, the fifth supporter filter 2125 can narrow the suggested supporter listing 2108 based upon a gender of the suggested supporting users 2110. The fifth supporter filter 2125, for example, can enable the suggested supporter listing 2108 include suggested supporting users 2110 of all genders, at 2125A, as illustrated in FIG. 28G. Alternatively, the fifth supporter filter 2125 can narrow the suggested supporter listing 2108 to include only suggested supporting users 2110 who are female, at 2125B, to include only suggested supporting users 2110 who are male, at 2125C, to include only suggested supporting users 2110 who are transgender, at 2125C, and/or to include only suggested supporting users 2110 who are non-binary, at 2125D, without limitation.

The sixth supporter filter 2126 can narrow the suggested supporter listing 2108 based upon a sexual orientation of the suggested supporting users 2110. As shown in FIG. 28H, the sixth supporter filter 2126, for example, can enable the suggested supporter listing 2108 include suggested supporting users 2110 of all sexual orientations, at 2126A. In selected embodiments, the sixth supporter filter 2126 alternatively can narrow the suggested supporter listing 2108 to include only suggested supporting users 2110 who are heterosexual, at 2126B, to include only suggested supporting users 2110 who are homosexual, at 2126C, to include only suggested supporting users 2110 who are bisexual, at 2126C, and/or to include only suggested supporting users 2110 who are asexual, at 2126D, without limitation.

The support network page 2100 of FIG. 28I is shown as enabling the first system user 210 to select at least one of the suggested supporting users 2110 included in the suggested supporter listing 2108. The first system user 210, at 2120A, can visit a supporter profile 2110X of the selected suggested supporting user 2110, can add the selected suggested supporting user 2110 to the user profile of the first system user 210 and/or can share the supporter profile 2110X of the selected suggested supporting user 2110.

As illustrated in FIG. 28J, the support network page 2100 can enable the first system user 210 to select at least one of the suggested supporting users 2110 included in the suggested supporter listing 2108. The first system user 210, at 2120X, can share the supporter profile 2110X of the selected suggested supporting user 2110.

The first system user 210 optionally can report the supporter profile 2110X. For example, the first system user 210, at 2120B, can report the supporter profile 2110X of the selected suggested supporting user 2110 as shown in FIGS. 28K-M. Turning to FIG. 28K, the support network page 2100 can enable the first system user 210 to report the supporter profile 2110X, for example, for including nudity or sexual content, violent content, hate speech content, terrorism content, fake news content, spamming or trolling content and/or copyright or sensitive data content, without limitation. The first system user 210 optionally can report the supporter profile 2110X if the selected suggested supporting user 2110 has multiplied the supporter profile 2110X too many times and/or if urgent help is needed. The support network page 2100 can receive the report from the first system user 210, at 2120C, and permit the first system user 210 to block the supporter profile 2110 from one or more user profiles associated with the first system user 210 as shown in FIG. 28L. Blocking confirmation can be provided, at 2120D, as illustrated in FIG. 28M.

In selected embodiments, the support network page 2100 can present one or more useful telephone numbers, at 2130, as shown in FIG. 28N. Exemplary useful telephone numbers can include, but are not limited to, a telephone number for police assistance, a telephone number for fire fighters, a telephone number for a women helpline and/or a telephone number for a child helpline The support network page 2100 optionally can enable the first system user 210 to search among available support groups and/or to suggest a support group, without limitation.

Turning to FIG. 28O, the support network page 2100 can enable the first system user 210 to narrow the suggested supporter listing 2108 to include only suggested supporting users 2110 for a selected discussion topic 2141. The first system user 210 optionally can add the supporter profile 2110X of the selected suggested supporting user 2110 to a group of favorites, at 2140. In selected embodiments, the support network page 2100 can present one or more related discussion topics 2145 that are related to the selected discussion topic 2141.

The support network page 2100 of FIG. 25P is shown as enabling the first system user 210 to submit one or more topic settings 2142 via the support network page 2100. The support network page 2100, for example, can permit the first system user 210 to share the supporter profile 2110X in a link, at 2144, to send request notifications, at 2146, and/or to report the selected discussion topic 2141, at 2148, without limitation. The support network page 2100 can permit the first system user 210 to share the supporter profile 2110X in a link, at 2144, in any suitable manner as illustrated in FIG. 28Q. The support network page 2100, for example, can permit the first system user 210 to share the supporter profile 2110X via a post on Facebook, at 2144A, via a tweet on Twitter, at 2144B, and/or by copying a Uniform Resource Locator (or URL) for the supporter profile 2110X, at 2144C, without limitation.

Additionally and/or alternatively, the support network page 2100 can be configured to send request notifications, at 2146, in any suitable manner. Turning to FIG. 28R, for instance, the support network page 2100 is illustrated as being configured to send request notifications, at 2146, by notifying the first system user 210 as soon as a suggested supporting user 2110 becomes available, at 2146A, by notifying the first system user 210 as soon as a new support group becomes available, at 2146B, and/or by sending a newsletter relevant to the selected discussion topic 2141 to the first system user 210, at 2146C, without limitation. The support network page 2100 likewise can be configured to enable the first system user 210 to report the selected discussion topic 2141, at 2148, in any suitable manner. As shown in FIG. 28S, the support network page 2100 can enable the first system user 210 to report the selected discussion topic 2141, at 2148, for including nudity or sexual content 2148A, violent content 2148B, hate speech content 2148C, terrorism content 2148D, fake news content 2148E, spamming or trolling content 2148F and/or copyright or sensitive data content 2148, without limitation.

The support network page 2100 is shown in FIG. 28T as comprising a supporting user listing 2160 of one or more supporting system users 2162 who support the first system user 210. The supporting user listing 2160 can include selected information about each of the supporting system users 2162. The selected information can include, but is not limited to, a user name 2162A of the supporting system user 2162, a user image 2162B of the supporting system user 2162 and/or a user category 2162C of the supporting system user 2162. In selected embodiments, the user category 2162C of the supporting system user 2162 can comprise a user category associated with a preselected discussion topic in the manner discussed in more detail herein. The selected information about the supporting system user 2162 optionally can include biographical, narrative and/or other demographic information 2162E of the supporting system user 2162, user review information 2162D for the supporting system user 2162, relevant discussion topic information for the supporting system user 2162 and/or contact information for the supporting system user 2162, without limitation. Exemplary contact information can include cost information for interacting with the supporting system user 2162, an availability of the supporting system user 2162 and/or available interaction media 2162F, such as a telephone call, a chat and/or a videoconference.

The support network page 2100 advantageously can present a my support network page 2200 for the first system user 210. Whereas the support network page 2100 can comprise a public page that can be made available for viewing by other system users 220, the my support network page 2200 preferably is a private page that is accessible only by the first system user 210 and can be developed for each user category (or role) assumed by the first system user 210. An exemplary my support network page 2200 is shown in FIG. 28U-AA. Turning to FIG. 28U, the my support network page 2200 can include navigation indicia 2205 for accessing one or more subpages of the my support network page 2200. The subpages can include, but are not limited to, a supporters subpage 2205A, a supporting subpage 2205B, a following subpage 2205C, a topics subpage 2205D and/or a supporter subpage 2205E.

The supporters subpage 2205A can comprise a supporter listing 2201 of one or more supporting system users 2202 who support the first system user 210. The supporter listing 2201 can include selected information about each of the supporting system users 2202. The selected information can include, but is not limited to, a user name 2202A of the supporting system user 2202, a user image 2202B of the supporting system user 2202 and/or a user category 2202C of the supporting system user 2202. In selected embodiments, the user category 2202C of the supporting system user 2202 can comprise a user category associated with a preselected discussion topic in the manner discussed in more detail herein. The selected information about the supporting system user 2202 optionally can include biographical, narrative and/or other demographic information 2202D of the supporting system user 2202, user review information for the supporting system user 2202, relevant discussion topic information for the supporting system user 2202 and/or contact information for the supporting system user 2202, without limitation. Exemplary contact information can include cost information for interacting with the supporting system user 2202, an availability 2202F of the supporting system user 2202 and/or available interaction media, such as a telephone call, a chat 2202G and/or a videoconference.

As shown in FIG. 28U, the supporters subpage 2205A can include a search feature 2204 by which the first system user 210 can enter discussion topic information and/or name or other information about a supporting system user 2202 of the first system user 210. The supporter listing 2201 can be based upon a discussion topic that might be of interest to the first system user 210 and/or a discussion topic searched via the search feature 2204. The supporting system users 2202 associated with the supporter listing 2201 can be arranged in any suitable order or other configuration. In selected embodiments, the supporting system users 2202 can be sorted based upon a popularity, a review rating or availability of the supporting system users 2202, without limitation.

As shown in FIG. 28U, the supporter listing 2201 can include filtering indicia 2209 by which the first system user 210 can focus or otherwise narrow the supporter listing 2201. The filtering indicia 2209, for example, can comprise one or more user category filters 2209A-C and/or other supporter filters 2209D. Peer user category filter 2209A can be utilized to narrow the supporter listing 2201 to include only supporting system users 2202 who identify as peer system users 222 that are experiencing the same issue as the first system user 210 and/or have an interest in the discussion topic provided by the first system user 210 and wants to share ideas and exchange mutual support.

Volunteer user category filter 2209B can be utilized to narrow the supporter listing 2201 to include only supporting system users 2202 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2209C can be utilized to narrow the supporter listing 2201 to include only supporting system users 2202 who comprise professional system users who are experts in the discussion topic, offer paid listing services and/or are available for professional consultations. Although FIG. 28U shows selected user category filters 2209A-C as including a peer user category filter 2209A, a volunteer user category filter 2209B and a professional user category filter 2209C for purposes of illustration only, the support network page 2200 can include user category filters 2209A-C for any of the user categories discussed herein.

The supporter filters 2209D can comprise any suitable filters for focusing or otherwise narrowing the supporter listing 2201. Exemplary supporter filters 2209D can include, but are not limited to, a first supporter filter based upon an availability of the supporting system users 2202, a second supporter filter based upon reviews of the supporting system users 2202, a third supporter filter based upon a price the supporting system users 2202, a fourth supporter filter based upon type of service provided by the supporting system users 2202, a fifth supporter filter based upon a gender of the supporting system users 2202 and/or a sixth supporter filter based upon a sexual orientation of the supporting system users 2202.

The supporting subpage 2205B can comprise a message 2213 for indicating that the first system user 210, when comprising a creator first user 213A, cannot be added as a supporter to the user profiles of other system users 200 as shown in FIG. 28V.

The following subpage 2205C of FIG. 28W can comprise a followed user listing 2221 of one or more followed system users 2222 who are followed by the first system user 210. The followed user listing 2221 can include selected information about each of the followed system users 2222. The selected information can include, but is not limited to, a user name 2222A of the followed system user 2222, a user image 2222B of the followed system user 2222 and/or a user category 2222C of the followed system user 2222.

In selected embodiments, the user category 2222C of the followed system user 2222 can comprise a user category associated with a preselected discussion topic in the manner discussed in more detail herein. The selected information about the followed system user 2222 optionally can include biographical, narrative and/or other demographic information 2222D of the followed system user 2222, user review information for the followed system user 2222, relevant discussion topic information for the followed system user 2222 and/or contact information for the followed system user 2222, without limitation. Exemplary contact information can include an availability of the followed system user 2222 and/or available interaction media, such as a telephone call 2222F, a chat 2222G and/or a videoconference.

As shown in FIG. 28W, the following subpage 2205C can include a search feature 2224 by which the first system user 210 can enter discussion topic information and/or name or other information about a followed system user 2222 of the first system user 210. The followed user listing 2221 can be based upon a discussion topic that might be of interest to the first system user 210 and/or a discussion topic searched via the search feature 2224. The followed system users 2222 associated with the followed user listing 2221 can be arranged in any suitable order or other configuration. In selected embodiments, the followed system users 2222 can be sorted based upon a popularity, a review rating or availability of the followed system users 2222, without limitation.

As shown in FIG. 28W, the followed user listing 2221 can include filtering indicia 2229 by which the first system user 210 can focus or otherwise narrow the followed user listing 2221. The filtering indicia 2229, for example, can comprise one or more user category filters 2229A-C and/or other supporter filters 2229D. Peer user category filter 2229A can be utilized to narrow the followed user listing 2221 to include only followed system users 2222 who identify as peer system users 222 that are experiencing the same issue as the first system user 210 and/or have an interest in the discussion topic provided by the first system user 210 and wants to share ideas and exchange mutual support.

Volunteer user category filter 2229B can be utilized to narrow the followed user listing 2221 to include only followed system users 2222 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2229C can be utilized to narrow the followed user listing 2221 to include only followed system users 2222 who comprise professional system users who are experts in the discussion topic, offer paid listing services and/or are available for professional consultations. Although FIG. 28W shows selected user category filters 2229A-C as including a peer user category filter 2229A, a volunteer user category filter 2229B and a professional user category filter 2229C for purposes of illustration only, the support network page 2200 can include user category filters 2229A-C for any of the user categories discussed herein.

The supporter filters 2229D can comprise any suitable filters for focusing or otherwise narrowing the followed user listing 2221. Exemplary supporter filters 2229D can include, but are not limited to, a first supporter filter based upon an availability of the followed system users 2222, a second supporter filter based upon reviews of the followed system users 2222, a third supporter filter based upon a price the followed system users 2222, a fourth supporter filter based upon type of service provided by the followed system users 2222, a fifth supporter filter based upon a gender of the followed system users 2222 and/or a sixth supporter filter based upon a sexual orientation of the followed system users 2222.

Turning to FIG. 28X, the topics subpage 2205D can comprise a topical listing 2231 of one or more system users 2232 who have indicated an interest in selected discussion topics 2232B. The topical listing 2231 can include selected information about each of the system users 2232. The selected information can include, but is not limited to, a user name, a user image 2232A and/or a user category of the supporting system user 2232. As shown in FIG. 28X, the topics subpage 2205D can include a search feature 2234 by which the first system user 210 can enter discussion topic information and/or name or other information about a supporting system user 2232 of the first system user 210. The topical listing 2231 can be based upon a discussion topic that might be of interest to the first system user 210 and/or a discussion topic searched via the search feature 2234. The system users 2232 associated with the topical listing 2231 can be arranged by discussion topic 2232B.

As shown in FIG. 28X, the topical listing 2231 can include filtering indicia 2239 by which the first system user 210 can focus or otherwise narrow the topical listing 2231. The filtering indicia 2239, for example, can comprise one or more user category filters 2239A-C and/or other supporter filters 2239D. Peer user category filter 2239A can be utilized to narrow the topical listing 2231 to include only system users 2232 who identify as peer system users 222 that are experiencing the same issue as the first system user 210 and/or have an interest in the discussion topic provided by the first system user 210 and wants to share ideas and exchange mutual support.

Volunteer user category filter 2239B can be utilized to narrow the topical listing 2231 to include only system users 2232 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2239C can be utilized to narrow the topical listing 2231 to include only system users 2232 who comprise professional system users who are experts in the discussion topic, offer paid listing services and/or are available for professional consultations. Although FIG. 28X shows selected user category filters 2239A-C as including a peer user category filter 2239A, a volunteer user category filter 2239B and a professional user category filter 2239C for purposes of illustration only, the support network page 2200 can include user category filters 2239A-C for any of the user categories discussed herein.

The supporter filters 2239D can comprise any suitable filters for focusing or otherwise narrowing the topical listing 2231. Exemplary supporter filters 2239D can include, but are not limited to, a first supporter filter based upon an availability of the system users 2232, a second supporter filter based upon reviews of the system users 2232, a third supporter filter based upon a price the system users 2232, a fourth supporter filter based upon type of service provided by the system users 2232, a fifth supporter filter based upon a gender of the system users 2232 and/or a sixth supporter filter based upon a sexual orientation of the system users 2232.

The my support network page 2200 advantageously can enable the first system user 210 to select at least one of the discussion topic 2232B included in the topical listing 2231. Upon selection of the discussion topic 2232B, the my support network page 2200 can present the selected information about each of the system users 2232 associated with the selected discussion topic 2232B. The first system user 210 thereby can be permitted to contact one or more of the system users 2232 to discuss the selected discussion topic 2232B.

The supporter subpage 2205E is shown in FIG. 28Y as comprising a user profile listing 2241 of each user profile 2242 associated with the first system user 210 when supporting other system users 220. Turning to FIG. 28Y, the user profile listing 2241 can include selected information about each of the user profiles 2242. The selected information can include, but is not limited to, a user name 2242A of the user profile 2242, a user image 2242B of the user profile 2242 and/or a user category 2242C of the user profile 2242. In selected embodiments, the user category 2242C of the user profile 2242 can comprise a user category associated with a preselected discussion topic in the manner discussed in more detail herein.

The selected information about the user profile 2242 optionally can include biographical, narrative and/or other demographic information 2242X, user review information, relevant discussion topic information 2242D and/or contact information for the user profile 2242, without limitation. Exemplary contact information can include cost information, an availability of the first system user 210 and/or available interaction media, such as a telephone call 2242E, a chat 2242F and/or a videoconference. The supporter subpage 2205E optionally can enable the first system user 210 to control, at 2250, selected aspects of each user profile 2242. The first system user 210, for example, can be permitted to control, at 2252, a manner in which the user profile 2242 is presented in the support network page 2100 of other system users 220. Additionally and/or alternatively, the supporter subpage 2205E can enable the first system user 210 to control whether the first system user 210 is willing to participate in telephone calls 2254, videoconferences 2256 and/or internet chats 2258, without limitation.

As illustrated in FIG. 28Z, the support network page 2100 optionally can enable the first system user 210 to adjust one or more support network settings 2260. The first system user 210 likewise can be permitted to view all user profiles 2270 associated with the first system user 210 and/or to create a new user profile 2272 as shown in FIG. 28AA.

The personal profile page 400 of FIG. 29A is shown as supporting a support network page 2300. The exemplary support network page 2300 of FIG. 29A can include support network content for a first system user 210 who comprises an anonymous first user 213B. The personal profile page 400, for instance, can include navigation indicia 2302, such as one or more tabs, one or more folders and/or one or more icons, for enabling the first system user 210 to access the support network page 2300 and associated support network content available via the multiuse communication system 100. The support network page 2300 is shown in FIG. 29A as including a search feature 2304 by which the first system user 210 can enter discussion topic information and/or name or other information about another system user 240 who might be a potential supporter of the first system user 210. The multiuse communication system 100 can prevent the first system user 210 who comprises an anonymous first user 213B from connecting with other system users 220 who comprise peer second users 222 in the manner discussed in more detail herein with reference to FIGS. 24A-B. In selected embodiments, the support network page 2300 can present a trending topic listing 2306 with one or more trending discussion topics and/or a suggested supporter listing 2308 of one or more suggested system users 2310 who might support the first system user 210.

The suggested supporter listing 2308 can include selected information about each of the suggested system users 2310. The selected information can include, but is not limited to, a user name 2311 of the suggested supporting user 2310, a user image 2312 of the suggested supporting user 2310 and/or a user category 2313 of the suggested supporting user 2310. In selected embodiments, the user category 2313 of the suggested supporting user 2310 can comprise a user category associated with a preselected discussion topic in the manner discussed in more detail herein. The selected information about the suggested supporting user 2310 optionally can include biographical, narrative and/or other demographic information 2314 of the suggested supporting user 2310, user review information 2315 for the suggested supporting user 2310, relevant discussion topic information 2316 for the suggested supporting user 2310 and/or contact information 2317 for the suggested supporting user 2310, without limitation. Exemplary contact information 2317 can include cost information for interacting with the suggested supporting user 2310 and/or available interaction media, such as a telephone call, a chat and/or a videoconference.

The suggested supporter listing 2308 can be based upon a discussion topic that might be of interest to the first system user 210 and/or a discussion topic searched via the search feature 2304. The suggested supporting users 2310 associated with the suggested supporter listing 2308 can be arranged in any suitable order or other configuration. In selected embodiments, the suggested supporting users 2310 can be sorted based upon a popularity, a review rating or availability of the suggested supporting users 2310, without limitation. As shown in FIG. 29A, the suggested supporter listing 2308 can include filtering indicia 2309 by which the first system user 210 can focus or otherwise narrow the suggested supporter listing 2308. The filtering indicia 2309, for example, can comprise one or more user category filters 2309A-C and/or other suggested supporter filters 2309D. Peer user category filter 2309A can be utilized to narrow the suggested supporter listing 2308 to include only suggested supporting users 2310 who identify as peer system users 222 that are experiencing the same issue as the first system user 210 and/or have an interest in the discussion topic provided by the first system user 210 and wants to share ideas and exchange mutual support.

Volunteer user category filter 2309B can be utilized to narrow the suggested supporter listing 2308 to include only suggested supporting users 2310 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2309C can be utilized to narrow the suggested supporter listing 2308 to include only suggested supporting users 2310 who comprise professional system users who are experts in the discussion topic, offer paid listing services and/or are available for professional consultations. Although FIG. 29A shows selected user category filters 2309A-C as including a peer user category filter 2309A, a volunteer user category filter 2309B and a professional user category filter 2309C for purposes of illustration only, the support network page 2300 can include user category filters 2309A-C for any of the user categories discussed herein.

The suggested supporter filters 2309D can comprise any suitable filters for focusing or otherwise narrowing the suggested supporter listing 2308. Turning to FIG. 29B, for example, the suggested supporter filters 2309D can include, but are not limited to, a first supporter filter 2321 based upon an availability of the suggested supporting users 2310, a second supporter filter 2322 based upon reviews of the suggested supporting users 2310, a third supporter filter 2323 based upon a price the suggested supporting users 2310, a fourth supporter filter 2324 based upon type of service provided by the suggested supporting users 2310, a fifth supporter filter 2325 based upon a gender of the suggested supporting users 2310 and/or a sixth supporter filter 2326 based upon a sexual orientation of the suggested supporting users 2310.

FIG. 29C shows that exemplary first supporter filters 2321 can be utilized, at 2321A, to present all of the suggested supporting users 2310 included in the suggested supporter listing 2308. The first supporter filters 2321 alternatively can be utilized to narrow the suggested supporter listing 2308 to include only suggested supporting users 2310 who are available to online, at 2321B, to include only suggested supporting users 2310 who are busy, at 2321C, and/or to include only suggested supporting users 2310 who are available to offline, at 2321D. Turning to FIG. 29D, the second supporter filter 2322 is shown as being configured to narrow the suggested supporter listing 2308 to include only suggested supporting users 2310 who have the highest review score, at 2322A, to include only suggested supporting users 2310 who have the lowest review score, at 2322B, and/or to include only suggested supporting users 2310 who have a maximum review score, at 2322C.

Additionally and/or alternatively, the third supporter filter 2323 illustrated in FIG. 29E enables the suggested supporter listing 2308 to be narrowed to include only suggested supporting users 2310 who have a price between a minimum price amount 2323A and a maximum price amount 2323B. The price can comprise a price rate, a total price for a selected interaction, or any other conventional pricing system or manner. Turning to FIG. 29F, the fourth supporter filter 2324 can narrow the suggested supporter listing 2308 to include only suggested supporting users 2310 who support all communication media 2324A, who support only telephonic communication media 2324B, who support only videoconference communication media 2324C and/or who support only internet chat communication media 2324D, without limitation.

As set forth above, the fifth supporter filter 2325 can narrow the suggested supporter listing 2308 based upon a gender of the suggested supporting users 2310. The fifth supporter filter 2325, for example, can enable the suggested supporter listing 2308 include suggested supporting users 2310 of all genders, at 2325A, as illustrated in FIG. 29G. Alternatively, the fifth supporter filter 2325 can narrow the suggested supporter listing 2308 to include only suggested supporting users 2310 who are female, at 2325B, to include only suggested supporting users 2310 who are male, at 2325C, to include only suggested supporting users 2310 who are transgender, at 2325C, and/or to include only suggested supporting users 2310 who are non-binary, at 2325D, without limitation.

The sixth supporter filter 2326 can narrow the suggested supporter listing 2308 based upon a sexual orientation of the suggested supporting users 2310. As shown in FIG. 29H, the sixth supporter filter 2326, for example, can enable the suggested supporter listing 2308 include suggested supporting users 2310 of all sexual orientations, at 2326A. In selected embodiments, the sixth supporter filter 2326 alternatively can narrow the suggested supporter listing 2308 to include only suggested supporting users 2310 who are heterosexual, at 2326B, to include only suggested supporting users 2310 who are homosexual, at 2326C, to include only suggested supporting users 2310 who are bisexual, at 2326C, and/or to include only suggested supporting users 2310 who are asexual, at 2326D, without limitation.

The support network page 2300 of FIG. 29I is shown as enabling the first system user 210 to select at least one of the suggested supporting users 2310 included in the suggested supporter listing 2308. The first system user 210, at 2320A, can visit a supporter profile 2310X of the selected suggested supporting user 2310, can add the selected suggested supporting user 2310 to the user profile of the first system user 210 and/or can share the supporter profile 2310X of the selected suggested supporting user 2310.

As illustrated in FIG. 29J, the support network page 2300 can enable the first system user 210 to select at least one of the suggested supporting users 2310 included in the suggested supporter listing 2308. The first system user 210, at 2320X, can share the supporter profile 2310X of the selected suggested supporting user 2310.

The first system user 210 optionally can report the supporter profile 2310X. For example, the first system user 210, at 2320B, can report the supporter profile 2310X of the selected suggested supporting user 2310 as shown in FIGS. 29K-M. Turning to FIG. 29K, the support network page 2300 can enable the first system user 210 to report the supporter profile 2310X, for example, for including nudity or sexual content, violent content, hate speech content, terrorism content, fake news content, spamming or trolling content and/or copyright or sensitive data content, without limitation. The first system user 210 optionally can report the supporter profile 2310X if the selected suggested supporting user 2310 has multiplied the supporter profile 2310X too many times and/or if urgent help is needed. The support network page 2300 can receive the report from the first system user 210, at 2320C, and permit the first system user 210 to block the supporter profile 2310 from one or more user profiles associated with the first system user 210 as shown in FIG. 29L. Blocking confirmation can be provided, at 2320D, as illustrated in FIG. 29M.

In selected embodiments, the support network page 2300 can present one or more useful telephone numbers, at 2330, as shown in FIG. 29N. Exemplary useful telephone numbers can include, but are not limited to, a telephone number for police assistance, a telephone number for fire fighters, a telephone number for a women helpline and/or a telephone number for a child helpline The support network page 2300 optionally can enable the first system user 210 to search among available support groups and/or to suggest a support group, without limitation.

Turning to FIG. 29O, the support network page 2300 can enable the first system user 210 to narrow the suggested supporter listing 2308 to include only suggested supporting users 2310 for a selected discussion topic 2341. The first system user 210 optionally can add the supporter profile 2310X of the selected suggested supporting user 2310 to a group of favorites, at 2340. In selected embodiments, the support network page 2300 can present one or more related discussion topics 2345 that are related to the selected discussion topic 2341.

The support network page 2300 of FIG. 25P is shown as enabling the first system user 210 to submit one or more topic settings 2342 via the support network page 2300. The support network page 2300, for example, can permit the first system user 210 to share the supporter profile 2310X in a link, at 2344, to send request notifications, at 2346, and/or to report the selected discussion topic 2341, at 2348, without limitation. The support network page 2300 can permit the first system user 210 to share the supporter profile 2310X in a link, at 2344, in any suitable manner as illustrated in FIG. 29Q. The support network page 2300, for example, can permit the first system user 210 to share the supporter profile 2310X via a post on Facebook, at 2344A, via a tweet on Twitter, at 2344B, and/or by copying a Uniform Resource Locator (or URL) for the supporter profile 2310X, at 2344C, without limitation.

Additionally and/or alternatively, the support network page 2300 can be configured to send request notifications, at 2346, in any suitable manner. Turning to FIG. 29R, for instance, the support network page 2300 is illustrated as being configured to send request notifications, at 2346, by notifying the first system user 210 as soon as a suggested supporting user 2310 becomes available, at 2346A, by notifying the first system user 210 as soon as a new support group becomes available, at 2346B, and/or by sending a newsletter relevant to the selected discussion topic 2341 to the first system user 210, at 2346C, without limitation. The support network page 2300 likewise can be configured to enable the first system user 210 to report the selected discussion topic 2341, at 2348, in any suitable manner. As shown in FIG. 29S, the support network page 2300 can enable the first system user 210 to report the selected discussion topic 2341, at 2348, for including nudity or sexual content 2348A, violent content 2348B, hate speech content 2348C, terrorism content 2348D, fake news content 2348E, spamming or trolling content 2348F and/or copyright or sensitive data content 2348, without limitation.

The support network page 2300 is shown in FIG. 29T as comprising a supporting user listing 2360 of one or more supporting system users 2362 who support the first system user 210. The supporting user listing 2360 can include selected information about each of the supporting system users 2362. The selected information can include, but is not limited to, a user name 2362A of the supporting system user 2362, a user image 2362B of the supporting system user 2362 and/or a user category 2362C of the supporting system user 2362. In selected embodiments, the user category 2362C of the supporting system user 2362 can comprise a user category associated with a preselected discussion topic in the manner discussed in more detail herein. The selected information about the supporting system user 2362 optionally can include biographical, narrative and/or other demographic information 2362E of the supporting system user 2362, user review information 2362D for the supporting system user 2362, relevant discussion topic information for the supporting system user 2362 and/or contact information for the supporting system user 2362, without limitation. Exemplary contact information can include cost information for interacting with the supporting system user 2362, an availability of the supporting system user 2362 and/or available interaction media 2362F, such as a telephone call, a chat and/or a videoconference.

The support network page 2300 advantageously can present a my support network page 2400 for the first system user 210. Whereas the support network page 2300 can comprise a public page that can be made available for viewing by other system users 220, the my support network page 2400 preferably is a private page that is accessible only by the first system user 210 and can be developed for each user category (or role) assumed by the first system user 210. An exemplary my support network page 2400 is shown in FIG. 29U-AA. Turning to FIG. 29U, the my support network page 2400 can include navigation indicia 2405 for accessing one or more subpages of the my support network page 2400. The subpages can include, but are not limited to, a supporters subpage 2405A, a supporting subpage 2405B, a following subpage 2405C, a topics subpage 2405D and/or a supporter subpage 2405E.

The supporters subpage 2405A can comprise a supporter listing 2401 of one or more supporting system users 2402 who support the first system user 210. The supporter listing 2401 can include selected information about each of the supporting system users 2402. The selected information can include, but is not limited to, a user name 2402A of the supporting system user 2402, a user image 2402B of the supporting system user 2402 and/or a user category 2402C of the supporting system user 2402. In selected embodiments, the user category 2402C of the supporting system user 2402 can comprise a user category associated with a preselected discussion topic in the manner discussed in more detail herein. The selected information about the supporting system user 2402 optionally can include biographical, narrative and/or other demographic information 2402D of the supporting system user 2402, user review information for the supporting system user 2402, relevant discussion topic information for the supporting system user 2402 and/or contact information for the supporting system user 2402, without limitation. Exemplary contact information can include cost information for interacting with the supporting system user 2402, an availability 2402F of the supporting system user 2402 and/or available interaction media, such as a telephone call, a chat 2402G and/or a videoconference.

As shown in FIG. 29U, the supporters subpage 2405A can include a search feature 2404 by which the first system user 210 can enter discussion topic information and/or name or other information about a supporting system user 2402 of the first system user 210. The supporter listing 2401 can be based upon a discussion topic that might be of interest to the first system user 210 and/or a discussion topic searched via the search feature 2404. The supporting system users 2402 associated with the supporter listing 2401 can be arranged in any suitable order or other configuration. In selected embodiments, the supporting system users 2402 can be sorted based upon a popularity, a review rating or availability of the supporting system users 2402, without limitation.

As shown in FIG. 29U, the supporter listing 2401 can include filtering indicia 2409 by which the first system user 210 can focus or otherwise narrow the supporter listing 2401. The filtering indicia 2409, for example, can comprise one or more user category filters 2409A-C and/or other supporter filters 2409D. Peer user category filter 2409A can be utilized to narrow the supporter listing 2401 to include only supporting system users 2402 who identify as peer system users 222 that are experiencing the same issue as the first system user 210 and/or have an interest in the discussion topic provided by the first system user 210 and wants to share ideas and exchange mutual support.

Volunteer user category filter 2409B can be utilized to narrow the supporter listing 2401 to include only supporting system users 2402 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2409C can be utilized to narrow the supporter listing 2401 to include only supporting system users 2402 who comprise professional system users who are experts in the discussion topic, offer paid listing services and/or are available for professional consultations. Although FIG. 29U shows selected user category filters 2409A-C as including a peer user category filter 2409A, a volunteer user category filter 2409B and a professional user category filter 2409C for purposes of illustration only, the support network page 2400 can include user category filters 2409A-C for any of the user categories discussed herein.

The supporter filters 2409D can comprise any suitable filters for focusing or otherwise narrowing the supporter listing 2401. Exemplary supporter filters 2409D can include, but are not limited to, a first supporter filter based upon an availability of the supporting system users 2402, a second supporter filter based upon reviews of the supporting system users 2402, a third supporter filter based upon a price the supporting system users 2402, a fourth supporter filter based upon type of service provided by the supporting system users 2402, a fifth supporter filter based upon a gender of the supporting system users 2402 and/or a sixth supporter filter based upon a sexual orientation of the supporting system users 2402.

The supporting subpage 2405B can comprise a message 2413 for indicating that the first system user 210, when comprising an anonymous first user 213B, cannot be added as a supporter to the user profiles of other system users 200 as shown in FIG. 29V.

The following subpage 2405C of FIG. 29W can comprise a followed user listing 2421 of one or more followed system users 2422 who are followed by the first system user 210. The followed user listing 2421 can include selected information about each of the followed system users 2422. The selected information can include, but is not limited to, a user name 2422A of the followed system user 2422, a user image 2422B of the followed system user 2422 and/or a user category 2422C of the followed system user 2422.

In selected embodiments, the user category 2422C of the followed system user 2422 can comprise a user category associated with a preselected discussion topic in the manner discussed in more detail herein. The selected information about the followed system user 2422 optionally can include biographical, narrative and/or other demographic information 2422D of the followed system user 2422, user review information for the followed system user 2422, relevant discussion topic information for the followed system user 2422 and/or contact information for the followed system user 2422, without limitation. Exemplary contact information can include an availability of the followed system user 2422 and/or available interaction media, such as a telephone call 2422F, a chat 2422G and/or a videoconference.

As shown in FIG. 29W, the following subpage 2405C can include a search feature 2424 by which the first system user 210 can enter discussion topic information and/or name or other information about a followed system user 2422 of the first system user 210. The followed user listing 2421 can be based upon a discussion topic that might be of interest to the first system user 210 and/or a discussion topic searched via the search feature 2424. The followed system users 2422 associated with the followed user listing 2421 can be arranged in any suitable order or other configuration. In selected embodiments, the followed system users 2422 can be sorted based upon a popularity, a review rating or availability of the followed system users 2422, without limitation.

As shown in FIG. 29W, the followed user listing 2421 can include filtering indicia 2429 by which the first system user 210 can focus or otherwise narrow the followed user listing 2421. The filtering indicia 2429, for example, can comprise one or more user category filters 2429A-C and/or other supporter filters 2429D. Peer user category filter 2429A can be utilized to narrow the followed user listing 2421 to include only followed system users 2422 who identify as peer system users 222 that are experiencing the same issue as the first system user 210 and/or have an interest in the discussion topic provided by the first system user 210 and wants to share ideas and exchange mutual support.

Volunteer user category filter 2429B can be utilized to narrow the followed user listing 2421 to include only followed system users 2422 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2429C can be utilized to narrow the followed user listing 2421 to include only followed system users 2422 who comprise professional system users who are experts in the discussion topic, offer paid listing services and/or are available for professional consultations. Although FIG. 29W shows selected user category filters 2429A-C as including a peer user category filter 2429A, a volunteer user category filter 2429B and a professional user category filter 2429C for purposes of illustration only, the support network page 2400 can include user category filters 2429A-C for any of the user categories discussed herein.

The supporter filters 2429D can comprise any suitable filters for focusing or otherwise narrowing the followed user listing 2421. Exemplary supporter filters 2429D can include, but are not limited to, a first supporter filter based upon an availability of the followed system users 2422, a second supporter filter based upon reviews of the followed system users 2422, a third supporter filter based upon a price the followed system users 2422, a fourth supporter filter based upon type of service provided by the followed system users 2422, a fifth supporter filter based upon a gender of the followed system users 2422 and/or a sixth supporter filter based upon a sexual orientation of the followed system users 2422.

Turning to FIG. 29X, the topics subpage 2405D can comprise a topical listing 2431 of one or more system users 2432 who have indicated an interest in selected discussion topics 2432B. The topical listing 2431 can include selected information about each of the system users 2432. The selected information can include, but is not limited to, a user name, a user image 2432A and/or a user category of the supporting system user 2432. As shown in FIG. 29X, the topics subpage 2405D can include a search feature 2434 by which the first system user 210 can enter discussion topic information and/or name or other information about a supporting system user 2432 of the first system user 210. The topical listing 2431 can be based upon a discussion topic that might be of interest to the first system user 210 and/or a discussion topic searched via the search feature 2434. The system users 2432 associated with the topical listing 2431 can be arranged by discussion topic 2432B.

As shown in FIG. 29X, the topical listing 2431 can include filtering indicia 2439 by which the first system user 210 can focus or otherwise narrow the topical listing 2431. The filtering indicia 2439, for example, can comprise one or more user category filters 2439A-C and/or other supporter filters 2439D. Peer user category filter 2439A can be utilized to narrow the topical listing 2431 to include only system users 2432 who identify as peer system users 222 that are experiencing the same issue as the first system user 210 and/or have an interest in the discussion topic provided by the first system user 210 and wants to share ideas and exchange mutual support.

Volunteer user category filter 2439B can be utilized to narrow the topical listing 2431 to include only system users 2432 who comprise volunteer system users 224. Volunteer system users 224 volunteer their time to help others system users 220. For example, volunteer system users 224 can be system users 220 who have overcome an illness, an addiction or another life issues and who want to share their experiences with other system users 220. Similarly, professional user category filter 2439C can be utilized to narrow the topical listing 2431 to include only system users 2432 who comprise professional system users who are experts in the discussion topic, offer paid listing services and/or are available for professional consultations. Although FIG. 29X shows selected user category filters 2439A-C as including a peer user category filter 2439A, a volunteer user category filter 2439B and a professional user category filter 2439C for purposes of illustration only, the support network page 2400 can include user category filters 2439A-C for any of the user categories discussed herein.

The supporter filters 2439D can comprise any suitable filters for focusing or otherwise narrowing the topical listing 2431. Exemplary supporter filters 2439D can include, but are not limited to, a first supporter filter based upon an availability of the system users 2432, a second supporter filter based upon reviews of the system users 2432, a third supporter filter based upon a price the system users 2432, a fourth supporter filter based upon type of service provided by the system users 2432, a fifth supporter filter based upon a gender of the system users 2432 and/or a sixth supporter filter based upon a sexual orientation of the system users 2432.

The my support network page 2400 advantageously can enable the first system user 210 to select at least one of the discussion topic 2432B included in the topical listing 2431. Upon selection of the discussion topic 2432B, the my support network page 2400 can present the selected information about each of the system users 2432 associated with the selected discussion topic 2432B. The first system user 210 thereby can be permitted to contact one or more of the system users 2432 to discuss the selected discussion topic 2432B.

The supporter subpage 2405E is shown in FIG. 29Y as comprising a user profile listing 2441 of each user profile 2442 associated with the first system user 210 when supporting other system users 220. Turning to FIG. 29Y, the user profile listing 2441 can include selected information about each of the user profiles 2442. The selected information can include, but is not limited to, a user name 2442A of the user profile 2442, a user image 2442B of the user profile 2442 and/or a user category 2442C of the user profile 2442. In selected embodiments, the user category 2442C of the user profile 2442 can comprise a user category associated with a preselected discussion topic in the manner discussed in more detail herein.

The selected information about the user profile 2442 optionally can include biographical, narrative and/or other demographic information 2442X, user review information, relevant discussion topic information 2442D and/or contact information for the user profile 2442, without limitation. Exemplary contact information can include cost information, an availability of the first system user 210 and/or available interaction media, such as a telephone call 2442E, a chat 2442F and/or a videoconference. The supporter subpage 2405E optionally can enable the first system user 210 to control, at 2450, selected aspects of each user profile 2442. The first system user 210, for example, can be permitted to control, at 2452, a manner in which the user profile 2442 is presented in the support network page 2300 of other system users 220. Additionally and/or alternatively, the supporter subpage 2405E can enable the first system user 210 to control whether the first system user 210 is willing to participate in telephone calls 2454, videoconferences 2456 and/or internet chats 2458, without limitation.

As illustrated in FIG. 29Z, the support network page 2300 optionally can enable the first system user 210 to adjust one or more support network settings 2460. The first system user 210 likewise can be permitted to view all user profiles 2470 associated with the first system user 210 and/or to create a new user profile 2472 as shown in FIG. 29AA.

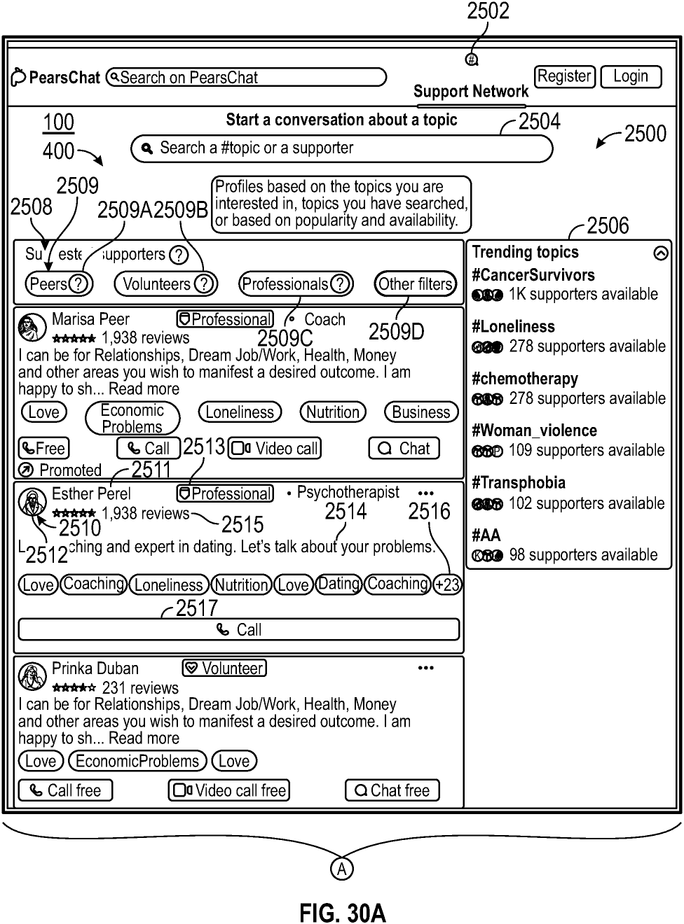

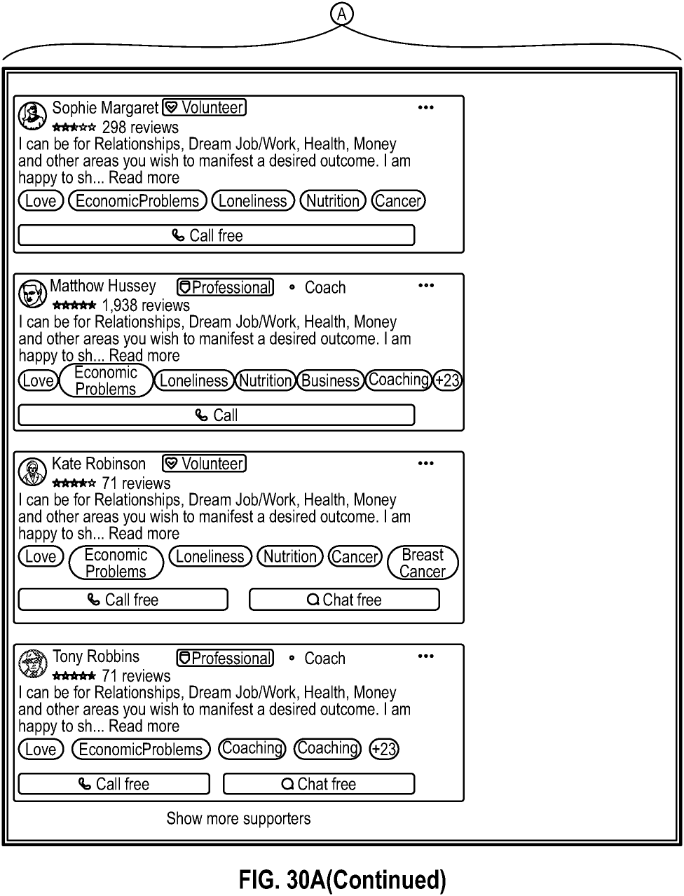

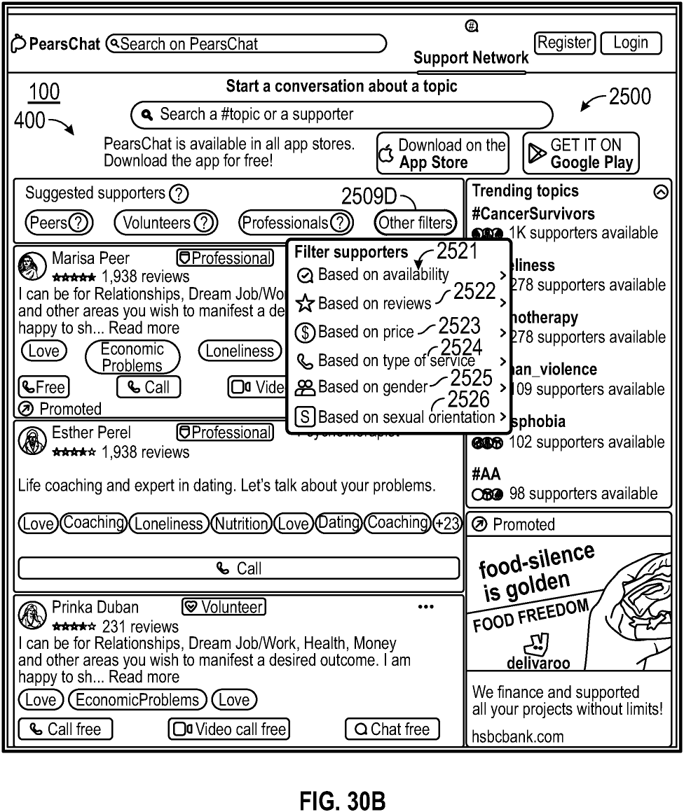

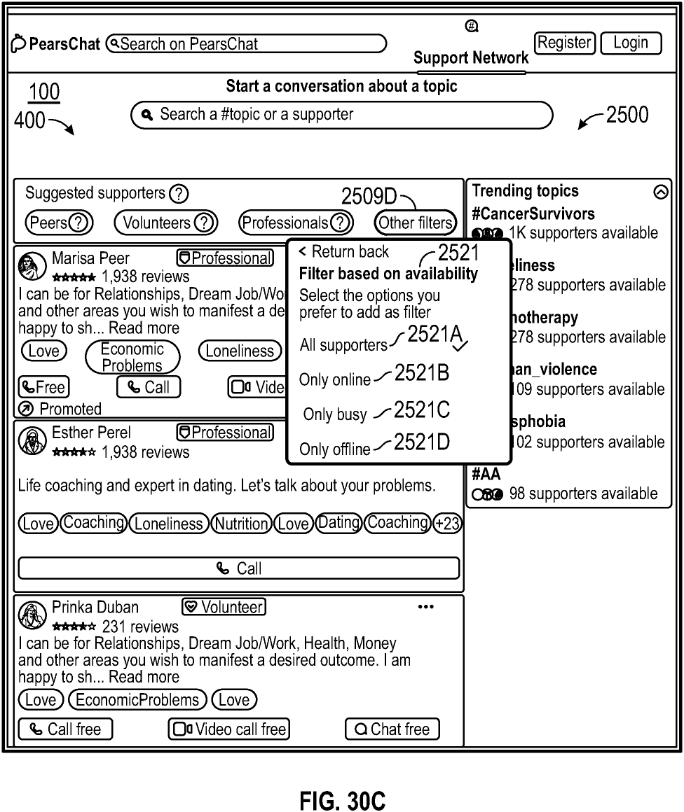

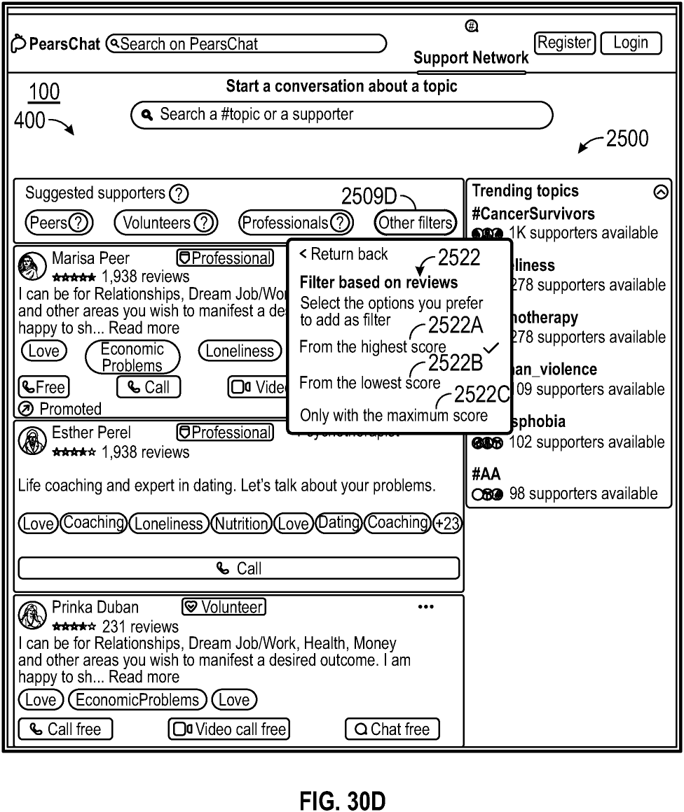

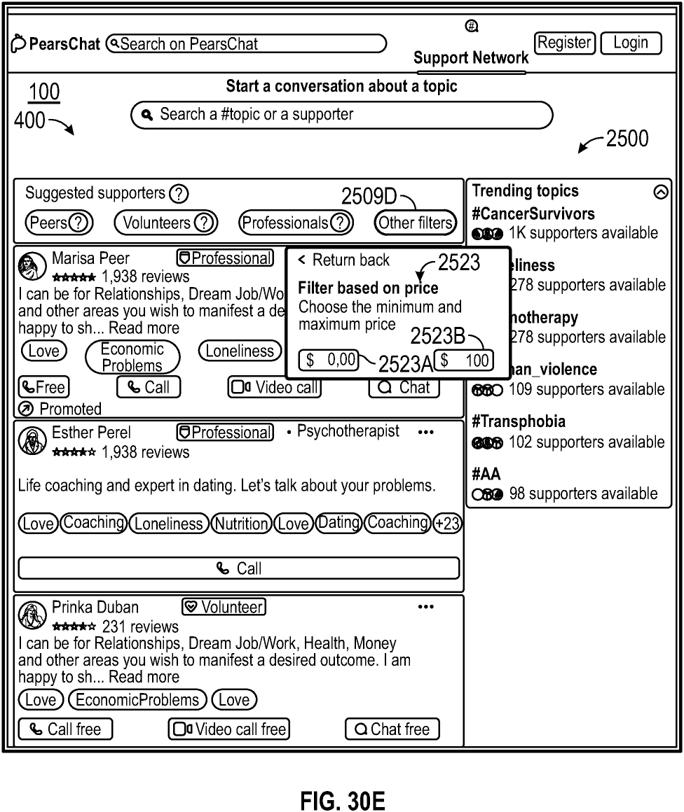

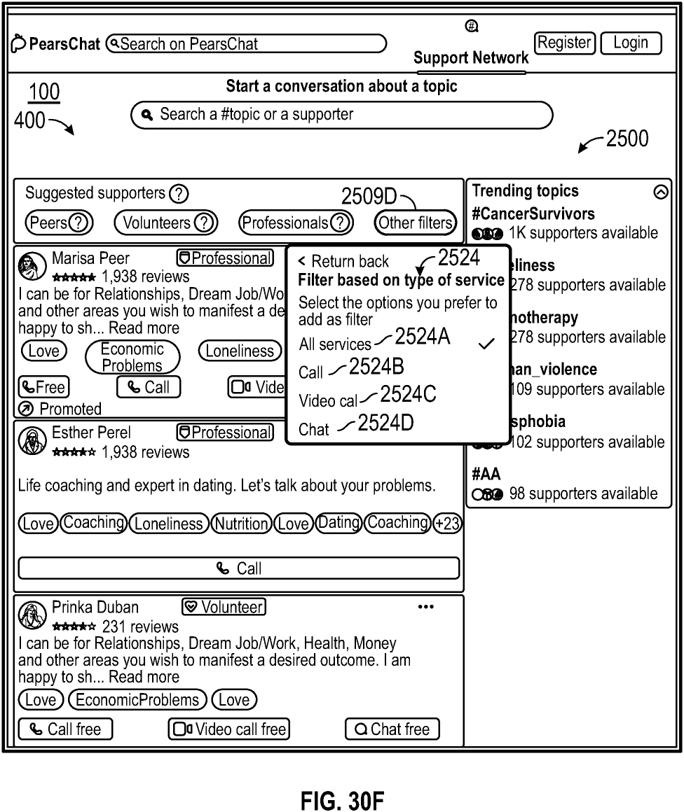

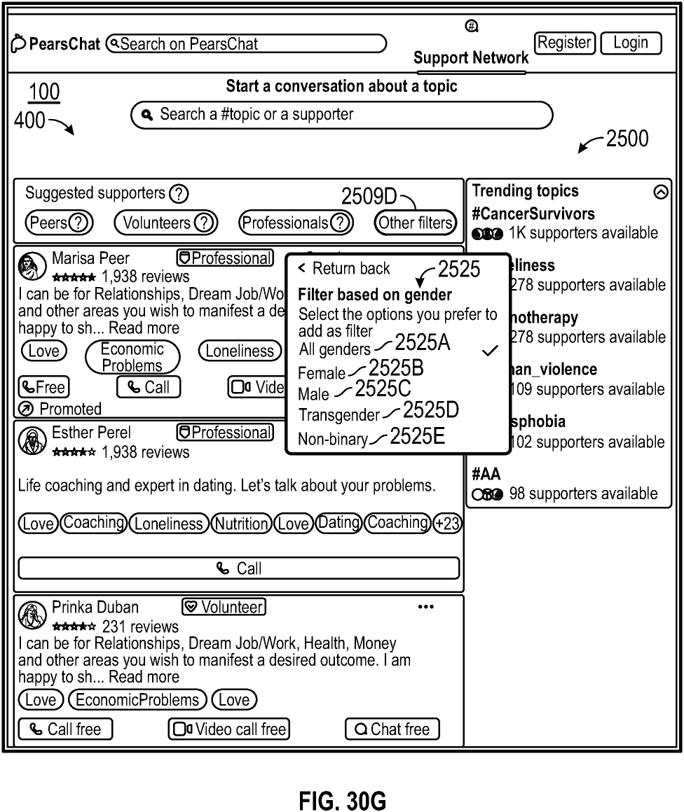

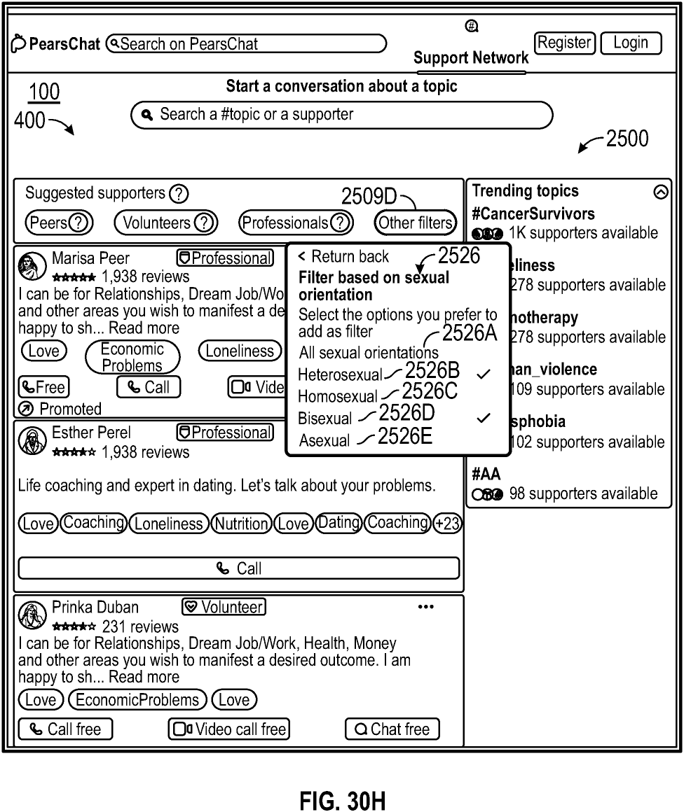

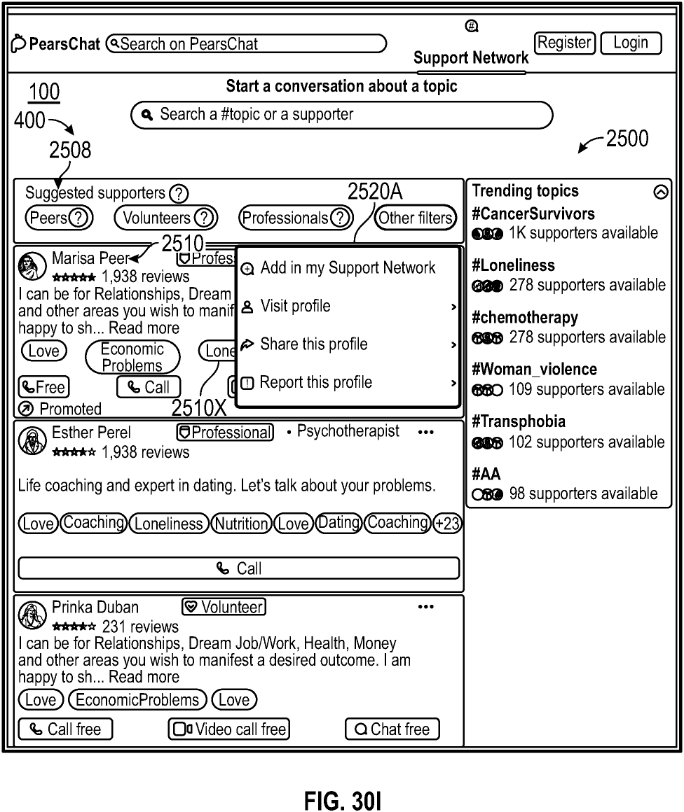

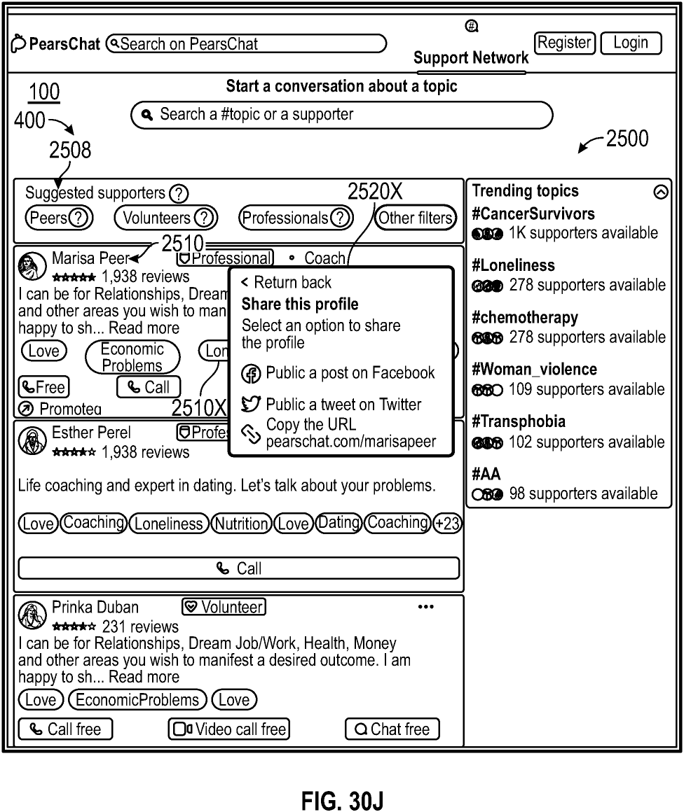

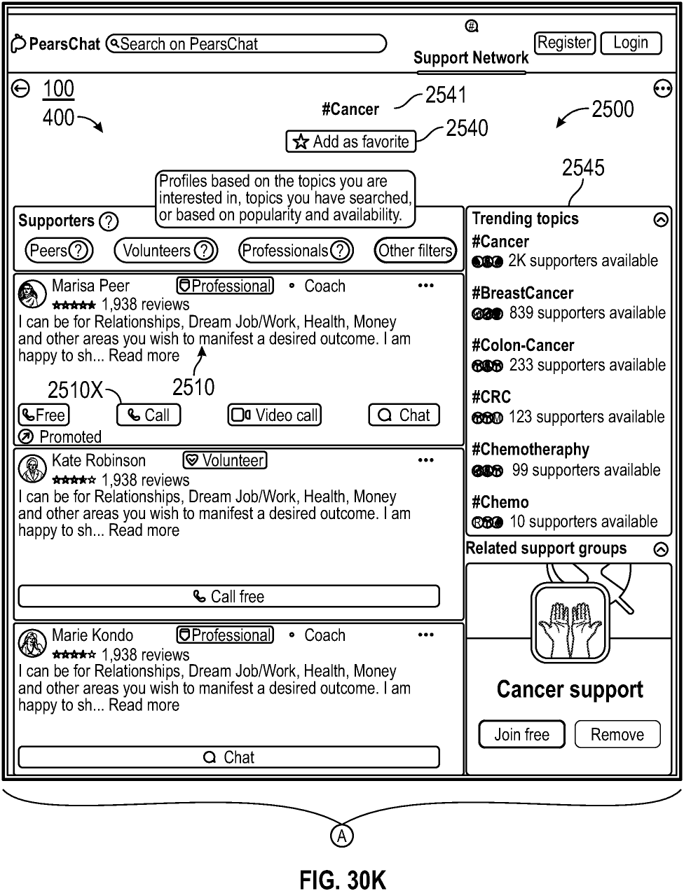

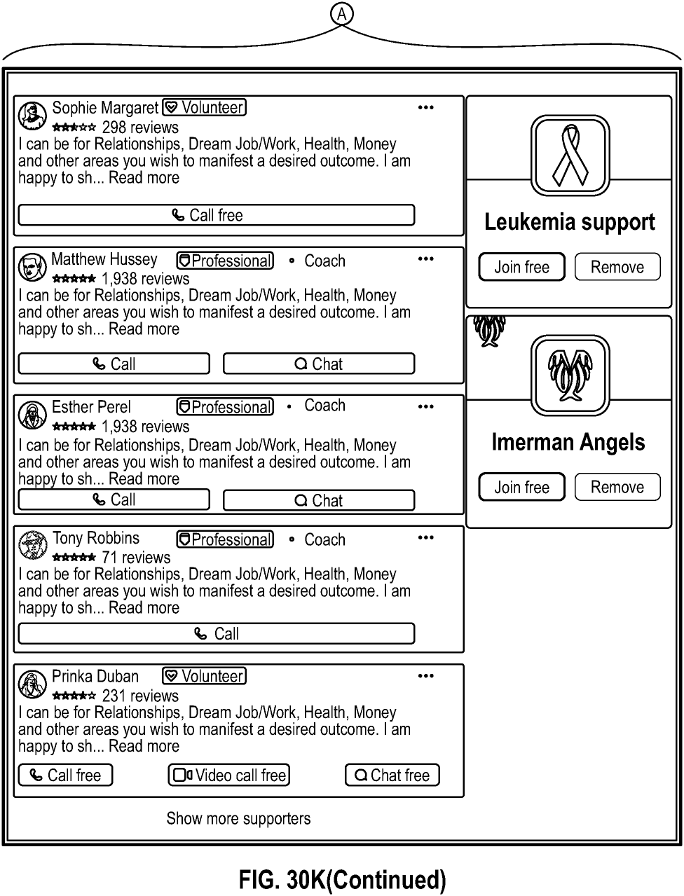

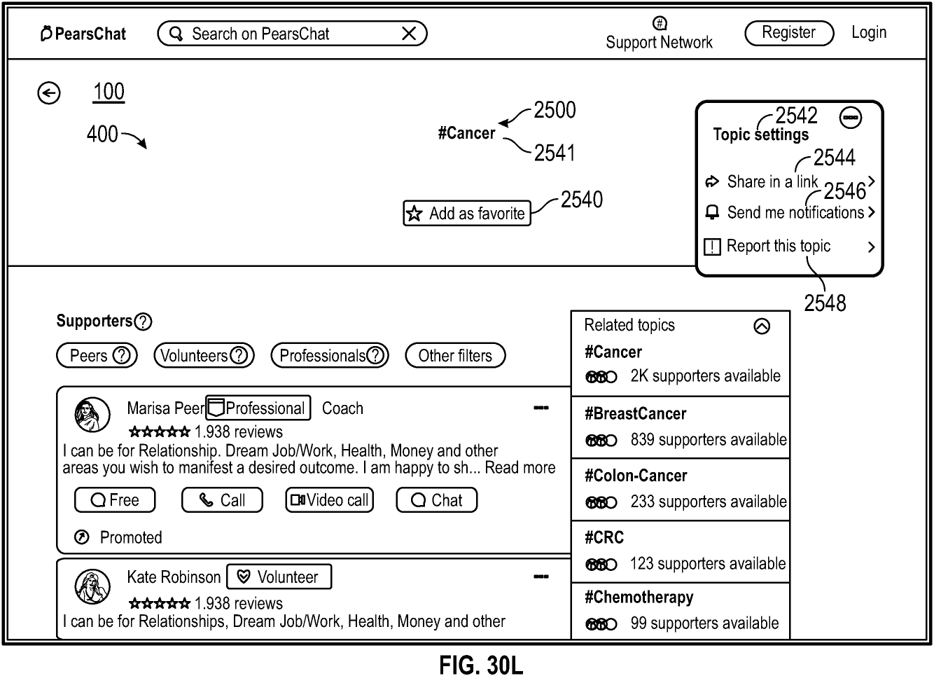

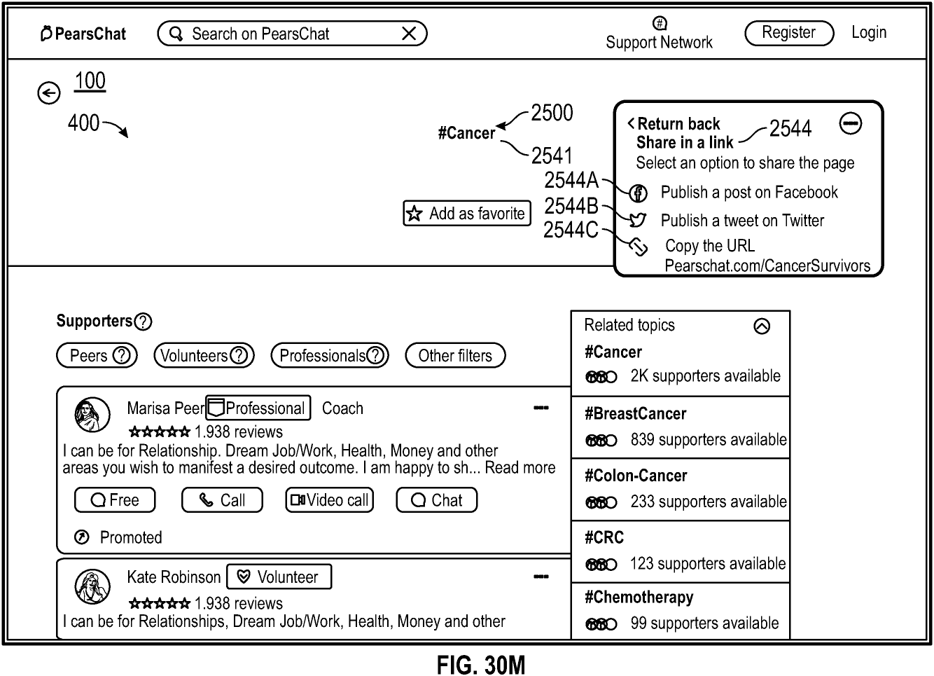

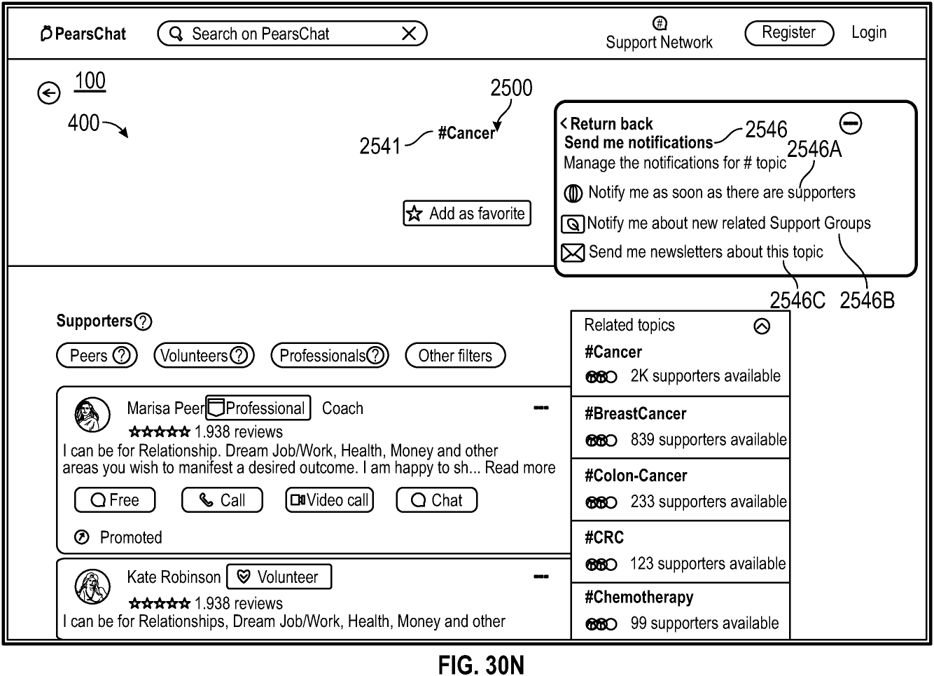

The personal profile page 400 of FIG. 30A is shown as supporting a support network page 2500. The exemplary support network page 2500 of FIG. 30A can include support network content for a first system user 210 who comprises a guest first user who is not logged into the multiuse communication system 100. Upon attempting to access the support network page 2500, the first system user 210, as guest first user, may be presented with an opportunity to login into the multiuse communication system 100 and/or to register with the multiuse communication system 100. The multiuse communication system 100, for example, can present the login page 489 in the manner shown and described herein with reference to FIG. 7 and/or to the registration page 310 in the manner shown and described herein with reference to FIGS. 2A-B. In selected embodiments, if the guest first user is not logged into the multiuse communication system 100, the multiuse communication system 100 can enable the guest first user to search based upon one or more discussion topics for other system users 220 in selected user categories, such as peer system users 212, volunteer system users 214, professional first user 211 and/or coach first user 226. The multiuse communication system 100 can present results from the search but, in preferred embodiments, may require the guest first user to log in and/or registration before permitting the guest first user to make a phone call or otherwise communicate with other system users 220.

The first system user 210 thereby can proceed with logging into, and/or registering with, the multiuse communication system 100 and can be permitted to access the personal profile page 400 shown and described herein with reference to FIGS. 25A-Y, FIGS. 26A-Y, FIGS. 27A-Z, FIG. 28A-AA and/or FIG. 29A-AA that are available for other categories of system users 200. Otherwise, the first system user 210 can elect to remain unlogged in and/or unregistered and can proceed to access the personal profile page 400 shown in FIG. 30A.

The personal profile page 400 of FIG. 30A, for instance, can include navigation indicia 2502, such as one or more tabs, one or more folders and/or one or more icons, for enabling the first system user 210 to access the support network page 2500 and associated support network content available via the multiuse communication system 100. The support network page 2500 is shown in FIG. 30A as including a search feature 2504 by which the first system user 210 can enter discussion topic information and/or name or other information about another system user 220 who might be a potential supporter of the first system user 210. In selected embodiments, the support network page 2500 can present a trending topic listing 2506 with one or more trending discussion topics and/or a suggested supporter listing 2508 of one or more suggested system users 2510 who might support the first system user 210.

The suggested supporter listing 2508 can include selected information about each of the suggested system users 2510. The selected information can include, but is not limited to, a user name 2511 of the suggested supporting user 2510, a user image 2512 of the suggested supporting user 2510 and/or a user category 2513 of the suggested supporting user 2510. In selected embodiments, the user category 2513 of the suggested supporting user 2510 can comprise a user category associated with a preselected discussion topic in the manner discussed in more detail herein. The selected information about the suggested supporting user 2510 optionally can include biographical, narrative and/or other demographic information 2514 of the suggested supporting user 2510, user review information 2515 for the suggested supporting user 2510, relevant discussion topic information 2516 for the suggested supporting user 2510 and/or contact information 2517 for the suggested supporting user 2510, without limitation. Exemplary contact information 2517 can include cost information for interacting with the suggested supporting user 2510 and/or available interaction media, such as a telephone call, a chat and/or a videoconference.

The suggested supporter listing 2508 can be based upon a discussion topic that might be of interest to the first system user 210 and/or a discussion topic searched via the search feature 2504. The suggested supporting users 2510 associated with the suggested supporter listing 2508 can be arranged in any suitable order or other configuration. In selected embodiments, the suggested supporting users 2510 can be sorted based upon a popularity, a review rating or availability of the suggested supporting users 2510, without limitation. As shown in FIG. 30A, the suggested supporter listing 2508 can include filtering indicia 2509 by which the first system user 210 can focus or otherwise narrow the suggested supporter listing 2508. The filtering indicia 2509, for example, can comprise one or more user category filters 2509A-C and/or other suggested supporter filters 2509D. Peer user category filter 2509A can be utilized to narrow the suggested supporter listing 2508 to include only suggested supporting users 2510 who identify as peer system users 212 that are experiencing the same issue as the first system user 210 and/or have an interest in the discussion topic provided by the first system user 210 and wants to share ideas and exchange mutual support.

Volunteer user category filter 2509B can be utilized to narrow the suggested supporter listing 2508 to include only suggested supporting users 2510 who comprise volunteer system users 214. Volunteer system users 214 volunteer their time to help others system users 210. For example, volunteer system users 214 can be system users 210 who have overcome an illness, an addiction or another life issues and who want to share their experiences with other system users 210. Similarly, professional user category filter 2509C can be utilized to narrow the suggested supporter listing 2508 to include only suggested supporting users 2510 who comprise professional system users who are experts in the discussion topic, offer paid listing services and/or are available for professional consultations. Although FIG. 30A shows selected user category filters 2509A-C as including a peer user category filter 2509A, a volunteer user category filter 2509B and a professional user category filter 2509C for purposes of illustration only, the support network page 2500 can include user category filters 2509A-C for any of the user categories discussed herein.

The suggested supporter filters 2509D can comprise any suitable filters for focusing or otherwise narrowing the suggested supporter listing 2508. Turning to FIG. 30B, for example, the suggested supporter filters 2509D can include, but are not limited to, a first supporter filter 2521 based upon an availability of the suggested supporting users 2510, a second supporter filter 2522 based upon reviews of the suggested supporting users 2510, a third supporter filter 2523 based upon a price the suggested supporting users 2510, a fourth supporter filter 2524 based upon type of service provided by the suggested supporting users 2510, a fifth supporter filter 2525 based upon a gender of the suggested supporting users 2510 and/or a sixth supporter filter 2526 based upon a sexual orientation of the suggested supporting users 2510.

FIG. 30C shows that exemplary first supporter filters 2521 can be utilized, at 2521A, to present all of the suggested supporting users 2510 included in the suggested supporter listing 2508. The first supporter filters 2521 alternatively can be utilized to narrow the suggested supporter listing 2508 to include only suggested supporting users 2510 who are available to online, at 2521B, to include only suggested supporting users 2510 who are busy, at 2521C, and/or to include only suggested supporting users 2510 who are available to offline, at 2521D. Turning to FIG. 30D, the second supporter filter 2522 is shown as being configured to narrow the suggested supporter listing 2508 to include only suggested supporting users 2510 who have the highest review score, at 2522A, to include only suggested supporting users 2510 who have the lowest review score, at 2522B, and/or to include only suggested supporting users 2510 who have a maximum review score, at 2522C.

Additionally and/or alternatively, the third supporter filter 2523 illustrated in FIG. 30E enables the suggested supporter listing 2508 to be narrowed to include only suggested supporting users 2510 who have a price between a minimum price amount 2523A and a maximum price amount 2523B. The price can comprise a price rate, a total price for a selected interaction, or any other conventional pricing system or manner. Turning to FIG. 30F, the fourth supporter filter 2524 can narrow the suggested supporter listing 2508 to include only suggested supporting users 2510 who support all communication media 2524A, who support only telephonic communication media 2524B, who support only videoconference communication media 2524C and/or who support only internet chat communication media 2524D, without limitation.

As set forth above, the fifth supporter filter 2525 can narrow the suggested supporter listing 2508 based upon a gender of the suggested supporting users 2510. The fifth supporter filter 2525, for example, can enable the suggested supporter listing 2508 include suggested supporting users 2510 of all genders, at 2525A, as illustrated in FIG. 30G. Alternatively, the fifth supporter filter 2525 can narrow the suggested supporter listing 2508 to include only suggested supporting users 2510 who are female, at 2525B, to include only suggested supporting users 2510 who are male, at 2525C, to include only suggested supporting users 2510 who are transgender, at 2525C, and/or to include only suggested supporting users 2510 who are nonbinary, at 2525D, without limitation.

The sixth supporter filter 2526 can narrow the suggested supporter listing 2508 based upon a sexual orientation of the suggested supporting users 2510. As shown in FIG. 30H, the sixth supporter filter 2526, for example, can enable the suggested supporter listing 2508 include suggested supporting users 2510 of all sexual orientations, at 2526A. In selected embodiments, the sixth supporter filter 2526 alternatively can narrow the suggested supporter listing 2508 to include only suggested supporting users 2510 who are heterosexual, at 2526B, to include only suggested supporting users 2510 who are homosexual, at 2526C, to include only suggested supporting users 2510 who are bisexual, at 2526C, and/or to include only suggested supporting users 2510 who are asexual, at 2526D, without limitation.

The support network page 2500 of FIG. 30I is shown as enabling the first system user 210 to select at least one of the suggested supporting users 2510 included in the suggested supporter listing 2508. The first system user 210, at 2520A, can visit a supporter profile 2510X of the selected suggested supporting user 2510, can add the selected suggested supporting user 2510 to the user profile of the first system user 210 and/or can share the supporter profile 2510X of the selected suggested supporting user 2510.

As illustrated in FIG. 30J, the support network page 2500 can enable the first system user 210 to select at least one of the suggested supporting users 2510 included in the suggested supporter listing 2508. The first system user 210, at 2520X, can share the supporter profile 2510X of the selected suggested supporting user 2510.

Turning to FIG. 30K, the support network page 2500 can enable the first system user 210 to narrow the suggested supporter listing 2508 to include only suggested supporting users 2510 for a selected discussion topic 2541. The first system user 210 optionally can add the supporter profile 2510X of the selected suggested supporting user 2510 to a group of favorites, at 2540. In selected embodiments, the support network page 2500 can present one or more related discussion topics 2545 that are related to the selected discussion topic 2541.

The support network page 2500 of FIG. 25L is shown as enabling the first system user 210 to submit one or more topic settings 2542 via the support network page 2500. The support network page 2500, for example, can permit the first system user 210 to share the supporter profile 2510X in a link, at 2544, to send request notifications, at 2546, and/or to report the selected discussion topic 2541, at 2548, without limitation. The support network page 2500 can permit the first system user 210 to share the supporter profile 2510X in a link, at 2544, in any suitable manner as illustrated in FIG. 30M. The support network page 2500, for example, can permit the first system user 210 to share the supporter profile 2510X via a post on Facebook, at 2544A, via a tweet on Twitter, at 2544B, and/or by copying a Uniform Resource Locator (or URL) for the supporter profile 2510X, at 2544C, without limitation.

Additionally and/or alternatively, the support network page 2500 can be configured to send request notifications, at 2546, in any suitable manner. Turning to FIG. 30N, for instance, the support network page 2500 is illustrated as being configured to send request notifications, at 2546, by notifying the first system user 210 as soon as a suggested supporting user 2510 becomes available, at 2546A, by notifying the first system user 210 as soon as a new support group becomes available, at 2546B, and/or by sending a newsletter relevant to the selected discussion topic 2541 to the first system user 210, at 2546C, without limitation.

According to various embodiments, various functionality of the multiuse communication system 100 discussed herein can be performed by and/or with the help of one or more computer systems (or circuits). Such a computer can be and/or incorporate, as just some examples, a personal computer, a server, a smartphone, a system-on-a-chip, and/or a microcontroller, without limitation. Such a computer can, in various embodiments, run Linux, MacOS, Windows, or another operating system.

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 31 is an example computer employable in various embodiments of the present invention. Exemplary computer system (or circuit) 2601 includes system bus 2603 which operatively connects two processors 2605 and 2607, random access memory (RAM) 2609, read-only memory (ROM) 2611, input and/or output (I/O) interfaces 2613 and 2615, storage interface 2617, and display interface 2619.

Storage interface 2617 in turn connects to mass storage 2621. Each of I/O interfaces 2613 and 2615 can, as just some examples, be a Universal Serial Bus (USB), a Thunderbolt, an Ethernet, a Bluetooth, a Long Term Evolution (LTE), a 5G, an IEEE 488, and/or other interface. Mass storage 2621 can be a flash drive, a hard drive, an optical drive, or a memory chip, as just some possibilities. Processors 2605 and 2607 can each be, as just some examples, a commonly known processor such as an ARM-based or x86-based processor.

Computer 2601 can, in various embodiments, include or be connected to a touch screen, a mouse, and/or a keyboard. Computer 2601 can additionally include or be attached to card readers, digital video disk (or DVD) drives, floppy disk drives, hard drives, memory cards, read only memory (ROM), and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, React, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed.

Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed.

It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for connecting a first user processing circuit of a first website user with a second user processing circuit of a second website user based upon shared needs and challenges of the first and second website users via a website by which website users create user profiles via respective user processing circuits, each of the created user profiles having at least one discussion topic and a user category of the relevant website user with respect to each discussion topic, the method comprising:
enabling the first website user to search among the created user profiles for a first preselected discussion topic via the website;
comparing the first preselected discussion topic with the at least one discussion topic of the created user profiles via the website;
identifying a first subset of the created user profiles that have the first preselected discussion topic via the website;
enabling the first website user to search among the first subset of the created user profiles for a first preselected user category for the first preselected discussion topic via the website;
comparing the first preselected user category for the first preselected discussion topic with the user category for the first preselected discussion topic of the first subset of the created user profiles via the website;
identifying a second subset of the created user profiles that have the first preselected user category for the first preselected discussion topic via the website, the second subset including a second user profile of the second website user;
enabling the first website user to select the second user profile from among the second subset of the created user profiles via the website; and
connecting the first user processing circuit with the second user processing circuit for permitting the first website user and the second website user to discuss the first preselected discussion topic via the website.

2. The method of claim 1, wherein said enabling the first website user to search among the created user profiles for the first preselected discussion topic includes enabling the first website user to search among the created user profiles for the first preselected discussion topic selected from among a discussion topic group consisting of health issues, relationship issues, divorce issues, loneliness issues and mental health issues.

3. The method of claim 1, wherein said enabling the first website user to search among the first subset of the created user profiles for a first preselected user category comprises enabling the first website user to search among the first subset of the created user profiles for website users who are identified as peer users for the first preselected discussion topic.

4. The method of claim 3, wherein the peer users are website users who are experiencing a particular issue associated with the first preselected discussion topic and who want to connect with other website users who also are experiencing the particular issue for mutual support.

5. The method of claim 1, wherein said enabling the first website user to search among the first subset of the created user profiles for a first preselected user category comprises enabling the first website user to search among the first subset of the created user profiles for website users who are identified as volunteer users for the first preselected discussion topic.

6. The method of claim 5, wherein the volunteer users are website users who have personal experience with a particular issue associated with the first preselected discussion topic and are willing to donate time to help other website users who are experiencing the particular issue.

7. The method of claim 1, wherein said enabling the first website user to search among the first subset of the created user profiles for a first preselected user category comprises enabling the first website user to search among the first subset of the created user profiles for website users who are identified as coach users for the first preselected discussion topic.

8. The method of claim 7, wherein the coach users are website users who have expertise or professional training in a particular issue associated with the first preselected discussion topic and are willing to offer services to other website users who are experiencing the particular issue.

9. The method of claim 1, wherein said connecting the first user processing circuit with the second user processing circuit includes a chat box presented via the website.

10. The method of claim 1, wherein said connecting the first user processing circuit with the second user processing circuit comprises establishing a private communication connection between the first user processing circuit and the second user processing circuit.

11. The method of claim 1, further comprising presenting fee information included in the created user profiles of the second subset, wherein said enabling the first website user to select the second user profile includes enabling the first website user to select the second user profile from among the second subset of the created user profiles based upon the presented fee information.

12. The method of claim 11, wherein the presented fee information comprises an optional donation amount for the second website user.

13. The method of claim 11, wherein the presented fee information sets forth that no payment will be accepted by the second website user.

14. The method of claim 11, wherein the presented fee information comprises a predetermined fee rate for the second website user.

15. The method of claim 11, wherein said connecting the first user processing circuit with the second user processing circuit includes enabling the first website user to submit payment for the presented fee information to initialize said connecting the first user processing circuit with the second user processing circuit.

16. A computer program product for connecting a first user processing circuit of a first website user with a second user processing circuit of a second website user based upon shared needs and challenges of the first and second website users via a website by which website users create user profiles via respective user processing circuits, each of the created user profiles having at least one discussion topic and a user category of the relevant website user with respect to each discussion topic, the computer program product being encoded on one or more non-transitory machine-readable storage media and comprising:
instruction for enabling the first website user to search among the created user profiles for a first preselected discussion topic via the website;
instruction for comparing the first preselected discussion topic with the at least one discussion topic of the created user profiles via the website;
instruction for identifying a first subset of the created user profiles that have the first preselected discussion topic via the website;
instruction for enabling the first website user to search among the first subset of the created user profiles for a first preselected user category for the first preselected discussion topic via the website;
instruction for comparing the first preselected user category for the first preselected discussion topic with the user category for the first preselected discussion topic of the first subset of the created user profiles via the website;
instruction for identifying a second subset of the created user profiles that have the first preselected user category for the first preselected discussion topic via the website, the second subset including a second user profile of the second website user;
instruction for enabling the first website user to select the second user profile from among the second subset of the created user profiles via the website; and
instruction for connecting the first user processing circuit with the second user processing circuit for permitting the first website user and the second website user to discuss the first preselected discussion topic via the website.

17. A system for connecting a first user processing circuit of a first system user with a second user processing circuit of a second system user based upon shared needs and challenges of the first and second system users, the method comprising:
a database circuit for compiling user profiles created by system users via respective user processing circuits, each of the created user profiles having at least one discussion topic and a user category of the relevant system user with respect to each discussion topic; and
a server circuit for enabling the first system user to search among the created user profiles for a first preselected discussion topic, comparing the first preselected discussion topic with the at least one discussion topic of the created user profiles and identifying a first subset of the created user profiles that have the first preselected discussion topic, said server circuit being configured for enabling the first system user to search among the first subset of the created user profiles for a first preselected user category for the first preselected discussion topic, comparing the first preselected user category for the first preselected discussion topic with the user category for the first preselected discussion topic of the first subset of the created user profiles and identifying a second subset of the created user profiles that have the first preselected user category for the first preselected discussion topic, the second subset including a second user profile of the second system user,
wherein said server system enables the first system user to select the second user profile from among the second subset of the created user profiles and connects the first user processing circuit with the second user processing circuit for permitting the first system user and the second system user to discuss the first preselected discussion topic.

18. The system of claim 17, wherein said database circuit is integrated with said server circuit.

19. The system of claim 17, wherein said server circuit provides a website for interacting with the first system user and the second system user.

20. The system of claim 17, wherein the website presents a chat box for permitting the first system user and the second system user to discuss the first preselected discussion topic.
